(19) United States
(12) Patent Application Publication
(10) Pub. No.: US 2025/0159326 A1
(43) Pub. Date: May 15, 2025

(54) SYSTEM, METHOD, AND COMPUTER PROGRAM FOR CAPTURING A FLASH IMAGE BASED ON AMBIENT AND FLASH METERING

(71) Applicant: Duelight LLC, Sunnyvale, CA (US)

(72) Inventors: William Guie Rivard, Menlo Park, CA (US); Adam Barry Feder, Mountain View, CA (US); Brian J. Kindle, Sunnyvale, CA (US)

(21) Appl. No.: 19/025,910

(22) Filed: Jan. 16, 2025

Related U.S. Application Data
(63) Continuation of application No. 18/935,319, filed on Nov. 1, 2024.
Application No. 18/935,319 is a continuation-in-part of application No. 18/388,158, filed on Nov. 8, 2023.
Application No. 18/388,158 is a continuation-in-part of application No. 17/824,773, filed on May 25, 2022, now abandoned.
Application No. 17/824,773 is a continuation of application No. 16/663,015, filed on Oct. 24, 2019, now Pat. No. 11,363,179.
Application No. 16/663,015 is a continuation of application No. 15/815,463, filed on Nov. 16, 2017, now Pat. No. 10,477,087.

(51) Int. Cl. H04N 23/56; H04N 23/71; H04N 23/73; H04N 23/74; H04N 23/741; H04N 25/531; H04N 25/583

(52) U.S. Cl. CPC H04N 23/56; H04N 23/71; H04N 23/73; H04N 23/74; H04N 23/741; H04N 25/531; H04N 25/583

(57) ABSTRACT

A system and method are provided for capturing a flash image based on ambient and flash metering. In use, a first ambient condition is metered for a first ambient frame. Next, a first ambient capture time is determined based on the metering of the first ambient condition. Further, a first flash condition is metered for a first flash frame, and a first flash capture time is determined based on the metering of the first flash condition. Next, a first ambient frame is captured based on the first ambient capture time. After capturing the first ambient frame, a flash circuit is enabled during an active period and, a first flash frame is captured based on a combination of the first ambient capture time and the first flash capture time. Finally, a final image is generated based on the first ambient frame and the first flash frame.

### RELATED APPLICATIONS

The present application is a continuation of U.S. patent application Ser. No. 18/935,319 filed Nov. 1, 2024, which in turn is a continuation-in-part, by virtue of the removal of subject matter (that was either expressly disclosed or incorporated by reference in one or more priority applications), with the purpose of claiming priority to and including herewith the full express and incorporated disclosure of U.S. patent application Ser. No. 15/815,463, now U.S. Pat. No. 10,477,087 issued Nov. 12, 2019, entitled “SYSTEM, METHOD, AND COMPUTER PROGRAM FOR CAPTURING A FLASH IMAGE BASED ON AMBIENT AND FLASH METERING,” filed Nov. 16, 2017, which, at the time of the aforementioned Nov. 16, 2017 filing, included (either expressly or by incorporation) a combination of the following applications, which are all incorporated herein by reference in their entirety for all purposes:
U.S. patent application Ser. No. 14/534,079, now U.S. Pat. No. 9,137,455 issued Sep. 15, 2025, entitled “IMAGE SENSOR APPARATUS AND METHOD FOR OBTAINING MULTIPLE EXPOSURES WITH ZERO INTERFRAME TIME,” filed Nov. 5, 2014 (which incorporated by reference U.S. patent application Ser. No. 13/999,678, now U.S. Pat. No. 9,807,322 issued Oct. 31, 2017, filed Mar. 14, 2014, entitled “SYSTEMS AND METHODS FOR A DIGITAL IMAGE SENSOR);
U.S. patent application Ser. No. 14/534,089, now U.S. Pat. No. 9,167,169 issued Oct. 20, 2015, entitled “IMAGE SENSOR APPARATUS AND METHOD FOR SIMULTANEOUSLY CAPTURING MULTIPLE IMAGES,” filed Nov. 5, 2014;
U.S. patent application Ser. No. 14/535,274, now U.S. Pat. No. 9,154,708 issued Oct. 6, 2015, entitled “IMAGE SENSOR APPARATUS AND METHOD FOR SIMULTANEOUSLY CAPTURING FLASH AND AMBIENT ILLUMINATED IMAGES,” filed Nov. 6, 2014;
U.S. patent application Ser. No. 14/535,279, now U.S. Pat. No. 9,179,085 issued Nov. 3, 2015, entitled “IMAGE SENSOR APPARATUS AND METHOD FOR OBTAINING LOW-NOISE, HIGH-SPEED CAPTURES OF A PHOTOGRAPHIC SCENE” filed Nov. 6, 2014;
U.S. patent application Ser. No. 13/573,252, now U.S. Pat. No. 8,976,264 issued Mar. 10, 2015, entitled “COLOR BALANCE IN DIGITAL PHOTOGRAPHY,” filed Sep. 4, 2012;
U.S. patent application Ser. No. 13/999,343, now U.S. Pat. No. 9,215,433 issued Dec. 15, 2015, entitled “SYSTEMS AND METHODS FOR DIGITAL PHOTOGRAPHY,” filed Feb. 11, 2014;
U.S. patent application Ser. No. 13/999,678, now U.S. Pat. No. 9,807,322 issued Oct. 31, 2017, entitled “SYSTEMS AND METHODS FOR A DIGITAL IMAGE SENSOR,” filed Mar. 14, 2014;
U.S. patent application Ser. No. 14/536,524, now U.S. Pat. No. 9,160,936 issued Oct. 13, 2015, entitled “SYSTEMS AND METHODS FOR GENERATING A HIGH-DYNAMIC RANGE (HDR) PIXEL STREAM,” filed Nov. 7, 2014; and
U.S. patent application Ser. No. 15/201,283, now U.S. Pat. No. 9,819,849 issued Nov. 14, 2017, entitled “SYSTEMS AND METHODS FOR CAPTURING DIGITAL IMAGES,” filed Jul. 1, 2016.

To accomplish the above, U.S. patent application Ser. No. 18/935,319 is a continuation-in-part of, and claims priority to, U.S. patent application Ser. No. 18/388,158, entitled “SYSTEM AND METHOD FOR GENERATING A DIGITAL IMAGE,” filed Nov. 8, 2023, which in turn is a continuation-in-part of, and claims priority to: U.S. patent application Ser. No. 17/824,773, entitled “SYSTEM, METHOD, AND COMPUTER PROGRAM FOR CAPTURING A FLASH IMAGE BASED ON AMBIENT AND FLASH METERING,” filed May 25, 2022, which in turn is a continuation of, and claims priority to U.S. patent application Ser. No. 16/663,015, filed Oct. 24, 2019, now U.S. Pat. No. 11,363,179 issued Jun. 14, 2022, entitled “SYSTEM, METHOD, AND COMPUTER PROGRAM FOR CAPTURING A FLASH IMAGE BASED ON AMBIENT AND FLASH METERING,” which in turn is a continuation of, and claims priority to U.S. patent application Ser. No. 15/815,463, now U.S. Pat. No. 10,477,087 issued Nov. 12, 2019, entitled “SYSTEM, METHOD, AND COMPUTER PROGRAM FOR CAPTURING A FLASH IMAGE BASED ON AMBIENT AND FLASH METERING,” filed Nov. 16, 2017.

### FIELD OF THE INVENTION

The present invention relates to capturing an image, and more particularly to capturing a flash image based on ambient and flash metering.

### BACKGROUND

Current photographic systems provide for capturing an ambient image and a flash image separately. Flash images are captured in combination with a flash, whereas ambient images are captured based on ambient conditions (e.g. ambient light). However, captured flash images often do not display the correct light and color (as captured, e.g., with an ambient image). Additionally, ambient images may lack correct exposure (e.g. a point of interest may remain dark). As such, elements of a flash image may improve a capture of an ambient image, and elements of an ambient image may improve a capture of a flash image.

There is thus a need for addressing these and/or other issues associated with the prior art.

### SUMMARY

A system and method are provided for capturing a flash image based on ambient and flash metering. In use, a first ambient condition is metered for a first ambient frame. Next, a first ambient capture time is determined based on the metering of the first ambient condition. Further, a first flash condition is metered for a first flash frame, and a first flash capture time is determined based on the metering of the first flash condition. Next, a first ambient frame is captured based on the first ambient capture time. After capturing the first ambient frame, a flash circuit is enabled during an active period and, a first flash frame is captured based on a combination of the first ambient capture time and the first flash capture time. Finally, a final image is generated based on the first ambient frame and the first flash frame.

### BRIEF DESCRIPTION OF THE DRAWINGS

FIG. 1 illustrates an exemplary method for capturing an image based on an ambient capture time and a flash capture time, in accordance with one possible embodiment.

FIG. 2 illustrates a method for capturing an image based on an ambient capture time and a flash capture time, in accordance with one embodiment.

FIG. 3A illustrates a digital photographic system, in accordance with an embodiment.

FIG. 3B illustrates a processor complex within the digital photographic system, according to one embodiment.

FIG. 3C illustrates a digital camera, in accordance with an embodiment.

FIG. 3D illustrates a wireless mobile device, in accordance with another embodiment.

FIG. 3E illustrates a camera module configured to sample an image, according to one embodiment.

FIG. 3F illustrates a camera module configured to sample an image, according to another embodiment.

FIG. 3G illustrates a camera module in communication with an application processor, in accordance with an embodiment.

FIG. 4 illustrates a network service system, in accordance with another embodiment.

FIG. 5A illustrates a time graph of line scan out and line reset signals for one capture associated with a rolling shutter, in accordance with one embodiment.

FIG. 5B illustrates a time graph of line scan out and line reset signals for capturing three frames having increasing exposure levels using a rolling shutter, in accordance with one embodiment.

FIG. 6A illustrates a time graph of a line reset, an ambient exposure time, a flash activation, a flash exposure time, and scan out for two frame captures performed with a rolling shutter image sensor, in accordance with one embodiment.

FIG. 6B illustrates a time graph of reset, exposure, and scan out timing for multiple equally exposed frames, in accordance with one embodiment.

FIG. 6C illustrates a time graph of reset, exposure, and scan out timing for two frames, in accordance with one embodiment.

FIG. 6D illustrates a time graph of reset, exposure, and scan out for an ambient frame and a flash frame, in accordance with one embodiment.

FIG. 6E illustrates a time graph of reset, exposure, and scan out for an ambient frame and two sequential flash frames, in accordance with one embodiment.

FIG. 7 illustrates a time graph of linear intensity increase for a flash, in accordance with one embodiment.

FIG. 8 illustrates a method for capturing a flash image based on a first and second metering, in accordance with one embodiment.

FIG. 9A illustrates a method for setting a point of interest associated with a flash exposure, in accordance with one embodiment.

FIG. 9B illustrates a network architecture, in accordance with one possible embodiment.

FIG. 9C illustrates an exemplary system, in accordance with one embodiment.

FIG. 10-1A illustrates a first data flow process for generating a blended image based on at least an ambient image and a strobe image, according to one embodiment of the present invention;

FIG. 10-1B illustrates a second data flow process for generating a blended image based on at least an ambient image and a strobe image, according to one embodiment of the present invention;

FIG. 10-1C illustrates a third data flow process for generating a blended image based on at least an ambient image and a strobe image, according to one embodiment of the present invention;

FIG. 10-1D illustrates a fourth data flow process for generating a blended image based on at least an ambient image and a strobe image, according to one embodiment of the present invention;

FIG. 10-2A illustrates an image blend operation for blending a strobe image with an ambient image to generate a blended image, according to one embodiment of the present invention;

FIG. 10-2B illustrates a blend function for blending pixels associated with a strobe image and an ambient image, according to one embodiment of the present invention;

FIG. 10-2C illustrates a blend surface for blending two pixels, according to one embodiment of the present invention;

FIG. 10-2D illustrates a blend surface for blending two pixels, according to another embodiment of the present invention;

FIG. 10-2E illustrates an image blend operation for blending a strobe image with an ambient image to generate a blended image, according to one embodiment of the present invention;

FIG. 10-3A illustrates a patch-level analysis process for generating a patch correction array, according to one embodiment of the present invention;

FIG. 10-3B illustrates a frame-level analysis process for generating frame-level characterization data, according to one embodiment of the present invention;

FIG. 10-4A illustrates a data flow process for correcting strobe pixel color, according to one embodiment of the present invention;

FIG. 10-4B illustrates a chromatic attractor function, according to one embodiment of the present invention;

FIG. 10-5 is a flow diagram of method steps for generating an adjusted digital photograph, according to one embodiment of the present invention;

FIG. 10-6A is a flow diagram of method steps for blending a strobe image with an ambient image to generate a blended image, according to a first embodiment of the present invention;

FIG. 10-6B is a flow diagram of method steps for blending a strobe image with an ambient image to generate a blended image, according to a second embodiment of the present invention;

FIG. 10-7A is a flow diagram of method steps for blending a strobe image with an ambient image to generate a blended image, according to a third embodiment of the present invention;

FIG. 10-7B is a flow diagram of method steps for blending a strobe image with an ambient image to generate a blended image, according to a fourth embodiment of the present invention;

FIG. 11-1 illustrates an exemplary system for obtaining multiple exposures with zero interframe time, in accordance with one possible embodiment.

FIG. 11-2 illustrates an exemplary method carried out for obtaining multiple exposures with zero interframe time, in accordance with one embodiment.

FIGS. 11-3A-11-3E illustrate systems for converting optical scene information to an electronic representation of a photographic scene, in accordance with other embodiments.

FIG. 11-4 illustrates a system for converting analog pixel data to digital pixel data, in accordance with an embodiment.

FIG. 11-5 illustrates a system for converting analog pixel data of an analog signal to digital pixel data, in accordance with another embodiment.

FIG. 11-6 illustrates various timing configurations for amplifying analog signals, in accordance with other embodiments.

FIG. 11-7 illustrates a system for converting in parallel analog pixel data to multiple signals of digital pixel data, in accordance with one embodiment.

FIG. 11-8 illustrates a message sequence for generating a combined image utilizing a network, according to another embodiment.

FIG. 12-1 illustrates an exemplary system for simultaneously capturing multiple images.

FIG. 12-2 illustrates an exemplary method carried out for simultaneously capturing multiple images.

FIG. 12-3 illustrates a circuit diagram for a photosensitive cell, according to one embodiment.

FIG. 12-4 illustrates a system for converting analog pixel data of more than one analog signal to digital pixel data, in accordance with another embodiment.

FIG. 13-1 illustrates an exemplary system for simultaneously capturing flash and ambient illuminated images, in accordance with an embodiment.

FIG. 13-2 illustrates an exemplary method carried out for simultaneously capturing flash and ambient illuminated images, in accordance with an embodiment.

FIG. 13-3 illustrates a system for converting analog pixel data of more than one analog signal to digital pixel data, in accordance with another embodiment.

FIG. 13-4A illustrates a user interface system for generating a combined image, according to an embodiment.

FIG. 13-4B illustrates another user interface system for generating a combined image, according to one embodiment.

FIG. 13-4C illustrates user interface (UI) systems displaying combined images with differing levels of strobe exposure, according to an embodiment.

FIG. 14-1 illustrates an exemplary system for obtaining low-noise, high-speed captures of a photographic scene, in accordance with one embodiment.

FIG. 14-2 illustrates an exemplary system for obtaining low-noise, high-speed captures of a photographic scene, in accordance with another embodiment.

FIG. 14-3A illustrates a circuit diagram for a photosensitive cell, according to one embodiment.

FIG. 14-3B illustrates a circuit diagram for another photosensitive cell, according to another embodiment.

FIG. 14-3C illustrates a circuit diagram for a plurality of communicatively coupled photosensitive cells, according to yet another embodiment.

FIG. 14-4 illustrates implementations of different analog storage planes, in accordance with another embodiment.

FIG. 14-5 illustrates a system for converting analog pixel data of an analog signal to digital pixel data, in accordance with another embodiment.

FIG. 15-1 illustrates an exemplary method for generating a high dynamic range (HDR) pixel stream, in accordance with an embodiment.

FIG. 15-2 illustrates a system for generating a HDR pixel stream, in accordance with another embodiment.

FIG. 15-3 illustrates a system for receiving a pixel stream and outputting a HDR pixel stream, in accordance with another embodiment.

FIG. 15-4 illustrates a system for generating a HDR pixel, in accordance with another embodiment.

FIG. 15-5A illustrates a method for generating a HDR pixel, in accordance with another embodiment.

FIG. 15-5B illustrates a system for generating a HDR pixel, in accordance with another embodiment.

FIG. 15-6 illustrates a method for generating a HDR pixel, in accordance with another embodiment.

FIG. 15-7 illustrates a method for generating a HDR pixel, in accordance with another embodiment.

FIG. 15-8A illustrates a surface diagram, in accordance with another embodiment.

FIG. 15-8B illustrates a surface diagram, in accordance with another embodiment.

FIG. 15-9A illustrates a surface diagram, in accordance with another embodiment.

FIG. 15-9B illustrates a surface diagram, in accordance with another embodiment.

FIG. 15-10 illustrates an image blend operation, in accordance with another embodiment.

FIG. 16-1A illustrates a first data flow process for generating a blended image based on at least an ambient image and a strobe image, according to one embodiment of the present invention;

FIG. 16-1B illustrates a second data flow process for generating a blended image based on at least an ambient image and a strobe image, according to one embodiment of the present invention;

FIG. 16-2A illustrates a third data flow process for generating a blended image based on at least an ambient image and a strobe image, according to one embodiment of the present invention;

FIG. 16-2B illustrates a fourth data flow process for generating a blended image based on at least an ambient image and a strobe image, according to one embodiment of the present invention;

FIG. 16-3A illustrates an image blend operation for blending a strobe image with an ambient image to generate a blended image, according to one embodiment of the present invention;

FIG. 16-3B illustrates a blend function for blending pixels associated with a strobe image and an ambient image, according to one embodiment of the present invention;

FIG. 16-3C illustrates a blend surface for blending two pixels, according to one embodiment of the present invention;

FIG. 16-3D illustrates a blend surface for blending two pixels, according to another embodiment of the present invention;

FIG. 16-3E illustrates an image blend operation for blending a strobe image with an ambient image to generate a blended image, according to one embodiment of the present invention;

FIG. 16-4A illustrates a patch-level analysis process for generating a patch correction array, according to one embodiment of the present invention;

FIG. 16-4B illustrates a frame-level analysis process for generating frame-level characterization data, according to one embodiment of the present invention;

FIG. 16-5A illustrates a data flow process for correcting strobe pixel color, according to one embodiment of the present invention;

FIG. 16-5B illustrates a chromatic attractor function, according to one embodiment of the present invention;

FIG. 16-6 is a flow diagram of method steps for generating an adjusted digital photograph, according to one embodiment of the present invention;

FIG. 16-7A is a flow diagram of method steps for blending a strobe image with an ambient image to generate a blended image, according to a first embodiment of the present invention;

FIG. 16-7B is a flow diagram of method steps for blending a strobe image with an ambient image to generate a blended image, according to a second embodiment of the present invention;

FIG. 16-8A is a flow diagram of method steps for blending a strobe image with an ambient image to generate a blended image, according to a third embodiment of the present invention;

FIG. 16-8B is a flow diagram of method steps for blending a strobe image with an ambient image to generate a blended image, according fourth embodiment of the present invention;

FIG. 16-9 illustrates a user interface system for generating a combined image, according to one embodiment of the present invention;

FIG. 16-10A is a flow diagram of method steps for generating a combined image, according to one embodiment of the present invention;

FIG. 16-10B is a flow diagram of a method steps for calculating a recommended UI control position for blending two different images, according to one embodiment of the present invention;

FIGS. 16-11A-16-11C illustrate a user interface configured to adapt to device orientation while preserving proximity of a user interface control element to a hand grip edge, according to embodiments of the present invention;

FIG. 16-11D illustrates a mobile device incorporating grip sensors configured to detect a user grip, according to one embodiment of the present invention;

FIG. 16-11E is a flow diagram of method steps for orienting a user interface surface with respect to a control element, according to one embodiment of the present invention;

FIG. 16-12A illustrates a first user interface control selector configured to select one active control from one or more available controls, according to embodiments of the present invention;

FIG. 16-12B illustrates a second user interface control selector configured to select one active control from one or more available controls, according to embodiments of the present invention;

FIG. 16-12C is a flow diagram of method steps for selecting an active control from one or more available control elements, according to one embodiment of the present invention;

FIG. 16-13A illustrates a data flow process for selecting an ambient target exposure coordinate, according to one embodiment of the present invention;

FIG. 16-13B is a flow diagram of method steps for selecting an ambient target exposure coordinate, according to one embodiment of the present invention;

FIG. 16-13C illustrates a scene having a strobe influence region, according to one embodiment of the present invention;

FIG. 16-13D illustrates a scene mask computed to preclude a strobe influence region, according to one embodiment of the present invention; and

FIG. 16-14 is a flow diagram of method steps for sampling an ambient image and a strobe image based on computed exposure coordinates, according to one embodiment of the present invention.

FIG. 17-1A illustrates a flow chart of a method for generating an image stack comprising two or more images of a photographic scene, in accordance with one embodiment;

FIG. 17-1B illustrates a flow chart of a method for generating an image stack comprising an ambient image and a strobe image of a photographic scene, in accordance with one embodiment;

FIG. 17-2 illustrates generating a synthetic image from an image stack, according to one embodiment of the present invention;

FIG. 17-3 illustrates a block diagram of image sensor, according to one embodiment of the present invention;

FIG. 17-4 is a circuit diagram for a photo-sensitive cell within a pixel implemented using complementary-symmetry metal-oxide semiconductor devices, according to one embodiment;

FIG. 17-5A is a circuit diagram for a first photo-sensitive cell, according to one embodiment;

FIG. 17-5B is a circuit diagram for a second photo-sensitive cell, according to one embodiment;

FIG. 17-6A is a circuit diagram for a third photo-sensitive cell, according to one embodiment;

FIG. 17-6B depicts exemplary physical layout for a pixel comprising four photo-sensitive cells, according to one embodiment;

FIG. 17-7A illustrates exemplary timing for controlling cells within a pixel array to sequentially capture an ambient image and a strobe image illuminated by a strobe unit, according to one embodiment of the present invention;

FIG. 17-7B illustrates exemplary timing for controlling cells within a pixel array to concurrently capture an ambient image and an image illuminated by a strobe unit, according to one embodiment of the present invention;

FIG. 17-7C illustrates exemplary timing for controlling cells within a pixel array to concurrently capture two ambient images having different exposures, according to one embodiment of the present invention;

FIG. 17-7D illustrates exemplary timing for controlling cells within a pixel array to concurrently capture two ambient images having different exposures, according to one embodiment of the present invention;

FIG. 17-7E illustrates exemplary timing for controlling cells within a pixel array to concurrently capture four ambient images, each having different exposure times, according to one embodiment of the present invention; and

FIG. 17-7F illustrates exemplary timing for controlling cells within a pixel array to concurrently capture three ambient images having different exposures and subsequently capture a strobe image, according to one embodiment of the present invention.

FIG. 18-1 illustrates an exemplary method for generating a de-noised pixel, in accordance with one possible embodiment.

FIG. 18-1A illustrates a method for generating a de-noised pixel comprising a digital image, according to one embodiment of the present invention.

FIG. 18-1B illustrates a method for estimating noise for a pixel within a digital image, according to one embodiment of the present invention.

FIG. 18-1C illustrates a method for generating a de-noised pixel, according to one embodiment of the present invention.

FIG. 18-1D illustrates a method for capturing an ambient image and a flash image, according to one embodiment of the present invention.

FIG. 18-2A illustrates a computational flow for generating a de-noised pixel, according to one embodiment of the present invention.

FIG. 18-2B illustrates a noise estimation function, according to one embodiment of the present invention.

FIG. 18-2C illustrates a pixel de-noise function, according to one embodiment of the present invention.

FIG. 18-2D illustrates patch-space samples organized around a central region, according to one embodiment of the present invention.

FIG. 18-2E illustrates patch-space regions organized around a center, according to one embodiment of the present invention.

FIG. 18-2F illustrates a constellation of patch-space samples around a center position, according to one embodiment of the present invention.

FIG. 18-2G illustrates relative weights for different ranks in a patch-space constellation, according to one embodiment of the present invention.

FIG. 18-2H illustrates assigning sample weights based on detected image features, according to one embodiment.

FIG. 18-3 illustrates a blend surface for estimating flash contribution at a pixel, according to one embodiment of the present invention.

FIG. 18-4A illustrates a front view of a mobile device comprising a display unit, according to one embodiment of the present invention.

FIG. 18-4B illustrates a back view of a mobile device comprising a front-facing camera and front-facing strobe unit, according to one embodiment of the present invention.

FIG. 18-5 illustrates an exemplary method for generating a de-noised pixel based on a plurality of camera modules, in accordance with one possible embodiment.

### DETAILED DESCRIPTION

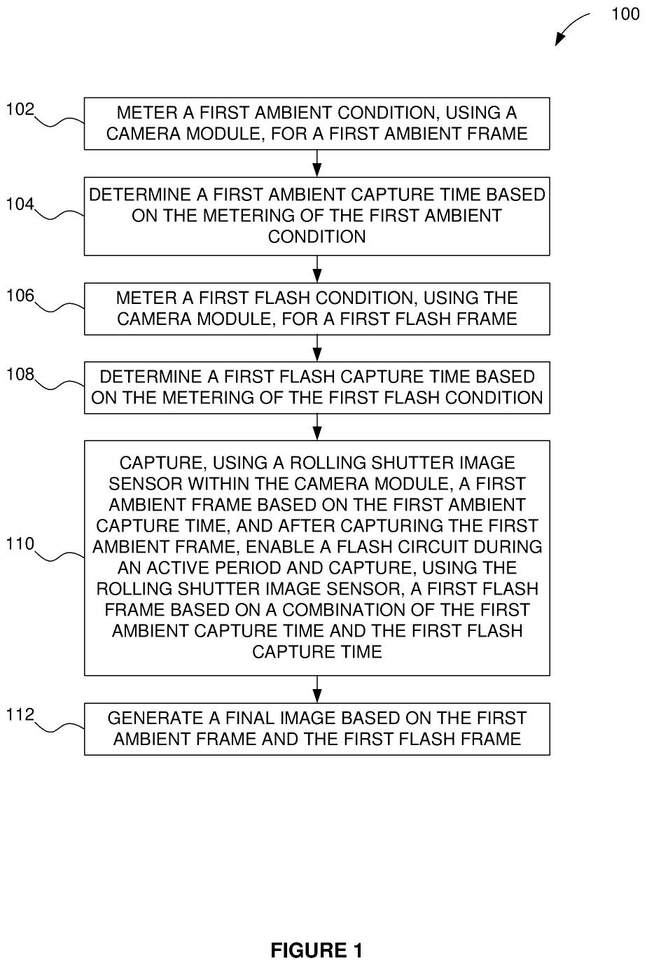

FIG. 1 illustrates an exemplary method 100 for capturing an image based on an ambient capture time and a flash capture time, in accordance with one possible embodiment. As shown, a first ambient condition is metered, using a camera module, for a first ambient frame. See operation 102. In the context of the present description, a first ambient condition includes any non-flash condition and/or environment.

Additionally, in the context of the present description, a camera module includes any camera component which may be used, at least in part, to take a photo and/or video. For example, an image sensor may be integrated with control electronics and/or circuitry to enable the capture of an image, any of and all of which may be construed as some aspect of the camera module.

Still yet, in the context of the present description, metering (e.g. with respect to a first ambient condition or a first flash condition) includes determining the amount of brightness of an image or a part of an image. In some embodiments, metering may include determining a shutter speed, an aperture, an ISO speed, a white balance (e.g. color), etc. In another embodiment, metering may occur based on the camera or by at least one second device, including but not limited to, a second camera, a light meter, a smart phone, etc. Of course, in certain embodiments, the camera module may determine exposure parameters for the photographic scene, such as in response to metering a scene.

As shown, a first ambient capture time is determined based on the metering of the first ambient condition. See operation 104. In one embodiment, the first ambient capture time may be correlated with or constrained to a shutter speed, an exposure, an aperture, a film speed (sensor sensitivity), etc. For example, based on the metering of the first ambient condition, it may be determined that a film speed of ISO 100 with an aperture of f/11 with a time exposure of 1/200 seconds is ideal for the ambient conditions.

Additionally, a first flash condition is metered, using the camera module (one of different camera modules configured to operate in conjunction with the camera module), for a first flash frame. See operation 106. In one embodiment, more than one metering may occur. For example, a first metering (e.g. as shown in operation 102) may be accomplished for an ambient image, and a second metering (e.g. as shown in operation 106) may be accomplished for a flash image. In one embodiment the first metering may include multiple different metering samples using different exposure parameters leading to the ambient metering. Furthermore, the second metering may include multiple different metering samples at different flash intensity levels leading to the flash metering. Of course, however, other metering may occur, including, but not limited to, a pre-metering operation (e.g. pre-flash or flash metering, through-the-lens (“TTL”) metering, automatic-TTL metering, etc.), a repetitive metering operation (e.g. multiple flash metering, etc.), etc. In one embodiment, metering may be dependent on the focus point, an amount of time (e.g. between a pre-flash metering and the capture of the image), a number of focus points, etc.

Next, a first flash capture time is determined based on the metering of the first flash condition. See operation 108. In one embodiment, the first flash capture time may be correlated with a shutter speed, an exposure, an aperture, a film speed, etc. For example, based on the metering of the first ambient condition, it may be determined that a film speed of ISO 800 with an aperture of f/1.8 with a time exposure of 1/60 seconds is ideal for the flash conditions. Further, in one embodiment, sampling parameters such as exposure parameter and flash or strobe parameters (e.g. which may contain strobe intensity and strobe color, etc.) may be determined as part of or constrained by the first ambient capture time or the first flash capture time.

In one embodiment, a distance between the camera or the flash, and the focus subject may be included as part of determining the first flash capture time and/or other exposure parameter, such as flash intensity. For example, a distance to a focus subject may influence parameters including aperture, exposure, flash duration, etc. such that the parameters may inherently include a distance from the camera or the flash to the focus subject. For example, a focus subject farther away may have a corresponding greater intensity (or duration) flash to account for such distance. In another embodiment, the distance to a focus subject may be calculated and determined, and such a distance may be retained (and potentially manipulated) to control exposure and/or camera parameters. For example, in one embodiment, a subject focus point may change position. In such an embodiment, the distance may be updated (e.g. via a pre-flash sample, via a manual input of distance, via object tracking and/or focus updates, etc.) and as a result of such an update, camera parameters (e.g. aperture, exposure, flash duration, etc.) may be updated accordingly.

Additionally, using a rolling shutter image sensor within the camera module, a first ambient frame is captured based on the first ambient capture time, and after capturing the first ambient frame, a flash circuit is enabled during an active period and using the rolling shutter image sensor, a first flash frame is captured based on a combination of the first ambient capture time and the first flash capture time. See operation 110. Further, a final image is generated based on the first ambient frame and the first flash frame. See operation 112. In one embodiment, a first line reset may commence the first ambient capture time, and after a certain point, flash may be enabled for the first flash capture time, after which, a first line scan-out may occur to capture the resulting image. After the first line scan-out, then the line may be reset for additional potential captures. In such an embodiment, metering information from the first ambient capture time may be directly used during the first flash capture time to improve color accuracy in the resulting captured image.

Of course, it can be appreciated that although the foregoing embodiment describes using a rolling shutter image sensor, similar methods and techniques may be applied also using a global shutter image sensor.

In one embodiment, at the conclusion of the first ambient capture time, a first line scan-out may occur to capture a resulting ambient image, and at the conclusion of the first flash capture time, a second line scan-out may occur to capture a resulting flash image. However, in such an embodiment, the first line reset would still not occur until the first ambient capture time and the second line scan-out have occurred (in aggregation). A given line scan-out can include a method or process of scanning out a set of lines comprising an image frame. The lines can be scanned out one or more at a time, with analog values of a given line being quantized by one or more analog-to-digital converters to generate a scanned out digital image.

In another embodiment, a first flash capture time may precede a first ambient capture time. In such an embodiment, a first line scan-out may occur at the conclusion of a first flash capture time, and a second line scan-out may occur at the conclusion of the first ambient capture.

In one embodiment, metering a first ambient condition may include identifying a white balance, and metering a first flash condition may include identifying multiple points of interest. In another embodiment, metering the first flash condition may include a pre-metering capture. Additionally, metering the first ambient condition may result in a first set of exposure parameters and the metering the first flash condition may result in a second set of exposure parameters.

Still yet, in one embodiment, an exposure time of the first flash condition may be less than an exposure time of the first ambient condition. Additionally, in one embodiment, metering the first flash condition may include determining one or more of a flash duration, a flash intensity, a flash color, an exposure time, and an ISO value. In one embodiment, two different ISO values are applied to sequentially scanned out frames; that is, a first ISO value is used to scan out a first frame (e.g. the ambient image) using a first analog gain for analog-to-digital conversion of the first frame, and a second ISO value is used to scan out the second frame (e.g., the flash image) using a second analog gain for the analog-to-digital conversion of the second frame.

In one embodiment, a second image may be captured based on the first ambient capture time, a third image may be captured based on the first flash capture time, and the second image and the third image may be blended to create a fourth image.

Additionally, in one embodiment, metering the first flash condition may include determining exposure parameters that satisfy an exposure goal. An exemplary exposure goal ensures that not more than a specified threshold (e.g. 5%) of over-exposed pixels is contained within the first image. Further, the exposure goal may provide a limit on the number of over-exposed pixels within the first image. Still yet, the exposure goal may include a set intensity goal including a range of goal values or a fixed goal value. For example, in one embodiment, a goal value may include a ceiling of maximum percentage of overexposed pixels allowed within a given frame (e.g. a scene, a point of interest, etc.). One exemplary exposure goal for the ambient image may be for the mid-range intensity value for the image (e.g. 0.5 in a 0.0 to 1.0 range) to also be the median pixel intensity value for the image (e.g., “proper” exposure). One exemplary exposure goal for the flash image may be for a number of additional over-exposed pixels relative to the ambient image to not exceed a specified threshold (e.g., not add more than 5% over exposed pixels). This exemplary exposure goal may attempt to reduce overall reflective and/or specular flash back for the flash image.

Moreover, in various embodiments, the exposure goal may bound the portion of over-exposed pixels associated with the metering of the first flash condition to the portion of over-exposed pixels associated with the metering of the first ambient condition. Further, the exposure goal may be associated with a point of interest.

In one embodiment, the first flash condition may determine a flash intensity, where the flash intensity may be used to control over-exposed pixels or may be used to satisfy an exposure goal. Additionally, the flash intensity may be based on the metering of the first ambient condition and a distance to a flash point of interest.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

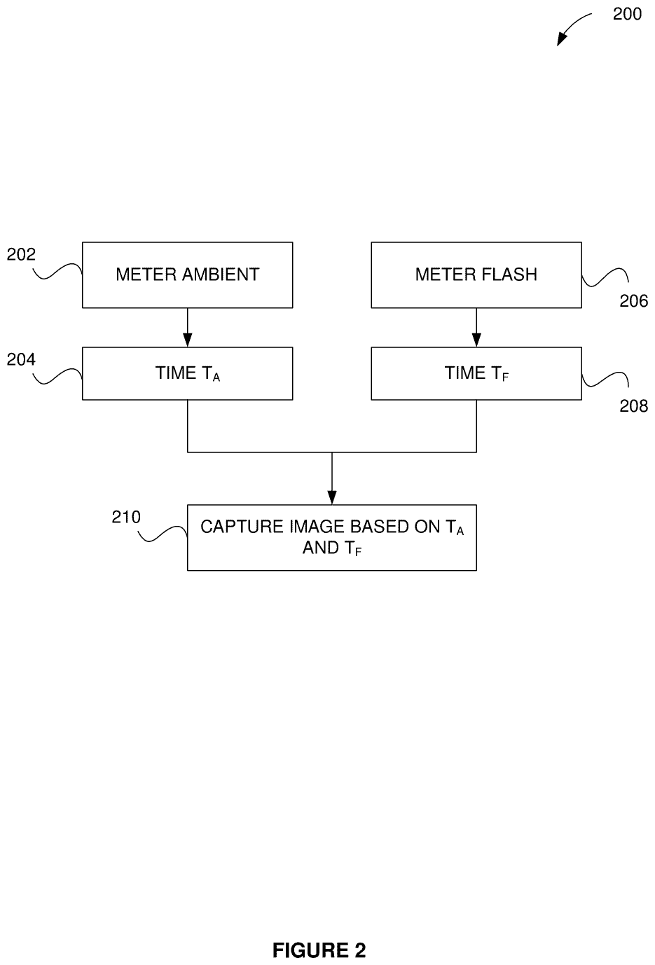

FIG. 2 illustrates a method 200 for capturing an image based on an ambient capture time and a flash capture time, in accordance with one embodiment. As an option, the method 200 may be implemented in the context of any one or more of the embodiments set forth in any previous and/or subsequent figure(s) and/or description thereof. Of course, however, the method 200 may be implemented in the context of any desired environment. In particular, method 200 may be implemented in the context of at least operation 110 of method 100. Further, the aforementioned definitions may equally apply to the description below.

As shown, a meter ambient 202 leads to ambient time (ambient capture time) T_{A} 204, and meter flash 206 leads to flash time (flash capture time) T_{F} 208, after which the combination of ambient time T_{A} 204 and flash time T_{F} 208 lead to operation 210 where an image is captured based on T_{A} 204 and T_{F} 208.

In one embodiment, ambient time T_{A} 204 and flash time T_{F} 208 may include a specific time (e.g. associated with an ambient condition or a flash condition respectively). In other embodiments, ambient time T_{A} 204 and flash time T_{F} 208 may each include information other than time, including, but not limited to, subject focus information (e.g. pixel coordinate for object, etc.), color information (e.g. white-balance, film color, etc.), device information (e.g. metering device information, camera metadata, etc.), parameters (e.g. aperture, film speed, etc.), and/or any other data which may be associated in some manner with a result of meter ambient 202 and/or meter flash 206. In this manner, therefore, the captured image (e.g. as indicated in operation 210) may incorporate overlap of information and time for ambient and flash conditions.

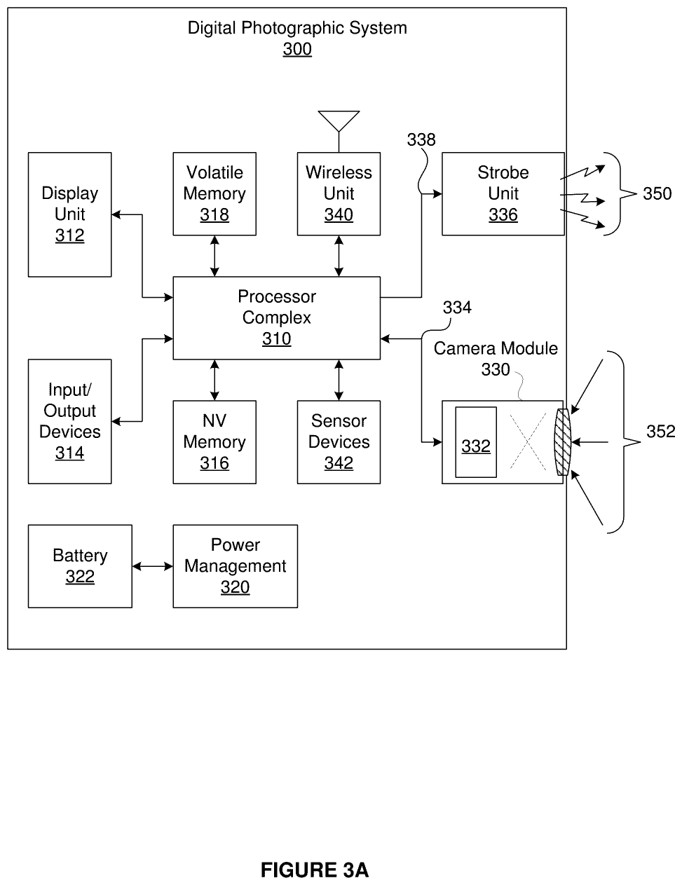

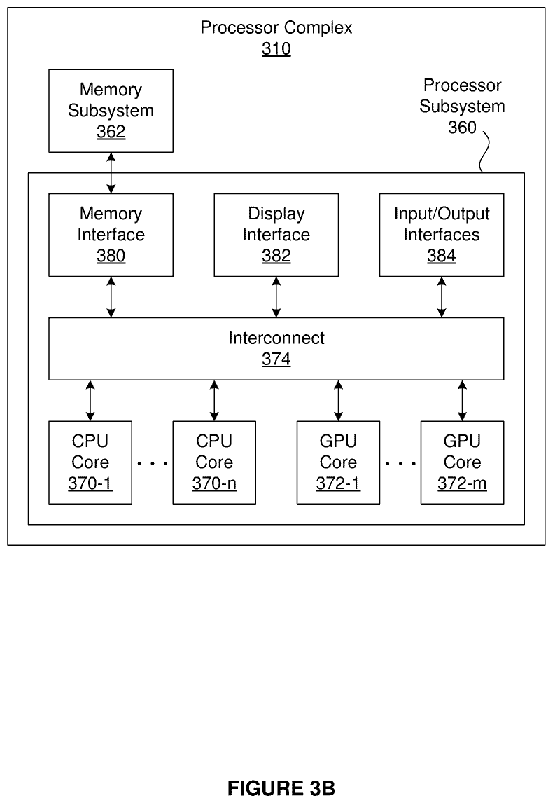

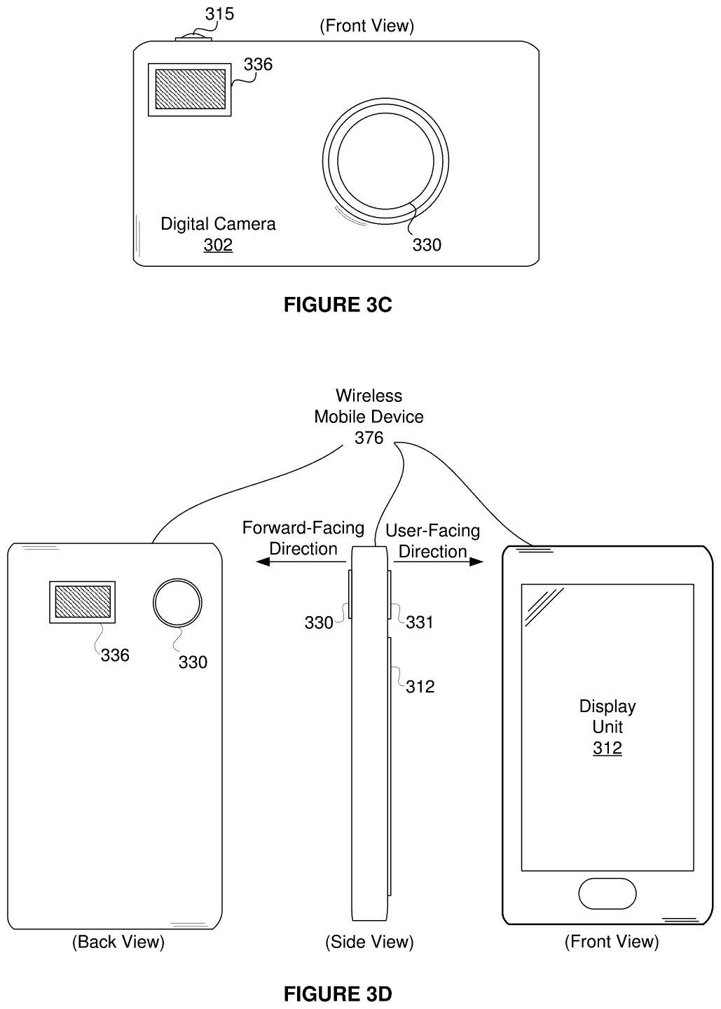

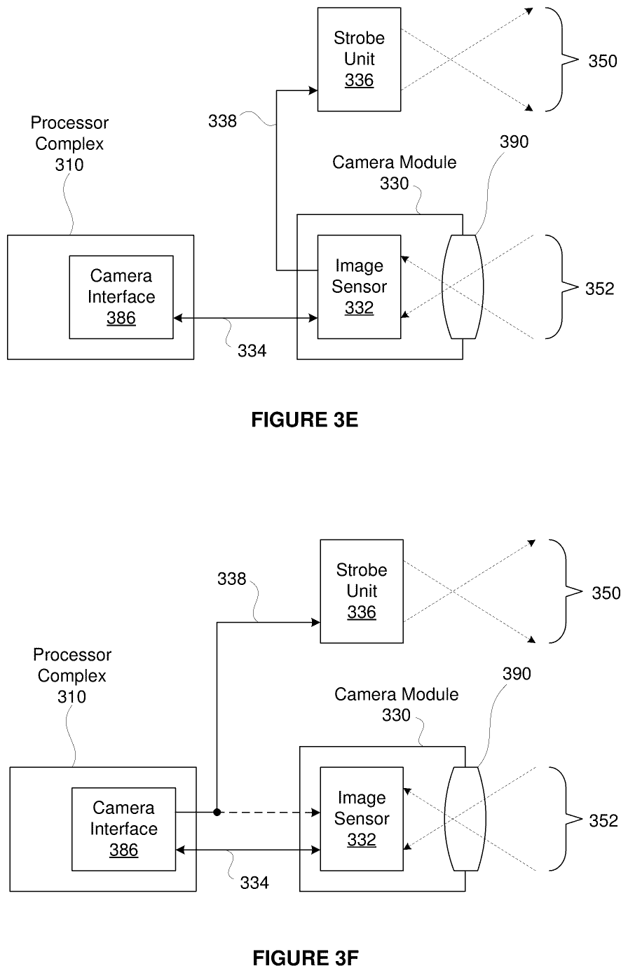

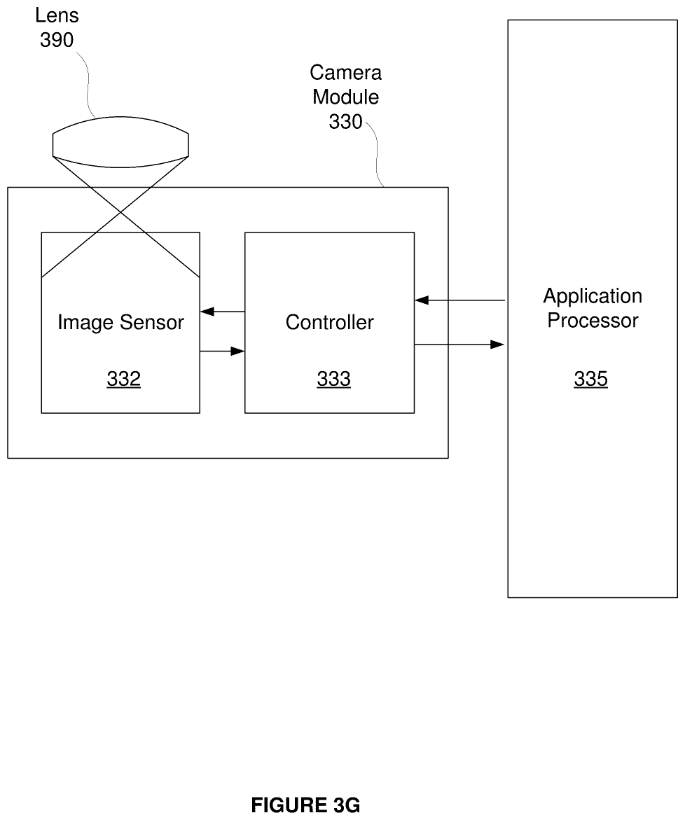

FIG. 3A illustrates a digital photographic system 300, in accordance with one embodiment. As an option, the digital photographic system 300 may be implemented in the context of the details of any of the Figures disclosed herein. Of course, however, the digital photographic system 300 may be implemented in any desired environment. Further, the aforementioned definitions may equally apply to the description below.

As shown, the digital photographic system 300 may include a processor complex 310 coupled to a camera module 330 via an interconnect 334. In one embodiment, the processor complex 310 is coupled to a strobe unit 336. The digital photographic system 300 may also include, without limitation, a display unit 312, a set of input/output devices 314, non-volatile memory 316, volatile memory 318, a wireless unit 340, and sensor devices 342, each coupled to the processor complex 310. In one embodiment, a power management subsystem 320 is configured to generate appropriate power supply voltages for each electrical load element within the digital photographic system 300. A battery 322 may be configured to supply electrical energy to the power management subsystem 320. The battery 322 may implement any technically feasible energy storage system, including primary or rechargeable battery technologies. Of course, in other embodiments, additional or fewer features, units, devices, sensors, or subsystems may be included in the system.

In one embodiment, a strobe unit 336 may be integrated into the digital photographic system 300 and configured to provide strobe illumination 350 during an image sample event performed by the digital photographic system 300. In another embodiment, a strobe unit 336 may be implemented as an independent device from the digital photographic system 300 and configured to provide strobe illumination 350 during an image sample event performed by the digital photographic system 300. The strobe unit 336 may comprise one or more LED devices, a gas-discharge illuminator (e.g. a Xenon strobe device, a Xenon flash lamp, etc.), or any other technically feasible illumination device. In certain embodiments, two or more strobe units are configured to synchronously generate strobe illumination in conjunction with sampling an image. In one embodiment, the strobe unit 336 is controlled through a strobe control signal 338 to either emit the strobe illumination 350 or not emit the strobe illumination 350. The strobe control signal 338 may be implemented using any technically feasible signal transmission protocol. The strobe control signal 338 may indicate a strobe parameter (e.g. strobe intensity, strobe color, strobe time, etc.), for directing the strobe unit 336 to generate a specified intensity and/or color of the strobe illumination 350. The strobe control signal 338 may be generated by the processor complex 310, the camera module 330, or by any other technically feasible combination thereof. In one embodiment, the strobe control signal 338 is generated by a camera interface unit within the processor complex 310 and transmitted to both the strobe unit 336 and the camera module 330 via the interconnect 334. In another embodiment, the strobe control signal 338 is generated by the camera module 330 and transmitted to the strobe unit 336 via the interconnect 334.

Optical scene information 352, which may include at least a portion of the strobe illumination 350 reflected from objects in the photographic scene, is focused as an optical image onto an image sensor 332 within the camera module 330. The image sensor 332 generates an electronic representation of the optical image. The electronic representation comprises spatial color intensity information, which may include different color intensity samples (e.g. red, green, and blue light, etc.). In other embodiments, the spatial color intensity information may also include samples for white light. The electronic representation is transmitted to the processor complex 310 via the interconnect 334, which may implement any technically feasible signal transmission protocol.

In one embodiment, input/output devices 314 may include, without limitation, a capacitive touch input surface, a resistive tablet input surface, one or more buttons, one or more knobs, light-emitting devices, light detecting devices, sound emitting devices, sound detecting devices, or any other technically feasible device for receiving user input and converting the input to electrical signals, or converting electrical signals into a physical signal. In one embodiment, the input/output devices 314 include a capacitive touch input surface coupled to a display unit 312. A touch entry display system may include the display unit 312 and a capacitive touch input surface, also coupled to processor complex 310.

Additionally, in other embodiments, non-volatile (NV) memory 316 is configured to store data when power is interrupted. In one embodiment, the NV memory 316 comprises one or more flash memory devices (e.g. ROM, PCM, FeRAM, FRAM, PRAM, MRAM, NRAM, etc.). The NV memory 316 comprises a non-transitory computer-readable medium, which may be configured to include programming instructions for execution by one or more processing units within the processor complex 310. The programming instructions may implement, without limitation, an operating system (OS), UI software modules, image processing and storage software modules, one or more input/output devices 314 connected to the processor complex 310, one or more software modules for sampling an image stack through camera module 330, one or more software modules for presenting the image stack or one or more synthetic images generated from the image stack through the display unit 312. As an example, in one embodiment, the programming instructions may also implement one or more software modules for merging images or portions of images within the image stack, aligning at least portions of each image within the image stack, or a combination thereof. In another embodiment, the processor complex 310 may be configured to execute the programming instructions, which may implement one or more software modules operable to create a high dynamic range (HDR) image.

Still yet, in one embodiment, one or more memory devices comprising the NV memory 316 may be packaged as a module configured to be installed or removed by a user. In one embodiment, volatile memory 318 comprises dynamic random access memory (DRAM) configured to temporarily store programming instructions, image data such as data associated with an image stack, and the like, accessed during the course of normal operation of the digital photographic system 300. Of course, the volatile memory may be used in any manner and in association with any other input/output device 314 or sensor device 342 attached to the process complex 310.

In one embodiment, sensor devices 342 may include, without limitation, one or more of an accelerometer to detect motion and/or orientation, an electronic gyroscope to detect motion and/or orientation, a magnetic flux detector to detect orientation, a global positioning system (GPS) module to detect geographic position, or any combination thereof. Of course, other sensors, including but not limited to a motion detection sensor, a proximity sensor, an RGB light sensor, a gesture sensor, a 3-D input image sensor, a pressure sensor, and an indoor position sensor, may be integrated as sensor devices. In one embodiment, the sensor devices may be one example of input/output devices 314.

Wireless unit 340 may include one or more digital radios configured to send and receive digital data. In particular, the wireless unit 340 may implement wireless standards (e.g. WiFi, Bluetooth, NFC, etc.), and may implement digital cellular telephony standards for data communication (e.g. CDMA, 3G, 4G, LTE, LTE-Advanced, etc.). Of course, any wireless standard or digital cellular telephony standards may be used.

In one embodiment, the digital photographic system 300 is configured to transmit one or more digital photographs to a network-based (online) or “cloud-based” photographic media service via the wireless unit 340. The one or more digital photographs may reside within either the NV memory 316 or the volatile memory 318, or any other memory device associated with the processor complex 310. In one embodiment, a user may possess credentials to access an online photographic media service and to transmit one or more digital photographs for storage to, retrieval from, and presentation by the online photographic media service. The credentials may be stored or generated within the digital photographic system 300 prior to transmission of the digital photographs. The online photographic media service may comprise a social networking service, photograph sharing service, or any other network-based service that provides storage of digital photographs, processing of digital photographs, transmission of digital photographs, sharing of digital photographs, or any combination thereof. In certain embodiments, one or more digital photographs are generated by the online photographic media service based on image data (e.g. image stack, HDR image stack, image package, etc.) transmitted to servers associated with the online photographic media service. In such embodiments, a user may upload one or more source images from the digital photographic system 300 for processing by the online photographic media service.

In one embodiment, the digital photographic system 300 comprises at least one instance of a camera module 330. In another embodiment, the digital photographic system 300 comprises a plurality of camera modules 330. Such an embodiment may also include at least one strobe unit 336 configured to illuminate a photographic scene, sampled as multiple views by the plurality of camera modules 330. The plurality of camera modules 330 may be configured to sample a wide angle view (e.g., greater than forty-five degrees of sweep among cameras) to generate a panoramic photograph. In one embodiment, a plurality of camera modules 330 may be configured to sample two or more narrow angle views (e.g., less than forty-five degrees of sweep among cameras) to generate a stereoscopic photograph. In other embodiments, a plurality of camera modules 330 may be configured to generate a 3-D image or to otherwise display a depth perspective (e.g. a z-component, etc.) as shown on the display unit 312 or any other display device.

In one embodiment, a display unit 312 may be configured to display a two-dimensional array of pixels to form an image for display. The display unit 312 may comprise a liquid-crystal (LCD) display, a light-emitting diode (LED) display, an organic LED display, or any other technically feasible type of display. In certain embodiments, the display unit 312 may be able to display a narrower dynamic range of image intensity values than a complete range of intensity values sampled from a photographic scene, such as within a single HDR image or over a set of two or more images comprising a multiple exposure or HDR image stack. In one embodiment, images comprising an image stack may be merged according to any technically feasible HDR blending technique to generate a synthetic image for display within dynamic range constraints of the display unit 312. In one embodiment, the limited dynamic range may specify an eight-bit per color channel binary representation of corresponding color intensities. In other embodiments, the limited dynamic range may specify more than eight-bits (e.g., 10 bits, 12 bits, or 14 bits, etc.) per color channel binary representation.

FIG. 3B illustrates a processor complex 310 within the digital photographic system 300 of FIG. 3A, in accordance with one embodiment. As an option, the processor complex 310 may be implemented in the context of the details of any of the Figures disclosed herein. Of course, however, the processor complex 310 may be implemented in any desired environment. Further, the aforementioned definitions may equally apply to the description below.

As shown, the processor complex 310 includes a processor subsystem 360 and may include a memory subsystem 362. In one embodiment, processor complex 310 may comprise a system on a chip (SoC) device that implements processor subsystem 360, and memory subsystem 362 comprises one or more DRAM devices coupled to the processor subsystem 360. In another embodiment, the processor complex 310 may comprise a multi-chip module (MCM) encapsulating the SoC device and the one or more DRAM devices comprising the memory subsystem 362.

The processor subsystem 360 may include, without limitation, one or more central processing unit (CPU) cores 370, a memory interface 380, input/output interfaces unit 384, and a display interface unit 382, each coupled to an interconnect 374. The one or more CPU cores 370 may be configured to execute instructions residing within the memory subsystem 362, volatile memory 318, NV memory 316, or any combination thereof. Each of the one or more CPU cores 370 may be configured to retrieve and store data through interconnect 374 and the memory interface 380. In one embodiment, each of the one or more CPU cores 370 may include a data cache, and an instruction cache. Additionally, two or more of the CPU cores 370 may share a data cache, an instruction cache, or any combination thereof. In one embodiment, a cache hierarchy is implemented to provide each CPU core 370 with a private cache layer, and a shared cache layer.

In some embodiments, processor subsystem 360 may include one or more graphics processing unit (GPU) cores 372. Each GPU core 372 may comprise a plurality of multi-threaded execution units that may be programmed to implement, without limitation, graphics acceleration functions. In various embodiments, the GPU cores 372 may be configured to execute multiple thread programs according to well-known standards (e.g. OpenGL™, WebGL™, OpenCL™, CUDA™, etc.), and/or any other programmable rendering graphic standard. In certain embodiments, at least one GPU core 372 implements at least a portion of a motion estimation function, such as a well-known Harris detector or a well-known Hessian-Laplace detector. Such a motion estimation function may be used at least in part to align images or portions of images within an image stack. For example, in one embodiment, an HDR image may be compiled based on an image stack, where two or more images are first aligned prior to compiling the HDR image.

As shown, the interconnect 374 is configured to transmit data between and among the memory interface 380, the display interface unit 382, the input/output interfaces unit 384, the CPU cores 370, and the GPU cores 372. In various embodiments, the interconnect 374 may implement one or more buses, one or more rings, a cross-bar, a mesh, or any other technically feasible data transmission structure or technique. The memory interface 380 is configured to couple the memory subsystem 362 to the interconnect 374. The memory interface 380 may also couple NV memory 316, volatile memory 318, or any combination thereof to the interconnect 374. The display interface unit 382 may be configured to couple a display unit 312 to the interconnect 374. The display interface unit 382 may implement certain frame buffer functions (e.g. frame refresh, etc.). Alternatively, in another embodiment, the display unit 312 may implement certain frame buffer functions (e.g. frame refresh, etc.). The input/output interfaces unit 384 may be configured to couple various input/output devices to the interconnect 374.

In certain embodiments, a camera module 330 is configured to store exposure parameters for sampling each image associated with an image stack. For example, in one embodiment, when directed to sample a photographic scene, the camera module 330 may sample a set of images comprising the image stack according to stored exposure parameters. A software module comprising programming instructions executing within a processor complex 310 may generate and store the exposure parameters prior to directing the camera module 330 to sample the image stack. In other embodiments, the camera module 330 may be used to meter an image or an image stack, and the software module comprising programming instructions executing within a processor complex 310 may generate and store metering parameters prior to directing the camera module 330 to capture the image. Of course, the camera module 330 may be used in any manner in combination with the processor complex 310.

In one embodiment, exposure parameters associated with images comprising the image stack may be stored within an exposure parameter data structure that includes exposure parameters for one or more images. In another embodiment, a camera interface unit (not shown in FIG. 3B) within the processor complex 310 may be configured to read exposure parameters from the exposure parameter data structure and to transmit associated exposure parameters to the camera module 330 in preparation of sampling a photographic scene. After the camera module 330 is configured according to the exposure parameters, the camera interface may direct the camera module 330 to sample the photographic scene; the camera module 330 may then generate a corresponding image stack. The exposure parameter data structure may be stored within the camera interface unit, a memory circuit within the processor complex 310, volatile memory 318, NV memory 316, the camera module 330, or within any other technically feasible memory circuit. Further, in another embodiment, a software module executing within processor complex 310 may generate and store the exposure parameter data structure.

FIG. 3C illustrates a digital camera 302, in accordance with one embodiment. As an option, the digital camera 302 may be implemented in the context of the details of any of the Figures disclosed herein. Of course, however, the digital camera 302 may be implemented in any desired environment. Further, the aforementioned definitions may equally apply to the description below.

In one embodiment, the digital camera 302 may be configured to include a digital photographic system, such as digital photographic system 300 of FIG. 3A. As shown, the digital camera 302 includes a camera module 330, which may include optical elements configured to focus optical scene information representing a photographic scene onto an image sensor, which may be configured to convert the optical scene information to an electronic representation of the photographic scene.

Additionally, the digital camera 302 may include a strobe unit 336, and may include a shutter release button 315 for triggering a photographic sample event, whereby digital camera 302 samples one or more images comprising the electronic representation. In other embodiments, any other technically feasible shutter release mechanism may trigger the photographic sample event (e.g. such as a timer trigger or remote control trigger, etc.).

FIG. 3D illustrates a wireless mobile device 376, in accordance with one embodiment. As an option, the mobile device 376 may be implemented in the context of the details of any of the Figures disclosed herein. Of course, however, the mobile device 376 may be implemented in any desired environment. Further, the aforementioned definitions may equally apply to the description below.

In one embodiment, the mobile device 376 may be configured to include a digital photographic system (e.g. such as digital photographic system 300 of FIG. 3A), which is configured to sample a photographic scene. In various embodiments, a camera module 330 may include optical elements configured to focus optical scene information representing the photographic scene onto an image sensor, which may be configured to convert the optical scene information to an electronic representation of the photographic scene. Further, a shutter release command may be generated through any technically feasible mechanism, such as a virtual button, which may be activated by a touch gesture on a touch entry display system comprising display unit 312, or a physical button, which may be located on any face or surface of the mobile device 376. Of course, in other embodiments, any number of other buttons, external inputs/outputs, or digital inputs/outputs may be included on the mobile device 376, and which may be used in conjunction with the camera module 330.

As shown, in one embodiment, a touch entry display system comprising display unit 312 is disposed on the opposite side of mobile device 376 from camera module 330. In certain embodiments, the mobile device 376 includes a user-facing camera module 331 and may include a user-facing strobe unit (not shown). Of course, in other embodiments, the mobile device 376 may include any number of user-facing camera modules or rear-facing camera modules, as well as any number of user-facing strobe units or rear-facing strobe units.

In some embodiments, the digital camera 302 and the mobile device 376 may each generate and store a synthetic image based on an image stack sampled by camera module 330. The image stack may include one or more images sampled under ambient lighting conditions, one or more images sampled under strobe illumination from strobe unit 336, or a combination thereof.

FIG. 3E illustrates camera module 330, in accordance with one embodiment. As an option, the camera module 330 may be implemented in the context of the details of any of the Figures disclosed herein. Of course, however, the camera module 330 may be implemented in any desired environment. Further, the aforementioned definitions may equally apply to the description below.

In one embodiment, the camera module 330 may be configured to control strobe unit 336 through strobe control signal 338. As shown, a lens 390 is configured to focus optical scene information 352 onto image sensor 332 to be sampled. In one embodiment, image sensor 332 advantageously controls detailed timing of the strobe unit 336 though the strobe control signal 338 to reduce inter-sample time between an image sampled with the strobe unit 336 enabled, and an image sampled with the strobe unit 336 disabled. For example, the image sensor 332 may enable the strobe unit 336 to emit strobe illumination 350 less than one microsecond (or any desired length) after image sensor 332 completes an exposure time associated with sampling an ambient image and prior to sampling a strobe image.

In other embodiments, the strobe illumination 350 may be configured based on a desired one or more target points. For example, in one embodiment, the strobe illumination 350 may light up an object in the foreground, and depending on the length of exposure time, may also light up an object in the background of the image. In one embodiment, once the strobe unit 336 is enabled, the image sensor 332 may then immediately begin exposing a strobe image. The image sensor 332 may thus be able to directly control sampling operations, including enabling and disabling the strobe unit 336 associated with generating an image stack, which may comprise at least one image sampled with the strobe unit 336 disabled, and at least one image sampled with the strobe unit 336 either enabled or disabled. In one embodiment, data comprising the image stack sampled by the image sensor 332 is transmitted via interconnect 334 to a camera interface unit 386 within processor complex 310. In some embodiments, the camera module 330 may include an image sensor controller (e.g., controller 333 of FIG. 3G), which may be configured to generate the strobe control signal 338 in conjunction with controlling operation of the image sensor 332.

FIG. 3F illustrates a camera module 330, in accordance with one embodiment. As an option, the camera module 330 may be implemented in the context of the details of any of the Figures disclosed herein. Of course, however, the camera module 330 may be implemented in any desired environment. Further, the aforementioned definitions may equally apply to the description below.

In one embodiment, the camera module 330 may be configured to sample an image based on state information for strobe unit 336. The state information may include, without limitation, one or more strobe parameters (e.g. strobe intensity, strobe color, strobe time, etc.), for directing the strobe unit 336 to generate a specified intensity and/or color of the strobe illumination 350. In one embodiment, commands for configuring the state information associated with the strobe unit 336 may be transmitted through a strobe control signal 338, which may be monitored by the camera module 330 to detect when the strobe unit 336 is enabled. For example, in one embodiment, the camera module 330 may detect when the strobe unit 336 is enabled or disabled within a microsecond or less of the strobe unit 336 being enabled or disabled by the strobe control signal 338. To sample an image requiring strobe illumination, a camera interface unit 386 may enable the strobe unit 336 by sending an enable command through the strobe control signal 338. In one embodiment, the camera interface unit 386 may be included as an interface of input/output interfaces 384 in a processor subsystem 360 of the processor complex 310 of FIG. 3B. The enable command may comprise a signal level transition, a data packet, a register write, or any other technically feasible transmission of a command. The camera module 330 may sense that the strobe unit 336 is enabled and then cause image sensor 332 to sample one or more images requiring strobe illumination while the strobe unit 336 is enabled. In such an implementation, the image sensor 332 may be configured to wait for an enable signal destined for the strobe unit 336 as a trigger signal to begin sampling a new exposure.

In one embodiment, camera interface unit 386 may transmit exposure parameters and commands to camera module 330 through interconnect 334. In certain embodiments, the camera interface unit 386 may be configured to directly control strobe unit 336 by transmitting control commands to the strobe unit 336 through strobe control signal 338. By directly controlling both the camera module 330 and the strobe unit 336, the camera interface unit 386 may cause the camera module 330 and the strobe unit 336 to perform their respective operations in precise time synchronization. In one embodiment, precise time synchronization may be less than five hundred microseconds of event timing error. Additionally, event timing error may be a difference in time from an intended event occurrence to the time of a corresponding actual event occurrence.

In another embodiment, camera interface unit 386 may be configured to accumulate statistics while receiving image data from camera module 330. In particular, the camera interface unit 386 may accumulate exposure statistics for a given image while receiving image data for the image through interconnect 334. Exposure statistics may include, without limitation, one or more of an intensity histogram, a count of over-exposed pixels, a count of under-exposed pixels, an intensity-weighted sum of pixel intensity, or any combination thereof. The camera interface unit 386 may present the exposure statistics as memory-mapped storage locations within a physical or virtual address space defined by a processor, such as one or more of CPU cores 370, within processor complex 310. In one embodiment, exposure statistics reside in storage circuits that are mapped into a memory-mapped register space, which may be accessed through the interconnect 334. In other embodiments, the exposure statistics are transmitted in conjunction with transmitting pixel data for a captured image. For example, the exposure statistics for a given image may be transmitted as in-line data, following transmission of pixel intensity data for the captured image. Exposure statistics may be calculated, stored, or cached within the camera interface unit 386. In other embodiments, an image sensor controller within camera module 330 may be configured to accumulate the exposure statistics and transmit the exposure statistics to processor complex 310, such as by way of camera interface unit 386. In one embodiment, the exposure statistics are accumulated within the camera module 330 and transmitted to the camera interface unit 386, either in conjunction with transmitting image data to the camera interface unit 386, or separately from transmitting image data.

In one embodiment, camera interface unit 386 may accumulate color statistics for estimating scene white-balance. Any technically feasible color statistics may be accumulated for estimating white balance, such as a sum of intensities for different color channels comprising red, green, and blue color channels. The sum of color channel intensities may then be used to perform a white-balance color correction on an associated image, according to a white-balance model such as a gray-world white-balance model. In other embodiments, curve-fitting statistics are accumulated for a linear or a quadratic curve fit used for implementing white-balance correction on an image. As with the exposure statistics, the color statistics may be presented as memory-mapped storage locations within processor complex 310. In one embodiment, the color statistics may be mapped in a memory-mapped register space, which may be accessed through interconnect 334. In other embodiments, the color statistics may be transmitted in conjunction with transmitting pixel data for a captured image. For example, in one embodiment, the color statistics for a given image may be transmitted as in-line data, following transmission of pixel intensity data for the image. Color statistics may be calculated, stored, or cached within the camera interface 386. In other embodiments, the image sensor controller within camera module 330 may be configured to accumulate the color statistics and transmit the color statistics to processor complex 310, such as by way of camera interface unit 386. In one embodiment, the color statistics may be accumulated within the camera module 330 and transmitted to the camera interface unit 386, either in conjunction with transmitting image data to the camera interface unit 386, or separately from transmitting image data.

In one embodiment, camera interface unit 386 may accumulate spatial color statistics for performing color-matching between or among images, such as between or among an ambient image and one or more images sampled with strobe illumination. As with the exposure statistics, the spatial color statistics may be presented as memory-mapped storage locations within processor complex 310. In one embodiment, the spatial color statistics are mapped in a memory-mapped register space. In another embodiment the camera module may be configured to accumulate the spatial color statistics, which may be accessed through interconnect 334. In other embodiments, the color statistics may be transmitted in conjunction with transmitting pixel data for a captured image. For example, in one embodiment, the color statistics for a given image may be transmitted as in-line data, following transmission of pixel intensity data for the image. Color statistics may be calculated, stored, or cached within the camera interface 386.

In one embodiment, camera module 330 may transmit strobe control signal 338 to strobe unit 336, enabling the strobe unit 336 to generate illumination while the camera module 330 is sampling an image. In another embodiment, camera module 330 may sample an image illuminated by strobe unit 336 upon receiving an indication signal from camera interface unit 386 that the strobe unit 336 is enabled. In yet another embodiment, camera module 330 may sample an image illuminated by strobe unit 336 upon detecting strobe illumination within a photographic scene via a rapid rise in scene illumination. In one embodiment, a rapid rise in scene illumination may include at least a rate of increasing intensity consistent with that of enabling strobe unit 336. In still yet another embodiment, camera module 330 may enable strobe unit 336 to generate strobe illumination while sampling one image, and disable the strobe unit 336 while sampling a different image.

FIG. 3G illustrates camera module 330, in accordance with one embodiment. As an option, the camera module 330 may be implemented in the context of the details of any of the Figures disclosed herein. Of course, however, the camera module 330 may be implemented in any desired environment. Further, the aforementioned definitions may equally apply to the description below.

In one embodiment, the camera module 330 may be in communication with an application processor 335. The camera module 330 is shown to include image sensor 332 in communication with a controller 333. Further, the controller 333 is shown to be in communication with the application processor 335.

In one embodiment, the application processor 335 may reside outside of the camera module 330. As shown, the lens 390 may be configured to focus optical scene information to be sampled onto image sensor 332. The optical scene information sampled by the image sensor 332 may then be communicated from the image sensor 332 to the controller 333 for at least one of subsequent processing and communication to the application processor 335. In another embodiment, the controller 333 may control storage of the optical scene information sampled by the image sensor 332, or storage of processed optical scene information.

In another embodiment, the controller 333 may enable a strobe unit to emit strobe illumination for a short time duration (e.g. less than ten milliseconds) after image sensor 332 completes an exposure time associated with sampling an ambient image. Further, the controller 333 may be configured to generate strobe control signal 338 in conjunction with controlling operation of the image sensor 332.

In one embodiment, the image sensor 332 may be a complementary metal oxide semiconductor (CMOS) sensor or a charge-coupled device (CCD) sensor. In another embodiment, the controller 333 and the image sensor 332 may be packaged together as an integrated system, multi-chip module, multi-chip stack, or integrated circuit. In yet another embodiment, the controller 333 and the image sensor 332 may comprise discrete packages. In one embodiment, the controller 333 may provide circuitry for receiving optical scene information from the image sensor 332, processing of the optical scene information, timing of various functionalities, and signaling associated with the application processor 335. Further, in another embodiment, the controller 333 may provide circuitry for control of one or more of exposure, shuttering, white balance, and gain adjustment. Processing of the optical scene information by the circuitry of the controller 333 may include one or more of gain application, amplification, and analog-to-digital conversion. After processing the optical scene information, the controller 333 may transmit corresponding digital pixel data, such as to the application processor 335.

In one embodiment, the application processor 335 may be implemented on processor complex 310 and at least one of volatile memory 318 and NV memory 316, or any other memory device and/or system. The application processor 335 may be previously configured for processing of received optical scene information or digital pixel data communicated from the camera module 330 to the application processor 335.

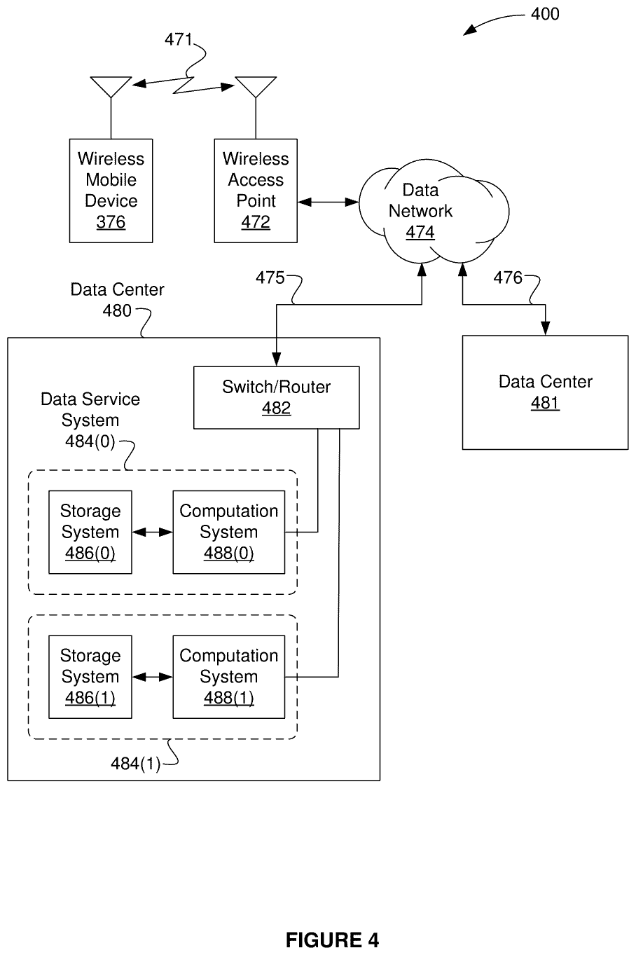

FIG. 4 illustrates a network service system 400, in accordance with one embodiment. As an option, the network service system 400 may be implemented in the context of the details of any of the Figures disclosed herein. Of course, however, the network service system 400 may be implemented in any desired environment. Further, the aforementioned definitions may equally apply to the description below.

In one embodiment, the network service system 400 may be configured to provide network access to a device implementing a digital photographic system. As shown, network service system 400 includes a wireless mobile device 376, a wireless access point 472, a data network 474, a data center 480, and a data center 481. The wireless mobile device 376 may communicate with the wireless access point 472 via a digital radio link 471 to send and receive digital data, including data associated with digital images. The wireless mobile device 376 and the wireless access point 472 may implement any technically feasible transmission techniques for transmitting digital data via digital radio link 471 without departing the scope and spirit of the present invention. In certain embodiments, one or more of data centers 480, 481 may be implemented using virtual constructs so that each system and subsystem within a given data center 480, 481 may comprise virtual machines configured to perform data processing and network data transmission tasks. In other implementations, one or more of data centers 480, 481 may be physically distributed over a plurality of physical sites.

The wireless mobile device 376 may comprise a smart phone configured to include a digital camera, a digital camera configured to include wireless network connectivity, a reality augmentation device, a laptop configured to include a digital camera and wireless network connectivity, or any other technically feasible computing device configured to include a digital photographic system and wireless network connectivity.

In various embodiments, the wireless access point 472 may be configured to communicate with wireless mobile device 376 via the digital radio link 471 and to communicate with the data network 474 via any technically feasible transmission media, such as any electrical, optical, or radio transmission media. For example, in one embodiment, wireless access point 472 may communicate with data network 474 through an optical fiber coupled to the wireless access point 472 and to a router system or a switch system within the data network 474. A network link 475, such as a wide area network (WAN) link, may be configured to transmit data between the data network 474 and the data center 480.

In one embodiment, the data network 474 may include routers, switches, long-haul transmission systems, provisioning systems, authorization systems, and any technically feasible combination of communications and operations subsystems configured to convey data between network endpoints, such as between the wireless access point 472 and the data center 480. In one implementation scenario, wireless mobile device 376 may comprise one of a plurality of wireless mobile devices configured to communicate with the data center 480 via one or more wireless access points coupled to the data network 474.

Additionally, in various embodiments, the data center 480 may include, without limitation, a switch/router 482 and at least one data service system 484. The switch/router 482 may be configured to forward data traffic between and among a network link 475, and each data service system 484. The switch/router 482 may implement any technically feasible transmission techniques, such as Ethernet media layer transmission, layer 2 switching, layer 3 routing, and the like. The switch/router 482 may comprise one or more individual systems configured to transmit data between the data service systems 484 and the data network 474.

In one embodiment, the switch/router 482 may implement session-level load balancing among a plurality of data service systems 484. Each data service system 484 may include at least one computation system 488 and may also include one or more storage systems 486. Each computation system 488 may comprise one or more processing units, such as a central processing unit, a graphics processing unit, or any combination thereof. A given data service system 484 may be implemented as a physical system comprising one or more physically distinct systems configured to operate together. Alternatively, a given data service system 484 may be implemented as a virtual system comprising one or more virtual systems executing on an arbitrary physical system. In certain scenarios, the data network 474 may be configured to transmit data between the data center 480 and another data center 481, such as through a network link 476.

In another embodiment, the network service system 400 may include any networked mobile devices configured to implement one or more embodiments of the present invention. For example, in some embodiments, a peer-to-peer network, such as an ad-hoc wireless network, may be established between two different wireless mobile devices. In such embodiments, digital image data may be transmitted between the two wireless mobile devices without having to send the digital image data to a data center 480.

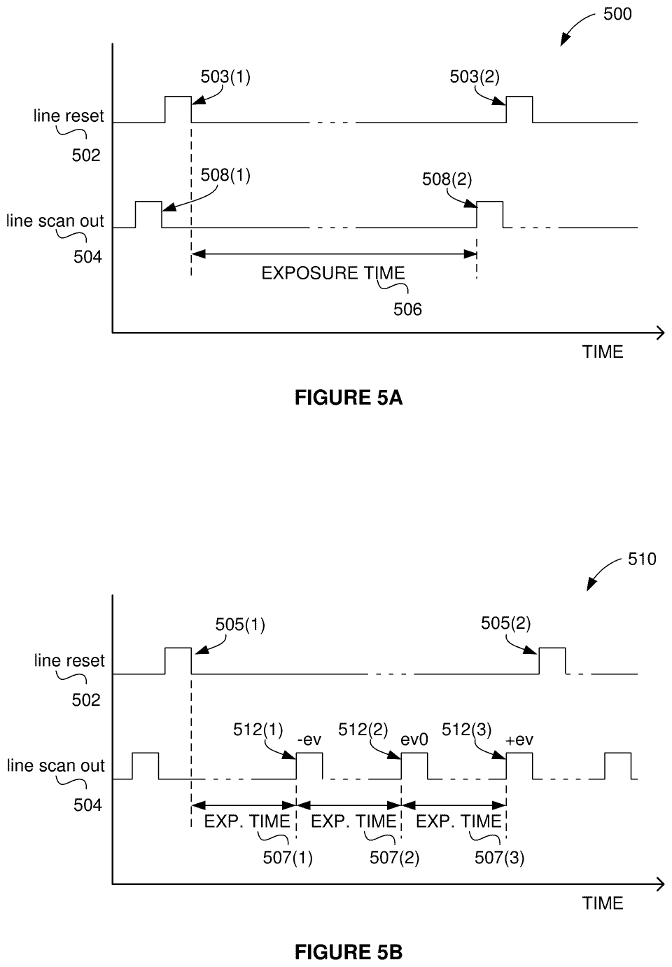

FIG. 5A illustrates a time graph 500 of line scan out and line reset for one capture associated with a rolling shutter, in accordance with one embodiment. As an option, signals depicted in the time graph 500 may be implemented in the context of any one or more of the embodiments set forth in any previous and/or subsequent figure(s) and/or description thereof. Of course, however, the time graph 500 may depict signals implemented in the context of any desired environment. Further, the aforementioned definitions may equally apply to the description below.

As shown in time graph 500, a line reset signal 502 indicates two line reset occurrences 503 of the same line (of pixels) within an image sensor. Of course, in various embodiments, any number of line resets may be included. For example, a number of line reset signals corresponding to the number of lines of pixels in the image sensor may be implemented within the image sensor. In one embodiment, one of the line reset signals may be asserted (depicted as a positive signal pulse) at a time to generate one corresponding line reset occurrence at a time. Further, a line scan out signal 504 indicates two line scan-out occurrences 508 of the line. As shown, an exposure time 506 begins after a line reset occurrence 503(1) has completed but before a line scan out occurrence 508(2) begins.

In one embodiment, a given line reset occurrence 503 correlates with a corresponding line scan-out occurrence 508. For example, a line scan-out occurrence 508(1) may be followed by a line reset occurrence 503(1). During operation, a line (of pixels) may be reset, then exposed during exposure time 506, then scanned out, and then reset again to maintain a given exposure in sequential frames. Of course, exposure parameters may change in sequential frames, such as to adapt to changing scene conditions.

FIG. 5B illustrates a time graph 510 of line scan out and line reset signals for capturing three frames having increasing exposure levels using a rolling shutter, in accordance with one embodiment. As an option, signals depicted in the time graph 510 may be implemented in the context of any one or more of the embodiments set forth in any previous and/or subsequent figure(s) and/or description thereof. Of course, however, the time graph 510 may depict signals implemented in the context of any desired environment. Further, the aforementioned definitions may equally apply to the description below.

As shown, line reset signal 502 indicates two line reset occurrences 505 on time graph 510. Further, a line scan out signal 504 includes three scan out occurrences including an underexposed (−ev) capture at scan out occurrence 512(1), a properly/normally exposed (ev 0) capture at scan out occurrence 512(2), and an over exposed (+ev) capture at scan out occurrence 512(3). Of course, in other embodiments, any number of scan out occurrences may be included to capture any combination of exposure levels. In time graph 510, the three scan out occurrences 512 may represent three different f/stop values, three different ISO values, in conjunction with scan out occurrences 512. Further, an exposure time 507 begins after a line reset occurrence 505(1) has completed but before a line scan out occurrence (e.g., 512(1)) begins. Exposure times 507 may be held constant between each capture (e.g., exposure time 507(1) is equal to exposure time 507(2), and so forth). Alternatively, exposure times 507 may be caused to vary, for example to generate asymmetric exposures (e.g., exposure time 507(1), exposure time 507(2), and exposure time 507(3) are not equal). Furthermore, a different number of frames (e.g., two, four or more) may be captured, each having increasing exposure.

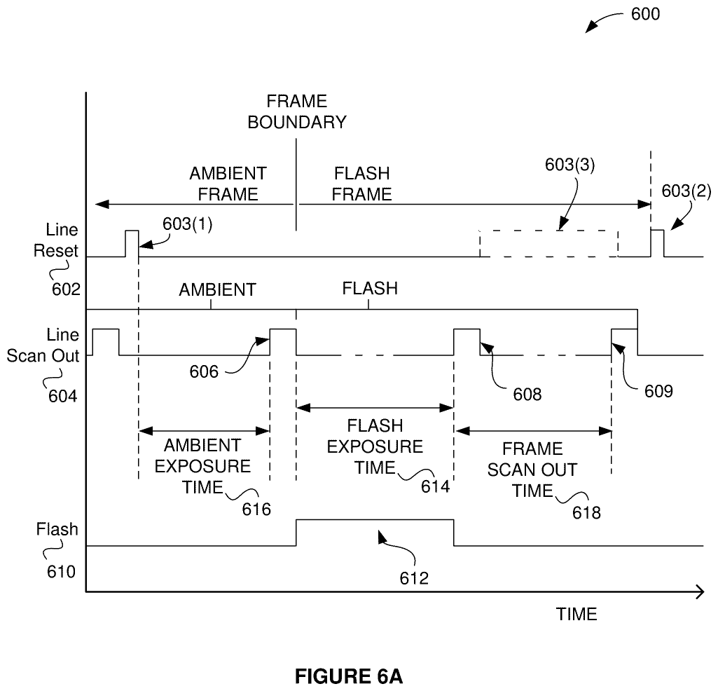

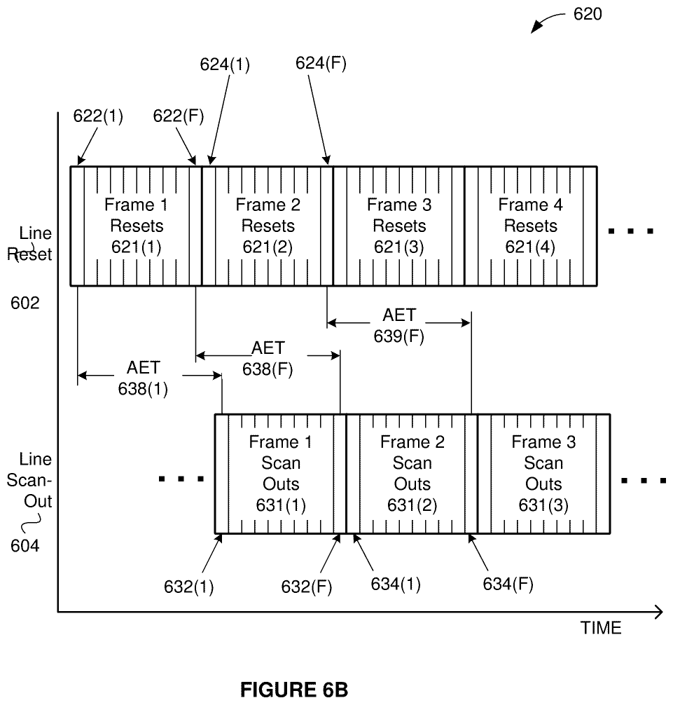

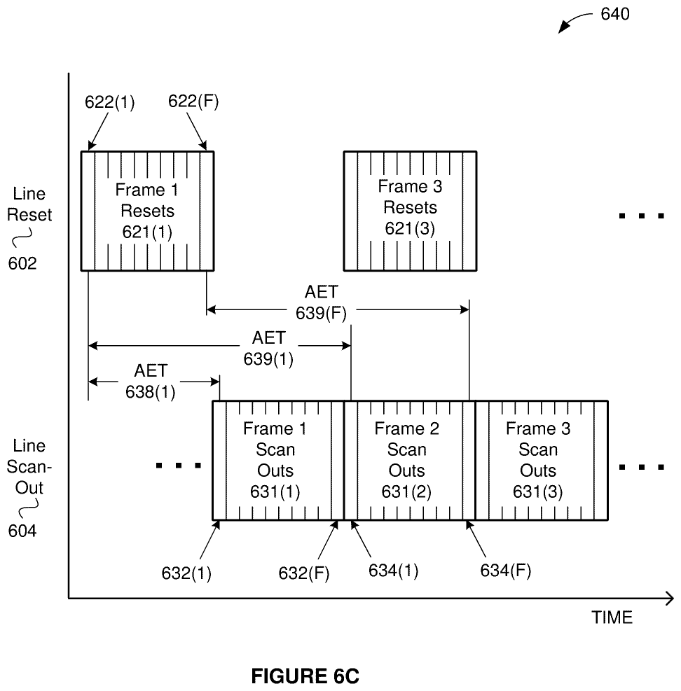

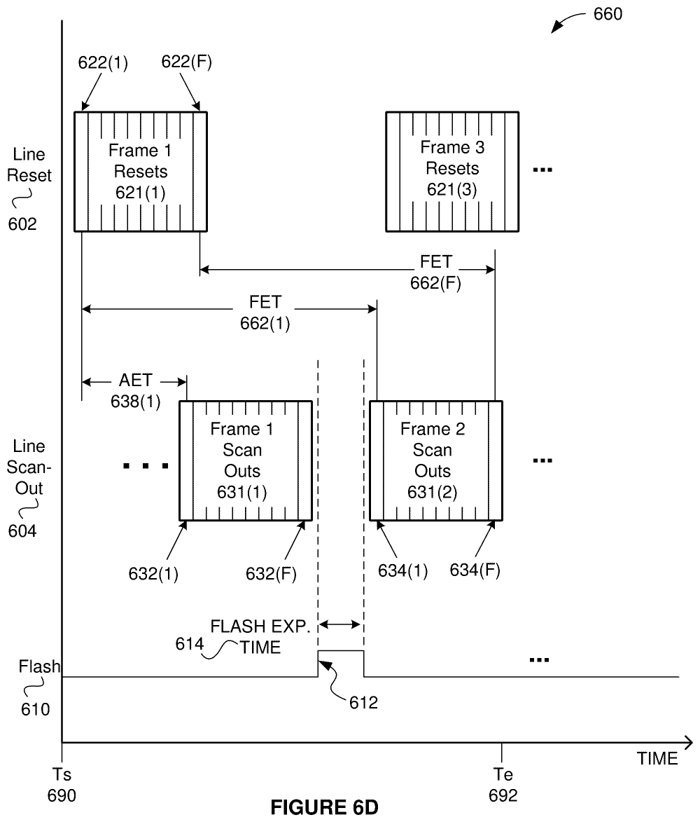

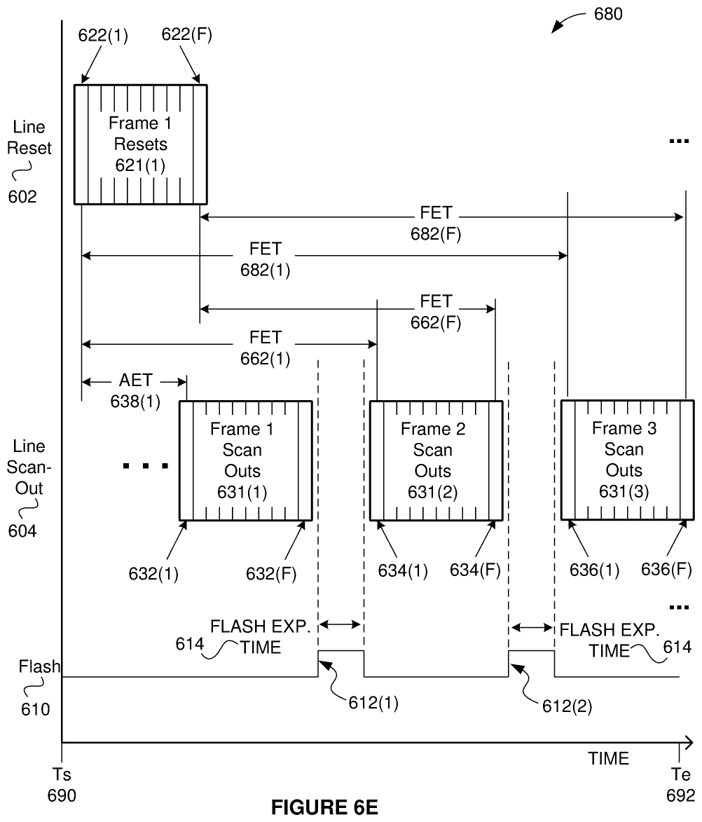

FIG. 6A illustrates a time graph 600 of a line reset, an ambient exposure time, a flash activation, a flash exposure time, and scan out for two frame captures performed with a rolling shutter image sensor, in accordance with one embodiment. As an option, the two captures depicted in the time graph 600 may be implemented in the context of any one or more of the embodiments set forth in any previous and/or subsequent figure(s) and/or description thereof. Of course, however, the two captures depicted in time graph 600 may be implemented in the context of any desired environment. Further, the aforementioned definitions may equally apply to the description below.

As shown, line reset 602 indicates two line reset occurrences 603 on time graph 600. Additionally, line scan out 604 includes an ambient scan-out 606 and a flash scan-out 608. Ambient scan out 606 correlates with an ambient exposure time 616, and flash scan out 608 correlates with a flash exposure time 614. Further, flash 610 indicates an active period 612 which correlates with flash exposure time 614. In one embodiment, a flash circuit (e.g., one or more LEDs or a Xenon strobe) is enabled during active period 612. The flash circuit may be disabled when not in an active period 612.

In one embodiment, an ambient period (corresponding to ambient exposure time 616) may precede a flash period (corresponding to flash exposure time 614). However, in another embodiment, a flash period may precede an ambient period.

In one embodiment, information associated with a properly exposed ambient image may also be used for a flash image. For example, rather than metering for a flash exposure, information gathered during the ambient exposure time may be used during the flash exposure time. In one embodiment, such information (i.e. obtained during the ambient exposure time) may be used as the metering for the flash exposure or a sequence of flash exposures. In another embodiment, metering for the flash exposure may be based on multiple images (e.g. an image set) captured with ambient illumination (e.g., images captured without flash but with increasing exposure time/decreasing shutter speed, etc.).

In another embodiment, illumination conditions may be insufficient to capture a properly exposed ambient image (and no color information may be obtained from the ambient image). In such an embodiment, if the photographic scene is sufficiently dark, then a first active period for the flash 610 may be enabled for pre-metering (e.g. pre-flash or flash metering, TTL metering, automatic-TTL metering, etc.), which may be followed by an ambient period (i.e. non-flash capture) corresponding with an ambient exposure time 616, and then a second active period for the flash 610 corresponding with a flash exposure time 614.

Additionally, although an ambient exposure time 616 and a flash exposure time 614 are represented as separate time periods, it should be noted that no line reset (e.g., line reset occurrence 603) may be performed between the ambient exposure time 616 and the flash exposure time 614; consequently, the flash capture (corresponding with flash scan out 608) is based on the combination of both ambient exposure time 616 and flash exposure time 614. In one embodiment, ambient scan out 606 may be optional and in some instances, may not even occur.

In one embodiment, an ambient image (e.g., a frame exposed during ambient exposure time 616) associated with ambient scan out 606 may be blended, at least in part, with a flash image (e.g., a frame exposed during flash exposure time 614) associated with flash scan out 608. To that effect, any of the techniques included in U.S. patent application Ser. No. 13/573,252 (DUELP003/DL001), now U.S. Pat. No. 8,976,264, filed Sep. 4, 2012, entitled “COLOR BALANCE IN DIGITAL PHOTOGRAPHY” (the entire disclosures being incorporated by reference herein) may be used to generate a blended image based on a capture associated with an ambient scan out 606 and a capture associated with a flash scan out 608. In one embodiment, the ambient image provides a dominant color reference for certain pixels and the flash image provides a dominant color reference for certain other pixels in a blended image. Further, in another embodiment, two or more images each associated with a separate scan out may be blended to generate one or more high-dynamic range (HDR) images.

Further, any number of line scan outs (e.g. as shown as ambient scan out 606 and flash scan out 608) may occur between two line reset occurrences 603. In one embodiment, the images captured resulting from each of the line scan outs may be compiled within an image set. In one embodiment, at least some of the images within the image set may be used as the basis for blending and/or creating a final output image. In some embodiments, such a final output image may be the result of at least one ambient image and at least one flash image. In certain embodiments, two or more ambient images having different exposures may be scanned out and combined to generate an HDR ambient image, two or more flash images having different exposures (e.g., different ISO, exposure time, flash intensity, aperture) may be scanned out and combined to generate an HDR flash image. Furthermore, an HDR ambient image may be combined with a flash image to generate a final output image; an ambient image may be combined with an HDR flash image to generate the final output image; and/or, an HDR ambient image may be combined with an HDR flash image to generate the final output image. In each case, exposure time may vary between different images being combined. In one embodiment, an ambient image may be captured and scanned out, followed by a sequence of flash images that are captured to have increasing flash exposure (and increasing overall exposure). The ambient image and the sequence of flash images may be stored in an image stack. Furthermore, the ambient image may be blended with one or more of the flash images to generate a final image. The one or more flash images may be selected to avoid overexposure in regions primarily illuminated by a flash subsystem, which may generate flash illumination using one or more LEDs or a Xenon flash tube. Alternatively, two or more of the flash images may be selected (e.g., based on flash exposure, avoiding overexposure) and blended to generate a final image.

In one embodiment, the flash subsystem may be enabled during active period 612 at a frame boundary for a duration corresponding to the flash exposure time 614. As shown, the frame boundary is between an ambient frame and a flash frame. In this example, ambient scan out 606 may represent scan out of a last line of the image sensor to generate an ambient image, flash scan out 608 may represent scan out for a first line of the image sensor, and flash scan out 609 may represent scan out for a last line of the image sensor to generate a flash image. A frame scan out time 618 may represent a time span needed to scan out a complete frame from the image sensor. As shown, line reset occurrence 603(1) may correspond to a line reset for the last line of the image sensor, and line reset occurrence 603(2) may also correspond to a line reset for the last line of the image sensor. Sequential line reset occurrences 603(3) are not shown as independent events for other lines, but may occur during frame scan out time 618. Exposure may continue between line reset occurrences; consequently, adjusting frame scan out time 618 (e.g., through faster or slower out scan out occurrences) may have the effect of adjusting ambient exposure contribution to the flash image. In certain embodiments, frame scan out time 618 may be constrained to a certain minimum time, such as by analog-to-digital conversion throughput limitations. In such embodiments, the ambient exposure time 616, flash exposure time 614, and frame scan out time 618 may be collectively adjusted to achieve a target ambient illumination exposure time.

In alternative embodiments, a first ambient image may be captured before the flash image, and a second ambient image may be captured after the flash image is captured; in such embodiments, line reset occurrence 603(2) may be delayed until after scan out of the second ambient image. In such embodiments, the flash image may be exposed to provide under exposed ambient illumination, but proper flash illumination on foreground objects; and the second ambient image may be exposed properly. The first ambient image, the flash image, and the second ambient image may be combined to generate a final output image. For example, the first ambient image may contain useful image information for very bright regions, the flash image may contain useful image information for regions needing flash illumination, and the second ambient image may contain useful image information for regions generally and sufficiently lit by ambient illumination-all of which may be combined to generate a final output image. In one embodiment, the second ambient image may be used as the final output image, with color optionally corrected based on color information from the first ambient image.

FIG. 6B illustrates a time graph 620 of reset, exposure, and scan out timing for multiple equally exposed frames, in accordance with one embodiment. As an option, the time graph 620 may be implemented in the context of any one or more of the embodiments set forth in any previous and/or subsequent figure(s) and/or description thereof. Of course, however, the time graph 620 may be implemented in the context of any desired environment. Further, the aforementioned definitions may equally apply to the description below.

Line reset occurrences 602 are indicated for lines comprising a given frame, and line scan out 604 occurrences are indicated for the lines comprising the frame. Capturing a sequence of frames (frame 1, frame 2, and so forth) is shown to include resetting of individual lines, exposing the individual lines, and scanning out the individual lines.

In one embodiment, an image sensor may include F lines of pixels, and each line of pixels may include an independent reset signal that, when asserted active, causes a line reset occurrence. The line reset occurrence may cause analog storage elements within pixels comprising the line of pixels to reset to an unexposed state. For example, the unexposed state may be defined as a reference voltage stored in an analog storage element; and, during increasing exposure the voltage stored in the analog storage element may decrease towards a ground reference, according to scene intensity at a corresponding pixel. Each reset occurrence for the line may reset the voltage stored in the analog storage element to the reference voltage, and each exposure may change the voltage stored according to intensity at the pixel. Of course, different unexposed and fully exposed voltage schemes may be implemented without departing the scope and spirit of various embodiments.

Frame 1 line resets 621(1) include a line 1 reset 622(1) for line 1, line resets for lines 2 through F−1 (not shown), and a line F reset 622(F) for line F. Similarly, frame 2 line resets 621(2) include a line 1 reset 624(1) for line 1 through a line F reset 624(F) for line F, and so forth. Furthermore, frame 1 line scan outs 631(1) include a line 1 scan out 632(1) for line 1, line scan outs for lines 2 through F−1 (not shown), and a line F scan out 632(F) for line F. Similarly, frame 2 scan outs 631(2) include a line 1 scan out 634(1) for line 1 of frame 2, line scan outs for lines 2 through F−1 for frame 2 (not shown), and a line F scan out 634(F) for line F for frame 2.

As shown, an ambient exposure time (AET) 638(1) for line 1 of frame 1 takes place during a time span between line 1 reset 622(1) and line 1 scan out 632(1) for frame 1. That is, line 1 of the image sensor is exposed during the AET 638(1). Similarly, an AET 638(F) takes place during a time span between line F reset 622(F) for frame 1 and line F scan out 632(F) for frame 1. That is, line F of the image sensor is exposed during the AET 638(F). In general, AET 638(1) is equal in length to AET 638(F), but AET 638(1) and AET 638(F) may occur at different times, with AET 638(F), in one embodiment, occurring after AET 638(1). Furthermore, lines 2 through F−1 (not shown) are also exposed for an ambient exposure time (not shown), with each ambient exposure time occurring after a precious ambient exposure time for sequential lines. As shown, an AET 639(F) corresponds to an AET for line F of frame 2. In one embodiment, duration times for each of AET 638(1) through AET 638(F) and AET 639(F) may be equal.

FIG. 6C illustrates a time graph 640 of reset, exposure, and scan out timing for two frames, in accordance with one embodiment. As an option, the time graph 640 may be implemented in the context of any one or more of the embodiments set forth in any previous and/or subsequent figure(s) and/or description thereof. Of course, however, the time graph 640 may be implemented in the context of any desired environment. Further, the aforementioned definitions may equally apply to the description below.

Frame 1 line resets 621(1) include a line 1 reset 622(1) for line 1, line resets for lines 2 through F−1 (not shown), and a line F reset 622(F) for line F. Furthermore, no line resets are performed for a frame 2 (but scan-outs are associated with frame 2 as will be explained below). Instead, exposure may continue to accumulate so that frame 2 has a higher exposure than frame 1. Frame 1 line scan outs 631(1) may include a line 1 scan out 632(1) for line 1 of frame 1, line scan outs for lines 2 through F−1 (not shown) of frame 1, and a line F scan out 632(F) for line F of frame 1. Similarly, frame 2 scan outs 631(2) may include a line 1 scan out 634(1) for line 1, line scan outs for lines 2 through F−1 (not shown), and a line F scan out 634(F) for line F. Furthermore, AET 638(1) may represent exposure time for line 1 of frame 1, AET 639(1) may represent exposure time for line 1 of frame 2, and AET 639(F) may represent exposure time for line F of frame 2. As shown, exposure times associated with AET 639(1) may be larger than exposure times associated with AET 638(1); consequently, exposure for frame 2 may be higher than exposure for frame 1.

FIG. 6D illustrates a time graph 660 of reset, exposure, a flash active period, and scan out for an ambient frame and a flash frame, in accordance with one embodiment. As an option, the time graph 660 may be implemented in the context of any one or more of the embodiments set forth in any previous and/or subsequent figure(s) and/or description thereof. Of course, however, the time graph 660 may be implemented in the context of any desired environment. Further, the aforementioned definitions may equally apply to the description below.

Frame 1 line resets 621(1) include a line 1 reset 622(1) for line 1, line resets for lines 2 through F−1 (not shown), and a line F reset 622(F) for line F. Furthermore, no line resets are performed for frame 2 (but scan-outs are associated with frame 2 as will be explained below). Instead, exposure may continue to accumulate so that frame 2 has a higher exposure than frame 1. Exposure accumulation for frame 2 may include accumulating flash illumination provided during flash active period 612. Frame 1 line scan outs 631(1) may include a line 1 scan out 632(1) for line 1 of frame 1, line scan outs for lines 2 through F−1 (not shown) of frame 1, and a line F scan out 632(F) for line F of frame 1. Similarly, frame 2 scan outs 631(2) may include a line 1 scan out 634(1) for line 1, line scan outs for lines 2 through F−1 (not shown), and a line F scan out 634(F) for line F. Furthermore, AET 638(1) may represent exposure time for line 1 of frame 1, flash exposure time (FET) 662(1) may represent exposure time for line 1 of frame 2, and FET 662(F) may represent exposure time for line F of frame 2. As shown, exposure times associated with FET 662 are larger than exposure times associated with AET 638; consequently, exposure for frame 2 may be higher than exposure for frame 1. In one embodiment, frame 2 is a flash image exposed according to an ambient exposure time for FET 662 in addition to flash exposure time 614 during flash active period 612. In certain embodiments, AET 638(1) may be metered to generate an underexposed ambient image, and FET 662(1) may be metered to generate well-exposed regions illuminated by flash illumination and well-exposed or over-exposed regions illuminated by ambient illumination. Frame 3 line resets 621(3) may include a line reset for lines within the image sensor. A reset for line 1 of frame 3 may occur after scan out for line 1 of frame 2. Frame 3 line resets 621(3) may prepare the image sensor to capture another ambient frame.

In one embodiment, the image sensor (e.g., image sensor 332) is configured to use at least two different analog gains for performing frame scan out. For example, frame 1 scan outs 631(1) may be performed using a first analog gain and frame 2 scan outs 631(2) may be performed using a second, different analog gain. In certain embodiments, the first analog gain (used for scanning out ambient frame) may be higher than the second analog gain (used for scanning out flash frame), causing the ambient frame to have a higher exposure in ambient-lit regions than the flash frame, despite the longer overall exposure time of the flash frame. In certain embodiments, the second analog gain is calculated to provide substantially equivalent exposure (e.g., within +/−0.125 ev) in ambient-lit regions for the ambient frame and the flash frame despite the longer exposure time of the flash frame. In certain embodiments, frame 2 scan outs 631(2) may be performed at a higher rate (e.g., shorter scan out time per line) than frame 1 scan outs 631(1), thereby reducing additional ambient-lit exposure within the flash frame and reducing additional motion blur associated with camera position and/or scene subjects.

In one embodiment, an image set may include frame 1 and frame 2, captured between a start time (Ts) 690 and an end time (Te) 692. One or more image sets may be captured, with one of the image sets being selected and saved, based on device motion. For example, an accelerometer and/or gyroscope comprising sensor devices 342 may provide an estimate of device motion between start time 690 and end time 692 for each of one or more image sets, with one image set having the least motion being selected to be saved and used to generate a final output image. In another example, pixel motion within at least one of frames 1 and 2 may be used to estimate device motion between start time 690 and end time 692 for each of the one or more image sets, with the one image set having the least pixel motion being selected to be saved and used to generate a final output image. In such embodiments, multiple image sets may be captured, with one image set having the least motion and therefore the least likelihood of visible motion blur being saved and used to generate a final output image.

FIG. 6E illustrates a time graph 680 of reset, exposure, and scan out for an ambient frame and two sequential flash frames, in accordance with one embodiment. As an option, the time graph 660 may be implemented in the context of any one or more of the embodiments set forth in any previous and/or subsequent figure(s) and/or description thereof. Of course, however, the time graph 660 may be implemented in the context of any desired environment. Further, the aforementioned definitions may equally apply to the description below.

Frame 1 line resets 621(1) include a line 1 reset 622(1) for line 1, line resets for lines 2 through F−1 (not shown), and a line F reset 622(F) for line F. Frame 1 line scan outs 631(1) may include a line 1 scan out 632(1) for line 1 of frame 1, line scan outs for lines 2 through F−1 (not shown) of frame 1, and a line F scan out 632(F) for line F of frame 1. Frame 2 scan outs 631(2) may include a line 1 scan out 634(1) for line 1, line scan outs for lines 2 through F−1 (not shown), and a line F scan out 634(F) for line F. Similarly, frame 3 scan outs 631(3) may include a line 1 scan out 636(1) for line 1, line scan outs for lines 2 through F−1 (not shown), and a line F scan out 636(F) for line F. FET 682(1) represents an exposure time for line 1 of frame 3, while FET 682(F) represents an exposure time for line F of frame 3. In one embodiment, FET 682(1) is equal in duration to 682(F), and FET 682(1) is longer in duration relative to FET 662(F).

Time graph 680 includes two flash active periods 612(1) and 612(2), as well as a second flash image scan out, shown as frame 3 scan outs 631(3). While one ambient frame (frame 1) and two flash frames (frames 2 and 3) are shown here, additional ambient frames may also be captured and/or additional flash frames may also be captured.

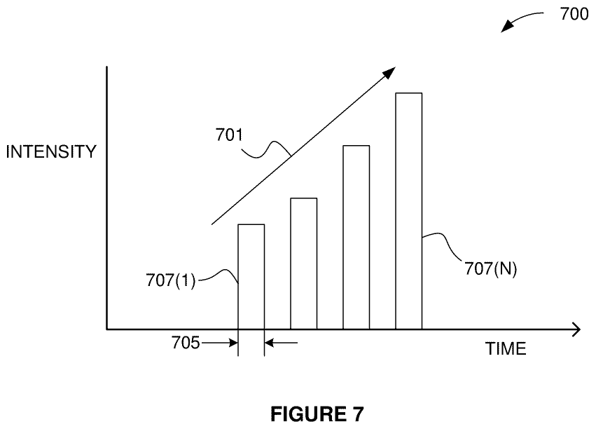

In one embodiment, flash exposure time 614 is the same for flash active period 612(1) and flash active period 612(2). In certain embodiments, flash intensity is also the same for flash active period 612(1) and flash active period 612(2). In other embodiments, flash intensity and/or flash active periods may vary in any of the frames. For example, in one embodiment, flash intensity may vary by increasing in sequential frames (as illustrated in FIG. 7).

In one embodiment, an image set may include frame 1, frame 2, and frame 3, captured between a start time (Ts) 690 and an end time (Te) 692. One or more image sets may be captured, with one of the image sets being selected and saved, based on device motion. For example, an accelerometer and/or gyroscope comprising sensor devices 342 may provide an estimate of device motion between start time 690 and end time 692 for each of one or more image sets, with one image set having the least motion being selected to be saved and used to generate a final output image. In another example, pixel motion within at least one of frames 1 to 3 (or any number of frames) may be used to estimate device motion between start time 690 and end time 692 for each of the one or more image sets, with the one image set having the least pixel motion being selected to be saved and used to generate a final output image. In such embodiments, multiple image sets may be captured, with one image set having the least motion and therefore the least likelihood of visible motion blur being saved and used to generate a final output image.

FIG. 7 illustrates a time graph 700 of linear intensity increase for a flash, in accordance with one embodiment. As an option, the time graph 700 may be implemented in the context of any one or more of the embodiments set forth in any previous and/or subsequent figure(s) and/or description thereof. Of course, however, the time graph 700 may be implemented in the context of any desired environment. Further, the aforementioned definitions may equally apply to the description below.

As shown, time graph 700 includes a time variable on the x-axis and intensity value on the y-axis. The intensity on the y-axis corresponds with a flash intensity. For example, flash intensity of time graph 700 may correspond to the flash intensity of strobe unit 336 plotted as a function of time. As shown, the intensity may increase 701 in a consistent fashion (i.e. same increase at each interval). In one embodiment, the increase 701 may be linear. In one embodiment, the increase 701 may be performed as part of a metering operation in preparation for capturing a flash image, wherein different flash intensity values are used to capture metering images for determining exposure parameters. In another embodiment, the increase 701 is performed to capture a sequence of flash images having different exposures.

As shown, time graph 700 includes a set of one or more flash occurrences 707(1)-707(N). Further, duration 705 may be determined, adjusted, or specified for each flash occurrence (e.g. among flash occurrences 707(1) -707(N)).

In one embodiment, time graph 700 may represent intensity values generated using pulse width modulation (PWM). PWM may be used to control the flash output associated with a LED flash. In this manner, PWM may be used to produce uniform (e.g. same time length) flash spikes of variable duration. Of course, in another embodiment, direct current may be used to control LED flash as well. In one embodiment, a PWM cycle or direct current approach may be used with a Xenon flash (e.g. to control duration of flash).

In one embodiment, a first goal of metering an ambient image (e.g. as it may relate to operation 102, operation 106, operation 202, operation 206, etc.) may include ensuring that the entire ambient image achieves a correct exposure (e.g. a majority of pixels in the middle of a histogram, or a median histogram value of a mid-range intensity value). Furthermore, a second goal of metering can apply to a flash image, wherein the second goal is to ensure that less than a specified threshold percentage of pixels (or a threshold percentage of additional pixels relative to the ambient image) are not overexposed. Exposure parameters for the flash image may be determined such that ambient illuminated portions of the flash image are underexposed and the flash does not overexpose more than the specified threshold of pixels. In this way, blending the ambient image with the flash image may produce a final image with properly exposed ambient illuminated regions and properly exposed flash illuminated regions. In another embodiment, a second goal of metering (e.g. as it may relate to operation 102, operation 106, operation 202, operation 206, etc.) may include constraining an intensity histogram to a specific envelope for high-intensity pixels. For example, in a system with intensity values ranging from 0.0 to 1.0, an intensity histogram envelope may specify that less than a first threshold (e.g., 6%) of pixels may fall within a first intensity range (e.g., 0.90 to 0.95), a second threshold (e.g., 3%) of pixels may fall within a second intensity range (e.g., 0.95 to 0.98), and a third threshold of pixels (e.g., 1%) may fall within a third intensity range (e.g., 0.98 to 1.0). This exemplary histogram envelop includes three steps, but other histogram envelopes may include more or fewer steps, may define functions such as straight lines, and may cover different intensity ranges. Such embodiments can operate to provide an ambient image that, when combined with a flash image, provide a final output image with sufficient illumination for relevant subject matter. For example, in a scene with a poorly illuminated foreground subject but adequate background illumination, an ambient image may be metered and captured to provide a portion of scene lighting for a final output image, while the flash image only needs to illuminate a foreground subject. The presently disclosed technique for constraining exposure parameters for the flash image relative to the ambient image allows for each of the flash image and ambient image to provide useful information to the combined final image.

In one embodiment, a percentage (e.g. 2-3%, etc.) may be used as a ceiling to the number of permitted overexposed pixels. Of course, in other embodiments, any percentage may be used (e.g. as predetermined by the system and/or user, as determined in real-time based on the size of the captured image, etc.).

In another embodiment, a location may be used as a point of interest frame to restrict overexposed pixels. For example, a face may be determined to be a point of interest in an image, and a frame may be constructed around the face such that no pixels (or no more than a set ceiling percentage) are overexposed within such a frame. Of course, a frame may be constructed around any object which may be further determined automatically (e.g. object detection, etc.) or manually selected (e.g. by a user, etc.). In such an embodiment, using a point of interest may be a basis for determining a framing location by which the exposure of pixels may be calculated.

Still yet, in one embodiment, a correctly exposed (e.g. majority of pixels in the middle of an image intensity histogram, a median intensity centered in an image histogram, etc.) ambient image (e.g. as captured via, e.g., ambient scan out 606) may be combined with a correctly exposed or constrained exposure flash image (e.g. as captured, via, e.g., flash scan out 608). In another embodiment, data captured from the ambient exposure time (e.g. exposure settings, white balance, etc.) may be used as a basis for the flash exposure time. In yet another embodiment, ambient exposure parameters including exposure time and ISO may be traded off (e.g., increased ISO value traded off against shorter exposure time) when taking the flash image. Further, such data obtained from the ambient exposure time and/or ambient image may be used in post-processing of the resulting captured image. For example, a frame white balance and/or color correction map (e.g., referenced to ambient image) may be applied to the flash image to correct the color of the flash image to be consistent with the ambient image as discussed herein.

In one embodiment, data obtained from the ambient exposure time (e.g. corresponding to ambient exposure time 616) may be used to influence the flash (e.g. active period 612). For example, an ambient exposure time may determine how much light is present and where the point of interest is located (e.g. pixel coordinates, distance away from camera, etc.). Such data may be used to select what the duration (e.g. duration 705, etc.), the frequency (e.g. frequency 703, etc.), and potentially even the flash type (e.g. time graph 700). In this manner, data gleaned from the ambient exposure time (e.g. 616) may directly influence the flash settings which are implemented during the flash exposure time 614. Further, in some embodiments, data obtained from the ambient exposure time 616 may dictate both the flash exposure time 614 and the flash active period 612.

In one embodiment, data obtained from ambient exposure time 616 may remove the need for a pre-metering of flash. For example, in one embodiment, based on the intensity of light in combination with how close the point of interest object is to the camera, a flash amount may be estimated.

Still yet, in another embodiment, a flash may be influenced by multiple points of interest. For example, two faces may be identified and the amount of flash may be based either individually on each of the two faces (e.g. take two captures, each capture being optimized for one or the other face), or on the global histogram of just the two faces (e.g. a histogram output based on the frames around the two faces). In another embodiment, it may be desired to focus the entire frame of the image in addition to a single (or multiple) points of interest. In such an embodiment, a flash may need to compensate for both a scene focus (e.g. global image) and a point of interest focus.

In one embodiment, a line scan out may be obtained after a first set time (e.g. based on distance to the point of interest) whereas a second line scan out may be obtained for a second set time (e.g. based on correct exposure for the entire scene). In this manner, flash settings may be optimized based on the distance to each object, the frame(s) (e.g. of a scene, of an object, etc.), the focus (e.g. point of focus may correspond with a point of interest, etc.), etc.

Additionally, in one embodiment, one or more automatic actions may be taken based on a point of interest. For example, in one embodiment, selecting a point of interest may automatically cause the point of interest to be in focus, and any surrounding objects to be defocused. Further, a point of interest may be tracked such that the location of the point of interest (i.e. the current pixel coordinates associated with the point of interest) is dynamically updated and the corresponding focus of the location for the point of interest is updated.

In another embodiment, although time graph 600 may be applied to a rolling shutter scenario (e.g. include scan line-out 604, etc.), the principle of using a combined ambient exposure time (e.g. 616) and a flash exposure time (e.g. 614) in combination for an image capture (e.g. flash scan out 608) may be applied to a global shutter system as well.

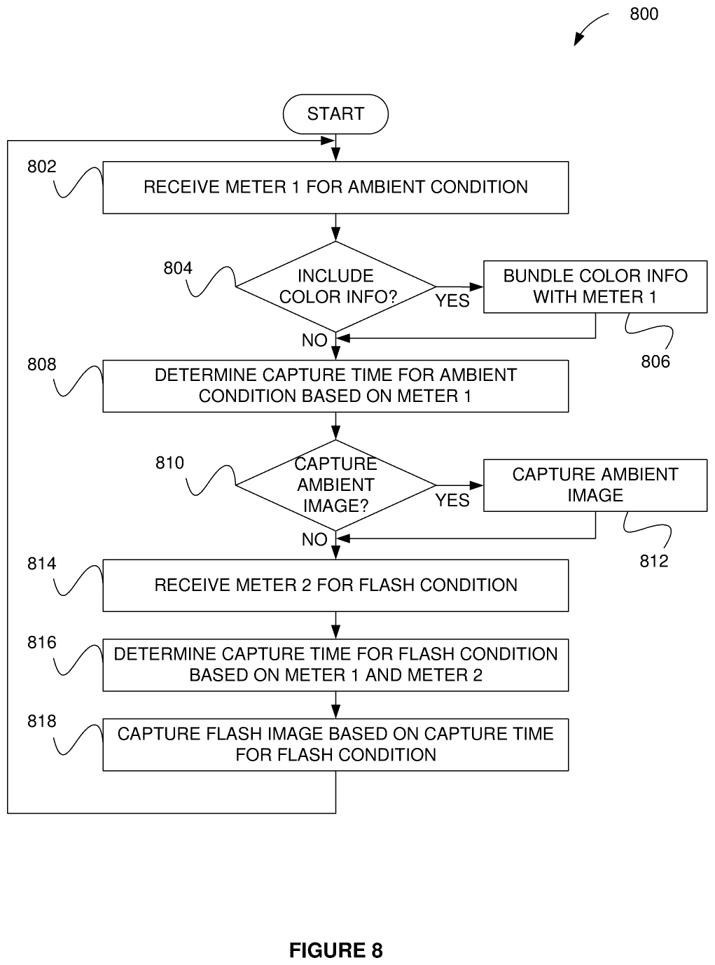

FIG. 8 illustrates a method 800 for capturing a flash image based on a first and second metering, in accordance with one embodiment. As an option, the method 800 may be implemented in the context of any one or more of the embodiments set forth in any previous and/or subsequent figure(s) and/or description thereof. For example, method 800 may be applied in the context of operation 110 of FIG. 1, and operation 210 of FIG. 2. Of course, however, the method 800 may be implemented in the context of any desired environment. Further, the aforementioned definitions may equally apply to the description below.

As shown, meter 1 is received for an ambient condition. See operation 802. In one embodiment, more than one metering may be received relating to a given ambient condition (or conditions). Next, it is determined to include color information. See decision 804. If yes, color information is bundled with meter 1. See operation 806. In one embodiment, color information may be bundled with meter 1 as metadata.

Next, a capture time is determined for the ambient condition based on meter 1. See operation 808. For example, if meter 1 indicates that the ambient condition is a low-light situation, then the capture time would include a longer exposure due to less light being present in a scene being photographed. Additionally, in another embodiment, if multiple points of focus were present in the image, then more than one metering may be required, and each may require a separate capture time for a given ambient condition.

It is then determined whether to capture the ambient image. See decision 810. If so, then the ambient image is captured. See operation 812.

Next, meter 2 is received for flash condition. See operation 814. In one embodiment, more than one metering may be received relating to a flash condition (or conditions). For example, in one embodiment, a scene may be metered for a flash capture to determine best exposure for the entire scene, but a second flash metering may be used to determine a best exposure for a point of interest (e.g. a face, an object, etc.).

A capture time is then determined for flash condition based on meter 1 and meter 2. See operation 816. For example, information from meter 1 (e.g. overall scene exposure at a first flash intensity, etc.) and information from meter 2 (e.g. optimal flash amount for point of interest, etc.) may be used to determine total capture time for a flash condition.

In one embodiment, the flash condition may include more than an indication of duration of flash. For example, a ramp up of flash intensity (e.g. time graph 700), or other flash intensity function may be included in the flash condition.

Last, a flash image is captured based on the capture time for flash condition. See operation 818. As discussed above, flash condition may include elements from both meter 1 and/or meter 2.

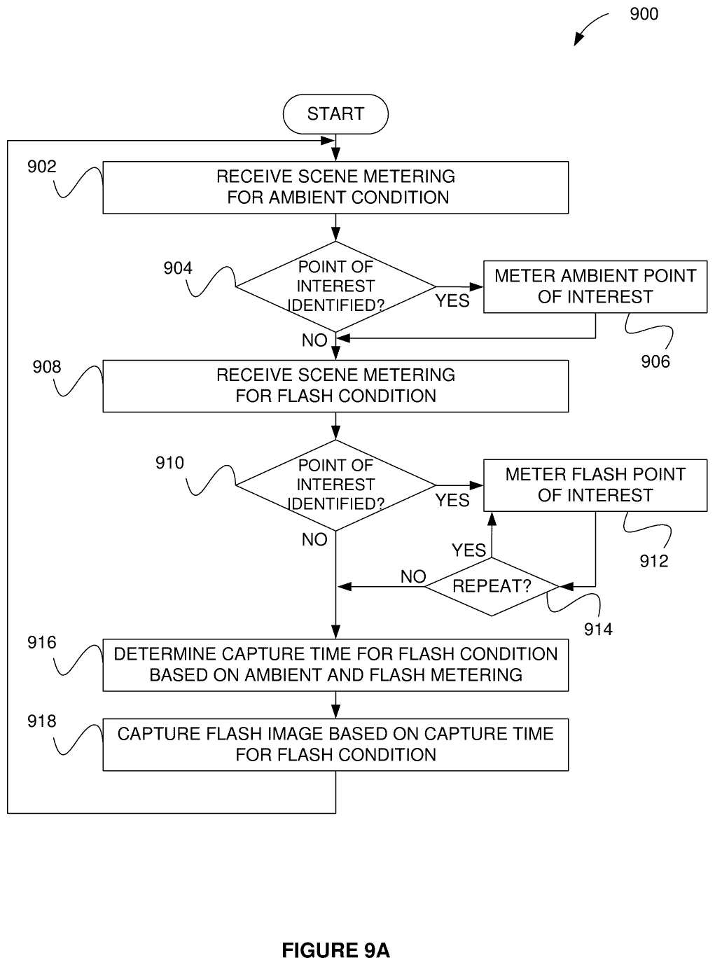

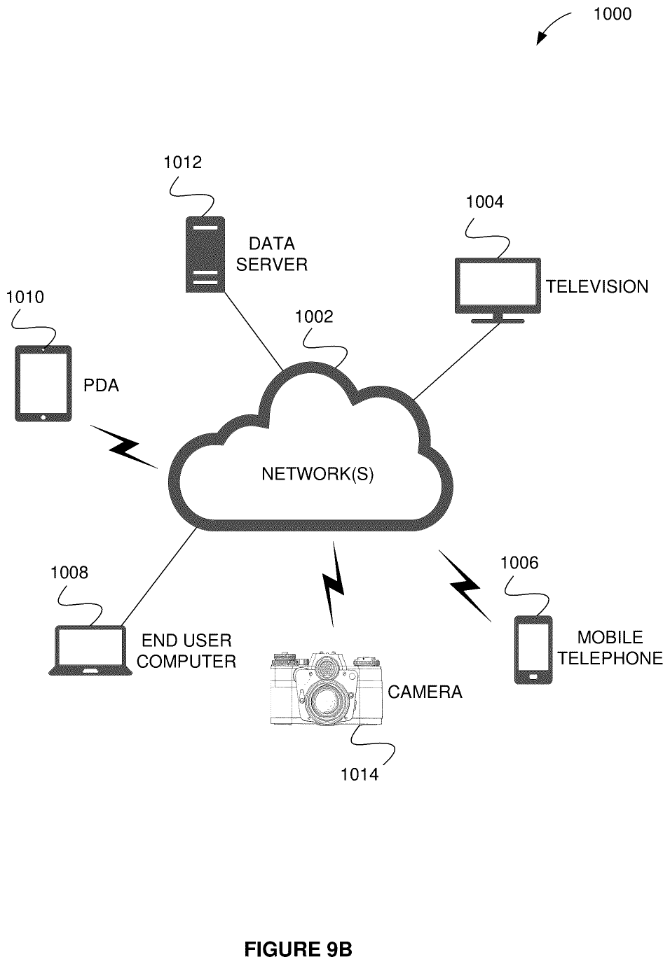

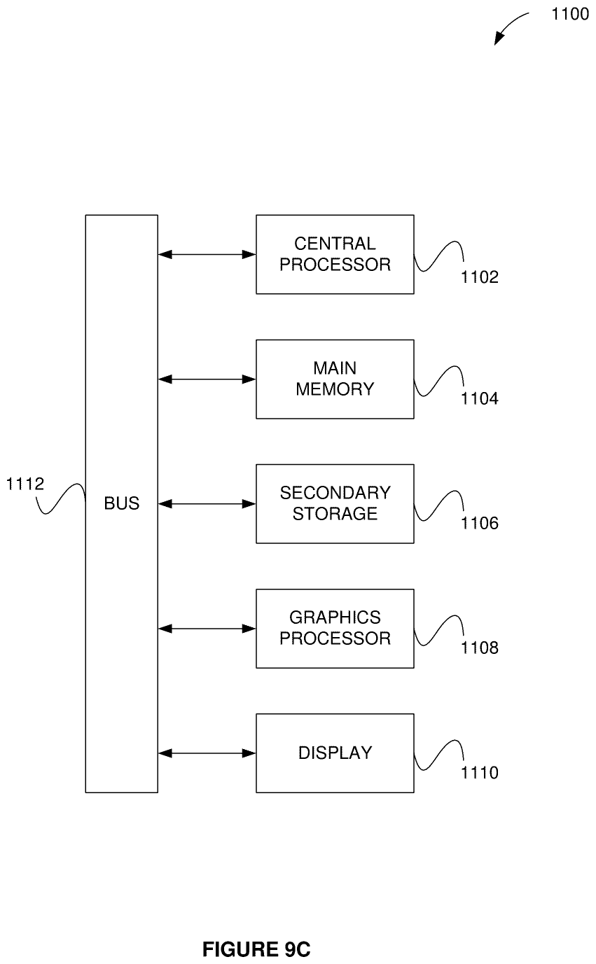

FIG. 9A illustrates a method 900 for setting a point of interest associated with a flash exposure, in accordance with one embodiment. As an option, the method 900 may be implemented in the context of any one or more of the embodiments set forth in any previous and/or subsequent figure(s) and/or description thereof. For example, method 900 may be applied in the context of operation 110 of FIG. 1, and operation 210 of FIG. 2. Of course, however, the method 900 may be implemented in the context of any desired environment. Further, the aforementioned definitions may equally apply to the description below.

As shown, scene metering is received for an ambient condition. See operation 902. In one embodiment, scene metering may include a global metering, an optimal exposure (e.g. histogram median for captured image at dynamic range intensity mid-point, etc.), a recommended aperture and/or shutter speed, one or more objects, etc. Next, it is determined if a point of interest is identified. See decision 904. In various embodiments, a point of interest may be identified manually (e.g. via an input, via a user, etc.), or automatically (e.g. object recognition, contextual awareness, etc.). In one embodiment, a point of interest may be determined only if a user indicates in advance to identify points of interest in scenes. Further, such identification of points of interest may rely, at least in part, on data obtained through an external source (e.g. internet, cloud, another connected device, etc.).

If a point of interest is identified, then an ambient point of interest is metered. See operation 906. For example, if under ambient conditions a face (or multiple faces) is identified, then the face may be used as the basis for metering for the point of interest. Additionally, if multiple points of interest are identified, in one embodiment, multiple meterings may each occur, at least one per point of interest.

Additionally, in another embodiment, based on the scene and point of interest meterings for ambient condition, one or more capture times for ambient condition may be determined. Further, a capture (or multiple captures) associated with the scene and point of interest meterings may also occur.

Next, scene metering for flash condition is received. See operation 908. In one embodiment, scene metering may seek to optimize exposure parameters to reduce overexposed pixels. In another embodiment, scene metering may seek to reduce overexposed pixels while maximizing correct exposure for the entire scene. Next, it is determined if a point of interest for a flash condition is identified. See decision 910. In one embodiment, the point of interest identified via decision 904 may correlate with the same point of interest identified via decision 910. In another embodiment, however, a point of interest for a flash condition may differ from a point of interest for an ambient condition. For example, a point of interest for an ambient condition may be the sky, while a point of interest for a flash condition may be an individual's face.

A flash point of interest is then metered. See operation 912. In one embodiment, multiple points of interest may be identified. Therefore, per decision 914, it is determined whether additional meterings need to occur (i.e. repeat metering step). In another embodiment, one metering may satisfy more than one point of interest. For example, two faces in close proximity to each other may each have the same metering.

Additionally, although not shown in method 900, after identifying and metering a point of interest, it may also be determined whether the point of interest has moved. In one embodiment, such movement may be analyzed with respect to a threshold, where if the movement is below a set threshold, no action is taken, whereas if the movement is above a set threshold, then another metering may need to occur.

Next, a capture time for flash condition based on the ambient metering and flash metering is determined. See operation 916. In one embodiment, the ambient metering may include both ambient scene metering and ambient point(s) of interest metering. Additionally, the flash metering may include both flash scene metering and flash point(s) of interest metering.

Last, a flash image based on the capture time for flash condition is captured. See operation 918.

FIG. 9B illustrates a network architecture 1000, in accordance with one possible embodiment. As shown, at least one network 1002 is provided. In the context of the present network architecture 1000, the network 1002 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 1002 may be provided.

Coupled to the network 1002 is a plurality of devices. For example, a server computer 1012 and an end user computer 1008 may be coupled to the network 1002 for communication purposes. Such end user computer 1008 may include a desktop computer, lap-top computer, and/or any other type of logic. Still yet, various other devices may be coupled to the network 1002 including a personal digital assistant (PDA) device 1010, a mobile phone device 1006, a television 1004, a camera 1014, etc.

FIG. 9C illustrates an exemplary system 1100, in accordance with one embodiment. As an option, the system 1100 may be implemented in the context of any of the devices of the network architecture 1000 of FIG. 9B. Of course, the system 1100 may be implemented in any desired environment.

As shown, a system 1100 is provided including at least one central processor 1102 which is connected to a communication bus 1112. The system 1100 also includes main memory 1104 [e.g. random access memory (RAM), etc.]. The system 1100 also includes a graphics processor 1108 and a display 1110.

The system 1100 may also include a secondary storage 1106. The secondary storage 1106 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 1104, the secondary storage 1106, and/or any other memory, for that matter. Such computer programs, when executed, enable the system 1100 to perform various functions (as set forth above, for example). Memory 1104, storage 1106 and/or any other storage are possible examples of non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

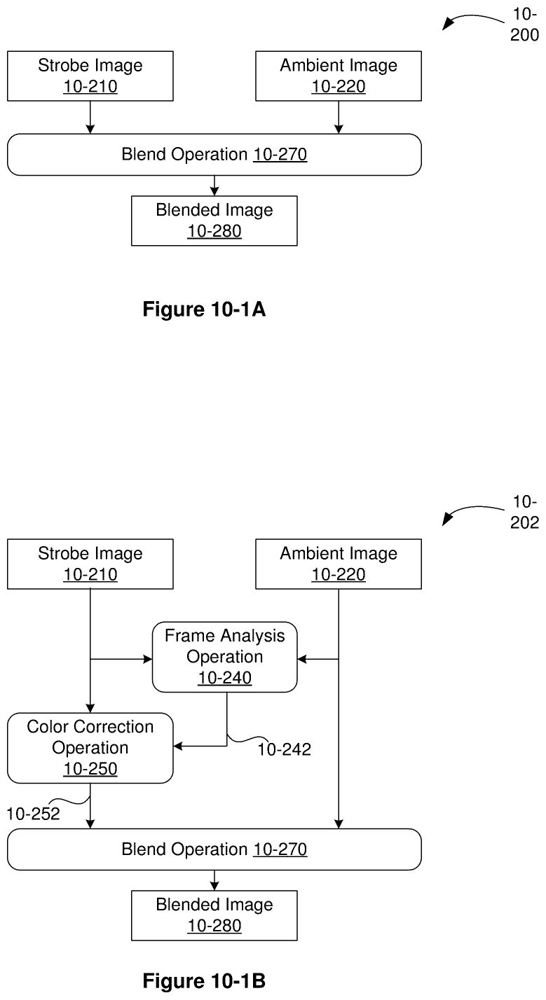

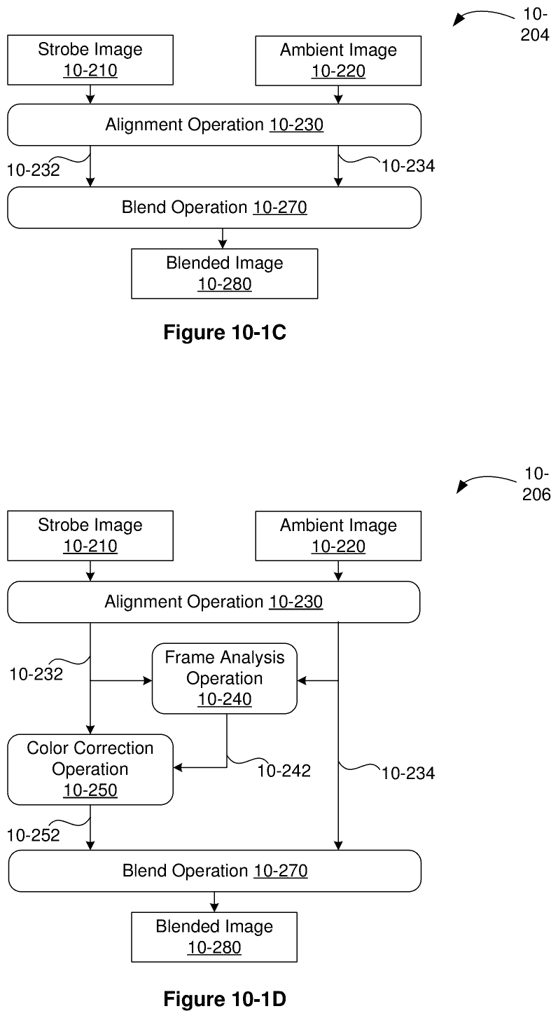

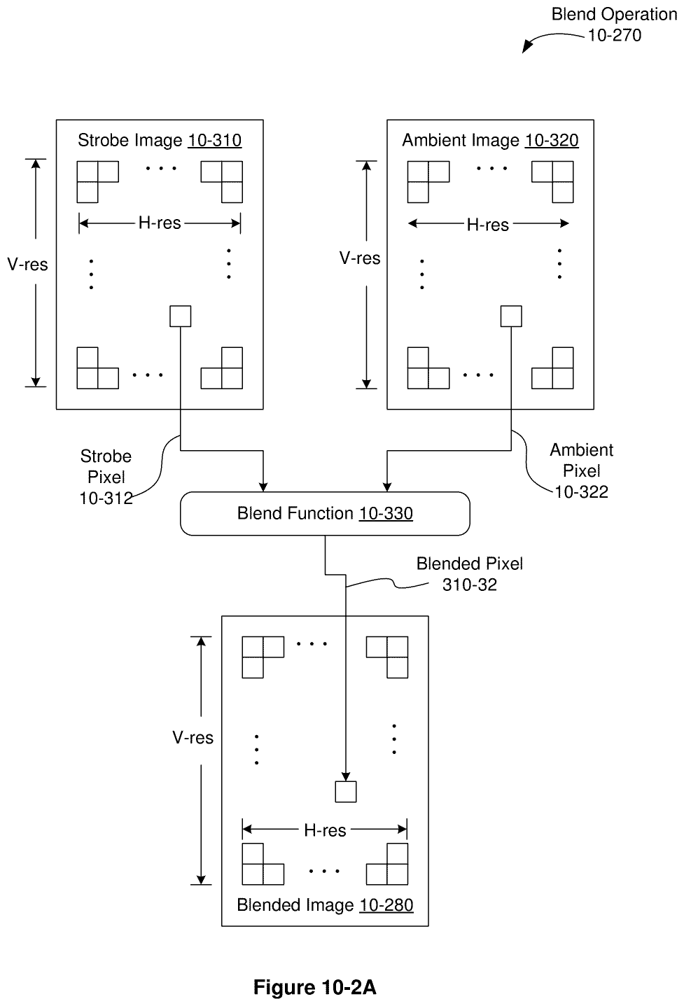

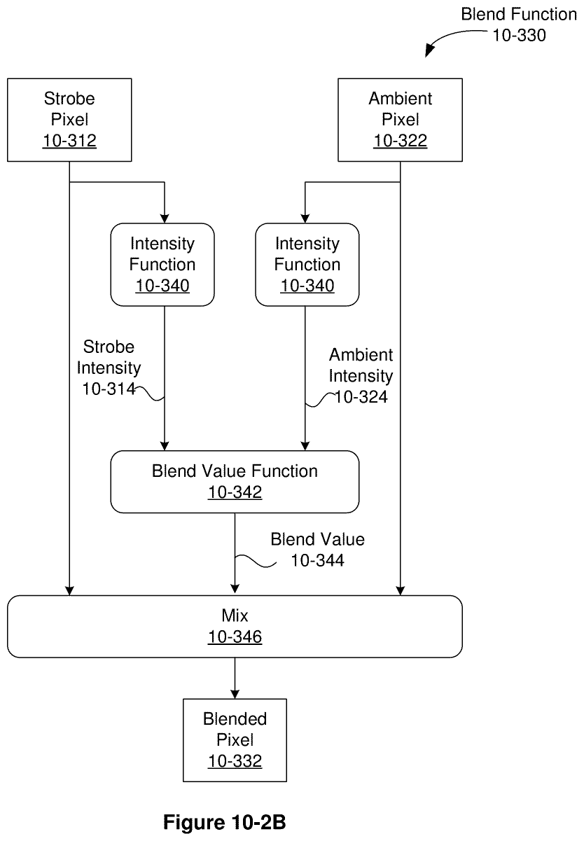

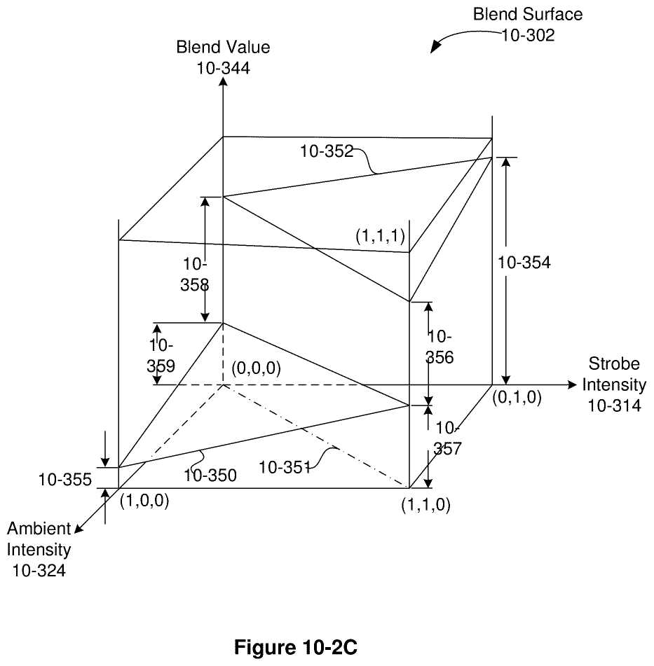

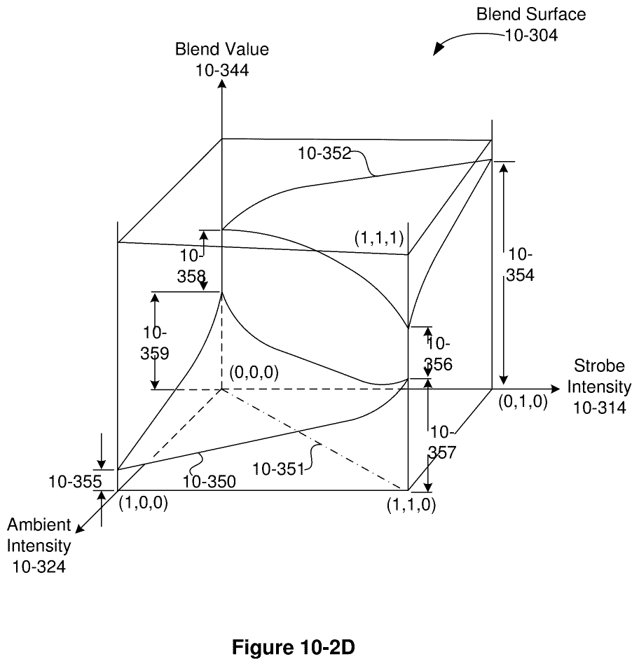

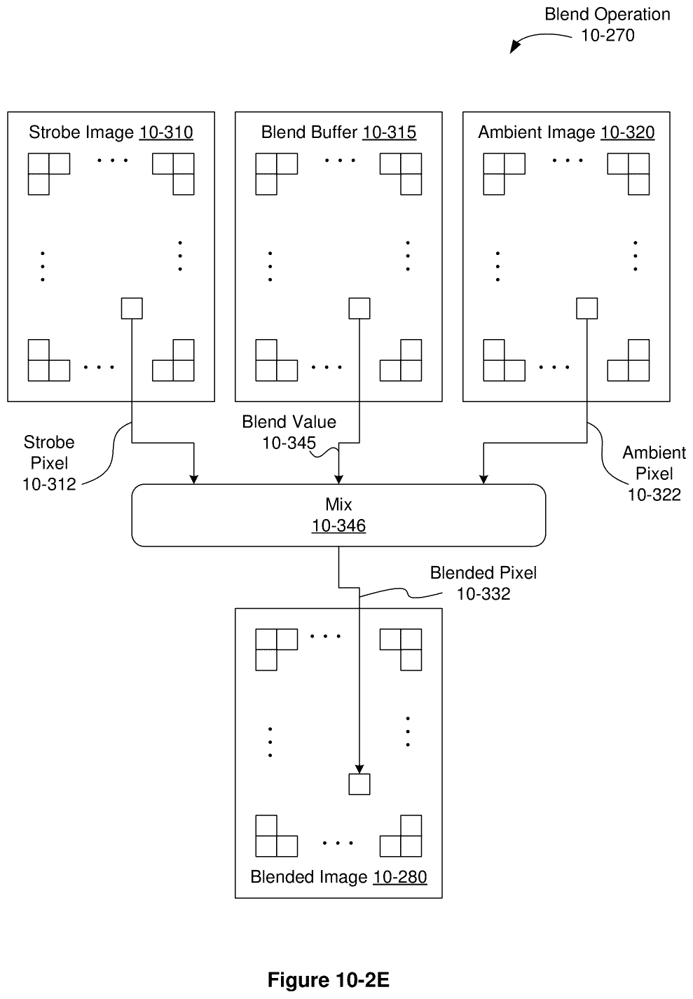

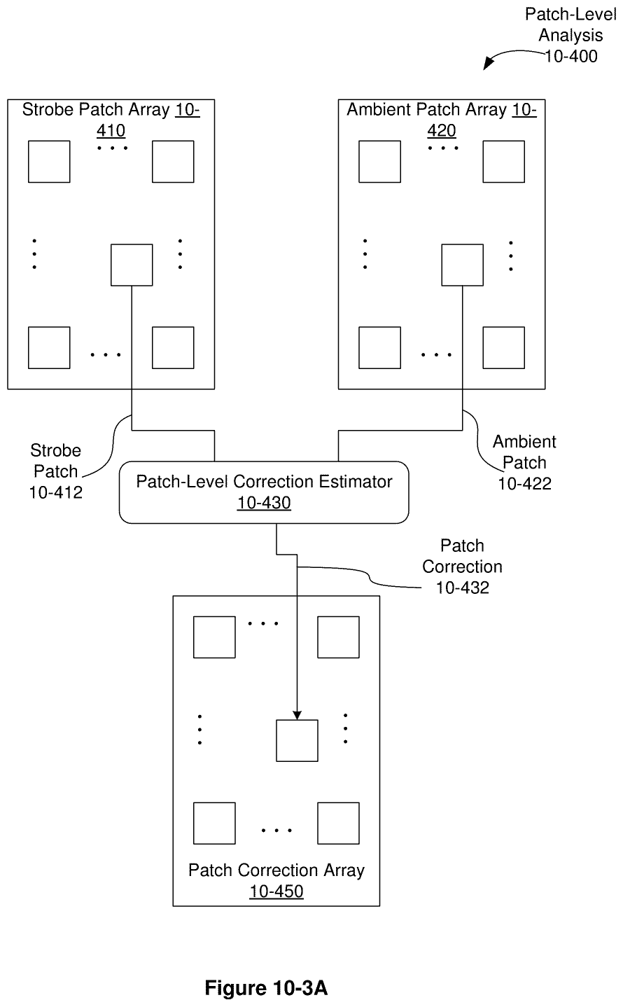

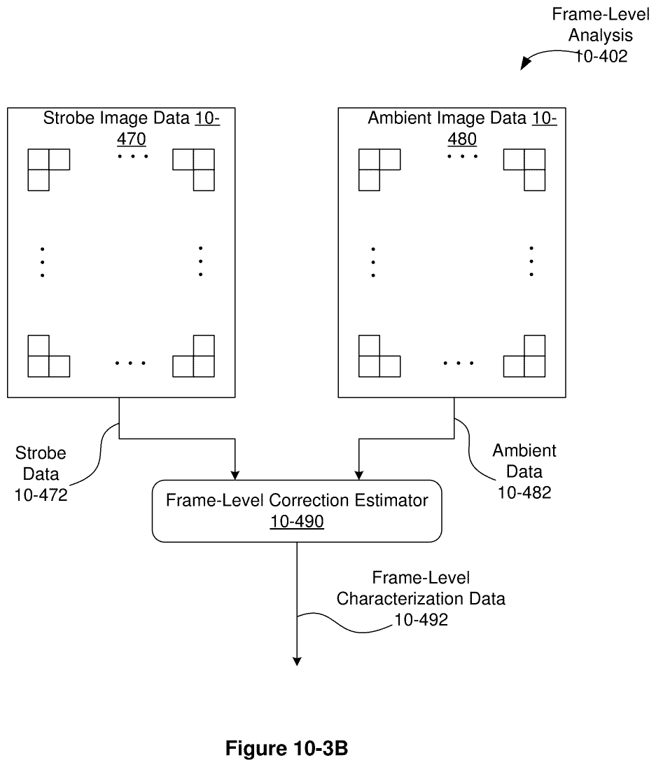

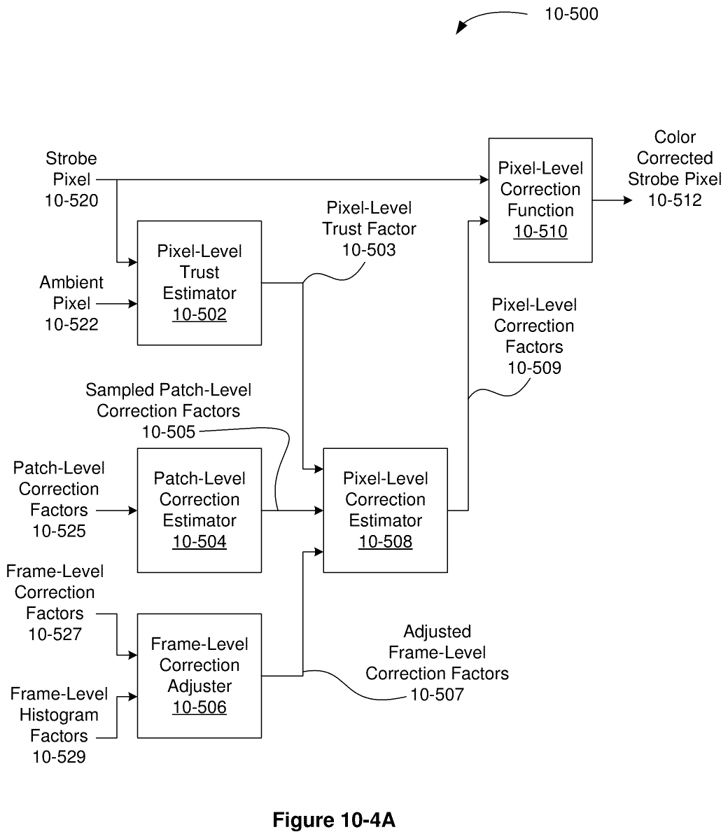

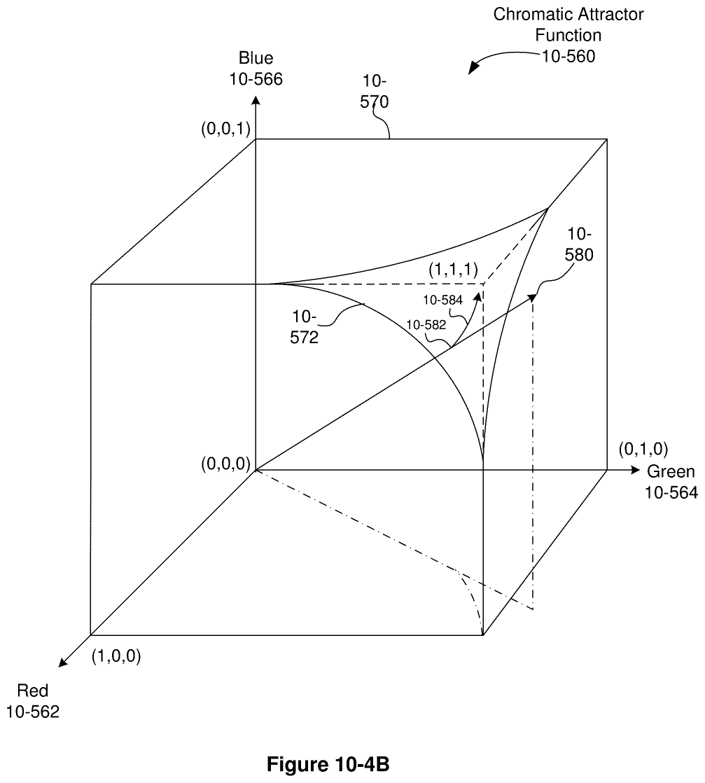

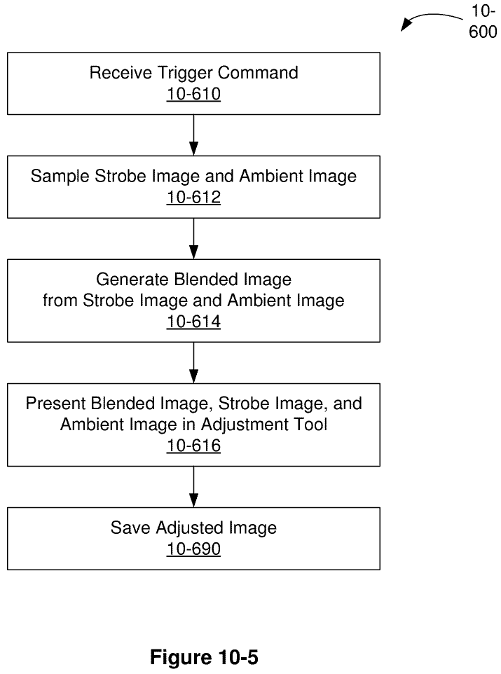

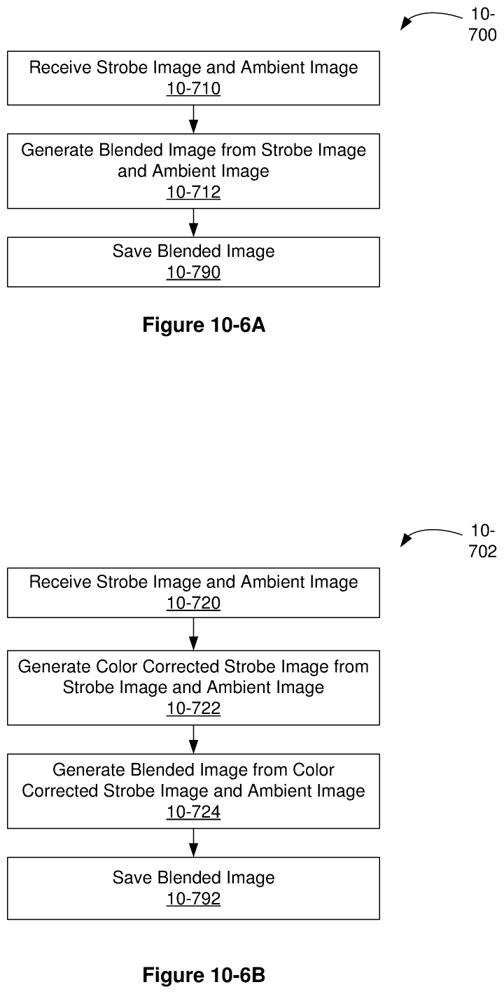

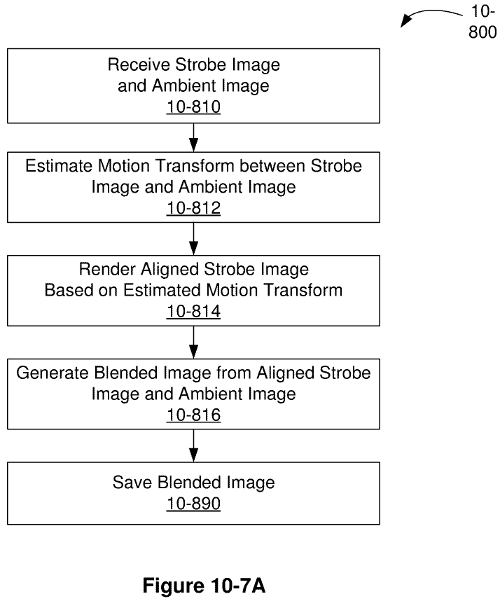

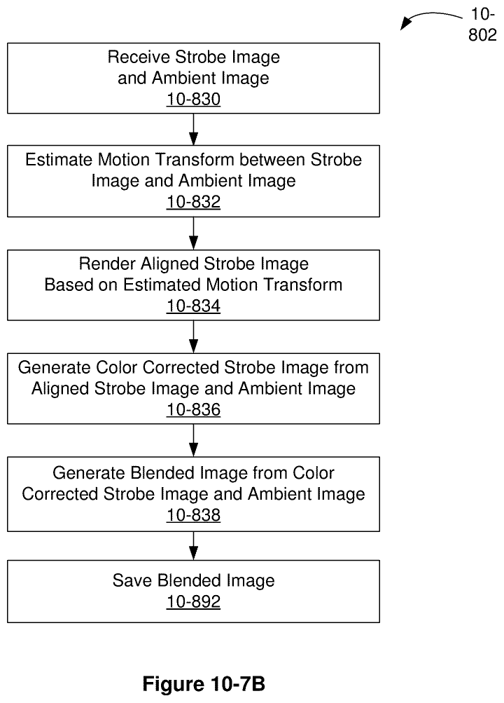

FIG. 10-1A illustrates a first data flow process 10-200 for generating a blended image 10-280 based on at least an ambient image 10-220 and a strobe image 10-210, according to one embodiment of the present invention. A strobe image 10-210 comprises a digital photograph sampled by camera unit 10-130 while strobe unit 10-136 is actively emitting strobe illumination 10-150. Ambient image 10-220 comprises a digital photograph sampled by camera unit 10-130 while strobe unit 10-136 is inactive and substantially not emitting strobe illumination 10-150.

In one embodiment, ambient image 10-220 is generated according to a prevailing ambient white balance for a scene being photographed. The prevailing ambient white balance may be computed using the well-known gray world model, an illuminator matching model, or any other technically feasible technique. Strobe image 10-210 should be generated according to an expected white balance for strobe illumination 10-150, emitted by strobe unit 10-136. Blend operation 10-270, discussed in greater detail below, blends strobe image 10-210 and ambient image 10-220 to generate a blended image 10-280 via preferential selection of image data from strobe image 10-210 in regions of greater intensity compared to corresponding regions of ambient image 10-220.

In one embodiment, data flow process 10-200 is performed by processor complex 10-110 within digital photographic system 10-100, and blend operation 10-270 is performed by at least one GPU core 10-172, one CPU core 10-170, or any combination thereof.

FIG. 10-1B illustrates a second data flow process 10-202 for generating a blended image 10-280 based on at least an ambient image 10-220 and a strobe image 10-210, according to one embodiment of the present invention. Strobe image 10-210 comprises a digital photograph sampled by camera unit 10-130 while strobe unit 10-136 is actively emitting strobe illumination 10-150. Ambient image 10-220 comprises a digital photograph sampled by camera unit 10-130 while strobe unit 10-136 is inactive and substantially not emitting strobe illumination 10-150.

In one embodiment, ambient image 10-220 is generated according to a prevailing ambient white balance for a scene being photographed. The prevailing ambient white balance may be computed using the well-known gray world model, an illuminator matching model, or any other technically feasible technique. In certain embodiments, strobe image 10-210 is generated according to the prevailing ambient white balance. In an alternative embodiment ambient image 10-220 is generated according to a prevailing ambient white balance, and strobe image 10-210 is generated according to an expected white balance for strobe illumination 10-150, emitted by strobe unit 10-136. In other embodiments, ambient image 10-220 and strobe image 10-210 comprise raw image data, having no white balance operation applied to either. Blended image 10-280 may be subjected to arbitrary white balance operations, as is common practice with raw image data, while advantageously retaining color consistency between regions dominated by ambient illumination and regions dominated by strobe illumination.

As a consequence of color balance differences between ambient illumination, which may dominate certain portions of strobe image 10-210 and strobe illumination 10-150, which may dominate other portions of strobe image 10-210, strobe image 10-210 may include color information in certain regions that is discordant with color information for the same regions in ambient image 10-220. Frame analysis operation 10-240 and color correction operation 10-250 together serve to reconcile discordant color information within strobe image 10-210. Frame analysis operation 10-240 generates color correction data 10-242, described in greater detail below, for adjusting color within strobe image 10-210 to converge spatial color characteristics of strobe image 10-210 to corresponding spatial color characteristics of ambient image 10-220. Color correction operation 10-250 receives color correction data 10-242 and performs spatial color adjustments to generate corrected strobe image data 10-252 from strobe image 10-210. Blend operation 10-270, discussed in greater detail below, blends corrected strobe image data 10-252 with ambient image 10-220 to generate blended image 10-280. Color correction data 10-242 may be generated to completion prior to color correction operation 10-250 being performed. Alternatively, certain portions of color correction data 10-242, such as spatial correction factors, may be generated as needed.

In one embodiment, data flow process 10-202 is performed by processor complex 10-110 within digital photographic system 10-100. In certain implementations, blend operation 10-270 and color correction operation 10-250 are performed by at least one GPU core 10-172, at least one CPU core 10-170, or a combination thereof. Portions of frame analysis operation 10-240 may be performed by at least one GPU core 10-172, one CPU core 10-170, or any combination thereof. Frame analysis operation 10-240 and color correction operation 10-250 are discussed in greater detail below.

FIG. 10-1C illustrates a third data flow process 10-204 for generating a blended image 10-280 based on at least an ambient image 10-220 and a strobe image 10-210, according to one embodiment of the present invention. Strobe image 10-210 comprises a digital photograph sampled by camera unit 10-130 while strobe unit 10-136 is actively emitting strobe illumination 10-150. Ambient image 10-220 comprises a digital photograph sampled by camera unit 10-130 while strobe unit 10-136 is inactive and substantially not emitting strobe illumination 10-150.

In one embodiment, ambient image 10-220 is generated according to a prevailing ambient white balance for a scene being photographed. The prevailing ambient white balance may be computed using the well-known gray world model, an illuminator matching model, or any other technically feasible technique. Strobe image 10-210 should be generated according to an expected white balance for strobe illumination 10-150, emitted by strobe unit 10-136.

In certain common settings, camera unit 10-130 is packed into a hand-held device, which may be subject to a degree of involuntary random movement or “shake” while being held in a user's hand. In these settings, when the hand-held device sequentially samples two images, such as strobe image 10-210 and ambient image 10-220, the effect of shake may cause misalignment between the two images. The two images should be aligned prior to blend operation 10-270, discussed in greater detail below. Alignment operation 10-230 generates an aligned strobe image 10-232 from strobe image 10-210 and an aligned ambient image 10-234 from ambient image 10-220. Alignment operation 10-230 may implement any technically feasible technique for aligning images or sub-regions.

In one embodiment, alignment operation 10-230 comprises an operation to detect point pairs between strobe image 10-210 and ambient image 10-220, an operation to estimate an affine or related transform needed to substantially align the point pairs. Alignment may then be achieved by executing an operation to resample strobe image 10-210 according to the affine transform thereby aligning strobe image 10-210 to ambient image 10-220, or by executing an operation to resample ambient image 10-220 according to the affine transform thereby aligning ambient image 10-220 to strobe image 10-210. Aligned images typically overlap substantially with each other, but may also have non-overlapping regions. Image information may be discarded from non-overlapping regions during an alignment operation. Such discarded image information should be limited to relatively narrow boundary regions. In certain embodiments, resampled images are normalized to their original size via a scaling operation performed by one or more GPU cores 10-172.

In one embodiment, the point pairs are detected using a technique known in the art as a Harris affine detector. The operation to estimate an affine transform may compute a substantially optimal affine transform between the detected point pairs, comprising pairs of reference points and offset points. In one implementation, estimating the affine transform comprises computing a transform solution that minimizes a sum of distances between each reference point and each offset point subjected to the transform. Persons skilled in the art will recognize that these and other techniques may be implemented for performing the alignment operation 10-230 without departing the scope and spirit of the present invention.

In one embodiment, data flow process 10-204 is performed by processor complex 10-110 within digital photographic system 10-100. In certain implementations, blend operation 10-270 and resampling operations are performed by at least one GPU core.

FIG. 10-1D illustrates a fourth data flow process 10-206 for generating a blended image 10-280 based on at least an ambient image 10-220 and a strobe image 10-210, according to one embodiment of the present invention. Strobe image 10-210 comprises a digital photograph sampled by camera unit 10-130 while strobe unit 10-136 is actively emitting strobe illumination 10-150. Ambient image 10-220 comprises a digital photograph sampled by camera unit 10-130 while strobe unit 10-136 is inactive and substantially not emitting strobe illumination 10-150.

In one embodiment, ambient image 10-220 is generated according to a prevailing ambient white balance for a scene being photographed. The prevailing ambient white balance may be computed using the well-known gray world model, an illuminator matching model, or any other technically feasible technique. In certain embodiments, strobe image 10-210 is generated according to the prevailing ambient white balance. In an alternative embodiment ambient image 10-220 is generated according to a prevailing ambient white balance, and strobe image 10-210 is generated according to an expected white balance for strobe illumination 10-150, emitted by strobe unit 10-136. In other embodiments, ambient image 10-220 and strobe image 10-210 comprise raw image data, having no white balance operation applied to either. Blended image 10-280 may be subjected to arbitrary white balance operations, as is common practice with raw image data, while advantageously retaining color consistency between regions dominated by ambient illumination and regions dominated by strobe illumination.

Alignment operation 10-230, discussed previously in FIG. 10-1C, generates an aligned strobe image 10-232 from strobe image 10-210 and an aligned ambient image 10-234 from ambient image 10-220. Alignment operation 10-230 may implement any technically feasible technique for aligning images.

Frame analysis operation 10-240 and color correction operation 10-250, both discussed previously in FIG. 10-1B, operate together to generate corrected strobe image data 10-252 from aligned strobe image 10-232. Blend operation 10-270, discussed in greater detail below, blends corrected strobe image data 10-252 with ambient image 10-220 to generate blended image 10-280.

Color correction data 10-242 may be generated to completion prior to color correction operation 10-250 being performed. Alternatively, certain portions of color correction data 10-242, such as spatial correction factors, may be generated as needed. In one embodiment, data flow process 10-206 is performed by processor complex 10-110 within digital photographic system 10-100.

While frame analysis operation 10-240 is shown operating on aligned strobe image 10-232 and aligned ambient image 10-234, certain global correction factors may be computed from strobe image 10-210 and ambient image 10-220. For example, in one embodiment, a frame level color correction factor, discussed below, may be computed from strobe image 10-210 and ambient image 10-220. In such an embodiment the frame level color correction may be advantageously computed in parallel with alignment operation 10-230, reducing overall time required to generate blended image 10-280.

In certain embodiments, strobe image 10-210 and ambient image 10-220 are partitioned into two or more tiles and color correction operation 10-250, blend operation 10-270, and resampling operations comprising alignment operation 10-230 are performed on a per tile basis before being combined into blended image 10-280. Persons skilled in the art will recognize that tiling may advantageously enable finer grain scheduling of computational tasks among CPU cores 10-170 and GPU cores 10-172. Furthermore, tiling enables GPU cores 10-172 to advantageously operate on images having higher resolution in one or more dimensions than native two-dimensional surface support may allow for the GPU cores. For example, certain generations of GPU core are only configured to operate on 2048 by 2048 pixel images, but popular mobile devices include camera resolution of more than 2048 in one dimension and less than 2048 in another dimension. In such a system, two tiles may be used to partition strobe image 10-210 and ambient image 10-220 into two tiles each, thereby enabling a GPU having a resolution limitation of 2048 by 2048 to operate on the images. In one embodiment, a first tile of blended image 10-280 is computed to completion before a second tile for blended image 10-280 is computed, thereby reducing peak system memory required by processor complex 10-110.

FIG. 10-2A illustrates image blend operation 10-270, according to one embodiment of the present invention. A strobe image 10-310 and an ambient image 10-320 of the same horizontal resolution (H-res) and vertical resolution (V-res) are combined via blend function 10-330 to generate blended image 10-280 having the same horizontal resolution and vertical resolution. In alternative embodiments, strobe image 10-310 or ambient image 10-320, or both images may be scaled to an arbitrary resolution defined by blended image 10-280 for processing by blend function 10-330. Blend function 10-330 is described in greater detail below in FIGS. 10-2B-10-2D.

As shown, strobe pixel 10-312 and ambient pixel 10-322 are blended by blend function 10-330 to generate blended pixel 10-332, stored in blended image 10-280. Strobe pixel 10-312, ambient pixel 10-322, and blended pixel 10-332 are located in substantially identical locations in each respective image.

In one embodiment, strobe image 10-310 corresponds to strobe image 10-210 of FIG. 10-1A and ambient image 10-320 corresponds to ambient image 10-220. In another embodiment, strobe image 10-310 corresponds to corrected strobe image data 10-252 of FIG. 10-1B and ambient image 10-320 corresponds to ambient image 10-220. In yet another embodiment, strobe image 10-310 corresponds to aligned strobe image 10-232 of FIG. 10-1C and ambient image 10-320 corresponds to aligned ambient image 10-234. In still yet another embodiment, strobe image 10-310 corresponds to corrected strobe image data 10-252 of FIG. 10-1D, and ambient image 10-320 corresponds to aligned ambient image 10-234.

Blend operation 10-270 may be performed by one or more CPU cores 10-170, one or more GPU cores 10-172, or any combination thereof. In one embodiment, blend function 10-330 is associated with a fragment shader, configured to execute within one or more GPU cores 10-172.

FIG. 10-2B illustrates blend function 10-330 of FIG. 10-2A for blending pixels associated with a strobe image and an ambient image, according to one embodiment of the present invention. As shown, a strobe pixel 10-312 from strobe image 10-310 and an ambient pixel 10-322 from ambient image 10-320 are blended to generate a blended pixel 10-332 associated with blended image 10-280.

Strobe intensity 10-314 is calculated for strobe pixel 10-312 by intensity function 10-340. Similarly, ambient intensity 10-324 is calculated by intensity function 10-340 for ambient pixel 10-322. In one embodiment, intensity function 10-340 implements Equation 10-1, where Cr, Cg, Cb are contribution constants and Red, Green, and Blue represent color intensity values for an associated pixel:

$$Intensity = Cr * Red + Cg * Green + Cb * Blue \qquad ( Eq . 10 ‐ 1 )$$

A sum of the contribution constants should be equal to a maximum range value for Intensity. For example, if Intensity is defined to range from 0.0 to 1.0, then Cr+Cg+Cb=1.0. In one embodiment Cr=Cg=Cb=⅓.

Blend value function 10-342 receives strobe intensity 10-314 and ambient intensity 10-324 and generates a blend value 10-344. Blend value function 10-342 is described in greater detail in FIGS. 10-2D and 10-2C. In one embodiment, blend value 10-344 controls a linear mix operation 10-346 between strobe pixel 10-312 and ambient pixel 10-322 to generate blended pixel 10-332. Linear mix operation 10-346 receives Red, Green, and Blue values for strobe pixel 10-312 and ambient pixel 10-322. Linear mix operation 10-346 receives blend value 10-344, which determines how much strobe pixel 10-312 versus how much ambient pixel 10-322 will be represented in blended pixel 10-332. In one embodiment, linear mix operation 10-346 is defined by Equation 10-2, where Out corresponds to blended pixel 10-332, Blend corresponds to blend value 10-344, “A” corresponds to a color vector comprising ambient pixel 10-322, and “B” corresponds to a color vector comprising strobe pixel 10-312.

$$Out = ( Blend * B ) + ( 1. - Blend ) * A \qquad ( Eq . 10 ‐ 2 )$$

When blend value 10-344 is equal to 1.0, blended pixel 10-332 is entirely determined by strobe pixel 10-312. When blend value 10-344 is equal to 0.0, blended pixel 10-332 is entirely determined by ambient pixel 10-322. When blend value 10-344 is equal to 0.5, blended pixel 10-332 represents a per component average between strobe pixel 10-312 and ambient pixel 10-322.

FIG. 10-2C illustrates a blend surface 10-302 for blending two pixels, according to one embodiment of the present invention. In one embodiment, blend surface 10-302 defines blend value function 10-342 of FIG. 10-2B. Blend surface 10-302 comprises a strobe dominant region 10-352 and an ambient dominant region 10-350 within a coordinate system defined by an axis for each of ambient intensity 10-324, strobe intensity 10-314, and blend value 10-344. Blend surface 10-302 is defined within a volume where ambient intensity 10-324, strobe intensity 10-314, and blend value 10-344 may range from 0.0 to 1.0. Persons skilled in the art will recognize that a range of 0.0 to 1.0 is arbitrary and other numeric ranges may be implemented without departing the scope and spirit of the present invention.

When ambient intensity 10-324 is larger than strobe intensity 10-314, blend value 10-344 may be defined by ambient dominant region 10-350. Otherwise, when strobe intensity 10-314 is larger than ambient intensity 10-324, blend value 10-344 may be defined by strobe dominant region 10-352. Diagonal 10-351 delineates a boundary between ambient dominant region 10-350 and strobe dominant region 10-352, where ambient intensity 10-324 is equal to strobe intensity 10-314. As shown, a discontinuity of blend value 10-344 in blend surface 10-302 is implemented along diagonal 10-351, separating ambient dominant region 10-350 and strobe dominant region 10-352.

For simplicity, a particular blend value 10-344 for blend surface 10-302 will be described herein as having a height above a plane that intersects three points including points at (1,0,0), (0,1,0), and the origin (0,0,0). In one embodiment, ambient dominant region 10-350 has a height 10-359 at the origin and strobe dominant region 10-352 has a height 10-358 above height 10-359. Similarly, ambient dominant region 10-350 has a height 10-357 above the plane at location (1,1), and strobe dominant region 10-352 has a height 10-356 above height 10-357 at location (1,1). Ambient dominant region 10-350 has a height 10-355 at location (1,0) and strobe dominant region 10-352 has a height of 354 at location (0,1).

In one embodiment, height 10-355 is greater than 0.0, and height 10-354 is less than 1.0. Furthermore, height 10-357 and height 10-359 are greater than 0.0 and height 10-356 and height 10-358 are each greater than 0.25. In certain embodiments, height 10-355 is not equal to height 10-359 or height 10-357. Furthermore, height 10-354 is not equal to the sum of height 10-356 and height 10-357, nor is height 10-354 equal to the sum of height 10-358 and height 10-359.

The height of a particular point within blend surface 10-302 defines blend value 10-344, which then determines how much strobe pixel 10-312 and ambient pixel 10-322 each contribute to blended pixel 10-332. For example, at location (0,1), where ambient intensity is 0.0 and strobe intensity is 1.0, the height of blend surface 10-302 is given as height 10-354, which sets blend value 10-344 to a value for height 10-354. This value is used as blend value 10-344 in mix operation 10-346 to mix strobe pixel 10-312 and ambient pixel 10-322. At (0,1), strobe pixel 10-312 dominates the value of blended pixel 10-332, with a remaining, small portion of blended pixel 10-322 contributed by ambient pixel 10-322. Similarly, at (1,0), ambient pixel 10-322 dominates the value of blended pixel 10-332, with a remaining, small portion of blended pixel 10-322 contributed by strobe pixel 10-312.

Ambient dominant region 10-350 and strobe dominant region 10-352 are illustrated herein as being planar sections for simplicity. However, as shown in FIG. 10-2D, certain curvature may be added, for example, to provide smoother transitions, such as along at least portions of diagonal 10-351, where strobe pixel 10-312 and ambient pixel 10-322 have similar intensity. A gradient, such as a table top or a wall in a given scene, may include a number of pixels that cluster along diagonal 10-351. These pixels may look more natural if the height difference between ambient dominant region 10-350 and strobe dominant region 10-352 along diagonal 10-351 is reduced compared to a planar section. A discontinuity along diagonal 10-351 is generally needed to distinguish pixels that should be strobe dominant versus pixels that should be ambient dominant. A given quantization of strobe intensity 10-314 and ambient intensity 10-324 may require a certain bias along diagonal 10-351, so that either ambient dominant region 10-350 or strobe dominant region 10-352 comprises a larger area within the plane than the other.

FIG. 10-2D illustrates a blend surface 10-304 for blending two pixels, according to another embodiment of the present invention. Blend surface 10-304 comprises a strobe dominant region 10-352 and an ambient dominant region 10-350 within a coordinate system defined by an axis for each of ambient intensity 10-324, strobe intensity 10-314, and blend value 10-344. Blend surface 10-304 is defined within a volume substantially identical to blend surface 10-302 of FIG. 10-2C.

As shown, upward curvature at locations (0,0) and (1,1) is added to ambient dominant region 10-350, and downward curvature at locations (0,0) and (1,1) is added to strobe dominant region 10-352. As a consequence, a smoother transition may be observed within blended image 10-280 for very bright and very dark regions, where color may be less stable and may diverge between strobe image 10-310 and ambient image 10-320. Upward curvature may be added to ambient dominant region 10-350 along diagonal 10-351 and corresponding downward curvature may be added to strobe dominant region 10-352 along diagonal 10-351.

In certain embodiments, downward curvature may be added to ambient dominant region 10-350 at (1,0), or along a portion of the axis for ambient intensity 10-324. Such downward curvature may have the effect of shifting the weight of mix operation 10-346 to favor ambient pixel 10-322 when a corresponding strobe pixel 10-312 has very low intensity.

In one embodiment, a blend surface, such as blend surface 10-302 or blend surface 10-304, is pre-computed and stored as a texture map that is established as an input to a fragment shader configured to implement blend operation 10-270. A surface function that describes a blend surface having an ambient dominant region 10-350 and a strobe dominant region 10-352 is implemented to generate and store the texture map. The surface function may be implemented on a CPU core 10-170 of FIG. 10-1A or a GPU core 10-172, or a combination thereof. The fragment shader executing on a GPU core may use the texture map as a lookup table implementation of blend value function 10-342. In alternative embodiments, the fragment shader implements the surface function and computes a blend value 10-344 as needed for each combination of a strobe intensity 10-314 and an ambient intensity 10-324. One exemplary surface function that may be used to compute a blend value 10-344 (blendValue) given an ambient intensity 10-324 (ambient) and a strobe intensity 10-314 (strobe) is illustrated below as pseudo-code in Table 10-1. A constant “e” is set to a value that is relatively small, such as a fraction of a quantization step for ambient or strobe intensity, to avoid dividing by zero. Height 10-355 corresponds to constant 0.125 divided by 3.0.

TABLE 10-1
fDivA = strobe/(ambient + e);
fDivB = (1.0 − ambient) / ((1.0 − strobe) + (1.0 − ambient) + e)
temp = (fDivA >= 1.0) ? 1.0 : 0.125;
blendValue = (temp + 2.0 * fDivB) / 3.0;

In certain embodiments, the blend surface is dynamically configured based on image properties associated with a given strobe image 10-310 and corresponding ambient image 10-320. Dynamic configuration of the blend surface may include, without limitation, altering one or more of heights 10-354 through 359, altering curvature associated with one or more of heights 10-354 through 359, altering curvature along diagonal 10-351 for ambient dominant region 10-350, altering curvature along diagonal 10-351 for strobe dominant region 10-352, or any combination thereof.

One embodiment of dynamic configuration of a blend surface involves adjusting heights associated with the surface discontinuity along diagonal 10-351. Certain images disproportionately include gradient regions having strobe pixels 10-312 and ambient pixels 10-322 of similar or identical intensity. Regions comprising such pixels may generally appear more natural as the surface discontinuity along diagonal 10-351 is reduced. Such images may be detected using a heat-map of ambient intensity 10-324 and strobe intensity 10-314 pairs within a surface defined by ambient intensity 10-324 and strobe intensity 10-314. Clustering along diagonal 10-351 within the heat-map indicates a large incidence of strobe pixels 10-312 and ambient pixels 10-322 having similar intensity within an associated scene. In one embodiment, clustering along diagonal 10-351 within the heat-map indicates that the blend surface should be dynamically configured to reduce the height of the discontinuity along diagonal 10-351. Reducing the height of the discontinuity along diagonal 10-351 may be implemented via adding downward curvature to strobe dominant region 10-352 along diagonal 10-351, adding upward curvature to ambient dominant region 10-350 along diagonal 10-351, reducing height 10-358, reducing height 10-356, or any combination thereof. Any technically feasible technique may be implemented to adjust curvature and height values without departing the scope and spirit of the present invention. Furthermore, any region of blend surfaces 10-302, 10-304 may be dynamically adjusted in response to image characteristics without departing the scope of the present invention.

In one embodiment, dynamic configuration of the blend surface comprises mixing blend values from two or more pre-computed lookup tables implemented as texture maps. For example, a first blend surface may reflect a relatively large discontinuity and relatively large values for heights 10-356 and 10-358, while a second blend surface may reflect a relatively small discontinuity and relatively small values for height 10-356 and 10-358. Here, blend surface 10-304 may be dynamically configured as a weighted sum of blend values from the first blend surface and the second blend surface. Weighting may be determined based on certain image characteristics, such as clustering of strobe intensity 10-314 and ambient intensity 10-324 pairs in certain regions within the surface defined by strobe intensity 10-314 and ambient intensity 10-324, or certain histogram attributes for strobe image 10-210 and ambient image 10-220. In one embodiment, dynamic configuration of one or more aspects of the blend surface, such as discontinuity height, may be adjusted according to direct user input, such as via a UI tool.

FIG. 10-2E illustrates an image blend operation for blending a strobe image with an ambient image to generate a blended image, according to one embodiment of the present invention. A strobe image 10-310 and an ambient image 10-320 of the same horizontal resolution and vertical resolution are combined via mix operation 10-346 to generate blended image 10-280 having the same resolution horizontal resolution and vertical resolution. In alternative embodiments, strobe image 10-310 or ambient image 10-320, or both images may be scaled to an arbitrary resolution defined by blended image 10-280 for processing by mix operation 10-346.

In certain settings, strobe image 10-310 and ambient image 10-320 include a region of pixels having similar intensity per pixel but different color per pixel. Differences in color may be attributed to differences in white balance for each image and different illumination contribution for each image. Because the intensity among adjacent pixels is similar, pixels within the region will cluster along diagonal 10-351 of FIGS. 10-2D and 10-2C, resulting in a distinctly unnatural speckling effect as adjacent pixels are weighted according to either strobe dominant region 10-352 or ambient dominant region 10-350. To soften this speckling effect and produce a natural appearance within these regions, blend values may be blurred, effectively reducing the discontinuity between strobe dominant region 10-352 and ambient dominant region 10-350. As is well-known in the art, blurring may be implemented by combining two or more individual samples.

In one embodiment, a blend buffer 10-315 comprises blend values 10-345, which are computed from a set of two or more blend samples. Each blend sample is computed according to blend function 10-330, described previously in FIGS. 10-2B-10-2D. In one embodiment, blend buffer 10-315 is first populated with blend samples, computed according to blend function 10-330. The blend samples are then blurred to compute each blend value 10-345, which is stored to blend buffer 10-315. In other embodiments, a first blend buffer is populated with blend samples computed according to blend function 10-330, and two or more blend samples from the first blend buffer are blurred together to generate blend each value 10-345, which is stored in blend buffer 10-315. In yet other embodiments, two or more blend samples from the first blend buffer are blurred together to generate each blend value 10-345 as needed. In still another embodiment, two or more pairs of strobe pixels 10-312 and ambient pixels 10-322 are combined to generate each blend value 10-345 as needed. Therefore, in certain embodiments, blend buffer 10-315 comprises an allocated buffer in memory, while in other embodiments blend buffer 10-315 comprises an illustrative abstraction with no corresponding allocation in memory.

As shown, strobe pixel 10-312 and ambient pixel 10-322 are mixed based on blend value 10-345 to generate blended pixel 10-332, stored in blended image 10-280. Strobe pixel 10-312, ambient pixel 10-322, and blended pixel 10-332 are located in substantially identical locations in each respective image.

In one embodiment, strobe image 10-310 corresponds to strobe image 10-210 and ambient image 10-320 corresponds to ambient image 10-220. In other embodiments, strobe image 10-310 corresponds to aligned strobe image 10-232 and ambient image 10-320 corresponds to aligned ambient image 10-234. In one embodiment, mix operation 10-346 is associated with a fragment shader, configured to execute within one or more GPU cores 10-172.

As discussed previously in FIGS. 10-1B and 10-1D, strobe image 10-210 may need to be processed to correct color that is divergent from color in corresponding ambient image 10-220. Strobe image 10-210 may include frame-level divergence, spatially localized divergence, or a combination thereof. FIGS. 10-3A and 10-3B describe techniques implemented in frame analysis operation 10-240 for computing color correction data 10-242. In certain embodiments, color correction data 10-242 comprises frame-level characterization data for correcting overall color divergence, and patch-level correction data for correcting localized color divergence. FIGS. 10-4A and 10-4B discuss techniques for implementing color correction operation 10-250, based on color correction data 10-242.

FIG. 10-3A illustrates a patch-level analysis process 10-400 for generating a patch correction array 10-450, according to one embodiment of the present invention. Patch-level analysis provides local color correction information for correcting a region of a source strobe image to be consistent in overall color balance with an associated region of a source ambient image. A patch corresponds to a region of one or more pixels within an associated source image. A strobe patch 10-412 comprises representative color information for a region of one or more pixels within strobe patch array 10-410, and an associated ambient patch 10-422 comprises representative color information for a region of one or more pixels at a corresponding location within ambient patch array 10-420.

In one embodiment, strobe patch array 10-410 and ambient patch array 10-420 are processed on a per patch basis by patch-level correction estimator 10-430 to generate patch correction array 10-450. Strobe patch array 10-410 and ambient patch array 10-420 each comprise a two-dimensional array of patches, each having the same horizontal patch resolution and the same vertical patch resolution. In alternative embodiments, strobe patch array 10-410 and ambient patch array 10-420 may each have an arbitrary resolution and each may be sampled according to a horizontal and vertical resolution for patch correction array 10-450.

In one embodiment, patch data associated with strobe patch array 10-410 and ambient patch array 10-420 may be pre-computed and stored for substantially entire corresponding source images. Alternatively, patch data associated with strobe patch array 10-410 and ambient patch array 10-420 may be computed as needed, without allocating buffer space for strobe patch array 10-410 or ambient patch array 10-420.

In data flow process 10-202 of FIG. 10-1B, the source strobe image comprises strobe image 10-210, while in data flow process 10-206 of FIG. 10-1D, the source strobe image comprises aligned strobe image 10-232. Similarly, ambient patch array 10-420 comprises a set of patches generated from a source ambient image. In data flow process 10-202, the source ambient image comprises ambient image 10-220, while in data flow process 10-206, the source ambient image comprises aligned ambient image 10-234.

In one embodiment, representative color information for each patch within strobe patch array 10-410 is generated by averaging color for a four-by-four region of pixels from the source strobe image at a corresponding location, and representative color information for each patch within ambient patch array 10-420 is generated by averaging color for a four-by-four region of pixels from the ambient source image at a corresponding location. An average color may comprise red, green and blue components. Each four-by-four region may be non-overlapping or overlapping with respect to other four-by-four regions. In other embodiments, arbitrary regions may be implemented. Patch-level correction estimator 10-430 generates patch correction 10-432 from strobe patch 10-412 and a corresponding ambient patch 10-422. In certain embodiments, patch correction 10-432 is saved to patch correction array 10-450 at a corresponding location. In one embodiment, patch correction 10-432 includes correction factors for red, green, and blue, computed according to the pseudo-code of Table 10-2, below.

TABLE 10-2
ratio.r = (ambient.r) / (strobe.r);
ratio.g = (ambient.g) / (strobe.g);
ratio.b = (ambient.b) / (strobe.b);
maxRatio = max(ratio.r, max(ratio.g, ratio.b));
correct.r = (ratio.r / maxRatio);
correct.g = (ratio.g / maxRatio);
correct.b = (ratio.b / maxRatio);

Here, “strobe.r” refers to a red component for strobe patch 10-412, “strobe.g” refers to a green component for strobe patch 10-412, and “strobe.b” refers to a blue component for strobe patch 10-412. Similarly, “ambient.r,” “ambient.g,” and “ambient.b” refer respectively to red, green, and blue components of ambient patch 10-422. A maximum ratio of ambient to strobe components is computed as “maxRatio,” which is then used to generate correction factors, including “correct.r” for a red channel, “correct.g” for a green channel, and “correct.b” for a blue channel. Correction factors correct.r, correct.g, and correct.b together comprise patch correction 10-432. These correction factors, when applied fully in color correction operation 10-250, cause pixels associated with strobe patch 10-412 to be corrected to reflect a color balance that is generally consistent with ambient patch 10-422.

In one alternative embodiment, each patch correction 10-432 comprises a slope and an offset factor for each one of at least red, green, and blue components. Here, components of source ambient image pixels bounded by a patch are treated as function input values and corresponding components of source strobe image pixels are treated as function outputs for a curve fitting procedure that estimates slope and offset parameters for the function. For example, red components of source ambient image pixels associated with a given patch may be treated as “X” values and corresponding red pixel components of source strobe image pixels may be treated as “Y” values, to form (X,Y) points that may be processed according to a least-squares linear fit procedure, thereby generating a slope parameter and an offset parameter for the red component of the patch. Slope and offset parameters for green and blue components may be computed similarly. Slope and offset parameters for a component describe a line equation for the component. Each patch correction 10-432 includes slope and offset parameters for at least red, green, and blue components. Conceptually, pixels within an associated strobe patch may be color corrected by evaluating line equations for red, green, and blue components.

In a different alternative embodiment, each patch correction 10-432 comprises three parameters describing a quadratic function for each one of at least red, green, and blue components. Here, components of source strobe image pixels bounded by a patch are fit against corresponding components of source ambient image pixels to generate quadratic parameters for color correction. Conceptually, pixels within an associated strobe patch may be color corrected by evaluating quadratic equations for red, green, and blue components.

FIG. 10-3B illustrates a frame-level analysis process 10-402 for generating frame-level characterization data 10-492, according to one embodiment of the present invention. Frame-level correction estimator 10-490 reads strobe data 10-472 comprising pixels from strobe image data 10-470 and ambient data 10-482 comprising pixels from ambient image data 10-480 to generate frame-level characterization data 10-492.

In certain embodiments, strobe data 10-472 comprises pixels from strobe image 10-210 of FIG. 10-1A and ambient data 10-482 comprises pixels from ambient image 10-220. In other embodiments, strobe data 10-472 comprises pixels from aligned strobe image 10-232 of FIG. 10-1C, and ambient data 10-482 comprises pixels from aligned ambient image 10-234. In yet other embodiments, strobe data 10-472 comprises patches representing average color from strobe patch array 10-410, and ambient data 10-482 comprises patches representing average color from ambient patch array 10-420.

In one embodiment, frame-level characterization data 10-492 includes at least frame-level color correction factors for red correction, green correction, and blue correction. Frame-level color correction factors may be computed according to the pseudo-code of Table 10-3.

TABLE 10-3
ratioSum.r = (ambientSum.r) / (strobeSum.r);
ratioSum.g = (ambientSum.g) / (strobeSum.g);
ratioSum.b = (ambientSum.b) / (strobeSum.b);
maxSumRatio = max(ratioSum.r, max(ratioSum.g, ratioSum.b));
correctFrame.r = (ratioSum.r / maxSumRatio);
correctFrame.g = (ratioSum.g / maxSumRatio);
correctFrame.b = (ratioSum.b / maxSumRatio);

Here, “strobeSum.r” refers to a sum of red components taken over strobe image data 10-470, “strobeSum.g” refers to a sum of green components taken over strobe image data 10-470, and “strobeSum.b” refers to a sum of blue components taken over strobe image data 10-470. Similarly, “ambientSum.r,” “ambientSum.g,” and “ambientSum.b” each refer to a sum of components taken over ambient image data 10-480 for respective red, green, and blue components. A maximum ratio of ambient to strobe sums is computed as “maxSumRatio,” which is then used to generate frame-level color correction factors, including “correctFrame.r” for a red channel, “correctFrame.g” for a green channel, and “correctFrame.b” for a blue channel. These frame-level color correction factors, when applied fully and exclusively in color correction operation 10-250, cause overall color balance of strobe image 10-210 to be corrected to reflect a color balance that is generally consistent with that of ambient image 10-220.

While overall color balance for strobe image 10-210 may be corrected to reflect overall color balance of ambient image 10-220, a resulting color corrected rendering of strobe image 10-210 based only on frame-level color correction factors may not have a natural appearance and will likely include local regions with divergent color with respect to ambient image 10-220. Therefore, as described below in FIG. 10-4A, patch-level correction may be used in conjunction with frame-level correction to generate a color corrected strobe image.

In one embodiment, frame-level characterization data 10-492 also includes at least a histogram characterization of strobe image data 10-470 and a histogram characterization of ambient image data 10-480. Histogram characterization may include identifying a low threshold intensity associated with a certain low percentile of pixels, a median threshold intensity associated with a fiftieth percentile of pixels, and a high threshold intensity associated with a high threshold percentile of pixels. In one embodiment, the low threshold intensity is associated with an approximately fifteenth percentile of pixels and a high threshold intensity is associated with an approximately eighty-fifth percentile of pixels, so that approximately fifteen percent of pixels within an associated image have a lower intensity than a calculated low threshold intensity and approximately eighty-five percent of pixels have a lower intensity than a calculated high threshold intensity.

In certain embodiments, frame-level characterization data 10-492 also includes at least a heat-map, described previously. The heat-map may be computed using individual pixels or patches representing regions of pixels. In one embodiment, the heat-map is normalized using a logarithm operator, configured to normalize a particular heat-map location against a logarithm of a total number of points contributing to the heat-map. Alternatively, frame-level characterization data 10-492 includes a factor that summarizes at least one characteristic of the heat-map, such as a diagonal clustering factor to quantify clustering along diagonal 10-351 of FIGS. 10-2C and 10-2D. This diagonal clustering factor may be used to dynamically configure a given blend surface.

While frame-level and patch-level correction coefficients have been discussed representing two different spatial extents, persons skilled in the art will recognize that more than two levels of spatial extent may be implemented without departing the scope and spirit of the present invention.

FIG. 10-4A illustrates a data flow process 10-500 for correcting strobe pixel color, according to one embodiment of the present invention. A strobe pixel 10-520 is processed to generate a color corrected strobe pixel 10-512. In one embodiment, strobe pixel 10-520 comprises a pixel associated with strobe image 10-210 of FIG. 10-1B, ambient pixel 10-522 comprises a pixel associated with ambient image 10-220, and color corrected strobe pixel 10-512 comprises a pixel associated with corrected strobe image data 10-252. In an alternative embodiment, strobe pixel 10-520 comprises a pixel associated with aligned strobe image 10-232 of FIG. 10-1D, ambient pixel 10-522 comprises a pixel associated with aligned ambient image 10-234, and color corrected strobe pixel 10-512 comprises a pixel associated with corrected strobe image data 10-252. Color corrected strobe pixel 10-512 may correspond to strobe pixel 10-312 in FIG. 10-2A, and serve as an input to blend function 10-330.

In one embodiment, patch-level correction factors 10-525 comprise one or more sets of correction factors for red, green, and blue associated with patch correction 10-432 of FIG. 10-3A, frame-level correction factors 10-527 comprise frame-level correction factors for red, green, and blue associated with frame-level characterization data 10-492 of FIG. 10-3B, and frame-level histogram factors 10-529 comprise at least a low threshold intensity and a median threshold intensity for both an ambient histogram and a strobe histogram associated with frame-level characterization data 10-492.

A pixel-level trust estimator 10-502 computes a pixel-level trust factor 10-503 from strobe pixel 10-520 and ambient pixel 10-522. In one embodiment, pixel-level trust factor 10-503 is computed according to the pseudo-code of Table 10-4, where strobe pixel 10-520 corresponds to strobePixel, ambient pixel 10-522 corresponds to ambientPixel, and pixel-level trust factor 10-503 corresponds to pixelTrust. Here, ambientPixel and strobePixel may comprise a vector variable, such as a well known vec3 or vec4 vector variable.

TABLE 10-4
ambientIntensity = intensity (ambientPixel);
strobeIntensity = intensity (strobePixel);
stepInput = ambientIntensity * strobeIntensity;
pixelTrust = smoothstep (lowEdge, highEdge, stepInput);

Here, an intensity function may implement Equation 10-1 to compute ambientIntensity and strobeIntensity, corresponding respectively to an intensity value for ambientPixel and an intensity value for strobePixel. While the same intensity function is shown computing both ambientIntensity and strobeIntensity, certain embodiments may compute each intensity value using a different intensity function. A product operator may be used to compute stepinput, based on ambientIntensity and strobeIntensity. The well-known smoothstep function implements a relatively smoothly transition from 0.0 to 1.0 as stepinput passes through lowEdge and then through highEdge. In one embodiment, lowEge=0.25 and highEdge=0.66.

A patch-level correction estimator 10-504 computes patch-level correction factors 10-505 by sampling patch-level correction factors 10-525. In one embodiment, patch-level correction estimator 10-504 implements bilinear sampling over four sets of patch-level color correction samples to generate sampled patch-level correction factors 10-505. In an alternative embodiment, patch-level correction estimator 10-504 implements distance weighted sampling over four or more sets of patch-level color correction samples to generate sampled patch-level correction factors 10-505. In another alternative embodiment, a set of sampled patch-level correction factors 10-505 is computed using pixels within a region centered about strobe pixel 10-520. Persons skilled in the art will recognize that any technically feasible technique for sampling one or more patch-level correction factors to generate sampled patch-level correction factors 10-505 is within the scope and spirit of the present invention.

In one embodiment, each one of patch-level correction factors 10-525 comprises a red, green, and blue color channel correction factor. In a different embodiment, each one of the patch-level correction factors 10-525 comprises a set of line equation parameters for red, green, and blue color channels. Each set of line equation parameters may include a slope and an offset. In another embodiment, each one of the patch-level correction factors 10-525 comprises a set of quadratic curve parameters for red, green, and blue color channels. Each set of quadratic curve parameters may include a square term coefficient, a linear term coefficient, and a constant.

In one embodiment, frame-level correction adjuster 10-506 computes adjusted frame-level correction factors 10-507 (adjCorrectFrame) from the frame-level correction factors for red, green, and blue according to the pseudo-code of Table 10-5. Here, a mix operator may function according to Equation 10-2, where variable A corresponds to 1.0, variable B corresponds to a correctFrame color value, and frameTrust may be computed according to an embodiment described below in conjunction with the pseudo-code of Table 10-5. As discussed previously, correctFrame comprises frame-level correction factors. Parameter frameTrust quantifies how trustworthy a particular pair of ambient image and strobe image may be for performing frame-level color correction.

TABLE 10-5
adjCorrectFrame.r = mix(1.0, correctFrame.r, frameTrust);
adjCorrectFrame.g = mix(1.0, correctFrame.g, frameTrust);
adjCorrectFrame.b = mix(1.0, correctFrame.b, frameTrust);

When frameTrust approaches zero (correction factors not trustworthy), the adjusted frame-level correction factors 10-507 converge to 1.0, which yields no frame-level color correction. When frameTrust is 1.0 (completely trustworthy), the adjusted frame-level correction factors 10-507 converge to values calculated previously in Table 10-3. The pseudo-code of Table 10-6 illustrates one technique for calculating frameTrust.

TABLE 10-6
strobeExp = (WSL*SL + WSM*SM + WSH*SH) /
(WSL + WSM + WSH);
ambientExp = (WAL*SL + WAM*SM + WAH*SH) /
(WAL + WAM + WAH);
frameTrustStrobe = smoothstep (SLE, SHE, strobeExp);
frameTrustAmbient = smoothstep (ALE, AHE, ambientExp);
frameTrust = frameTrustStrobe * frameTrustAmbient;

Here, strobe exposure (strobeExp) and ambient exposure (ambientExp) are each characterized as a weighted sum of corresponding low threshold intensity, median threshold intensity, and high threshold intensity values. Constants WSL, WSM, and WSH correspond to strobe histogram contribution weights for low threshold intensity, median threshold intensity, and high threshold intensity values, respectively. Variables SL, SM, and SH correspond to strobe histogram low threshold intensity, median threshold intensity, and high threshold intensity values, respectively. Similarly, constants WAL, WAM, and WAH correspond to ambient histogram contribution weights for low threshold intensity, median threshold intensity, and high threshold intensity values, respectively; and variables AL, AM, and AH correspond to ambient histogram low threshold intensity, median threshold intensity, and high threshold intensity values, respectively. A strobe frame-level trust value (frameTrustStrobe) is computed for a strobe frame associated with strobe pixel 10-520 to reflect how trustworthy the strobe frame is for the purpose of frame-level color correction. In one embodiment, WSL=WAL=1.0, WSM=WAM=2.0, and WSH=WAH=0.0. In other embodiments, different weights may be applied, for example, to customize the techniques taught herein to a particular camera apparatus. In certain embodiments, other percentile thresholds may be measured, and different combinations of weighted sums may be used to compute frame-level trust values.

In one embodiment, a smoothstep function with a strobe low edge (SLE) and strobe high edge (SHE) is evaluated based on strobeExp. Similarly, a smoothstep function with ambient low edge (ALE) and ambient high edge (AHE) is evaluated to compute an ambient frame-level trust value (frameTrustAmbient) for an ambient frame associated with ambient pixel 10-522 to reflect how trustworthy the ambient frame is for the purpose of frame-level color correction. In one embodiment, SLE=ALE=0.15, and SHE=AHE=0.30. In other embodiments, different low and high edge values may be used.

In one embodiment, a frame-level trust value (frameTrust) for frame-level color correction is computed as the product of frameTrustStrobe and frameTrustAmbient. When both the strobe frame and the ambient frame are sufficiently exposed and therefore trustworthy frame-level color references, as indicated by frameTrustStrobe and frameTrustAmbient, the product of frameTrustStrobe and frameTrustAmbient will reflect a high trust for frame-level color correction. If either the strobe frame or the ambient frame is inadequately exposed to be a trustworthy color reference, then a color correction based on a combination of strobe frame and ambient frame should not be trustworthy, as reflected by a low or zero value for frameTrust.

In an alternative embodiment, the frame-level trust value (frameTrust) is generated according to direct user input, such as via a UI color adjustment tool having a range of control positions that map to a frameTrust value. The UI color adjustment tool may generate a full range of frame-level trust values (0.0 to 1.0) or may generate a value constrained to a computed range. In certain settings, the mapping may be non-linear to provide a more natural user experience. In one embodiment, the control position also influences pixel-level trust factor 10-503 (pixelTrust), such as via a direct bias or a blended bias.

A pixel-level correction estimator 10-508 is configured to generate pixel-level correction factors 10-509 (pixCorrection) from sampled patch-level correction factors 10-505 (correct), adjusted frame-level correction factors 10-507, and pixel-level trust factor 10-503. In one embodiment, pixel-level correction estimator 10-508 comprises a mix function, whereby sampled patch-level correction factors 10-505 is given substantially full mix weight when pixel-level trust factor 10-503 is equal to 1.0 and adjusted frame-level correction factors 10-507 is given substantially full mix weight when pixel-level trust factor 10-503 is equal to 0.0. Pixel-level correction estimator 10-508 may be implemented according to the pseudo-code of Table 10-7.

TABLE 10-7
pixCorrection.r = mix(adjCorrectFrame.r, correct.r, pixelTrust);
pixCorrection.g= mix(adjCorrectFrame.g, correct.g, pixelTrust);
pixCorrection.b = mix(adjCorrectFrame.b, correct.b, pixelTrust);

In another embodiment, line equation parameters comprising slope and offset define sampled patch-level correction factors 10-505 and adjusted frame-level correction factors 10-507. These line equation parameters are mixed within pixel-level correction estimator 10-508 according to pixelTrust to yield pixel-level correction factors 10-509 comprising line equation parameters for red, green, and blue channels. In yet another embodiment, quadratic parameters define sampled patch-level correction factors 10-505 and adjusted frame-level correction factors 10-507. In one embodiment, the quadratic parameters are mixed within pixel-level correction estimator 10-508 according to pixelTrust to yield pixel-level correction factors 10-509 comprising quadratic parameters for red, green, and blue channels. In another embodiment, quadratic equations are evaluated separately for frame-level correction factors and patch level correction factors for each color channel, and the results of evaluating the quadratic equations are mixed according to pixelTrust.

In certain embodiments, pixelTrust is at least partially computed by image capture information, such as exposure time or exposure ISO index. For example, if an image was captured with a very long exposure at a very high ISO index, then the image may include significant chromatic noise and may not represent a good frame-level color reference for color correction.

Pixel-level correction function 10-510 generates color corrected strobe pixel 10-512 from strobe pixel 10-520 and pixel-level correction factors 10-509. In one embodiment, pixel-level correction factors 10-509 comprise correction factors pixCorrection.r, pixCorrection.g, and pixCorrection.b and color corrected strobe pixel 10-512 is computed according to the pseudo-code of Table 10-8.

TABLE 10-8
// scale red, green, blue
vec3 pixCorrection = (pixCorrection.r, pixCorrection.g, pixCorrection.b);
vec3 deNormCorrectedPixel = strobePixel * pixCorrection;
normalizeFactor = length(strobePixel) / length(deNormCorrectedPixel);
vec3 normCorrectedPixel = deNormCorrectedPixel * normalizeFactor;
vec3 correctedPixel = cAttractor(normCorrectedPixel);

Here, pixCorrection comprises a vector of three components (vec3) corresponding pixel-level correction factors pixCorrection.r, pixCorrection.g, and pixCorrection.b. A de-normalized, color corrected pixel is computed as deNormCorrectedPixel. A pixel comprising a red, green, and blue component defines a color vector in a three-dimensional space, the color vector having a particular length. The length of a color vector defined by deNormCorrectedPixel may be different with respect to a color vector defined by strobePixel. Altering the length of a color vector changes the intensity of a corresponding pixel. To maintain proper intensity for color corrected strobe pixel 10-512, deNormCorrectedPixel is re-normalized via normalizeFactor, which is computed as a ratio of length for a color vector defined by strobePixel to a length for a color vector defined by deNormCorrectedPixel. Color vector normCorrectedPixel includes pixel-level color correction and re-normalization to maintain proper pixel intensity. A length function may be performed using any technically feasible technique, such as calculating a square root of a sum of squares for individual vector component lengths.

A chromatic attractor function (cAttractor) gradually converges an input color vector to a target color vector as the input color vector increases in length. Below a threshold length, the chromatic attractor function returns the input color vector. Above the threshold length, the chromatic attractor function returns an output color vector that is increasingly convergent on the target color vector. The chromatic attractor function is described in greater detail below in FIG. 10-4B.

In alternative embodiments, pixel-level correction factors comprise a set of line equation parameters per color channel, with color components of strobePixel comprising function inputs for each line equation. In such embodiments, pixel-level correction function 10-510 evaluates the line equation parameters to generate color corrected strobe pixel 10-512. This evaluation process is illustrated in the pseudo-code of Table 10-9.

TABLE 10-9
// evaluate line equation based on strobePixel for red, green, blue
vec3 pixSlope = (pixSlope.r, pixSlope.g, pixSlope.b);
vec3 pixOffset = (pixOffset.r, pixOffset.g, pixOffset.b);
vec3 deNormCorrectedPixel = (strobePixel * pixSlope) + pixOffset;
normalizeFactor = length(strobePixel) / length(deNormCorrectedPixel);
vec3 normCorrectedPixel = deNormCorrectedPixel * normalizeFactor;
vec3 correctedPixel = cAttractor(normCorrectedPixel);

In other embodiments, pixel level correction factors comprise a set of quadratic parameters per color channel, with color components of strobePixel comprising function inputs for each quadratic equation. In such embodiments, pixel-level correction function 10-510 evaluates the quadratic equation parameters to generate color corrected strobe pixel 10-512.

In certain embodiments chromatic attractor function (cAttractor) implements a target color vector of white (1, 1, 1), and causes very bright pixels to converge to white, providing a natural appearance to bright portions of an image. In other embodiments, a target color vector is computed based on spatial color information, such as an average color for a region of pixels surrounding the strobe pixel. In still other embodiments, a target color vector is computed based on an average frame-level color. A threshold length associated with the chromatic attractor function may be defined as a constant, or, without limitation, by a user input, a characteristic of a strobe image or an ambient image or a combination thereof. In an alternative embodiment, pixel-level correction function 10-510 does not implement the chromatic attractor function.

In one embodiment, a trust level is computed for each patch-level correction and applied to generate an adjusted patch-level correction factor comprising sampled patch-level correction factors 10-505. Generating the adjusted patch-level correction may be performed according to the techniques taught herein for generating adjusted frame-level correction factors 10-507.

Other embodiments include two or more levels of spatial color correction for a strobe image based on an ambient image, where each level of spatial color correction may contribute a non-zero weight to a color corrected strobe image comprising one or more color corrected strobe pixels. Such embodiments may include patches of varying size comprising varying shapes of pixel regions without departing the scope of the present invention.

FIG. 10-4B illustrates a chromatic attractor function 10-560, according to one embodiment of the present invention. A color vector space is shown having a red axis 10-562, a green axis 10-564, and a blue axis 10-566. A unit cube 10-570 is bounded by an origin at coordinate (0, 0, 0) and an opposite corner at coordinate (1, 1, 1). A surface 10-572 having a threshold distance from the origin is defined within the unit cube. Color vectors having a length that is shorter than the threshold distance are conserved by the chromatic attractor function 10-560. Color vectors having a length that is longer than the threshold distance are converged towards a target color. For example, an input color vector 10-580 is defined along a particular path that describes the color of the input color vector 10-580, and a length that describes the intensity of the color vector. The distance from the origin to point 10-582 along input color vector 10-580 is equal to the threshold distance. In this example, the target color is pure white (1, 1, 1), therefore any additional length associated with input color vector 10-580 beyond point 10-582 follows path 10-584 towards the target color of pure white.

One implementation of chromatic attractor function 10-560, comprising the cAttractor function of Tables 10-8 and 10-9 is illustrated in the pseudo-code of Table 10-10.

TABLE 10-10

extraLength = max(length (inputColor), distMin) ;
mixValue= (extraLength − distMin) / (distMax− distMin);
outputColor = mix (inputColor, targetColor, mixValue);

Here, a length value associated with inputColor is compared to distMin, which represents the threshold distance. If the length value is less than distMin, then the “max” operator returns distMin. The mixValue term calculates a parameterization from 0.0 to 1.0 that corresponds to a length value ranging from the threshold distance to a maximum possible length for the color vector, given by the square root of 3.0. If extraLength is equal to distMin, then mixValue is set equal to 0.0 and outputColor is set equal to the inputColor by the mix operator. Otherwise, if the length value is greater than distMin, then mixValue represents the parameterization, enabling the mix operator to appropriately converge inputColor to targetColor as the length of inputColor approaches the square root of 3.0. In one embodiment, distMax is equal to the square root of 3.0 and distMin=1.45. In other embodiments different values may be used for distMax and distMin. For example, if distMin=1.0, then chromatic attractor 10-560 begins to converge to targetColor much sooner, and at lower intensities. If distMax is set to a larger number, then an inputPixel may only partially converge on targetColor, even when inputPixel has a very high intensity. Either of these two effects may be beneficial in certain applications.

While the pseudo-code of Table 10-10 specifies a length function, in other embodiments, computations may be performed in length-squared space using constant squared values with comparable results.

In one embodiment, targetColor is equal to (1,1,1), which represents pure white and is an appropriate color to “burn” to in overexposed regions of an image rather than a color dictated solely by color correction. In another embodiment, targetColor is set to a scene average color, which may be arbitrary. In yet another embodiment, targetColor is set to a color determined to be the color of an illumination source within a given scene.

FIG. 10-5 is a flow diagram of method 10-500 for generating an adjusted digital photograph, according to one embodiment of the present invention. Although the method steps are described in conjunction with the systems disclosed herein, persons skilled in the art will understand that any system configured to perform the method steps, in any order, is within the scope of the present invention.

Method 10-500 begins in step 10-510, where a digital photographic system, such as digital photographic system 300 of FIG. 3A, receives a trigger command to take a digital photograph. The trigger command may comprise a user input event, such as a button press, remote control command related to a button press, completion of a timer count down, an audio indication, or any other technically feasible user input event. In one embodiment, the digital photographic system implements digital camera 302 of FIG. 3C, and the trigger command is generated when shutter release button 315 is pressed. In another embodiment, the digital photographic system implements mobile device 376 of FIG. 3D, and the trigger command is generated when a UI button is pressed.

In step 10-512, the digital photographic system samples a strobe image and an ambient image. In one embodiment, the strobe image is taken before the ambient image. Alternatively, the ambient image is taken before the strobe image. In certain embodiments, a white balance operation is performed on the ambient image. Independently, a white balance operation may be performed on the strobe image. In other embodiments, such as in scenarios involving raw digital photographs, no white balance operation is applied to either the ambient image or the strobe image.

In step 10-514, the digital photographic system generates a blended image from the strobe image and the ambient image. In one embodiment, the digital photographic system generates the blended image according to data flow process 10-200 of FIG. 10-1A. In a second embodiment, the digital photographic system generates the blended image according to data flow process 10-202 of FIG. 10-1B. In a third embodiment, the digital photographic system generates the blended image according to data flow process 10-204 of FIG. 10-1C. In a fourth embodiment, the digital photographic system generates the blended image according to data flow process 10-206 of FIG. 10-1D. In each of these embodiments, the strobe image comprises strobe image 10-210, the ambient image comprises ambient image 10-220, and the blended image comprises blended image 10-280.

In step 10-516, the digital photographic system presents an adjustment tool configured to present at least the blended image, the strobe image, and the ambient image, according to a transparency blend among two or more of the images. The transparency blend may be controlled by a user interface slider. The adjustment tool may be configured to save a particular blend state of the images as an adjusted image. The adjustment tool is described in greater detail hereinabove.

The method terminates in step 10-590, where the digital photographic system saves at least the adjusted image.

FIG. 10-6A is a flow diagram of method 10-700 for blending a strobe image with an ambient image to generate a blended image, according to a first embodiment of the present invention. Although the method steps are described in conjunction with the systems of FIGS. 3A-3D, persons skilled in the art will understand that any system configured to perform the method steps, in any order, is within the scope of the present invention. In one embodiment, method 10-700 implements data flow 10-200 of FIG. 10-1A. The strobe image and the ambient image each comprise at least one pixel and may each comprise an equal number of pixels.

The method begins in step 10-710, where a processor complex within a digital photographic system, such as processor complex 310 within digital photographic system 300 of FIG. 3A, receives a strobe image and an ambient image, such as strobe image 10-210 and ambient image 10-220, respectively. In step 10-712, the processor complex generates a blended image, such as blended image 10-280, by executing a blend operation 10-270 on the strobe image and the ambient image. The method terminates in step 10-790, where the processor complex saves the blended image, for example to NV memory 316, volatile memory 318, or memory system 362.

FIG. 10-6B is a flow diagram of method 10-702 for blending a strobe image with an ambient image to generate a blended image, according to a second embodiment of the present invention. Although the method steps are described in conjunction with the systems of FIGS. 3A-3D, persons skilled in the art will understand that any system configured to perform the method steps, in any order, is within the scope of the present invention. In one embodiment, method 10-702 implements data flow 10-202 of FIG. 10-1B. The strobe image and the ambient image each comprise at least one pixel and may each comprise an equal number of pixels.

The method begins in step 10-720, where a processor complex within a digital photographic system, such as processor complex 310 within digital photographic system 300 of FIG. 3A, receives a strobe image and an ambient image, such as strobe image 10-210 and ambient image 10-220, respectively. In step 10-722, the processor complex generates a color corrected strobe image, such as corrected strobe image data 10-252, by executing a frame analysis operation 10-240 on the strobe image and the ambient image and executing and a color correction operation 10-250 on the strobe image. In step 10-724, the processor complex generates a blended image, such as blended image 10-280, by executing a blend operation 10-270 on the color corrected strobe image and the ambient image. The method terminates in step 10-792, where the processor complex saves the blended image, for example to NV memory 316, volatile memory 318, or memory system 362.

FIG. 10-7A is a flow diagram of method 10-800 for blending a strobe image with an ambient image to generate a blended image, according to a third embodiment of the present invention. Although the method steps are described in conjunction with the systems of FIGS. 3A-3D, persons skilled in the art will understand that any system configured to perform the method steps, in any order, is within the scope of the present invention. In one embodiment, method 10-800 implements data flow 10-204 of FIG. 10-1C. The strobe image and the ambient image each comprise at least one pixel and may each comprise an equal number of pixels.

The method begins in step 10-810, where a processor complex within a digital photographic system, such as processor complex 310 within digital photographic system 300 of FIG. 3A, receives a strobe image and an ambient image, such as strobe image 10-210 and ambient image 10-220, respectively. In step 10-812, the processor complex estimates a motion transform between the strobe image and the ambient image. In step 10-814, the processor complex renders at least an aligned strobe image or an aligned ambient image based the estimated motion transform. In certain embodiments, the processor complex renders both the aligned strobe image and the aligned ambient image based on the motion transform. The aligned strobe image and the aligned ambient image may be rendered to the same resolution so that each is aligned to the other. In one embodiment, steps 10-812 and 814 together comprise alignment operation 10-230. In step 10-816, the processor complex generates a blended image, such as blended image 10-280, by executing a blend operation 10-270 on the aligned strobe image and the aligned ambient image. The method terminates in step 10-890, where the processor complex saves the blended image, for example to NV memory 316, volatile memory 318, or memory system 362.

FIG. 10-7B is a flow diagram of method steps for blending a strobe image with an ambient image to generate a blended image, according to a fourth embodiment of the present invention. Although the method steps are described in conjunction with the systems of FIGS. 3A-3D, persons skilled in the art will understand that any system configured to perform the method steps, in any order, is within the scope of the present invention. In one embodiment, method 10-802 implements data flow 10-206 of FIG. 10-1D. The strobe image and the ambient image each comprise at least one pixel and may each comprise an equal number of pixels.

The method begins in step 10-830, where a processor complex within a digital photographic system, such as processor complex 310 within digital photographic system 300 of FIG. 3A, receives a strobe image and an ambient image, such as strobe image 10-10 and ambient image 10-220, respectively. In step 10-832, the processor complex estimates a motion transform between the strobe image and the ambient image. In step 10-834, the processor complex may render at least an aligned strobe image or an aligned ambient image based the estimated motion transform. In certain embodiments, the processor complex renders both the aligned strobe image and the aligned ambient image based on the motion transform. The aligned strobe image and the aligned ambient image may be rendered to the same resolution so that each is aligned to the other. In one embodiment, steps 10-832 and 834 together comprise alignment operation 10-230.

In step 10-836, the processor complex generates a color corrected strobe image, such as corrected strobe image data 10-252, by executing a frame analysis operation 10-240 on the aligned strobe image and the aligned ambient image and executing a color correction operation 10-250 on the aligned strobe image. In step 10-838, the processor complex generates a blended image, such as blended image 10-280, by executing a blend operation 10-270 on the color corrected strobe image and the aligned ambient image. The method terminates in step 10-892, where the processor complex saves the blended image, for example to NV memory 316, volatile memory 318, or memory system 362.

While the techniques taught herein are discussed above in the context of generating a digital photograph having a natural appearance from an underlying strobe image and ambient image with potentially discordant color, these techniques may be applied in other usage models as well.

For example, when compositing individual images to form a panoramic image, color inconsistency between two adjacent images can create a visible seam, which detracts from overall image quality. Persons skilled in the art will recognize that frame analysis operation 10-240 may be used in conjunction with color correction operation 10-250 to generated panoramic images with color-consistent seams, which serve to improve overall image quality. In another example, frame analysis operation 10-240 may be used in conjunction with color correction operation 10-250 to improve color consistency within high dynamic range (HDR) images.

In yet another example, multispectral imaging may be improved by enabling the addition of a strobe illuminator, while maintaining spectral consistency. Multispectral imaging refers to imaging of multiple, arbitrary wavelength ranges, rather than just conventional red, green, and blue ranges. By applying the above techniques, a multispectral image may be generated by blending two or more multispectral images having different illumination sources.

In still other examples, the techniques taught herein may be applied in an apparatus that is separate from digital photographic system 10-100 of FIG. 10-1A. Here, digital photographic system 10-100 may be used to generate and store a strobe image and an ambient image. The strobe image and ambient image are then combined later within a computer system, disposed locally with a user, or remotely within a cloud-based computer system. In one embodiment, method 10-802 comprises a software module operable with an image processing tool to enable a user to read the strobe image and the ambient image previously stored, and to generate a blended image within a computer system that is distinct from digital photographic system 10-100.

Persons skilled in the art will recognize that while certain intermediate image data may be discussed in terms of a particular image or image data, these images serve as illustrative abstractions. Such buffers may be allocated in certain implementations, while in other implementations intermediate data is only stored as needed. For example, aligned strobe image 10-232 may be rendered to completion in an allocated image buffer during a certain processing step or steps, or alternatively, pixels associated with an abstraction of an aligned image may be rendered as needed without a need to allocate an image buffer to store aligned strobe image 10-232.

While the techniques described above discuss color correction operation 10-250 in conjunction with a strobe image that is being corrected to an ambient reference image, a strobe image may serve as a reference image for correcting an ambient image. In one embodiment ambient image 10-220 is subjected to color correction operation 10-250, and blend operation 10-270 operates as previously discussed for blending an ambient image and a strobe image.

In summary, a technique is disclosed for generating a digital photograph that beneficially blends an ambient image sampled under ambient lighting conditions and a strobe image sampled under strobe lighting conditions. The strobe image is blended with the ambient image based on a function that implements a blend surface. Discordant spatial coloration between the strobe image and the ambient image is corrected via a spatial color correction operation. An adjustment tool implements a user interface technique that enables a user to select and save a digital photograph from a gradation of parameters for combining related images.

On advantage of the present invention is that a digital photograph may be generated having consistent white balance in a scene comprising regions illuminated primarily by a strobe of one color balance and other regions illuminated primarily by ambient illumination of a different color balance.

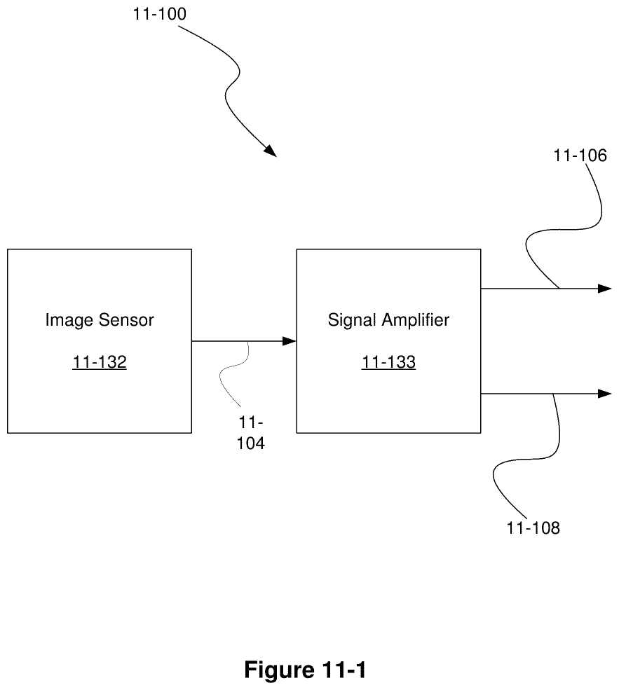

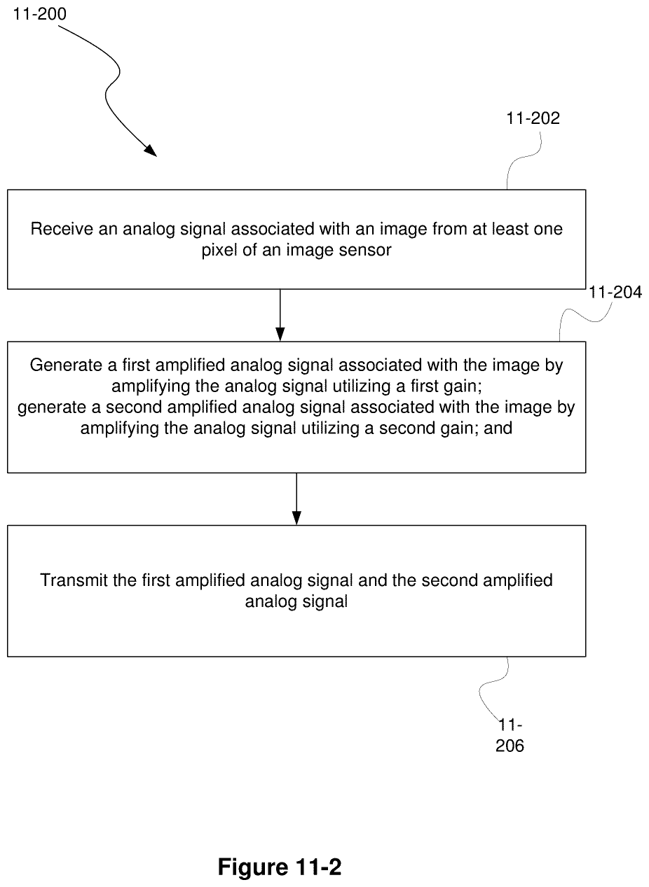

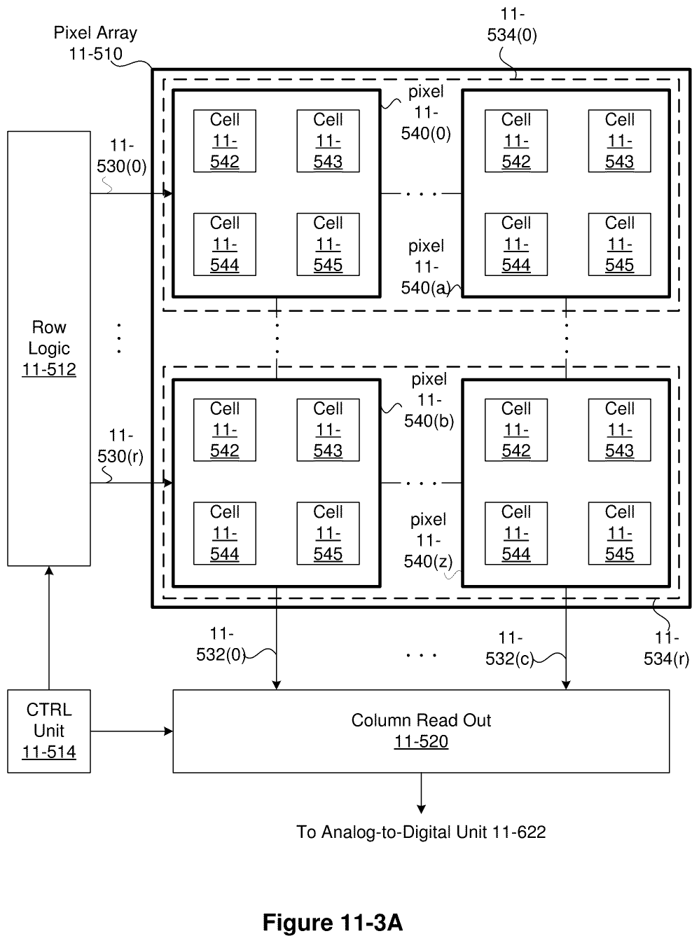

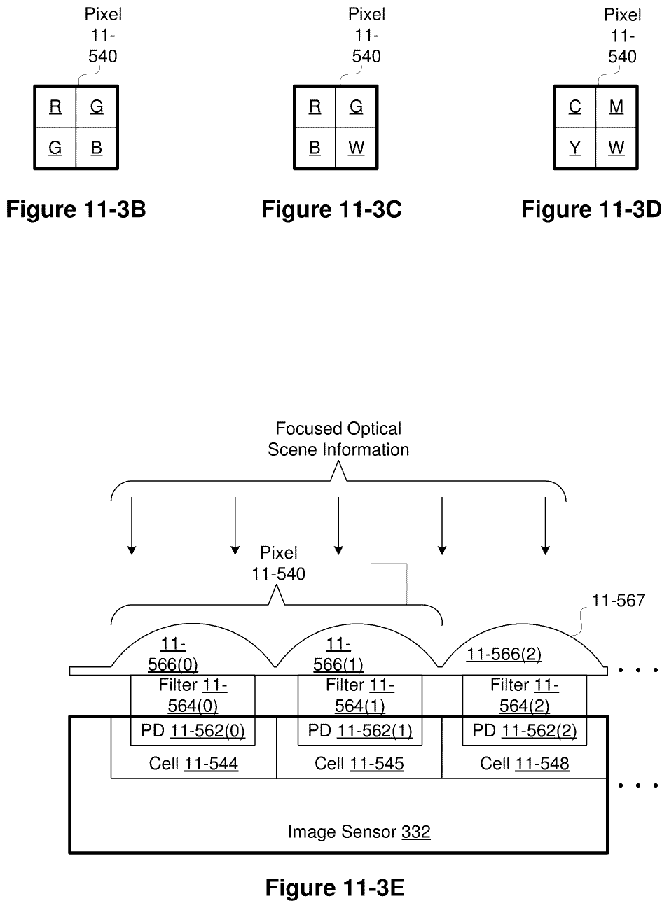

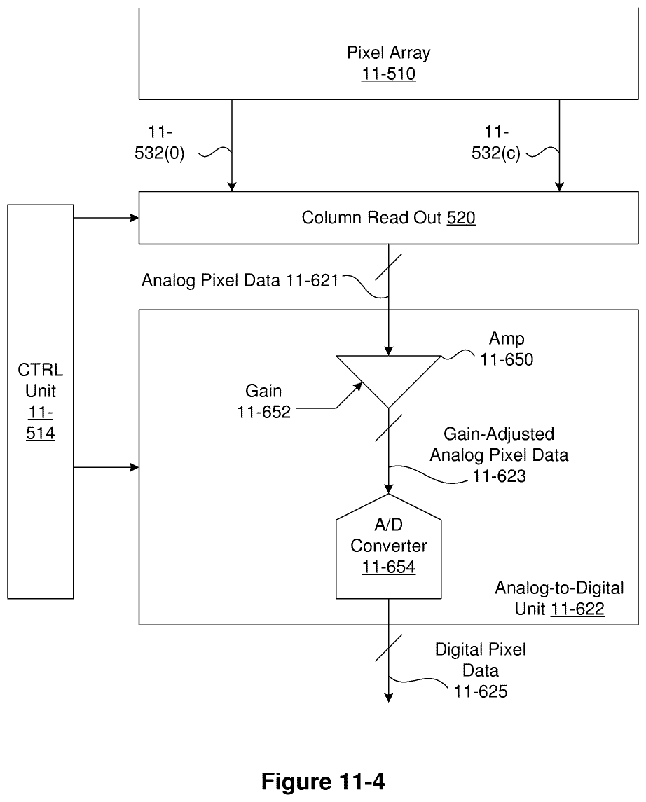

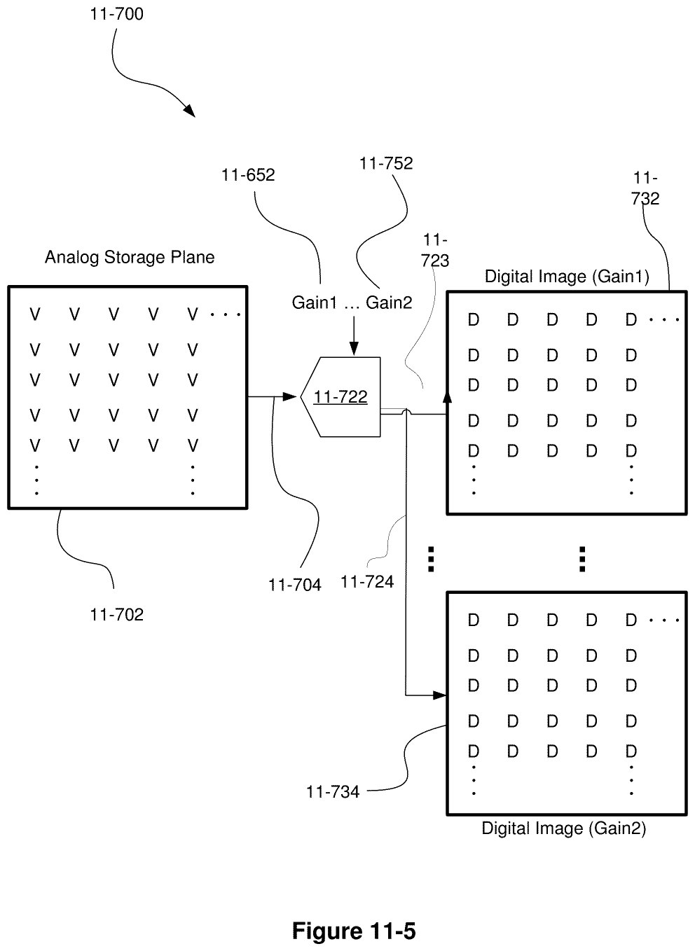

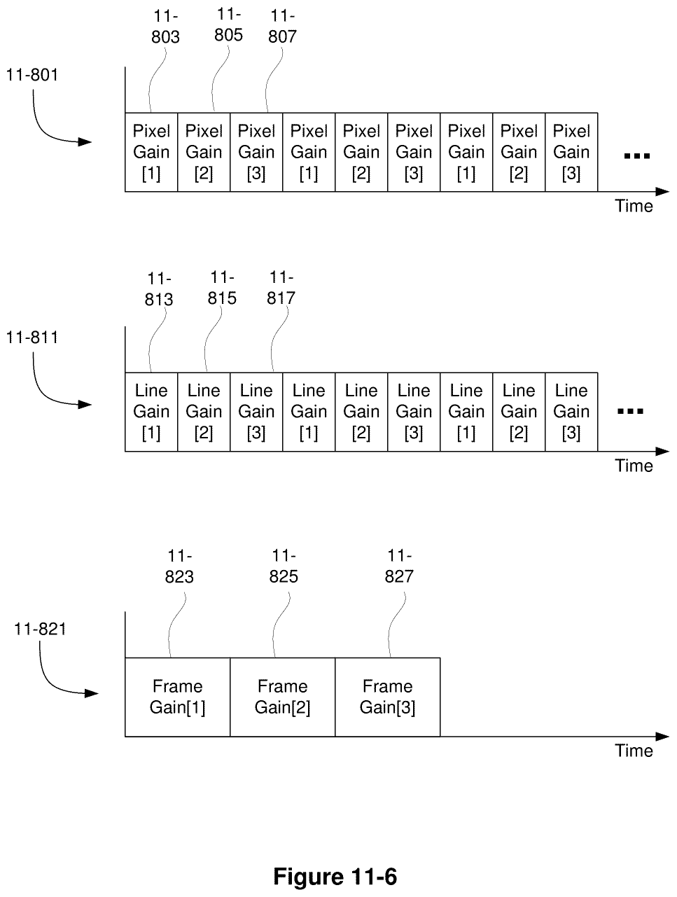

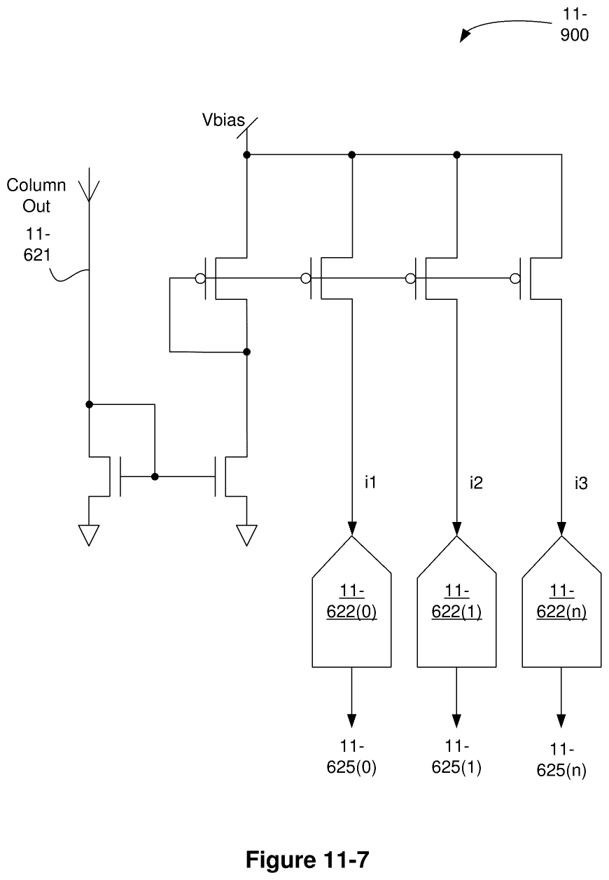

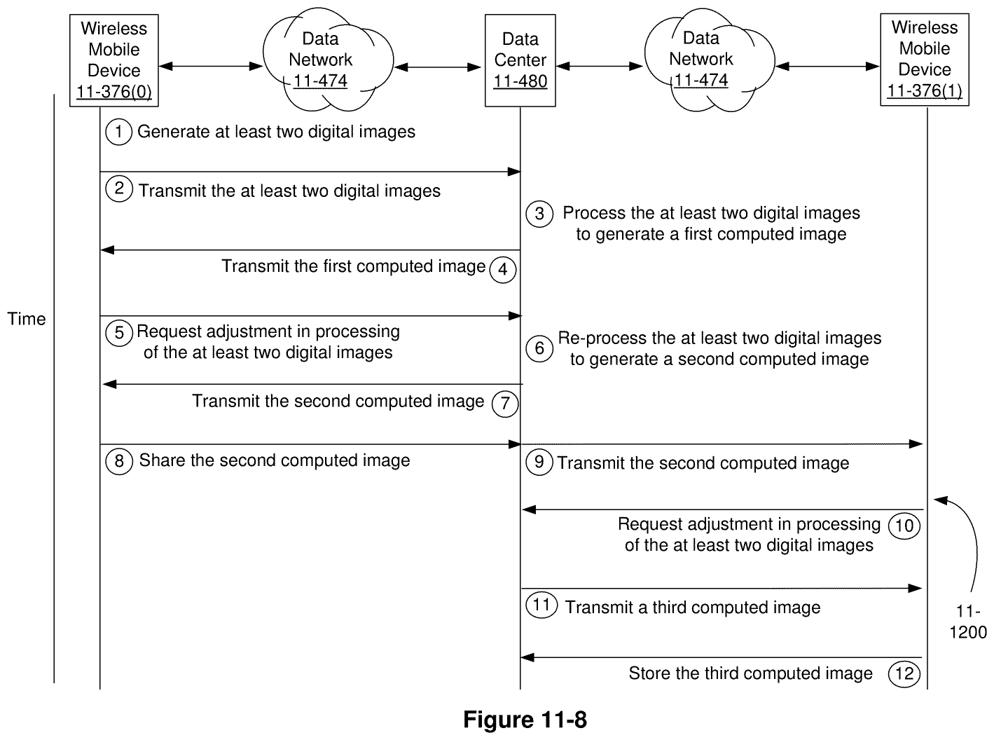

FIG. 11-1 illustrates a system 11-100 for obtaining multiple exposures with zero interframe time, in accordance with one possible embodiment. As an option, the system 11-100 may be implemented in the context of any of the Figures disclosed herein. Of course, however, the system 11-100 may be implemented in any desired environment. Further, the aforementioned definitions may equally apply to the description below.

As shown, a signal amplifier 11-133 receives an analog signal 11-104 from an image sensor 11-132. In response to receiving the analog signal 11-104, the signal amplifier 11-133 amplifies the analog signal 11-104 utilizing a first gain, and transmits a first amplified analog signal 11-106. Further, in response to receiving the analog signal 11-104, the signal amplifier 11-133 also amplifies the analog signal 11-104 utilizing a second gain, and transmits a second amplified analog signal 11-108.

In one specific embodiment, the analog signal 11-106 and the analog signal 11-108 are transmitted on a common electrical interconnect. In alternative embodiments, the analog signal 11-106 and the analog signal 11-108 are transmitted on different electrical interconnects.

In one embodiment, the analog signal 11-104 generated by image sensor 11-132 includes an electronic representation of an optical image that has been focused on the image sensor 11-132. In such an embodiment, the optical image may be focused on the image sensor 11-132 by a lens. The electronic representation of the optical image may comprise spatial color intensity information, which may include different color intensity samples (e.g. red, green, and blue light, etc.). In other embodiments, the spatial color intensity information may also include samples for white light. In one embodiment, the optical image may be an optical image of a photographic scene.

In one embodiment, the image sensor 11-132 may comprise a complementary metal oxide semiconductor (CMOS) image sensor, or charge-coupled device (CCD) image sensor, or any other technically feasible form of image sensor.

In an embodiment, the signal amplifier 11-133 may include a transimpedance amplifier (TIA), which may be dynamically configured, such as by digital gain values, to provide a selected gain to the analog signal 11-104. For example, a TIA could be configured to apply a first gain to the analog signal. The same TIA could then be configured to subsequently apply a second gain to the analog signal. In other embodiments, the gain may be specified to the signal amplifier 11-133 as a digital value. Further, the specified gain value may be based on a specified sensitivity or ISO. The specified sensitivity may be specified by a user of a photographic system, or instead may be set by software or hardware of the photographic system, or some combination of the foregoing working in concert.

In one embodiment, the signal amplifier 11-133 includes a single amplifier. In such an embodiment, the amplified analog signals 11-106 and 11-108 are transmitted or output in sequence. For example, in one embodiment, the output may occur through a common electrical interconnect. For example, the amplified analog signal 11-106 may first be transmitted, and then the amplified analog signal 11-108 may subsequently be transmitted. In another embodiment, the signal amplifier 11-133 may include a plurality of amplifiers. In such an embodiment, the amplifier 11-133 may transmit the amplified analog signal 11-106 in parallel with the amplified analog signal 11-108. To this end, the analog signal 11-106 may be amplified utilizing the first gain in serial with the amplification of the analog signal 11-108 utilizing the second gain, or the analog signal 11-106 may be amplified utilizing the first gain in parallel with the amplification of the analog signal 11-108 utilizing the second gain. In one embodiment, the amplified analog signals 11-106 and 11-108 each include gain-adjusted analog pixel data.

Each instance of gain-adjusted analog pixel data may be converted to digital pixel data by subsequent processes and/or hardware. For example, the amplified analog signal 11-106 may subsequently be converted to a first digital signal comprising a first set of digital pixel data representative of the optical image that has been focused on the image sensor 11-132. Further, the amplified analog signal 11-108 may subsequently or concurrently be converted to a second digital signal comprising a second set of digital pixel data representative of the optical image that has been focused on the image sensor 11-132. In one embodiment, any differences between the first set of digital pixel data and the second set of digital pixel data are a function of a difference between the first gain and the second gain applied by the signal amplifier 11-133. Further, each set of digital pixel data may include a digital image of the photographic scene. Thus, the amplified analog signals 11-106 and 11-108 may be used to generate two different digital images of the photographic scene. Furthermore, in one embodiment, each of the two different digital images may represent a different exposure level.

FIG. 11-2 illustrates a method 11-200 for obtaining multiple exposures with zero interframe time, in accordance with one embodiment. As an option, the method 11-200 may be carried out in the context of any of the Figures disclosed herein. Of course, however, the method 11-200 may be carried out in any desired environment. Further, the aforementioned definitions may equally apply to the description below.

As shown in operation 11-202, an analog signal associated with an image is received from at least one pixel of an image sensor. In the context of the present embodiment, the analog signal may include analog pixel data for at least one pixel of an image sensor. In one embodiment, the analog signal may include analog pixel data for every pixel of an image sensor. In another embodiment, each pixel of an image sensor may include a plurality of photodiodes. In such an embodiment, the analog pixel data received in the analog signal may include an analog value for each photodiode of each pixel of the image sensor. Each analog value may be representative of a light intensity measured at the photodiode associated with the analog value. Accordingly, an analog signal may be a set of spatially discrete intensity samples, each represented by continuous analog values, and analog pixel data may be analog signal values associated with one or more given pixels.

Additionally, as shown in operation 11-204, a first amplified analog signal associated with the image is generated by amplifying the analog signal utilizing a first gain, and a second amplified analog signal associated with the image is generated by amplifying the analog signal utilizing a second gain. Accordingly, the analog signal is amplified utilizing both the first gain and the second gain, resulting in the first amplified analog signal and the second amplified analog signal, respectively. In one embodiment, the first amplified analog signal may include first gain-adjusted analog pixel data. In such an embodiment, the second amplified analog signal may include second gain-adjusted analog pixel data. In accordance with one embodiment, the analog signal may be amplified utilizing the first gain simultaneously with the amplification of the analog signal utilizing the second gain. In another embodiment, the analog signal may be amplified utilizing the first gain during a period of time other than when the analog signal is amplified utilizing the second gain. For example, the first gain and the second gain may be applied to the analog signal in sequence. In one embodiment, a sequence for applying the gains to the analog signal may be predetermined.

Further, as shown in operation 11-206, the first amplified analog signal and the second amplified analog signal are both transmitted, such that multiple amplified analog signals are transmitted based on the analog signal associated with the image. In the context of one embodiment, the first amplified analog signal and the second amplified analog signal are transmitted in sequence. For example, the first amplified analog signal may be transmitted prior to the second amplified analog signal. In another embodiment, the first amplified analog signal and the second amplified signal may be transmitted in parallel.

The embodiments disclosed herein advantageously enable a camera module to sample images comprising an image stack with lower (e.g. at or near zero, etc.) inter-sample time (e.g. interframe, etc.) than conventional techniques. In certain embodiments, images comprising the image stack are effectively sampled during overlapping time intervals, which may reduce inter-sample time to zero. In other embodiments, the camera module may sample images in coordination with the strobe unit to reduce inter-sample time between an image sampled without strobe illumination and an image sampled with strobe illumination.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 11-3A illustrates a system for capturing optical scene information for conversion to an electronic representation of a photographic scene, in accordance with one embodiment. As an option, the system of FIG. 11-3A may be implemented in the context of the details of any of the Figures.

As shown in FIG. 11-3A, a pixel array 11-510 is in communication with row logic 11-512 and a column read out circuit 11-520. Further, the row logic 11-512 and the column read out circuit 11-520 are both in communication with a control unit 11-514. Still further, the pixel array 11-510 is shown to include a plurality of pixels 11-540, where each pixel 11-540 may include four cells, cells 11-542-11-545. In the context of the present description, the pixel array 11-510 may be included in an image sensor, such as image sensor 132 or image sensor 332 of camera module 330.

As shown, the pixel array 11-510 includes a 2-dimensional array of the pixels 11-540. For example, in one embodiment, the pixel array 11-510 may be built to comprise 4,000 pixels 11-540 in a first dimension, and 3,000 pixels 11-540 in a second dimension, for a total of 12,000,000 pixels 11-540 in the pixel array 11-510, which may be referred to as a 12 megapixel pixel array. Further, as noted above, each pixel 11-540 is shown to include four cells 11-542-11-545. In one embodiment, cell 11-542 may be associated with (e.g. selectively sensitive to, etc.) a first color of light, cell 11-543 may be associated with a second color of light, cell 11-544 may be associated with a third color of light, and cell 11-545 may be associated with a fourth color of light. In one embodiment, each of the first color of light, second color of light, third color of light, and fourth color of light are different colors of light, such that each of the cells 11-542-11-545 may be associated with different colors of light. In another embodiment, at least two cells of the cells 11-542-11-545 may be associated with a same color of light. For example, the cell 11-543 and the cell 11-544 may be associated with the same color of light.

Further, each of the cells 11-542-11-545 may be capable of storing an analog value. In one embodiment, each of the cells 11-542-11-545 may be associated with a capacitor for storing a charge that corresponds to an accumulated exposure during an exposure time. In such an embodiment, asserting a row select signal to circuitry of a given cell may cause the cell to perform a read operation, which may include, without limitation, generating and transmitting a current that is a function of the stored charge of the capacitor associated with the cell. In one embodiment, prior to a readout operation, current received at the capacitor from an associated photodiode may cause the capacitor, which has been previously charged, to discharge at a rate that is proportional to an incident light intensity detected at the photodiode. The remaining charge of the capacitor of the cell may then be read using the row select signal, where the current transmitted from the cell is an analog value that reflects the remaining charge on the capacitor. To this end, an analog value received from a cell during a readout operation may reflect an accumulated intensity of light detected at a photodiode. The charge stored on a given capacitor, as well as any corresponding representations of the charge, such as the transmitted current, may be referred to herein as a type of analog pixel data. Of course, analog pixel data may include a set of spatially discrete intensity samples, each represented by continuous analog values.

Still further, the row logic 11-512 and the column read out circuit 11-520 may work in concert under the control of the control unit 11-514 to read a plurality of cells 11-542-11-545 of a plurality of pixels 11-540. For example, the control unit 11-514 may cause the row logic 11-512 to assert a row select signal comprising row control signals 11-530 associated with a given row of pixels 11-540 to enable analog pixel data associated with the row of pixels to be read. As shown in FIG. 11-3A, this may include the row logic 11-512 asserting one or more row select signals comprising row control signals 11-530(0) associated with a row 11-534(0) that includes pixel 11-540(0) and pixel 11-540(a). In response to the row select signal being asserted, each pixel 11-540 on row 11-534(0) transmits at least one analog value based on charges stored within the cells 11-542-11-545 of the pixel 11-540. In certain embodiments, cell 11-542 and cell 11-543 are configured to transmit corresponding analog values in response to a first row select signal, while cell 11-544 and cell 11-545 are configured to transmit corresponding analog values in response to a second row select signal.

In one embodiment, analog values for a complete row of pixels 11-540 comprising each row 11-534(0) through 11-534(r) may be transmitted in sequence to column read out circuit 11-520 through column signals 11-532. In one embodiment, analog values for a complete row or pixels or cells within a complete row of pixels may be transmitted simultaneously. For example, in response to row select signals comprising row control signals 11-530(0) being asserted, the pixel 11-540(0) may respond by transmitting at least one analog value from the cells 11-542-11-545 of the pixel 11-540(0) to the column read out circuit 11-520 through one or more signal paths comprising column signals 11-532(0); and simultaneously, the pixel 11-540(a) will also transmit at least one analog value from the cells 11-542-545 of the pixel 11-540(a) to the column read out circuit 11-520 through one or more signal paths comprising column signals 11-532(c). Of course, one or more analog values may be received at the column read out circuit 11-520 from one or more other pixels 11-540 concurrently to receiving the at least one analog value from pixel 11-540(0) and concurrently receiving the at least one analog value from the pixel 11-540(a). Together, a set of analog values received from the pixels 11-540 comprising row 11-534(0) may be referred to as an analog signal, and this analog signal may be based on an optical image focused on the pixel array 11-510. An analog signal may be a set of spatially discrete intensity samples, each represented by continuous analog values.

Further, after reading the pixels 11-540 comprising row 11-534(0), the row logic 11-512 may select a second row of pixels 11-540 to be read. For example, the row logic 11-512 may assert one or more row select signals comprising row control signals 11-530(r) associated with a row of pixels 11-540 that includes pixel 11-540(b) and pixel 11-540(z). As a result, the column read out circuit 11-520 may receive a corresponding set of analog values associated with pixels 11-540 comprising row 11-534(r).

The column read out circuit 11-520 may serve as a multiplexer to select and forward one or more received analog values to an analog-to-digital converter circuit, such as analog-to-digital unit 11-622 of FIG. 11-4. The column read out circuit 11-520 may forward the received analog values in a predefined order or sequence. In one embodiment, row logic 11-512 asserts one or more row selection signals comprising row control signals 11-530, causing a corresponding row of pixels to transmit analog values through column signals 11-532. The column read out circuit 11-520 receives the analog values and sequentially selects and forwards one or more of the analog values at a time to the analog-to-digital unit 11-622. Selection of rows by row logic 11-512 and selection of columns by column read out circuit 11-620 may be directed by control unit 11-514. In one embodiment, rows 11-534 are sequentially selected to be read, starting with row 11-534(0) and ending with row 11-534(r), and analog values associated with sequential columns are transmitted to the analog-to-digital unit 11-622. In other embodiments, other selection patterns may be implemented to read analog values stored in pixels 11-540.

Further, the analog values forwarded by the column read out circuit 11-520 may comprise analog pixel data, which may later be amplified and then converted to digital pixel data for generating one or more digital images based on an optical image focused on the pixel array 11-510.

FIGS. 11-3B-11-3D illustrate three optional pixel configurations, according to one or more embodiments. As an option, these pixel configurations may be implemented in the context of the details of any of the Figures disclosed herein. Of course, however, these pixel configurations may be implemented in any desired environment. By way of a specific example, any of the pixels 11-540 of FIGS. 11-3B-11-3D may operate as one or more of the pixels 11-540 of the pixel array 11-510.

As shown in FIG. 11-3B, a pixel 11-540 is illustrated to include a first cell (R) for measuring red light intensity, second and third cells (G) for measuring green light intensity, and a fourth cell (B) for measuring blue light intensity, in accordance with one embodiment. As shown in FIG. 11-3C, a pixel 11-540 is illustrated to include a first cell (R) for measuring red light intensity, a second cell (G) for measuring green light intensity, a third cell (B) for measuring blue light intensity, and a fourth cell (W) for measuring white light intensity, in accordance with another embodiment. As shown in FIG. 11-3D, a pixel 11-540 is illustrated to include a first cell (C) for measuring cyan light intensity, a second cell (M) for measuring magenta light intensity, a third cell (Y) for measuring yellow light intensity, and a fourth cell (W) for measuring white light intensity, in accordance with yet another embodiment.

Of course, while pixels 11-540 are each shown to include four cells, a pixel 11-540 may be configured to include fewer or more cells for measuring light intensity. Still further, in another embodiment, while certain of the cells of pixel 11-540 are shown to be configured to measure a single peak wavelength of light, or white light, the cells of pixel 11-540 may be configured to measure any wavelength, range of wavelengths of light, or plurality of wavelengths of light.

Referring now to FIG. 11-3E, a system is shown for capturing optical scene information focused as an optical image on an image sensor 332, in accordance with one embodiment. As an option, the system of FIG. 11-3E may be implemented in the context of the details of any of the Figures. Of course, however, the system of FIG. 11-3E may be carried out in any desired environment. Further, the aforementioned definitions may equally apply to the description below.

As shown in FIG. 11-3E, an image sensor 332 is shown to include a first cell 11-544, a second cell 11-545, and a third cell 11-548. Further, each of the cells 11-544-548 is shown to include a photodiode 11-562. Still further, upon each of the photodiodes 11-562 is a corresponding filter 11-564, and upon each of the filters 11-564 is a corresponding microlens 11-566. For example, the cell 11-544 is shown to include photodiode 11-562(0), upon which is filter 11-564(0), and upon which is microlens 11-566(0). Similarly, the cell 11-545 is shown to include photodiode 11-562(1), upon which is filter 11-564(1), and upon which is microlens 11-566(1). Still yet, as shown in FIG. 11-3E, pixel 11-540 is shown to include each of cells 11-544 and 11-545, photodiodes 11-562(0) and 11-562(1), filters 11-564(0) and 11-564(1), and microlenses 11-566(0) and 11-566(1).

In one embodiment, each of the microlenses 11-566 may be any lens with a diameter of less than 50 microns. However, in other embodiments each of the microlenses 11-566 may have a diameter greater than or equal to 50 microns. In one embodiment, each of the microlenses 11-566 may include a spherical convex surface for focusing and concentrating received light on a supporting substrate beneath the microlens 11-566. For example, as shown in FIG. 11-3E, the microlens 11-566(0) focuses and concentrates received light on the filter 11-564(0). In one embodiment, a microlens array 11-567 may include microlenses 11-566, each corresponding in placement to photodiodes 11-562 within cells 11-544 of image sensor 332.

In the context of the present description, the photodiodes 11-562 may comprise any semiconductor diode that generates a potential difference, or changes its electrical resistance, in response to photon absorption. Accordingly, the photodiodes 11-562 may be used to detect or measure light intensity. Further, each of the filters 11-564 may be optical filters for selectively transmitting light of one or more predetermined wavelengths. For example, the filter 11-564(0) may be configured to selectively transmit substantially only green light received from the corresponding microlens 11-566(0), and the filter 11-564(1) may be configured to selectively transmit substantially only blue light received from the microlens 11-566(1). Together, the filters 11-564 and microlenses 11-566 may be operative to focus selected wavelengths of incident light on a plane. In one embodiment, the plane may be a 2-dimensional grid of photodiodes 11-562 on a surface of the image sensor 332. Further, each photodiode 11-562 receives one or more predetermined wavelengths of light, depending on its associated filter. In one embodiment, each photodiode 11-562 receives only one of red, blue, or green wavelengths of filtered light. As shown with respect to FIGS. 11-3B-11-3D, it is contemplated that a photodiode may be configured to detect wavelengths of light other than only red, green, or blue. For example, in the context of FIGS. 11-3C-11-3D specifically, a photodiode may be configured to detect white, cyan, magenta, yellow, or non-visible light such as infrared or ultraviolet light.

To this end, each coupling of a cell, photodiode, filter, and microlens may be operative to receive light, focus and filter the received light to isolate one or more predetermined wavelengths of light, and then measure, detect, or otherwise quantify an intensity of light received at the one or more predetermined wavelengths. The measured or detected light may then be represented as an analog value stored within a cell. For example, in one embodiment, the analog value may be stored within the cell utilizing a capacitor, as discussed in more detail above. Further, the analog value stored within the cell may be output from the cell based on a selection signal, such as a row selection signal, which may be received from row logic 11-512. Further still, the analog value transmitted from a single cell may comprise one analog value in a plurality of analog values of an analog signal, where each of the analog values is output by a different cell. Accordingly, the analog signal may comprise a plurality of analog pixel data values from a plurality of cells. In one embodiment, the analog signal may comprise analog pixel data values for an entire image of a photographic scene. In another embodiment, the analog signal may comprise analog pixel data values for a subset of the entire image of the photographic scene. For example, the analog signal may comprise analog pixel data values for a row of pixels of the image of the photographic scene. In the context of FIGS. 11-3A-11-3E, the row 11-534(0) of the pixels 11-540 of the pixel array 11-510 may be one such row of pixels of the image of the photographic scene.

FIG. 11-4 illustrates a system for converting analog pixel data to digital pixel data, in accordance with an embodiment. As an option, the system of FIG. 11-4 may be implemented in the context of the details of any of the Figures disclosed herein. Of course, however, the system of FIG. 11-4 may be implemented in any desired environment. Further, the aforementioned definitions may equally apply to the description below.

As shown in FIG. 11-4, analog pixel data 11-621 is received from column read out circuit 11-520 at analog-to-digital unit 11-622 under the control of control unit 11-514. The analog pixel data 11-621 may be received within an analog signal, as noted hereinabove. Further, the analog-to-digital unit 11-622 generates digital pixel data 11-625 based on the received analog pixel data 11-621.

More specifically, and as shown in FIG. 11-4, the analog-to-digital unit 11-622 includes an amplifier 11-650 and an analog-to-digital converter 11-654. In one embodiment, the amplifier 11-650 receives both the analog pixel data 11-621 and a gain 11-652, and applies the gain 11-652 to the analog pixel data 11-621 to generate gain-adjusted analog pixel data 11-623. The gain-adjusted analog pixel data 11-623 is transmitted from the amplifier 11-650 to the analog-to-digital converter 11-654. The analog-to-digital converter 11-654 receives the gain-adjusted analog pixel data 11-623, and converts the gain-adjusted analog pixel data 11-623 to the digital pixel data 11-625, which is then transmitted from the analog-to-digital converter 11-654. In other embodiments, the amplifier 11-650 may be implemented within the column read out circuit 520 instead of within the analog-to-digital unit 11-622. The analog-to-digital converter 11-654 may convert the gain-adjusted analog pixel data 11-623 to the digital pixel data 11-625 using any technically feasible analog-to-digital conversion system.

In an embodiment, the gain-adjusted analog pixel data 11-623 results from the application of the gain 11-652 to the analog pixel data 11-621. In one embodiment, the gain 11-652 may be selected by the analog-to-digital unit 11-622. In another embodiment, the gain 11-652 may be selected by the control unit 11-514, and then supplied from the control unit 11-514 to the analog-to-digital unit 11-622 for application to the analog pixel data 11-621.

It should be noted, in one embodiment, that a consequence of applying the gain 11-652 to the analog pixel data 11-621 is that analog noise may appear in the gain-adjusted analog pixel data 11-623. If the amplifier 11-650 imparts a significantly large gain to the analog pixel data 11-621 in order to obtain highly sensitive data from of the pixel array 11-510, then a significant amount of noise may be expected within the gain-adjusted analog pixel data 11-623. In one embodiment, the detrimental effects of such noise may be reduced by capturing the optical scene information at a reduced overall exposure. In such an embodiment, the application of the gain 11-652 to the analog pixel data 11-621 may result in gain-adjusted analog pixel data with proper exposure and reduced noise.

In one embodiment, the amplifier 11-650 may be a transimpedance amplifier (TIA). Furthermore, the gain 11-652 may be specified by a digital value. In one embodiment, the digital value specifying the gain 11-652 may be set by a user of a digital photographic device, such as by operating the digital photographic device in a “manual” mode. Still yet, the digital value may be set by hardware or software of a digital photographic device. As an option, the digital value may be set by the user working in concert with the software of the digital photographic device.

In one embodiment, a digital value used to specify the gain 11-652 may be associated with an ISO. In the field of photography, the ISO system is a well-established standard for specifying light sensitivity. In one embodiment, the amplifier 11-650 receives a digital value specifying the gain 11-652 to be applied to the analog pixel data 11-621. In another embodiment, there may be a mapping from conventional ISO values to digital gain values that may be provided as the gain 11-652 to the amplifier 11-650. For example, each of ISO 100, ISO 200, ISO 400, ISO 800, ISO 1600, etc. may be uniquely mapped to a different digital gain value, and a selection of a particular ISO results in the mapped digital gain value being provided to the amplifier 11-650 for application as the gain 11-652. In one embodiment, one or more ISO values may be mapped to a gain of 1. Of course, in other embodiments, one or more ISO values may be mapped to any other gain value.

Accordingly, in one embodiment, each analog pixel value may be adjusted in brightness given a particular ISO value. Thus, in such an embodiment, the gain-adjusted analog pixel data 11-623 may include brightness corrected pixel data, where the brightness is corrected based on a specified ISO. In another embodiment, the gain-adjusted analog pixel data 11-623 for an image may include pixels having a brightness in the image as if the image had been sampled at a certain ISO.

In accordance with an embodiment, the digital pixel data 11-625 may comprise a plurality of digital values representing pixels of an image captured using the pixel array 11-510.

FIG. 11-5 illustrates a system 11-700 for converting analog pixel data of an analog signal to digital pixel data, in accordance with an embodiment. As an option, the system 11-700 may be implemented in the context of the details of any of the Figures disclosed herein. Of course, however, the system 11-700 may be implemented in any desired environment. Further, the aforementioned definitions may equally apply to the description below.

The system 11-700 is shown in FIG. 11-5 to include an analog storage plane 11-702, an analog-to-digital unit 11-722, a first digital image 11-732, and a second digital image 11-734. Additionally, in one embodiment, analog values may each be depicted as a “V” within the analog storage plane 11-702 and corresponding digital values may each be depicted as a “D” within first digital image 11-732 and second digital image 11-734.

In the context of the present description, the analog storage plane 11-702 may comprise any collection of one or more analog values. In one embodiment, the analog storage plane 11-702 may comprise one or more analog pixel values. In some embodiments, the analog storage plane 11-702 may comprise at least one analog pixel value for each pixel of a row or line of a pixel array. Still yet, in another embodiment, the analog storage plane 11-702 may comprise at least one analog pixel value for each pixel of an entirety of a pixel array, which may be referred to as a frame. In one embodiment, the analog storage plane 11-702 may comprise an analog value for each cell of a pixel. In yet another embodiment, the analog storage plane 11-702 may comprise an analog value for each cell of each pixel of a row or line of a pixel array. In another embodiment, the analog storage plane 11-702 may comprise an analog value for each cell of each pixel of multiple lines or rows of a pixel array. For example, the analog storage plane 11-702 may comprise an analog value for each cell of each pixel of every line or row of a pixel array.

Further, the analog values of the analog storage plane 11-702 are output as analog pixel data 11-704 to the analog-to-digital unit 11-722. In one embodiment, the analog-to-digital unit 11-722 may be substantially identical to the analog-to-digital unit 11-622 described within the context of FIG. 11-4. For example, the analog-to-digital unit 11-722 may comprise at least one amplifier and at least one analog-to-digital converter, where the amplifier is operative to receive a gain value and utilize the gain value to gain-adjust analog pixel data received at the analog-to-digital unit 11-722. Further, in such an embodiment, the amplifier may transmit gain-adjusted analog pixel data to an analog-to-digital converter, which then generates digital pixel data from the gain-adjusted analog pixel data.

In the context of the system 11-700 of FIG. 11-5, the analog-to-digital unit 11-722 receives the analog pixel data 11-704, and applies at least two different gains to the analog pixel data 11-704 to generate at least a first gain-adjusted analog pixel data and a second gain-adjusted analog pixel data. Further, the analog-to-digital unit 11-722 converts each generated gain-adjusted analog pixel data to digital pixel data, and then outputs at least two digital outputs. To this end, the analog-to-digital unit 11-722 provides a different digital output corresponding to each gain applied to the analog pixel data 11-704. With respect to FIG. 11-5 specifically, the analog-to-digital unit 11-722 is shown to generate a first digital signal comprising first digital pixel data 11-723 corresponding to a first gain 11-652, and a second digital signal comprising second digital pixel data 11-724 corresponding to a second gain 11-752.

In one embodiment, the analog-to-digital unit 11-722 applies in sequence the at least two gains to the analog values. For example, the analog-to-digital unit 11-722 first applies the first gain 11-652 to the analog pixel data 11-704, and then subsequently applies the second gain 11-752 to the same analog pixel data 11-704. In other embodiments, the analog-to-digital unit 11-722 may apply in parallel the at least two gains to the analog values. For example, the analog-to-digital unit 11-722 may apply the first gain 652 to the analog pixel data 11-704 in parallel with the application of the second gain 11-752 to the analog pixel data 11-704. To this end, as a result of applying the at least two gains, the analog pixel data 11-704 is amplified utilizing at least the first gain 11-652 and the second gain 11-752.

In accordance with one embodiment, the at least two gains may be determined using any technically feasible technique based on an exposure of a photographic scene, metering data, user input, detected ambient light, a strobe control, or any combination of the foregoing. For example, a first gain of the at least two gains may be determined such that half of the digital values from the analog storage plane 11-702 are converted to digital values above a specified threshold (e.g., a threshold of 0.5 in a range of 0.0 to 1.0) for the dynamic range associated with digital values comprising the first digital image 11-732, which can be characterized as having an “EV0” exposure. Continuing the example, a second gain of the at least two gains may be determined as being twice that of the first gain to generate a second digital image 11-734 characterized as having an “EV+1” exposure.

In one embodiment, the analog-to-digital unit 11-722 converts in sequence the first gain-adjusted analog pixel data to the first digital pixel data 11-723, and the second gain-adjusted analog pixel data to the second digital pixel data 11-724. For example, the analog-to-digital unit 11-722 first converts the first gain-adjusted analog pixel data to the first digital pixel data 11-723, and then subsequently converts the second gain-adjusted analog pixel data to the second digital pixel data 11-724. In other embodiments, the analog-to-digital unit 11-722 may perform such conversions in parallel, such that the first digital pixel data 11-723 is generated in parallel with the second digital pixel data 11-724.

Still further, as shown in FIG. 11-5, the first digital pixel data 11-723 is used to provide the first digital image 11-732. Similarly, the second digital pixel data 11-724 is used to provide the second digital image 11-734. The first digital image 11-732 and the second digital image 11-734 are both based upon the same analog pixel data 11-704, however the first digital image 11-732 may differ from the second digital image 11-734 as a function of a difference between the first gain 11-652 (used to generate the first digital image 11-732) and the second gain 11-752 (used to generate the second digital image 11-752). Specifically, the digital image generated using the largest gain of the at least two gains may be visually perceived as the brightest or more exposed. Conversely, the digital image generated using the smallest gain of the at least two gains may be visually perceived as the darkest and less exposed. To this end, a first light sensitivity value may be associated with the first digital pixel data 11-723, and a second light sensitivity value may be associated with the second digital pixel data 11-724. Further, because each of the gains may be associated with a different light sensitivity value, the first digital image or first digital signal may be associated with a first light sensitivity value, and the second digital image or second digital signal may be associated with a second light sensitivity value.

It should be noted that while a controlled application of gain to the analog pixel data may greatly aid in HDR image generation, an application of too great of gain may result in a digital image that is visually perceived as being noisy, over-exposed, and/or blown-out. In one embodiment, application of two stops of gain to the analog pixel data may impart visually perceptible noise for darker portions of a photographic scene, and visually imperceptible noise for brighter portions of the photographic scene. In another embodiment, a digital photographic device may be configured to provide an analog storage plane of analog pixel data for a captured photographic scene, and then perform at least two analog-to-digital samplings of the same analog pixel data using the analog-to-digital unit 11-722. To this end, a digital image may be generated for each sampling of the at least two samplings, where each digital image is obtained at a different exposure despite all the digital images being generated from the same analog sampling of a single optical image focused on an image sensor.

In one embodiment, an initial exposure parameter may be selected by a user or by a metering algorithm of a digital photographic device. The initial exposure parameter may be selected based on user input or software selecting particular capture variables. Such capture variables may include, for example, ISO, aperture, and shutter speed. An image sensor may then capture a single exposure of a photographic scene at the initial exposure parameter, and populate an analog storage plane with analog values corresponding to an optical image focused on the image sensor. Next, a first digital image may be obtained utilizing a first gain in accordance with the above systems and methods. For example, if the digital photographic device is configured such that the initial exposure parameter includes a selection of ISO 400, the first gain utilized to obtain the first digital image may be mapped to, or otherwise associated with, ISO 400. This first digital image may be referred to as an exposure or image obtained at exposure value 0 (EV0). Further at least one more digital image may be obtained utilizing a second gain in accordance with the above systems and methods. For example, the same analog pixel data used to generate the first digital image may be processed utilizing a second gain to generate a second digital image.

In one embodiment, at least two digital images may be generated using the same analog pixel data and blended to generate an HDR image. The at least two digital images generated using the same analog signal may be blended by blending a first digital signal and a second digital signal. Because the at least two digital images are generated using the same analog pixel data, there may be zero interframe time between the at least two digital images. As a result of having zero interframe time between at least two digital images of a same photographic scene, an HDR image may be generated without motion blur or other artifacts typical of HDR photographs.

In another embodiment, the second gain may be selected based on the first gain. For example, the second gain may be selected on the basis of it being one stop away from the first gain. More specifically, if the first gain is mapped to or associated with ISO 400, then one stop down from ISO 400 provides a gain associated with ISO 200, and one stop up from ISO 400 provides a gain associated with ISO 800. In such an embodiment, a digital image generated utilizing the gain associated with ISO 200 may be referred to as an exposure or image obtained at exposure value−1 (EV−1), and a digital image generated utilizing the gain associated with ISO 800 may be referred to as an exposure or image obtained at exposure value+1 (EV+1).

Still further, if a more significant difference in exposures is desired between digital images generated utilizing the same analog signal, then the second gain may be selected on the basis of it being two stops away from the first gain. For example, if the first gain is mapped to or associated with ISO 400, then two stops down from ISO 400 provides a gain associated with ISO 100, and two stops up from ISO 400 provides a gain associated with ISO 1600. In such an embodiment, a digital image generated utilizing the gain associated with ISO 100 may be referred to as an exposure or image obtained at exposure value−2 (EV−2), and a digital image generated utilizing the gain associated with ISO 1600 may be referred to as an exposure or image obtained at exposure value+2 (EV+2).

In one embodiment, an ISO and exposure of the EV0 image may be selected according to a preference to generate darker or more saturated digital images. In such an embodiment, the intention may be to avoid blowing out or overexposing what will be the brightest digital image, which is the digital image generated utilizing the greatest gain. In another embodiment, an EV−1 digital image or EV−2 digital image may be a first generated digital image. Subsequent to generating the EV−1 or EV−2 digital image, an increase in gain at an analog-to-digital unit may be utilized to generate an EV0 digital image, and then a second increase in gain at the analog-to-digital unit may be utilized to generate an EV+1 or EV+2 digital image. In one embodiment, the initial exposure parameter corresponds to an EV−N digital image and subsequent gains are used to obtain an EV0 digital image, an EV+M digital image, or any combination thereof, where N and M are values ranging from 0 to −10.

In one embodiment, an EV−2 digital image, an EV0 digital image, and an EV+2 digital image may be generated in parallel by implementing three analog-to-digital units. Such an implementation may be also capable of simultaneously generating all of an EV−1 digital image, an EV0 digital image, and an EV+1 digital image. Similarly, any combination of exposures may be generated in parallel from two or more analog-to-digital units, three or more analog-to-digital units, or an arbitrary number of analog-to-digital units.

FIG. 11-6 illustrates various timing configurations for amplifying analog signals, in accordance with various embodiments. As an option, the timing configurations of FIG. 11-6 may be implemented in the context of the details of any of the Figures disclosed herein. Of course, however, the timing configurations of FIG. 11-6 may be carried out in any desired environment. Further, the aforementioned definitions may equally apply to the description below.

Specifically, as shown in FIG. 11-6, per pixel timing configuration 11-801 is shown to amplify analog signals on a pixel-by-pixel basis. Further, per line timing configuration 11-811 is shown to amplify analog signals on a line-by-line basis. Finally, per frame timing configuration 11-821 is shown to amplify analog signals on a frame-by-frame basis. Each amplified analog signal associated with analog pixel data may be converted to a corresponding digital signal value.

In systems that implement per pixel timing configuration 11-801, an analog signal containing analog pixel data may be received at an analog-to-digital unit. Further, the analog pixel data may include individual analog pixel values. In such an embodiment, a first analog pixel value associated with a first pixel may be identified within the analog signal and selected. Next, each of a first gain 11-803, a second gain 11-805, and a third gain 11-807 may be applied in sequence or concurrently to the same first analog pixel value. In some embodiments less than or more than three different gains may be applied to a selected analog pixel value. For example, in some embodiments applying only two different gains to the same analog pixel value may be sufficient for generating a satisfactory HDR image. In one embodiment, after applying each of the first gain 11-803, the second gain 11-805, and the third gain 11-807, a second analog pixel value associated with a second pixel may be identified within the analog signal and selected. The second pixel may be a neighboring pixel of the first pixel. For example, the second pixel may be in a same row as the first pixel and located adjacent to the first pixel on a pixel array of an image sensor. Next, each of the first gain 11-803, the second gain 11-805, and the third gain 11-807 may be applied in sequence or concurrently to the same second analog pixel value. To this end, in the per pixel timing configuration 11-801, a plurality of sequential analog pixel values may be identified within an analog signal, and a set of at least two gains are applied to each pixel in the analog signal on a pixel-by-pixel basis.

Further, in systems that implement the per pixel timing configuration 11-801, a control unit may select a next gain to be applied after each pixel is amplified using a previously selected gain. In another embodiment, a control unit may control an amplifier to cycle through a set of predetermined gains that will be applied to a first analog pixel value, such a first analog pixel data value comprising analog pixel data 11-704, associated with a first pixel so that each gain in the set may be used to amplify the first analog pixel data before applying the set of predetermined gains to a second analog pixel data that subsequently arrives at the amplifier. In one embodiment, and as shown in the context of FIG. 11-6, this may include selecting a first gain, applying the first gain to a received first analog pixel value, selecting a second gain, applying the second gain to the received first analog pixel value, selecting a third gain, applying the third selected gain to the received first analog pixel value, and then receiving a second analog pixel value and applying the three selected gains to the second pixel value in the same order as applied to the first pixel value. In one embodiment, each analog pixel value may be read a plurality of times. In general, an analog storage plane may be utilized to hold the analog pixel values of the pixels for reading.

In systems that implement per line timing configuration 11-811, an analog signal containing analog pixel data may be received at an analog-to-digital unit. Further, the analog pixel data may include individual analog pixel values. In one embodiment, a first line of analog pixel values associated with a first line of pixels of a pixel array may be identified within the analog signal and selected. Next, each of a first gain 11-813, a second gain 11-815, and a third gain 11-817 may be applied in sequence or concurrently to the same first line of analog pixel values. In some embodiments less than or more than three different gains may be applied to a selected line of analog pixel values. For example, in some embodiments applying only two different gains to the same line of analog pixel values may be sufficient for generating a satisfactory HDR image. In one embodiment, after applying each of the first gain 11-813, the second gain 11-815, and the third gain 11-817, a second line of analog pixel values associated with a second line of pixels may be identified within the analog signal and selected. The second line of pixels may be a neighboring line of the first line of pixels. For example, the second line of pixels may be located immediately above or immediately below the first line of pixels in a pixel array of an image sensor. Next, each of the first gain 11-813, the second gain 11-815, and the third gain 11-817 may be applied in sequence or concurrently to the same second line of analog pixel values. To this end, in the per line timing configuration 11-811, a plurality of sequential lines of analog pixel values are identified within an analog signal, and a set of at least two gains are applied to each line of analog pixel values in the analog signal on a line-by-line basis.

Further, in systems that implement the per line timing configuration 11-811, a control unit may select a next gain to be applied after each line is amplified using a previously selected gain. In another embodiment, a control unit may control an amplifier to cycle through a set of predetermined gains that will be applied to a line so that each gain in the set is used to amplify a first line of analog pixel values before applying the set of predetermined gains to a second line of analog pixel values that arrives at the amplifier subsequent to the first line of analog pixel values. In one embodiment, and as shown in the context of FIG. 11-6, this may include selecting a first gain, applying the first gain to a received first line of analog pixel values, selecting a second gain, applying the second gain to the received first line of analog pixel values, selecting a third gain, applying the third selected gain to the received first line of analog pixel values, and then receiving a second line of analog pixel values and applying the three selected gains to the second line of analog pixel values in the same order as applied to the first line of analog pixel values. In one embodiment, each line of analog pixel values may be read a plurality of times. In another embodiment, an analog storage plane may be utilized to hold the analog pixel data values of one or more lines for reading.

In systems that implement per frame timing configuration 11-821, an analog signal that contains a plurality of analog pixel data values comprising analog pixel values may be received at an analog-to-digital unit. In such an embodiment, a first frame of analog pixel values associated with a first frame of pixels may be identified within the analog signal and selected. Next, each of a first gain 11-823, a second gain 11-825, and a third gain 11-827 may be applied in sequence or concurrently to the same first frame of analog pixel values. In some embodiments less than or more than three different gains may be applied to a selected frame of analog pixel values. For example, in some embodiments applying only two different gains to the same frame of analog pixel values may be sufficient for generating a satisfactory HDR image.

In one embodiment, after applying each of the first gain 11-823, the second gain 11-825, and the third gain 11-827, a second frame of analog pixel values associated with a second frame of pixels may be identified within the analog signal and selected. The second frame of pixels may be a next frame in a sequence of frames that capture video data associated with a photographic scene. For example, a digital photographic system may be operative to capture 30 frames per second of video data. In such digital photographic systems, the first frame of pixels may be one frame of said thirty frames, and the second frame of pixels may be a second frame of said thirty frames. Further still, each of the first gain 11-823, the second gain 11-825, and the third gain 11-827 may be applied in sequence to the analog pixel values of the second frame. To this end, in the per frame timing configuration 11-821, a plurality of sequential frames of analog pixel values may be identified within an analog signal, and a set of at least two gains are applied to each frame of analog pixel values on a frame-by-frame basis.

Further, in systems that implement the per frame timing configuration 11-821, a control unit may select a next gain to be applied after each frame is amplified using a previously selected gain. In another embodiment, a control unit may control an amplifier to cycle through a set of predetermined gains that will be applied to a frame so that each gain is used to amplify a analog pixel values associated with the first frame before applying the set of predetermined gains to analog pixel values associated with a second frame that subsequently arrive at the amplifier. In one embodiment, and as shown in the context of FIG. 11-6, this may include selecting a first gain, applying the first gain to analog pixel values associated with the first frame, selecting a second gain, applying the second gain to analog pixel values associated with the first frame, selecting a third gain, and applying the third gain to analog pixel values associated with the first frame. In another embodiment, analog pixel values associated with a second frame may be received following the application of all three selected gains to analog pixel values associated with the first frame, and the three selected gains may then be applied to analog pixel values associated with the second frame in the same order as applied to the first frame.

In yet another embodiment, selected gains applied to the first frame may be different than selected gains applied to the second frame, such as may be the case when the second frame includes different content and illumination than the first frame. In general, an analog storage plane may be utilized to hold the analog pixel data values of one or more frames for reading.

In certain embodiments, an analog-to-digital unit is assigned for each different gain and the analog-to-digital units are configured to operate concurrently. Resulting digital values may be interleaved for output or may be output in parallel. For example, analog pixel data for a given row may be amplified according to gain 11-803 and converted to corresponding digital values by a first analog-to-digital unit, while, concurrently, the analog pixel data for the row may be amplified according to gain 11-805 and converted to corresponding digital values by a second analog-to-digital unit. Furthermore, and concurrently, the analog pixel data for the row may be amplified according to gain 11-807 and converted to corresponding digital values by a third analog-to-digital unit. Digital values from the first through third analog-to-digital units may be output as sets of pixels, with each pixel in a set of pixels corresponding to one of the three gains 11-803, 11-805, 11-807. Similarly, output data values may be organized as lines having different gain values, with each line comprising pixels with a gain corresponding to one of the three gains 11-803, 11-805, 11-807.

FIG. 11-7 illustrates a system 11-900 for converting in parallel analog pixel data to multiple signals of digital pixel data, in accordance with one embodiment. As an option, the system 11-900 may be implemented in the context of the details of any of the Figures disclosed herein. Of course, however, the system 11-900 may be implemented in any desired environment. Further, the aforementioned definitions may equally apply to the description below.

In the context of FIG. 11-7, the system 11-900 is shown to receive as input analog pixel data 11-621. The analog pixel data 11-621 may be received within an analog signal, as noted hereinabove. Further, the analog-to-digital units 11-622 may be configured to generate digital pixel data 11-625 based on the received analog pixel data 11-621.

As shown in FIG. 11-7, the system 11-900 is configured to mirror the current of the analog pixel data 11-621 such that each of analog-to-digital unit 11-622(0), analog-to-digital unit 11-622(1), and analog-to-digital unit 11-622(n) receive a scaled copy of the analog pixel data 11-621. In one embodiment, each of the analog-to-digital unit 11-622(0), the analog-to-digital unit 11-622(1), and the analog-to-digital unit 11-622(n) may be configured to apply a unique gain to the analog pixel data 11-621. Each scaled copy may be scaled according to physical dimensions for the transistors comprising system 11-900, which comprises a structure known in the art as a current mirror. As shown, each current i1, i2, i3 may be generated in an arbitrary ratio relative to input current Iin, based on the physical dimensions. For example, currents i1, i2, i3 may be generated in a ratio of 1:1:1, 1:2:4, 0.5:1:2, or any other technically feasible ratio relative to Iin.

In an embodiment, the unique gains may be configured at each of the analog-to-digital units 11-622 by a controller. By way of a specific example, the analog-to-digital unit 11-622(0) may be configured to apply a gain of 1.0 to the analog pixel data 11-621, the analog-to-digital unit 11-622(1) may be configured to apply a gain of 2.0 to the analog pixel data 11-621, and the analog-to-digital unit 11-622(n) may be configured to apply a gain of 4.0 to the analog pixel data 11-621. Accordingly, while the same analog pixel data 11-621 may be input transmitted to each of the analog-to-digital unit 11-622(0), the analog-to-digital unit 11-622(1), and the analog-to-digital unit 11-622(n), each of digital pixel data 11-625(0), digital pixel data 11-625(1), and digital pixel data 11-625(n) may include different digital values based on the different gains applied within the analog-to-digital units 11-622, and thereby provide unique exposure representations of the same photographic scene.

In the embodiment described above, where the analog-to-digital unit 11-622(0) may be configured to apply a gain of 1.0, the analog-to-digital unit 11-622(1) may be configured to apply a gain of 2.0, and the analog-to-digital unit 11-622(n) may be configured to apply a gain of 4.0, the digital pixel data 11-625(0) may provide the least exposed corresponding digital image. Conversely, the digital pixel data 11-625(n) may provide the most exposed digital image. In another embodiment, the digital pixel data 11-625(0) may be utilized for generating an EV−1 digital image, the digital pixel data 11-625(1) may be utilized for generating an EV0 digital image, and the digital pixel data 11-625(n) may be utilized for generating an EV+2 image. In another embodiment, system 11-900 is configured to generate currents i1, i2, and i3 in a ratio of 2:1:4, and each analog-to-digital unit 11-622 may be configured to apply a gain of 1.0, which results in corresponding digital images having exposure values of EV−1, EV0, and EV+1 respectively. In such an embodiment, further differences in exposure value may be achieved by applying non-unit gain within one or more analog-to-digital unit 11-622.

While the system 11-900 is illustrated to include three analog-to-digital units 11-622, it is contemplated that multiple digital images may be generated by similar systems with more or less than three analog-to-digital units 11-622. For example, a system with two analog-to-digital units 11-622 may be implemented for simultaneously generating two exposures of a photographic scene with zero interframe time in a manner similar to that described above with respect to system 11-900. In one embodiment, the two analog-to-digital units 11-622 may be configured to generate two exposures each, for a total of four different exposures relative to one frame of analog pixel data.

FIG. 11-8 illustrates a message sequence 11-1200 for generating a combined image utilizing a network, according to one embodiment. As an option, the message sequence 11-1200 may be implemented in the context of the details of any of the Figures disclosed herein. Of course, however, the message sequence 11-1200 may be carried out in any desired environment. Further, the aforementioned definitions may equally apply to the description below.

As shown in FIG. 11-8, a wireless mobile device 11-376(0) generates at least two digital images. In one embodiment, the at least two digital images may be generated by amplifying an analog signal with at least two gains, where each generated digital image corresponds to digital output of an applied gain. As described previously, at least two different gains may be applied by one or more amplifiers to an analog signal containing analog pixel data in order to generate gain-adjusted analog pixel data. Further, the gain-adjusted analog pixel data may then be converted to the at least two digital images utilizing at least one analog-to-digital converter, where each of the digital images provides a different exposure of a same photographic scene. For example, in one embodiment, the at least two digital images may include an EV−1 exposure of the photographic scene and an EV+1 exposure of the photographic scene. In another embodiment, the at least two digital images may include an EV−2 exposure of the photographic scene, an EV0 exposure of the photographic scene, and an EV+2 exposure of the photographic scene.

Referring again to FIG. 11-8, the at least two digital images are transmitted from the wireless mobile device 11-376(0) to a data center 11-480 by way of a data network 11-474. The at least two digital images may be transmitted by the wireless mobile device 11-376(0) to the data center 11-480 using any technically feasible network communication method.

Further, in one embodiment, the data center 11-480 may then process the at least two digital images to generate a first computed image. The processing of the at least two digital images may include any processing of the at least two digital images that blends or merges at least a portion of each of the at least two digital images to generate the first computed image. To this end, the first digital image and the second digital image may be combined remotely from the wireless mobile device 11-376(0). For example, the processing of the at least two digital images may include an any type of blending operation, including but not limited to, an HDR image combining operation. In one embodiment, the processing of the at least two digital images may include any computations that produce a first computed image having a greater dynamic range than any one of the digital images received at the data center 11-480. Accordingly, in one embodiment, the first computed image generated by the data center 11-480 may be an HDR image. In other embodiments, the first computed image generated by the data center 11-480 may be at least a portion of an HDR image.

After generating the first computed image, the data center 11-480 may then transmit the first computed image to the wireless mobile device 11-376(0). In one embodiment, the transmission of the at least two digital images from the wireless mobile device 11-376(0), and the receipt of the first computed image at the wireless device 11-376(0), may occur without any intervention or instruction being received from a user of the wireless mobile device 11-376(0). For example, in one embodiment, the wireless mobile device 11-376(0) may transmit the at least two digital images to the data center 11-480 immediately after capturing a photographic scene and generating the at least two digital images utilizing an analog signal representative of the photographic scene. The photographic scene may be captured based on a user input or selection of an electronic shutter control, or pressing of a manual shutter button, on the wireless mobile device 11-376(0). Further, in response to receiving the at least two digital images, the data center 11-480 may generate an HDR image based on the at least two digital images, and transmit the HDR image to the wireless mobile device 11-376(0). The wireless mobile device 11-376(0) may then display the received HDR image. Accordingly, a user of the wireless mobile device 11-376(0) may view on the display of the wireless mobile device 11-376(0) an HDR image computed by the data center 11-480. Thus, even though the wireless mobile device 11-376(0) does not perform any HDR image processing, the user may view on the wireless mobile device 11-376(0) the newly computed HDR image substantially instantaneously after capturing the photographic scene and generating the at least two digital images on which the HDR image is based.

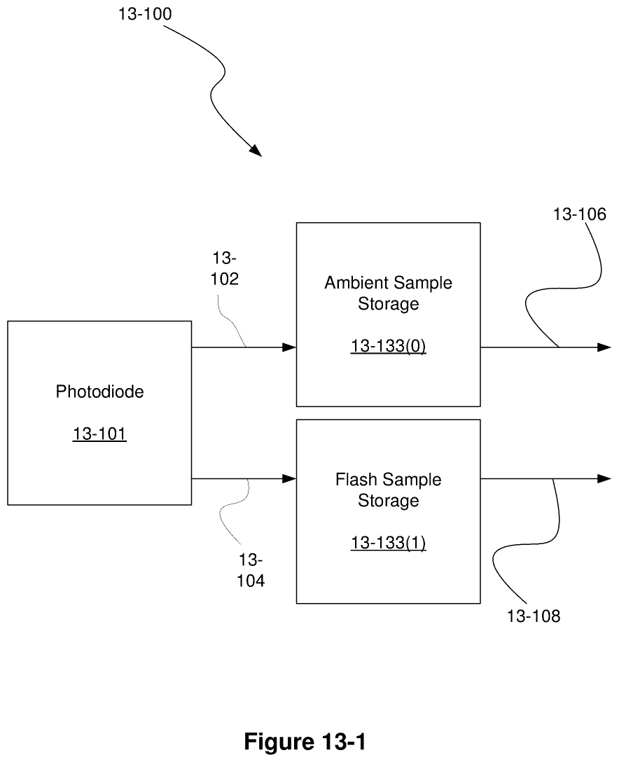

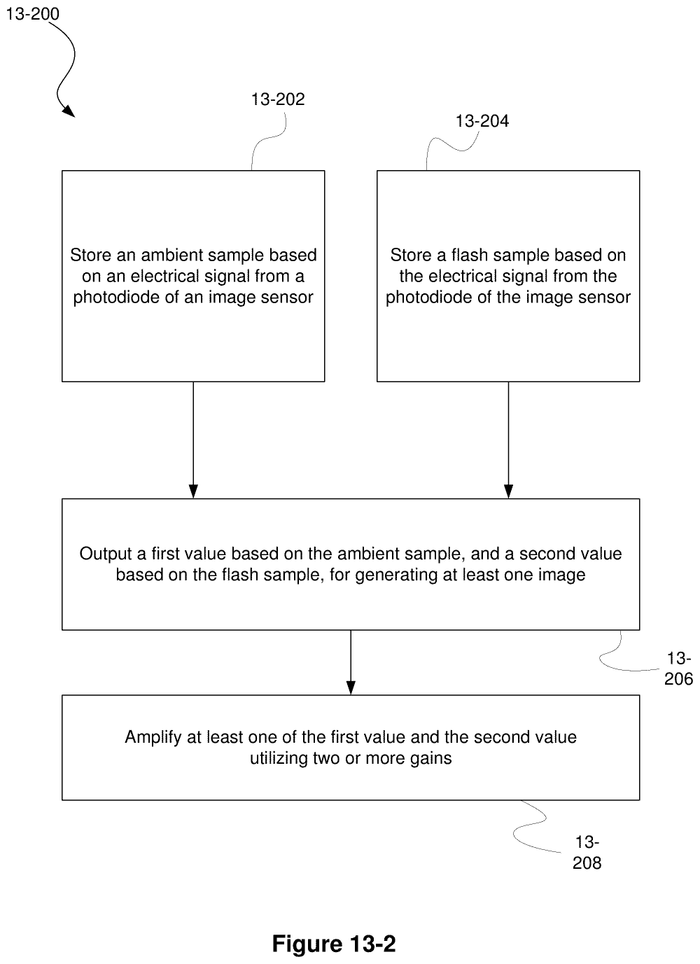

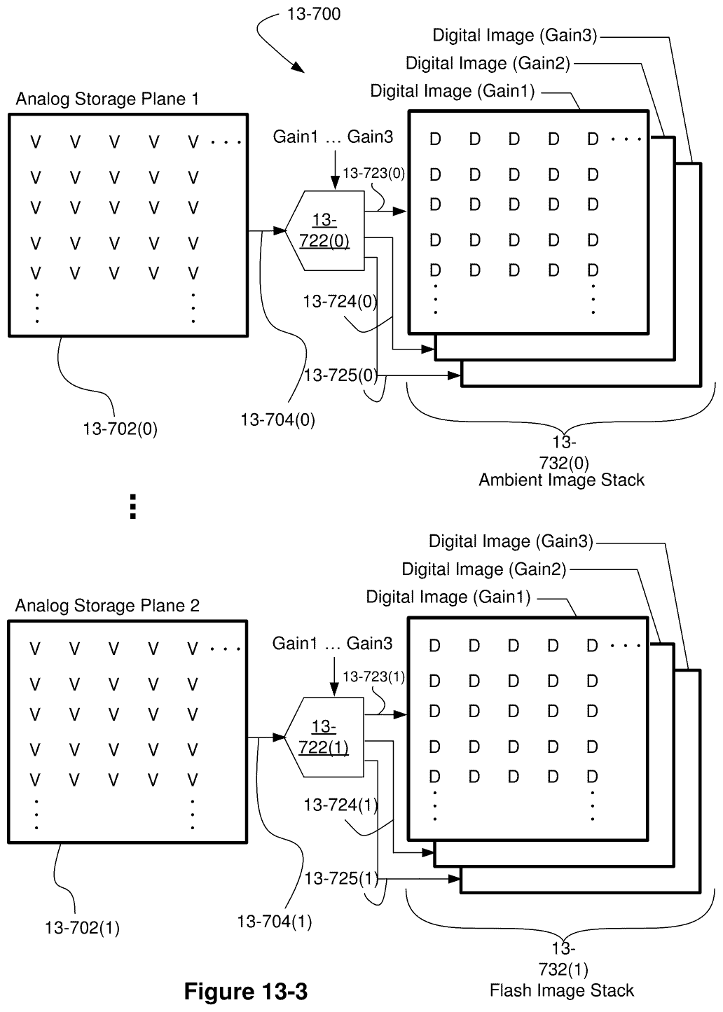

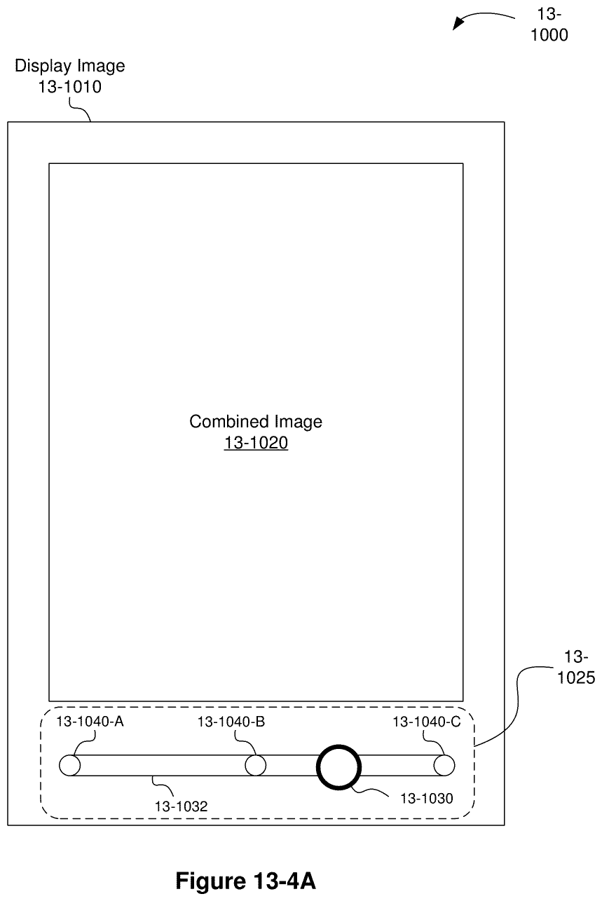

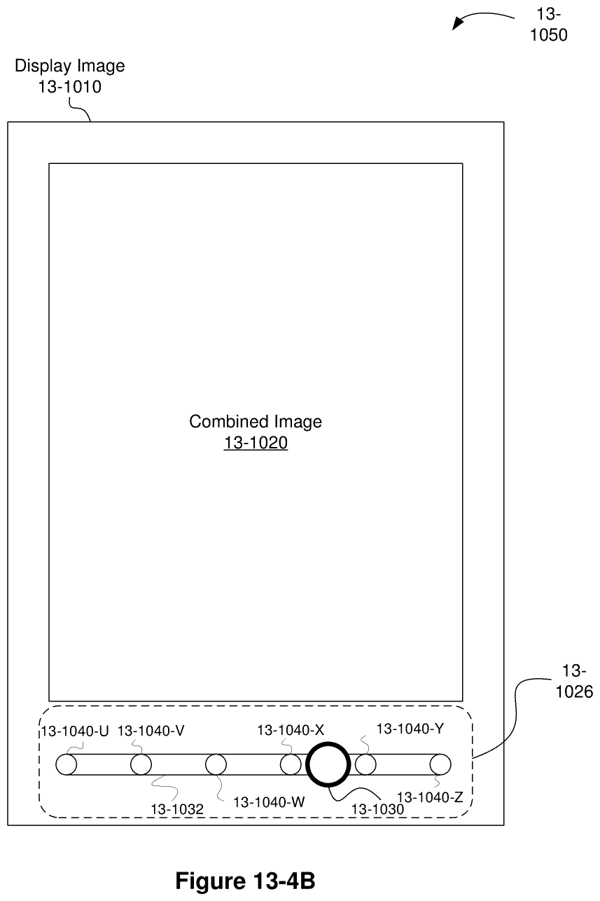

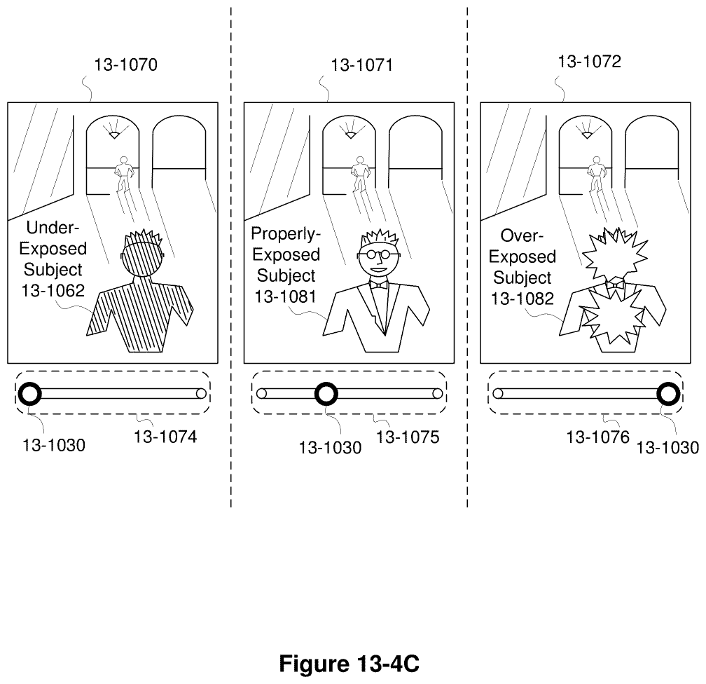

As shown in FIG. 11-8, the wireless mobile device 11-376(0) requests adjustment in processing of the at least two digital images. In one embodiment, upon receiving the first computed image from the data center 11-480, the wireless mobile device 11-376(0) may display the first computed image in a UI system, such as the UI system 13-1000 of FIG. 13-4A. In such an embodiment, the user may control a slider control, such as the slider control 13-1030, to adjust the processing of the at least two digital images transmitted to the data center 11-480. For example, user manipulation of a slider control may result in commands being transmitted to the data center 11-480. In one embodiment, the commands transmitted to the data center 11-480 may include mix weights for use in adjusting the processing of the at least two digital images. In other embodiments, the request to adjust processing of the at least two digital images includes any instructions from the wireless mobile device 11-376(0) that the data center 11-480 may use to again process the at least two digital images and generate a second computed image.

As shown in FIG. 11-8, upon receiving the request to adjust processing, the data center 11-480 re-processes the at least two digital images to generate a second computed image. In one embodiment, the data center 11-480 may re-process the at least two digital images using parameters received from the wireless mobile device 11-376(0). In such an embodiment, the parameters may be provided as input with the at least two digital images to an HDR processing algorithm that executes at the data center 11-480. After generating the second computed image, the second computed image may be then transmitted from the data center 11-480 to the wireless mobile device 11-376(0) for display to the user.

Referring again to FIG. 11-8, the wireless mobile device 11-376(0) shares the second computed image with another wireless mobile device 11-376(1). In one embodiment, the wireless mobile device 11-376(0) may share any computed image received from the data center 11-480 with the other wireless mobile device 11-376(1). For example, the wireless mobile device 11-376(0) may share the first computed image received from the data center 11-480. As shown in FIG. 11-8, the data center 11-480 communicates with the wireless mobile device 11-376(0) and the wireless mobile device 11-376(1) over the same data network 11-474. Of course, in other embodiments the wireless mobile device 11-376(0) may communicate with the data center 11-480 via a network different than a network utilized by the data center 11-480 and the wireless mobile device 11-376(1) for communication.

In another embodiment, the wireless mobile device 11-376(0) may share a computed image with the other wireless mobile device 11-376(1) by transmitting a sharing request to data center 11-480. For example, the wireless mobile device 11-376(0) may request that the data center 11-480 forward the second computed to the other wireless mobile device 11-376(1). In response to receiving the sharing request, the data center 11-480 may then transmit the second computed image to the wireless mobile device 11-376(1). In an embodiment, transmitting the second computed image to the other wireless mobile device 11-376(1) may include sending a URL at which the other wireless mobile device 11-376(1) may access the second computed image.

Still further, as shown in FIG. 11-8, after receiving the second computed image, the other wireless mobile device 11-376(1) may send to the data center 11-480 a request to adjust processing of the at least two digital images. For example, the other wireless mobile device 11-376(1) may display the second computed image in a UI system, such as the UI system 13-1000 of FIG. 13-4A. A user of the other wireless mobile device 11-376(1) may manipulate UI controls to adjust the processing of the at least two digital images transmitted to the data center 11-480 by the wireless mobile device 11-376(0). For example, user manipulation of a slider control at the other wireless mobile device 11-376(1) may result in commands being generated and transmitted to data center 11-480 for processing. In an embodiment, the request to adjust the processing of the at least two digital images sent from the other wireless mobile device 11-376(1) includes the commands generated based on the user manipulation of the slider control at the other wireless mobile device 11-376(1). In other embodiments, the request to adjust processing of the at least two digital images includes any instructions from the wireless mobile device 11-376(1) that the data center 11-480 may use to again process the at least two digital images and generate a third computed image.

As shown in FIG. 11-8, upon receiving the request to adjust processing, the data center 11-480 re-processes the at least two digital images to generate a third computed image. In one embodiment, the data center 11-480 may re-process the at least two digital images using mix weights received from the wireless mobile device 11-376(1). In such an embodiment, the mix weights received from the wireless mobile device 11-376(1) may be provided as input with the at least two digital images to an HDR processing algorithm that executes at the data center 11-480. After generating the third computed image, the third computed image is then transmitted from the data center 11-480 to the wireless mobile device 11-376(1) for display. Still further, after receiving the third computed image, the wireless mobile device 11-376(1) may send to the data center 11-480 a request to store the third computed image. In another embodiment, other wireless mobile devices 11-376 in communication with the data center 11-480 may request storage of a computed image. For example, in the context of FIG. 11-8, the wireless mobile device 11-376(0) may at any time request storage of the first computed image or the second computed image.

In response to receiving a request to store a computed image, the data center 11-480 may store the computed image for later retrieval. For example, the stored computed image may be stored such that the computed image may be later retrieved without re-applying the processing that was applied to generate the computed image. In one embodiment, the data center 11-480 may store computed images within a storage system 11-486 local to the data center 11-480. In other embodiments, the data center 11-480 may store computed images within hardware devices not local to the data center 11-480, such as a data center 11-481. In such embodiments, the data center 11-480 may transmit the computed images over the data network 11-474 for storage.

Still further, in some embodiments, a computed image may be stored with a reference to the at least two digital images utilized to generate the computed image. For example, the computed image may be associated with the at least two digital images utilized to generate the computed image, such as through a URL served by data center 11-480 or 11-481. By linking the stored computed image to the at least two digital images, any user or device with access to the computed image may also be given the opportunity to subsequently adjust the processing applied to the at least two digital images, and thereby generate a new computed image.

To this end, users of wireless mobile devices 11-376 may leverage processing capabilities of a data center 11-480 accessible via a data network 11-474 to generate an HDR image utilizing digital images that other wireless mobile devices 11-376 have captured and subsequently provided access to. For example, digital signals comprising digital images may be transferred over a network for being combined remotely, and the combined digital signals may result in at least a portion of a HDR image. Still further, a user may be able to adjust a blending of two or more digital images to generate a new HDR photograph without relying on their wireless mobile device 11-376 to perform the processing or computation necessary to generate the new HDR photograph. Subsequently, the user's device may receive at least a portion of a HDR image resulting from a combination of two or more digital signals. Accordingly, the user's wireless mobile device 11-376 may conserve power by offloading HDR processing to a data center. Further, the user may be able to effectively capture HDR photographs despite not having a wireless mobile device 11-376 capable of performing high-power processing tasks associated with HDR image generation. Finally, the user may be able to obtain an HDR photograph generated using an algorithm determined to be best for a photographic scene without having to select the HDR algorithm himself or herself and without having installed software that implements such an HDR algorithm on their wireless mobile device 11-376. For example, the user may rely on the data center 11-480 to identify and to select a best HDR algorithm for a particular photographic scene.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

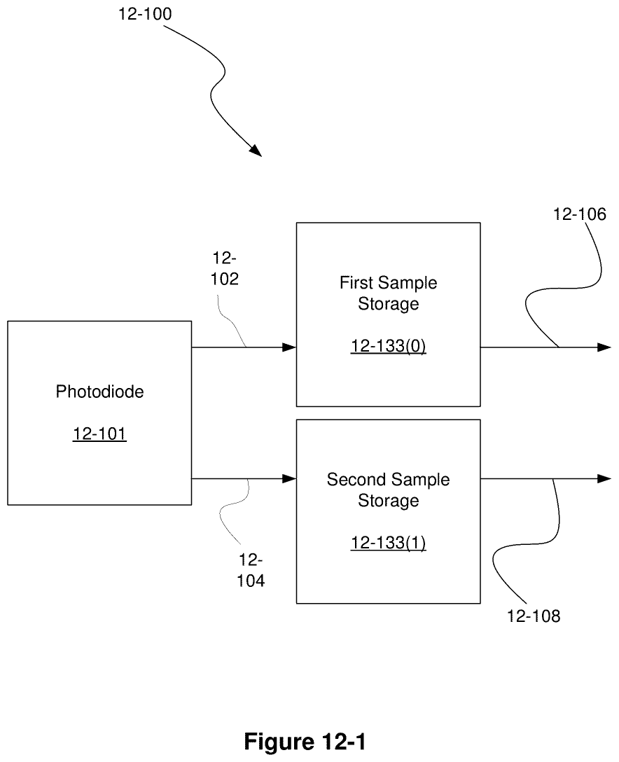

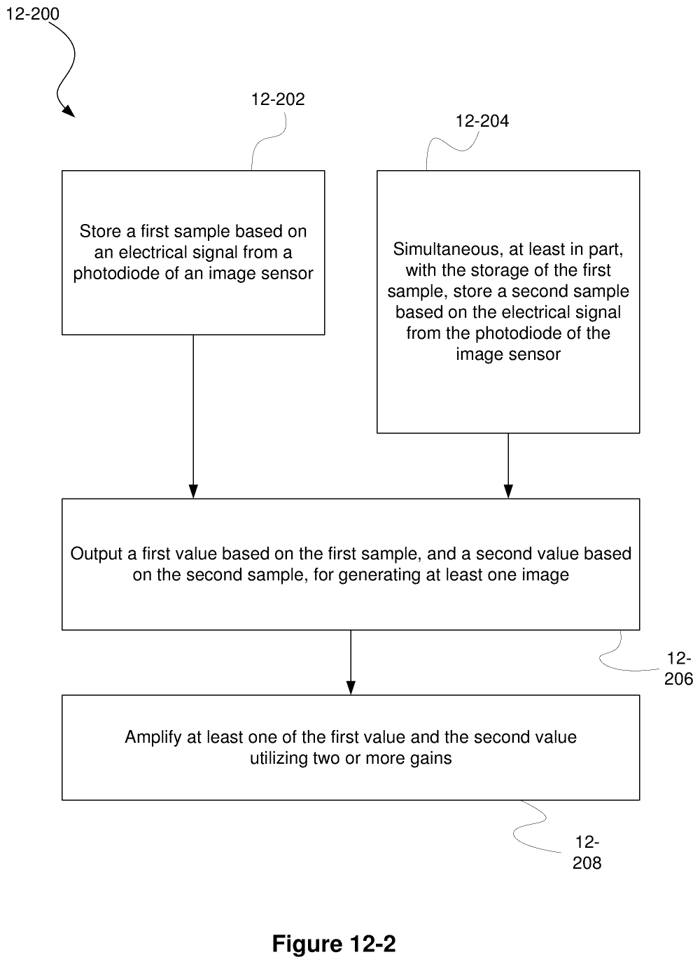

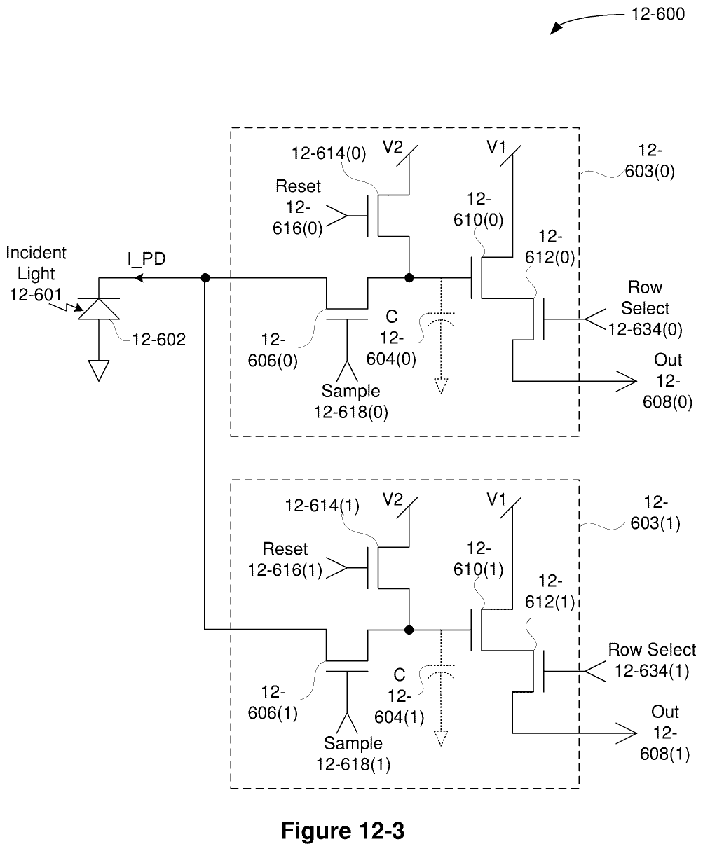

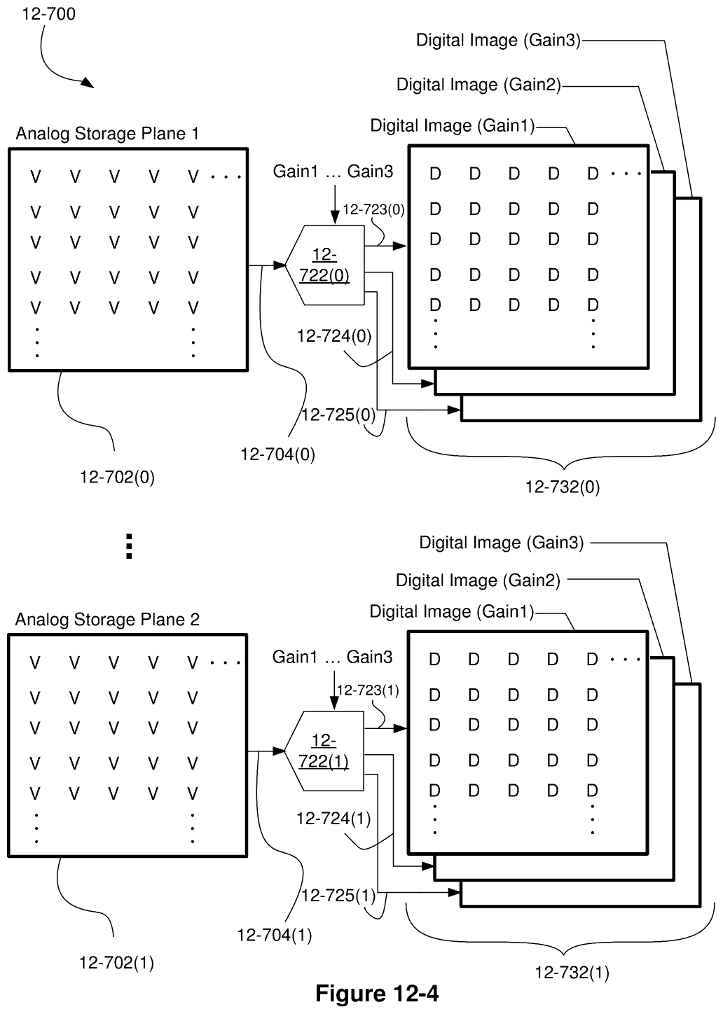

FIG. 12-1 illustrates a system 12-100 for simultaneously capturing multiple images, in accordance with one possible embodiment. As an option, the system 12-100 may be implemented in the context of any of the Figures disclosed herein. Of course, however, the system 12-100 may be implemented in any desired environment. Further, the aforementioned definitions may equally apply to the description below.

As shown in FIG. 12-1, the system 12-100 includes a first input 12-102 that is provided to a first sample storage node 12-133(0) based on a photodiode 12-101, and a second input 12-104 provided simultaneously, at least in part, to a second sample storage node 12-133(1) based on the photodiode 12-101. Accordingly, based on the input 12-102 to the first sample storage node 12-133(0) and the input 12-104 to the second sample storage node 12-133(1), a first sample is stored to the first sample storage node 12-133(0) simultaneously, at least in part, with storage of a second sample to the second sample storage node 12-133(1). In one embodiment, simultaneous storage of the first sample during a first time duration and storing the second sample during a second time duration includes storing the first sample and the second sample at least partially contemporaneously. In one embodiment, an entirety of the first sample may be stored simultaneously with storage of at least a portion of the second sample. For example, storage of the second sample may occur during an entirety of the storing of the first sample; however, because storage of the second sample may occur over a greater period of time than storage of the first sample, storage of the first sample may occur during only a portion of the storing of the second sample. In an embodiment, storage of the first sample and the second sample may be started at the same time.

While the following discussion describes an image sensor apparatus and method for simultaneously capturing multiple images using one or more photodiodes of an image sensor, any photo-sensing electrical element or photosensor may be used or implemented.

In one embodiment, the photodiode 12-101 may comprise any semiconductor diode that generates a potential difference, current, or changes its electrical resistance, in response to photon absorption. Accordingly, the photodiode 12-101 may be used to detect or measure a light intensity. Further, the input 12-102 and the input 12-104 received at sample storage nodes 12-133(0) and 12-133(1), respectively, may be based on the light intensity detected or measured by the photodiode 12-101. In such an embodiment, the first sample stored at the first sample storage node 12-133(0) may be based on a first exposure time to light at the photodiode 12-101, and the second sample stored at the second sample storage node 12-133(1) may be based on a second exposure time to the light at the photodiode 12-101.

In one embodiment, the first input 12-102 may include an electrical signal from the photodiode 12-101 that is received at the first sample storage node 12-133(0), and the second input 12-104 may include an electrical signal from the photodiode 12-101 that is received at the second sample storage node 12-133(1). For example, the first input 12-102 may include a current that is received at the first sample storage node 12-133(0), and the second input 12-104 may include a current that is received at the second sample storage node 12-133(1). In another embodiment, the first input 12-102 and the second input 12-104 may be transmitted, at least partially, on a shared electrical interconnect. In other embodiments, the first input 12-102 and the second input 12-104 may be transmitted on different electrical interconnects. In some embodiments, the input 12-102 may be the same as the input 12-104. For example, the input 12-102 and the input 12-104 may each include the same current. In other embodiments, the input 12-102 may include a first current, and the input 12-104 may include a second current that is different than the first current. In yet other embodiments, the first input 12-102 may include any input from which the first sample storage node 12-133(0) may be operative to store a first sample, and the second input 12-104 may include any input from which the second sample storage node 12-133(1) may be operative to store a second sample.

In one embodiment, the first input 12-102 and the second input 12-104 may include an electronic representation of a portion of an optical image that has been focused on an image sensor that includes the photodiode 12-101. In such an embodiment, the optical image may be focused on the image sensor by a lens. The electronic representation of the optical image may comprise spatial color intensity information, which may include different color intensity samples (e.g. red, green, and blue light, etc.). In other embodiments, the spatial color intensity information may also include samples for white light. In one embodiment, the optical image may be an optical image of a photographic scene. In some embodiments, the photodiode 12-101 may be a single photodiode of an array of photodiodes of an image sensor. Such an image sensor may comprise a complementary metal oxide semiconductor (CMOS) image sensor, or charge-coupled device (CCD) image sensor, or any other technically feasible form of image sensor. In other embodiments, photodiode 12-101 may include two or more photodiodes.

In one embodiment, each sample storage node 12-133 includes a charge storing device for storing a sample, and the stored sample may be a function of a light intensity detected at the photodiode 12-101. For example, each sample storage node 12-133 may include a capacitor for storing a charge as a sample. In such an embodiment, each capacitor stores a charge that corresponds to an accumulated exposure during an exposure time or sample time. For example, current received at each capacitor from an associated photodiode may cause the capacitor, which has been previously charged, to discharge at a rate that is proportional to an incident light intensity detected at the photodiode. The remaining charge of each capacitor may be subsequently output from the capacitor as a value. For example, the remaining charge of each capacitor may be output as an analog value that is a function of the remaining charge on the capacitor.

To this end, an analog value received from a capacitor may be a function of an accumulated intensity of light detected at an associated photodiode. In some embodiments, each sample storage node 12-133 may include circuitry operable for receiving input based on a photodiode. For example, such circuitry may include one or more transistors. The one or more transistors may be configured for rendering the sample storage node 12-133 responsive to various control signals, such as sample, reset, and row select signals received from one or more controlling devices or components. In other embodiments, each sample storage node 12-133 may include any device for storing any sample or value that is a function of a light intensity detected at the photodiode 12-101.

Further, as shown in FIG. 12-1, the first sample storage node 12-133(0) outputs first value 12-106, and the second sample storage node 12-133(1) outputs second value 12-108. In one embodiment, the first sample storage node 12-133(0) outputs the first value 12-106 based on the first sample stored at the first sample storage node 12-133(0), and the second sample storage node 12-133(1) outputs the second value 12-108 based on the second sample stored at the second sample storage node 12-133(1).

In some embodiments, the first sample storage node 12-133(0) outputs the first value 12-106 based on a charge stored at the first sample storage node 12-133(0), and the second sample storage node 12-133(1) outputs the second value 12-108 based on a second charge stored at the second sample storage node 12-133(1). The first value 12-106 may be output serially with the second value 12-108, such that one value is output prior to the other value; or the first value 12-106 may be output in parallel with the output of the second value 12-108. In various embodiments, the first value 12-106 may include a first analog value, and the second value 12-108 may include a second analog value. Each of these values may include a current, which may be output for inclusion in an analog signal that includes at least one analog value associated with each photodiode of a photodiode array. In such embodiments, the first analog value 12-106 may be included in a first analog signal, and the second analog value 12-108 may be included in a second analog signal that is different than the first analog signal. In other words, a first analog signal may be generated to include an analog value associated with each photodiode of a photodiode array, and a second analog signal may also be generated to include a different analog value associated with each of the photodiodes of the photodiode array. An analog signal may be a set of spatially discrete intensity samples, each represented by continuous analog values.

To this end, a single photodiode array may be utilized to generate a plurality of analog signals. The plurality of analog signal may be generated concurrently or in parallel. Further, the plurality of analog signals may each be amplified utilizing two or more gains, and each amplified analog signal may be converted to one or more digital signals such that two or more digital signals may be generated in total, where each digital signal may include a digital image. Accordingly, due to the partially contemporaneous storage of the first sample and the second sample, a single photodiode array may be utilized to concurrently generate multiple digital signals or digital images, where each digital signal is associated with a different exposure time or sample time of the same photographic scene. In such an embodiment, multiple digital signals having different exposure characteristics may be simultaneously generated for a single photographic scene. Such a collection of digital signals or digital images may be referred to as an image stack.

In certain embodiments, an analog signal comprises a plurality of distinct analog signals, and a signal amplifier comprises a corresponding set of distinct signal amplifier circuits. For example, each pixel within a row of pixels of an image sensor may have an associated distinct analog signal within an analog signal, and each distinct analog signal may have a corresponding distinct signal amplifier circuit. Further, two or more amplified analog signals may each include gain-adjusted analog pixel data representative of a common analog value from at least one pixel of an image sensor. For example, for a given pixel of an image sensor, a given analog value may be output in an analog signal, and then, after signal amplification operations, the given analog value is represented by a first amplified value in a first amplified analog signal, and by a second amplified value in a second amplified analog signal. Analog pixel data may be analog signal values associated with one or more given pixels.

FIG. 12-2 illustrates a method 12-200 for simultaneously capturing multiple images, in accordance with one embodiment. As an option, the method 12-200 may be carried out in the context of any of the Figures disclosed herein. Of course, however, the method 12-200 may be carried out in any desired environment. Further, the aforementioned definitions may equally apply to the description below.

As shown in operation 12-202, a first sample is stored based on an electrical signal from a photodiode of an image sensor. Further, simultaneous, at least in part, with the storage of the first sample, a second sample is stored based on the electrical signal from the photodiode of the image sensor at operation 12-204. As noted above, the photodiode of the image sensor may comprise any semiconductor diode that generates a potential difference, or changes its electrical resistance, in response to photon absorption. Accordingly, the photodiode may be used to detect or measure light intensity, and the electrical signal from the photodiode may include a photodiode current.

In some embodiments, each sample may include an electronic representation of a portion of an optical image that has been focused on an image sensor that includes the photodiode. In such an embodiment, the optical image may be focused on the image sensor by a lens. The electronic representation of the optical image may comprise spatial color intensity information, which may include different color intensity samples (e.g. red, green, and blue light, etc.). In other embodiments, the spatial color intensity information may also include samples for white light. In one embodiment, the optical image may be an optical image of a photographic scene. The photodiode may be a single photodiode of an array of photodiodes of the image sensor. Such an image sensor may comprise a complementary metal oxide semiconductor (CMOS) image sensor, or charge-coupled device (CCD) image sensor, or any other technically feasible form of image sensor

In the context of one embodiment, each of the samples may be stored by storing energy. For example, each of the samples may include a charged stored on a capacitor. In such an embodiment, the first sample may include a first charge stored at a first capacitor, and the second sample may include a second charge stored at a second capacitor. In one embodiment, the first sample may be different than the second sample. For example, the first sample may include a first charge stored at a first capacitor, and the second sample may include a second charge stored at a second capacitor that is different than the first charge. In one embodiment, the first sample may be different than the second sample due to different sample times. For example, the first sample may be stored by charging or discharging a first capacitor for a first period of time, and the second sample may be stored by charging or discharging a second capacitor for a second period of time, where the first capacitor and the second capacitor may be substantially identical and charged or discharged at a substantially identical rate. Further, the second capacitor may be charged or discharged simultaneously, at least in part, with the charging or discharging of the first capacitor.

In another embodiment, the first sample may be different than the second sample due to, at least partially, different storage characteristics. For example, the first sample may be stored by charging or discharging a first capacitor for a period of time, and the second sample may be stored by charging or discharging a second capacitor for the same period of time, where the first capacitor and the second capacitor may have different storage characteristics and/or be charged or discharged at different rates. More specifically, the first capacitor may have a different capacitance than the second capacitor. Of course, the second capacitor may be charged or discharged simultaneously, at least in part, with the charging or discharging of the first capacitor.

Additionally, as shown at operation 12-206, after storage of the first sample and the second sample, a first value is output based on the first sample, and a second value is output based on the second sample, for generating at least one image. In the context of one embodiment, the first value and the second value are transmitted or output in sequence. For example, the first value may be transmitted prior to the second value. In another embodiment, the first value and the second value may be transmitted in parallel.

In one embodiment, each output value may comprise an analog value. For example, each output value may include a current representative of the associated stored sample. More specifically, the first value may include a current value representative of the stored first sample, and the second value may include a current value representative of the stored second sample. In one embodiment, the first value is output for inclusion in a first analog signal, and the second value is output for inclusion in a second analog signal different than the first analog signal. Further, each value may be output in a manner such that it is combined with other values output based on other stored samples, where the other stored samples are stored responsive to other electrical signals received from other photodiodes of an image sensor. For example, the first value may be combined in a first analog signal with values output based on other samples, where the other samples were stored based on electrical signals received from photodiodes that neighbor the photodiode from which the electrical signal utilized for storing the first sample was received. Similarly, the second value may be combined in a second analog signal with values output based on other samples, where the other samples were stored based on electrical signals received from the same photodiodes that neighbor the photodiode from which the electrical signal utilized for storing the second sample was received.

Finally, at operation 12-208, at least one of the first value and the second value are amplified utilizing two or more gains. In one embodiment, where each output value comprises an analog value, amplifying at least one of the first value and the second value may result in at least two amplified analog values. In another embodiment, where the first value is output for inclusion in a first analog signal, and the second value is output for inclusion in a second analog signal different than the first analog signal, one of the first analog signal or the second analog signal may be amplified utilizing the two or more gains. For example, a first analog signal that includes the first value may be amplified with a first gain and a second gain, such that the first value is amplified with the first gain and the second gain. Of course, more than two analog signals may be amplified using two or more gains. In one embodiment, each amplified analog signal may be converted to a digital signal comprising a digital image.

To this end, an array of photodiodes may be utilized to generate a first analog signal based on a first set of samples captured at a first exposure time or sample time, and a second analog signal based on a second set of samples captured at a second exposure time or sample time, where the first set of samples and the second set of samples may be two different sets of samples of the same photographic scene. Further, each analog signal may include an analog value generated based on each photodiode of each pixel of an image sensor. Each analog value may be representative of a light intensity measured at the photodiode associated with the analog value. Accordingly, an analog signal may be a set of spatially discrete intensity samples, each represented by continuous analog values, and analog pixel data may be analog signal values associated with one or more given pixels. Still further, each analog signal may undergo subsequent processing, such as amplification, which may facilitate conversion of the analog signal into one or more digital signals, each including digital pixel data, which may each comprise a digital image.

The embodiments disclosed herein may advantageously enable a camera module to sample images comprising an image stack with lower (e.g. at or near zero, etc.) inter-sample time (e.g. interframe, etc.) than conventional techniques. In certain embodiments, images comprising the image stack are effectively sampled or captured simultaneously, which may reduce inter-sample time to zero. In other embodiments, the camera module may sample images in coordination with the strobe unit to reduce inter-sample time between an image sampled without strobe illumination and an image sampled with strobe illumination.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 12-3 illustrates a circuit diagram for a photosensitive cell 12-600, in accordance with one possible embodiment. As an option, the cell 12-600 may be implemented in the context of any of the Figures disclosed herein. Of course, however, the system 12-600 may be implemented in any desired environment. Further, the aforementioned definitions may equally apply to the description below.

As shown in FIG. 12-3, a photosensitive cell 12-600 includes a photodiode 12-602 coupled to a first analog sampling circuit 12-603(0) and a second analog sampling circuit 12-603(1). The photodiode 12-602 may be implemented as the photodiode 12-101 described within the context of FIG. 12-1, or any of the photodiodes 11-562 of FIG. 11-3E. Further, an analog sampling circuit 12-603 may be implemented as a sample storage node 12-133 described within the context of FIG. 12-1. In one embodiment, a unique instance of photosensitive cell 12-600 may be implemented as each of cells 11-542-11-545 comprising a pixel 11-540 within the context of FIGS. 11-3A-11-3E.

As shown, the photosensitive cell 12-600 comprises two analog sampling circuits 12-603, and a photodiode 12-602. The two analog sampling circuits 12-603 include a first analog sampling circuit 12-603(0) which is coupled to a second analog sampling circuit 12-603(1). As shown in FIG. 12-3, the first analog sampling circuit 12-603(0) comprises transistors 12-606(0), 12-610(0), 12-612(0), 12-614(0), and a capacitor 12-604(0); and the second analog sampling circuit 12-603(1) comprises transistors 12-606(1), 12-610(1), 12-612(1), 12-614(1), and a capacitor 12-604(1). In one embodiment, each of the transistors 12-606, 12-610, 12-612, and 12-614 may be a field-effect transistor.

The photodiode 12-602 may be operable to measure or detect incident light 12-601 of a photographic scene. In one embodiment, the incident light 12-601 may include ambient light of the photographic scene. In another embodiment, the incident light 12-601 may include light from a strobe unit utilized to illuminate the photographic scene. Of course, the incident light 12-601 may include any light received at and measured by the photodiode 12-602. Further still, and as discussed above, the incident light 12-601 may be concentrated on the photodiode 12-602 by a microlens, and the photodiode 12-602 may be one photodiode of a photodiode array that is configured to include a plurality of photodiodes arranged on a two-dimensional plane.

In one embodiment, the analog sampling circuits 12-603 may be substantially identical. For example, the first analog sampling circuit 12-603(0) and the second analog sampling circuit 12-603(1) may each include corresponding transistors, capacitors, and interconnects configured in a substantially identical manner. Of course, in other embodiments, the first analog sampling circuit 12-603(0) and the second analog sampling circuit 12-603(1) may include circuitry, transistors, capacitors, interconnects and/or any other components or component parameters (e.g. capacitance value of each capacitor 12-604) which may be specific to just one of the analog sampling circuits 12-603.

In one embodiment, each capacitor 12-604 may include one node of a capacitor comprising gate capacitance for a transistor 12-610 and diffusion capacitance for transistors 12-606 and 12-614. The capacitor 12-604 may also be coupled to additional circuit elements (not shown) such as, without limitation, a distinct capacitive structure, such as a metal-oxide stack, a poly capacitor, a trench capacitor, or any other technically feasible capacitor structures.

With respect to analog sampling circuit 12-603(0), when reset 12-616(0) is active (low), transistor 12-614(0) provides a path from voltage source V2 to capacitor 12-604(0), causing capacitor 12-604(0) to charge to the potential of V2. When sample signal 12-618(0) is active, transistor 12-606(0) provides a path for capacitor 12-604(0) to discharge in proportion to a photodiode current (I_PD) generated by the photodiode 12-602 in response to the incident light 12-601. In this way, photodiode current I_PD is integrated for a first exposure time when the sample signal 12-618(0) is active, resulting in a corresponding first voltage on the capacitor 12-604(0). This first voltage on the capacitor 12-604(0) may also be referred to as a first sample. When row select 12-634(0) is active, transistor 12-612(0) provides a path for a first output current from V1 to output 12-608(0). The first output current is generated by transistor 12-610(0) in response to the first voltage on the capacitor 12-604(0). When the row select 12-634(0) is active, the output current at the output 12-608(0) may therefore be proportional to the integrated intensity of the incident light 12-601 during the first exposure time. In one embodiment, sample signal 12-618(0) is asserted substantially simultaneously over substantially all photo sensitive cells 12-600 comprising an image sensor to implement a global shutter for all first samples within the image sensor.

With respect to analog sampling circuit 12-603(1), when reset 12-616(1) is active (low), transistor 12-614(1) provides a path from voltage source V2 to capacitor 12-604(1), causing capacitor 12-604(1) to charge to the potential of V2. When sample signal 12-618(1) is active, transistor 12-606(1) provides a path for capacitor 12-604(1) to discharge in proportion to a photodiode current (I_PD) generated by the photodiode 12-602 in response to the incident light 12-601. In this way, photodiode current I_PD is integrated for a second exposure time when the sample signal 12-618(1) is active, resulting in a corresponding second voltage on the capacitor 12-604(1). This second voltage on the capacitor 12-604(1) may also be referred to as a second sample. When row select 12-634(1) is active, transistor 12-612(1) provides a path for a second output current from V1 to output 12-608(1). The second output current is generated by transistor 12-610(1) in response to the second voltage on the capacitor 12-604(1). When the row select 12-634(1) is active, the output current at the output 12-608(1) may therefore be proportional to the integrated intensity of the incident light 12-601 during the second exposure time. In one embodiment, sample signal 12-618(1) is asserted substantially simultaneously over substantially all photo sensitive cells 12-600 comprising an image sensor to implement a global shutter for all second samples within the image sensor.

To this end, by controlling the first exposure time and the second exposure time such that the first exposure time is different than the second exposure time, the capacitor 12-604(0) may store a first voltage or sample, and the capacitor 12-604(1) may store a second voltage or sample different than the first voltage or sample, in response to a same photodiode current I_PD being generated by the photodiode 12-602. In one embodiment, the first exposure time and the second exposure time begin at the same time, overlap in time, and end at different times. Accordingly, each of the analog sampling circuits 12-603 may be operable to store an analog value corresponding to a different exposure. As a benefit of having two different exposure times, in situations where a photodiode 12-602 is exposed to a sufficient threshold of incident light 12-601, a first capacitor 12-604(0) may provide a blown out, or over-exposed image portion, and a second capacitor 12-604(1) of the same cell 12-600 may provide an analog value suitable for generating a digital image. Thus, for each cell 12-600, a first capacitor 12-604 may more effectively capture darker image content than another capacitor 12-604 of the same cell 12-600.

In other embodiments, it may be desirable to use more than two analog sampling circuits for the purpose of storing more than two voltages or samples. For example, an embodiment with three or more analog sampling circuits could be implemented such that each analog sampling circuit concurrently samples for a different exposure time the same photodiode current I_PD being generated by a photodiode. In such an embodiment, three or more voltages or samples could be obtained. To this end, a current I_PD generated by the photodiode 12-602 may be split over a number of analog sampling circuits 12-603 coupled to the photodiode 12-602 at any given time. Consequently, exposure sensitivity may vary as a function of the number of analog sampling circuits 12-603 that are coupled to the photodiode 12-602 at any given time, and the amount of capacitance that is associated with each analog sampling circuit 12-603. Such variation may need to be accounted for in determining an exposure time or sample time for each analog sampling circuit 12-603.

In various embodiments, capacitor 12-604(0) may be substantially identical to capacitor 12-604(1). For example, the capacitors 12-604(0) and 12-604(1) may have substantially identical capacitance values. In such embodiments, the photodiode current I_PD may be split evenly between the capacitors 12-604(0) and 12-604(1) during a first portion of time where the capacitors are discharged at a substantially identical rage. The photodiode current may be subsequently directed to one selected capacitor of the capacitors 12-604(0) and 12-604(1) during a second portion of time in which the selected capacitor discharges at twice the rate associated with the first portion of time. In one embodiment, to obtain different voltages or samples between the capacitors 12-604(0) and 12-604(1), a sample signal 12-618 of one of the analog sampling circuits may be activated for a longer or shorter period of time than a sample signal 12-618 is activated for any other analog sampling circuits 12-603 receiving at least a portion of photodiode current I_PD.

In an embodiment, an activation of a sample signal 12-618 of one analog sampling circuit 12-603 may be configured to be controlled based on an activation of another sample signal 12-618 of another analog sampling circuit 12-603 in the same cell 12-600. For example, the sample signal 12-618(0) of the first analog sampling circuit 12-603(0) may be activated for a period of time that is controlled to be at a ratio of 2:1 with respect to an activation period for the sample signal 12-618(1) of the second analog sampling circuit 12-603(1). By way of a more specific example, a controlled ratio of 2:1 may result in the sample signal 12-618(0) being activated for a period of 1/30 of a second when the sample signal 12-618(1) has been selected to be activated for a period of 1/60 of a second. Of course activation or exposure times for each sample signal 12-618 may be controlled to be for other periods of time, such as for 1 second, 1/120 of a second, 1/1000 of a second, etc., or for other ratios, such as 0.5:1, 1.2:1, 1.5:1, 3:1, etc. In one embodiment, a period of activation of at least one of the sample signals 12-618 may be controlled by software executing on a digital photographic system, such as digital photographic system 300, or by a user, such as a user interacting with a “manual mode” of a digital camera. For example, a period of activation of at least one of the sample signals 12-618 may be controlled based on a user selection of a shutter speed. To achieve a 2:1 exposure, a 3:1 exposure time may be needed due to current splitting during a portion of the overall exposure process.

In other embodiments, the capacitors 12-604(0) and 12-604(1) may have different capacitance values. In one embodiment, the capacitors 12-604(0) and 12-604(1) may have different capacitance values for the purpose of rendering one of the analog sampling circuits 12-603 more or less sensitive to the current I_PD from the photodiode 12-602 than other analog sampling circuits 12-603 of the same cell 12-600. For example, a capacitor 12-604 with a significantly larger capacitance than other capacitors 12-604 of the same cell 12-600 may be less likely to fully discharge when capturing photographic scenes having significant amounts of incident light 12-601. In such embodiments, any difference in stored voltages or samples between the capacitors 12-604(0) and 12-604(1) may be a function of the different capacitance values in conjunction with different activation times of the sample signals 12-618.

In an embodiment, sample signal 12-618(0) and sample signal 12-618(1) may be asserted to an active state independently. In another embodiment, the sample signal 12-618(0) and the sample signal 12-618(1) are asserted to an active state simultaneously, and one is deactivated at an earlier time than the other, to generate images that are sampled substantially simultaneously for a portion of time, but with each having a different effective exposure time or sample time. Whenever both the sample signal 12-618(0) and the sample signal 12-618(1) are asserted simultaneously, photodiode current I_PD may be divided between discharging capacitor 12-604(0) and discharging capacitor 12-604(1).

In one embodiment, the photosensitive cell 12-600 may be configured such that the first analog sampling circuit 12-603(0) and the second analog sampling circuit 12-603(1) share at least one shared component. In various embodiments, the at least one shared component may include a photodiode 12-602 of an image sensor. In other embodiments, the at least one shared component may include a reset, such that the first analog sampling circuit 12-603(0) and the second analog sampling circuit 12-603(1) may be reset concurrently utilizing the shared reset. In the context of FIG. 12-3, the photosensitive cell 12-600 may include a shared reset between the analog sampling circuits 12-603(0) and 12-603(1). For example, reset 12-616(0) may be coupled to reset 12-616(1), and both may be asserted together such that the reset 12-616(0) is the same signal as the reset 12-616(1), which may be used to simultaneously reset both of the first analog sampling circuit 12-603(0) and the second analog sampling circuit 12-603(1). After reset, the first analog sampling circuit 12-603(0) and the second analog sampling circuit 12-603(1) may be asserted to sample together.

In another embodiment, a sample signal 12-618(0) for the first analog sampling circuit 12-603(0) may be independent of a sample signal 12-618(1) for the second analog sampling circuit 12-603(1). In one embodiment, a row select 12-634(0) for the first analog sampling circuit 12-603(0) may be independent of a row select 12-634(1) for the second analog sampling circuit 12-603(1). In other embodiments, the row select 12-634(0) for the first analog sampling circuit 12-603(0) may include a row select signal that is shared with the row select 12-634(1) for the second analog sampling circuit 12-603(1). In yet another embodiment, output signal at output 12-608(0) of the first analog sampling circuit 12-603(0) may be independent of output signal at output 12-608(1) of the second analog sampling circuit 12-603(1). In another embodiment, the output signal of the first analog sampling circuit 12-603(0) may utilize an output shared with the output signal of the second analog sampling circuit 12-603(1). In embodiments sharing an output, it may be necessary for the row select 12-634(0) of the first analog sampling circuit 12-603(0) to be independent of the row select 12-634(1) of the second analog sampling circuit 12-603(1). In embodiments sharing a row select signal, it may be necessary for a line of the output 12-608(0) of the first analog sampling circuit 12-603(0) to be independent of a line of the output 12-608(1) of the second analog sampling circuit 12-603(1).

In one embodiment, a column signal 11-532 of FIG. 11-3A may comprise one output signal of a plurality of independent output signals of the outputs 12-608(0) and 12-608(1). Further, a row control signal 11-530 of FIG. 11-3A may comprise one of independent row select signals of the row selects 12-634(0) and 12-634(1), which may be shared for a given row of pixels. In embodiments of cell 12-600 that implement a shared row select signal, the row select 12-634(0) may be coupled to the row select 12-634(1), and both may be asserted together simultaneously.

In an embodiment, a given row of pixels may include one or more rows of cells, where each row of cells includes multiple instances of the photosensitive cell 12-600, such that each row of cells includes multiple pairs of analog sampling circuits 12-603(0) and 12-603(1). For example, a given row of cells may include a plurality of first analog sampling circuits 12-603(0), and may further include a different second analog sampling circuit 12-603(1) paired to each of the first analog sampling circuits 12-603(0). In one embodiment, the plurality of first analog sampling circuits 12-603(0) may be driven independently from the plurality of second analog sampling circuits 12-603(1). In another embodiment, the plurality of first analog sampling circuits 12-603(0) may be driven in parallel with the plurality of second analog sampling circuits 12-603(1). For example, each output 12-608(0) of each of the first analog sampling circuits 12-603(0) of the given row of cells may be driven in parallel through one set of column signals 11-532. Further, each output 12-608(1) of each of the second analog sampling circuits 12-603(1) of the given row of cells may be driven in parallel through a second, parallel, set of column signals 11-532.

To this end, the photosensitive cell 12-600 may be utilized to simultaneously, at least in part, generate and store both of a first sample and a second sample based on the incident light 12-601. Specifically, the first sample may be captured and stored on a first capacitor during a first exposure time, and the second sample may be simultaneously, at least in part, captured and stored on a second capacitor during a second exposure time. Further, an output current signal corresponding to the first sample of the two different samples may be coupled to output 12-608(0) when row select 12-634(0) is activated, and an output current signal corresponding to the second sample of the two different samples may be coupled to output 12-608(1) when row select 12-634(1) is activated.

In one embodiment, the first value may be included in a first analog signal containing first analog pixel data for a plurality of pixels at the first exposure time, and the second value may be included in a second analog signal containing second analog pixel data for the plurality of pixels at the second exposure time. Further, the first analog signal may be utilized to generate a first stack of one or more digital images, and the second analog signal may be utilized to generate a second stack of one or more digital images. Any differences between the first stack of images and the second stack of images may be based on, at least in part, a difference between the first exposure time and the second exposure time. Accordingly, an array of photosensitive cells 12-600 may be utilized for simultaneously capturing multiple digital images.

In one embodiment, a unique instance of analog pixel data 12-621 may include, as an ordered set of individual analog values, all analog values output from all corresponding analog sampling circuits or sample storage nodes. For example, in the context of the foregoing figures, each cell of cells 11-542-11-545 of a plurality of pixels 11-540 of a pixel array 11-510 may include both a first analog sampling circuit 12-603(0) and a second analog sampling circuit 12-603(1). Thus, the pixel array 11-510 may include a plurality of first analog sampling circuits 12-603(0) and also include a plurality of second analog sampling circuits 12-603(1). In other words, the pixel array 11-510 may include a first analog sampling circuit 12-603(0) for each cell, and also include a second analog sampling circuit 12-603(1) for each cell. In an embodiment, a first instance of analog pixel data 12-621 may be received containing a discrete analog value from each analog sampling circuit of a plurality of first analog sampling circuits 12-603(0), and a second instance of analog pixel data 12-621 may be received containing a discrete analog value from each analog sampling circuit of a plurality of second analog sampling circuits 12-603(1). Thus, in embodiments where cells of a pixel array include two or more analog sampling circuits, the pixel array may output two or more discrete analog signals, where each analog signal includes a unique instance of analog pixel data 12-621.

In some embodiments, only a subset of the cells of a pixel array may include two or more analog sampling circuits. For example, not every cell may include both a first analog sampling circuit 12-603(0) and a second analog sampling circuit 12-603(1).

With continuing reference to FIG. 11-4, the analog-to-digital unit 11-622 includes an amplifier 11-650 and an analog-to-digital converter 11-654. In one embodiment, the amplifier 11-650 receives an instance of analog pixel data 11-621 and a gain 11-652, and applies the gain 11-652 to the analog pixel data 11-621 to generate gain-adjusted analog pixel data 11-623. The gain-adjusted analog pixel data 11-623 is transmitted from the amplifier 11-650 to the analog-to-digital converter 11-654. The analog-to-digital converter 11-654 receives the gain-adjusted analog pixel data 11-623, and converts the gain-adjusted analog pixel data 11-623 to the digital pixel data 11-625, which is then transmitted from the analog-to-digital converter 11-654. In other embodiments, the amplifier 11-650 may be implemented within the column read out circuit 11-520 instead of within the analog-to-digital unit 11-622. The analog-to-digital converter 11-654 may convert the gain-adjusted analog pixel data 11-623 to the digital pixel data 11-625 using any technically feasible analog-to-digital conversion technique.

In an embodiment, the gain-adjusted analog pixel data 11-623 results from the application of the gain 11-652 to the analog pixel data 11-621. In one embodiment, the gain 11-652 may be selected by the analog-to-digital unit 11-622. In another embodiment, the gain 11-652 may be selected by the control unit 11-514, and then supplied from the control unit 11-514 to the analog-to-digital unit 11-622 for application to the analog pixel data 11-621.

It should be noted, in one embodiment, that a consequence of applying the gain 11-652 to the analog pixel data 11-621 is that analog noise may appear in the gain-adjusted analog pixel data 11-623. If the amplifier 11-650 imparts a significantly large gain to the analog pixel data 11-621 in order to obtain highly sensitive data from of the pixel array 11-510, then a significant amount of noise may be expected within the gain-adjusted analog pixel data 11-623. In one embodiment, the detrimental effects of such noise may be reduced by capturing the optical scene information at a reduced overall exposure. In such an embodiment, the application of the gain 11-652 to the analog pixel data 11-621 may result in gain-adjusted analog pixel data with proper exposure and reduced noise.

In one embodiment, the amplifier 11-650 may be a transimpedance amplifier (TIA). Furthermore, the gain 11-652 may be specified by a digital value. In one embodiment, the digital value specifying the gain 11-652 may be set by a user of a digital photographic device, such as by operating the digital photographic device in a “manual” mode. Still yet, the digital value may be set by hardware or software of a digital photographic device. As an option, the digital value may be set by the user working in concert with the software of the digital photographic device.

In one embodiment, a digital value used to specify the gain 11-652 may be associated with an ISO. In the field of photography, the ISO system is a well-established standard for specifying light sensitivity. In one embodiment, the amplifier 11-650 receives a digital value specifying the gain 11-652 to be applied to the analog pixel data 11-621. In another embodiment, there may be a mapping from conventional ISO values to digital gain values that may be provided as the gain 11-652 to the amplifier 11-650. For example, each of ISO 100, ISO 200, ISO 400, ISO 800, ISO 1600, etc. may be uniquely mapped to a different digital gain value, and a selection of a particular ISO results in the mapped digital gain value being provided to the amplifier 11-650 for application as the gain 11-652. In one embodiment, one or more ISO values may be mapped to a gain of 1. Of course, in other embodiments, one or more ISO values may be mapped to any other gain value.

Accordingly, in one embodiment, each analog pixel value may be adjusted in brightness given a particular ISO value. Thus, in such an embodiment, the gain-adjusted analog pixel data 11-623 may include brightness corrected pixel data, where the brightness is corrected based on a specified ISO. In another embodiment, the gain-adjusted analog pixel data 11-623 for an image may include pixels having a brightness in the image as if the image had been sampled at a certain ISO.

In accordance with an embodiment, the digital pixel data 11-625 may comprise a plurality of digital values representing pixels of an image captured using the pixel array 11-510.

In one embodiment, an instance of digital pixel data 11-625 may be output for each instance of analog pixel data 11-621 received. Thus, where a pixel array 11-510 includes a plurality of first analog sampling circuits 12-603(0) and also includes a plurality of second analog sampling circuits 12-603(1), then a first instance of analog pixel data 11-621 may be received containing a discrete analog value from each of the first analog sampling circuits 12-603(0) and a second instance of analog pixel data 11-621 may be received containing a discrete analog value from each of the second analog sampling circuits 12-603(1). In such an embodiment, a first instance of digital pixel data 11-625 may be output based on the first instance of analog pixel data 11-621, and a second instance of digital pixel data 11-625 may be output based on the second instance of analog pixel data 11-621.

Further, the first instance of digital pixel data 11-625 may include a plurality of digital values representing pixels of a first image captured using the plurality of first analog sampling circuits 12-603(0) of the pixel array 11-510, and the second instance of digital pixel data 11-625 may include a plurality of digital values representing pixels of a second image captured using the plurality of second analog sampling circuits 12-603(1) of the pixel array 11-510. Where the first instance of digital pixel data 11-625 and the second instance of digital pixel data 11-625 are generated utilizing the same gain 11-652, then any differences between the instances of digital pixel data may be a function of a difference between the exposure time of the plurality of first analog sampling circuits 12-603(0) and the exposure time of the plurality of second analog sampling circuits 12-603(1).

In some embodiments, two or more gains 11-652 may be applied to an instance of analog pixel data 11-621, such that two or more instances of digital pixel data 11-625 may be output for each instance of analog pixel data 11-621. For example, two or more gains may be applied to both of a first instance of analog pixel data 11-621 and a second instance of analog pixel data 11-621. In such an embodiment, the first instance of analog pixel data 11-621 may contain a discrete analog value from each of a plurality of first analog sampling circuits 12-603(0) of a pixel array 11-510, and the second instance of analog pixel data 11-621 may contain a discrete analog value from each of a plurality of second analog sampling circuits 12-603(1) of the pixel array 11-510. Thus, four or more instances of digital pixel data 11-625 associated with four or more corresponding digital images may be generated from a single capture by the pixel array 11-510 of a photographic scene.

FIG. 12-4 illustrates a system 12-700 for converting analog pixel data of an analog signal to digital pixel data, in accordance with an embodiment. As an option, the system 12-700 may be implemented in the context of the details of any of the Figures disclosed herein. Of course, however, the system 12-700 may be implemented in any desired environment. Further, the aforementioned definitions may equally apply to the description below.

The system 12-700 is shown in FIG. 12-4 to include a first analog storage plane 12-702(0), a first analog-to-digital unit 12-722(0), and a first digital image stack 12-732(0), and is shown to further include a second analog storage plane 12-702(1), a second analog-to-digital unit 12-722(1), and a second digital image stack 12-732(1). Accordingly, the system 12-700 is shown to include at least two analog storage planes 12-702(0) and 12-702(1). As illustrated in FIG. 12-4, a plurality of analog values are each depicted as a “V” within each of the analog storage planes 12-702, and corresponding digital values are each depicted as a “D” within digital images of each of the image stacks 12-732.

In the context of certain embodiments, each analog storage plane 12-702 may comprise any collection of one or more analog values. In some embodiments, each analog storage plane 12-702 may comprise at least one analog pixel value for each pixel of a row or line of a pixel array. Still yet, in another embodiment, each analog storage plane 12-702 may comprise at least one analog pixel value for each pixel of an entirety of a pixel array, which may be referred to as a frame. For example, each analog storage plane 12-702 may comprise an analog pixel value, or more generally, an analog value for each cell of each pixel of every line or row of a pixel array.

Further, the analog values of each analog storage plane 12-702 are output as analog pixel data 12-704 to a corresponding analog-to-digital unit 12-722. For example, the analog values of analog storage plane 12-702(0) are output as analog pixel data 12-704(0) to analog-to-digital unit 12-722(0), and the analog values of analog storage plane 12-702(1) are output as analog pixel data 12-704(1) to analog-to-digital unit 12-722(1). In one embodiment, each analog-to-digital unit 12-722 may be substantially identical to the analog-to-digital unit 11-622 described within the context of FIG. 11-4. For example, each analog-to-digital unit 12-722 may comprise at least one amplifier and at least one analog-to-digital converter, where the amplifier is operative to receive a gain value and utilize the gain value to gain-adjust analog pixel data received at the analog-to-digital unit 12-722. Further, in such an embodiment, the amplifier may transmit gain-adjusted analog pixel data to an analog-to-digital converter, which then generates digital pixel data from the gain-adjusted analog pixel data. To this end, an analog-to-digital conversion may be performed on the contents of each of two or more different analog storage planes 12-702.

In the context of the system 12-700 of FIG. 12-4, each analog-to-digital unit 12-722 receives corresponding analog pixel data 12-704, and applies at least two different gains to the received analog pixel data 12-704 to generate at least a first gain-adjusted analog pixel data and a second gain-adjusted analog pixel data. For example, the analog-to-digital unit 12-722(0) receives analog pixel data 12-704(0), and applies at least two different gains to the analog pixel data 12-704(0) to generate at least a first gain-adjusted analog pixel data and a second gain-adjusted analog pixel data based on the analog pixel data 12-704(0); and the analog-to-digital unit 12-722(1) receives analog pixel data 12-704(1), and applies at least two different gains to the analog pixel data 12-704(1) to generate at least a first gain-adjusted analog pixel data and a second gain-adjusted analog pixel data based on the analog pixel data 12-704(1).

Further, each analog-to-digital unit 12-722 converts each generated gain-adjusted analog pixel data to digital pixel data, and then outputs at least two digital outputs. In one embodiment, each analog-to-digital unit 12-722 provides a different digital output corresponding to each gain applied to the received analog pixel data 12-704. With respect to FIG. 12-4 specifically, the analog-to-digital unit 12-722(0) is shown to generate a first digital signal comprising first digital pixel data 12-723(0) corresponding to a first gain (Gain1), a second digital signal comprising second digital pixel data 12-724(0) corresponding to a second gain (Gain2), and a third digital signal comprising third digital pixel data 12-725(0) corresponding to a third gain (Gain3). Similarly, the analog-to-digital unit 12-722(1) is shown to generate a first digital signal comprising first digital pixel data 12-723(1) corresponding to a first gain (Gain1), a second digital signal comprising second digital pixel data 12-724(1) corresponding to a second gain (Gain2), and a third digital signal comprising third digital pixel data 12-725(1) corresponding to a third gain (Gain3). Each instance of each digital pixel data may comprise a digital image, such that each digital signal comprises a digital image.

Accordingly, as a result of the analog-to-digital unit 12-722(0) applying each of Gain1, Gain2, and Gain3 to the analog pixel data 12-704(0), and thereby generating first digital pixel data 12-723(0), second digital pixel data 12-724(0), and third digital pixel data 12-725(0), the analog-to-digital unit 12-722(0) generates a stack of digital images, also referred to as an image stack 12-732(0). Similarly, as a result of the analog-to-digital unit 12-722(1) applying each of Gain1, Gain2, and Gain3 to the analog pixel data 12-704(1), and thereby generating first digital pixel data 12-723(1), second digital pixel data 12-724(1), and third digital pixel data 12-725(1), the analog-to-digital unit 12-722(1) generates a second stack of digital images, also referred to as an image stack 12-732(1).

In one embodiment, each analog-to-digital unit 12-722 applies in sequence at least two gains to the analog values. For example, within the context of FIG. 12-4, the analog-to-digital unit 12-722(0) first applies Gain1 to the analog pixel data 12-704(0), then subsequently applies Gain2 to the same analog pixel data 12-704(0), and then subsequently applies Gain3 to the same analog pixel data 12-704(0). In other embodiments, each analog-to-digital unit 12-722 may apply in parallel at least two gains to the analog values. For example, an analog-to-digital unit may apply Gain1 to received analog pixel data in parallel with application of Gain2 and Gain3 to the analog pixel data. To this end, each instance of analog pixel data 12-704 is amplified utilizing at least two gains.

In one embodiment, the gains applied to the analog pixel data 12-704(0) at the analog-to-digital unit 12-722(0) may be the same as the gains applied to the analog pixel data 12-704(1) at the analog-to-digital unit 12-722(1). By way of a specific example, the Gain1 applied by both of the analog-to-digital unit 12-722(0) and the analog-to-digital unit 12-722(1) may be a gain of 12-1.0, the Gain2 applied by both of the analog-to-digital unit 12-722(0) and the analog-to-digital unit 12-722(1) may be a gain of 12-2.0, and the Gain3 applied by both of the analog-to-digital unit 12-722(0) and the analog-to-digital unit 12-722(1) may be a gain of 4.0. In another embodiment, one or more of the gains applied to the analog pixel data 12-704(0) at the analog-to-digital unit 12-722(0) may be different from the gains applied to the analog pixel data 12-704(1) at the analog-to-digital unit 12-722(1). For example, the Gain1 applied at the analog-to-digital unit 12-722(0) may be a gain of 12-1.0, and the Gain1 applied at the analog-to-digital unit 12-722(1) may be a gain of 12-2.0. Accordingly, the gains applied at each analog-to-digital unit 12-722 may be selected dependently or independently of the gains applied at other analog-to-digital units 12-722 within system 12-700.

In accordance with one embodiment, the at least two gains may be determined using any technically feasible technique based on an exposure of a photographic scene, metering data, user input, detected ambient light, a strobe control, or any combination of the foregoing. For example, a first gain of the at least two gains may be determined such that half of the digital values from an analog storage plane 12-702 are converted to digital values above a specified threshold (e.g., a threshold of 0.5 in a range of 0.0 to 12-1.0) for the dynamic range associated with digital values comprising a first digital image of an image stack 12-732, which can be characterized as having an “EV0” exposure. Continuing the example, a second gain of the at least two gains may be determined as being twice that of the first gain to generate a second digital image of the image stack 12-732 characterized as having an “EV+1” exposure. Further still, a third gain of the at least two gains may be determined as being half that of the first gain to generate a third digital image of the image stack 12-732 characterized as having an “EV−1” exposure.

In one embodiment, an analog-to-digital unit 12-722 converts in sequence a first instance of the gain-adjusted analog pixel data to the first digital pixel data 12-723, a second instance of the gain-adjusted analog pixel data to the second digital pixel data 12-724, and a third instance of the gain-adjusted analog pixel data to the third digital pixel data 12-725. For example, an analog-to-digital unit 12-722 may first convert a first instance of the gain-adjusted analog pixel data to first digital pixel data 12-723, then subsequently convert a second instance of the gain-adjusted analog pixel data to second digital pixel data 12-724, and then subsequently convert a third instance of the gain-adjusted analog pixel data to third digital pixel data 12-725. In other embodiments, an analog-to-digital unit 12-722 may perform such conversions in parallel, such that one or more of a first digital pixel data 12-723, a second digital pixel data 12-724, and a third digital pixel data 12-725 are generated in parallel.

Still further, as shown in FIG. 12-4, each first digital pixel data 12-723 provides a first digital image. Similarly, each second digital pixel data 12-724 provides a second digital image, and each third digital pixel data 12-725 provides a third digital image. Together, each set of digital images produced using the analog values of a single analog storage plane 12-702 comprises an image stack 12-732. For example, image stack 12-732(0) comprises digital images produced using analog values of the analog storage plane 12-702(0), and image stack 12-732(1) comprises the digital images produced using the analog values of the analog storage plane 12-702(1).

As illustrated in FIG. 12-4, all digital images of an image stack 12-732 may be based upon a same analog pixel data 12-704. However, each digital image of an image stack 12-732 may differ from other digital images in the image stack 12-732 as a function of a difference between the gains used to generate the two digital images. Specifically, a digital image generated using the largest gain of at least two gains may be visually perceived as the brightest or more exposed of the digital images of the image stack 12-732. Conversely, a digital image generated using the smallest gain of the at least two gains may be visually perceived as the darkest and less exposed than other digital images of the image stack 12-732. To this end, a first light sensitivity value may be associated with first digital pixel data 12-723, a second light sensitivity value may be associated with second digital pixel data 12-724, and a third light sensitivity value may be associated with third digital pixel data 12-725. Further, because each of the gains may be associated with a different light sensitivity value, a first digital image or first digital signal may be associated with a first light sensitivity value, a second digital image or second digital signal may be associated with a second light sensitivity value, and a third digital image or third digital signal may be associated with a third light sensitivity value.

It should be noted that while a controlled application of gain to the analog pixel data may greatly aid in HDR image generation, an application of too great of gain may result in a digital image that is visually perceived as being noisy, over-exposed, and/or blown-out. In one embodiment, application of two stops of gain to the analog pixel data may impart visually perceptible noise for darker portions of a photographic scene, and visually imperceptible noise for brighter portions of the photographic scene. In another embodiment, a digital photographic device may be configured to provide an analog storage plane for analog pixel data of a captured photographic scene, and then perform at least two analog-to-digital samplings of the same analog pixel data using an analog-to-digital unit 12-722. To this end, a digital image may be generated for each sampling of the at least two samplings, where each digital image is obtained at a different exposure despite all the digital images being generated from the same analog sampling of a single optical image focused on an image sensor.

In one embodiment, an initial exposure parameter may be selected by a user or by a metering algorithm of a digital photographic device. The initial exposure parameter may be selected based on user input or software selecting particular capture variables. Such capture variables may include, for example, ISO, aperture, and shutter speed. An image sensor may then capture a photographic scene at the initial exposure parameter, and populate a first analog storage plane with a first plurality of analog values corresponding to an optical image focused on the image sensor. Simultaneous, at least in part, with populating the first analog storage plane, a second analog storage plane may be populated with a second plurality of analog values corresponding to the optical image focused on the image sensor. In the context of the foregoing Figures, a first analog storage plane 12-702(0) may be populated with a plurality of analog values output from a plurality of first analog sampling circuits 12-603(0) of a pixel array 11-510, and a second analog storage plane 12-702(1) may be populated with a plurality of analog values output from a plurality of second analog sampling circuits 12-603(1) of the pixel array 11-510.

In other words, in an embodiment where each photosensitive cell includes two analog sampling circuits, then two analog storage planes may be configured such that a first of the analog storage planes stores a first analog value output from one of the analog sampling circuits of a cell, and a second of the analog storage planes stores a second analog value output from the other analog sampling circuit of the same cell. In this configuration, each of the analog storage planes may store at least one analog value received from a pixel of a pixel array or image sensor.

Further, each of the analog storage planes may receive and store different analog values for a given pixel of the pixel array or image sensor. For example, an analog value received for a given pixel and stored in a first analog storage plane may be output based on a first sample captured during a first exposure time, and a corresponding analog value received for the given pixel and stored in a second analog storage plane may be output based on a second sample captured during a second exposure time that is different than the first exposure time. Accordingly, in one embodiment, substantially all analog values stored in a first analog storage plane may be based on samples obtained during a first exposure time, and substantially all analog values stored in a second analog storage plane may be based on samples obtained during a second exposure time that is different than the first exposure time.

In the context of the present description, a “single exposure” of a photographic scene at an initial exposure parameter may include simultaneously, at least in part, capturing the photographic scene using two or more sets of analog sampling circuits, where each set of analog sampling circuits may be configured to operate at different exposure times. During capture of the photographic scene using the two or more sets of analog sampling circuits, the photographic scene may be illuminated by ambient light or may be illuminated using a strobe unit. Further, after capturing the photographic scene using the two or more sets of analog sampling circuits, two or more analog storage planes (e.g., one storage plane for each set of analog sampling circuits) may be populated with analog values corresponding to an optical image focused on an image sensor. Next, one or more digital images of a first image stack may be obtained by applying one or more gains to the analog values of a first analog storage plane in accordance with the above systems and methods. Further, one or more digital images of a second image stack may be obtained by applying one or more gains to the analog values of a second analog storage plane in accordance with the above systems and methods.

To this end, one or more image stacks 12-732 may be generated based on a single exposure of a photographic scene. In one embodiment, each digital image of a particular image stack 12-732 may be generated based on a common exposure time or sample time, but be generated utilizing a unique gain. In such an embodiment, each of the image stacks 12-732 of the single exposure of a photographic scene may be generated based on different sample times.

In one embodiment, a first digital image of an image stack 12-732 may be obtained utilizing a first gain in accordance with the above systems and methods. For example, if a digital photographic device is configured such that initial exposure parameter includes a selection of ISO 400, the first gain utilized to obtain the first digital image may be mapped to, or otherwise associated with, ISO 400. This first digital image may be referred to as an exposure or image obtained at exposure value 0 (EV0). Further one more digital images may be obtained utilizing a second gain in accordance with the above systems and methods. For example, the same analog pixel data used to generate the first digital image may be processed utilizing a second gain to generate a second digital image. Still further, one or more digital images may be obtained utilizing a second analog storage plane in accordance with the above systems and methods. For example, second analog pixel data may be used to generate a second digital image, where the second analog pixel data is different from the analog pixel data used to generate the first digital image. Specifically, the analog pixel data used to generate the first digital image may have been captured using a first sample time, and the second analog pixel data may have been captured using a second sample time different than the first sample time. Specifically, the analog pixel data used to generate the first digital image may have been captured during a first exposure time, and the second analog pixel data may have been captured during a second exposure time different than the first exposure time.

To this end, at least two digital images may be generated utilizing different analog pixel data, and then blended to generate an HDR image. The at least two digital images may be blended by blending a first digital signal and a second digital signal. Where the at least two digital images are generated using different analog pixel data captured during a single exposure of a photographic scene, then there may be approximately, or near, zero interframe time between the at least two digital images. As a result of having zero, or near zero, interframe time between at least two digital images of a same photographic scene, an HDR image may be generated, in one possible embodiment, without motion blur or other artifacts typical of HDR photographs.

In one embodiment, after selecting a first gain for generating a first digital image of an image stack 12-732, a second gain may be selected based on the first gain. For example, the second gain may be selected on the basis of it being one stop away from the first gain. More specifically, if the first gain is mapped to or associated with ISO 400, then one stop down from ISO 400 provides a gain associated with ISO 200, and one stop up from ISO 400 provides a gain associated with ISO 800. In such an embodiment, a digital image generated utilizing the gain associated with ISO 200 may be referred to as an exposure or image obtained at exposure value−1 (EV−1), and a digital image generated utilizing the gain associated with ISO 800 may be referred to as an exposure or image obtained at exposure value+1 (EV+1).

Still further, if a more significant difference in exposures is desired between digital images generated utilizing the same analog signal, then the second gain may be selected on the basis of it being two stops away from the first gain. For example, if the first gain is mapped to or associated with ISO 400, then two stops down from ISO 400 provides a gain associated with ISO 100, and two stops up from ISO 400 provides a gain associated with ISO 1600. In such an embodiment, a digital image generated utilizing the gain associated with ISO 100 may be referred to as an exposure or image obtained at exposure value−2 (EV−2), and a digital image generated utilizing the gain associated with ISO 1600 may be referred to as an exposure or image obtained at exposure value+2 (EV+2).

In one embodiment, an ISO and exposure of the EV0 image may be selected according to a preference to generate darker digital images. In such an embodiment, the intention may be to avoid blowing out or overexposing what will be the brightest digital image, which is the digital image generated utilizing the greatest gain. In another embodiment, an EV−1 digital image or EV−2 digital image may be a first generated digital image. Subsequent to generating the EV−1 or EV−2 digital image, an increase in gain at an analog-to-digital unit may be utilized to generate an EV0 digital image, and then a second increase in gain at the analog-to-digital unit may be utilized to generate an EV+1 or EV+2 digital image. In one embodiment, the initial exposure parameter corresponds to an EV−N digital image and subsequent gains are used to obtain an EV0 digital image, an EV+M digital image, or any combination thereof, where N and M are values ranging from 0 to −10.

In one embodiment, three digital images having three different exposures (e.g. an EV−2 digital image, an EV0 digital image, and an EV+2 digital image) may be generated in parallel by implementing three analog-to-digital units. Each analog-to-digital unit may be configured to convert one or more analog signal values to corresponding digital signal values. Such an implementation may be also capable of simultaneously generating all of an EV−1 digital image, an EV0 digital image, and an EV+1 digital image. Similarly, in other embodiments, any combination of exposures may be generated in parallel from two or more analog-to-digital units, three or more analog-to-digital units, or an arbitrary number of analog-to-digital units. In other embodiments, a set of analog-to-digital units may be configured to each operate on either of two or more different analog storage planes.

In one embodiment, a combined image 13-1020 comprises a combination of at least two related digital images. In one embodiment, the combined image 13-1020 comprises, without limitation, a combined rendering of at least two digital images, such as two or more of the digital images of an image stack 12-732(0) and an image stack 12-732(1) of FIG. 12-4. In another embodiment, the digital images used to compute the combined image 13-1020 may be generated by amplifying each of a first analog signal and a second analog signal with at least two different gains, where each analog signal includes optical scene information captured based on an optical image focused on an image sensor. In yet another embodiment, each analog signal may be amplified using the at least two different gains on a pixel-by-pixel, line-by-line, or frame-by-frame basis.

In other embodiments, in addition to the indication point 13-1040-B, there may exist a plurality of additional indication points along the track 13-1032 between the indication points 13-1040-A and 13-1040-C. The additional indication points may be associated with additional digital images. For example, a first image stack 12-732 may be generated to include each of a digital image at EV−1 exposure, a digital image at EV0 exposure, and a digital image at EV+1 exposure. Said image stack 12-732 may be associated with a first analog storage plane captured at a first exposure time, such as the image stack 12-732(0) of FIG. 12-4. Thus, a first image stack may include a plurality of digital images all associated with a first exposure time, where each digital image is associated with a different ISO. Further, a second image stack 12-732 may also be generated to include each of a digital image at EV−1 exposure, a digital image at EV0 exposure, and a digital image at EV+1 exposure. However, the second image stack 12-732 may be associated with a second analog storage plane captured at a second exposure time different than the first exposure time, such as the image stack 12-732(1) of FIG. 12-4. Thus, a second image stack may include a second plurality of digital images all associated with a second exposure time, where each digital image is associated with a different ISO. After analog-to-digital units 12-722(0) and 12-722(1) generate the respective image stacks 12-732, the digital pixel data output by the analog-to-digital units 12-722(0) and 12-722(1) may be arranged together into a single sequence of digital images of increasing or decreasing exposure. In the context of the instant description, no two digital signals of the two image stacks may be associated with a same ISO+exposure time combination, thus each digital image or instance of digital pixel data may be considered as having a unique effective exposure.

In the context of the foregoing figures, arranging the digital images or instances of digital pixel data output by the analog-to-digital units 12-722(0) and 12-722(1) into a single sequence of digital images of increasing or decreasing exposure may be performed according to overall exposure. For example, the single sequence of digital images may combine gain and exposure time to determine an effective exposure. The digital pixel data may be rapidly organized to obtain a single sequence of digital images of increasing effective exposure, such as, for example: 12-723(0), 12-723(1), 12-724(0), 12-724(1), 12-725(0), and 12-725(1). Of course, any sorting of the digital images or digital pixel data based on effective exposure level will depend on an order of application of the gains and generation of the digital signals 12-723-725.

In one embodiment, exposure times and gains may be selected or predetermined for generating a number of adequately different effective exposures. For example, where three gains are to be applied, then each gain may be selected to be two exposure stops away from a nearest selected gain. Further, where multiple exposure times are to be used, then a first exposure time may be selected to be one exposure stop away from a second exposure time. In such an embodiment, selection of three gains separated two exposure stops, and two exposure times separated by one exposure stop, may ensure generation of six digital images, each having a unique effective exposure.

With continuing reference to the digital images of multiple image stacks sorted in a sequence of increasing exposure, each of the digital images may then be associated with indication points along the track 13-1032 of the UI system 13-1000. For example, the digital images may be sorted or sequenced along the track 13-1032 in the order of increasing effective exposure noted previously: 12-723(0), 12-723(1), 12-724(0), 12-724(1), 12-725(0), and 12-725(1). In such an embodiment, the slider control 13-1030 may then be positioned at any point along the track 13-1032 that is between two digital images generated based on two different analog storage planes. As a result, two digital images generated based on two different analog storage planes may then be blended to generate a combined image 13-1020.

For example, the slider control 13-1030 may be positioned at an indication point that may be equally associated with digital pixel data 12-724(0) and digital pixel data 12-724(1). As a result, the digital pixel data 12-724(0), which may include a first digital image generated from a first analog signal captured during a first sample time and amplified utilizing a gain, may be blended with the digital pixel data 12-724(1), which may include a second digital image generated from a second analog signal captured during a second sample time and amplified utilizing the same gain, to generate a combined image 13-1020.

Still further, as another example, the slider control 13-1030 may be positioned at an indication point that may be equally associated with digital pixel data 12-724(1) and digital pixel data 12-725(0). As a result, the digital pixel data 12-724(1), which may include a first digital image generated from a first analog signal captured during a first sample time and amplified utilizing a first gain, may be blended with the digital pixel data 12-725(0), which may include a second digital image generated from a second analog signal captured during a second sample time and amplified utilizing a different gain, to generate a combined image 13-1020.

Thus, as a result of the slider control 13-1030 positioning, two or more digital signals may be blended, and the blended digital signals may be generated utilizing analog values from different analog storage planes. As a further benefit of sorting effective exposures along a slider, and then allowing blend operations based on slider control position, each pair of neighboring digital images may include a higher noise digital image and a lower noise digital image. For example, where two neighboring digital signals are amplified utilizing a same gain, the digital signal generated from an analog signal captured with a lower sample time may have less noise. Similarly, where two neighboring digital signals are amplified utilizing different gains, the digital signal generated from an analog signal amplified with a lower gain value may have less noise. Thus, when digital signals are sorted based on effective exposure along a slider, a blend operation of two or more digital signals may serve to reduce the noise apparent in at least one of the digital signals.

Of course, any two or more effective exposures may be blended based on the indication point of the slider control 13-1030 to generate a combined image 13-1020 in the UI system 13-1000.

One advantage of the present invention is that a digital photograph may be selectively generated based on user input using two or more different images generated from a single exposure of a photographic scene. Accordingly, the digital photograph generated based on the user input may have a greater dynamic range than any of the individual images. Further, the generation of an HDR image using two or more different images with zero, or near zero, interframe time allows for the rapid generation of HDR images without motion artifacts.

Additionally, when there is any motion within a photographic scene, or a capturing device experiences any jitter during capture, any interframe time between exposures may result in a motion blur within a final merged HDR photograph. Such blur can be significantly exaggerated as interframe time increases. This problem renders current HDR photography an ineffective solution for capturing clear images in any circumstance other than a highly static scene.

Further, traditional techniques for generating a HDR photograph involve significant computational resources, as well as produce artifacts which reduce the image quality of the resulting image. Accordingly, strictly as an option, one or more of the above issues may or may not be addressed utilizing one or more of the techniques disclosed herein.

Still yet, in various embodiments, one or more of the techniques disclosed herein may be applied to a variety of markets and/or products. For example, although the techniques have been disclosed in reference to a photo capture, they may be applied to televisions, web conferencing (or live streaming capabilities, etc.), security cameras (e.g. increase contrast to determine characteristic, etc.), automobiles (e.g. driver assist systems, in-car infotainment systems, etc.), and/or any other product which includes a camera input.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

FIG. 13-1 illustrates a system 13-100 for capturing flash and ambient illuminated images, in accordance with one possible embodiment. As an option, the system 13-100 may be implemented in the context of any of the Figures disclosed herein. Of course, however, the system 13-100 may be implemented in any desired environment. Further, the aforementioned definitions may equally apply to the description below.

As shown in FIG. 13-1, the system 13-100 includes a first input 13-102 that is provided to an ambient sample storage node 13-133(0) based on a photodiode 13-101, and a second input 13-104 provided to a flash sample storage node 13-133(1) based on the photodiode 13-101. Based on the input 13-102 to the ambient sample storage node 13-133(0) and the input 13-104 to the flash sample storage node 13-133(1), an ambient sample is stored to the ambient sample storage node 13-133(0) sequentially, at least in part, with storage of a flash sample to the flash sample storage node 13-133(1). In one embodiment, simultaneous storage of the ambient sample and the flash sample includes storing the ambient sample and the second sample at least partially sequentially.

In one embodiment, the input 13-104 may be provided to the flash sample storage node 13-133(1) after the input 13-102 is provided to the ambient sample storage node 13-133(0). In such an embodiment, the process of storing the flash sample may occur after the process of storing the ambient sample. In other words, storing the ambient sample may occur during a first time duration, and storing the flash sample may occur during a second time duration that begins after the first time duration. The second time duration may begin nearly simultaneously with the conclusion of the first time duration.

While the following discussion describes an image sensor apparatus and method for simultaneously capturing multiple images using one or more photodiodes of an image sensor, any photo-sensing electrical element or photosensor may be used or implemented.

In one embodiment, the photodiode 13-101 may comprise any semiconductor diode that generates a potential difference, current, or changes its electrical resistance, in response to photon absorption. Accordingly, the photodiode 13-101 may be used to detect or measure a light intensity. Further, the input 13-102 and the input 13-104 received at sample storage nodes 13-133(0) and 13-133(1), respectively, may be based on the light intensity detected or measured by the photodiode 13-101. In such an embodiment, the ambient sample stored at the ambient sample storage node 13-133(0) may be based on a first exposure time to light at the photodiode 13-101, and the second sample stored at the flash sample storage node 13-133(1) may be based on a second exposure time to the light at the photodiode 13-101. The second exposure time may begin concurrently, or near concurrently, with the conclusion of the conclusion of the first exposure time.

In one embodiment, a rapid rise in scene illumination may occur after completion of the first exposure time, and during the second exposure time while input 13-104 is being received at the flash sample storage node 13-133(1). The rapid rise in scene illumination may be due to activation of a flash or strobe, or any other near instantaneous illumination. As a result of the rapid rise in scene illumination after the first exposure time, the light intensity detected or measured by the photodiode 13-101 during the second exposure time may be greater than the light intensity detected or measured by the photodiode 13-101 during the first exposure time. Accordingly, the second exposure time may be configured or selected based on an anticipated light intensity.

In one embodiment, the first input 13-102 may include an electrical signal from the photodiode 13-101 that is received at the ambient sample storage node 13-133(0), and the second input 13-104 may include an electrical signal from the photodiode 13-101 that is received at the flash sample storage node 13-133(1). For example, the first input 13-102 may include a current that is received at the ambient sample storage node 13-133(0), and the second input 13-104 may include a current that is received at the flash sample storage node 13-133(1). In another embodiment, the first input 13-102 and the second input 13-104 may be transmitted, at least partially, on a shared electrical interconnect. In other embodiments, the first input 13-102 and the second input 13-104 may be transmitted on different electrical interconnects. In some embodiments, the input 13-102 may include a first current, and the input 13-104 may include a second current that is different than the first current. The first current and the second current may each be a function of incident light intensity measured or detected by the photodiode 13-101. In yet other embodiments, the first input 13-102 may include any input from which the ambient sample storage node 13-133(0) may be operative to store an ambient sample, and the second input 13-104 may include any input from which the flash sample storage node 13-133(1) may be operative to store a flash sample.

In one embodiment, the first input 13-102 and the second input 13-104 may include an electronic representation of a portion of an optical image that has been focused on an image sensor that includes the photodiode 13-101. In such an embodiment, the optical image may be focused on the image sensor by a lens. The electronic representation of the optical image may comprise spatial color intensity information, which may include different color intensity samples (e.g. red, green, and blue light, etc.). In other embodiments, the spatial color intensity information may also include samples for white light. In one embodiment, the optical image may be an optical image of a photographic scene. In some embodiments, the photodiode 13-101 may be a single photodiode of an array of photodiodes of an image sensor. Such an image sensor may comprise a complementary metal oxide semiconductor (CMOS) image sensor, or charge-coupled device (CCD) image sensor, or any other technically feasible form of image sensor. In other embodiments, photodiode 13-101 may include two or more photodiodes.

In one embodiment, each sample storage node 13-133 includes a charge storing device for storing a sample, and the stored sample may be a function of a light intensity detected at the photodiode 13-101. For example, each sample storage node 13-133 may include a capacitor for storing a charge as a sample. In such an embodiment, each capacitor stores a charge that corresponds to an accumulated exposure during an exposure time or sample time. For example, current received at each capacitor from an associated photodiode may cause the capacitor, which has been previously charged, to discharge at a rate that is proportional to an incident light intensity detected at the photodiode. The remaining charge of each capacitor may be subsequently output from the capacitor as a value. For example, the remaining charge of each capacitor may be output as an analog value that is a function of the remaining charge on the capacitor.

To this end, an analog value received from a capacitor may be a function of an accumulated intensity of light detected at an associated photodiode. In some embodiments, each sample storage node 13-133 may include circuitry operable for receiving input based on a photodiode. For example, such circuitry may include one or more transistors. The one or more transistors may be configured for rendering the sample storage node 13-133 responsive to various control signals, such as sample, reset, and row select signals received from one or more controlling devices or components. In other embodiments, each sample storage node 13-133 may include any device for storing any sample or value that is a function of a light intensity detected at the photodiode 13-101.

Further, as shown in FIG. 13-1, the ambient sample storage node 13-133(0) outputs first value 13-106, and the flash sample storage node 13-133(1) outputs second value 13-108. In one embodiment, the ambient sample storage node 13-133(0) outputs the first value 13-106 based on the ambient sample stored at the ambient sample storage node 13-133(0), and the flash sample storage node 13-133(1) outputs the second value 13-108 based on the flash sample stored at the flash sample storage node 13-133(1). An ambient sample may include any value stored at an ambient sample storage node 13-133(0) due to input 13-102 from the photodiode 13-101 during an exposure time in which the photodiode 13-101 measures or detects ambient light. A flash sample may include any value stored at a flash storage node 13-133(1) due to input 13-104 from the photodiode 13-101 during an exposure time in which the photodiode 13-101 measures or detects flash or strobe illumination.

In some embodiments, the ambient sample storage node 13-133(0) outputs the first value 13-106 based on a charge stored at the ambient sample storage node 13-133(0), and the flash sample storage node 13-133(1) outputs the second value 13-108 based on a second charge stored at the flash sample storage node 13-133(1). The first value 13-106 may be output serially with the second value 13-108, such that one value is output prior to the other value; or the first value 13-106 may be output in parallel with the output of the second value 13-108. In various embodiments, the first value 13-106 may include a first analog value, and the second value 13-108 may include a second analog value. Each of these values may include a current, which may be output for inclusion in an analog signal that includes at least one analog value associated with each photodiode of a photodiode array. In such embodiments, the first analog value 13-106 may be included in an ambient analog signal, and the second analog value 13-108 may be included in a flash analog signal that is different than the ambient analog signal. In other words, an ambient analog signal may be generated to include an analog value associated with each photodiode of a photodiode array, and a flash analog signal may also be generated to include a different analog value associated with each of the photodiodes of the photodiode array. In such an embodiment, the analog values of the ambient analog signal would be sampled during a first exposure time in which the associated photodiodes were exposed to ambient light, and the analog values of the flash analog signal would be sampled during a second exposure time in which the associated photodiode were exposed to strobe or flash illumination.

To this end, a single photodiode array may be utilized to generate a plurality of analog signals. The plurality of analog signals may be generated concurrently or in parallel. Further, the plurality of analog signals may each be amplified utilizing two or more gains, and each amplified analog signal may converted to one or more digital signals such that two or more digital signals may be generated, where each digital signal may include a digital image. Accordingly, due to the contemporaneous storage of the ambient sample and the flash sample, a single photodiode array may be utilized to concurrently generate multiple digital signals or digital images, where at least one of the digital signals is associated with an ambient exposure photographic scene, and at least one of the digital signals is associated with a flash or strobe illuminated exposure of the same photographic scene. In such an embodiment, multiple digital signals having different exposure characteristics may be substantially simultaneously generated for a single photographic scene captured at ambient illumination. Such a collection of digital signals or digital images may be referred to as an ambient image stack. Further, multiple digital signals having different exposure characteristics may be substantially simultaneously generated for the single photographic scene captured with strobe or flash illumination. Such a collection of digital signals or digital images may be referred to as a flash image stack.

In certain embodiments, an analog signal comprises a plurality of distinct analog signals, and a signal amplifier comprises a corresponding set of distinct signal amplifier circuits. For example, each pixel within a row of pixels of an image sensor may have an associated distinct analog signal within an analog signal, and each distinct analog signal may have a corresponding distinct signal amplifier circuit. Further, two or more amplified analog signals may each include gain-adjusted analog pixel data representative of a common analog value from at least one pixel of an image sensor. For example, for a given pixel of an image sensor, a given analog value may be output in an analog signal, and then, after signal amplification operations, the given analog value is represented by a first amplified value in a first amplified analog signal, and by a second amplified value in a second amplified analog signal. Analog pixel data may be analog signal values associated with one or more given pixels.

In various embodiments, the digital images of the ambient image stack and the flash image stack may be combined or blended to generate one or more new blended images having a greater dynamic range than any of the individual images. Further, the digital images of the ambient image stack and the flash image stack may be combined or blended for controlling a flash contribution in the one or more new blended images.

FIG. 13-2 illustrates a method 13-200 for capturing flash and ambient illuminated images, in accordance with one embodiment. As an option, the method 13-200 may be carried out in the context of any of the Figures disclosed herein. Of course, however, the method 13-200 may be carried out in any desired environment. Further, the aforementioned definitions may equally apply to the description below.

As shown in operation 13-202, an ambient sample is stored based on an electrical signal from a photodiode of an image sensor. Further, sequentially, at least in part, with the storage of the ambient sample, a flash sample is stored based on the electrical signal from the photodiode of the image sensor at operation 13-204. As noted above, the photodiode of the image sensor may comprise any semiconductor diode that generates a potential difference, or changes its electrical resistance, in response to photon absorption. Accordingly, the photodiode may be used to detect or measure light intensity, and the electrical signal from the photodiode may include a photodiode current that varies as a function of the light intensity.

In some embodiments, each sample may include an electronic representation of a portion of an optical image that has been focused on an image sensor that includes the photodiode. In such an embodiment, the optical image may be focused on the image sensor by a lens. The electronic representation of the optical image may comprise spatial color intensity information, which may include different color intensity samples (e.g. red, green, and blue light, etc.). In other embodiments, the spatial color intensity information may also include samples for white light. In one embodiment, the optical image may be an optical image of a photographic scene. The photodiode may be a single photodiode of an array of photodiodes of the image sensor. Such an image sensor may comprise a complementary metal oxide semiconductor (CMOS) image sensor, or charge-coupled device (CCD) image sensor, or any other technically feasible form of image sensor

In the context of one embodiment, each of the samples may be stored by storing energy. For example, each of the samples may include a charged stored on a capacitor. In such an embodiment, the ambient sample may include a first charge stored at a first capacitor, and the flash sample may include a second charge stored at a second capacitor. In one embodiment, the ambient sample may be different than the flash sample. For example, the ambient sample may include a first charge stored at a first capacitor, and the flash sample may include a second charge stored at a second capacitor that is different than the first charge.

In one embodiment, the ambient sample may be different than the flash sample due to being sampled at different sample times. For example, the ambient sample may be stored by charging or discharging a first capacitor during a first sample time, and the flash sample may be stored by charging or discharging a second capacitor during a second sample time, where the first capacitor and the second capacitor may be substantially identical and charged or discharged at a substantially identical rate for a given photodiode current. The second sample time may be contemporaneously, or near contemporaneously, with a conclusion of the first sample time, such that the second capacitor may be charged or discharged after the charging or discharging of the first capacitor has completed.

In another embodiment, the ambient sample may be different than the flash sample due to, at least partially, different storage characteristics. For example, the ambient sample may be stored by charging or discharging a first capacitor for a period of time, and the flash sample may be stored by charging or discharging a second capacitor for the same period of time, where the first capacitor and the second capacitor may have different storage characteristics and/or be charged or discharged at different rates. More specifically, the first capacitor may have a different capacitance than the second capacitor.

In another embodiment, the ambient sample may be different than the flash sample due to a flash or strobe illumination that occurs during the second exposure time, and that provides different illumination characteristics than the ambient illumination of the first exposure time. For example, the ambient sample may be stored by charging or discharging a first capacitor for a period of time of ambient illumination, and the flash sample may be stored by charging or discharging a second capacitor for a period of time of flash illumination. Due to the differences in illumination between the first exposure time and the second exposure time, the second capacitor may be charged or discharged faster than the first capacitor due to the increased light intensity associated with the flash illumination of the second exposure time.

Additionally, as shown at operation 13-206, after storage of the ambient sample and the flash sample, a first value is output based on the ambient sample, and a second value is output based on the flash sample, for generating at least one image. In the context of one embodiment, the first value and the second value are transmitted or output in sequence. For example, the first value may be transmitted prior to the second value. In another embodiment, the first value and the second value may be transmitted in parallel.

In one embodiment, each output value may comprise an analog value. For example, each output value may include a current representative of the associated stored sample, such as an ambient sample or a flash sample. More specifically, the first value may include a current value representative of the stored ambient sample, and the second value may include a current value representative of the stored flash sample. In one embodiment, the first value is output for inclusion in an ambient analog signal, and the second value is output for inclusion in a flash analog signal different than the ambient analog signal. Further, each value may be output in a manner such that it is combined with other values output based on other stored samples, where the other stored samples are stored responsive to other electrical signals received from other photodiodes of an image sensor. For example, the first value may be combined in an ambient analog signal with values output based on other ambient samples, where the other ambient samples were stored based on electrical signals received from photodiodes that neighbor the photodiode from which the electrical signal utilized for storing the ambient sample was received. Similarly, the second value may be combined in a flash analog signal with values output based on other flash samples, where the other flash samples were stored based on electrical signals received from the same photodiodes that neighbor the photodiode from which the electrical signal utilized for storing the flash sample was received.

Finally, at operation 13-208, at least one of the first value and the second value are amplified utilizing two or more gains. In one embodiment, where each output value comprises an analog value, amplifying at least one of the first value and the second value may result in at least two amplified analog values. In another embodiment, where the first value is output for inclusion in an ambient analog signal, and the second value is output for inclusion in a flash analog signal different than the ambient analog signal, one of the ambient analog signal or the flash analog signal may be amplified utilizing two or more gains each. For example, an ambient analog signal that includes the first value may be amplified with a first gain and a second gain, such that the first value is amplified with the first gain and the second gain. Amplifying the ambient analog signal with the first gain may result in a first amplified ambient analog signal, and amplifying the ambient analog signal with the second gain may result in a second amplified ambient analog signal. Of course, more than two analog signals may be amplified using two or more gains. In one embodiment, each amplified analog signal may be converted to a digital signal comprising a digital image.

To this end, an array of photodiodes may be utilized to generate an ambient analog signal based on a set of ambient samples captured at a first exposure time or sample time and illuminated with ambient light, and a flash analog signal based on a set of flash samples captured at a second exposure time or sample time and illuminated with flash or strobe illumination, where the set of ambient samples and the set of flash samples may be two different sets of samples of the same photographic scene. Further, each analog signal may include an analog value generated based on each photodiode of each pixel of an image sensor. Each analog value may be representative of a light intensity measured at the photodiode associated with the analog value. Accordingly, an analog signal may be a set of spatially discrete intensity samples, each represented by continuous analog values, and analog pixel data may be analog signal values associated with one or more given pixels. Still further, each analog signal may undergo subsequent processing, such as amplification, which may facilitate conversion of the analog signal into one or more digital signals, each including digital pixel data, which may each comprise a digital image.

The embodiments disclosed herein may advantageously enable a camera module to sample images comprising an image stack with lower (e.g. at or near zero, etc.) inter-sample time (e.g. interframe, etc.) than conventional techniques. In certain embodiments, images comprising an analog image stack or a flash image stack are effectively sampled or captured simultaneously, or near simultaneously, which may reduce inter-sample time to zero. In other embodiments, the camera module may sample images in coordination with the strobe unit to reduce inter-sample time between an image sampled without strobe illumination and an image sampled with strobe illumination.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

In one embodiment, the first exposure time and the second exposure time do not overlap in time. For example, a controller may be configured to control the second exposure time such that it begins contemporaneously, or near contemporaneously, with a conclusion of the first exposure time. In such an embodiment, the sample signal 12-618(1) may be activated as the sample signal 12-618(0) is deactivated.

As a benefit of having two different exposure conditions, in situations where a photodiode 12-602 is exposed to a sufficient threshold of incident light 12-601, a first capacitor 12-604(0) may provide an analog value suitable for generating a digital image, and a second capacitor 12-604(1) of the same cell 12-600 may provide a “blown out” or over exposed image portion due to excessive flash illumination. Thus, for each cell 12-600, a first capacitor 12-604 may more effectively capture darker image content than another capacitor 12-604 of the same cell 12-600. This may be useful, for example, in situations where strobe or flash illumination over-exposes foreground objects in a digital image of a photographic scene, or under-exposes background objects in the digital image of the photographic scene. In such an example, an image captured during another exposure time utilizing ambient illumination may help correct any over-exposed or under-exposed objects. Similarly, in situations where ambient light is unable to sufficiently illuminate particular elements of a photographic scene, and these elements appear dark or difficult to see in an associated digital image, an image captured during another exposure time utilizing strobe or flash illumination may help correct any under-exposed portions of the image.

In various embodiments, capacitor 12-604(0) may be substantially identical to capacitor 12-604(1). For example, the capacitors 12-604(0) and 12-604(1) may have substantially identical capacitance values. In one embodiment, a sample signal 12-618 of one of the analog sampling circuits may be activated for a longer or shorter period of time than a sample signal 12-618 is activated for any other analog sampling circuits 12-603.

As noted above, the sample signal 12-618(0) of the first analog sampling circuit 12-603(0) may be activated for a first exposure time, and a sample signal 12-618(1) of the second analog sampling circuit 12-603(1) may be activated for a second exposure time. In one embodiment, the first exposure time and/or the second exposure time may be determined based on an exposure setting selected by a user, by software, or by some combination of user and software. For example, the first exposure time may be selected based on a 1/60 second shutter time selected by a user of a camera. In response, the second exposure time may be selected based on the first exposure time. In one embodiment, the user's selected 1/60 second shutter time may be selected for an ambient image, and a metering algorithm may then evaluate the photographic scene to determine an optimal second exposure time for a flash or strobe capture. The second exposure time for the flash or strobe capture may be selected based on incident light metered during the evaluation of the photographic scene. Of course, in other embodiments, a user selection may be used to select the second exposure time, and then the first exposure time for an ambient capture may be selected according to the selected second exposure time. In yet other embodiments, the first exposure time may be selected independent of the second exposure time.

In other embodiments, the capacitors 12-604(0) and 12-604(1) may have different capacitance values. In one embodiment, the capacitors 12-604(0) and 12-604(1) may have different capacitance values for the purpose of rendering one of the analog sampling circuits 12-603 more or less sensitive to the current I_PD from the photodiode 12-602 than other analog sampling circuits 12-603 of the same cell 12-600. For example, a capacitor 12-604 with a significantly larger capacitance than other capacitors 12-604 of the same cell 12-600 may be less likely to fully discharge when capturing photographic scenes having significant amounts of incident light 12-601. In such embodiments, any difference in stored voltages or samples between the capacitors 12-604(0) and 12-604(1) may be a function of the different capacitance values, in conjunction with different activation times of the sample signals 12-618 and different incident light measurements during the respective exposure times.

In one embodiment, the photosensitive cell 12-600 may be configured such that the first analog sampling circuit 12-603(0) and the second analog sampling circuit 12-603(1) share at least one shared component. In various embodiments, the at least one shared component may include a photodiode 12-602 of an image sensor. In other embodiments, the at least one shared component may include a reset, such that the first analog sampling circuit 12-603(0) and the second analog sampling circuit 12-603(1) may be reset concurrently utilizing the shared reset. In the context of FIG. 12-3, the photosensitive cell 12-600 may include a shared reset between the analog sampling circuits 12-603(0) and 12-603(1). For example, reset 12-616(0) may be coupled to reset 12-616(1), and both may be asserted together such that the reset 12-616(0) is the same signal as the reset 12-616(1), which may be used to simultaneously reset both of the first analog sampling circuit 12-603(0) and the second analog sampling circuit 12-603(1). After reset, the first analog sampling circuit 12-603(0) and the second analog sampling circuit 12-603(1) may be asserted to sample independently.

To this end, the photosensitive cell 12-600 may be utilized to simultaneously store both of an ambient sample and a flash sample based on the incident light 12-601. Specifically, the ambient sample may be captured and stored on a first capacitor during a first exposure time, and the flash sample may be captured and stored on a second capacitor during a second exposure time. Further, during this second exposure time, a strobe may be activated for temporarily increasing illumination of a photographic scene, and increasing the incident light measured at one or more photodiodes of an image sensor during the second exposure time.

In one embodiment, a unique instance of analog pixel data 11-621 may include, as an ordered set of individual analog values, all analog values output from all corresponding analog sampling circuits or sample storage nodes. For example, in the context of the foregoing figures, each cell of cells 11-542-11-545 of a plurality of pixels 11-540 of a pixel array 11-510 may include both a first analog sampling circuit 11-603(0) and a second analog sampling circuit 11-603(1). Thus, the pixel array 11-510 may include a plurality of first analog sampling circuits 11-603(0) and also include a plurality of second analog sampling circuits 11-603(1). In other words, the pixel array 11-510 may include a first analog sampling circuit 11-603(0) for each cell, and also include a second analog sampling circuit 11-603(1) for each cell. In an embodiment, a first instance of analog pixel data 11-621 may be received containing a discrete analog value from each analog sampling circuit of a plurality of first analog sampling circuits 11-603(0), and a second instance of analog pixel data 11-621 may be received containing a discrete analog value from each analog sampling circuit of a plurality of second analog sampling circuits 11-603(1). Thus, in embodiments where cells of a pixel array include two or more analog sampling circuits, the pixel array may output two or more discrete analog signals, where each analog signal includes a unique instance of analog pixel data 11-621.

Further, each of the first analog sampling circuits 12-603(0) may sample a photodiode current during a first exposure time, during which a photographic scene is illuminated with ambient light; and each of the second sampling circuits 12-603(1) may sample the photodiode current during a second exposure time, during which the photographic scene is illuminated with a strobe or flash. Accordingly, a first analog signal, or ambient analog signal, may include analog values representative of the photographic scene when illuminated with ambient light; and a second analog signal, or flash analog signal, may include analog values representative of the photographic scene when illuminated with the strobe or flash.

In some embodiments, only a subset of the cells of a pixel array may include two or more analog sampling circuits. For example, not every cell may include both a first analog sampling circuit 12-603(0) and a second analog sampling circuit 12-603(1).

FIG. 13-3 illustrates a system 13-700 for converting analog pixel data of an analog signal to digital pixel data, in accordance with an embodiment. As an option, the system 13-700 may be implemented in the context of the details of any of the Figures disclosed herein. Of course, however, the system 13-700 may be implemented in any desired environment. Further, the aforementioned definitions may equally apply to the description below.

The system 13-700 is shown in FIG. 13-3 to include a first analog storage plane 13-702(0), a first analog-to-digital unit 13-722(0), and an ambient digital image stack 13-732(0), and is shown to further include a second analog storage plane 13-702(1), a second analog-to-digital unit 13-722(1), and a flash digital image stack 13-732(1). Accordingly, the system 13-700 is shown to include at least two analog storage planes 13-702(0) and 13-702(1). As illustrated in FIG. 13-3, a plurality of analog values are each depicted as a “V” within each of the analog storage planes 13-702, and corresponding digital values are each depicted as a “D” within digital images of each of the image stacks 13-732. In one embodiment, all of the analog values of the first analog storage plane 13-702(0) are captured during a first exposure time, during which a photographic scene was illuminated with ambient light; and all of the analog values of the second analog storage plane 13-702(1) are captured during a second exposure time, during which the photographic scene was illuminated using a strobe or flash.

In the context of certain embodiments, each analog storage plane 13-702 may comprise any collection of one or more analog values. In some embodiments, each analog storage plane 13-702 may comprise at least one analog pixel value for each pixel of a row or line of a pixel array. Still yet, in another embodiment, each analog storage plane 13-702 may comprise at least one analog pixel value for each pixel of an entirety of a pixel array, which may be referred to as a frame. For example, each analog storage plane 13-702 may comprise an analog pixel value, or more generally, an analog value for each cell of each pixel of every line or row of a pixel array.

Further, the analog values of each analog storage plane 13-702 are output as analog pixel data 13-704 to a corresponding analog-to-digital unit 13-722. For example, the analog values of analog storage plane 13-702(0) are output as analog pixel data 13-704(0) to analog-to-digital unit 13-722(0), and the analog values of analog storage plane 13-702(1) are output as analog pixel data 13-704(1) to analog-to-digital unit 13-722(1). In one embodiment, each analog-to-digital unit 13-722 may be substantially identical to the analog-to-digital unit 11-622 described within the context of FIG. 11-4. For example, each analog-to-digital unit 13-722 may comprise at least one amplifier and at least one analog-to-digital converter, where the amplifier is operative to receive a gain value and utilize the gain value to gain-adjust analog pixel data received at the analog-to-digital unit 13-722. Further, in such an embodiment, the amplifier may transmit gain-adjusted analog pixel data to an analog-to-digital converter, which then generates digital pixel data from the gain-adjusted analog pixel data. To this end, an analog-to-digital conversion may be performed on the contents of each of two or more different analog storage planes 13-702.

In the context of the system 13-700 of FIG. 13-3, each analog-to-digital unit 13-722 receives corresponding analog pixel data 13-704, and applies at least two different gains to the received analog pixel data 13-704 to generate at least a first gain-adjusted analog pixel data and a second gain-adjusted analog pixel data. For example, the analog-to-digital unit 13-722(0) receives analog pixel data 13-704(0), and applies at least two different gains to the analog pixel data 13-704(0) to generate at least a first gain-adjusted analog pixel data and a second gain-adjusted analog pixel data based on the analog pixel data 13-704(0); and the analog-to-digital unit 13-722(1) receives analog pixel data 13-704(1), and applies at least two different gains to the analog pixel data 13-704(1) to generate at least a first gain-adjusted analog pixel data and a second gain-adjusted analog pixel data based on the analog pixel data 13-704(1).

Further, each analog-to-digital unit 13-722 converts each generated gain-adjusted analog pixel data to digital pixel data, and then outputs at least two digital outputs. In one embodiment, each analog-to-digital unit 13-722 provides a different digital output corresponding to each gain applied to the received analog pixel data 13-704. With respect to FIG. 13-3 specifically, the analog-to-digital unit 13-722(0) is shown to generate a first digital signal comprising first digital pixel data 13-723(0) corresponding to a first gain (Gain1), a second digital signal comprising second digital pixel data 13-724(0) corresponding to a second gain (Gain2), and a third digital signal comprising third digital pixel data 13-725(0) corresponding to a third gain (Gain3). Similarly, the analog-to-digital unit 13-722(1) is shown to generate a first digital signal comprising first digital pixel data 13-723(1) corresponding to a first gain (Gain1), a second digital signal comprising second digital pixel data 13-724(1) corresponding to a second gain (Gain2), and a third digital signal comprising third digital pixel data 13-725(1) corresponding to a third gain (Gain3). Each instance of each digital pixel data may comprise a digital image, such that each digital signal comprises a digital image.

Accordingly, as a result of the analog-to-digital unit 13-722(0) applying each of Gain1, Gain2, and Gain3 to the analog pixel data 13-704(0), and thereby generating first digital pixel data 13-723(0), second digital pixel data 13-724(0), and third digital pixel data 13-725(0), the analog-to-digital unit 13-722(0) generates a stack of digital images, also referred to as an ambient image stack 13-732(0). Similarly, as a result of the analog-to-digital unit 13-722(1) applying each of Gain1, Gain2, and Gain3 to the analog pixel data 13-704(1), and thereby generating first digital pixel data 13-723(1), second digital pixel data 13-724(1), and third digital pixel data 13-725(1), the analog-to-digital unit 13-722(1) generates a second stack of digital images, also referred to as a flash image stack 13-732(1). Each of the digital images of the ambient image stack 13-732(0) may be a digital image of the photographic scene captured with ambient illumination during a first exposure time. Each of the digital images of the flash image stack 13-732(1) may be a digital image of the photographic scene captured with strobe or flash illumination during a second exposure time.

In one embodiment, each analog-to-digital unit 13-722 applies in sequence at least two gains to the analog values. For example, within the context of FIG. 13-3, the analog-to-digital unit 13-722(0) first applies Gain1 to the analog pixel data 13-704(0), then subsequently applies Gain2 to the same analog pixel data 13-704(0), and then subsequently applies Gain3 to the same analog pixel data 13-704(0). In other embodiments, each analog-to-digital unit 13-722 may apply in parallel at least two gains to the analog values. For example, an analog-to-digital unit may apply Gain1 to received analog pixel data in parallel with application of Gain2 and Gain3 to the analog pixel data. To this end, each instance of analog pixel data 13-704 is amplified utilizing at least two gains.

In one embodiment, the gains applied to the analog pixel data 13-704(0) at the analog-to-digital unit 13-722(0) may be the same as the gains applied to the analog pixel data 13-704(1) at the analog-to-digital unit 13-722(1). By way of a specific example, the Gain1 applied by both of the analog-to-digital unit 13-722(0) and the analog-to-digital unit 13-722(1) may be a gain of 1.0, the Gain2 applied by both of the analog-to-digital unit 13-722(0) and the analog-to-digital unit 13-722(1) may be a gain of 2.0, and the Gain3 applied by both of the analog-to-digital unit 13-722(0) and the analog-to-digital unit 13-722(1) may be a gain of 4.0. In another embodiment, one or more of the gains applied to the analog pixel data 13-704(0) at the analog-to-digital unit 13-722(0) may be different from the gains applied to the analog pixel data 13-704(1) at the analog-to-digital unit 13-722(1). For example, the Gain1 applied at the analog-to-digital unit 13-722(0) may be a gain of 1.0, and the Gain1 applied at the analog-to-digital unit 13-722(1) may be a gain of 2.0. Accordingly, the gains applied at each analog-to-digital unit 13-722 may be selected dependently or independently of the gains applied at other analog-to-digital units 13-722 within system 13-700.

In accordance with one embodiment, the at least two gains may be determined using any technically feasible technique based on an exposure of a photographic scene, metering data, user input, detected ambient light, a strobe control, or any combination of the foregoing. For example, a first gain of the at least two gains may be determined such that half of the digital values from an analog storage plane 13-702 are converted to digital values above a specified threshold (e.g., a threshold of 0.5 in a range of 0.0 to 1.0) for the dynamic range associated with digital values comprising a first digital image of an image stack 13-732, which can be characterized as having an “EV0” exposure. Continuing the example, a second gain of the at least two gains may be determined as being twice that of the first gain to generate a second digital image of the image stack 13-732 characterized as having an “EV+1” exposure. Further still, a third gain of the at least two gains may be determined as being half that of the first gain to generate a third digital image of the image stack 13-732 characterized as having an “EV−1” exposure.

In one embodiment, an analog-to-digital unit 13-722 converts in sequence a first instance of the gain-adjusted analog pixel data to the first digital pixel data 13-723, a second instance of the gain-adjusted analog pixel data to the second digital pixel data 13-724, and a third instance of the gain-adjusted analog pixel data to the third digital pixel data 13-725. For example, an analog-to-digital unit 13-722 may first convert a first instance of the gain-adjusted analog pixel data to first digital pixel data 13-723, then subsequently convert a second instance of the gain-adjusted analog pixel data to second digital pixel data 13-724, and then subsequently convert a third instance of the gain-adjusted analog pixel data to third digital pixel data 13-725. In other embodiments, an analog-to-digital unit 13-722 may perform such conversions in parallel, such that one or more of a first digital pixel data 13-723, a second digital pixel data 13-724, and a third digital pixel data 13-725 are generated in parallel.

Still further, as shown in FIG. 13-3, each first digital pixel data 13-723 provides a first digital image. Similarly, each second digital pixel data 13-724 provides a second digital image, and each third digital pixel data 13-725 provides a third digital image. Together, each set of digital images produced using the analog values of a single analog storage plane 13-702 comprises an image stack 13-732. For example, ambient image stack 13-732(0) comprises digital images produced using analog values of the analog storage plane 13-702(0), and flash image stack 13-732(1) comprises the digital images produced using the analog values of the analog storage plane 13-702(1). As noted previously, each of the digital images of the ambient image stack 13-732(0) may be a digital image of the photographic scene captured with ambient illumination during a first exposure time. Similarly, each of the digital images of the flash image stack 13-732(1) may be a digital image of the photographic scene captured with strobe or flash illumination during a second exposure time.

As illustrated in FIG. 13-3, all digital images of an image stack 13-732 may be based upon a same analog pixel data 13-704. However, each digital image of an image stack 13-732 may differ from other digital images in the image stack 13-732 as a function of a difference between the gains used to generate the two digital images. Specifically, a digital image generated using the largest gain of at least two gains may be visually perceived as the brightest or more exposed of the digital images of the image stack 13-732. Conversely, a digital image generated using the smallest gain of the at least two gains may be visually perceived as the darkest and less exposed than other digital images of the image stack 13-732. To this end, a first light sensitivity value may be associated with first digital pixel data 13-723, a second light sensitivity value may be associated with second digital pixel data 13-724, and a third light sensitivity value may be associated with third digital pixel data 13-725. Further, because each of the gains may be associated with a different light sensitivity value, a first digital image or first digital signal may be associated with a first light sensitivity value, a second digital image or second digital signal may be associated with a second light sensitivity value, and a third digital image or third digital signal may be associated with a third light sensitivity value. In one embodiment, one or more digital images of an image stack may be blended, resulting in a blended image associated with a blended light sensitivity.

It should be noted that while a controlled application of gain to the analog pixel data may greatly aid in HDR image generation, an application of too great of gain may result in a digital image that is visually perceived as being noisy, over-exposed, and/or blown-out. In one embodiment, application of two stops of gain to the analog pixel data may impart visually perceptible noise for darker portions of a photographic scene, and visually imperceptible noise for brighter portions of the photographic scene. In another embodiment, a digital photographic device may be configured to provide an analog storage plane for analog pixel data of a captured photographic scene, and then perform at least two analog-to-digital samplings of the same analog pixel data using an analog-to-digital unit 13-722. To this end, a digital image may be generated for each sampling of the at least two samplings, where each digital image is obtained at a different exposure despite all the digital images being generated from the same analog sampling of a single optical image focused on an image sensor.

In one embodiment, an initial exposure parameter may be selected by a user or by a metering algorithm of a digital photographic device. The initial exposure parameter may be selected based on user input or software selecting particular capture variables. Such capture variables may include, for example, ISO, aperture, and shutter speed. An image sensor may then capture a photographic scene at the initial exposure parameter during a first exposure time, and populate a first analog storage plane with a first plurality of analog values corresponding to an optical image focused on the image sensor. Next, during a second exposure time, a second analog storage plane may be populated with a second plurality of analog values corresponding to the optical image focused on the image sensor. During the second exposure time, a strobe or flash unit may be utilized to illuminate at least a portion of the photographic scene. In the context of the foregoing Figures, a first analog storage plane 13-702(0) comprising a plurality of first analog sampling circuits 12-603(0) may be populated with a plurality of analog values associated with an ambient capture, and a second analog storage plane 13-702(1) comprising a plurality of second analog sampling circuits 12-603(1) may be populated with a plurality of analog values associated with a flash or strobe capture.

In other words, in an embodiment where each photosensitive cell includes two analog sampling circuits, then two analog storage planes may be configured such that a first of the analog storage planes stores a first analog value output from one of the analog sampling circuits of a cell, and a second of the analog storage planes stores a second analog value output from the other analog sampling circuit of the same cell.

Further, each of the analog storage planes may receive and store different analog values for a given pixel of the pixel array or image sensor. For example, an analog value received for a given pixel and stored in a first analog storage plane may be output based on an ambient sample captured during a first exposure time, and a corresponding analog value received for the given pixel and stored in a second analog storage plane may be output based on a flash sample captured during a second exposure time that is different than the first exposure time. Accordingly, in one embodiment, substantially all analog values stored in a first analog storage plane may be based on samples obtained during a first exposure time, and substantially all analog values stored in a second analog storage plane may be based on samples obtained during a second exposure time that is different than the first exposure time.

In the context of the present description, a “single exposure” of a photographic scene may include simultaneously, at least in part, storing analog values representative of the photographic scene using two or more sets of analog sampling circuits, where each set of analog sampling circuits may be configured to operate at different exposure times. During capture of the photographic scene using the two or more sets of analog sampling circuits, the photographic scene may be illuminated by ambient light during a first exposure time, and by a flash or strobe unit during a second exposure time. Further, after capturing the photographic scene using the two or more sets of analog sampling circuits, two or more analog storage planes (e.g., one storage plane for each set of analog sampling circuits) may be populated with analog values corresponding to an optical image focused on an image sensor. Next, one or more digital images of an ambient image stack may be obtained by applying one or more gains to the analog values of the first analog storage plane captured during the first exposure time, in accordance with the above systems and methods. Further, one or more digital images of a flash image stack may be obtained by applying one or more gains to the analog values of the second analog storage plane captured during the second exposure time, in accordance with the above systems and methods.

To this end, one or more image stacks 13-732 may be generated based on a single exposure of a photographic scene.

In one embodiment, a first digital image of an image stack 13-732 may be obtained utilizing a first gain in accordance with the above systems and methods. For example, if a digital photographic device is configured such that initial exposure parameter includes a selection of ISO 400, the first gain utilized to obtain the first digital image may be mapped to, or otherwise associated with, ISO 400. This first digital image may be referred to as an exposure or image obtained at exposure value 0 (EV0). Further one more digital images may be obtained utilizing a second gain in accordance with the above systems and methods. For example, the same analog pixel data used to generate the first digital image may be processed utilizing a second gain to generate a second digital image. Still further, one or more digital images may be obtained utilizing a second analog storage plane in accordance with the above systems and methods. For example, second analog pixel data may be used to generate a second digital image, where the second analog pixel data is different from the analog pixel data used to generate the first digital image. Specifically, the analog pixel data used to generate the first digital image may have been captured during a first exposure time, and the second analog pixel data may have been captured during a second exposure time different than the first exposure time.

To this end, at least two digital images may be generated utilizing different analog pixel data, and then blended to generate an HDR image. The at least two digital images may be blended by blending a first digital signal and a second digital signal. Where the at least two digital images are generated using different analog pixel data captured during a single exposure of a photographic scene, then there may be approximately, or near, zero interframe time between the at least two digital images. As a result of having zero, or near zero, interframe time between at least two digital images of a same photographic scene, an HDR image may be generated, in one possible embodiment, without motion blur or other artifacts typical of HDR photographs.

In one embodiment, after selecting a first gain for generating a first digital image of an image stack 13-732, a second gain may be selected based on the first gain. For example, the second gain may be selected on the basis of it being one stop away from the first gain. More specifically, if the first gain is mapped to or associated with ISO 400, then one stop down from ISO 400 provides a gain associated with ISO 200, and one stop up from ISO 400 provides a gain associated with ISO 800. In such an embodiment, a digital image generated utilizing the gain associated with ISO 200 may be referred to as an exposure or image obtained at exposure value−1 (EV−1), and a digital image generated utilizing the gain associated with ISO 800 may be referred to as an exposure or image obtained at exposure value+1 (EV+1).

Still further, if a more significant difference in exposures is desired between digital images generated utilizing the same analog signal, then the second gain may be selected on the basis of it being two stops away from the first gain. For example, if the first gain is mapped to or associated with ISO 400, then two stops down from ISO 400 provides a gain associated with ISO 100, and two stops up from ISO 400 provides a gain associated with ISO 1600. In such an embodiment, a digital image generated utilizing the gain associated with ISO 100 may be referred to as an exposure or image obtained at exposure value−2 (EV−2), and a digital image generated utilizing the gain associated with ISO 1600 may be referred to as an exposure or image obtained at exposure value+2 (EV+2).

In one embodiment, an ISO and exposure of the EV0 image may be selected according to a preference to generate darker digital images. In such an embodiment, the intention may be to avoid blowing out or overexposing what will be the brightest digital image, which is the digital image generated utilizing the greatest gain. In another embodiment, an EV−1 digital image or EV−2 digital image may be a first generated digital image. Subsequent to generating the EV−1 or EV−2 digital image, an increase in gain at an analog-to-digital unit may be utilized to generate an EV0 digital image, and then a second increase in gain at the analog-to-digital unit may be utilized to generate an EV+1 or EV+2 digital image. In one embodiment, the initial exposure parameter corresponds to an EV−N digital image and subsequent gains are used to obtain an EV0 digital image, an EV+M digital image, or any combination thereof, where N and M are values ranging from 0 to −10.

In one embodiment, three digital images having three different exposures (e.g. an EV−2 digital image, an EV0 digital image, and an EV+2 digital image) may be generated in parallel by implementing three analog-to-digital units. Each analog-to-digital unit may be configured to convert one or more analog signal values to corresponding digital signal values. Such an implementation may be also capable of simultaneously generating all of an EV−1 digital image, an EV0 digital image, and an EV+1 digital image. Similarly, in other embodiments, any combination of exposures may be generated in parallel from two or more analog-to-digital units, three or more analog-to-digital units, or an arbitrary number of analog-to-digital units. In other embodiments, a set of analog-to-digital units may be configured to each operate on either of two or more different analog storage planes.

In some embodiments, a set of gains may be selected for application to the analog pixel data 11-621 based on whether the analog pixel data is associated with an ambient capture or a flash capture. For example, if the analog pixel data 11-621 comprises a plurality of values from an analog storage plane associated with ambient sample storage, a first set of gains may be selected for amplifying the values of the analog storage plane associated with the ambient sample storage. Further, a second set of gains may be selected for amplifying values of an analog storage plane associated with the flash sample storage.

A plurality of first analog sampling circuits 12-603(0) may comprise the analog storage plane used for the ambient sample storage, and a plurality of second analog sampling circuits 12-603(1) may comprise the analog storage plane used for the flash sample storage. Either set of gains may be preselected based on exposure settings. For example, a first set of gains may be preselected for exposure settings associated with a flash capture, and a second set of gains may be preselected for exposure settings associated with an ambient capture. Each set of gains may be preselected based on any feasible exposure settings, such as, for example, ISO, aperture, shutter speed, white balance, and exposure. One set of gains may include gain values that are greater than each of their counterparts in the other set of gains. For example, a first set of gains selected for application to each ambient sample may include gain values of 0.5, 1.0, and 2.0, and a second set of gains selected for application to each flash sample may include gain values of 1.0, 2.0, and 4.0.

FIG. 13-4A illustrates a user interface (UI) system 13-1000 for generating a combined image 13-1020, according to one embodiment. As an option, the UI system 13-1000 may be implemented in the context of the details of any of the Figures disclosed herein. Of course, however, the UI system 13-1000 may be implemented in any desired environment. Further, the aforementioned definitions may equally apply to the description below.

In one embodiment, a combined image 13-1020 comprises a combination of at least two related digital images. For example the combined image 13-1020 may comprise, without limitation, a combined rendering of at least two digital images, such as two or more of the digital images of an ambient image stack 13-732(0) and a flash image stack 13-732(1) of FIG. 13-3. In another embodiment, the digital images used to compute the combined image 13-1020 may be generated by amplifying each of an ambient analog signal and a flash analog signal with at least two different gains, where each analog signal includes optical scene information captured based on an optical image focused on an image sensor. In yet another embodiment, each analog signal may be amplified using the at least two different gains on a pixel-by-pixel, line-by-line, or frame-by-frame basis.

In one embodiment, the UI system 13-1000 presents a display image 13-1010 that includes, without limitation, a combined image 13-1020, and a control region 13-1025, which in FIG. 13-4A is shown to include a slider control 13-1030 configured to move along track 13-1032, and two or more indication points 13-1040, which may each include a visual marker displayed within display image 13-1010.

In one embodiment, the UI system 13-1000 is generated by an adjustment tool executing within a processor complex 310 of a digital photographic system 300, and the display image 13-1010 is displayed on display unit 312. In one embodiment, at least two digital images comprise source images for generating the combined image 13-1020. The at least two digital images may reside within NV memory 316, volatile memory 318, memory subsystem 362, or any combination thereof. In another embodiment, the UI system 13-1000 is generated by an adjustment tool executing within a computer system, such as a laptop computer or a desktop computer. The at least two digital images may be transmitted to the computer system or may be generated by an attached camera device. In yet another embodiment, the UI system 13-1000 may be generated by a cloud-based server computer system, which may download the at least two digital images to a client browser, which may execute combining operations described below. In another embodiment, the UI system 13-1000 is generated by a cloud-based server computer system, which receives the at least two digital images from a digital photographic system in a mobile device, and which may execute the combining operations described below in conjunction with generating combined image 13-1020.

The slider control 13-1030 may be configured to move between two end points corresponding to indication points 13-1040-A and 13-1040-C. One or more indication points, such as indication point 13-1040-B may be positioned between the two end points. Of course, in other embodiment, the control region 13-1025 may include other configurations of indication points 13-1040 between the two end points. For example, the control region 13-1025 may include more or less than one indication point.

Each indication point 13-1040 may be associated with a specific rendering of a combined image 13-1020, or a specific combination of two or more digital images. For example, the indication point 13-1040-A may be associated with a first digital image generated from an ambient analog signal captured during a first exposure time, and amplified utilizing a first gain; and the indication point 13-1040-C may be associated with a second digital image generated from a flash analog signal captured during a second exposure time, and amplified utilizing a second gain. Both the first digital image and the second digital image may be from a single exposure, as described hereinabove. Further, the first digital image may include an ambient capture of the single exposure, and the second digital image may include a flash capture of the single exposure. In one embodiment, the first gain and the second gain may be the same gain. In another embodiment, when the slider control 13-1030 is positioned directly over the indication point 13-1040-A, only the first digital image may be displayed as the combined image 13-1020 in the display image 13-1010, and similarly when the slider control 13-1030 is positioned directly over the indication point 13-1040-C, only the second digital image may be displayed as the combined image 13-1020 in the display image 13-1010.

In one embodiment, indication point 13-1040-B may be associated with a blending of the first digital image and the second digital image. Further, the first digital image may be an ambient digital image, and the second digital image may be a flash digital image. Thus, when the slider control 13-1030 is positioned at the indication point 13-1040-B, the combined image 13-1020 may be a blend of the ambient digital image and the flash digital image. In one embodiment, blending of the ambient digital image and the flash digital image may comprise alpha blending, brightness blending, dynamic range blending, and/or tone mapping or other non-linear blending and mapping operations. In another embodiment, any blending of the first digital image and the second digital image may provide a new image that has a greater dynamic range or other visual characteristics that are different than either of the first image and the second image alone. In one embodiment, a blending of the first digital image and the second digital image may allow for control of a flash contribution within the combined image. Thus, a blending of the first digital image and the second digital image may provide a new computed image that may be displayed as combined image 13-1020 or used to generate combined image 13-1020. To this end, a first digital signal and a second digital signal may be combined, resulting in at least a portion of a combined image. Further, one of the first digital signal and the second digital signal may be further combined with at least a portion of another digital image or digital signal. In one embodiment, the other digital image may include another combined image, which may include an HDR image.

In one embodiment, when the slider control 13-1030 is positioned at the indication point 13-1040-A, the first digital image is displayed as the combined image 13-1020, and when the slider control 13-1030 is positioned at the indication point 13-1040-C, the second digital image is displayed as the combined image 13-1020; furthermore, when slider control 13-1030 is positioned at indication point 13-1040-B, a blended image is displayed as the combined image 13-1020. In such an embodiment, when the slider control 13-1030 is positioned between the indication point 13-1040-A and the indication point 13-1040-C, a mix (e.g. blend) weight may be calculated for the first digital image and the second digital image. For the first digital image, the mix weight may be calculated as having a value of 0.0 when the slider control 13-1030 is at indication point 13-1040-C and a value of 1.0 when slider control 13-1030 is at indication point 13-1040-A, with a range of mix weight values between 0.0 and 1.0 located between the indication points 13-1040-C and 13-1040-A, respectively. For the second digital image, the mix weight may be calculated as having a value of 0.0 when the slider control 13-1030 is at indication point 13-1040-A and a value of 1.0 when slider control 13-1030 is at indication point 13-1040-C, with a range of mix weight values between 0.0 and 1.0 located between the indication points 13-1040-A and 13-1040-C, respectively.

In another embodiment, the indication point 13-1040-A may be associated with a first combination of images, and the indication point 13-1040-C may be associated with a second combination of images. Each combination of images may include an independent blend of images. For example, the indication point 13-1040-A may be associated with a blending of the digital images of ambient image stack 13-732(0) of FIG. 13-3, and the indication point 13-1040-C may be associated with a blending of the digital images of flash image stack 13-732(1). In other words, the indication point 13-1040-A may be associated with a blended ambient digital image or blended ambient digital signal, and the indication point 13-1040-C may be associated with a blended flash digital image or blended flash digital signal. In such an embodiment, when the slider control 13-1030 is positioned at the indication point 13-1040-A, the blended ambient digital image is displayed as the combined image 13-1020, and when the slider control 13-1030 is positioned at the indication point 13-1040-C, the blended flash digital image is displayed as the combined image 13-1020. Each of the blended ambient digital image and the blended flash digital image may be associated with unique light sensitivities.

Further, when slider control 13-1030 is positioned at indication point 13-1040-B, the blended ambient digital image may be blended with the blended flash digital image to generate a new blended image. The new blended image may be associated with yet another unique light sensitivity, and may offer a balance of proper background exposure due to the blending of ambient images, with a properly lit foreground subject due to the blending of flash images. In such an embodiment, when the slider control 13-1030 is positioned between the indication point 13-1040-A and the indication point 13-1040-C, a mix (e.g. blend) weight may be calculated for the blended ambient digital image and the blended flash digital image. For the blended ambient digital image, the mix weight may be calculated as having a value of 0.0 when the slider control 13-1030 is at indication point 13-1040-C and a value of 1.0 when slider control 13-1030 is at indication point 13-1040-A, with a range of mix weight values between 0.0 and 1.0 located between the indication points 13-1040-C and 13-1040-A, respectively. For the blended flash digital image, the mix weight may be calculated as having a value of 0.0 when the slider control 13-1030 is at indication point 13-1040-A and a value of 1.0 when slider control 13-1030 is at indication point 13-1040-C, with a range of mix weight values between 0.0 and 1.0 located between the indication points 13-1040-A and 13-1040-C, respectively.

FIG. 13-4B illustrates a user interface (UI) system 13-1050 for generating a combined image 13-1020, according to one embodiment. As an option, the UI system 13-1050 may be implemented in the context of the details of any of the Figures disclosed herein. Of course, however, the UI system 13-1050 may be implemented in any desired environment. Further, the aforementioned definitions may equally apply to the description below.

As shown in FIG. 13-4B, the UI system 13-1050 may be substantially identical to the UI system 13-1000 of FIG. 13-4A, with exception of the control region 13-1025 of UI system 13-1000 and control region 13-1026 of UI system 13-1050. The control region 13-1026 of UI system 13-1050 is shown to include six indication points 13-1040-U, 13-1040-V, 13-1040-W, 13-1040-X, 13-1040-Y, and 13-1040-Z. The indication points 13-1040-U and 13-1040-Z may be representative of end points, similar to the indication points 13-1040-A and 13-1040-C, respectively, of UI system 13-1000. Further, the control region 13-1026 of UI system 13-1050 is shown to include a plurality of indication points 13-1040—such as indication points 13-1040-V, 13-1040-W, 13-1040-X, and 13-1040-Y—disposed between the two end points along track 13-1032. Each of the indication points may be associated with one or more digital images of image stacks 13-732.

For example, an ambient image stack 13-732 may be generated to include each of an ambient digital image at EV−1 exposure, an ambient digital image at EV0 exposure, and an ambient digital image at EV+1 exposure. Said ambient image stack 13-732 may be associated with a first analog storage plane captured at a first exposure time, such as the ambient image stack 13-732(0) of FIG. 13-3. Thus, an ambient image stack may include a plurality of digital images all associated with a first exposure time during an ambient capture, where each digital image is associated with a different ISO or light sensitivity. Further, a flash image stack 13-732 may also be generated to include each of a flash digital image at EV−1 exposure, a flash digital image at EV0 exposure, and a flash digital image at EV+1 exposure. However, the flash image stack 13-732 may be associated with a second analog storage plane captured at a second exposure time during which a strobe or flash was activated, such as the flash image stack 13-732(1) of FIG. 13-3. Thus, a flash image stack may include a second plurality of digital images all associated with a second exposure time during which a strobe or flash was activated, where each flash digital image is associated with a different ISO or light sensitivity.

After analog-to-digital units 13-722(0) and 13-722(1) generate the respective image stacks 13-732, the digital pixel data output by the analog-to-digital units 13-722(0) and 13-722(1) may be arranged together into a single sequence of digital images of increasing or decreasing exposure. In one embodiment, no two digital signals of the two image stacks may be associated with a same ISO+exposure time combination, such that each digital image or instance of digital pixel data may be considered as having a unique effective exposure.

In one embodiment, and in the context of the foregoing figures, each of the indication points 13-1040-U, 13-1040-V, and 13-1040-W may be associated with digital images of an image stack 13-732, and each of the indication points 13-1040-X, 13-1040-Y, and 13-1040-Z may be associated with digital images of another image stack 13-732. For example, each the indication points 13-1040-U, 13-1040-V, and 13-1040-W may be associated with a different ambient digital image or ambient digital signal. Similarly, each of the indication points 13-1040-X, 13-1040-Y, and 13-1040-Z may be associated with a different flash digital image or flash digital signal. In such an embodiment, as the slider 13-1030 is moved from left to right along the track 13-1032, exposure and flash contribution of the combined image 13-1020 may appear to be adjusted or changed. Of course, when the slider 13-1030 is between two indication points along the track 13-1032, the combined image 13-1032 may be a combination of any two or more images of the two image stacks 13-732.

In another embodiment, the digital images or instances of digital pixel data output by the analog-to-digital units 13-722(0) and 13-722(1) may be arranged into a single sequence of digital images of increasing or decreasing exposure. In such an embodiment, the sequence may alternate between ambient and flash digital images. For example, for each of the digital images, gain and exposure time may be combined to determine an effective exposure of the digital image. The digital pixel data may be rapidly organized to obtain a single sequence of digital images of increasing effective exposure, such as, for example: 13-723(0), 13-723(1), 13-724(0), 13-724(1), 13-725(0), and 13-725(1). In such an organization, the sequence of digital images may alternate between flash digital images and ambient digital images. Of course, any sorting of the digital images or digital pixel data based on effective exposure level will depend on an order of application of the gains and generation of the digital signals 13-723-13-725.

In one embodiment, exposure times and gains may be selected or predetermined for generating a number of adequately different effective exposures. For example, where three gains are to be applied, then each gain may be selected to be two exposure stops away from a nearest selected gain. Further, a first exposure time may be selected to be one exposure stop away from a second exposure time. In such an embodiment, selection of three gains separated by two exposure stops, and two exposure times separated by one exposure stop, may ensure generation of six digital images, each having a unique effective exposure.

In another embodiment, exposure times and gains may be selected or predetermined for generating corresponding images of similar exposures between the ambient image stack and the flash image stack. For example, a first digital image of an ambient image stack may be generated utilizing an exposure time and gain combination that corresponds to an exposure time and gain combination utilized to generate a first digital image of a flash image stack. This may be done so that the first digital image of the ambient image stack has a similar effective exposure to that of the first digital image of the flash image stack, which may assist in adjusting a flash contribution in a combined image generated by blending the two digital images.

With continuing reference to the digital images of multiple image stacks sorted in a sequence of increasing exposure, each of the digital images may then be associated with indication points along the track 13-1032 of the UI system 13-1050. For example, the digital images may be sorted or sequenced along the track 13-1032 in the order of increasing effective exposure noted previously (13-723(0), 13-723(1), 13-724(0), 13-724(1), 13-725(0), and 13-725(1)) at indication points 13-1040-U, 13-1040-V, 13-1040-W, 13-1040-X, 13-1040-Y, and 13-1040-Z, respectively.

In such an embodiment, the slider control 13-1030 may then be positioned at any point along the track 13-1032 that is between two digital images generated based on two different analog storage planes, where each analog storage plane is associated with a different scene illumination. As a result, a digital image generated based on an analog storage plane associated with ambient illumination may then be blended with a digital image generated based on an analog storage plane associated with flash illumination to generate a combined image 13-1020. In this way, one or more images captured with ambient illumination may be blended with one or more images captured with flash illumination.

For example, the slider control 13-1030 may be positioned at an indication point that may be equally associated with digital pixel data 13-724(0) and digital pixel data 13-724(1). As a result, the digital pixel data 13-724(0), which may include a first digital image generated from an ambient analog signal captured during a first exposure time with ambient illumination and amplified utilizing a gain, may be blended with the digital pixel data 13-724(1), which may include a second digital image generated from a flash analog signal captured during a second exposure time with flash illumination and amplified utilizing the same gain, to generate a combined image 13-1020.

Still further, as another example, the slider control 13-1030 may be positioned at an indication point that may be equally associated with digital pixel data 13-724(1) and digital pixel data 13-725(0). As a result, the digital pixel data 13-724(1), which may include a first digital image generated from an ambient analog signal captured during a first exposure time with ambient illumination and amplified utilizing a first gain, may be blended with the digital pixel data 13-725(0), which may include a second digital image generated from a flash analog signal captured during a second exposure time with flash illumination and amplified utilizing a different gain, to generate a combined image 13-1020.

Thus, as a result of the slider control 13-1030 positioning, two or more digital signals may be blended, and the blended digital signals may be generated utilizing analog values from different analog storage planes. As a further benefit of sorting effective exposures along a slider, and then allowing blend operations based on slider control position, each pair of neighboring digital images may include a higher noise digital image and a lower noise digital image. For example, where two neighboring digital signals are amplified utilizing a same gain, the digital signal generated from an analog signal captured with a lower exposure time may have less noise. Similarly, where two neighboring digital signals are amplified utilizing different gains, the digital signal generated from an analog signal amplified with a lower gain value may have less noise. Thus, when digital signals are sorted based on effective exposure along a slider, a blend operation of two or more digital signals may serve to reduce the noise apparent in at least one of the digital signals.

Of course, any two or more effective exposures may be blended based on the indication point of the slider control 13-1030 to generate a combined image 13-1020 in the UI system 13-1050.

In one embodiment, a mix operation may be applied to a first digital image and a second digital image based upon at least one mix weight value associated with at least one of the first digital image and the second digital image. In one embodiment, a mix weight of 1.0 gives complete mix weight to a digital image associated with the 1.0 mix weight. In this way, a user may blend between the first digital image and the second digital image. To this end, a first digital signal and a second digital signal may be blended in response to user input. For example, sliding indicia may be displayed, and a first digital signal and a second digital signal may be blended in response to the sliding indicia being manipulated by a user.

A system of mix weights and mix operations provides a UI tool for viewing a first digital image, a second digital image, and a blended image as a gradual progression from the first digital image to the second digital image. In one embodiment, a user may save a combined image 13-1020 corresponding to an arbitrary position of the slider control 13-1030. The adjustment tool implementing the UI system 13-1000 may receive a command to save the combined image 13-1020 via any technically feasible gesture or technique. For example, the adjustment tool may be configured to save the combined image 13-1020 when a user gestures within the area occupied by combined image 13-1020. Alternatively, the adjustment tool may save the combined image 13-1020 when a user presses, but does not otherwise move the slider control 13-1030. In another implementation, the adjustment tool may save the combined image 13-1020 when a user gestures, such as by pressing a UI element (not shown), such as a save button, dedicated to receive a save command.

To this end, a slider control may be used to determine a contribution of two or more digital images to generate a final computed image, such as combined image 13-1020. Persons skilled in the art will recognize that the above system of mix weights and mix operations may be generalized to include two or more indication points, associated with two or more related images. Such related images may comprise, without limitation, any number of digital images that have been generated from two or more analog storage planes, and which may have zero, or near zero, interframe time.

Furthermore, a different continuous position UI control, such as a rotating knob, may be implemented rather than the slider 13-1030.

FIG. 13-4C illustrates user interface (UI) systems displaying combined images 13-1070-13-1072 with differing levels of strobe exposure, according to one embodiment. As an option, the UI systems of FIG. 13-4C may be implemented in the context of the details of any of the Figures disclosed herein. Of course, however, the UI systems be implemented in any desired environment. Further, the aforementioned definitions may equally apply to the description below.

As shown in FIG. 13-4C, a blended image may be blended from two or more images based on a position of slider control 13-1030. As shown, the slider control 13-1030 is configured to select one or more source images for input to a blending operation, where the source images are associated with increasing strobe intensity as the slider control 13-1030 moves from left to right.

For example, based on the position of slider control 13-1030 in control region 13-1074, first blended image 13-1070 may be generated utilizing one or more source images captured without strobe or flash illumination. As a specific example, the first blended image 13-1070 may be generated utilizing one or more images captured using only ambient illumination. The one or more images captured using only ambient illumination may comprise an image stack 13-732, such as the ambient image stack 13-732(0). As shown, the first blended image 13-1070 includes an under-exposed subject 13-1062. Further, based on the position of slider control 13-1030 in control region 13-1076, third blended image 13-1072 may be generated utilizing one or more source images captured using strobe or flash illumination. The one or more source images associated with the position of slider control 13-1030 in the control region 13-1076 may comprise an image stack 13-732, such as the flash image stack 13-732(1). As shown, the third blended image 13-1072 includes an over-exposed subject 13-1082

By manipulating the slider control 13-1030, a user may be able to adjust the contribution of the source images used to generate the blended image. Or, in other words, the user may be able to adjust the blending of one or more images. For example, the user may be able to adjust or increase a flash contribution from the one or more source images captured using strobe or flash illumination. As illustrated in FIG. 13-4C, when a user positions the slider control 13-1030 along a track away from track end points, as shown in control region 13-1075, a flash contribution from the one or more source images captured using strobe or flash illumination may be blended with the one or more source images captured using ambient illumination. This may result in the generation of second blended image 13-1071, which includes a properly exposed subject 13-1081. To this end, by blending digital images captured in ambient lighting conditions with digital images of the same photographic scene captured with strobe or flash illumination, novel digital images may be generated. Further, a flash contribution of the digital images captured with strobe or flash illumination may be adjustable by a user to ensure that both foreground subjects and background objects are properly exposed.

A determination of appropriate strobe intensity may be subjective, and embodiments disclosed herein advantageously enable a user to subjectively select a final combined image having a desired strobe intensity after a digital image has been captured. In practice, a user is able to capture what is apparently a single photograph by asserting a single shutter-release. The single shutter-release may cause capture of a set of ambient samples to a first analog storage plane during a first exposure time, and capture of a set of flash samples to a second analog storage plane during a second exposure time that immediately follows the first exposure time. The ambient samples may comprise an ambient analog signal that is then used to generate multiple digital images of an ambient image stack. Further, the flash samples may comprise a flash analog signal that is then used to generate multiple digital images of a flash image stack. By blending two or more images of the ambient image stack and the flash image stack, the user may thereby identify a final combined image with desired strobe intensity. Further, both the ambient image stack and the flash image stack may be stored, such that the user can select the final combined image at a later time.

In other embodiments, two or more slider controls may be presented in a UI system. For example, in one embodiment, a first slider control may be associated with digital images of an ambient image stack, and a second slider control may be associated with digital images of a flash image stack. By manipulating the slider controls independently, a user may control a blending of ambient digital images independently from blending of flash digital images. Such an embodiment may allow a user to first select a blending of images from the ambient image stack that provides a preferred exposure of background objects. Next, the user may then select a flash contribution. For example, the user may select a blending of images from the flash image stack that provides a preferred exposure of foreground objects. Thus, by allowing for independent selection of ambient contribution and flash contribution, a final blended or combined image may include properly exposed foreground objects as well as properly exposed background objects.

In another embodiment, a desired exposure for one or more given regions of a blended image may be identified by a user selecting another region of the blended image. For example, the other region selected by the user may be currently displayed at a proper exposure within a UI system while the one or more given regions are currently under-exposed or over-exposed. In response to the user's selection of the other region, a blending of source images from an ambient image stack and a flash image stack may be identified to provide the proper exposure at the one or more given regions of the blended image. The blended image may then be updated to reflect the identified blending of source images that provides the proper exposure at the one or more given regions.

In another embodiment, images of a given image stack may be blended before performing any blending operations with images of a different image stack. For example, two or more ambient digital images or ambient digital signals, each with a unique light sensitivity, may be blended to generate a blended ambient digital image with a blended ambient light sensitivity. Further, the blended ambient digital image may then be subsequently blended with one or more flash digital images or flash digital signals. The blending with the one or more flash digital images may be in response to user input. In another embodiment, two or more flash digital images may be blended to generate a blended flash digital image with a blended flash light sensitivity, and the blended flash digital image may then be blended with the blended ambient digital image.

As another example, two or more flash digital images or flash digital signals, each with a unique light sensitivity, may be blended to generate a blended flash digital image with a blended flash light sensitivity. Further, the blended flash digital image may then be subsequently blended with one or more ambient digital images or ambient digital signals. The blending with the one or more ambient digital images may be in response to user input. In another embodiment, two or more ambient digital images may be blended to generate a blended ambient digital image with a blended ambient light sensitivity, and the blended ambient digital image may then be blended with the blended flash digital image.

In one embodiment, the ambient image stack may include digital images at different effective exposures than the digital images of the flash image stack. This may be due to application of different gain values for generating each of the ambient image stack and the flash image stack. For example, a particular gain value may be selected for application to an ambient analog signal, but not for application to a corresponding flash analog signal.

As shown in FIG. 11-8, a wireless mobile device 11-376(0) generates at least two digital images. In one embodiment, the at least two digital images may be generated by amplifying analog values of two or more analog storage planes, where each generated digital image may correspond to digital output of an applied gain. In one embodiment, a first digital image may include an EV−1 exposure of a photographic scene, and a second digital image may include an EV+1 exposure of the photographic scene. In another embodiment, the at least two digital images may include an EV−2 exposure of a photographic scene, an EV0 exposure of the photographic scene, and an EV+2 exposure of the photographic scene. In yet another embodiment, the at least two digital images may comprise one or more image stacks. For example, the at least two digital images may comprise an ambient image stack and/or a flash image stack.

With respect to FIG. 11-8, user manipulation of the slider control may adjust a flash contribution of one or more source images captured with strobe or flash illumination.

One advantage of the present invention is that a digital photograph may be selectively generated based on user input using two or more different images generated from a single exposure of a photographic scene. Accordingly, the digital photograph generated based on the user input may have a greater dynamic range than any of the individual images. Additionally, a user may selectively adjust a flash contribution of the different images to the generated digital photograph. Further, the generation of an HDR image using two or more different images with zero, or near zero, interframe time allows for the rapid generation of HDR images without motion artifacts.

Additionally, when there is any motion within a photographic scene, or a capturing device experiences any jitter during capture, any interframe time between exposures may result in a motion blur within a final merged HDR photograph. Such blur can be significantly exaggerated as interframe time increases. This problem renders current HDR photography an ineffective solution for capturing clear images in any circumstance other than a highly static scene. Further, traditional techniques for generating a HDR photograph involve significant computational resources, as well as produce artifacts which reduce the image quality of the resulting image. Accordingly, strictly as an option, one or more of the above issues may or may not be addressed utilizing one or more of the techniques disclosed herein.

Still yet, in various embodiments, one or more of the techniques disclosed herein may be applied to a variety of markets and/or products. For example, although the techniques have been disclosed in reference to a photo capture, they may be applied to televisions, web conferencing (or live streaming capabilities, etc.), security cameras (e.g. increase contrast to determine characteristic, etc.), automobiles (e.g. driver assist systems, in-car infotainment systems, etc.), and/or any other product which includes a camera input.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

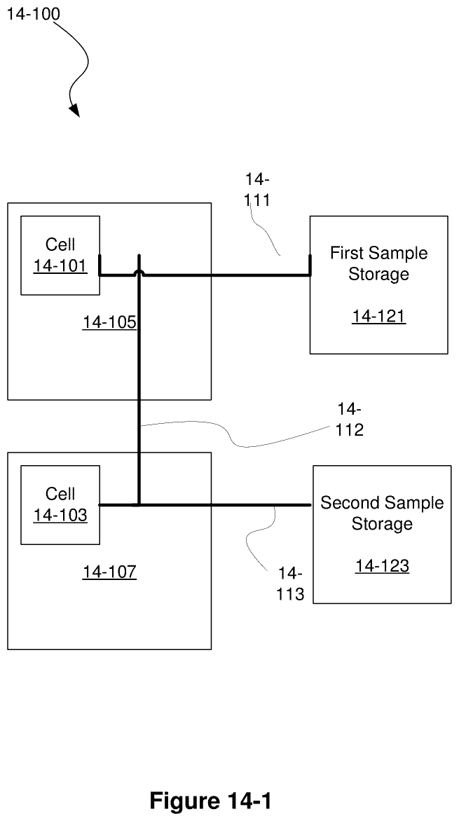

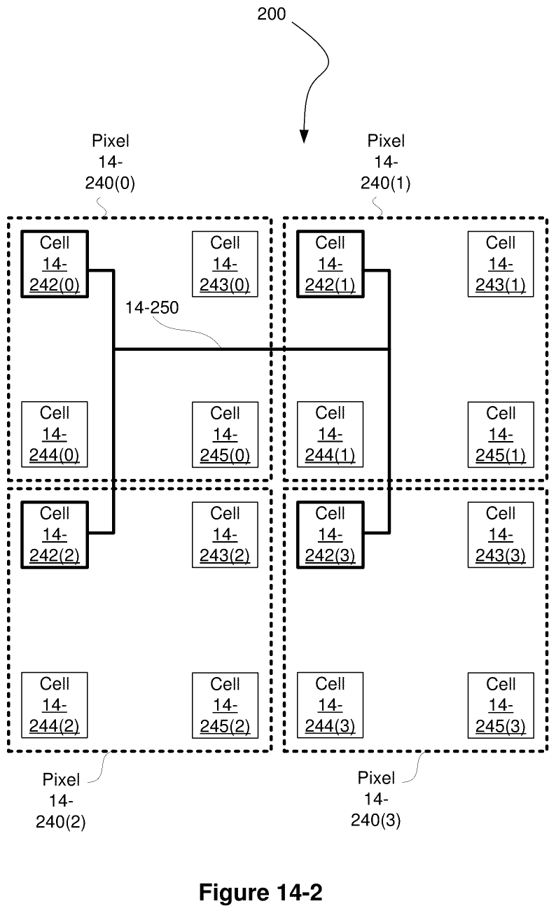

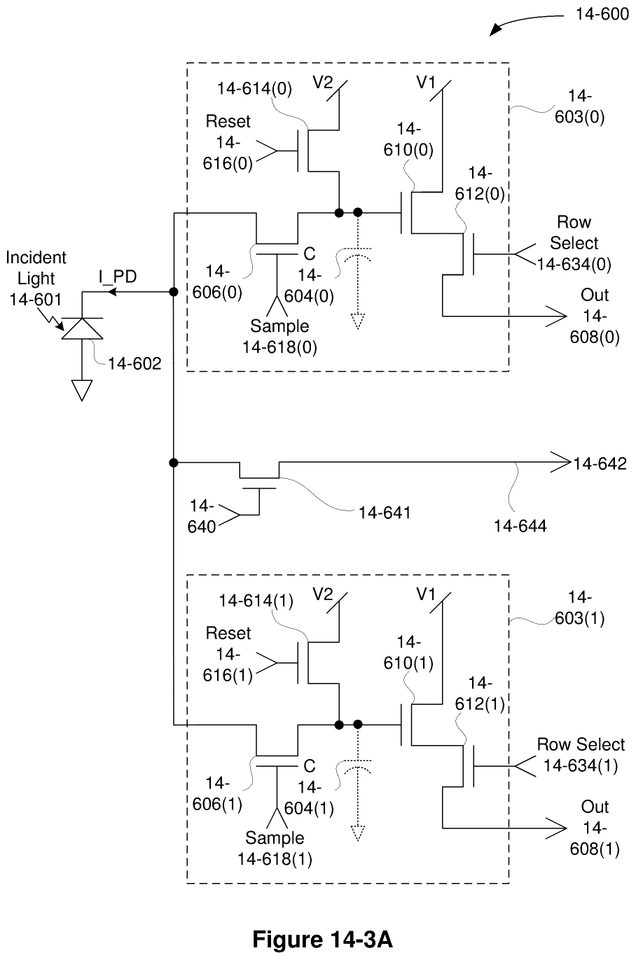

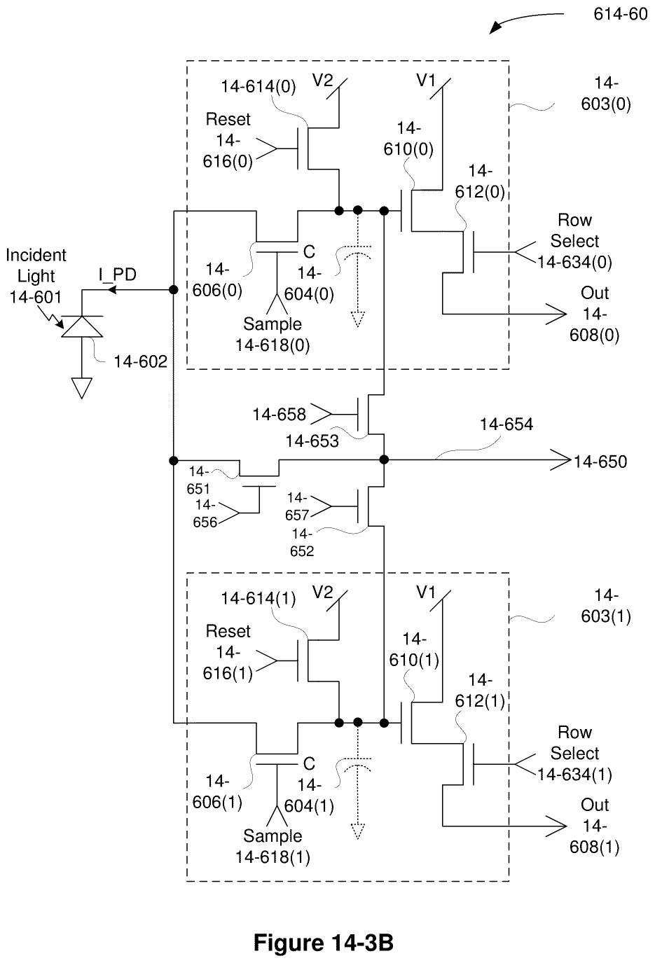

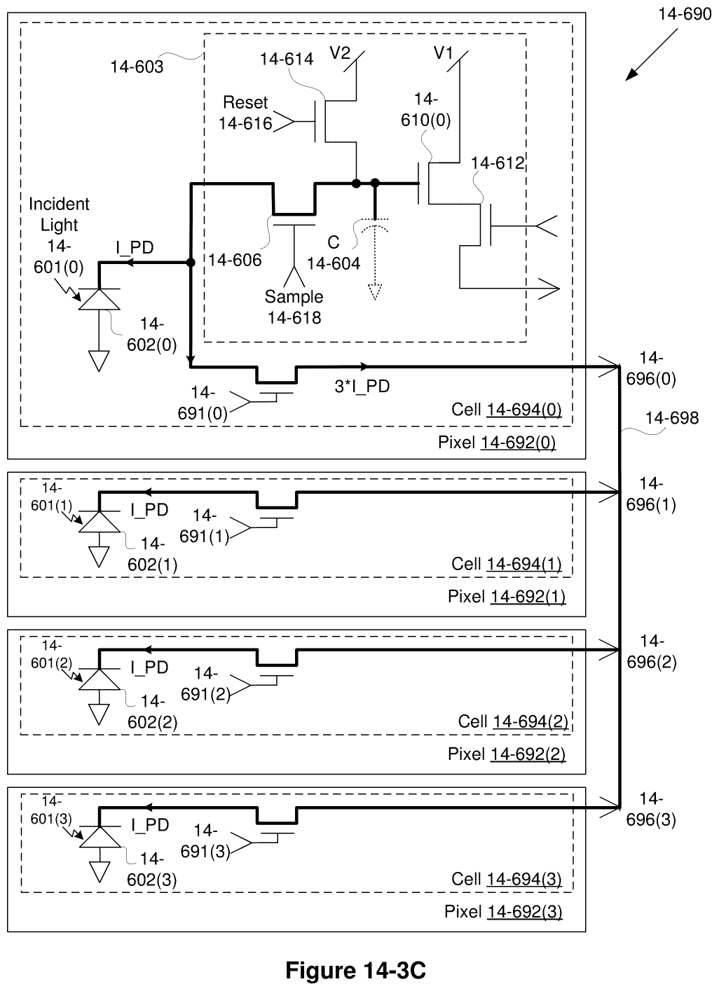

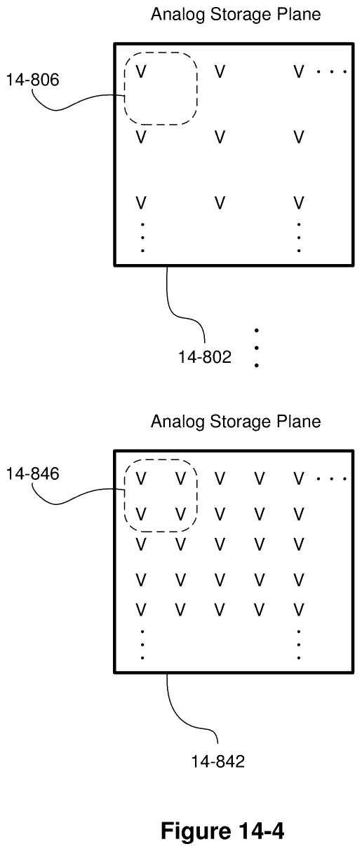

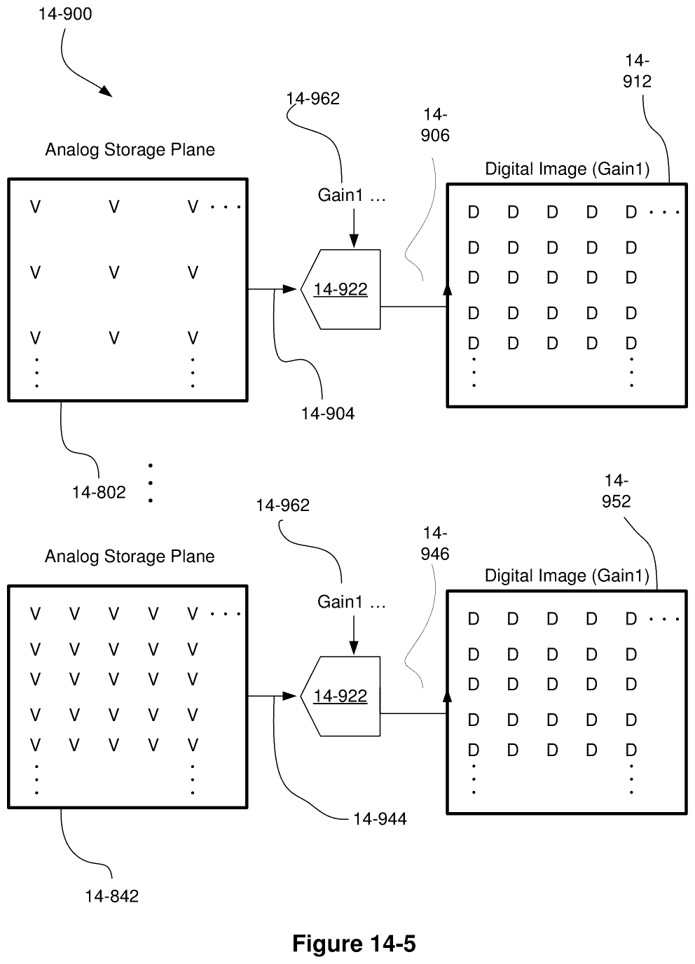

FIG. 14-1 illustrates a system 14-100 for obtaining low-noise, high-speed captures of a photographic scene, in accordance with one embodiment. As an option, the system 14-100 may be implemented in the context of any of the Figures disclosed herein. Of course, however, the system 14-100 may be implemented in any desired environment. Further, the aforementioned definitions may equally apply to the description below.

As shown in FIG. 14-1, the system 14-100 includes a first pixel 14-105, a second pixel 14-107, a first sample storage node 14-121, and a second sample storage node 14-123. Further, the first pixel 14-105 is shown to include a first cell 14-101, and the second pixel 14-107 is shown to include a second cell 14-103. In one embodiment, each pixel may include one or more cells. For example, in some embodiments, each pixel may include four cells. Further, each of the cells may include a photodiode, photosensor, or any photo-sensing electrical element. A photodiode may comprise any semiconductor diode that generates a potential difference, current, or changes its electrical resistance, in response to photon absorption. Accordingly, a photodiode may be used to detect or measure a light intensity.

Referring again to FIG. 14-1, the first cell 14-101 and the first sample storage node 14-121 are in communication via interconnect 14-111, the second cell 14-103 and the second sample storage node 14-123 are in communication via interconnect 14-113, and the first cell 14-101 and the second cell 14-103 are in communication via interconnect 14-112.

Each of the interconnects 14-111-14-113 may carry an electrical signal from one or more cells to a sample storage node. For example, the interconnect 14-111 may carry an electrical signal from the cell 14-101 to the first sample storage node 14-121. The interconnect 14-113 may carry an electrical signal from the cell 14-103 to the second sample storage node 14-123. Further, the interconnect 14-112 may carry an electrical signal from the cell 14-103 to the first sample storage node 14-121, or may carry an electrical signal from the cell 14-101 to the second sample storage node 14-123. In such embodiments, the interconnect 14-112 may enable a communicative coupling between the first cell 14-101 and the second cell 14-103. Further, in some embodiments, the interconnect 14-112 may be operable to be selectively enabled or disabled. In such embodiments, the interconnect 14-112 may be selectively enabled or disable using one or more transistors and/or control signals.

In one embodiment, each electrical signal carried by the interconnects 14-111-113 may include a photodiode current. For example, each of the cells 14-101 and 14-103 may include a photodiode. Each of the photodiodes of the cells 14-101 and 14-103 may generate a photodiode current which is communicated from the cells 14-101 and 14-103 via the interconnects 14-111-113 to one or more of the sample storage nodes 14-121 and 14-123. In configurations where the interconnect 14-112 is disabled, the interconnect 14-113 may communicate a photodiode current from the cell 14-103 to the second sample storage node 14-123, and, similarly, the interconnect 14-111 may communicate a photodiode current from the cell 14-101 to the first sample storage node 14-121. However, in configurations where the interconnect 14-112 is enabled, both the cell 14-101 and the cell 14-103 may communicate a photodiode current to the first sample storage node 14-121 and the second sample storage node 14-123.

Of course, each sample storage node may be operative to receive any electrical signal from one or more communicatively coupled cells, and then store a sample based upon the received electrical signal. In some embodiments, each sample storage node may be configured to store two or more samples. For example, the first sample storage node 14-121 may store a first sample based on a photodiode current from the cell 14-101, and may separately store a second sample based on, at least in part, a photodiode current from the cell 14-103.

In one embodiment, each sample storage node includes a charge storing device for storing a sample, and the sample stored at a given storage node may be a function of a light intensity detected at one or more associated photodiodes. For example, the first sample storage node 14-121 may store a sample as a function of a received photodiode current, which is generated based on a light intensity detected at a photodiode of the cell 14-101. Further, the second sample storage node 14-123 may store a sample as a function of a received photodiode current, which is generated based on a light intensity detected at a photodiode of the cell 14-103. As yet another example, when the interconnect 14-112 is enabled, the first sample storage node 14-121 may receive a photodiode current from each of the cells 14-101 and 14-103, and the first sample storage node 14-121 may thereby store a sample as a function of both the light intensity detected at the photodiode of the cell 14-101 and the light intensity detected at the photodiode of the cell 14-103.

In one embodiment, each sample storage node may include a capacitor for storing a charge as a sample. In such an embodiment, each capacitor stores a charge that corresponds to an accumulated exposure during an exposure time or sample time. For example, current received at each capacitor from one or more associated photodiodes may cause the capacitor, which has been previously charged, to discharge at a rate that is proportional to incident light intensity detected at the one or more photodiodes. The remaining charge of each capacitor may be referred to as a value or analog value, and may be subsequently output from the capacitor. For example, the remaining charge of each capacitor may be output as an analog value that is a function of the remaining charge on the capacitor. In one embodiment, via the interconnect 14-112, the cell 14-101 may be communicatively coupled to one or more capacitors of the first sample storage node 14-121, and the cell 14-103 may also be communicatively coupled to one or more capacitors of the first sample storage node 14-121.

In some embodiments, each sample storage node may include circuitry operable for receiving input based on one or more photodiodes. For example, such circuitry may include one or more transistors. The one or more transistors may be configured for rendering the sample storage node responsive to various control signals, such as sample, reset, and row select signals received from one or more controlling devices or components. In other embodiments, each sample storage node may include any device for storing any sample or value that is a function of a light intensity detected at one or more associated photodiode. In some embodiments, the interconnect 14-112 may be selectively enabled or disabled using one or more associated transistors. Accordingly, the cell 14-101 and the cell 14-103 may be in communication utilizing a communicative coupling that includes at least one transistor. In embodiments where each of the pixels 14-105 and 14-107 include additional cells (not shown), the additional cells may not be communicatively coupled to the cells 14-101 and 14-103 via the interconnect 14-112.

In various embodiments, the pixels 14-105 and 14-107 may be two pixels of an array of pixels of an image sensor. Each value stored at a sample storage node may include an electronic representation of a portion of an optical image that has been focused on the image sensor that includes the pixels 14-105 and 14-107. In such an embodiment, the optical image may be focused on the image sensor by a lens. The electronic representation of the optical image may comprise spatial color intensity information, which may include different color intensity samples (e.g. red, green, and blue light, etc.). In other embodiments, the spatial color intensity information may also include samples for white light. In one embodiment, the optical image may be an optical image of a photographic scene. Such an image sensor may comprise a complementary metal oxide semiconductor (CMOS) image sensor, or charge-coupled device (CCD) image sensor, or any other technically feasible form of image sensor.

FIG. 14-2 illustrates a system 14-200 for obtaining low-noise, high-speed captures of a photographic scene, in accordance with another embodiment. As an option, the system 14-200 may be implemented in the context of any of the Figures disclosed herein. Of course, however, the system 14-200 may be implemented in any desired environment. Further, the aforementioned definitions may equally apply to the description below.

As shown in FIG. 14-2, the system 14-200 includes a plurality of pixels 14-240. Specifically, the system 14-200 is shown to include pixels 14-240(0), 14-240(1), 14-240(2), and 14-240(3). Each of the pixels 14-240 may be substantially identical with respect to composition and configuration. Further, each of the pixels 14-240 may be a single pixel of an array of pixels comprising an image sensor. To this end, each of the pixels 14-240 may comprise hardware that renders the pixel operable to detect or measure various wavelengths of light, and convert the measured light into one or more electrical signals for rendering or generating one or more digital images. Each of the pixels 14-240 may be substantially identical to the pixel 14-105 or the pixel 14-107 of FIG. 14-1.

Further, each of the pixels 14-240 is shown to include a cell 14-242, a cell 14-243, a cell 14-244 and a cell 14-245. In one embodiment, each of the cells 14-242-245 includes a photodiode operative to detect and measure one or more peak wavelengths of light. For example, each of the cells 14-242 may be operative to detect and measure red light, each of the cells 14-243 and 14-244 may be operative to detect and measure green light, and each of the cells 14-245 may be operative to detect and measure blue light. In other embodiments, a photodiode may be configured to detect wavelengths of light other than only red, green, or blue. For example, a photodiode may be configured to detect white, cyan, magenta, yellow, or non-visible light such as infrared or ultraviolet light. Any communicatively coupled cells may be configured to detect a same peak wavelength of light.

In various embodiments, each of the cells 14-242-14-245 may generate an electrical signal in response to detecting and measuring its associated one or more peak wavelengths of light. In one embodiment, each electrical signal may include a photodiode current. A given cell may generate a photodiode current which is sampled by a sample storage node for a selected sample time or exposure time, and the sample storage node may store an analog value based on the sampling of the photodiode current. Of course, as noted previously, each sample storage node may be capable of concurrently storing more than one analog value.

As shown in FIG. 14-2, each of the cells 14-242 are communicatively coupled via an interconnect 14-250. In one embodiment, the interconnect 14-250 may be enabled or disabled using one or more control signals. When the interconnect 14-250 is enabled, the interconnect may carry a combined electrical signal. The combined electrical signal may comprise a combination of electrical signals output from each of the cells 14-242. For example, the combined electrical signal may comprise a combined photodiode current, where the combined photodiode current includes photodiode current received from photodiodes of each of the cells 14-242. Thus, enabling the interconnect 14-250 may serve to increase a combined photodiode current generated based on one or more peak wavelengths of light. In some embodiments, the combined photodiode current may be used to more rapidly store an analog value at a sample storage node than if a photodiode current generated by only a single cell was used to store the analog value. To this end, the interconnect 14-250 may be enabled to render the pixels 14-240 of an image sensor more sensitive to incident light. Increasing the sensitivity of an image sensor may allow for more rapid capture of digital images in low light conditions, capture of digital images with reduced noise, and/or capture of brighter or better exposed digital images in a given exposure time.

The embodiments disclosed herein may advantageously enable a camera module to sample images to have less noise, less blur, and greater exposure in low-light conditions than conventional techniques. In certain embodiments, images may be effectively sampled or captured simultaneously, which may reduce inter-sample time to, or near, zero. In other embodiments, the camera module may sample images in coordination with the strobe unit to reduce inter-sample time between an image sampled without strobe illumination and an image sampled with strobe illumination.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 14-3A illustrates a circuit diagram for a photosensitive cell 14-600, in accordance with one possible embodiment. As an option, the cell 14-600 may be implemented in the context of any of the Figures disclosed herein. Of course, however, the cell 14-600 may be implemented in any desired environment. Further, the aforementioned definitions may equally apply to the description below.

As shown in FIG. 14-3A, a photosensitive cell 14-600 includes a photodiode 14-602 coupled to a first analog sampling circuit 14-603(0) and a second analog sampling circuit 14-603(1). The photodiode 14-602 may be implemented as a photodiode of a cell 14-101 described within the context of FIG. 14-1, or any of the photodiodes 11-562 of FIG. 11-3E. In one embodiment, a unique instance of photosensitive cell 14-600 may be implemented as any of cells 14-242-14-245 within the context of FIG. 14-2, or any of cells 11-542-11-545 within the context of FIGS. 11-3A-11-5E. Further, the first analog sampling circuit 14-603(0) and the second analog sampling circuit 14-603(1) may separately, or in combination, comprise a sample storage node, such as one of the sample storage nodes 14-121 or 14-123 of FIG. 14-1.

As shown, the photosensitive cell 14-600 comprises two analog sampling circuits 14-603, and a photodiode 14-602. The two analog sampling circuits 14-603 include a first analog sampling circuit 14-603(0) which is coupled to a second analog sampling circuit 14-603(1). As shown in FIG. 14-3A, the first analog sampling circuit 14-603(0) comprises transistors 14-606(0), 14-610(0), 14-612(0), 14-614(0), and a capacitor 14-604(0); and the second analog sampling circuit 14-603(1) comprises transistors 14-606(1), 14-610(1), 14-612(1), 14-614(1), and a capacitor 14-604(1). In one embodiment, each of the transistors 14-606, 14-610, 14-612, and 14-614 may be a field-effect transistor.

The photodiode 14-602 may be operable to measure or detect incident light 14-601 of a photographic scene. In one embodiment, the incident light 14-601 may include ambient light of the photographic scene. In another embodiment, the incident light 14-601 may include light from a strobe unit utilized to illuminate the photographic scene. Of course, the incident light 14-601 may include any light received at and measured by the photodiode 14-602. Further still, and as discussed above, the incident light 14-601 may be concentrated on the photodiode 14-602 by a microlens, and the photodiode 14-602 may be one photodiode of a photodiode array that is configured to include a plurality of photodiodes arranged on a two-dimensional plane.

In one embodiment, the analog sampling circuits 14-603 may be substantially identical. For example, the first analog sampling circuit 14-603(0) and the second analog sampling circuit 14-603(1) may each include corresponding transistors, capacitors, and interconnects configured in a substantially identical manner. Of course, in other embodiments, the first analog sampling circuit 14-603(0) and the second analog sampling circuit 14-603(1) may include circuitry, transistors, capacitors, interconnects and/or any other components or component parameters (e.g. capacitance value of each capacitor 14-604) which may be specific to just one of the analog sampling circuits 14-603.

In one embodiment, each capacitor 14-604 may include one node of a capacitor comprising gate capacitance for a transistor 14-610 and diffusion capacitance for transistors 14-606 and 14-614. The capacitor 14-604 may also be coupled to additional circuit elements (not shown) such as, without limitation, a distinct capacitive structure, such as a metal-oxide stack, a poly capacitor, a trench capacitor, or any other technically feasible capacitor structures.

The cell 14-600 is further shown to include an interconnect 14-644 between the analog sampling circuit 14-603(0) and the analog sampling circuit 14-603(1). The interconnect 14-644 includes a transistor 14-641, which comprises a gate 14-640 and a source 14-642. A drain of the transistor 14-641 is coupled to each of the analog sampling circuit 14-603(0) and the analog sampling circuit 14-603(1). When the gate 14-640 is turned off, the cell 14-600 may operate in isolation. When operating in isolation, the cell 14-600 may operate in a manner whereby the photodiode 14-602 is sampled by one or both of the analog sampling circuits 14-603 of the cell 14-600. For example, the photodiode 14-602 may be sampled by the analog sampling circuit 14-603(0) and the analog sampling circuit 14-603(1) in a concurrent manner, or the photodiode 14-602 may be sampled by the analog sampling circuit 14-603(0) and the analog sampling circuit 14-603(1) in a sequential manner. In alternative embodiments, the drain terminal of transistor 14-641 is coupled to interconnect 14-644 and the source terminal of transistor 14-641 is coupled to the sampling circuits 14-603 and the photodiode 14-602.

With respect to analog sampling circuit 14-603(0), when reset 14-616(0) is active (low), transistor 14-614(0) provides a path from voltage source V2 to capacitor 14-604(0), causing capacitor 14-604(0) to charge to the potential of V2. When sample signal 14-618(0) is active, transistor 14-606(0) provides a path for capacitor 14-604(0) to discharge in proportion to a photodiode current (I_PD) generated by the photodiode 14-602 in response to the incident light 14-601. In this way, photodiode current I_PD is integrated for a first exposure time when the sample signal 14-618(0) is active, resulting in a corresponding first voltage on the capacitor 14-604(0). This first voltage on the capacitor 14-604(0) may also be referred to as a first sample. When row select 14-634(0) is active, transistor 14-612(0) provides a path for a first output current from V1 to output 14-608(0). The first output current is generated by transistor 14-610(0) in response to the first voltage on the capacitor 14-604(0). When the row select 14-634(0) is active, the output current at the output 14-608(0) may therefore be proportional to the integrated intensity of the incident light 14-601 during the first exposure time.

With respect to analog sampling circuit 14-603(1), when reset 14-616(1) is active (low), transistor 14-614(1) provides a path from voltage source V2 to capacitor 14-604(1), causing capacitor 14-604(1) to charge to the potential of V2. When sample signal 14-618(1) is active, transistor 14-606(1) provides a path for capacitor 14-604(1) to discharge in proportion to a photodiode current (I_PD) generated by the photodiode 14-602 in response to the incident light 14-601. In this way, photodiode current I_PD is integrated for a second exposure time when the sample signal 14-618(1) is active, resulting in a corresponding second voltage on the capacitor 14-604(1). This second voltage on the capacitor 14-604(1) may also be referred to as a second sample. When row select 14-634(1) is active, transistor 14-612(1) provides a path for a second output current from V1 to output 14-608(1). The second output current is generated by transistor 14-610(1) in response to the second voltage on the capacitor 14-604(1). When the row select 14-634(1) is active, the output current at the output 14-608(1) may therefore be proportional to the integrated intensity of the incident light 14-601 during the second exposure time.

As noted above, when the cell 14-600 is operating in an isolation mode, the photodiode current I_PD of the photodiode 14-602 may be sampled by one of the analog sampling circuits 14-603 of the cell 14-600; or may be sampled by both of the analog sampling circuits 14-603 of the cell 14-600, either concurrently or sequentially. When both the sample signal 14-618(0) and the sample signal 14-618(1) are activated simultaneously, the photodiode current I_PD of the photodiode 14-602 may be sampled by both analog sampling circuits 14-603 concurrently, such that the first exposure time and the second exposure time are, at least partially, overlapping.

When the sample signal 14-618(0) and the sample signal 14-618(1) are activated sequentially, the photodiode current I_PD of the photodiode 14-602 may be sampled by the analog sampling circuits 14-603 sequentially, such that the first exposure time and the second exposure time do not overlap.

In various embodiments, when the gate 14-640 is turned on, the cell 14-600 may be thereby communicatively coupled to one or more other instances of cell 14-600 of other pixels via the interconnect 14-644. In one embodiment, when two or more cells 14-600 are coupled together, the two or more corresponding instances of photodiode 14-602 may collectively provide a shared photodiode current on the interconnect 14-644. In such an embodiment, one or more analog sampling circuits 14-603 of the two instances of cell 14-600 may sample the shared photodiode current. For example, in one embodiment, a single sample signal 14-618(0) may be activated such that a single analog sampling circuit 14-603 samples the shared photodiode current. In another embodiment two instances of a sample signal 14-618(0), each associated with a different cell 14-600, may be activated to sample the shared photodiode current, such that two analog sampling circuits 14-603 of two different cells 14-600 sample the shared photodiode current. In yet another embodiment, both of a sample signal 14-618(0) and 14-618(1) of a single cell 14-600 may be activated to sample the shared photodiode current, such that two analog sampling circuits 14-603(0) and 14-603(1) of one of the cells 14-600 sample the shared photodiode current, and neither of the analog sampling circuits 14-603 of the other cell 14-600 sample the shared photodiode current.

In a specific example, two instances of cell 14-600 may be coupled via the interconnect 14-644. Each instance of the cell 14-600 may include a photodiode 14-602 and two analog sampling circuits 14-603. In such an example, the two photodiodes 14-602 may be configured to provide a shared photodiode current to one, two, three, or all four of the analog sampling circuits 14-603 via the interconnect 14-644. If the two photodiodes 14-602 detect substantially identical quantities of light, then the shared photodiode current may be twice the magnitude that any single photodiode current would be from a single one of the photodiodes 14-602. Thus, this shared photodiode current may otherwise be referred to as a 2× photodiode current. If only one analog sampling circuit 14-603 is activated to sample the 2× photodiode current, the analog sampling circuit 14-603 may effectively sample the 2× photodiode current twice as fast for a given exposure level as the analog sampling circuit 14-603 would sample a photodiode current received from a single photodiode 14-602. Further, if only one analog sampling circuit 14-603 is activated to sample the 2× photodiode current, the analog sampling circuit 14-603 may be able to obtain a sample twice as bright as the analog sampling circuit 14-603 would obtain by sampling a photodiode current received from a single photodiode 14-602 for a same exposure time. However, in such an embodiment, because only a single analog sampling circuit 14-603 of the two cells 14-600 actively samples the 2× photodiode current, one of the cells 14-600 does not store any analog value representative of the 2× photodiode current. Accordingly, when a 2× photodiode current is sampled by only a subset of corresponding analog sampling circuits 14-603, image resolution may be reduced in order to increase a sampling speed or sampling sensitivity.

In one embodiment, communicatively coupled cells 14-600 may be located in a same row of pixels of an image sensor. In such an embodiment, sampling with only a subset of communicatively coupled analog sampling circuits 14-603 may reduce an effective horizontal resolution of the image sensor by ½. In another embodiment, communicatively coupled cells 14-600 may be located in a same column of pixels of an image sensor. In such an embodiment, sampling with only a subset of communicatively coupled analog sampling circuits 14-603 may reduce an effective vertical resolution of the image sensor by ½.

In another embodiment, an analog sampling circuit 14-603 of each of the two cells 14-600 may be simultaneously activated to concurrently sample the 2× photodiode current. In such an embodiment, because the 2× photodiode current is shared by two analog sampling circuits 14-603, sampling speed and sampling sensitivity may not be improved in comparison to a single analog sampling circuit 14-603 sampling a photodiode current of a single photodiode 14-602. However, by sharing the 2× photodiode current over the interconnect 14-644 between the two cells 14-600, and then sampling the 2× photodiode current using an analog sampling circuit 14-603 in each of the cells 14-600, the analog values sampled by each of the analog sampling circuits 14-603 may be effectively averaged, thereby reducing the effects of any noise present in a photodiode current output by either of the coupled photodiodes 14-602.

In yet another example, two instances of cell 14-600 may be coupled via the interconnect 14-644. Each instance of the cell 14-600 may include a photodiode 14-602 and two analog sampling circuits 14-603. In such an example, the two photodiodes 14-602 may be configured to provide a shared photodiode current to one, two, three, or all four of the analog sampling circuits 14-603 via the interconnect 14-644. If the two photodiodes 14-602 detect substantially identical quantities of light, then the shared photodiode current may be twice the magnitude that any single photodiode current would be from a single one of the photodiodes 14-602. Thus, this shared photodiode current may otherwise be referred to as a 2× photodiode current. Two analog sampling circuits 14-603 of one of the cells 14-600 may be simultaneously activated to concurrently sample the 2× photodiode current in a manner similar to that described hereinabove with respect to the analog sampling circuits 14-603(0) and 14-603(1) sampling the photodiode current I_PD of the photodiode 14-602 in isolation. In such an embodiment, two analog storage planes may be populated with analog values at a rate that is 2× faster than if the analog sampling circuits 14-603(0) and 14-603(1) received a photodiode current from a single photodiode 14-602.

In another embodiment including two instances of cell 14-600 coupled via interconnect 14-644 for sharing a 2× photodiode current, such that four analog sampling circuits 14-603 may be simultaneously activated for a single exposure. In such an embodiment, the four analog sampling circuits 14-603 may concurrently sample the 2× photodiode current in a manner similar to that described hereinabove with respect to the analog sampling circuits 14-603(0) and 14-603(1) sampling the photodiode current I_PD of the photodiode 14-602 in isolation. In such an embodiment, the four analog sampling circuits 14-603 may be disabled sequentially, such that each of the four analog sampling circuits 14-603 stores a unique analog value representative of the 2× photodiode current. Thereafter, each analog value may be output in a different analog signal, and each analog signal may be amplified and converted to a digital signal comprising a digital image.

Thus, in addition to the 2× photodiode current serving to reduce noise in any final digital image, four different digital images may be generated for the single exposure, each with a different effective exposure and light sensitivity. These four digital images may comprise, and be processed as, an image stack. In other embodiments, the four analog sampling circuits 14-603 may be activated and deactivated together for sampling the 2× photodiode current, such that each of the analog sampling circuits 14-603 store a substantially identical analog value. In yet other embodiments, the four analog sampling circuits 14-603 may be activated and deactivated in a sequence for sampling the 2× photodiode current, such that no two analog sampling circuits 14-603 are actively sampling at any given moment.

Of course, while the above examples and embodiments have been described for simplicity in the context of two instances of a cell 14-600 being communicatively coupled via interconnect 14-644, more than two instances of a cell 14-600 may be communicatively coupled via the interconnect 14-644. For example, four instances of a cell 14-600 may be communicatively coupled via an interconnect 14-644. In such an example, eight different analog sampling circuits 14-603 may be addressable, in any sequence or combination, for sampling a 4× photodiode current shared between the four instances of cell 14-600. Thus, as an option, a single analog sampling circuit 14-603 may be able to sample the 4× photodiode current at a rate 4× faster than the analog sampling circuit 14-603 would be able to sample a photodiode current received from a single photodiode 14-602.

For example, an analog value stored by sampling a 4× photodiode current at a 1/120 second exposure time may be substantially identical to an analog value stored by sampling a 1× photodiode current at a 1/30 second exposure time. By reducing an exposure time required to sample a given analog value under a given illumination, blur may be reduced within a final digital image. Thus, sampling a shared photodiode current may effectively increase the ISO, or light sensitivity, at which a given photographic scene is sampled without increasing the noise associated with applying a greater gain.

As another option, the single analog sampling circuit 14-603 may be able to obtain, for a given exposure time, a sample 4× brighter than a sample obtained by sampling a photodiode current received from a single photodiode. Sampling a 4× photodiode current may allow for much more rapid sampling of a photographic scene, which may serve to reduce any blur present in a final digital image, to more quickly capture a photographic scene (e.g., ¼ exposure time), to increase the brightness or exposure of a final digital image, or any combination of the foregoing. Of course, sampling a 4× photodiode current with a single analog sampling circuit 14-603 may result in an analog storage plane having ¼ the resolution of an analog storage plane in which each cell 14-600 generates a sample. In another embodiment, where four instances of a cell 14-600 may be communicatively coupled via an interconnect 14-644, up to eight separate exposures may be captured by sequentially sampling the 4× photodiode current with each of the eight analog sampling circuits 14-603. In one embodiment, each cell includes one or more analog sampling circuits 14-603.

FIG. 14-3B illustrates a circuit diagram for a photosensitive cell 14-660, in accordance with one possible embodiment. As an option, the cell 14-660 may be implemented in the context of any of the Figures disclosed herein. Of course, however, the cell 14-660 may be implemented in any desired environment. Further, the aforementioned definitions may equally apply to the description below.

As shown, the photosensitive cell 14-660 comprises a photodiode 14-602 that is substantially identical to the photodiode 14-602 of cell 14-600, a first analog sampling circuit 14-603(0) that is substantially identical to the first analog sampling circuit 14-603(0) of cell 14-600, a second analog sampling circuit 14-603(1) that is substantially identical to the second analog sampling circuit 14-603(1) of cell 14-600, and an interconnect 14-654. The interconnect 14-654 is shown to comprise three transistors 14-651-653, and a source 14-650. Each of the transistors 14-651, 14-652, and 14-653, include a gate 14-656, 14-657, and 14-658, respectively. The cell 14-660 may operate in substantially the same manner as the cell 14-600 of FIG. 14-3A, however the cell 14-660 includes only two pass gates from photodiodes 14-602 of other cells 14-660 coupled via the interconnect 14-654, whereas the cell 14-600 includes three pass gates from the photodiodes 14-602 of other cells 14-600 coupled via the interconnect 14-644.

FIG. 14-3C illustrates a circuit diagram for a system 14-690 including plurality of communicatively coupled photosensitive cells 14-694, in accordance with one possible embodiment. As an option, the system 14-690 may be implemented in the context of any of the Figures disclosed herein. Of course, however, the system 14-690 may be implemented in any desired environment. Further, the aforementioned definitions may equally apply to the description below.

As illustrated in FIG. 14-3C, the system 14-690 is shown to include four pixels 14-692, where each of the pixels 14-692 includes a respective cell 14-694, and a set of related cells 14-694 are communicatively coupled via interconnect 14-698. Each of the pixels 14-692 may be implemented as a pixel 14-240 of FIG. 14-2, each of the cells 14-694 may be implemented as a cell 14-242 of FIG. 14-2, and the interconnect 14-698 may be implemented as the interconnect 14-250 of FIG. 14-2. Further, the interconnect 14-698 is shown to include multiple instances of a source 14-696, and multiple instances of a gate 14-691. Also, each cell 14-694 may include an analog sampling circuit 14-603 coupled to a photodiode 14-602 for measuring or detecting incident light 14-601. The analog sampling circuit 14-603 may be substantially identical to either of the analog sampling circuits 14-603(0) and 14-603(1) disclosed in the context of FIG. 14-3A.

When all instances of the gate 14-691 are turned on, each of the cells 14-694 may be thereby communicatively coupled to each of the other cells 14-694 of the other pixels 14-692 via the interconnect 14-698. As a result, a shared photodiode current may be generated. As shown in FIG. 14-3C, each of the cells 14-694(1), 14-694(2), and 14-694(3) output a substantially similar photodiode current I_PD on the interconnect 14-698. The photodiode current I_PD generated by each of the cells 14-694(1), 14-694(2), and 14-694(3) may be generated by the respective photodiodes 14-602(1), 14-602(2), and 14-602(3). The photodiode current from the cells 14-694(1), 14-694(2), and 14-694(3) may combine on the interconnect 14-698 to form a combined photodiode current of 3*I_PD, or a 3× photodiode current.

When sample signal 14-618 of analog sampling circuit 14-603 is asserted, the 3× photodiode combines with the photodiode current I_PD of photodiode 14-602(0), and a 4× photodiode current may be sampled by the analog sampling circuit 14-603. Thus, a sample may be stored to capacitor 14-604 of analog sampling circuit 14-603 of cell 14-694(0) at a rate 4× faster than if the single photodiode 14-602(0) generated the photodiode current I_PD sampled by the analog sampling circuit 14-603. As an option, the 4× photodiode current may be sampled for a same given exposure time that a 1× photodiode current would be sampled for, which may significantly increase or decrease a value of the analog value stored in the analog sampling circuit 14-603. For example, an analog value stored from sampling the 4× photodiode current for the given exposure time may be associated with a final digital pixel value that is effectively 4× brighter than an analog value stored from sampling a 1× photodiode current for the given exposure time.

When all instances of the gate 14-691 are turned off, each of the cells 14-694 may be uncoupled from the other cells 14-694 of the other pixels 14-692. When the cells 14-694 are uncoupled, each of the cells 14-694 may operate in isolation as discussed previously, for example with respect to FIG. 14-3A. For example, when operating in isolation, analog sampling circuit 14-603 may only sample, under the control of sample signal 14-618, a photodiode current I_PD from a respective photodiode 14-602(0).

In one embodiment, pixels 14-692 within an image sensor each include a cell 14-694 configured to be sensitive to red light (a “red cell”), a cell 14-694 configured to be sensitive to green light (a “green cell”), and a cell 14-694 configured to be sensitive to blue light (a “blue cell”). Furthermore, sets of two or more pixels 14-692 may be configured as described above in FIGS. 14-6A-6C to switch into a photodiode current sharing mode, whereby red cells within each set of pixels share photodiode current, green cells within each set of pixels share photodiode current, and blue cells within each set of pixels share photodiode current. In certain embodiments, the pixels 14-692 also each include a cell 14-694 configured to be sensitive to white light (a “white cell”), whereby each white cell may operate independently with respect to photodiode current while the red cells, green cells, and blue cells operate in a shared photodiode current mode. All other manufacturing parameters being equal, each white cell may be more sensitive (e.g., three times more sensitive) to incident light than any of the red cells, green cells, or blue cells, and, consequently, a white cell may require less exposure time or gain to generate a comparable intensity signal level. In such an embodiment, the resolution of color information (from the red cells, green cells, and blue cells) may be reduced to gain greater sensitivity and better noise performance, while the resolution of pure intensity information (from the white cells) may be kept at full sensor resolution without significantly sacrificing sensitivity or noise performance with respect to intensity information. For example, a 4K pixel by 4K pixel image sensor may be configured to operate as a 2K pixel by 2K pixel image sensor with respect to color, thereby improving color sensitivity by a factor of 4×, while, at the same time, being able to simultaneously capture a 4K pixel by 4K pixel intensity plane from the white cells. In such a configuration, the quarter resolution color information provided by the red cells, green cells, and blue cells may be fused with full resolution intensity information provided by the white cells. To this end, a full 4K by 4K resolution color image may be generated by the image sensor, with better overall sensitivity and noise performance than a comparable conventional image sensor.

FIG. 14-4 illustrates implementations of different analog storage planes, in accordance with another embodiment. As an option, the analog storage planes of FIG. 14-4 may be implemented in the context of the details of any of the Figures disclosed herein. Of course, however, the analog storage planes of FIG. 14-4 may be implemented in any desired environment. Further, the aforementioned definitions may equally apply to the description below.

FIG. 14-4 is illustrated to include a first analog storage plane 14-802 and a second analog storage plane 14-842. A plurality of analog values are each depicted as a “V” within the analog storage planes 14-802 and 14-842. In the context of certain embodiments, each analog storage plane may comprise any collection of one or more analog values. In some embodiments, an analog storage plane may be capable of storing at least one analog pixel value for each pixel of a row or line of a pixel array. In one embodiment, an analog storage plane may cable of storing an analog value for each cell of each pixel of a plurality of pixels of a pixel array. Still yet, in another embodiment, an analog storage plane may be capable of storing at least one analog pixel value for each pixel of an entirety of a pixel array, which may be referred to as a frame. For example, an analog storage plane may be capable of storing an analog value for each cell of each pixel of every line or row of a pixel array.

In one embodiment, the analog storage plane 14-842 may be representative of a portion of an image sensor in which an analog sampling circuit of each cell has been activated to sample a corresponding photodiode current. In other words, for a given region of an image sensor, all cells include an analog sampling circuit that samples a corresponding photodiode current, and stores an analog value as a result of the sampling operation. As a result, the analog storage plane 14-842 includes a greater analog value density 14-846 than an analog value density 14-806 of the analog storage plane 14-802.

In one embodiment, the analog storage plane 14-802 may be representative of a portion of an image sensor in which only one-quarter of the cells include analog sampling circuits activated to sample a corresponding photodiode current. In other words, for a given region of an image sensor, only one-quarter of the cells include an analog sampling circuit that samples a corresponding photodiode current, and stores an analog value as a result of the sampling operation. The analog value density 14-806 of the analog storage plane 14-802 may result from a configuration, as discussed above, wherein four neighboring cells are communicatively coupled via an interconnect such that a 4× photodiode current is sampled by a single analog sampling circuit of one of the four cells, and the remaining analog sampling circuits of the other three cells are not activated to sample.

FIG. 14-5 illustrates a system 14-900 for converting analog pixel data of an analog signal to digital pixel data, in accordance with another embodiment. As an option, the system 14-900 may be implemented in the context of the details of any of the Figures disclosed herein. Of course, however, the system 14-900 may be implemented in any desired environment. Further, the aforementioned definitions may equally apply to the description below.

The system 14-900 is shown in FIG. 14-5 to include a first analog storage plane 14-802, an analog-to-digital unit 14-922, a first digital image 14-912, a second analog storage plane 14-842, and a second digital image 14-952. As illustrated in FIG. 14-5, a plurality of analog values are each depicted as a “V” within each of the analog storage planes 14-802 and 14-842, and corresponding digital values are each depicted as a “D” within digital images 14-912 and 14-952, respectively.

As noted above, each analog storage plane 14-802 and 14-842 may comprise any collection of one or more analog values. In one embodiment, a given analog storage plane may comprise an analog value for each analog storage circuit 14-603 that receives an active sample signal 14-618, and thereby samples a photodiode current, during an associated exposure time.

In some embodiments, an analog storage plane may include analog values for only a subset of all the analog storage circuits 14-603 of an image sensor. This may occur, for example, when analog storage circuits 14-603 of only odd or even rows of pixels are activated to sample during a given exposure time. Similarly, this may occur when analog storage circuits 14-603 of only odd or even columns of pixels are activated to sample during a given exposure. As another example, this may occur when two or more photosensitive cells are communicatively coupled, such as by an interconnect 14-644, in a manner that distributes a shared photodiode current, such as a 2× or 4× photodiode current, between the communicatively coupled cells. In such an embodiment, only a subset of analog sampling circuits 14-603 of the communicatively coupled cells may be activated by a sample signal 14-618 to sample the shared photodiode current during a given exposure time. Any analog sampling circuits 14-603 activated by a sample signal 14-618 during the given exposure time may sample the shared photodiode current, and store an analog value to the analog storage plane associated with the exposure time. However, the analog storage plane associated with the exposure time would not include any analog values associated with the analog sampling circuits 14-603 that are not activated by a sample signal 14-618 during the exposure time.

Thus, an analog value density of a given analog storage plane may depend on a subset of analog sampling circuits 14-603 activated to sample photodiode current during a given exposure associated with the analog storage plane. Specifically, a greater analog value density may be obtained, such as for the more dense analog storage plane 14-842, when a sample signal 14-618 is activated for an analog sampling circuit 14-603 in each of a plurality of neighboring cells of an image sensor during a given exposure time. Conversely, a decreased analog value density may be obtained, such as for the less dense analog storage plane 14-802, when a sample signal 14-618 is activated for only a subset of neighboring cells of an image sensor during a given exposure time.

Returning now to FIG. 14-5, the analog values of the less dense analog storage plane 14-802 are output as analog pixel data 14-904 to the analog-to-digital unit 14-922. Further, the analog values of the more dense analog storage plane 14-842 are separately output as analog pixel data 14-944 to the analog-to-digital unit 14-922. In one embodiment, the analog-to-digital unit 14-922 may be substantially identical to the analog-to-digital unit 11-622 described within the context of FIG. 11-4. For example, the analog-to-digital unit 14-922 may comprise at least one amplifier and at least one analog-to-digital converter, where the amplifier is operative to receive a gain value and utilize the gain value to gain-adjust analog pixel data received at the analog-to-digital unit 14-922. Further, in such an embodiment, the amplifier may transmit gain-adjusted analog pixel data to an analog-to-digital converter, which then generates digital pixel data from the gain-adjusted analog pixel data. To this end, an analog-to-digital conversion may be performed on the contents of each of two or more different analog storage planes 14-802 and 14-842.

In one embodiment, the analog-to-digital unit 14-922 applies at least two different gains to each instance of received analog pixel data. For example, the analog-to-digital unit 14-922 may receive analog pixel data 14-904, and apply at least two different gains to the analog pixel data 14-904 to generate at least a first gain-adjusted analog pixel data and a second gain-adjusted analog pixel data based on the analog pixel data 14-904; and the analog-to-digital unit 14-922 may receive analog pixel data 14-944, and then apply at least two different gains to the analog pixel data 14-944 to generate at least a first gain-adjusted analog pixel data and a second gain-adjusted analog pixel data based on the analog pixel data 14-944.

Further, the analog-to-digital unit 14-922 may convert each instance of gain-adjusted analog pixel data to digital pixel data, and then output a corresponding digital signal. With respect to FIG. 14-5 specifically, the analog-to-digital unit 14-922 is shown to generate a first digital signal comprising first digital pixel data 14-906 corresponding to application of Gain1 to analog pixel data 14-904; and a second digital signal comprising second digital pixel data 14-946 corresponding to application of Gain1 to analog pixel data 14-944. Each instance of digital pixel data may comprise a digital image, such that the first digital pixel data 14-906 comprises a digital image 14-912, and the second digital pixel data 14-946 comprises a digital image 14-952. In other words, a first digital image 14-912 may be generated based on the analog values of the less dense analog storage plane 14-802, and a second digital image 14-952 may be generated based on the analog values of the more dense analog storage plane 14-842.

Of course, in other embodiments, the analog-to-digital unit 14-922 may apply a plurality of gains to each instance of analog pixel data, to thereby generate an image stack based on each analog storage plane 14-802 and 14-842. Each image stack may be manipulated as set forth in those applications, or as set forth below.

In some embodiments, the digital image 14-952 may have a greater resolution than the digital image 14-912. In other words, a greater number of pixels may comprise digital image 14-952 than a number of pixels that comprise digital image 14-912. This may be because the digital image 14-912 was generated from the less dense analog storage plane 14-802 that included, in one example, only one-quarter the number of sampled analog values of more dense analog storage plane 14-842. In other embodiments, the digital image 14-952 may have the same resolution as the digital image 14-912. In such an embodiment, a plurality of digital pixel data values may be generated to make up for the reduced number of sampled analog values in the less dense analog storage plane 14-802. For example, the plurality of digital pixel data values may be generated by interpolation to increase the resolution of the digital image 14-912.

In one embodiment, the digital image 14-912 generated from the less dense analog storage plane 14-802 may be used to improve the digital image 14-952 generated from the more dense analog storage plane 14-842. As a specific non-limiting example, each of the less dense analog storage plane 14-802 and the more dense analog storage plane 14-842 may storage analog values for a single exposure of a photographic scene. In the context of the present description, a “single exposure” of a photographic scene may include simultaneously, at least in part, capturing the photographic scene using two or more sets of analog sampling circuits, where each set of analog sampling circuits may be configured to operate at different exposure times. Further, the single exposure may be further broken up into multiple discrete exposure times or samples times, where the exposure times or samples times may occur sequentially, partially simultaneously, or in some combination of sequentially and partially simultaneously.

During capture of the single exposure of the photographic scene using the two or more sets of analog sampling circuits, some cells of the capturing image sensor may be communicatively coupled to one or more other cells. For example, cells of an image sensor may be communicatively coupled as shown in FIG. 14-2, such that each cell is coupled to three other cells associated with a same peak wavelength of light. Therefore, during the single exposure, each of the communicatively coupled cells may receive a 4× photodiode current.

During a first sample time of the single exposure, a first analog sampling circuit in each of the four cells may receive an active sample signal, which causes the first analog sampling circuit in each of the four cells to sample the 4× photodiode current for the first sample time. The more dense analog storage plane 14-842 may be representative of the analog values stored during such a sample operation. Further, a second analog sampling circuit in each of the four cells may be controlled to separately sample the 4× photodiode current. As one option, during a second sample time after the first sample time, only a single second analog sampling circuit of the four coupled cells may receive an active sample signal, which causes the single analog sampling circuit to sample the 4× photodiode current for the second sample time. The less dense analog storage plane 14-802 may be representative of the analog values stored during such a sample operation.

As a result, analog values stored during the second sample time of the single exposure are sampled with an increased sensitivity, but a decreased resolution, in comparison to the analog values stored during the first sample time. In situations involving a low-light photographic scene, the increased light sensitivity associated with the second sample time may generate a better exposed and/or less noisy digital image, such as the digital image 14-912. However, the digital image 14-952 may have a desired final image resolution or image size. Thus, in some embodiments, the digital image 14-912 may be blended or mixed or combined with digital image 14-952 to reduce the noise and improve the exposure of the digital image 14-952. For example, a digital image with one-half vertical or one-half horizontal resolution may be blended with a digital image at full resolution. In another embodiment any combination of digital images at one-half vertical resolution, one-half horizontal resolution, and full resolution may be blended.

In some embodiments, a first exposure time (or first sample time) and a second exposure time (or second sample time) are each captured using an ambient illumination of the photographic scene. In other embodiments, the first exposure time (or first sample time) and the second exposure time (or second sample time) are each captured using a flash or strobe illumination of the photographic scene. In yet other embodiments, the first exposure time (or first sample time) may be captured using an ambient illumination of the photographic scene, and the second exposure time (or second sample time) may be captured using a flash or strobe illumination of the photographic scene.

In embodiments in which the first exposure time is captured using an ambient illumination, and the second exposure time is captured using flash or strobe illumination, analog values stored during the first exposure time may be stored to an analog storage plane at a higher density than the analog values stored during the second exposure time. This may effectively increase the ISO or sensitivity of the capture of the photographic scene at ambient illumination. Subsequently, the photographic scene may then be captured at full resolution using the strobe or flash illumination. The lower resolution ambient capture and the full resolution strobe or flash capture may then be merged to create a combined image that includes detail not found in either of the individual captures.

One advantage of the present invention is that a digital photograph may be selectively generated based on user input using two or more different images generated from a single exposure of a photographic scene. Accordingly, the digital photograph generated based on the user input may have a greater dynamic range than any of the individual images. Further, the generation of an HDR image using two or more different images with zero, or near zero, interframe time allows for the rapid generation of HDR images without motion artifacts.

When there is any motion within a photographic scene, or a capturing device experiences any jitter during capture, any interframe time between exposures may result in a motion blur within a final merged HDR photograph. Such blur can be significantly exaggerated as interframe time increases. This problem renders current HDR photography an ineffective solution for capturing clear images in any circumstance other than a highly static scene. Further, traditional techniques for generating a HDR photograph involve significant computational resources, as well as produce artifacts which reduce the image quality of the resulting image. Accordingly, strictly as an option, one or more of the above issues may or may not be addressed utilizing one or more of the techniques disclosed herein.

Still yet, in various embodiments, one or more of the techniques disclosed herein may be applied to a variety of markets and/or products. For example, although the techniques have been disclosed in reference to a photo capture, they may be applied to televisions, web conferencing (or live streaming capabilities, etc.), security cameras (e.g. increase contrast to determine characteristic, etc.), automobiles (e.g. driver assist systems, in-car infotainment systems, etc.), and/or any other product which includes a camera input.

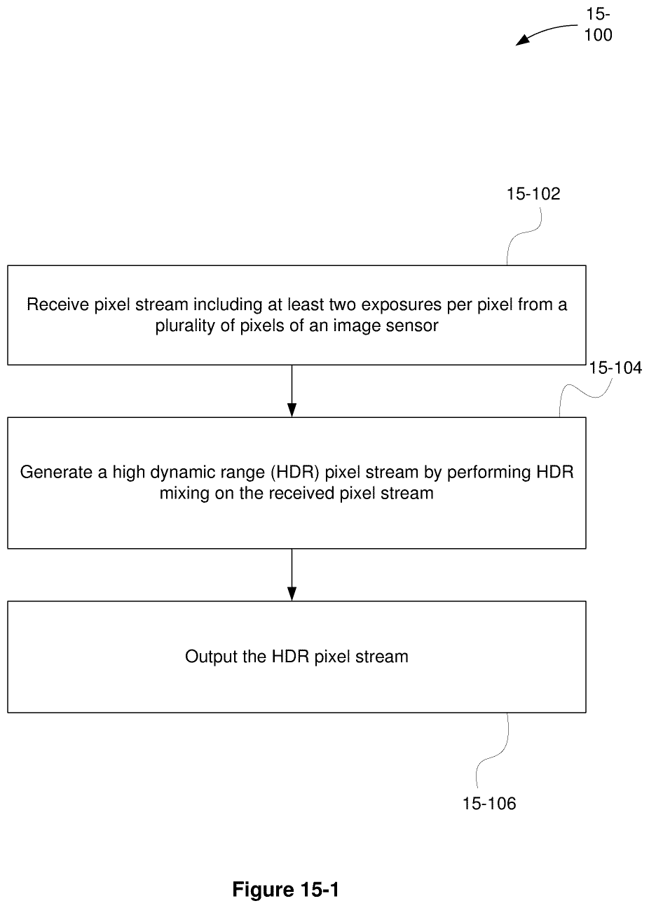

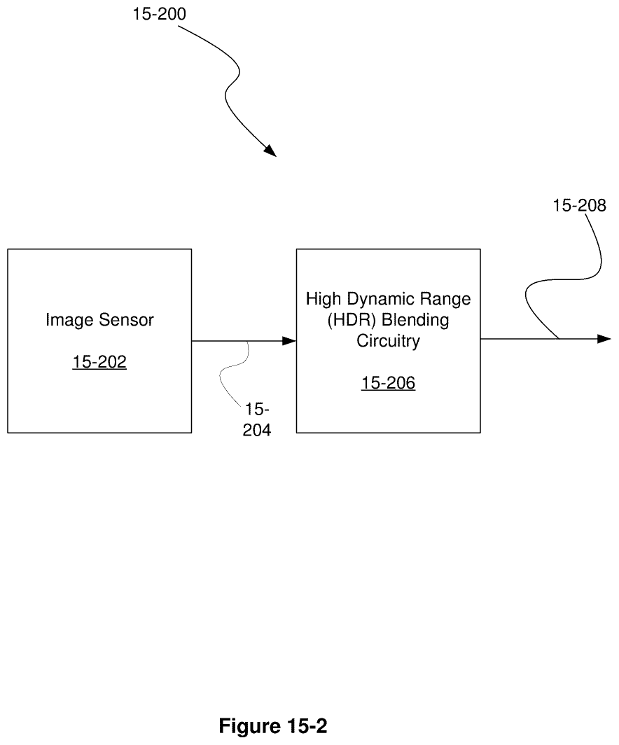

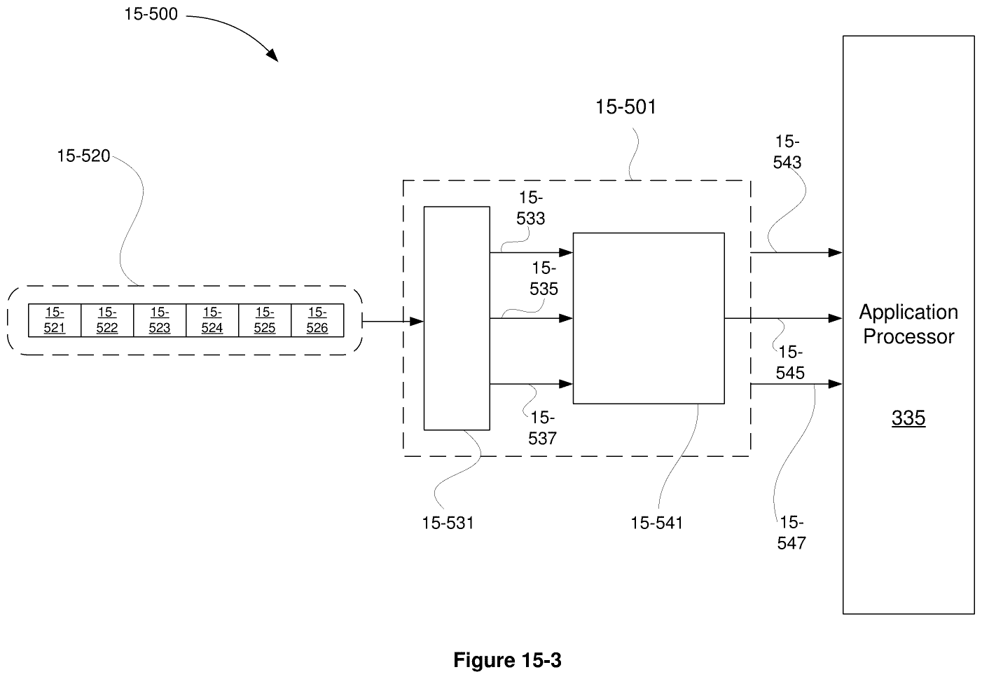

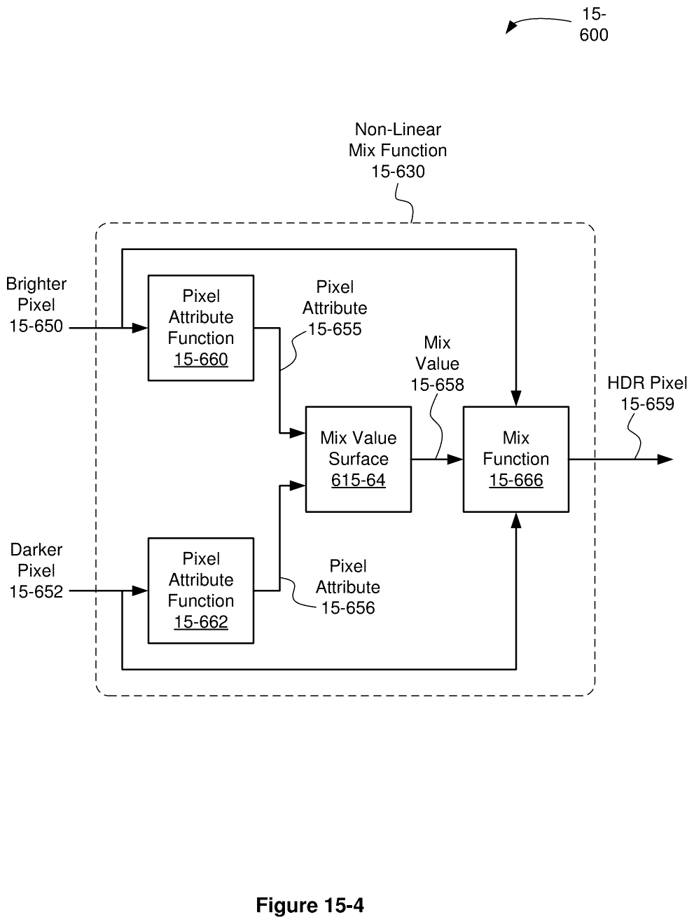

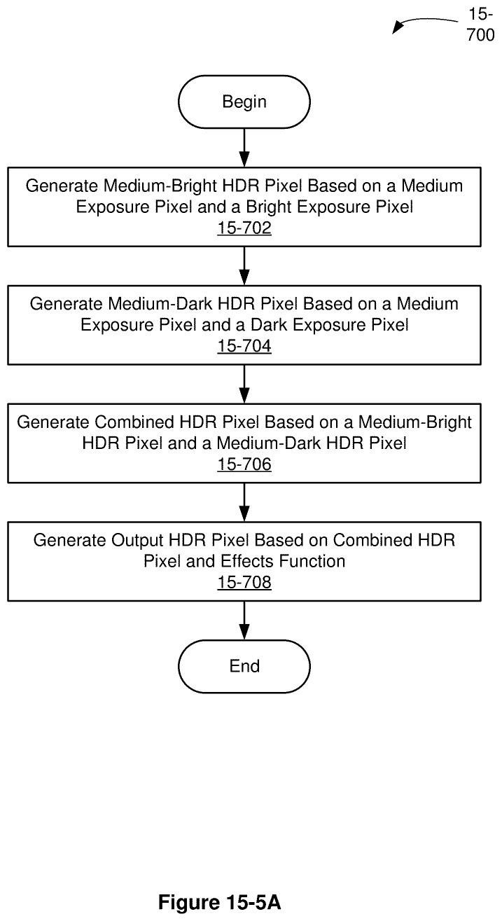

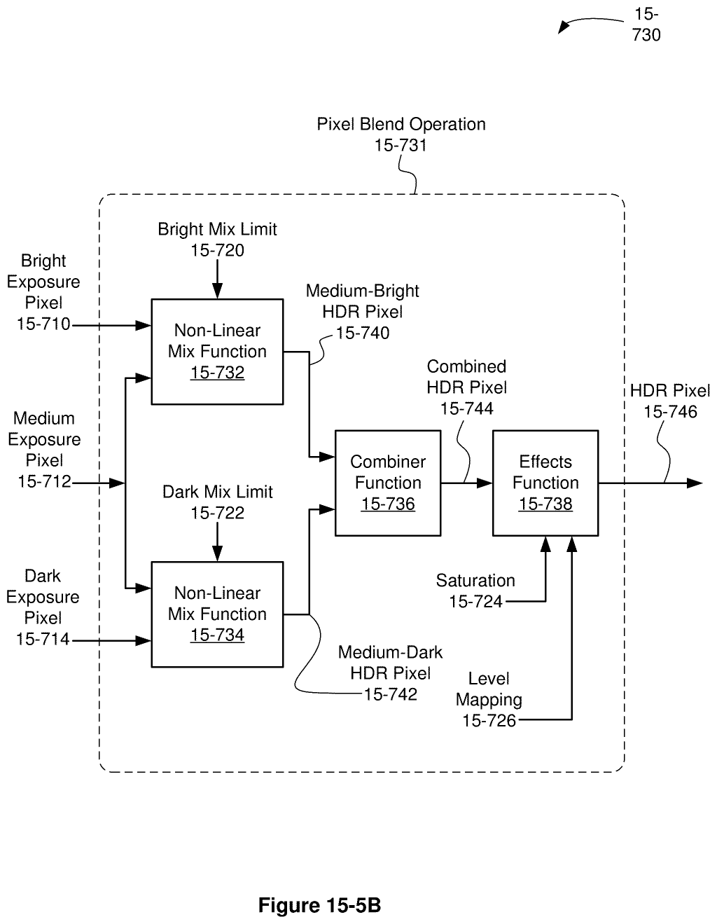

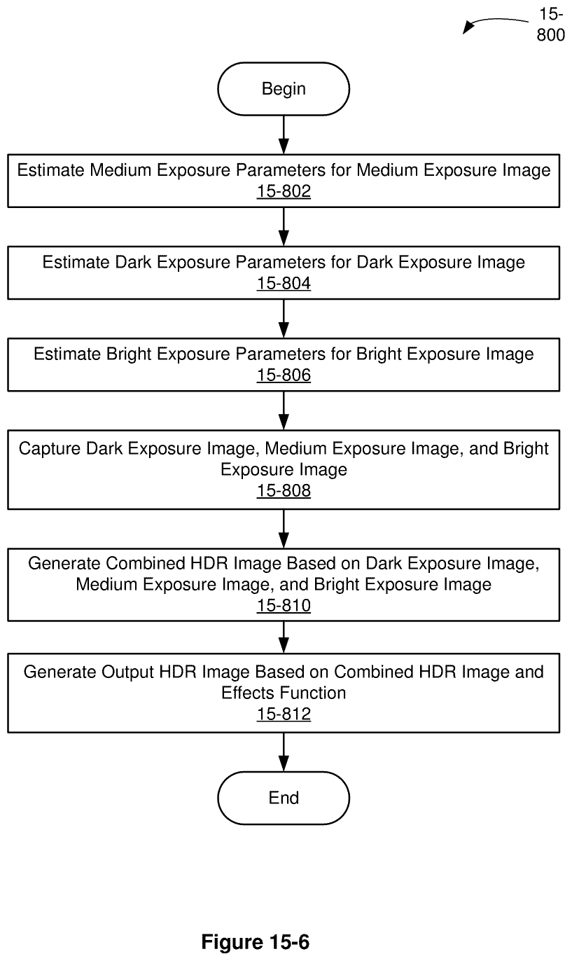

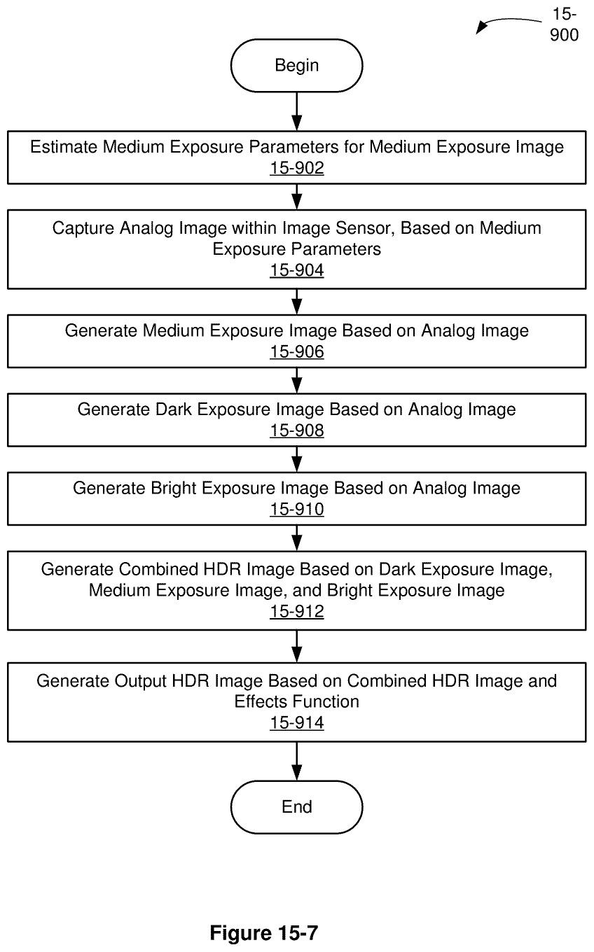

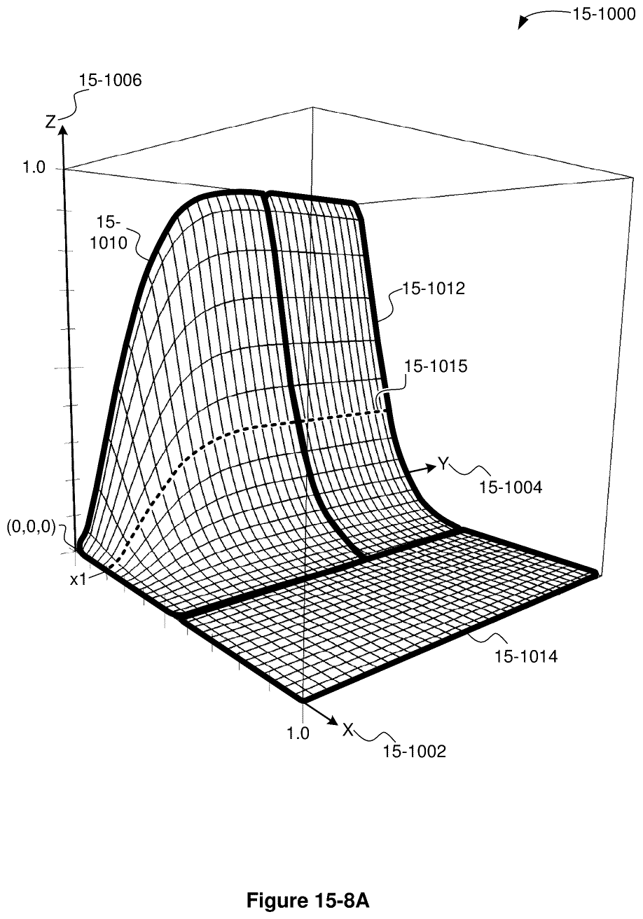

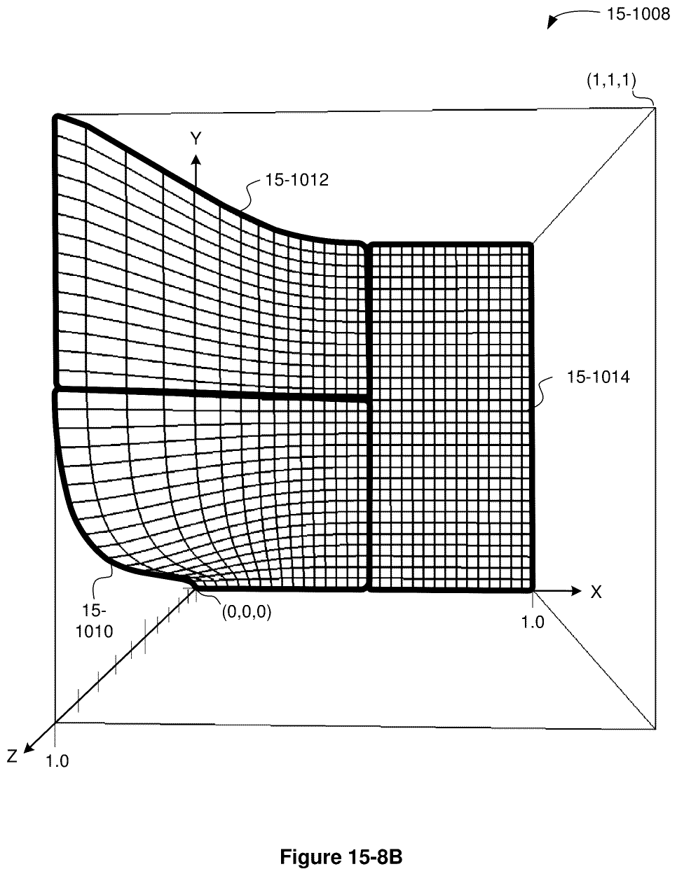

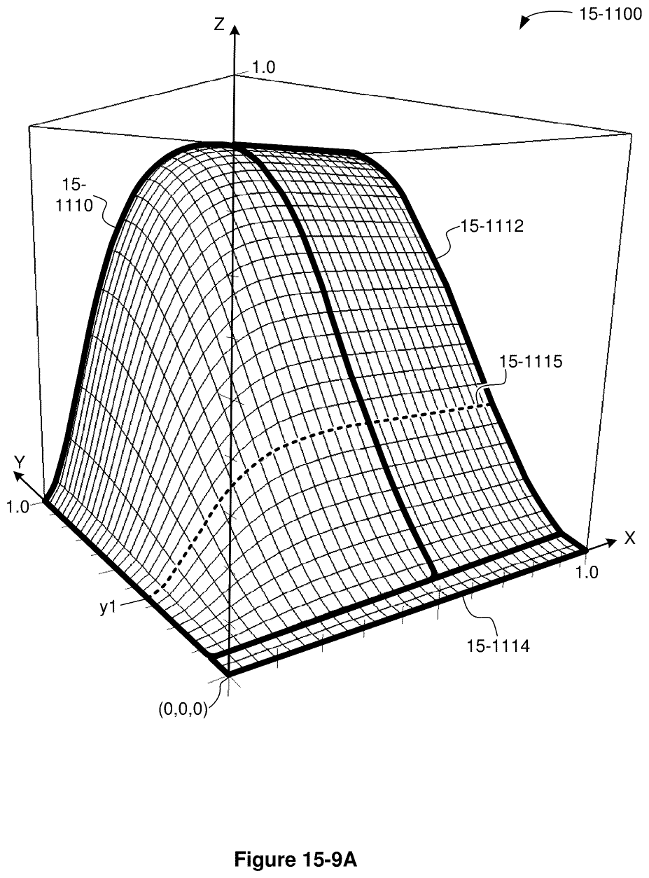

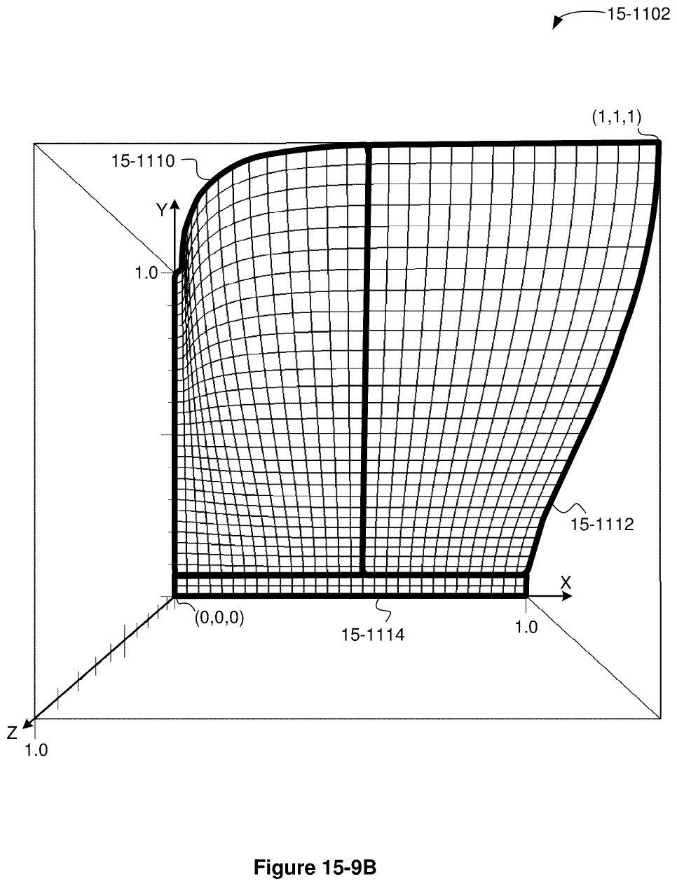

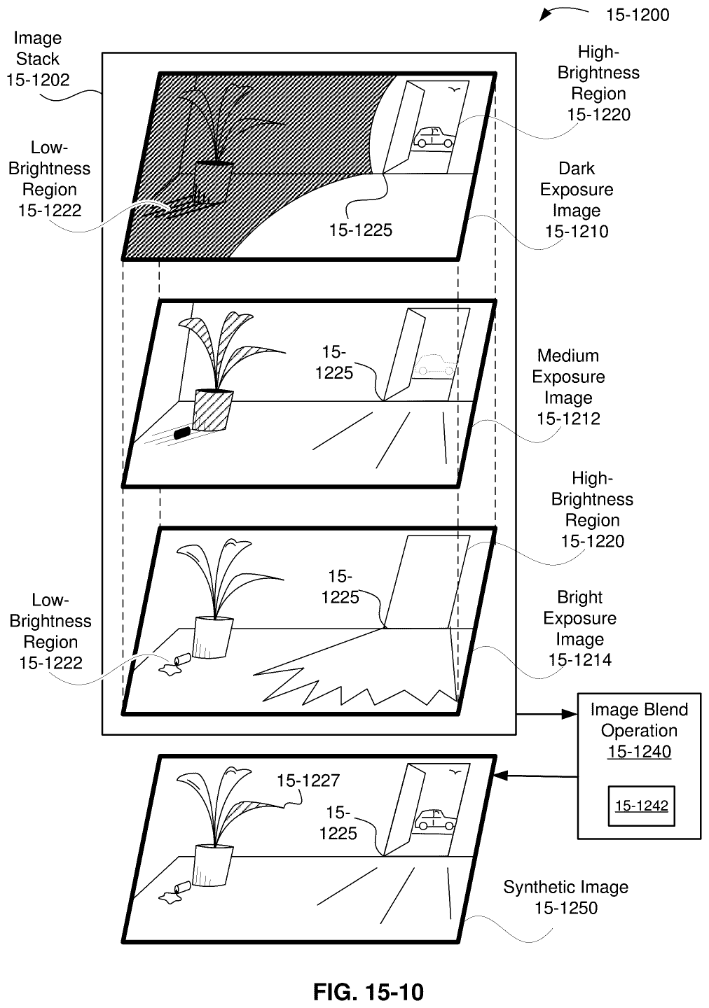

FIG. 15-1 illustrates an exemplary method 15-100 for generating a high dynamic range (HDR) pixel stream, in accordance with one possible embodiment. As an option, the method 15-100 may be carried out in the context of any of the Figures. Of course, however, the method 15-100 may be carried out in any desired environment. Further, the aforementioned definitions may equally apply to the description below.

As shown, at operation 15-102, a pixel stream is received, and the pixel stream includes at least two exposures per pixel of a plurality of pixels of the image sensor. In one embodiment, the pixel stream may be received directly from the image sensor. In another embodiment, the pixel stream may be received from a controller, where the controller first receives the pixel stream from an image sensor. In yet another embodiment, the pixel stream may be received from a camera module, or any other hardware component, which may first receive the pixel stream generated by an image sensor.

The pixel stream includes at least two exposures per pixel of a plurality of pixels of an image sensor. In one embodiment, the pixel stream includes a sequence of digital pixel data associated with the pixels of the image sensor. The sequence of digital pixel data may include, for each of the pixels, values representative of pixel attributes, such as brightness, intensity, color, etc. Each exposure of a given pixel may be associated with a different value for a given attribute, such as brightness, such that each of the exposures may include a unique attribute value. For example, in one embodiment, pixel data for a first exposure of a given pixel may include a first attribute value, pixel data for a third exposure of the pixel may include a third attribute value different than the first value, and pixel data for a second exposure of the pixel may include a second value between the first value and the third value. In one embodiment, each value may include a brightness value.

Further, the pixel stream may include at least two units of digital pixel data for each pixel, where each unit of digital pixel data is associated with a different exposure. Still further, a first unit of the digital pixel data for a pixel may be associated with a first set of digital pixel data, and a second unit of the digital pixel data for the pixel may be associated with a second set of digital pixel data. In such an embodiment, each set of digital pixel data may be associated with at least a portion of a digital image. For example, a first set of digital pixel data may be associated with a first digital image, and a second set of digital pixel data may be associated with a second digital image.

In on embodiment, each set of digital pixel data may be representative of an optical image of a photographic scene focused on an image sensor. For example, a first set of digital pixel data in the pixel stream may be representative of a first exposure of an optical image focused on an image sensor, and a second set of digital pixel data in the pixel stream may be representative of a second exposure of the optical image focused on the image sensor.

To this end, a pixel stream may include two sets of digital pixel data, where each set includes a corresponding unit of digital pixel data for a given pixel of an image sensor at a different exposure, such that the pixel stream includes digital pixel data for two different exposures of a same photographic scene image.

In one embodiment, the pixel stream may include a first set of digital pixel data interleaved with a second set of digital pixel data. For example, the pixel stream may include first digital pixel data for a first line of pixels, then second digital pixel data for the first line of pixels, then first digital pixel data for a second line of pixels, and then second digital pixel data for the second line of pixels, and so on. Of course, the pixel stream may include two or more sets of digital pixel data interleaved in any fashion. Still yet, the pixel stream may comprise two or more sets of digital pixel data organized in a non-interleaved fashion.

In one embodiment, the at least two exposures may be of the same photographic scene. For example, the at least two exposures may include a brighter exposure and a darker exposure of the same photographic scene. As another example, the at least two exposures may include each of the brighter exposure, the darker exposure, and a median exposure of the same photographic scene. The median exposure may be brighter than the darker exposure, but darker than the brighter exposure. In one embodiment, a brightness of an exposure may be controlled utilizing one or more exposure times. In another embodiment, a brightness of an exposure may be controlled utilizing one or more gains or one or more ISO values. Of course, a brightness of each exposure may be controlled utilizing any technically feasible technique.

In one embodiment, the image sensor may include a plurality of pixels arranged in a two-dimensional grid or array. Further, each of the pixels may include one or more cells, where each cell includes one or more photodiodes. Under the control of one or more control signals, each cell of the image sensor may measure or sample an amount of incident light focused on the photodiode of the cell, and store an analog value representative of the incident light sampled. In one embodiment, the analog values stored in the one or more cells of a pixel may be output in an analog signal, and the analog signal may then be amplified and/or converted to two or more digital signals, where each digital signal may be associated with a different effective exposure, as disclosed in U.S. patent application Ser. No. 14/534,079 (DUELP007/DL014), filed Nov. 5, 2014, entitled “IMAGE SENSOR APPARATUS AND METHOD FOR OBTAINING MULTIPLE EXPOSURES WITH ZERO INTERFRAME TIME,” now U.S. Pat. No. 9,137,455, which is incorporated by reference as though set forth in full. An analog signal may be a set of spatially discrete intensity samples, each represented by continuous analog values. Analog pixel data may be analog signal values associated with one or more given pixels.

In another embodiment, each cell of a pixel may store two or more analog values, where each of the analog values is obtained by sampling an exposure of incident light for a different sample time. The analog values stored in the one or more cells of a pixel may be output in two or more analog signals, and the analog signals may then be amplified and/or converted to two or more digital signals, where each digital signal may be associated with a different effective exposure, as disclosed in application Ser. No. 14/534,089 (DUELP008/DL015), filed Nov. 5, 2014, entitled “IMAGE SENSOR APPARATUS AND METHOD FOR SIMULTANEOUSLY CAPTURING MULTIPLE IMAGES” now U.S. Pat. No. 9,167,169; or application Ser. No. 14/535,274 (DUELP009/DL016), filed Nov. 6, 2014, entitled “IMAGE SENSOR APPARATUS AND METHOD FOR SIMULTANEOUSLY CAPTURING FLASH AND AMBIENT ILLUMINATED IMAGES;” now U.S. Pat. No. 9,154,708, or application Ser. No. 14/535,279 (DUELP010/DL017), filed Nov. 6, 2014, entitled “IMAGE SENSOR APPARATUS AND METHOD FOR OBTAINING LOW-NOISE, HIGH-SPEED CAPTURES OF A PHOTOGRAPHIC SCENE;” now U.S. Pat. No. 9,179,085, which are all incorporated by reference as though set forth in full.

To this end, the one or more digital signals may comprise a pixel stream including at least two exposures per pixel from a plurality of pixels of an image sensor.

Further, at operation 15-104, a high dynamic range (HDR) pixel stream is generated by performing HDR blending on the received pixel stream. In one embodiment, the HDR blending of the received pixel stream may generate a HDR pixel for each pixel of the plurality of pixels of the image sensor, and the HDR pixel may be based on the at least two exposures from the pixel. For example, a HDR blending operation may receive as input the at least two exposures of a pixel of the image sensor, and then blend the at least two exposures of the pixel to generate a HDR pixel. In a specific embodiment, the blending of the at least two exposures of the pixel may include a mix operation. In one embodiment, a generated HDR pixel for a given pixel may be output in a HDR pixel stream, and the HDR pixel stream also includes HDR pixels generated based on exposures received from neighboring pixels of the given pixel. Each HDR pixel may be based on at least two exposures received from an image sensor.

Finally, at operation 15-106, the HDR pixel stream is outputted. In one embodiment, the HDR pixel stream may be outputted as a sequence of individual HDR pixels. In another embodiment, the HDR pixel stream may be output to an application processor, which may then control storage and/or display of the HDR pixel stream. In yet another embodiment, the HDR pixel stream may be stored in associated with the pixel stream utilized to generate the HDR pixel stream. Storing the pixel stream in association with the HDR pixel stream may facilitate later retrieval of the pixel stream.

FIG. 15-2 illustrates a system 15-200 for generating a HDR pixel stream, in accordance with one embodiment. As an option, the system 15-200 may be implemented in the context of any of the Figures. Of course, however, the system 15-200 may be implemented in any desired environment. Further, the aforementioned definitions may equally apply to the description below.

As shown in FIG. 15-2, the system 15-200 includes a high dynamic range (HDR) blending circuitry 15-206 receiving a pixel stream 15-204 from an image sensor 15-202. Still further, the HDR blending circuitry 15-206 is shown to output a HDR pixel stream 15-208.

In one embodiment, the image sensor 15-202 may comprise a complementary metal oxide semiconductor (CMOS) image sensor, or charge-coupled device (CCD) image sensor, or any other technically feasible form of image sensor. In another embodiment, the image sensor 15-202 may include a plurality of pixels arranged in a two-dimensional array or plane on a surface of the image sensor 15-202.

In another embodiment, an optical image focused on the image sensor 15-202 may result in a plurality of analog values being stored and output as an analog signal that includes at least one analog value for each pixel of the image sensor. The analog signal may be amplified to generate two or more amplified analog signals utilizing two or more gains. In such an embodiment, a digital signal may then be generated based on each amplified analog signal, such that two or more digital signals are generated. In various embodiments, the two or more digital signals may comprise the pixel stream 15-204.

In yet another embodiment, a first set of analog values may be output as a first analog signal that includes at least one analog value for each pixel of the image sensor, and a second set of analog values may be output as a second analog signal that includes at least one analog value for each pixel of the image sensor. In such an embodiment, each analog signal may subsequently be processed and converted to one or more digital signals, such that two or more digital signals are generated. In various embodiments, the two or more digital signals may comprise the pixel stream 15-204.

Accordingly, in one embodiment, the pixel stream 15-204 generated by the image sensor 15-202 may include at least two electronic representations of an optical image that has been focused on the image sensor 15-202. Further, each electronic representation of the optical image may include digital pixel data generated utilizing one or more analog signals.

In one embodiment, the HDR blending circuitry 15-206 may include any hardware component or circuitry operable to receive a pixel stream and generate a HDR pixel stream based on the content of the received pixel stream. As noted above, the pixel stream may include multiple instances of digital pixel data. For example, the pixel stream may include first digital pixel data from a first exposure of a photographic scene and second digital pixel data from a second exposure of the photographic scene. The first exposure and the second exposure may vary based on exposure or sample timing, gain application or amplification, or any other exposure parameter that may result in a first exposure of a photographic scene and a second exposure of the photographic scene that is different than the first exposure.

Additionally, the HDR blending circuitry 15-206 may perform any blending operation on the pixel stream 15-204 that is operative to generate HDR pixel stream 15-208. In one embodiment, a blending operation of the HDR blending circuitry 15-206 may include blending two exposures received from a pixel of the image sensor 15-202. In another embodiment, a blending operation of the HDR blending circuitry 15-206 may include blending three or more exposures received from a pixel of the image sensor 15-202. For example, the HDR blending circuitry 15-206 may perform a blending of the exposures received in the pixel stream according to the blending operations and methods taught in U.S. patent application Ser. No. 14/534,068 (DUELP005/DL011), filed Nov. 5, 2014, entitled “SYSTEMS AND METHODS FOR HIGH-DYNAMIC RANGE IMAGES,” now U.S. Pat. No. 9,167,174, which is incorporated by reference as though set forth in full.

Finally, HDR pixel stream 15-208 is output from the HDR blending circuitry 15-206. In one embodiment, the HDR pixel stream 15-208 output from the HDR blending circuitry 15-206 may include any stream comprising one or more HDR pixels of one or more HDR images. For example, the HDR pixel stream 15-208 may include HDR pixels of a portion of a HDR image, an entirety of a HDR image, or more than one HDR image, such as multiple frames of a HDR video.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 15-3 illustrates a system 15-500 for receiving a pixel stream and outputting an HDR pixel stream, in accordance with an embodiment. As an option, the system 15-500 may be implemented in the context of any of the Figures. Of course, however, the system 15-500 may be implemented in any desired environment. Further, the aforementioned definitions may equally apply to the description below.

As shown, the system 15-500 includes a blending circuitry 15-501 receiving a pixel stream 15-520, and outputting at least one instance of a HDR pixel data 15-545 to an application processor 335. The blending circuitry 15-501 is shown to include a buffer 15-531 and a HDR pixel generator 15-541. In one embodiment, the pixel stream 15-520 may be received from an image sensor, such as the image sensor 332 of FIG. 15-3G. For example, the pixel stream 15-520 may be received from an interface of the image sensor 332. In another embodiment, the pixel stream 15-520 may be received from a controller, such as the controller 333 of FIG. 15-3G. For example, the pixel stream 15-520 may be received from an interface of the controller 333. The application processor 335 of FIG. 15-3 may be substantially identical to the application processor 335 of FIG. 15-3G. Accordingly, the blending circuitry 15-501 may be operative to intercept a signal comprising the pixel data 15-520 as the pixel data 15-520 is being transmitted from an image sensor to the application processor 335.

As illustrated in FIG. 15-3, the pixel stream 15-520 is shown to include digital pixel data units 521-526. Each of the digital pixel data units 521-526 may comprise digital pixel data for one or more pixels of an image sensor. In one embodiment, each of the digital pixel data units 521-526 may include digital pixel data representative of light measured or sampled at a single pixel of an image sensor. In another embodiment, each of the digital pixel data units 521-526 may comprise digital pixel data for more than one pixel of an image sensor, such as for a line of pixels of an image sensor. In yet another embodiment, each of the digital pixel data units 521-526 may comprise digital pixel data for a frame of pixels of an image sensor.

In the various embodiments, the digital pixel data units 521-526 may be interleaved by pixel, line, or frame from of the image sensor. For example, in one embodiment, the pixel stream 15-520 may be output such that it includes digital pixel data for multiple pixels in a sequence at a first exposure, and then includes digital pixel data for the multiple pixels in the sequence at a second exposure. The multiple pixels in the sequence may comprise at least a portion of a line of pixels of an image sensor. In another embodiment, the pixel stream 15-520 may be output such that it includes digital pixel data comprising a sequence of different exposures of a single pixel, and then a sequence of different exposures of another single pixel.

As an example, in an embodiment where the pixel stream 15-520 includes two exposures per pixel of a plurality of pixels of an image sensor, a digital pixel data unit 15-521 may include first digital pixel data for a first pixel of the image sensor, a digital pixel data unit 15-522 may include second digital pixel data for the first pixel of the image sensor, a digital pixel data unit 15-523 may include first digital pixel data for a second pixel of the image sensor, a digital pixel data unit 15-524 may include second digital pixel data for the second pixel of the image sensor, a digital pixel data unit 15-525 may include first digital pixel data for a third pixel of the image sensor, and a digital pixel data unit 15-526 may include second digital pixel data for the third pixel of the image sensor. In such an example, each set of digital pixel data may be associated with a different exposure, such that each first digital pixel data is associated with a first exposure, and each second digital pixel data is associated with a second exposure different than the first exposure.

As another example, in an embodiment where the pixel stream 15-520 includes three exposures per pixel of a plurality of pixels of an image sensor, a digital pixel data unit 15-521 may include first digital pixel data for a first pixel of the image sensor, a digital pixel data unit 15-522 may include second digital pixel data for the first pixel of the image sensor, a digital pixel data unit 15-523 may include third digital pixel data for the first pixel of the image sensor, a digital pixel data unit 15-524 may include first digital pixel data for a second pixel of the image sensor, a digital pixel data unit 15-525 may include second digital pixel data for second pixel of the image sensor, and a digital pixel data unit 15-526 may include third digital pixel data for the second pixel of the image sensor. In such an example, each set of digital pixel data may be associated with a different exposure, such that each first digital pixel data is associated with a first exposure, each second digital pixel data is associated with a second exposure different than the first exposure, and each third digital pixel data is associated with a third exposure different than the first exposure and the second exposure.

As yet another example, in an embodiment where the pixel stream 15-520 includes two exposures per pixel of a plurality of pixels of an image sensor, and the pixel stream 15-520 is interleaved by groups of pixels, a digital pixel data unit 15-521 may include first digital pixel data for a first plurality of pixels of the image sensor, a digital pixel data unit 15-522 may include second digital pixel data for the first plurality of pixels of the image sensor, a digital pixel data unit 15-523 may include first digital pixel data for a second plurality of pixels of the image sensor, a digital pixel data unit 15-524 may include second digital pixel data for the second plurality of pixels of the image sensor, a digital pixel data unit 15-525 may include first digital pixel data for a third plurality of pixels of the image sensor, and a digital pixel data unit 15-526 may include second digital pixel data for the third plurality of pixels of the image sensor. In such an example, each plurality of pixels may include a line of pixels, such that the first plurality of pixels comprise a first line of pixels, the second plurality of pixels comprises a second line of pixels, and the third plurality of pixels comprises a third line of pixels. Further, each set of digital pixel data may be associated with a different exposure, such that each first digital pixel data is associated with a first exposure, and each second digital pixel data is associated with a second exposure different than the first exposure.

As still another example, in an embodiment where the pixel stream 15-520 includes three exposures per pixel of a plurality of pixels of an image sensor, and the pixel stream 15-520 is interleaved by groups of pixels, a digital pixel data unit 15-521 may include first digital pixel data for a first plurality of pixels of the image sensor, a digital pixel data unit 15-522 may include second digital pixel data for the first plurality of pixels of the image sensor, a digital pixel data unit 15-523 may include third digital pixel data for the first plurality of pixels of the image sensor, a digital pixel data unit 15-524 may include first digital pixel data for a second plurality of pixels of the image sensor, a digital pixel data unit 15-525 may include second digital pixel data for the second plurality of pixels of the image sensor, and digital pixel data unit 15-526 may include third digital pixel data for the second plurality of pixels of the image sensor. In such an example, each plurality of pixels may include a line of pixels, such that the first plurality of pixels comprises a first line of pixels, and the second plurality of pixels comprises a second line of pixels. Further, each set of digital pixel data may be associated with a different exposure, such that each first digital pixel data is associated with a first exposure, each second digital pixel data is associated with a second exposure different than the first exposure, and each third digital pixel data is associated with a third exposure different than the first exposure and the second exposure.

As shown in FIG. 15-3, the buffer 15-531 of the blending circuitry 15-501 is operative to receive the pixel stream 15-520. In one embodiment, the buffer 15-531 is operative to de-interleave the pixel stream. In another embodiment, the buffer 15-531 may be operative to identify each exposure of a particular pixel of the image sensor. For example, for a given pixel of a plurality of pixels of an image sensor, the buffer 15-531 may identify at least two different exposures of the pixel. More specifically, the buffer 15-531 may identify a first exposure of the pixel from a first unit of digital pixel data, and identify a second exposure of the pixel from a second unit of digital pixel data. Similarly, in embodiments including three exposures per pixel, the buffer 15-531 may identify a first exposure of the pixel from a first unit of digital pixel data, identify a second exposure of the pixel from a second unit of digital pixel data, and identify a third exposure of the pixel from a third unit of digital pixel data. To this end, the buffer may identify at least two exposures of a single pixel of a pixel array of an image sensor.

In an embodiment in which lines are interleaved in the pixel stream 15-520, the buffer 15-531 may receive two or more digital pixel data units of a same line, where each digital pixel data unit is associated with a different exposure of the line. Further, the buffer 15-531 may then identify and select pixel data at each exposure for a given pixel in the line. In such an embodiment, pixel data that is not associated with the given pixel may be temporarily stored. Further, pixel data that is temporarily stored may be utilized for identifying and selecting pixel data at each of the exposures for another given pixel in the line. This process of pixel data storage and pixel data retrieval may repeat for each pixel in the line.

As used herein, pixel data for a pixel may describe a set of components of a color space, such as red, green, and blue in RGB color space; or cyan, magenta, yellow, and black, in CMYK color space. Further, an intensity of each of the color components may be variable, and may be described using one or more values for each component. Thus, in one embodiment, pixel data for a given exposure of a pixel may include the one or more values for the color components of the pixel at the given exposure. Further, the one or more values for the color components of a pixel may be utilized to calculate various attributes of the pixel in addition to color, such as, for example, saturation, brightness, hue, luminance, etc.

After identifying at least two exposures of a given pixel, the buffer 15-531 may then output first exposure pixel data 15-533 for the given pixel, second exposure pixel data 15-535 for the given pixel, and third exposure pixel data 15-537 for the given pixel. As shown in FIG. 15-3, each of the first exposure pixel data 15-533, the second exposure pixel data 15-535, and the third exposure pixel data 15-537 are output from the buffer 15-531 to the HDR pixel generator 15-541. Of course, in other embodiments, a buffer 15-531 may output, to a HDR pixel generator 15-541, pixel data for only two exposures of the pixel, or for more than three exposures of the pixel.

The buffer 15-531 may be operative to identify pixel data of the two or more exposures of a given pixel in a line while saving received digital pixel data for remaining pixels of the line, as well as other lines, for subsequent processing. For example, if the buffer 15-531 receives first pixel data for a given line, second pixel data for the given line, and third pixel data for the given line, where each of the units of pixel data corresponds to a different exposure of the given line, the buffer 15-531 may be operative to identify a portion of pixel data associated with a first pixel in each of the received pixel data units. For example, the buffer 15-531 may identify a first exposure of the pixel, a second exposure of the pixel, and a third exposure of the pixel. Further, the buffer 15-531 may be operative to store unselected pixel data received in each unit of pixel data, and subsequently identify pixel data associated with a second pixel in each of the received pixel data units. For example, the buffer 15-531 may identify a first exposure of a second pixel adjacent to the first pixel, a second exposure of the second pixel, and a third exposure of the second pixel. To this end, the buffer 15-531 may be operative to identify each exposure of a plurality of exposures of each of the pixels of a line.

Referring again to FIG. 15-3, the buffer 15-531 is shown to output each of the first exposure pixel data 15-533, the second exposure pixel data 15-535, and the third exposure pixel data 15-537 to the HDR pixel generator 15-541. As noted above, each of the first exposure pixel data 15-533, the second exposure pixel data 15-535, and the third exposure pixel data 15-537 may comprise pixel data for different exposures of the same pixel.

In one embodiment, each exposure of a pixel may be characterized as having an exposure value (EV). In such an embodiment, an exposure of the pixel may be characterized as being obtained at exposure value 0 (EV0), wherein the EV0 exposure is characterized as being captured utilizing a first collection of capture parameters. Such capture parameters may include ISO or light sensitivity, aperture, shutter speed or sampling time, or any other parameter associated with image capture that may be controlled or modulated. The pixel characterized as captured at EV0 may be captured using a particular combination of capture parameters, such as a particular ISO and a particular shutter speed.

Further, an exposure of another capture or sample of the pixel may be selected based on the capture parameters of the EV0 pixel. More specifically, the other capture or sample of the pixel may be selected to have an increased or decreased exposure in comparison to the exposure of the EV0 pixel. For example, an ISO capture parameter of the other sample of the pixel may be selected such that the exposure is increased or decreased with respect to the exposure of the EV0 pixel. Still yet, an exposure time capture parameter of the other sample of the pixel may be selected such that the exposure time is increased or decreased with respect to the exposure time of the EV0 pixel. As a specific example, the other sample of the pixel may be captured at an increased exposure when it is captured using a faster ISO and the same exposure time, or using a greater exposure time at the same ISO, with respect to the EV0 pixel. In such an embodiment, the other capture or exposure of the pixel may be referred to as an EV+exposure, or an EV+ pixel. Similarly, the other sample of the pixel may be captured at a decreased exposure when it is captured using a slower ISO and the same exposure time, or using a reduced exposure time at the same ISO, with respect to the EV0 pixel. In such an embodiment, the other capture or exposure of the pixel may be referred to as an EV− exposure, or an EV− pixel.

In some embodiments, different exposures of a given pixel may be controlled based on an ISO value associated with the pixel during or following a capture operation, where the ISO value may be mapped to one or more gains that may be applied to an analog signal output from an image sensor during the capture operation. Such embodiments are described in more depth in U.S. patent application Ser. No. 14/534,079 (DUELP007/DL014), filed Nov. 5, 2014, entitled “IMAGE SENSOR APPARATUS AND METHOD FOR OBTAINING MULTIPLE EXPOSURES WITH ZERO INTERFRAME TIME,” now U.S. Pat. No. 9,137,455, which is incorporated herein as though set forth in full.

In yet other embodiments, different exposures of a given pixel may be obtained by controlling exposure times for two or more sampling operations that occur simultaneously or concurrently at the pixel. Such embodiments are described in more depth in application Ser. No. 14/534,089 (DUELP008/DL015), filed Nov. 5, 2014, entitled “IMAGE SENSOR APPARATUS AND METHOD FOR SIMULTANEOUSLY CAPTURING MULTIPLE IMAGES”; now U.S. Pat. No. 9,167,169, or application Ser. No. 14/535,274 (DUELP009/DL016), filed Nov. 6, 2014, entitled “IMAGE SENSOR APPARATUS AND METHOD FOR SIMULTANEOUSLY CAPTURING FLASH AND AMBIENT ILLUMINATED IMAGES;” now U.S. Pat. No. 9,154,708, or application Ser. No. 14/535,279 (DUELP010/DL017), filed Nov. 6, 2014, entitled “IMAGE SENSOR APPARATUS AND METHOD FOR OBTAINING LOW-NOISE, HIGH-SPEED CAPTURES OF A PHOTOGRAPHIC SCENE;” now U.S. Pat. No. 9,179,085, which are incorporated herein as though set forth in full.

In some embodiments, a first exposure pixel data 15-533 may include pixel data for an EV− exposure of a given pixel, a second exposure pixel data 15-535 may include pixel data for an EV0 exposure of the pixel, and a third exposure pixel data 15-537 may include pixel data for an EV+exposure of the pixel. Of course, any of the pixel data 533-537 may include pixel data for any exposure of the pixel. To this end, pixel data for three different exposures of a same pixel are shown provided by the buffer 15-531 to the HDR pixel generator 15-541 in FIG. 15-3.

In other embodiments, an HDR pixel generator 15-541 may receive a different number of exposures of a given pixel. For example, in one embodiment, the HDR pixel generator 15-541 may receive pixel data for two exposures of a given pixel. As options, in such an embodiment, the HDR pixel generator 15-541 may receive data for an EV− exposure and an EV0 exposure of a given pixel, or an EV0 exposure and an EV+exposure of a given pixel.

After receiving each of the first exposure pixel data 15-533, the second exposure pixel data 15-535, and the third exposure pixel data 15-537, the HDR pixel generator 15-541 may then perform a blend operation on the three instances of pixel data and output HDR pixel data 15-545. As noted previously, in one embodiment the blend operation performed to generate the HDR pixel data 15-545 may be any of the blend operations discussed within U.S. patent application Ser. No. 14/534,068 (DUELP005/DL011), filed Nov. 5, 2014, entitled “SYSTEMS AND METHODS FOR HIGH-DYNAMIC RANGE IMAGES,” now U.S. Pat. No. 9,167,174, the contents of which are hereby incorporated as if set forth in full.

To this end, the HDR pixel generator 15-541 may be operative to generate HDR pixel data 15-545 for an HDR pixel utilizing only pixel data from multiple exposures of a given pixel of an image sensor. Thus, the HDR pixel generator 15-541 does not require pixel data of additional pixels of the image sensor that neighbor the given pixel, and may perform an operation utilizing only two or more exposures of a single pixel. Further, because each of the two or more exposures of a given pixel may be generated in a manner with zero, or near zero, interframe time, the two or more exposures of the pixel may be used to generate the HDR pixel without performing an alignment step. In other words, pixel stream 15-520 may inherently include pre-aligned pixel data, which may be used by the blending circuitry 15-501 to generate HDR pixels.

To this end, using relatively low-power resources, a stream of HDR pixels may be rapidly generated and output based on an input stream of pixel data. For example, the stream of HDR pixels may be generated as the stream of pixel data is in transit from an image sensor. Further, the stream of HDR pixels may be generated without use of a graphics processing unit (GPU), which may allow for disabling at least a portion of the GPU, or for use of the GPU to perform other processing tasks. Such processing tasks may include performing dehazing operations or contrast enhancement on the HDR pixel stream.

Still further, in addition to outputting the HDR pixel data 15-545, the blending circuitry 15-501 may also output a first received pixel data 15-534 and a second received pixel data 15-547. In one embodiment, the first received pixel data 15-534 may comprise one of the first exposure pixel data 15-533, the second exposure pixel data 15-535, and the third exposure pixel data 15-537. In such an embodiment, the second received pixel data 15-547 may comprise another one of the first exposure pixel data 15-533, the second exposure pixel data 15-535, and the third exposure pixel data 15-537.

For example, the first received pixel data 15-534 may comprise the first exposure pixel data 15-533, and the second received pixel data 15-547 may comprise the third exposure pixel data 15-537. As noted previously, the first exposure pixel data 15-533 may include pixel data for an EV− exposure of a given pixel, and the third exposure pixel data 15-537 may include pixel data for an EV+exposure of the given pixel. Thus, in such an example, the first received pixel data 15-534 may include pixel data for the EV− exposure of the given pixel, and the second received pixel data 15-547 may include pixel data for the EV+exposure of the given pixel. To this end, in addition to outputting the HDR pixel data 15-545, the blending circuitry 15-501 may also output various instances of the pixel data utilized to generate the HDR pixel data 15-545. For example, the blending circuitry 15-501 may output for a pixel each of an EV+exposure of the pixel, an EV− exposure of the pixel, and an HDR pixel.

Of course, in other embodiments, the blending circuitry 15-501 may output an EV0 exposure of a pixel as either the first received pixel data 15-534 or the second received pixel data 15-547, such that the EV0 exposure of a pixel is output with the HDR pixel for subsequent processing and/or storage. In one embodiment, any output exposures of the pixel may be stored with the HDR pixel in flash storage. In some embodiments, it may be useful to retain one or more exposures of the pixel that were used to generate the HDR pixel. For example, the one or more exposures of the pixel used to generate the HDR pixel may be used in subsequent HDR processing, for generating a non-HDR image, or in any other technically feasible manner.

Still further, after outputting the HDR pixel data 15-545, which was generated utilizing pixel data for multiple exposures of a first pixel, the blending circuit 15-501 may output second HDR pixel data for a second HDR pixel. The second HDR pixel data may be generated by the HDR pixel generator 15-541 utilizing pixel data for multiple exposures of a second pixel. The second pixel may be a neighboring pixel of the first pixel. For example, the second pixel may be adjacent to the first pixel in a row or line of pixels of an image sensor. Still further, after outputting the second HDR pixel data, the blending circuit 15-501 may output a third HDR pixel. The third HDR pixel may be generated by the HDR pixel generator 15-541 utilizing pixel data for multiple exposures of a third pixel. The third pixel may be a neighboring pixel of the second pixel. For example, the third pixel may be adjacent to the second pixel in the row or line of pixels of the image sensor. Still further, along with each of the second HDR pixel and the third HDR pixel, the blending circuit 15-501 may also output received pixel data utilized to generate, respectively, the second HDR pixel and the third HDR pixel.

The blending circuitry 15-501 may be operative to output a stream of pixel data for HDR pixels of an HDR image, where each of the HDR pixels is generated based on a respective pixel of an image sensor. Further still, with each output HDR pixel, the pixel data from corresponding the two or more exposures of the pixel may also be output. Thus, an HDR pixel may be output with the pixel data utilized to generate the HDR pixel.

Additionally, because the blending circuitry 15-501 may be operative to continuously process the pixel data of the pixel stream 15-520 as the pixel stream 15-520 is received, the pixel stream 15-520 may be received from an image sensor that is capturing and transmitting pixel data at a rate of multiple frames per second. In such an embodiment, digital pixel data units 521-526 may include pixel data for pixels or lines of a frame of video output by an image sensor. To this end, the blending circuitry 15-501 may be operative to receive pixels for a frame of video at two or more exposures, and generate HDR pixels for the frame of video utilizing the received pixels. Further, the blending circuitry 15-501 may be operative to receive pixels for the frame of video at the two or more exposures and generate HDR pixels for the frame as additional digital pixel data is received in the pixel stream 15-520 for one or more other frames of the video. In one embodiment, one or more pixels of a second frame of video may be buffered by a buffer 15-531 as a HDR pixel generator 15-541 outputs HDR pixels for a first frame of the video.

As shown in FIG. 15-3, the blending circuitry 15-501 may be a discrete component that exists along one or more electrical interconnects between an image sensor and an application processor 335. In one embodiment, the pixel stream 15-520 may be received by the blending circuit 15-501 on a single electrical interconnect. In other embodiments, the pixel stream 15-520 may be received by the blending circuitry 15-501 along two or more electrical interconnects. Such an implementation may allow for concurrent receipt of multiple instances of pixel data at the blending circuitry 15-501. In one embodiment, a first received pixel data 15-534, a second received pixel data 15-547, and a HDR pixel data 15-545 may be output to an application processor 335 along a single electrical interconnect. In other embodiments, a first received pixel data 15-534, a second received pixel data 15-547, and a HDR pixel data 15-545 may be output to an application processor 335 along two or more electrical interconnects. Such an implementation may allow for concurrent receipt of multiple instances of pixel data at the application processor 335.

To this end, the blending circuitry 15-501 may be operative to receive pixels for a frame of video at two or more exposures, and generate HDR pixels for the frame of video utilizing the received pixels. Further, the blending circuitry 15-501 may be operative to receive pixels for the frame of video at the two or more exposures and generate HDR pixels for the frame as additional digital pixel data is received in the pixel stream 15-520 for one or more other frames of the video.

As noted above, blending circuitry 15-501 may be operative to continuously process pixel data of a pixel stream 15-520 as the pixel stream 15-520 is received, such that a stream of HDR pixels is output from the blending circuitry 15-501. In such an embodiment, first received pixel data 15-534 may be included in a stream of pixel data associated with a first exposure, and second received pixel data 15-547 may be included in a stream of pixel data associated with a second exposure. Thus, in one embodiment, in addition to outputting a stream of HDR pixels, the blending circuitry 15-501 may also output at least one stream of pixel data utilized to generate the HDR pixels. For example, the blending circuitry may output a stream of EV0 pixel data utilized to generate the HDR pixels, a stream of EV− pixel data utilized to generate the HDR pixels, and/or a stream of EV+ pixel data utilized to generate the HDR pixels.

In one embodiment, sets of pixel data may be saved separately. For example, a stream of EV0 pixel data may be used to generate a stream of HDR pixels at the blending circuitry 15-501, and then the stream of EV0 pixels may stored separately from the stream of HDR pixels. Similarly, a stream of EV− or EV+ pixels may be stored separately from the HDR pixels. To this end, a stored stream of HDR pixels may comprise a HDR video, a stored stream of EV0 pixels may comprise the same video captured at EV0, and a stored stream of EV+ or EV− pixels may comprise the same video captured at EV+ or EV−, respectively.

In another embodiment, an application processor 335 may generate a residue image utilizing two or more received pixel streams. For example, the application processor 335 may receive a stream of HDR pixels from the blending circuitry 15-501, as well as one or more streams of received pixel data from the blending circuitry 15-501. Each of the one or more streams of received pixel data may include an EV0, EV+, or EV− pixel stream. The application processor 335 may be operative to perform a compare operation that compares the received stream of HDR pixels with one or more of the EV0, EV+, or EV− pixel stream to generate the residue image. For example, the application processor 335 may compare a given pixel within the HDR pixel stream with the given pixel within the EV0 pixel stream to generate a difference or scaling value, and then store the difference or scaling value. The application processor 335 may generate a plurality of difference values or scaling values for a plurality of corresponding pixels between the HDR pixel stream and the EV0 pixel stream. The plurality of difference values or scaling values may then be stored as a residue image. Of course, comparing any of the EV+, EV0, and EV− pixel streams with the HDR pixel stream may work equally well to generate difference values or scaling values.

Further, one or more generated residue images may then be stored in association with the HDR pixel stream. In such an embodiment, one or more of the EV0, EV−, or EV+ pixel streams may be discarded. Storing residue images in lieu of the one or more discarded EV0, EV−, or EV+ pixel streams may utilize less storage space. For example, a discarded EV− pixel stream may be subsequently reconstructed utilizing an associated HDR pixel stream, an associated EV0 pixel stream, and/or an associated EV+ pixel stream in conjunction with residue images previously generated utilizing the discarded EV− pixel stream. In such an embodiment, storage of the residue images may require substantially less storage capacity than storage of the EV− pixel stream.

In another embodiment, blending circuitry may be included in an application processor 335. In certain embodiments, blending circuitry includes histogram accumulation circuitry for implementing level mapping, such as contrast-limited adaptive histogram equalization (CLAHE). In such embodiments, the accumulation circuitry generates a cumulative distribution function (CDF) operative to perform localized level mapping. To this end, localized contrast enhancement may be implemented, for example by the either the blending circuitry or the application processor 335 based on the CDF.

FIG. 15-4 shows a system 15-600 for outputting a HDR pixel, in accordance with one embodiment. As an option, the system 15-600 may be implemented in the context of any of the Figures. Of course, however, the system 15-600 may be carried out in any desired environment. Further, the aforementioned definitions may equally apply to the description below.

As shown, the system 15-600 includes a non-linear mix function 15-630. In one embodiment, the non-linear mix function 15-630 includes receiving a brighter pixel 15-650 and a darker pixel 15-652. In one embodiment, the brighter pixel 15-650 and the darker pixel 15-652 may be blended via a mix function 15-666, resulting in a HDR pixel 15-659.

In one embodiment, the non-linear mix function 15-630 may be performed by the blending circuitry 15-501 of FIG. 15-3. For example, the non-linear mix function 15-630 may be performed by an HDR pixel generator 15-501 of FIG. 15-3. In one embodiment, the HDR pixel generator 15-501 may be configured to receive two pixels, identify an attribute of each of the two pixels, select a scalar or mix value based on the attributes of the two pixels, and then perform a mix function on the two pixels using the selected scalar or mix value, where performing the mix function on the two pixels using the selected scalar or mix value generates a HDR pixel. The HDR pixel may then be output in an HDR pixel stream.

As described in the context of FIG. 15-4, pixel data for one or more exposures from a given pixel may be referred to as a “pixel.” For example, pixel data from a first exposure of a pixel may be referred to as a first pixel, pixel data from a second exposure of the pixel may be referred to as a second pixel, and pixel data from a third exposure of the pixel may be referred to as a third pixel. Further, each of the pixel data from the first exposure, the second exposure, and the third exposure may be referred to as a brighter pixel or bright exposure pixel, medium pixel or medium exposure pixel, or darker pixel or dark exposure pixel in comparison to other pixel data sampled from the same pixel of an image sensor. For example, pixel data captured at an EV0 exposure may be referred to as a medium exposure pixel, pixel data captured at an EV− exposure may be referred to as a darker exposure pixel, and pixel data captured at an EV+exposure may be referred to as a brighter exposure pixel. As an option, an EV0 exposure may be referred to as a brighter pixel or a darker pixel, depending on other exposures of the same pixel. Accordingly, it should be understood that in the context of FIG. 15-4, any blending or mixing operation of two or more pixels refers to a blending or mixing operation of pixel data obtained from a single pixel of an image sensor sampled at two or more exposures.

In one embodiment, the mix function 15-666 may include any function which is capable of combining two input values (e.g. pixels, etc.). The mix function 15-666 may define a linear blend operation for generating a vec3 value associated with HDR pixel 15-659 by blending a vec3 value associated with the brighter pixel 15-650 and a vec3 value associated with the darker pixel 15-652 based on mix value 15-658. For example the mix function 15-666 may implement the well-known OpenGL mix function. In other examples, the mix function may include normalizing a weighted sum of values for two different pixels, summing and normalizing vectors (e.g. RGB, etc.) associated with the input pixels, computing a weighted average for the two input pixels, and/or applying any other function which may combine in some manner the brighter pixel and the darker pixel. In one embodiment, mix value 15-658 may range from 0 to 1, and mix function 15-666 mixes darker pixel 15-652 and brighter pixel 15-650 based on the mix value 15-658. In another embodiment, the mix value 15-658 ranges from 0 to an arbitrarily large value, however the mix function 15-666 is configured to respond to mix values greater than 1 as though such values are equal to 1. Further still, the mix value may be a scalar.

In one embodiment, a mix value function may include a product of two polynomials and may include a strength coefficient. In a specific example, the mix value function is implemented as mix value surface 15-664, which operates to generate mix value 15-658. One exemplary mix value function is illustrated below in Equation 1:

$$z = p 1 ( x ) * p 2 ( y ) * s \qquad ( Eq . 1 )$$

where:
z is resulting mix value for first and second pixels;
p1 is a first polynomial in x, where x may be a pixel attribute for first (darker) pixel;
p2 is a second polynomial in y, where y may be a pixel attribute for second (lighter) pixel; and
s is a strength coefficient (s==0: no mixing, s==1.0: nominal mixing, s>1.0: exaggerated mixing).

In Equation 1, the strength coefficient(s) may cause the resulting mix value to reflect no mixing (e.g. s=0, etc.), nominal mixing (e.g. s=1, etc.), and exaggerated mixing (e.g. s>1.0, etc.) between the first and second pixels.

In another specific embodiment, a mix function may include a specific polynomial form:

$$z = ( 1 - {( 1 - {( 1 - x )}^{∧} A )}^{∧} B ) * ( {( 1 - {( 1 - y )}^{∧} C )}^{∧} D ) * s \qquad ( Eq . 2 )$$

As shown, p1(x) of Equation 1 may be implemented in Equation 2 as the term (1−(1−(1−x)\hat{ }A)\hat{ }B), while p2(y) of Equation 2 may be implemented as the term ((1−(1−y)\hat{ }C)\hat{ }D). In one embodiment, Equation 2 may include the following coefficients: A=8, B=2, C=8, and D=2. Of course, in other embodiments, other coefficient values may be used to optimize overall mixing, which may include subjective visual quality associated with mixing the first and second pixels. In certain embodiments, Equation 2 may be used to mix a combination of an “EV0” pixel (e.g. a pixel from an image having an EV0 exposure), an “EV−” pixel (e.g. a pixel from an image having an exposure of EV−1, EV−2, or EV−3, etc.), and an “EV+” pixel (e.g. a pixel from an image having an exposure of EV+1, EV+2, or EV+3, etc.). Further, in another embodiment, Equation 2 may be used to mix images having a bright exposure, median exposure, and/or dark exposure in any combination.

In another embodiment, when z=0, the darker pixel may be given full weight, and when z=1, the brighter pixel may be given full weight. In one embodiment, Equation 2 may correspond with the surface diagrams as shown in FIGS. 10A and 10B.

In another specific embodiment, a mix function may include a specific polynomial form:

$$z = ( {( 1 - {( 1 - x )}^{∧} A )}^{∧} B ) * ( {( 1 - {( 1 - y )}^{∧} C )}^{∧} D ) * s \qquad ( Eq . 3 )$$

As shown, p1(x) of Equation 1 may be implemented in Equations 3 as the term ((1−(1−x)\hat{ }A)\hat{ }B), while p2(y) of Equation 3 may be implemented as the term ((1−(1−y)\hat{ }C)\hat{ }D). In one embodiment, Equation 3 may include the following coefficients: A=8, B=2, C=2, and D=2. Of course, in other embodiments, other coefficient values may be used to optimize the mixing. In another embodiment, Equation 3 may be used to mix an “EV0” pixel, and an “EV−” pixel (e.g., EV−1, EV−2, or EV−3) pixel. Further, in another embodiment, Equation 3 may be used to mix a bright exposure, median exposure, and/or dark exposure in any combination.

In another embodiment, when z=0, the brighter pixel may be given full weight, and when z=1, the darker pixel may be given full weight. In one embodiment, Equation 3 may correspond with the surface diagrams as shown in FIGS. 11A and 11B.

In another embodiment, the brighter pixel 15-650 may be received by a pixel attribute function 15-660, and the darker pixel 15-652 may be received by a pixel attribute function 15-662. In various embodiments, the pixel attribute function 15-660 and/or 662 may include any function which is capable of determining an attribute associated with the input pixel (e.g. brighter pixel, darker pixel, etc.). For example, in various embodiments, the pixel attribute function 15-660 and/or 662 may include determining an intensity, a saturation, a hue, a color space (e.g. EGB, YCbCr, YUV, etc.), a RGB blend, a brightness, an RGB color, a luminance, a chrominance, and/or any other feature which may be associated with a pixel in some manner.

In response to the pixel attribute function 15-660, a pixel attribute 15-655 associated with brighter pixel 15-650 results and is inputted into a mix value function, such as mix value surface 15-664. Additionally, in response to the pixel attribute function 15-662, a pixel attribute 15-656 associated with darker pixel 15-652 results and is inputted into the mix value function.

In one embodiment, a given mix value function may be associated with a surface diagram. For example, in one embodiment, an x value may be associated with a polynomial associated with the first pixel attribute (or a plurality of pixel attributes), and a y value may be associated with a polynomial associated with the second pixel attribute (or a plurality of pixel attributes). Further, in another embodiment, a strength function may be used to scale the mix value calculated by the mix value function. In one embodiment, the mix value may include a scalar.

In one embodiment, the mix value 15-658 determined by the mix value function may be selected from a table that embodies the surface diagram. In another embodiment, a first value associated with a first polynomial and a second value associated with a second polynomial may each be used to select a corresponding value from a table, and the two or more values may be used to interpolate a mix value. In other words, at least a portion of the mix value function may be implemented as a table (e.g. lookup table) indexed in x and y to determine a value of z. Each value of z may be directly represented in the table or interpolated from sample points comprising the table. Accordingly, a scalar may be identified by at least one of generating, selecting, and interpolating.

As shown, a mix value 15-658 results from the mix value surface 15-664 and is inputted into the mix function 15-666, described previously.

HDR pixel 15-659 may be generated based on the brighter pixel 15-650 and the darker pixel 15-652, in accordance with various embodiments described herein.

FIG. 15-5A illustrates a method 15-700 for generating a HDR pixel based on combined HDR pixel and effects function, in accordance with another embodiment. As an option, the method 15-700 may be carried out in the context of the details of any of the Figures. Of course, however, the method 15-700 may be carried out in any desired environment. Further, the aforementioned definitions may equally apply to the description below.

As described in the context of FIGS. 7A-7B, pixel data for one or more exposures from a given pixel may be referred to as a “pixel.” For example, pixel data from a first exposure of a pixel may be referred to as a first pixel, pixel data from a second exposure of the pixel may be referred to as a second pixel, and pixel data from a third exposure of the pixel may be referred to as a third pixel. Further, each of the pixel data from the first exposure, the second exposure, and the third exposure may be referred to as a brighter pixel or bright exposure pixel, medium pixel or medium exposure pixel, or darker pixel or dark exposure pixel in comparison to other pixel data sampled from the same pixel of an image sensor. For example, pixel data captured at an EV0 exposure may be referred to as a medium exposure pixel, pixel data captured at an EV− exposure may be referred to as a darker exposure pixel, and pixel data captured at an EV+ exposure may be referred to as a brighter exposure pixel. As an option, an EV0 exposure may be referred to as a brighter pixel or a darker pixel, depending on other exposures of the same pixel. Accordingly, it should be understood that in the context of FIGS. 7A-7B, any blending or mixing operation of two or more pixels refers to a blending or mixing operation of pixel data obtained from a single pixel of an image sensor sampled at two or more exposures.

As shown, in one embodiment, a medium-bright HDR pixel may be generated based on a medium exposure pixel and a bright exposure pixel. See operation 15-702. Additionally, a medium-dark HDR pixel may be generated based on a medium exposure pixel and a dark exposure pixel. See operation 15-704. For example, in one embodiment, a medium exposure pixel may include an EV0 exposure and a bright exposure pixel may include an EV+1 exposure, and medium-bright HDR pixel may be a blend between the EV0 exposure pixel and the EV+1 exposure pixel. Of course, a bright exposure pixel may include an exposure greater (e.g. in any amount, etc.) than the medium exposure value.

In another embodiment, a medium exposure pixel may include an EV0 exposure and a dark exposure pixel may include an EV−1 exposure, and a medium-dark HDR pixel may be a blend between the EV0 exposure and the EV−1 exposure. Of course, a dark exposure pixel may include an exposure (e.g. in any amount, etc.) less than the medium exposure value.

As shown, a combined HDR pixel may be generated based on a medium-bright HDR pixel and a medium-dark HDR pixel. See operation 15-706. In another embodiment, the combined HDR pixel may be generated based on multiple medium-bright HDR pixels and multiple medium-dark HDR pixels.

In a separate embodiment, a second combined HDR pixel may be based on the combined HDR pixel and a medium-bright HDR pixel, or may be based on the combined HDR pixel and a medium-dark HDR pixel. In a further embodiment, a third combined HDR pixel may be based on a first combined HDR pixel, a second combined HDR pixel, a medium-bright HDR pixel, a medium-dark HDR pixel, and/or any combination thereof.

Further, as shown, an output HDR pixel may be generated based on a combined HDR pixel and an effects function. See operation 15-708. For example in one embodiment, an effect function may include a function to alter an intensity, a saturation, a hue, a color space (e.g. EGB, YCbCr, YUV, etc.), a RGB blend, a brightness, an RGB color, a luminance, a chrominance, a contrast, an attribute levels function, and/or an attribute curves function. Further, an effect function may include a filter, such as but not limited to, a pastel look, a watercolor function, a charcoal look, a graphic pen look, an outline of detected edges, a change of grain or of noise, a change of texture, and/or any other modification which may alter the output HDR pixel in some manner.

FIG. 15-5B illustrates a system 15-730 for outputting a HDR pixel stream, in accordance with another embodiment. As an option, the system 15-730 may be implemented in the context of the details of any of the Figures. Of course, however, the system 15-730 may be carried out in any desired environment. Further, the aforementioned definitions may equally apply to the description below.

In one embodiment, the system 15-730 may include a pixel blend operation 15-731. In one embodiment, the pixel blend operation 15-731 may include receiving a bright exposure pixel 15-710 and a medium exposure pixel 15-712 at a non-linear mix function 15-732. In another embodiment, the non-linear mix function 15-732 may operate in a manner consistent with non-linear mix function 15-630 of FIG. 15-4. In another embodiment, the pixel blend operation 15-731 may include receiving a dark exposure pixel 15-714 and a medium exposure pixel 15-712 at a non-linear mix function 15-734. In another embodiment, the non-linear mix function 15-734 may operate in a manner consistent with item 15-630 of FIG. 15-4.

In one embodiment, the pixel blend operation 15-731 may be performed by the blending circuitry 15-501 of FIG. 15-3. For example, the pixel blend operation 15-731 may be performed by an HDR pixel generator 15-501 of FIG. 15-3. In one embodiment, the HDR pixel generator 15-501 may be configured to receive three pixels, identify an attribute of each of the three pixels, select mix values based on the attributes of the three pixels, perform mix functions using the selected mix values to obtain two resulting pixels, and then combine the resulting pixels to generate an HDR pixel. The HDR pixel may then be output in an HDR pixel stream.

In various embodiments, the non-linear mix function 15-732 and/or 734 may receive an input from a bright mix limit 15-720 or dark mix limit 15-722, respectively. In one embodiment, the bright mix limit 15-720 and/or the dark mix limit 15-722 may include an automatic or manual setting. For example, in some embodiments, the mix limit may be set by predefined settings (e.g. optimized settings, etc.). In one embodiment, each mix limit may be predefined to optimize the mix function. In another embodiment, the manual settings may include receiving a user input. For example, in one embodiment, the user input may correspond with a slider setting on a sliding user interface. Each mix limit may correspond to a respective strength coefficient, described above in conjunction with Equations 1-3.

For example, in one embodiment, a mix value function may include a product of two polynomials and may include a strength coefficient. In a specific example, the mix value function is implemented as mix value surface 15-664, which operates to generate mix value 15-658. One exemplary mix value function is illustrated below in Equation 1:

$$z = p 1 ( x ) * p 2 ( y ) * s \qquad ( Eq . 1 )$$

where:
z is resulting mix value for first and second pixels;
p1 is a first polynomial in x, where x may be a pixel attribute for first (darker) pixel;
p2 is a second polynomial in y, where y may be a pixel attribute for second (lighter) pixel; and
s is a strength coefficient (s==0: no mixing, s==1.0: nominal mixing, s>1.0: exaggerated mixing).

In Equation 1, the strength coefficient (s) may cause the resulting mix value to reflect no mixing (e.g. s=0, etc.), nominal mixing (e.g. s=1, etc.), and exaggerated mixing (e.g. s>1.0, etc.) between the first and second pixels.

In another specific embodiment, a mix function may include a specific polynomial form:

$$z = ( 1 - {( 1 - {( 1 - x )}^{∧} A )}^{∧} B ) * ( {( 1 - {( 1 - y )}^{∧} C )}^{∧} D ) * s \qquad ( Eq . 2 )$$

As shown, p1(x) of Equation 1 may be implemented in Equation 2 as the term (1−(1−(1−x)\hat{ }A)\hat{ }B), while p2(y) of Equation 2 may be implemented as the term ((1−(1−y)\hat{ }C)\hat{ }D). In one embodiment, Equation 2 may include the following coefficients: A=8, B=2, C=8, and D=2. Of course, in other embodiments, other coefficient values may be used to optimize overall mixing, which may include subjective visual quality associated with mixing the first and second pixels. In certain embodiments, Equation 2 may be used to mix a combination of an “EV0” pixel (e.g. a pixel from an image having an EV0 exposure), an “EV−” pixel (e.g. a pixel from an image having an exposure of EV−1, EV−2, or EV−3, etc.), and an “EV+” pixel (e.g. a pixel from an image having an exposure of EV+1, EV+2, or EV+3, etc.). Further, in another embodiment, Equation 2 may be used to mix images having a bright exposure, median exposure, and/or dark exposure in any combination.

In another embodiment, when z=0, the darker pixel may be given full weight, and when z=1, the brighter pixel may be given full weight. In one embodiment, Equation 2 may correspond with the surface diagrams as shown in FIGS. 10A and 10B.

In another specific embodiment, a mix function may include a specific polynomial form:

$$z = ( {( 1 - {( 1 - x )}^{∧} A )}^{∧} B ) * ( {( 1 - {( 1 - y )}^{∧} C )}^{∧} D ) * s \qquad ( Eq . 3 )$$

As shown, p1(x) of Equation 1 may be implemented in Equation 3 as the term ((1−(1−x)\hat{ }A)\hat{ }B), while p2(y) of Equation 3 may be implemented as the term ((1−(1−y)\hat{ }C)\hat{ }D). In one embodiment, Equation 3 may include the following coefficients: A=8, B=2, C=2, and D=2. Of course, in other embodiments, other coefficient values may be used to optimize the mixing. In another embodiment, Equation 3 may be used to mix an “EV0” pixel, and an “EV−” pixel (e.g., EV−1, EV−2, or EV−3) pixel. Further, in another embodiment, Equation 3 may be used to mix a bright exposure, median exposure, and/or dark exposure in any combination.

In another embodiment, when z=0, the brighter pixel may be given full weight, and when z=1, the darker pixel may be given full weight. In one embodiment, Equation 3 may correspond with the surface diagrams as shown in FIGS. 11A and 11B.

As shown, in one embodiment, the non-linear mix function 15-732 results in a medium-bright HDR pixel 15-740. In another embodiment, the non-linear mix function 15-734 results in a medium-dark HDR pixel 15-742. In one embodiment, the medium-bright HDR pixel 15-740 and the medium-dark HDR pixel 15-742 are inputted into a combiner function 15-736. In another embodiment, the combiner function 15-736 blends the medium-bright HDR pixel 15-740 and the medium-dark HDR pixel 15-742.

In various embodiments, the combiner function 15-736 may include taking an average of two or more pixel values, summing and normalizing a color attribute associated with each pixel value (e.g. a summation of a red/green/blue component in a RGB color space, etc.), determining a RGB (or any color space) vector length which may then be normalized, using an average pixel value in combination with a brighter pixel or a darker pixel, and/or using any other combination to blend the medium-bright HDR pixel 15-740 and the medium-dark HDR pixel 15-742.

In one embodiment, the combiner function 15-736 results in a combined HDR pixel 15-744. In various embodiments, the combined HDR pixel 15-744 may include any type of blend associated with the medium-bright pixel 15-740 and the medium-dark HDR pixel 15-742. For example, in some embodiments, the combined HDR pixel may include a resulting pixel with no HDR effect applied, whereas in other embodiments, any amount of HDR or even amplification may be applied and be reflected in the resulting combined HDR pixel.

In various embodiments, the combined HDR pixel 15-744 is inputted into an effects function 15-738. In one embodiment, the effects function 15-738 may receive a saturation parameter 15-724, level mapping parameters 15-726, and/or any other function parameter which may cause the effects function 15-738 to modify the combined HDR pixel 15-744 in some manner. Of course, in other embodiments, the effects function 15-738 may include a function to alter an intensity, a hue, a color space (e.g. EGB, YCbCr, YUV, etc.), a RGB blend, a brightness, an RGB color, a luminance, a chrominance, a contrast, and/or a curves function. Further, an effect function may include a filter, such as but not limited to, a pastel look, a watercolor function, a charcoal look, a graphic pen look, an outline of detected edges, a change of grain or of noise, a change of texture, and/or any other modification which may alter the combined HDR pixel 15-744 in some manner. In some embodiments, output HDR pixel 15-746 may be generated by effects function 15-738. Alternatively, effects function 15-738 may be configured to have no effect and output HDR pixel 15-746 is equivalent to combined HDR pixel 15-744.

In some embodiments, and in the alternative, the combined HDR pixel 15-744 may have no effects applied. After passing through an effects function 15-738, an output HDR pixel 15-746 results.

FIG. 15-6 illustrates a method 15-800 for generating a HDR pixel based on a combined HDR pixel and an effects function, in accordance with another embodiment. As an option, the method 15-800 may be carried out in the context of the details of any of the Figures. Of course, however, the method 15-800 may be carried out in any desired environment. Further, the aforementioned definitions may equally apply to the description below.

In one embodiment, a medium exposure parameter may be estimated for a medium exposure image. See operation 15-802. Additionally, a dark exposure parameter is estimated for a dark exposure image (see operation 15-804) and a bright exposure parameter is estimated for a bright exposure image (see operation 15-806).

In various embodiments, an exposure parameter (e.g. associated with medium exposure, dark exposure, or bright exposure, etc.) may include an ISO, an exposure time, an exposure value, an aperture, and/or any other parameter which may affect image capture time. In one embodiment, the capture time may include the amount of time that the image sensor is exposed to optical information presented by a corresponding camera lens.

In one embodiment, estimating a medium exposure parameter, a dark exposure parameter, and/or a bright exposure parameter may include metering an image associated with a photographic scene. For example, in various embodiments, the brightness of light within a lens' field of view may be determined. Further, the metering of the image may include a spot metering (e.g. narrow area of coverage, etc.), an average metering (e.g. metering across the entire photo, etc.), a multi-pattern metering (e.g. matrix metering, segmented metering, etc.), and/or any other type of metering system. The metering of the image may be performed at any resolution, including a lower resolution than available from the image sensor, which may result in faster metering latency.

As shown, a dark exposure image, a medium exposure image, and a bright exposure image are captured. See operation 15-808. In various embodiments, capturing an image (e.g. a dark exposure image, a medium exposure image, a bright exposure image, etc.) may include committing the image (e.g. as seen through the corresponding camera lens, etc.) to an image processor and/or otherwise store the image temporarily in some manner. Of course, in other embodiments, the capturing may include a photodiode which may detect light (e.g. RGB light, etc.), a bias voltage or capacitor (e.g. to store intensity of the light, etc.), and/or any other circuitry necessary to receive the light intensity and store it. In other embodiments, the photodiode may charge or discharge a capacitor at a rate that is proportional to the incident light intensity (e.g. associated with the exposure time, etc.).

Additionally, in one embodiment, a combined HDR image may be generated based on a dark exposure image, a medium exposure image, and a bright exposure image. See operation 15-810. In various embodiments, the combined HDR image may be generated in a manner consistent with combined HDR pixel 15-744 in FIG. 15-5B. Further, in one embodiment, an output HDR image may be generated based on a combined HDR image comprising combined HDR pixel 15-744 and an effects function. See operation 15-812. In various embodiments, the output HDR image may be generated in a manner consistent with Output HDR pixel 15-746 in FIG. 15-5B.

FIG. 15-7 illustrates a method 15-900 for generating a HDR pixel based on combined HDR pixel and an effects function, in accordance with another embodiment. As an option, the method 15-900 may be carried out in the context of the details of any of the Figures. Of course, however, the method 15-900 may be carried out in any desired environment. Further, the aforementioned definitions may equally apply to the description below.

In one embodiment, a medium exposure parameter may be estimated for medium exposure image. See operation 15-902. In various embodiments, the medium exposure parameter may include an ISO, an exposure time, an exposure value, an aperture, and/or any other parameter which may affect the capture time. In one embodiment, the capture time may include the amount of time that the image sensor is exposed to optical information presented by a corresponding camera lens. In one embodiment, estimating a medium exposure parameter may include metering the image. For example, in various embodiments, the brightness of light within a lens' field of view may be determined. Further, the metering of the image may include a spot metering (e.g. narrow area of coverage, etc.), an average metering (e.g. metering across the entire photo, etc.), a multi-pattern metering (e.g. matrix metering, segmented metering, etc.), and/or any other type of metering system. The metering of the image may be performed at any resolution, including a lower resolution than available from the image sensor, which may result in faster metering latency. Additionally, in one embodiment, the metering for a medium exposure image may include an image at EV0. Of course, however, in other embodiments, the metering may include an image at any shutter stop and/or exposure value.

As shown, in one embodiment, an analog image may be captured within an image sensor based on medium exposure parameters. See operation 15-904. In various embodiments, capturing the analog image may include committing the image (e.g. as seen through the corresponding camera lens, etc.) to an image sensor and/or otherwise store the image temporarily in some manner. Of course, in other embodiments, the capturing may include a photodiode which may detect light (e.g. RGB light, etc.), a bias voltage or capacitor (e.g. to store intensity of the light, etc.), and/or any other circuitry necessary to receive the light intensity and store it. In other embodiments, the photodiode may charge or discharge a capacitor at a rate that is proportional to the incident light intensity (e.g. associated with the exposure time, etc.).

Additionally, in one embodiment, a medium exposure image may be generated based on an analog image. See operation 15-906. Additionally, a dark exposure image may be generated based on an analog image (see operation 15-908), and a brighter exposure image may be generated based on an analog image (see operation 15-910). In various embodiments, generating an exposure image (e.g. medium, dark, bright, etc.) may include applying an ISO or film speed to the analog image. Of course, in another embodiment, any function which may alter the analog image's sensitivity to light may be applied. In one embodiment, the same analog image may be sampled repeatedly to generate multiple images (e.g. medium exposure image, dark exposure image, bright exposure image, etc.). For example, in one embodiment, current stored within the circuitry may be read multiple times.

Additionally, in one embodiment, a combined HDR image may be generated based on a dark exposure image, a medium exposure image, and a bright exposure image. See operation 15-912. In various embodiments, the combined HDR image may be generated in a manner consistent with Combined HDR pixel 15-744 in FIG. 15-5B. Further, in one embodiment, an output HDR image may be generated based on a combined HDR image and an effects function. See operation 15-914. In various embodiments, the output HDR image may be generated in a manner consistent with Output HDR pixel 15-746 in FIG. 15-5B.

FIG. 15-8A illustrates a surface diagram 15-1000, in accordance with another embodiment. As an option, the surface diagram 15-1000 may be implemented in the context of the details of any of the Figures. Of course, however, the surface diagram 15-1000 may be implemented in any desired environment. Further, the aforementioned definitions may equally apply to the description below.

As described in the context of FIGS. 10A-10B, pixel data for one or more exposures from a given pixel may be referred to as a “pixel.” For example, pixel data from a first exposure of a pixel may be referred to as a first pixel, pixel data from a second exposure of the pixel may be referred to as a second pixel, and pixel data from a third exposure of the pixel may be referred to as a third pixel. Further, each of the pixel data from the first exposure, the second exposure, and the third exposure may be referred to as a brighter pixel or bright exposure pixel, medium pixel or medium exposure pixel, or darker pixel or dark exposure pixel in comparison to other pixel data sampled from the same pixel of an image sensor. For example, pixel data captured at an EV0 exposure may be referred to as a medium exposure pixel, pixel data captured at an EV− exposure may be referred to as a darker exposure pixel, and pixel data captured at an EV+exposure may be referred to as a brighter exposure pixel. As an option, an EV0 exposure may be referred to as a brighter pixel or a darker pixel, depending on other exposures of the same pixel. Accordingly, it should be understood that in the context of FIG. 15-8A-10B, any blending or mixing operation of two or more pixels refers to a blending or mixing operation of pixel data obtained from a single pixel of an image sensor sampled at two or more exposures.

In one embodiment, surface diagram 15-1000 depicts a surface associated with Equation 2 for determining a mix value for two pixels, based on two pixel attributes for the two pixels. As shown, the surface diagram 15-1000 is illustrated within a unit cube having an x axis 15-1002, a y axis 15-1004, and a z axis 15-1006. As described in Equation 2, variable “x” is associated with an attribute for a first (e.g. darker) pixel, and variable “y” is associated with an attribute for a second (e.g. lighter) pixel. For example, each attribute may represent an intensity value ranging from 0 to 1 along a respective x and y axis of the unit cube. An attribute for the first pixel may correspond to pixel attribute 15-656 of FIG. 15-4, while an attribute for the second pixel may correspond to pixel attribute 15-655. As described in Equation 2, variable “z” is associated with the mix value, such as mix value 15-658, for generating a HDR pixel, such as HDR pixel 15-659, from the two pixels. A mix value of 0 (e.g. z=0) may result in a HDR pixel that is substantially identical to the first pixel, while a mix value of 1 (e.g. z=1) may result in a HDR pixel that is substantially identical to the second pixel.

As shown, surface diagram 15-1000 includes a flat region 15-1014, a transition region 15-1010, and a saturation region 15-1012. The transition region 15-1010 is associated with x values below an x threshold and y values below a y threshold. The transition region 15-1010 is generally characterized as having monotonically increasing z values for corresponding monotonically increasing x and y values. The flat region 15-1014 is associated with x values above the x threshold. The flat region 15-1014 is characterized as having substantially constant z values independent of corresponding x and y values. The saturation region 15-1012 is associated with x values below the x threshold and above the y threshold. The saturation region 15-1012 is characterized as having z values that are a function of corresponding x values while being relatively independent of y values. For example, with x=x1, line 15-1015 shows z monotonically increasing through the transition region 15-1010, and further shows z remaining substantially constant within the saturation region 15-1012. In one embodiment mix value surface 15-664 implements surface diagram 15-1000. In another embodiment, non-linear mix function 15-732 of FIG. 15-5B implements surface diagram 15-1000. In yet another embodiment, non-linear mix function 15-734 of FIG. 15-5B implements surface diagram 15-1000.

FIG. 15-8B illustrates a surface diagram 15-1008, in accordance with another embodiment. As an option, the surface diagram 15-1008 may be implemented in the context of the details of any of the Figures. Of course, however, the surface diagram 15-1008 may be implemented in any desired environment. Further, the aforementioned definitions may equally apply to the description below.

In one embodiment, the surface diagram 15-1008 provides a separate view (e.g. top down view, etc.) of surface diagram 15-1000 of FIG. 15-8A. Additionally, the description relating to FIG. 15-8A may be applied to FIG. 15-8B as well.

FIG. 15-9A illustrates a surface diagram 15-1100, in accordance with another embodiment. As an option, the surface diagram 15-1100 may be implemented in the context of the details of any of the Figures. Of course, however, the surface diagram 15-1100 may be implemented in any desired environment. Further, the aforementioned definitions may equally apply to the description below.

In one embodiment, surface diagram 15-1100 depicts a surface associated with Equation 3 for determining a mix value for two pixels, based on two pixel attributes for the two pixels. As described in Equation 3, variable “x” is associated with an attribute for a first (e.g. darker) pixel, and variable “y” is associated with an attribute for a second (e.g. lighter) pixel. The flat region 15-1114 may correspond in general character to flat region 15-1014 of FIG. 15-8A. Transition region 15-1110 may correspond in general character to transition region 15-1010. Saturation region 15-1112 may correspond in general character to saturation region 15-1012. While each region of surface diagram 15-1100 may correspond in general character to similar regions for surface diagram 15-1000, the size of corresponding regions may vary between surface diagram 15-1100 and surface diagram 15-1000. For example, the x threshold associated with surface diagram 15-1100 is larger than the x threshold associated with surface diagram 15-1000, leading to a generally smaller flat region 15-1114. As shown, the surface diagram 15-1100 may include a flat region 15-1114, a transition region 15-1110, and a saturation region 15-1112.

FIG. 15-9B illustrates a surface diagram 15-1102, in accordance with another embodiment. As an option, the surface diagram 15-1102 may be implemented in the context of the details of any of the Figures. Of course, however, the surface diagram 15-1102 may be implemented in any desired environment. Further, the aforementioned definitions may equally apply to the description below.

In one embodiment, the surface diagram 15-1102 provides a separate view (e.g. top down view, etc.) of surface diagram 15-1100 of FIG. 15-9A. Additionally, in various embodiments, the description relating to FIG. 15-9A and FIG. 15-8A may be applied to FIG. 15-9B as well.

FIG. 15-10 illustrates an image synthesis operation 15-1200, in accordance with another embodiment. As an option, the image synthesis operation 15-1200 may be implemented in the context of the details of any of the Figures. Of course, however, the image synthesis operation 15-1200 may be carried out in any desired environment. Further, the aforementioned definitions may equally apply to the description below.

As shown, an image blend operation 15-1240 comprising the image synthesis operation 15-1200 may generate a synthetic image 15-1250 from an image stack 15-1202, according to one embodiment of the present invention. Additionally, in various embodiments, the image stack 15-1202 may include images 15-1210, 15-1212, and 15-1214 of a scene, which may comprise a high brightness region 15-1220 and a low brightness region 15-1222. In such an embodiment, medium exposure image 15-1212 is exposed according to overall scene brightness, thereby generally capturing scene detail.

In another embodiment, medium exposure image 15-1212 may also potentially capture some detail within high brightness region 15-1220 and some detail within low brightness region 15-1222. Additionally, dark exposure image 15-1210 may be exposed to capture image detail within high brightness region 15-1220. In one embodiment, in order to capture high brightness detail within the scene, image 15-1210 may be exposed according to an exposure offset from medium exposure image 15-1212.

In a separate embodiment, dark exposure image 15-1210 may be exposed according to local intensity conditions for one or more of the brightest regions in the scene. In such an embodiment, dark exposure image 15-1210 may be exposed according to high brightness region 15-1220, to the exclusion of other regions in the scene having lower overall brightness. Similarly, bright exposure image 15-1214 is exposed to capture image detail within low brightness region 15-1222. Additionally, in one embodiment, in order to capture low brightness detail within the scene, bright exposure image 15-1214 may be exposed according to an exposure offset from medium exposure image 15-1212. Alternatively, bright exposure image 15-1214 may be exposed according to local intensity conditions for one or more of the darkest regions of the scene.

As shown, in one embodiment, an image blend operation 15-1240 may generate synthetic image 15-1250 from image stack 15-1202. Additionally, in another embodiment, synthetic image 15-1250 may include overall image detail, as well as image detail from high brightness region 15-1220 and low brightness region 15-1222. Further, in another embodiment, image blend operation 15-1240 may implement any technically feasible operation for blending an image stack. For example, in one embodiment, any high dynamic range (HDR) blending technique may be implemented to perform image blend operation 15-1240, including but not limited to bilateral filtering, global range compression and blending, local range compression and blending, and/or any other technique which may blend the one or more images. In one embodiment, image blend operation 15-1240 includes a pixel blend operation 15-1242. The pixel blend operation 15-1242 may generate a pixel within synthetic image 15-1250 based on values for corresponding pixels received from at least two images of images 15-1210, 15-1212, and 15-1214. In one embodiment, pixel blend operation 15-1242 comprises pixel blend operation 15-731 of FIG. 15-5B. Further, the pixel blend operation 15-1242 may be implemented within blending circuitry, such as blending circuitry 15-501 of FIG. 15-3. For example, the synthetic image 15-1250 may comprise a plurality of HDR pixels of an HDR pixel stream, which is generated based on a received pixel stream including two or more exposures of an image.

In certain embodiments, at least two images of images 15-1210, 15-1212, 15-1214 are generated from a single analog image, as described in U.S. patent application Ser. No. 14/534,079 (DUELP007/DL014), filed Nov. 5, 2014, entitled “IMAGE SENSOR APPARATUS AND METHOD FOR OBTAINING MULTIPLE EXPOSURES WITH ZERO INTERFRAME TIME,” now U.S. Pat. No. 9,137,455, which is incorporated by reference as though set forth in full, thereby substantially eliminating any alignment processing needed prior to blending the images 15-1210, 15-1212, 15-1214. In other embodiments, at least two images of images 15-1210, 15-1212, 15-1214 are generated from two or more analog images that are captured or sampled simultaneously, as described in application Ser. No. 14/534,089 (DUELP008/DL015), filed Nov. 5, 2014, entitled “IMAGE SENSOR APPARATUS AND METHOD FOR SIMULTANEOUSLY CAPTURING MULTIPLE IMAGES” now U.S. Pat. No. 9,167,169; or application Ser. No. 14/535,274 (DUELP009/DL016), filed Nov. 6, 2014, entitled “IMAGE SENSOR APPARATUS AND METHOD FOR SIMULTANEOUSLY CAPTURING FLASH AND AMBIENT ILLUMINATED IMAGES”, now U.S. Pat. No. 9,154,708; or application Ser. No. 14/535,279 (DUELP010/DL017), filed Nov. 6, 2014, entitled “IMAGE SENSOR APPARATUS AND METHOD FOR OBTAINING LOW-NOISE, HIGH-SPEED CAPTURES OF A PHOTOGRAPHIC SCENE,” now U.S. Pat. No. 9,179,085, which are incorporated by reference as though set forth in full, thereby substantially eliminating any alignment processing needed prior to blending the images 15-1210, 15-1212, 15-1214.

Still yet, in various embodiments, one or more of the techniques disclosed herein may be applied to a variety of markets and/or products. For example, although the techniques have been disclosed in reference to a still photo capture, they may be applied to televisions, video capture, web conferencing (or live streaming capabilities, etc.), security cameras (e.g. increase contrast to determine characteristic, etc.), automobiles (e.g. driver assist systems, in-car infotainment systems, etc.), and/or any other product which includes a camera input.

Certain embodiments of the present invention enable digital photographic systems having a strobe light source to beneficially preserve proper white balance within regions of a digital photograph primarily illuminated by the strobe light source as well as regions primarily illuminated by an ambient light source. Proper white balance is maintained within the digital photograph even when the strobe light source and an ambient light source are of discordant color. The strobe light source may comprise a light-emitting diode (LED), a Xenon tube, or any other type of technically feasible illuminator device. Certain embodiments beneficially maintain proper white balance within the digital photograph even when the strobe light source exhibits color shift, a typical characteristic of high-output LEDs commonly used to implement strobe illuminators for mobile devices.

Certain other embodiments enable efficient capture of multiple related images either concurrently in time, or spaced closely together in time. Each of the multiple related images may be sampled at different exposure levels within an image sensor.

Certain other embodiments provide for a user interface configured to enable efficient management of different merge parameters associated with a multi-exposure image.

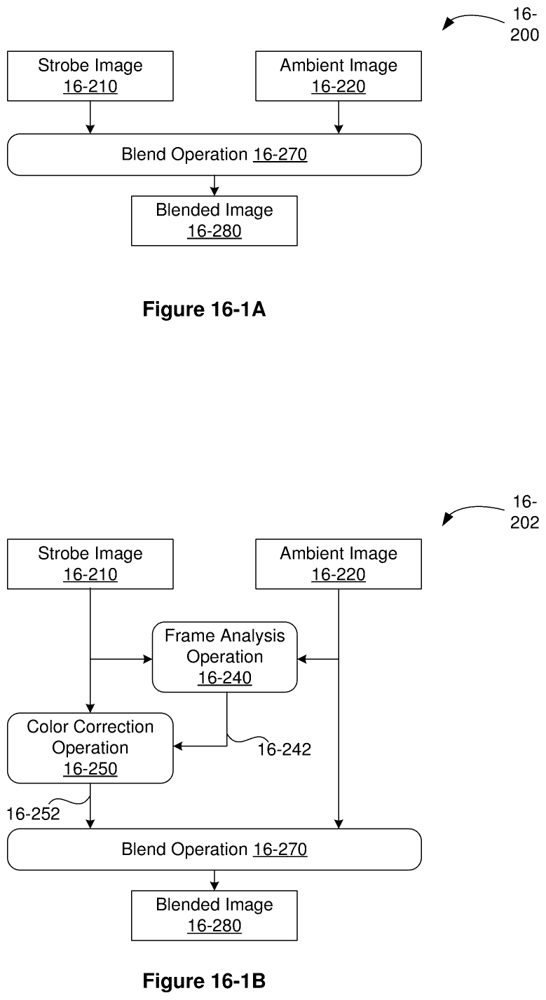

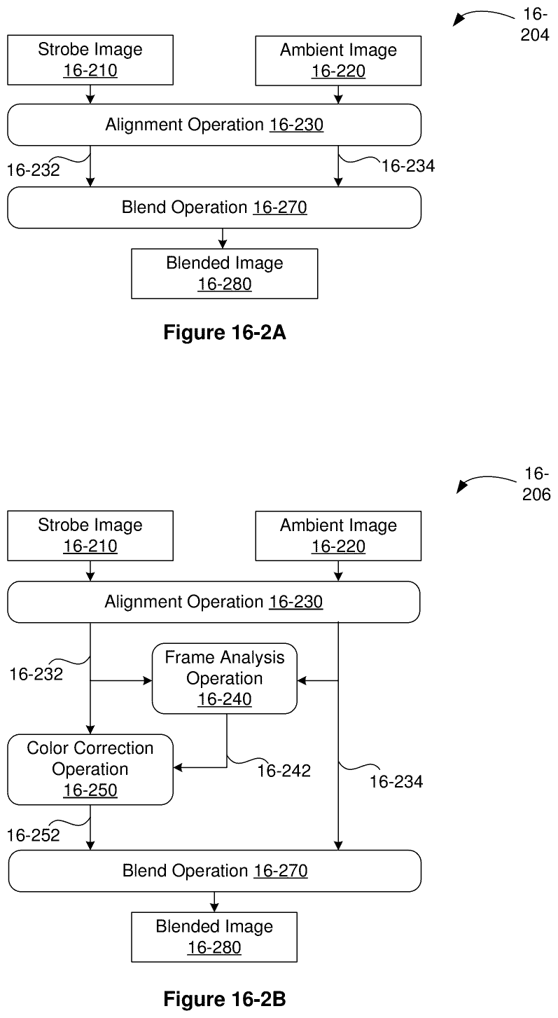

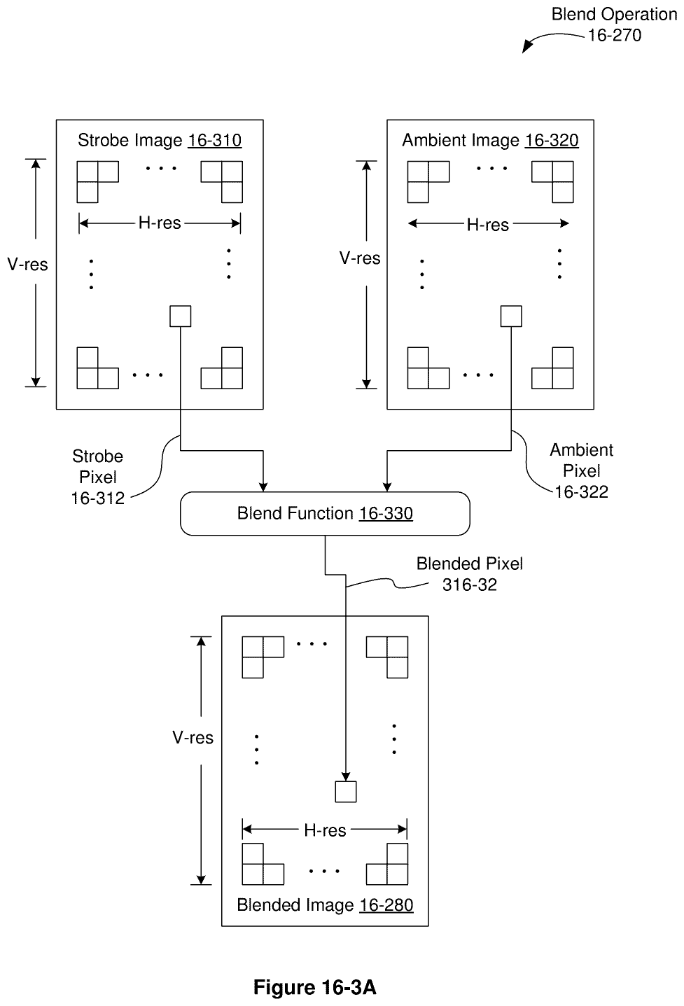

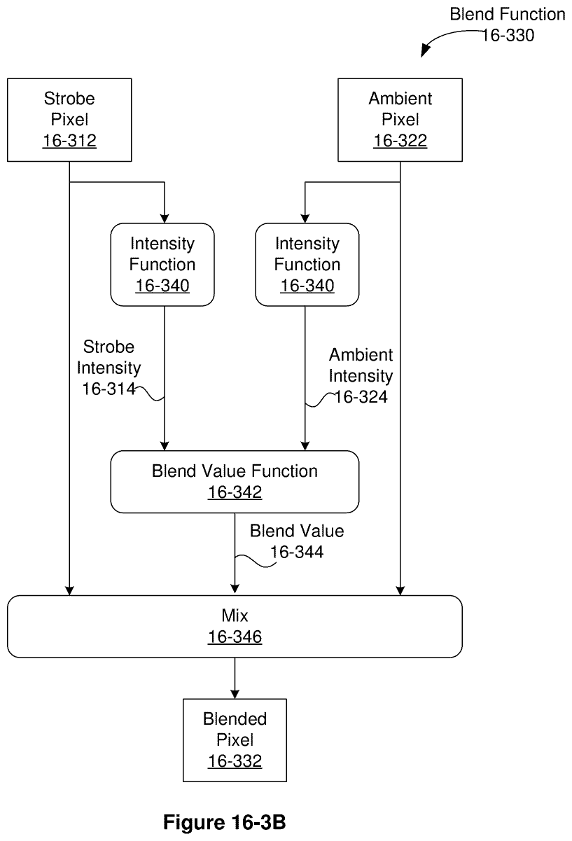

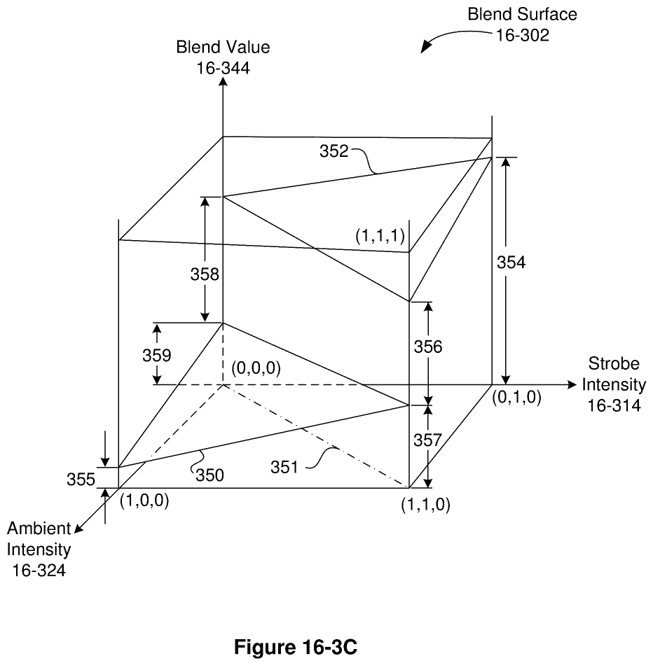

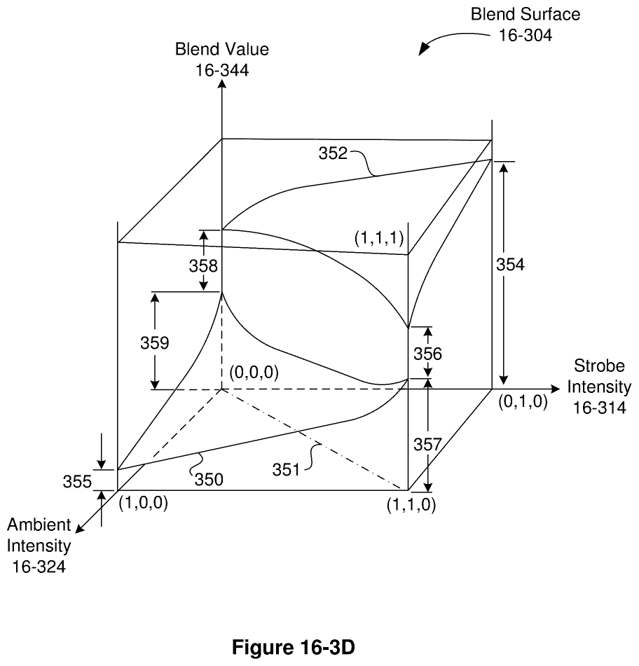

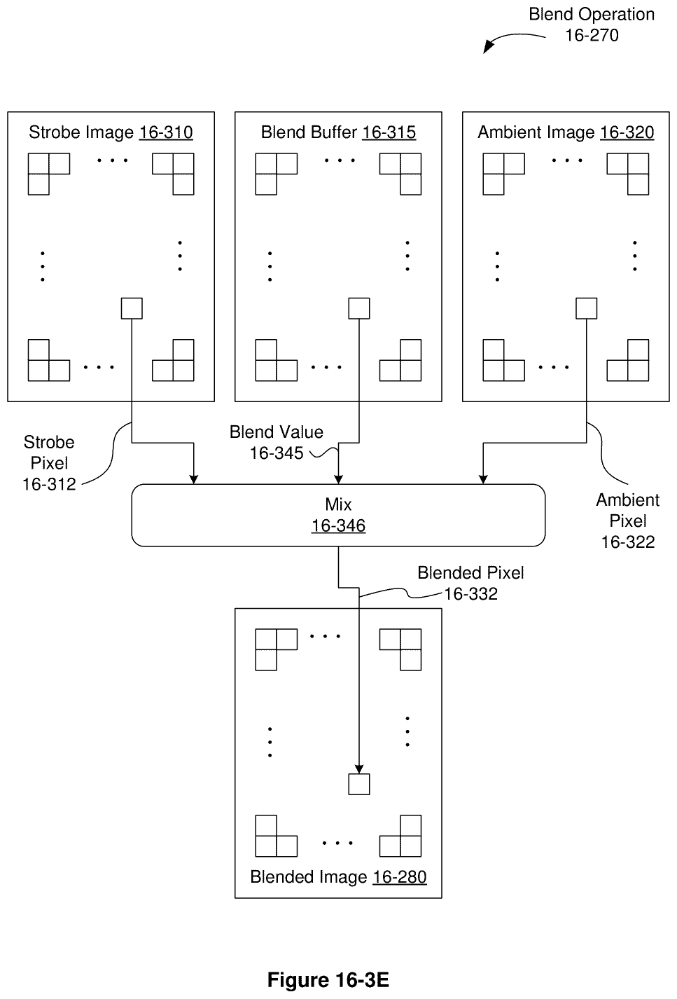

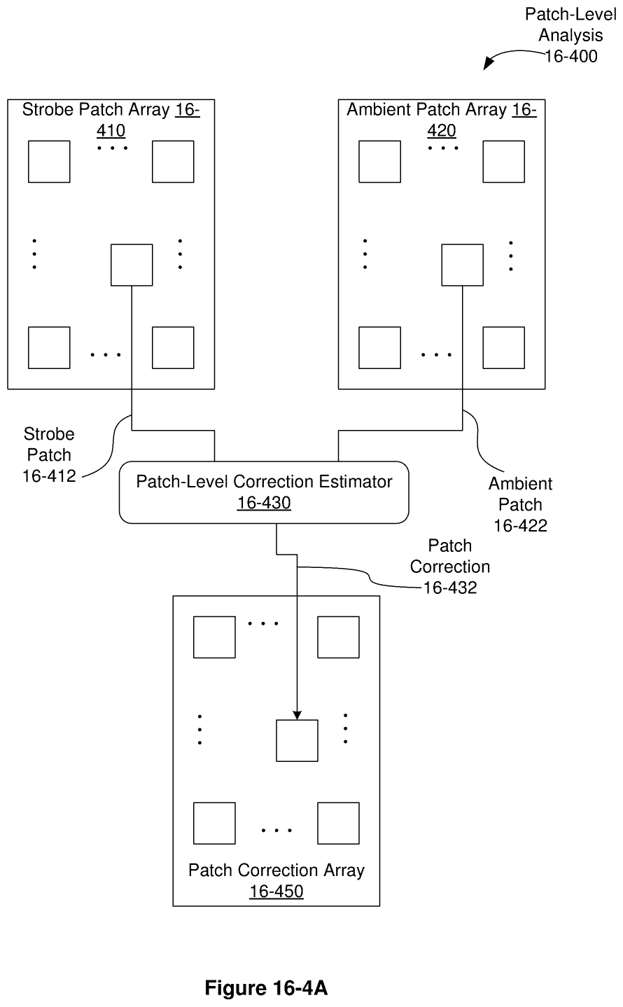

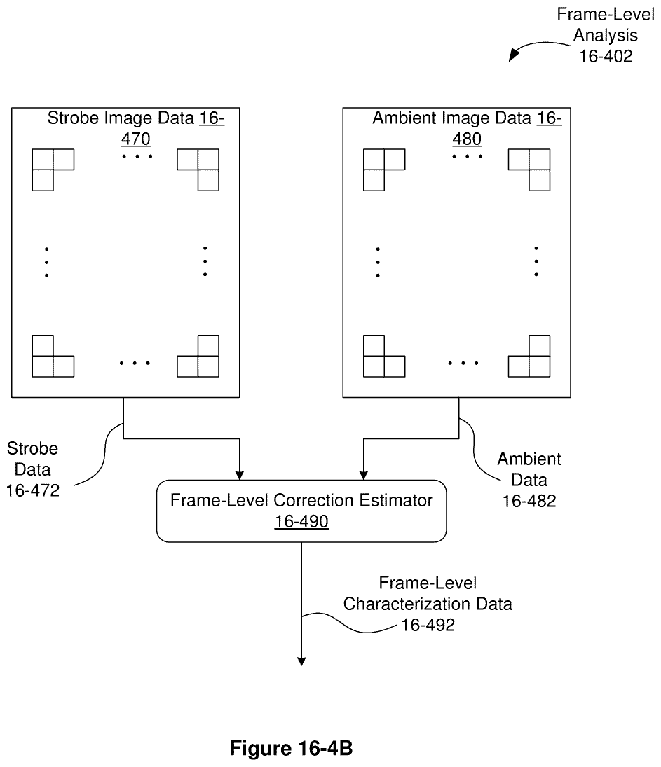

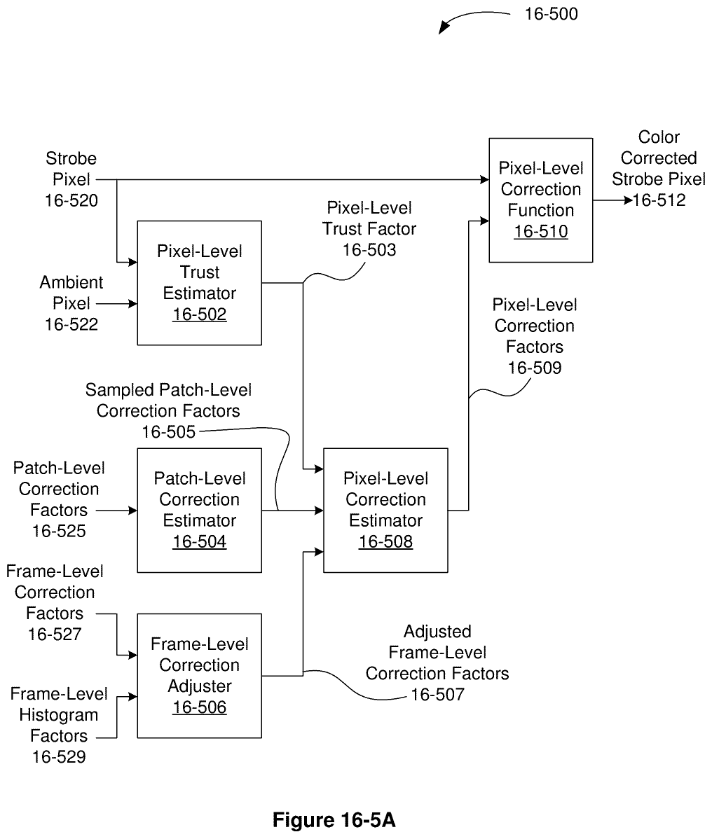

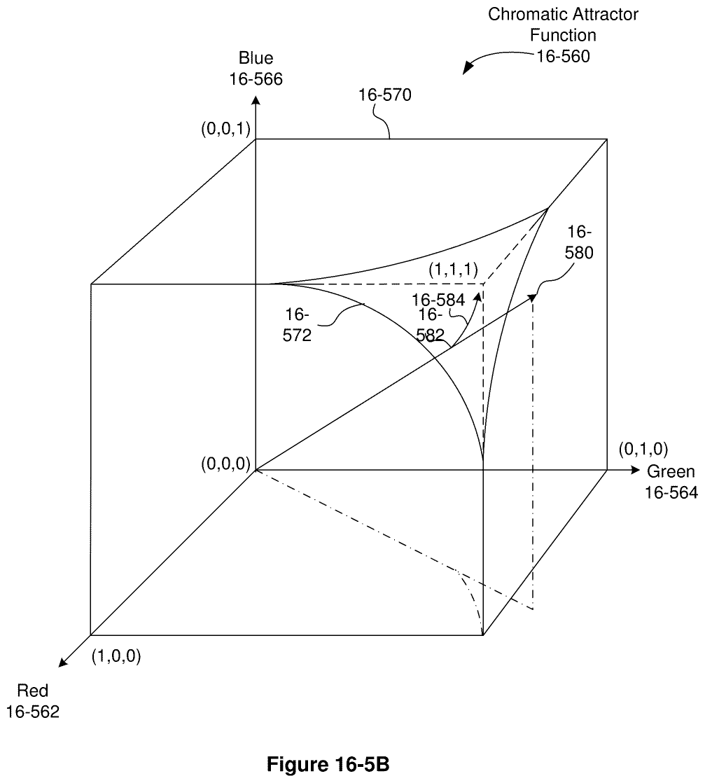

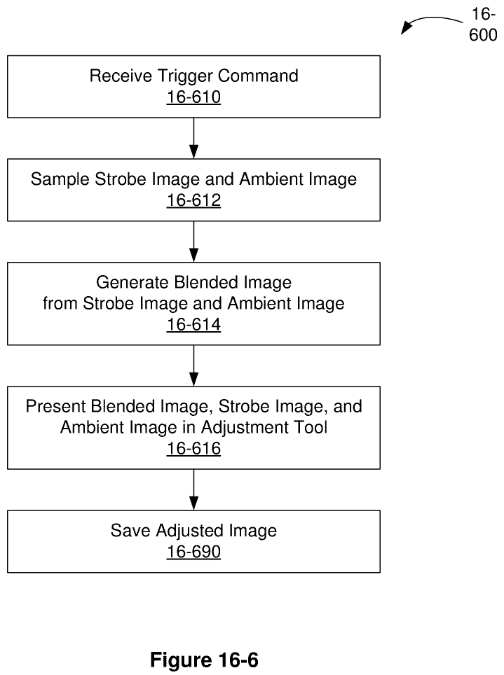

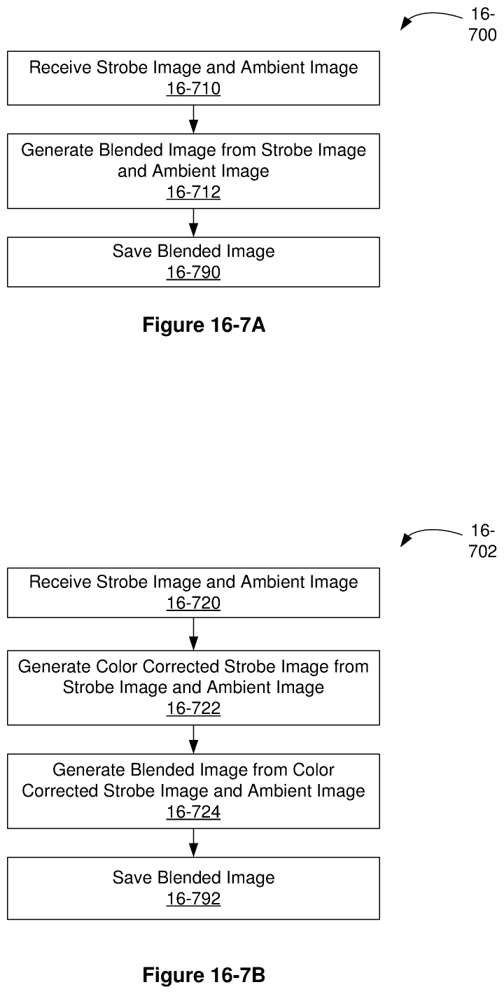

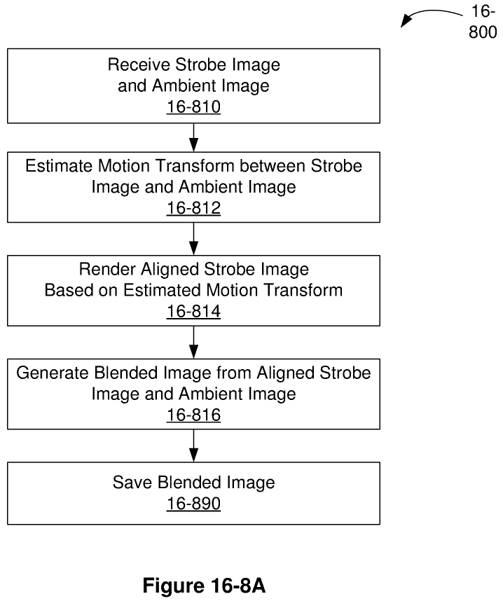

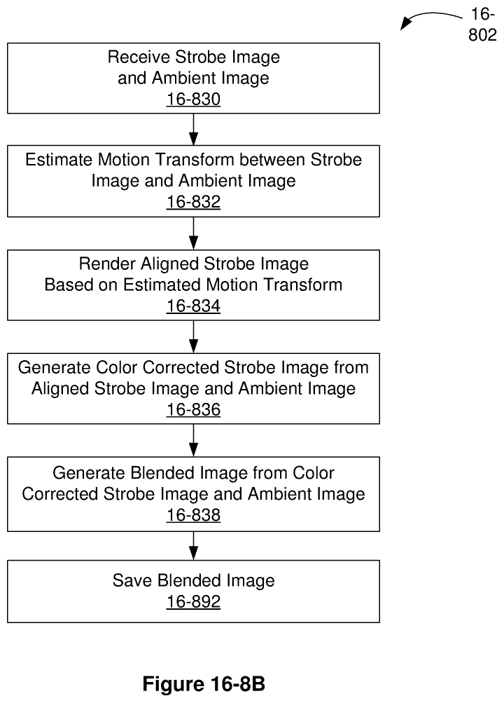

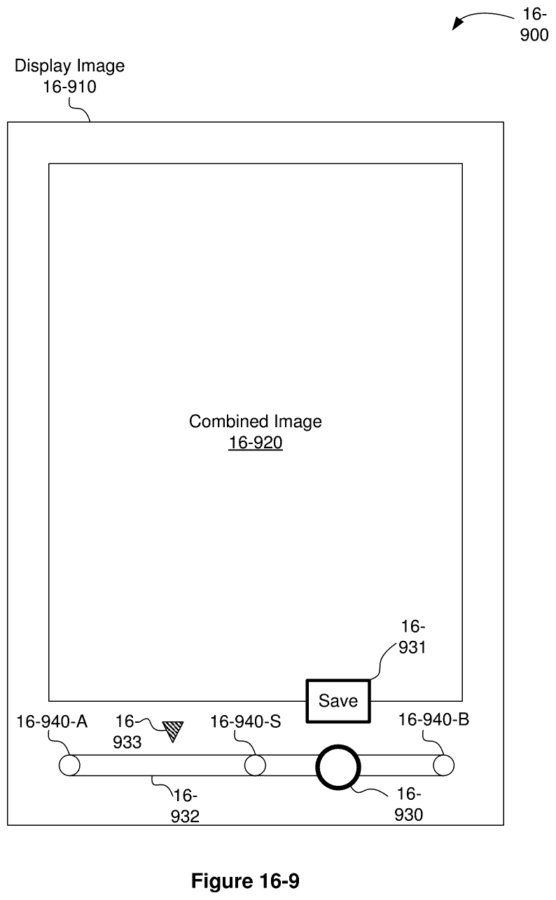

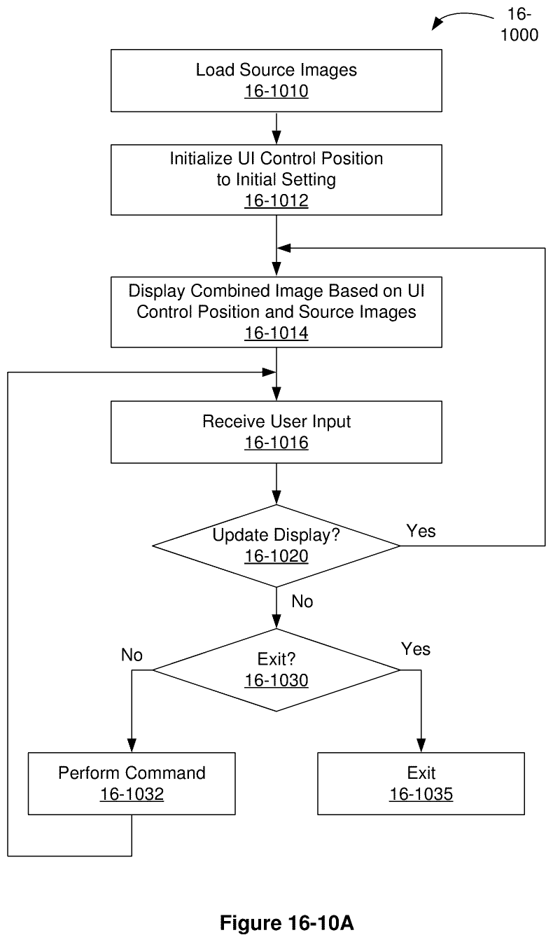

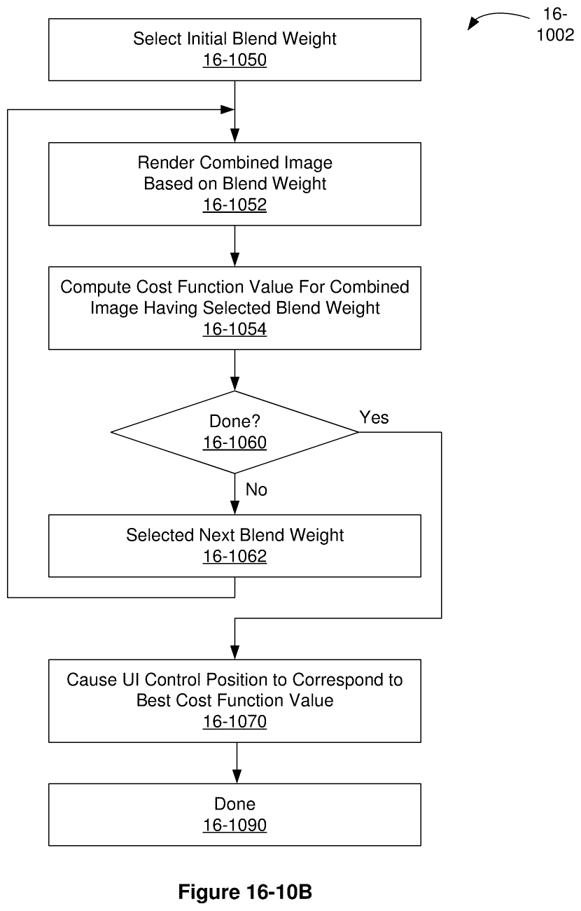

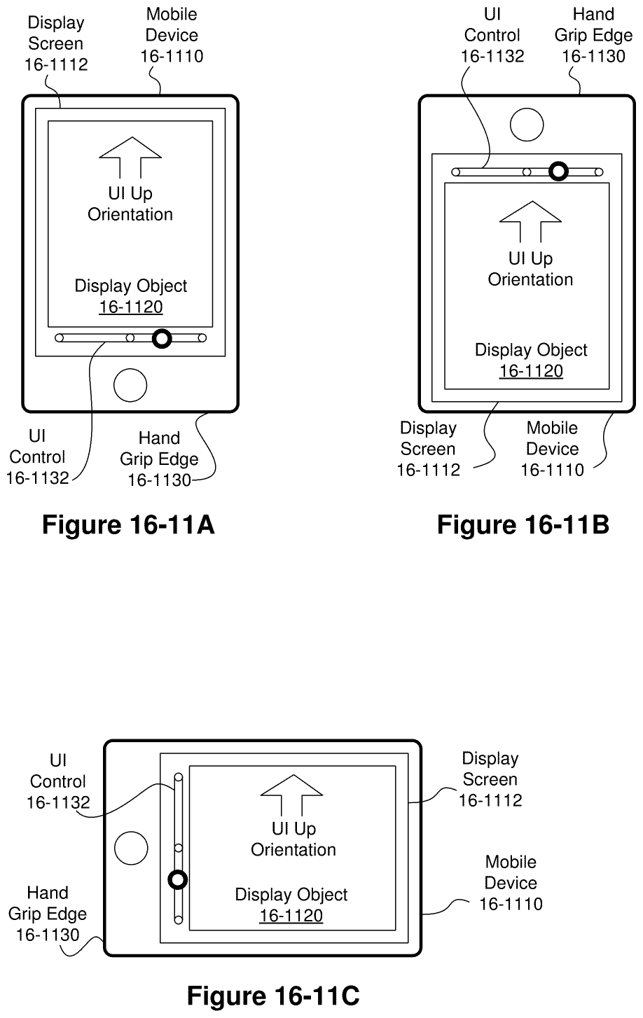

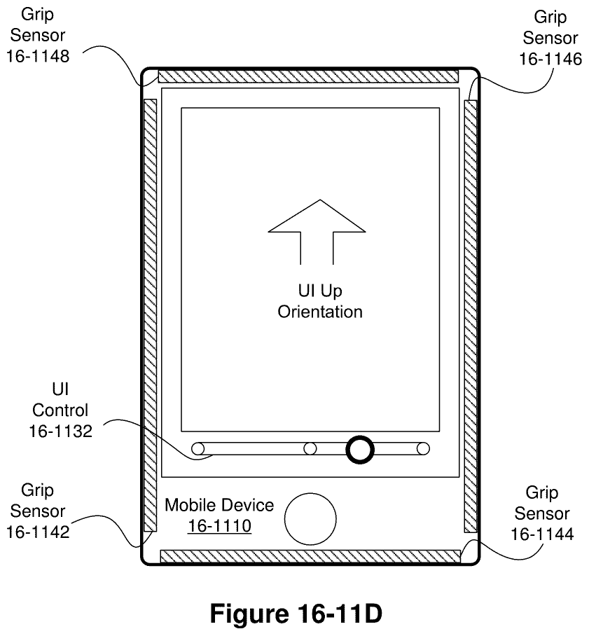

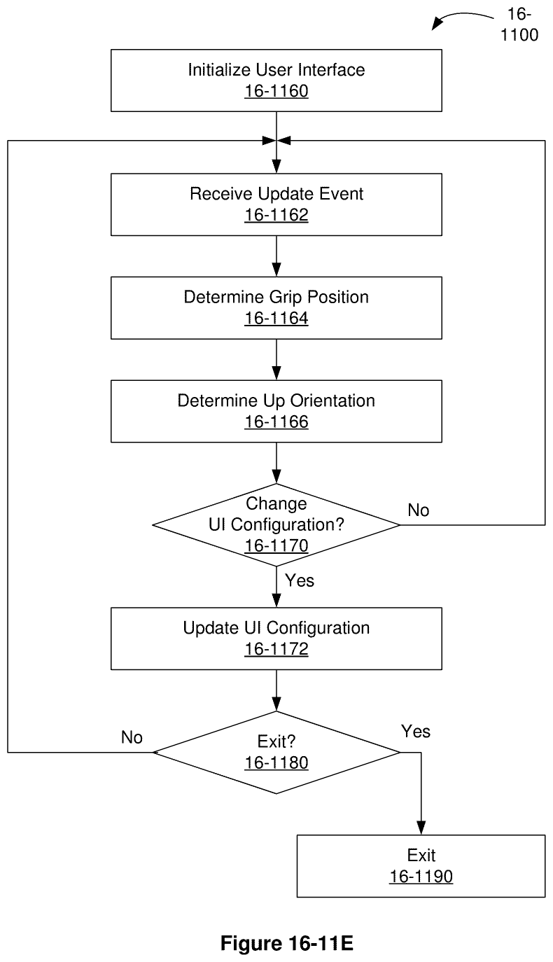

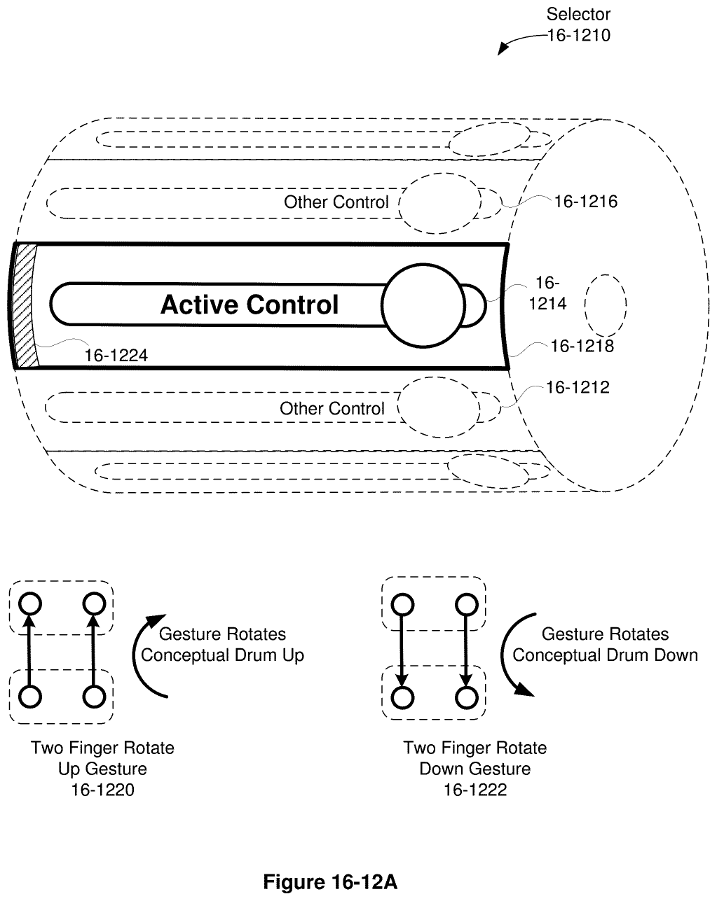

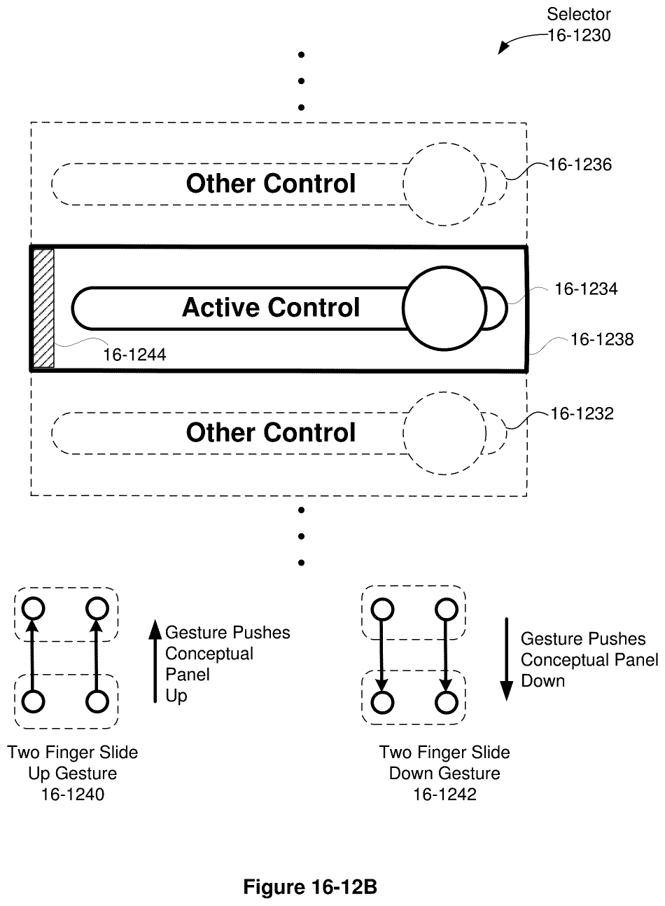

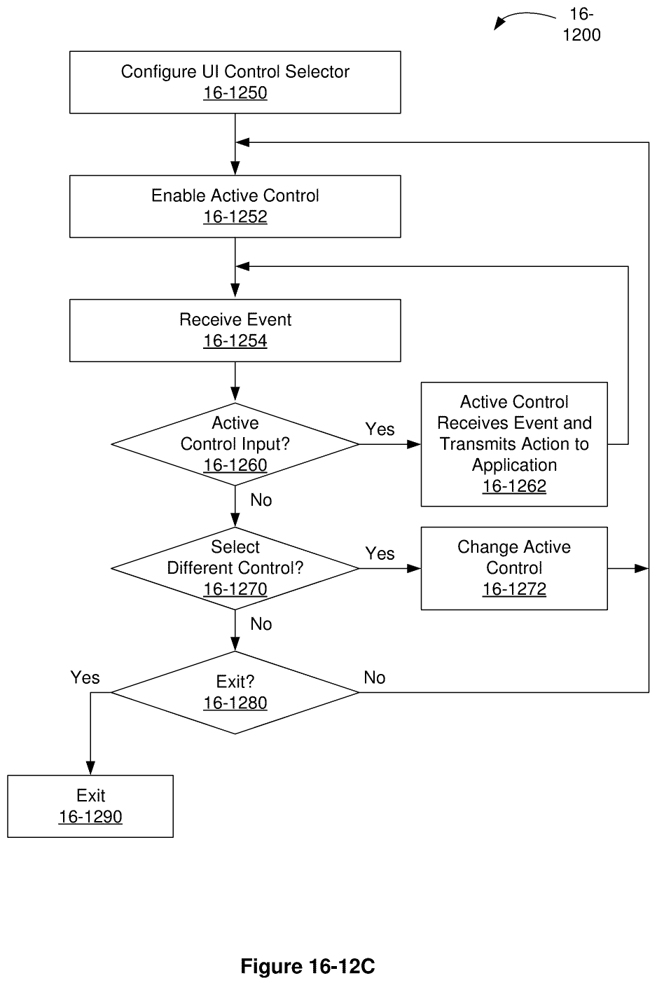

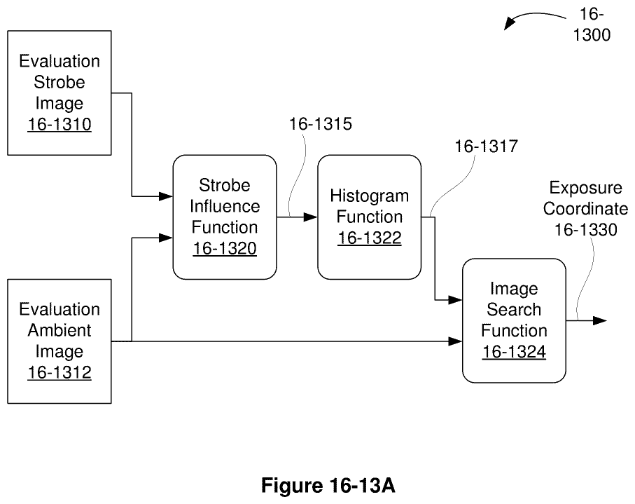

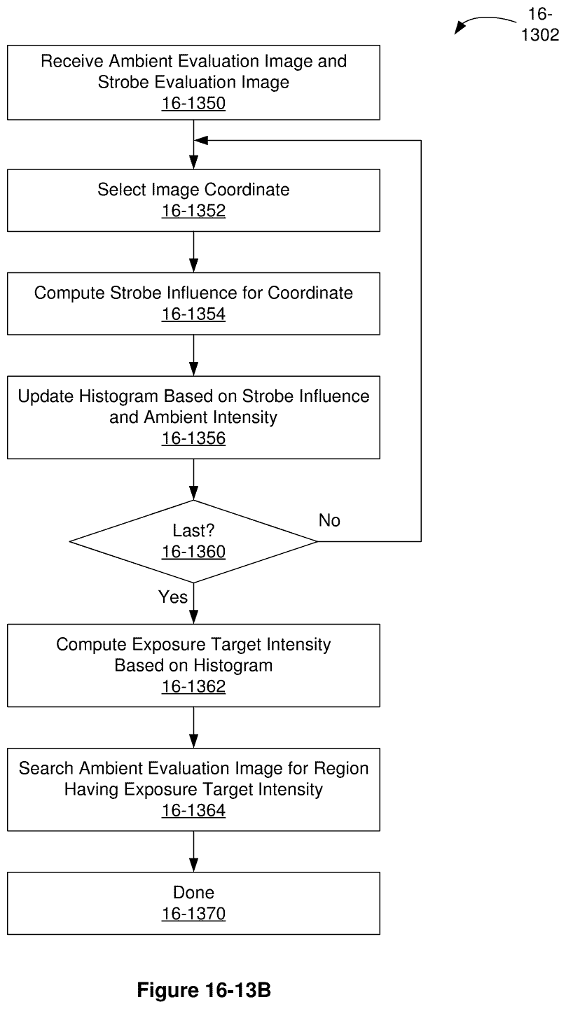

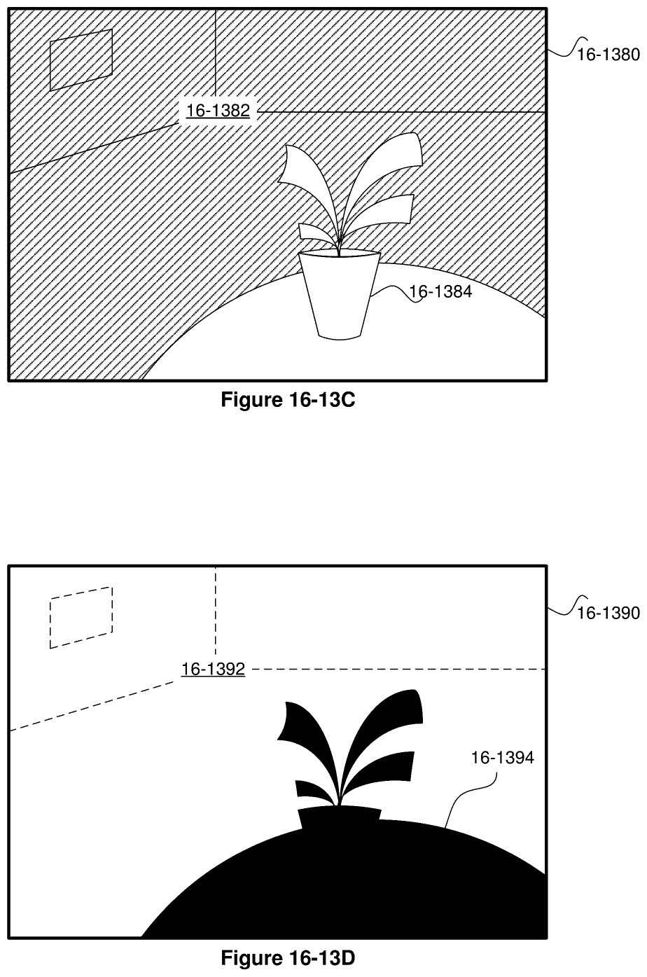

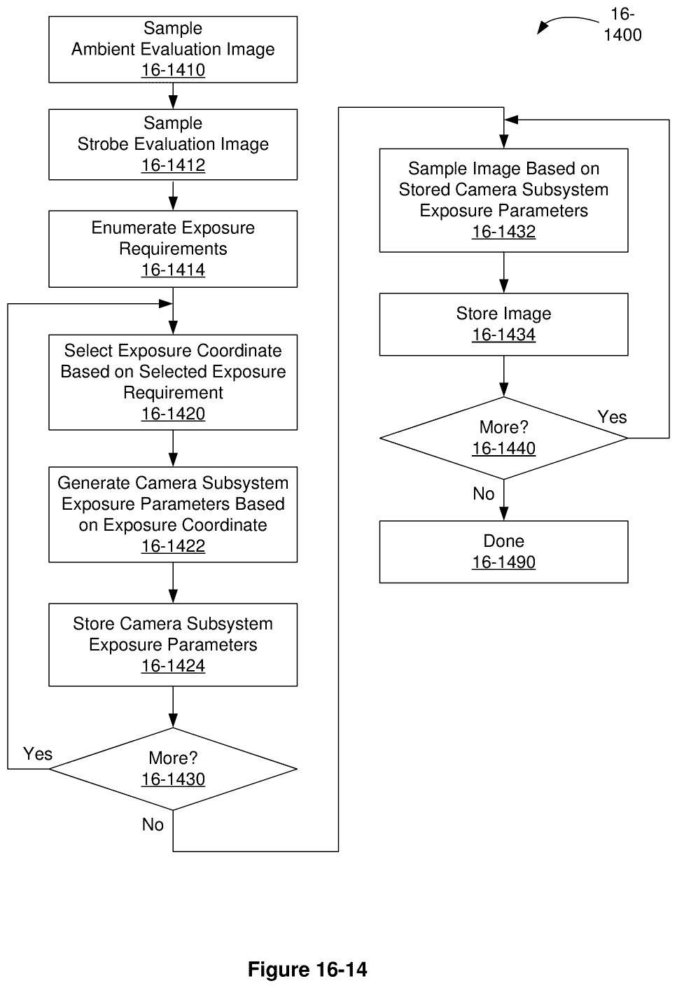

FIG. 16-1A illustrates a first data flow process 16-200 for generating a blended image 16-280 based on at least an ambient image 16-220 and a strobe image 16-210, according to one embodiment of the present invention. A strobe image 16-210 comprises a digital photograph sampled by camera unit 330 while strobe unit 336 is actively emitting strobe illumination 350. Ambient image 16-220 comprises a digital photograph sampled by camera unit 330 while strobe unit 336 is inactive and substantially not emitting strobe illumination 350. In other words, the ambient image 16-220 corresponds to a first lighting condition and the strobe image 16-210 corresponds to a second lighting condition.

In one embodiment, ambient image 16-220 is generated according to a prevailing ambient white balance for a scene being photographed. The prevailing ambient white balance may be computed using the well-known gray world model, an illuminator matching model, or any other technically feasible technique. Strobe image 16-210 should be generated according to an expected white balance for strobe illumination 350, emitted by strobe unit 336. Blend operation 16-270, discussed in greater detail below, blends strobe image 16-210 and ambient image 16-220 to generate a blended image 16-280 via preferential selection of image data from strobe image 16-210 in regions of greater intensity compared to corresponding regions of ambient image 16-220.

In one embodiment, data flow process 16-200 is performed by processor complex 310 within digital photographic system 300, and blend operation 16-270 is performed by at least one GPU core 372, one CPU core 370, or any combination thereof.

FIG. 16-1B illustrates a second data flow process 16-202 for generating a blended image 16-280 based on at least an ambient image 16-220 and a strobe image 16-210, according to one embodiment of the present invention. Strobe image 16-210 comprises a digital photograph sampled by camera unit 330 while strobe unit 336 is actively emitting strobe illumination 350. Ambient image 16-220 comprises a digital photograph sampled by camera unit 330 while strobe unit 336 is inactive and substantially not emitting strobe illumination 350.

In one embodiment, ambient image 16-220 is generated according to a prevailing ambient white balance for a scene being photographed. The prevailing ambient white balance may be computed using the well-known gray world model, an illuminator matching model, or any other technically feasible technique. In certain embodiments, strobe image 16-210 is generated according to the prevailing ambient white balance. In an alternative embodiment ambient image 16-220 is generated according to a prevailing ambient white balance, and strobe image 16-210 is generated according to an expected white balance for strobe illumination 350, emitted by strobe unit 336. In other embodiments, ambient image 16-210 and strobe image 16-220 comprise raw image data, having no white balance operation applied to either. Blended image 16-280 may be subjected to arbitrary white balance operations, as is common practice with raw image data, while advantageously retaining color consistency between regions dominated by ambient illumination and regions dominated by strobe illumination.

As a consequence of color balance differences between ambient illumination, which may dominate certain portions of strobe image 16-210 and strobe illumination 350, which may dominate other portions of strobe image 16-210, strobe image 16-210 may include color information in certain regions that is discordant with color information for the same regions in ambient image 16-220. Frame analysis operation 16-240 and color correction operation 16-250 together serve to reconcile discordant color information within strobe image 16-210. Frame analysis operation 16-240 generates color correction data 16-242, described in greater detail below, for adjusting color within strobe image 16-210 to converge spatial color characteristics of strobe image 16-210 to corresponding spatial color characteristics of ambient image 16-220. Color correction operation 16-250 receives color correction data 16-242 and performs spatial color adjustments to generate corrected strobe image data 16-252 from strobe image 16-210. Blend operation 16-270, discussed in greater detail below, blends corrected strobe image data 16-252 with ambient image 16-220 to generate blended image 16-280. Color correction data 16-242 may be generated to completion prior to color correction operation 16-250 being performed. Alternatively, certain portions of color correction data 16-242, such as spatial correction factors, may be generated as needed.

In one embodiment, data flow process 16-202 is performed by processor complex 310 within digital photographic system 300. In certain implementations, blend operation 16-270 and color correction operation 16-250 are performed by at least one GPU core 372, at least one CPU core 370, or a combination thereof. Portions of frame analysis operation 16-240 may be performed by at least one GPU core 372, one CPU core 370, or any combination thereof. Frame analysis operation 16-240 and color correction operation 16-250 are discussed in greater detail below.

FIG. 16-2A illustrates a third data flow process 16-204 for generating a blended image 16-280 based on at least an ambient image 16-220 and a strobe image 16-210, according to one embodiment of the present invention. Strobe image 16-210 comprises a digital photograph sampled by camera unit 330 while strobe unit 336 is actively emitting strobe illumination 350. Ambient image 16-220 comprises a digital photograph sampled by camera unit 330 while strobe unit 336 is inactive and substantially not emitting strobe illumination 350.

In one embodiment, ambient image 16-220 is generated according to a prevailing ambient white balance for a scene being photographed. The prevailing ambient white balance may be computed using the well-known gray world model, an illuminator matching model, or any other technically feasible technique. Strobe image 16-210 should be generated according to an expected white balance for strobe illumination 350, emitted by strobe unit 336.

In certain common settings, camera unit 330 resides within a hand-held device, which may be subject to a degree of involuntary random movement or “shake” while being held in a user's hand. In these settings, when the hand-held device sequentially samples two images, such as strobe image 16-210 and ambient image 16-220, the effect of shake may cause misalignment between the two images. The two images should be aligned prior to blend operation 16-270, discussed in greater detail below. Alignment operation 16-230 generates an aligned strobe image 16-232 from strobe image 16-210 and an aligned ambient image 16-234 from ambient image 16-220. Alignment operation 16-230 may implement any technically feasible technique for aligning images or sub-regions.

In one embodiment, alignment operation 16-230 comprises an operation to detect point pairs between strobe image 16-210 and ambient image 16-220, an operation to estimate an affine or related transform needed to substantially align the point pairs. Alignment may then be achieved by executing an operation to resample strobe image 16-210 according to the affine transform thereby aligning strobe image 16-210 to ambient image 16-220, or by executing an operation to resample ambient image 16-220 according to the affine transform thereby aligning ambient image 16-220 to strobe image 16-210. Aligned images typically overlap substantially with each other, but may also have non-overlapping regions. Image information may be discarded from non-overlapping regions during an alignment operation. Such discarded image information should be limited to relatively narrow boundary regions. In certain embodiments, resampled images are normalized to their original size via a scaling operation performed by one or more GPU cores 372.

In one embodiment, the point pairs are detected using a technique known in the art as a Harris affine detector. The operation to estimate an affine transform may compute a substantially optimal affine transform between the detected point pairs, comprising pairs of reference points and offset points. In one implementation, estimating the affine transform comprises computing a transform solution that minimizes a sum of distances between each reference point and each offset point subjected to the transform. Persons skilled in the art will recognize that these and other techniques may be implemented for performing the alignment operation 16-230 without departing the scope and spirit of the present invention.

In one embodiment, data flow process 16-204 is performed by processor complex 310 within digital photographic system 300. In certain implementations, blend operation 16-270 and resampling operations are performed by at least one GPU core.

FIG. 16-2B illustrates a fourth data flow process 16-206 for generating a blended image 16-280 based on at least an ambient image 16-220 and a strobe image 16-210, according to one embodiment of the present invention. Strobe image 16-210 comprises a digital photograph sampled by camera unit 330 while strobe unit 336 is actively emitting strobe illumination 350. Ambient image 16-220 comprises a digital photograph sampled by camera unit 330 while strobe unit 336 is inactive and substantially not emitting strobe illumination 350.

In one embodiment, ambient image 16-220 is generated according to a prevailing ambient white balance for a scene being photographed. The prevailing ambient white balance may be computed using the well-known gray world model, an illuminator matching model, or any other technically feasible technique. In certain embodiments, strobe image 16-210 is generated according to the prevailing ambient white balance. In an alternative embodiment ambient image 16-220 is generated according to a prevailing ambient white balance, and strobe image 16-210 is generated according to an expected white balance for strobe illumination 350, emitted by strobe unit 336. In other embodiments, ambient image 16-210 and strobe image 16-220 comprise raw image data, having no white balance operation applied to either. Blended image 16-280 may be subjected to arbitrary white balance operations, as is common practice with raw image data, while advantageously retaining color consistency between regions dominated by ambient illumination and regions dominated by strobe illumination.

Alignment operation 16-230, discussed previously in FIG. 16-2A, generates an aligned strobe image 16-232 from strobe image 16-210 and an aligned ambient image 16-234 from ambient image 16-220. Alignment operation 16-230 may implement any technically feasible technique for aligning images.

Frame analysis operation 16-240 and color correction operation 16-250, both discussed previously in FIG. 16-1B, operate together to generate corrected strobe image data 16-252 from aligned strobe image 16-232. Blend operation 16-270, discussed in greater detail below, blends corrected strobe image data 16-252 with ambient image 16-220 to generate blended image 16-280.

Color correction data 16-242 may be generated to completion prior to color correction operation 16-250 being performed. Alternatively, certain portions of color correction data 16-242, such as spatial correction factors, may be generated as needed. In one embodiment, data flow process 16-206 is performed by processor complex 310 within digital photographic system 300.

While frame analysis operation 16-240 is shown operating on aligned strobe image 16-232 and aligned ambient image 16-234, certain global correction factors may be computed from strobe image 16-210 and ambient image 16-220. For example, in one embodiment, a frame-level color correction factor, discussed below, may be computed from strobe image 16-210 and ambient image 16-220. In such an embodiment the frame-level color correction may be advantageously computed in parallel with alignment operation 16-230, reducing overall time required to generate blended image 16-280.

In certain embodiments, strobe image 16-210 and ambient image 16-220 are partitioned into two or more tiles and color correction operation 16-250, blend operation 16-270, and resampling operations comprising alignment operation 16-230 are performed on a per tile basis before being combined into blended image 16-280. Persons skilled in the art will recognize that tiling may advantageously enable finer grain scheduling of computational tasks among CPU cores 370 and GPU cores 372. Furthermore, tiling enables GPU cores 372 to advantageously operate on images having higher resolution in one or more dimensions than native two-dimensional surface support may allow for the GPU cores. For example, certain generations of GPU core are only configured to operate on 2048 by 2048 pixel images, but popular mobile devices include camera resolution of more than 2048 in one dimension and less than 2048 in another dimension. In such a system, two tiles may be used to partition strobe image 16-210 and ambient image 16-220 into two tiles each, thereby enabling a GPU having a resolution limitation of 2048 by 2048 to operate on the images. In one embodiment, a first of tile blended image 16-280 is computed to completion before a second tile for blended image 16-280 is computed, thereby reducing peak system memory required by processor complex 310.

FIG. 16-3A illustrates image blend operation 16-270, according to one embodiment of the present invention. A strobe image 16-310 and an ambient image 16-320 of the same horizontal resolution (H-res) and vertical resolution (V-res) are combined via blend function 16-330 to generate blended image 16-280 having the same horizontal resolution and vertical resolution. In alternative embodiments, strobe image 16-310 or ambient image 16-320, or both images may be scaled to an arbitrary resolution defined by blended image 16-280 for processing by blend function 16-330. Blend function 16-330 is described in greater detail below in FIGS. 16-3B-16-3D.

As shown, strobe pixel 16-312 and ambient pixel 16-322 are blended by blend function 16-330 to generate blended pixel 16-332, stored in blended image 16-280. Strobe pixel 16-312, ambient pixel 16-322, and blended pixel 16-332 are located in substantially identical locations in each respective image.

In one embodiment, strobe image 16-310 corresponds to strobe image 16-210 of FIG. 16-1A and ambient image 16-320 corresponds to ambient image 16-220. In another embodiment, strobe image 16-310 corresponds to corrected strobe image data 16-252 of FIG. 16-1B and ambient image 16-320 corresponds to ambient image 16-220. In yet another embodiment, strobe image 16-310 corresponds to aligned strobe image 16-232 of FIG. 16-2A and ambient image 16-320 corresponds to aligned ambient image 16-234. In still yet another embodiment, strobe image 16-310 corresponds to corrected strobe image data 16-252 of FIG. 16-2B, and ambient image 16-320 corresponds to aligned ambient image 16-234.

Blend operation 16-270 may be performed by one or more CPU cores 370, one or more GPU cores 372, or any combination thereof. In one embodiment, blend function 16-330 is associated with a fragment shader, configured to execute within one or more GPU cores 372.

FIG. 16-3B illustrates blend function 16-330 of FIG. 3A for blending pixels associated with a strobe image and an ambient image, according to one embodiment of the present invention. As shown, a strobe pixel 16-312 from strobe image 16-310 and an ambient pixel 16-322 from ambient image 16-320 are blended to generate a blended pixel 16-332 associated with blended image 16-280.

Strobe intensity 16-314 is calculated for strobe pixel 16-312 by intensity function 16-340. Similarly, ambient intensity 16-324 is calculated by intensity function 16-340 for ambient pixel 16-322. In one embodiment, intensity function 16-340 implements Equation 16-1, where Cr, Cg, Cb are contribution constants and Red, Green, and Blue represent color intensity values for an associated pixel:

$$Intensity = Cr * Red + Cg * Green + Cb * Blue \qquad ( Eq . 16 ‐ 1 )$$

A sum of the contribution constants should be equal to a maximum range value for Intensity. For example, if Intensity is defined to range from 0.0 to 1.0, then Cr+Cg+Cb=1.0. In one embodiment Cr=Cg=Cb=⅓.

Blend value function 16-342 receives strobe intensity 16-314 and ambient intensity 16-324 and generates a blend value 16-344. Blend value function 16-342 is described in greater detail in FIGS. 16-3B and 16-3C. In one embodiment, blend value 16-344 controls a linear mix operation 16-346 between strobe pixel 16-312 and ambient pixel 16-322 to generate blended pixel 16-332. Linear mix operation 16-346 receives Red, Green, and Blue values for strobe pixel 16-312 and ambient pixel 16-322. Linear mix operation 16-346 receives blend value 16-344, which determines how much strobe pixel 16-312 versus how much ambient pixel 16-322 will be represented in blended pixel 16-332. In one embodiment, linear mix operation 16-346 is defined by Equation 16-2, where Out corresponds to blended pixel 16-332, Blend corresponds to blend value 16-344, “A” corresponds to a color vector comprising ambient pixel 16-322, and “B” corresponds to a color vector comprising strobe pixel 16-312.

$$Out = ( Blend * B ) + ( 1. - Blend ) * A \qquad ( Eq . 16 ‐ 2 )$$

When blend value 16-344 is equal to 1.0, blended pixel 16-332 is entirely determined by strobe pixel 16-312. When blend value 16-344 is equal to 0.0, blended pixel 16-332 is entirely determined by ambient pixel 16-322. When blend value 16-344 is equal to 0.5, blended pixel 16-332 represents a per component average between strobe pixel 16-312 and ambient pixel 16-322.

FIG. 16-3C illustrates a blend surface 16-302 for blending two pixels, according to one embodiment of the present invention. In one embodiment, blend surface 16-302 defines blend value function 16-342 of FIG. 3B. Blend surface 16-302 comprises a strobe dominant region 16-352 and an ambient dominant region 16-350 within a coordinate system defined by an axis for each of ambient intensity 16-324, strobe intensity 16-314, and blend value 16-344. Blend surface 16-302 is defined within a volume where ambient intensity 16-324, strobe intensity 16-314, and blend value 16-344 may range from 0.0 to 1.0. Persons skilled in the art will recognize that a range of 0.0 to 1.0 is arbitrary and other numeric ranges may be implemented without departing the scope and spirit of the present invention.

When ambient intensity 16-324 is larger than strobe intensity 16-314, blend value 16-344 may be defined by ambient dominant region 16-350. Otherwise, when strobe intensity 16-314 is larger than ambient intensity 16-324, blend value 16-344 may be defined by strobe dominant region 16-352. Diagonal 16-351 delineates a boundary between ambient dominant region 16-350 and strobe dominant region 16-352, where ambient intensity 16-324 is equal to strobe intensity 16-314. As shown, a discontinuity of blend value 16-344 in blend surface 16-302 is implemented along diagonal 16-351, separating ambient dominant region 16-350 and strobe dominant region 16-352.

For simplicity, a particular blend value 16-344 for blend surface 16-302 will be described herein as having a height above a plane that intersects three points including points at (1,0,0), (0,1,0), and the origin (0,0,0). In one embodiment, ambient dominant region 16-350 has a height 16-359 at the origin and strobe dominant region 16-352 has a height 16-358 above height 16-359. Similarly, ambient dominant region 16-350 has a height 16-357 above the plane at location (1,1), and strobe dominant region 16-352 has a height 16-356 above height 16-357 at location (1,1). Ambient dominant region 16-350 has a height 16-355 at location (1,0) and strobe dominant region 16-352 has a height of 354 at location (0,1).

In one embodiment, height 16-355 is greater than 0.0, and height 16-354 is less than 1.0. Furthermore, height 16-357 and height 16-359 are greater than 0.0 and height 16-356 and height 16-358 are each greater than 0.25. In certain embodiments, height 16-355 is not equal to height 16-359 or height 16-357. Furthermore, height 16-354 is not equal to the sum of height 16-356 and height 16-357, nor is height 16-354 equal to the sum of height 16-358 and height 16-359.

The height of a particular point within blend surface 16-302 defines blend value 16-344, which then determines how much strobe pixel 16-312 and ambient pixel 16-322 each contribute to blended pixel 16-332. For example, at location (0,1), where ambient intensity is 0.0 and strobe intensity is 1.0, the height of blend surface 16-302 is given as height 16-354, which sets blend value 16-344 to a value for height 16-354. This value is used as blend value 16-344 in mix operation 16-346 to mix strobe pixel 16-312 and ambient pixel 16-322. At (0,1), strobe pixel 16-312 dominates the value of blended pixel 16-332, with a remaining, small portion of blended pixel 16-322 contributed by ambient pixel 16-322. Similarly, at (1,0), ambient pixel 16-322 dominates the value of blended pixel 16-332, with a remaining, small portion of blended pixel 16-322 contributed by strobe pixel 16-312.

Ambient dominant region 16-350 and strobe dominant region 16-352 are illustrated herein as being planar sections for simplicity. However, as shown in FIG. 16-3D, certain curvature may be added, for example, to provide smoother transitions, such as along at least portions of diagonal 16-351, where strobe pixel 16-312 and ambient pixel 16-322 have similar intensity. A gradient, such as a table top or a wall in a given scene, may include a number of pixels that cluster along diagonal 16-351. These pixels may look more natural if the height difference between ambient dominant region 16-350 and strobe dominant region 16-352 along diagonal 16-351 is reduced compared to a planar section. A discontinuity along diagonal 16-351 is generally needed to distinguish pixels that should be strobe dominant versus pixels that should be ambient dominant. A given quantization of strobe intensity 16-314 and ambient intensity 16-324 may require a certain bias along diagonal 16-351, so that either ambient dominant region 16-350 or strobe dominant region 16-352 comprises a larger area within the plane than the other.

FIG. 16-3D illustrates a blend surface 16-304 for blending two pixels, according to another embodiment of the present invention. Blend surface 16-304 comprises a strobe dominant region 16-352 and an ambient dominant region 16-350 within a coordinate system defined by an axis for each of ambient intensity 16-324, strobe intensity 16-314, and blend value 16-344. Blend surface 16-304 is defined within a volume substantially identical to blend surface 16-302 of FIG. 16-3E.

As shown, upward curvature at the origin (0,0) and at (1,1) is added to ambient dominant region 16-350, and downward curvature at (0,0) and (1,1) is added to strobe dominant region 16-352. As a consequence, a smoother transition may be observed within blended image 16-280 for very bright and very dark regions, where color may be less stable and may diverge between strobe image 16-310 and ambient image 16-320. Upward curvature may be added to ambient dominant region 16-350 along diagonal 16-351 and corresponding downward curvature may be added to strobe dominant region 16-352 along diagonal 16-351.

In certain embodiments, downward curvature may be added to ambient dominant region 16-350 at (1,0), or along a portion of the axis for ambient intensity 16-324. Such downward curvature may have the effect of shifting the weight of mix operation 16-346 to favor ambient pixel 16-322 when a corresponding strobe pixel 16-312 has very low intensity.

In one embodiment, a blend surface, such as blend surface 16-302 or blend surface 16-304, is pre-computed and stored as a texture map that is established as an input to a fragment shader configured to implement blend operation 16-270. A surface function that describes a blend surface having an ambient dominant region 16-350 and a strobe dominant region 16-352 is implemented to generate and store the texture map. The surface function may be implemented on a CPU core 370 of FIG. 3B or a GPU core 372, or a combination thereof. The fragment shader executing on a GPU core may use the texture map as a lookup table implementation of blend value function 16-342. In alternative embodiments, the fragment shader implements the surface function and computes a blend value 16-344 as needed for each combination of a strobe intensity 16-314 and an ambient intensity 16-324. One exemplary surface function that may be used to compute a blend value 16-344 (blendValue) given an ambient intensity 16-324 (ambient) and a strobe intensity 16-314 (strobe) is illustrated below as pseudo-code in Table 16-1. A constant “e” is set to a value that is relatively small, such as a fraction of a quantization step for ambient or strobe intensity, to avoid dividing by zero. Height 16-355 corresponds to constant 0.125 divided by 3.0.

TABLE 16-1

fDivA = strobe/(ambient + e);
fDivB = (1.0 − ambient) / ((1.0 − strobe) + (1.0 − ambient) + e)
temp = (fDivA >= 1.0) ? 1.0 : 0.125;
blendValue = (temp + 2.0 * fDivB) / 3.0;

In certain embodiments, the blend surface is dynamically configured based on image properties associated with a given strobe image 16-310 and corresponding ambient image 16-320. Dynamic configuration of the blend surface may include, without limitation, altering one or more of heights 16-354 through 359, altering curvature associated with one or more of heights 16-354 through 359, altering curvature along diagonal 16-351 for ambient dominant region 16-350, altering curvature along diagonal 16-351 for strobe dominant region 16-352, or any combination thereof.

One embodiment of dynamic configuration of a blend surface involves adjusting heights associated with the surface discontinuity along diagonal 16-351. Certain images disproportionately include gradient regions having strobe pixels 16-312 and ambient pixels 16-322 of similar or identical intensity. Regions comprising such pixels may generally appear more natural as the surface discontinuity along diagonal 16-351 is reduced. Such images may be detected using a heat-map of ambient intensity 16-324 and strobe intensity 16-314 pairs within a surface defined by ambient intensity 16-324 and strobe intensity 16-314. Clustering along diagonal 351 within the heat-map indicates a large incidence of strobe pixels 16-312 and ambient pixels 16-322 having similar intensity within an associated scene. In one embodiment, clustering along diagonal 16-351 within the heat-map indicates that the blend surface should be dynamically configured to reduce the height of the discontinuity along diagonal 16-351. Reducing the height of the discontinuity along diagonal 16-351 may be implemented via adding downward curvature to strobe dominant region 16-352 along diagonal 16-351, adding upward curvature to ambient dominant region 16-350 along diagonal 16-351, reducing height 16-358, reducing height 16-356, or any combination thereof. Any technically feasible technique may be implemented to adjust curvature and height values without departing the scope and spirit of the present invention. Furthermore, any region of blend surface 16-302 may be dynamically adjusted in response to image characteristics without departing the scope of the present invention.

In one embodiment, dynamic configuration of the blend surface comprises mixing blend values from two or more pre-computed lookup tables implemented as texture maps. For example, a first blend surface may reflect a relatively large discontinuity and relatively large values for heights 16-356 and 358, while a second blend surface may reflect a relatively small discontinuity and relatively small values for height 16-356 and 358. Here, blend surface 16-304 may be dynamically configured as a weighted sum of blend values from the first blend surface and the second blend surface. Weighting may be determined based on certain image characteristics, such as clustering of strobe intensity 16-314 and ambient intensity 16-324 pairs in certain regions within the surface defined by strobe intensity 16-314 and ambient intensity 16-324, or certain histogram attributes for strobe image 16-210 and ambient image 16-220. In one embodiment, dynamic configuration of one or more aspects of the blend surface, such as discontinuity height, may be adjusted according to direct user input, such as via a UI tool.

FIG. 16-3E illustrates an image blend operation 16-270 for blending a strobe image with an ambient image to generate a blended image, according to one embodiment of the present invention. A strobe image 16-310 and an ambient image 16-320 of the same horizontal resolution and vertical resolution are combined via mix operation 16-346 to generate blended image 16-280 having the same resolution horizontal resolution and vertical resolution. In alternative embodiments, strobe image 16-310 or ambient image 16-320, or both images may be scaled to an arbitrary resolution defined by blended image 16-280 for processing by mix operation 16-346.

In certain settings, strobe image 16-310 and ambient image 16-320 include a region of pixels having similar intensity per pixel but different color per pixel. Differences in color may be attributed to differences in white balance for each image and different illumination contribution for each image. Because the intensity among adjacent pixels is similar, pixels within the region will cluster along diagonal 16-351 of FIGS. 16-3B and 16-3C, resulting in a distinctly unnatural speckling effect as adjacent pixels are weighted according to either strobe dominant region 16-352 or ambient dominant region 16-350. To soften this speckling effect and produce a natural appearance within these regions, blend values may be blurred, effectively reducing the discontinuity between strobe dominant region 16-352 and ambient dominant region 16-350. As is well-known in the art, blurring may be implemented by combining two or more individual samples.

In one embodiment, a blend buffer 16-315 comprises blend values 16-345, which are computed from a set of two or more blend samples. Each blend sample is computed according to blend function 16-330, described previously in conjunction with FIGS. 16-3B-16-3D. In one embodiment, blend buffer 16-315 is first populated with blend samples, computed according to blend function 16-330. The blend samples are then blurred to compute each blend value 16-345, which is stored to blend buffer 16-315. In other embodiments, a first blend buffer is populated with blend samples computed according to blend function 16-330, and two or more blend samples from the first blend buffer are blurred together to generate blend each value 16-345, which is stored in blend buffer 16-315. In yet other embodiments, two or more blend samples from the first blend buffer are blurred together to generate each blend value 16-345 as needed. In still another embodiment, two or more pairs of strobe pixels 16-312 and ambient pixels 16-322 are combined to generate each blend value 16-345 as needed. Therefore, in certain embodiments, blend buffer 16-315 comprises an allocated buffer in memory, while in other embodiments blend buffer 16-315 comprises an illustrative abstraction with no corresponding allocation in memory.

As shown, strobe pixel 16-312 and ambient pixel 16-322 are mixed based on blend value 16-345 to generate blended pixel 16-332, stored in blended image 16-280. Strobe pixel 16-312, ambient pixel 16-322, and blended pixel 16-332 are located in substantially identical locations in each respective image.

In one embodiment, strobe image 16-310 corresponds to strobe image 16-210 and ambient image 16-320 corresponds to ambient image 16-220. In other embodiments, strobe image 16-310 corresponds to aligned strobe image 16-232 and ambient image 16-320 corresponds to aligned ambient image 16-234. In one embodiment, mix operation 16-346 is associated with a fragment shader, configured to execute within one or more GPU cores 372.

As discussed previously in FIGS. 16-2B and 16-2D, strobe image 16-210 may need to be processed to correct color that is divergent from color in corresponding ambient image 16-220. Strobe image 16-210 may include frame-level divergence, spatially localized divergence, or a combination thereof. FIGS. 16-4A and 16-4B describe techniques implemented in frame analysis operation 16-240 for computing color correction data 16-242. In certain embodiments, color correction data 16-242 comprises frame-level characterization data for correcting overall color divergence, and patch-level correction data for correcting localized color divergence. FIGS. 16-5A and 16-5B discuss techniques for implementing color correction operation 16-250, based on color correction data 16-242.

FIG. 16-4A illustrates a patch-level analysis process 16-400 for generating a patch correction array 16-450, according to one embodiment of the present invention. Patch-level analysis provides local color correction information for correcting a region of a source strobe image to be consistent in overall color balance with an associated region of a source ambient image. A patch corresponds to a region of one or more pixels within an associated source image. A strobe patch 16-412 comprises representative color information for a region of one or more pixels within strobe patch array 16-410, and an associated ambient patch 16-422 comprises representative color information for a region of one or more pixels at a corresponding location within ambient patch array 16-420.

In one embodiment, strobe patch array 16-410 and ambient patch array 16-420 are processed on a per patch basis by patch-level correction estimator 16-430 to generate patch correction array 16-450. Strobe patch array 16-410 and ambient patch array 16-420 each comprise a two-dimensional array of patches, each having the same horizontal patch resolution and the same vertical patch resolution. In alternative embodiments, strobe patch array 16-410 and ambient patch array 16-420 may each have an arbitrary resolution and each may be sampled according to a horizontal and vertical resolution for patch correction array 16-450.

In one embodiment, patch data associated with strobe patch array 16-410 and ambient patch array 16-420 may be pre-computed and stored for substantially entire corresponding source images. Alternatively, patch data associated with strobe patch array 16-410 and ambient patch array 16-420 may be computed as needed, without allocating buffer space for strobe patch array 16-410 or ambient patch array 16-420.

In data flow process 16-202 of FIG. 16-1B, the source strobe image comprises strobe image 16-210, while in data flow process 16-206 of FIG. 16-2B, the source strobe image comprises aligned strobe image 16-232. Similarly, ambient patch array 16-420 comprises a set of patches generated from a source ambient image. In data flow process 16-202, the source ambient image comprises ambient image 16-220, while in data flow process 16-206, the source ambient image comprises aligned ambient image 16-234.

In one embodiment, representative color information for each patch within strobe patch array 16-410 is generated by averaging color for a four-by-four region of pixels from the source strobe image at a corresponding location, and representative color information for each patch within ambient patch array 16-420 is generated by averaging color for a four-by-four region of pixels from the ambient source image at a corresponding location. An average color may comprise red, green and blue components. Each four-by-four region may be non-overlapping or overlapping with respect to other four-by-four regions. In other embodiments, arbitrary regions may be implemented. Patch-level correction estimator 16-430 generates patch correction 16-432 from strobe patch 16-412 and a corresponding ambient patch 16-422. In certain embodiments, patch correction 16-432 is saved to patch correction array 16-450 at a corresponding location. In one embodiment, patch correction 16-432 includes correction factors for red, green, and blue, computed according to the pseudo-code of Table 16-2, below.

TABLE 16-2

ratio.r = (ambient.r) / (strobe.r);
ratio.g = (ambient.g) / (strobe.g);
ratio.b = (ambient.b) / (strobe.b);
maxRatio = max(ratio.r, max(ratio.g, ratio.b));
correct.r = (ratio.r / maxRatio);
correct.g = (ratio.g / maxRatio);
correct.b = (ratio.b / maxRatio);

Here, “strobe.r” refers to a red component for strobe patch 16-412, “strobe.g” refers to a green component for strobe patch 16-412, and “strobe.b” refers to a blue component for strobe patch 16-412. Similarly, “ambient.r,” “ambient.g,” and “ambient.b” refer respectively to red, green, and blue components of ambient patch 16-422. A maximum ratio of ambient to strobe components is computed as “maxRatio,” which is then used to generate correction factors, including “correct.r” for a red channel, “correct.g” for a green channel, and “correct.b” for a blue channel. Correction factors correct.r, correct.g, and correct.b together comprise patch correction 16-432. These correction factors, when applied fully in color correction operation 16-250, cause pixels associated with strobe patch 16-412 to be corrected to reflect a color balance that is generally consistent with ambient patch 16-422.

In one alternative embodiment, each patch correction 16-432 comprises a slope and an offset factor for each one of at least red, green, and blue components. Here, components of source ambient image pixels bounded by a patch are treated as function input values and corresponding components of source strobe image pixels are treated as function outputs for a curve fitting procedure that estimates slope and offset parameters for the function. For example, red components of source ambient image pixels associated with a given patch may be treated as “X” values and corresponding red pixel components of source strobe image pixels may be treated as “Y” values, to form (X,Y) points that may be processed according to a least-squares linear fit procedure, thereby generating a slope parameter and an offset parameter for the red component of the patch. Slope and offset parameters for green and blue components may be computed similarly. Slope and offset parameters for a component describe a line equation for the component. Each patch correction 16-432 includes slope and offset parameters for at least red, green, and blue components. Conceptually, pixels within an associated strobe patch may be color corrected by evaluating line equations for red, green, and blue components.

In a different alternative embodiment, each patch correction 16-432 comprises three parameters describing a quadratic function for each one of at least red, green, and blue components. Here, components of source strobe image pixels bounded by a patch are fit against corresponding components of source ambient image pixels to generate quadratic parameters for color correction. Conceptually, pixels within an associated strobe patch may be color corrected by evaluating quadratic equations for red, green, and blue components.

FIG. 16-4B illustrates a frame-level analysis process 16-402 for generating frame-level characterization data 16-492, according to one embodiment of the present invention. Frame-level correction estimator 16-490 reads strobe data 16-472 comprising pixels from strobe image data 16-470 and ambient data 16-482 comprising pixels from ambient image data 16-480 to generate frame-level characterization data 16-492.

In certain embodiments, strobe data 16-472 comprises pixels from strobe image 16-210 of FIG. 16-1A and ambient data 16-482 comprises pixels from ambient image 16-220. In other embodiments, strobe data 16-472 comprises pixels from aligned strobe image 16-232 of FIG. 16-2A, and ambient data 16-482 comprises pixels from aligned ambient image 16-234. In yet other embodiments, strobe data 16-472 comprises patches representing average color from strobe patch array 16-410, and ambient data 16-482 comprises patches representing average color from ambient patch array 16-420.

In one embodiment, frame-level characterization data 16-492 includes at least frame-level color correction factors for red correction, green correction, and blue correction. Frame-level color correction factors may be computed according to the pseudo-code of Table 16-3.

TABLE 16-3

ratioSum.r = (ambientSum.r) / (strobeSum.r);
ratioSum.g = (ambientSum.g) / (strobeSum.g);
ratioSum.b = (ambientSum.b) / (strobeSum.b);
maxSumRatio = max(ratioSum.r, max(ratioSum.g, ratioSum.b));
correctFrame.r = (ratioSum.r / maxSumRatio);
correctFrame.g = (ratioSum.g / maxSumRatio);
correctFrame.b = (ratioSum.b / maxSumRatio);

Here, “strobeSum.r” refers to a sum of red components taken over strobe image data 16-470, “strobeSum.g” refers to a sum of green components taken over strobe image data 16-470, and “strobeSum.b” refers to a sum of blue components taken over strobe image data 16-470. Similarly, “ambientSum.r,” “ambientSum.g,” and “ambientSum.b” each refer to a sum of components taken over ambient image data 16-480 for respective red, green, and blue components. A maximum ratio of ambient to strobe sums is computed as “maxSumRatio,” which is then used to generate frame-level color correction factors, including “correctFrame.r” for a red channel, “correctFrame.g” for a green channel, and “correctFrame.b” for a blue channel. These frame-level color correction factors, when applied fully and exclusively in color correction operation 16-250, cause overall color balance of strobe image 16-210 to be corrected to reflect a color balance that is generally consistent with that of ambient image 16-220.

While overall color balance for strobe image 16-210 may be corrected to reflect overall color balance of ambient image 16-220, a resulting color corrected rendering of strobe image 16-210 based only on frame-level color correction factors may not have a natural appearance and will likely include local regions with divergent color with respect to ambient image 16-220. Therefore, as described below in FIG. 16-5A, patch-level correction may be used in conjunction with frame-level correction to generate a color corrected strobe image.

In one embodiment, frame-level characterization data 16-492 also includes at least a histogram characterization of strobe image data 16-470 and a histogram characterization of ambient image data 16-480. Histogram characterization may include identifying a low threshold intensity associated with a certain low percentile of pixels, a median threshold intensity associated with a fiftieth percentile of pixels, and a high threshold intensity associated with a high threshold percentile of pixels. In one embodiment, the low threshold intensity is associated with an approximately fifteenth percentile of pixels and a high threshold intensity is associated with an approximately eighty-fifth percentile of pixels, so that approximately fifteen percent of pixels within an associated image have a lower intensity than a calculated low threshold intensity and approximately eighty-five percent of pixels have a lower intensity than a calculated high threshold intensity.

In certain embodiments, frame-level characterization data 16-492 also includes at least a heat-map, described previously. The heat-map may be computed using individual pixels or patches representing regions of pixels. In one embodiment, the heat-map is normalized using a logarithm operator, configured to normalize a particular heat-map location against a logarithm of a total number of points contributing to the heat-map. Alternatively, frame-level characterization data 16-492 includes a factor that summarizes at least one characteristic of the heat-map, such as a diagonal clustering factor to quantify clustering along diagonal 16-351 of FIGS. 16-3C and 16-3D. This diagonal clustering factor may be used to dynamically configure a given blend surface.

While frame-level and patch-level correction coefficients have been discussed representing two different spatial extents, persons skilled in the art will recognize that more than two levels of spatial extent may be implemented without departing the scope and spirit of the present invention.

FIG. 16-5A illustrates a data flow process 16-500 for correcting strobe pixel color, according to one embodiment of the present invention. A strobe pixel 16-520 is processed to generate a color corrected strobe pixel 16-512. In one embodiment, strobe pixel 16-520 comprises a pixel associated with strobe image 16-210 of FIG. 16-1B, ambient pixel 16-522 comprises a pixel associated with ambient image 16-220, and color corrected strobe pixel 16-512 comprises a pixel associated with corrected strobe image data 16-252. In an alternative embodiment, strobe pixel 16-520 comprises a pixel associated with aligned strobe image 16-232 of FIG. 16-2B, ambient pixel 16-522 comprises a pixel associated with aligned ambient image 16-234, and color corrected strobe pixel 16-512 comprises a pixel associated with corrected strobe image data 16-252. Color corrected strobe pixel 16-512 may correspond to strobe pixel 16-312 in FIG. 3A, and serve as an input to blend function 16-330.

In one embodiment, patch-level correction factors 16-525 comprise one or more sets of correction factors for red, green, and blue associated with patch correction 16-432 of FIG. 16-4A, frame-level correction factors 16-527 comprise frame-level correction factors for red, green, and blue associated with frame-level characterization data 16-492 of FIG. 16-4B, and frame-level histogram factors 16-529 comprise at least a low threshold intensity and a median threshold intensity for both an ambient histogram and a strobe histogram associated with frame-level characterization data 16-492.

A pixel-level trust estimator 16-502 computes a pixel-level trust factor 16-503 from strobe pixel 16-520 and ambient pixel 16-522. In one embodiment, pixel-level trust factor 16-503 is computed according to the pseudo-code of Table 16-4, where strobe pixel 16-520 corresponds to strobePixel, ambient pixel 16-522 corresponds to ambientPixel, and pixel-level trust factor 16-503 corresponds to pixelTrust. Here, ambientPixel and strobePixel may comprise a vector variable, such as a well-known vec3 or vec4 vector variable.

TABLE 16-4

ambientIntensity = intensity (ambientPixel);
strobeIntensity = intensity (strobePixel);
stepInput = ambientIntensity * strobeIntensity;
pixelTrust = smoothstep (lowEdge, highEdge, stepInput);

Here, an intensity function may implement Equation 16-1 to compute ambientIntensity and strobeIntensity, corresponding respectively to an intensity value for ambientPixel and an intensity value for strobePixel. While the same intensity function is shown computing both ambientIntensity and strobeIntensity, certain embodiments may compute each intensity value using a different intensity function. A product operator may be used to compute stepInput, based on ambientIntensity and strobeIntensity. The well-known smoothstep function implements a relatively smoothly transition from 0.0 to 1.0 as stepInput passes through lowEdge and then through highEdge. In one embodiment, lowEge=0.25 and highEdge=0.66.

A patch-level correction estimator 16-504 computes patch-level correction factors 16-505 by sampling patch-level correction factors 16-525. In one embodiment, patch-level correction estimator 16-504 implements bilinear sampling over four sets of patch-level color correction samples to generate sampled patch-level correction factors 16-505. In an alternative embodiment, patch-level correction estimator 16-504 implements distance weighted sampling over four or more sets of patch-level color correction samples to generate sampled patch-level correction factors 16-505. In another alternative embodiment, a set of sampled patch-level correction factors 16-505 is computed using pixels within a region centered about strobe pixel 16-520. Persons skilled in the art will recognize that any technically feasible technique for sampling one or more patch-level correction factors to generate sampled patch-level correction factors 16-505 is within the scope and spirit of the present invention.

In one embodiment, each one of patch-level correction factors 16-525 comprises a red, green, and blue color channel correction factor. In a different embodiment, each one of the patch-level correction factors 16-525 comprises a set of line equation parameters for red, green, and blue color channels. Each set of line equation parameters may include a slope and an offset. In another embodiment, each one of the patch-level correction factors 16-525 comprises a set of quadratic curve parameters for red, green, and blue color channels. Each set of quadratic curve parameters may include a square term coefficient, a linear term coefficient, and a constant.

In one embodiment, frame-level correction adjustor 16-506 computes adjusted frame-level correction factors 16-507 from the frame-level correction factors for red, green, and blue according to the pseudo-code of Table 16-5. Here, a mix operator may function according to Equation 16-2, where variable A corresponds to 1.0, variable B corresponds to a correctFrame color value, and frameTrust may be computed according to an embodiment described below in conjunction with the pseudo-code of Table 6. As discussed previously, correctFrame comprises frame-level correction factors. Parameter frameTrust quantifies how trustworthy a particular pair of ambient image and strobe image may be for performing frame-level color correction.

TABLE 16-5

adjCorrectFrame.r = mix(1.0, correctFrame.r, frameTrust);
adjCorrectFrame.g = mix(1.0, correctFrame.g, frameTrust);
adjCorrectFrame.b = mix(1.0, correctFrame.b, frameTrust);

When frameTrust approaches zero (correction factors not trustworthy), the adjusted frame-level correction factors 16-507 converge to 1.0, which yields no frame-level color correction. When frameTrust is 1.0 (completely trustworthy), the adjusted frame-level correction factors 16-507 converge to values calculated previously in Table 16-3. The pseudo-code of Table 16-6 illustrates one technique for calculating frameTrust.

TABLE 16-6

strobeExp = (WSL*SL + WSM*SM + WSH*SH) /
(WSL + WSM + WSH);
ambientExp = (WAL*SL + WAM*SM + WAH*SH) /
(WAL + WAM + WAH);
frameTrustStrobe = smoothstep (SLE, SHE, strobeExp);
frameTrustAmbient = smoothstep (ALE, AHE, ambientExp);
frameTrust = frameTrustStrobe * frameTrustAmbient;

Here, strobe exposure (strobeExp) and ambient exposure (ambientExp) are each characterized as a weighted sum of corresponding low threshold intensity, median threshold intensity, and high threshold intensity values. Constants WSL, WSM, and WSH correspond to strobe histogram contribution weights for low threshold intensity, median threshold intensity, and high threshold intensity values, respectively. Variables SL, SM, and SH correspond to strobe histogram low threshold intensity, median threshold intensity, and high threshold intensity values, respectively. Similarly, constants WAL, WAM, and WAH correspond to ambient histogram contribution weights for low threshold intensity, median threshold intensity, and high threshold intensity values, respectively; and variables AL, AM, and AH correspond to ambient histogram low threshold intensity, median threshold intensity, and high threshold intensity values, respectively. A strobe frame-level trust value (frameTrustStrobe) is computed for a strobe frame associated with strobe pixel 16-520 to reflect how trustworthy the strobe frame is for the purpose of frame-level color correction. In one embodiment, WSL=WAL=1.0, WSM=WAM=2.0, and WSH=WAH=0.0. In other embodiments, different weights may be applied, for example, to customize the techniques taught herein to a particular camera apparatus. In certain embodiments, other percentile thresholds may be measured, and different combinations of weighted sums may be used to compute frame-level trust values.

In one embodiment, a smoothstep function with a strobe low edge (SLE) and strobe high edge (SHE) is evaluated based on strobeExp. Similarly, a smoothstep function with ambient low edge (ALE) and ambient high edge (AHE) is evaluated to compute an ambient frame-level trust value (frameTrustAmbient) for an ambient frame associated with ambient pixel 16-522 to reflect how trustworthy the ambient frame is for the purpose of frame-level color correction. In one embodiment, SLE=ALE=0.15, and SHE=AHE=0.30. In other embodiments, different low and high edge values may be used.

In one embodiment, a frame-level trust value (frameTrust) for frame-level color correction is computed as the product of frameTrustStrobe and frameTrustAmbient. When both the strobe frame and the ambient frame are sufficiently exposed and therefore trustworthy frame-level color references, as indicated by frameTrustStrobe and frameTrustAmbient, the product of frameTrustStrobe and frameTrustAmbient will reflect a high trust for frame-level color correction. If either the strobe frame or the ambient frame is inadequately exposed to be a trustworthy color reference, then a color correction based on a combination of strobe frame and ambient frame should not be trustworthy, as reflected by a low or zero value for frameTrust.

In an alternative embodiment, the frame-level trust value (frameTrust) is generated according to direct user input, such as via a UI color adjustment tool having a range of control positions that map to a frameTrust value. The UI color adjustment tool may generate a full range of frame-level trust values (0.0 to 1.0) or may generate a value constrained to a computed range. In certain settings, the mapping may be non-linear to provide a more natural user experience. In one embodiment, the control position also influences pixel-level trust factor 16-503 (pixelTrust), such as via a direct bias or a blended bias.

A pixel-level correction estimator 16-508 is configured to generate pixel-level correction factors 16-509 from sampled patch-level correction factors 16-505, adjusted frame-level correction factors 16-507, and pixel-level trust factor 16-503. In one embodiment, pixel-level correction estimator 16-508 comprises a mix function, whereby sampled patch-level correction factors 16-505 is given substantially full mix weight when pixel-level trust factor 16-503 is equal to 1.0 and adjusted frame-level correction factors 16-507 is given substantially full mix weight when pixel-level trust factor 16-503 is equal to 0.0. Pixel-level correction estimator 16-508 may be implemented according to the pseudo-code of Table 16-7.

TABLE 16-7

pixCorrection.r = mix(adjCorrectFrame.r, correct.r, pixelTrust);
pixCorrection.g= mix(adjCorrectFrame.g, correct.g, pixelTrust);
pixCorrection.b = mix(adjCorrectFrame.b, correct.b, pixelTrust);

In another embodiment, line equation parameters comprising slope and offset define sampled patch-level correction factors 16-505 and adjusted frame-level correction factors 16-507. These line equation parameters are mixed within pixel-level correction estimator 16-508 according to pixelTrust to yield pixel-level correction factors 16-509 comprising line equation parameters for red, green, and blue channels. In yet another embodiment, quadratic parameters define sampled patch-level correction factors 16-505 and adjusted frame-level correction factors 16-507. In one embodiment, the quadratic parameters are mixed within pixel-level correction estimator 16-508 according to pixelTrust to yield pixel-level correction factors 16-509 comprising quadratic parameters for red, green, and blue channels. In another embodiment, quadratic equations are evaluated separately for frame-level correction factors and patch level correction factors for each color channel, and the results of evaluating the quadratic equations are mixed according to pixelTrust.

In certain embodiments, pixelTrust is at least partially computed by image capture information, such as exposure time or exposure ISO index. For example, if an image was captured with a very long exposure at a very high ISO index, then the image may include significant chromatic noise and may not represent a good frame-level color reference for color correction.

Pixel-level correction function 16-510 generates color corrected strobe pixel 16-512 from strobe pixel 16-520 and pixel-level correction factors 16-509. In one embodiment, pixel-level correction factors 16-509 comprise correction factors pixCorrection.r, pixCorrection.g, and pixCorrection.b and color corrected strobe pixel 16-512 is computed according to the pseudo-code of Table 16-8.

TABLE 16-8
// scale red, green, blue
vec3 pixCorrection = (pixCorrection.r, pixCorrection.g, pixCorrection.b);
vec3 deNormCorrectedPixel = strobePixel * pixCorrection;
normalizeFactor = length(strobePixel) / length(deNormCorrectedPixel);
vec3 normCorrectedPixel = deNormCorrectedPixel * normalizeFactor;
vec3 correctedPixel = cAttractor(normCorrectedPixel);

Here, pixCorrection comprises a vector of three components (vec3) corresponding pixel-level correction factors pixCorrection.r, pixCorrection.g, and pixCorrection.b. A de-normalized, color corrected pixel is computed as deNormCorrectedPixel. A pixel comprising a red, green, and blue component defines a color vector in a three-dimensional space, the color vector having a particular length. The length of a color vector defined by deNormCorrectedPixel may be different with respect to a color vector defined by strobePixel. Altering the length of a color vector changes the intensity of a corresponding pixel. To maintain proper intensity for color corrected strobe pixel 16-512, deNormCorrectedPixel is re-normalized via normalizeFactor, which is computed as a ratio of length for a color vector defined by strobePixel to a length for a color vector defined by deNormCorrectedPixel. Color vector normCorrectedPixel includes pixel-level color correction and re-normalization to maintain proper pixel intensity. A length function may be performed using any technically feasible technique, such as calculating a square root of a sum of squares for individual vector component lengths.

A chromatic attractor function (cAttractor) gradually converges an input color vector to a target color vector as the input color vector increases in length. Below a threshold length, the chromatic attractor function returns the input color vector. Above the threshold length, the chromatic attractor function returns an output color vector that is increasingly convergent on the target color vector. The chromatic attractor function is described in greater detail below in FIG. 16-5B.

In alternative embodiments, pixel-level correction factors comprise a set of line equation parameters per color channel, with color components of strobePixel comprising function inputs for each line equation. In such embodiments, pixel-level correction function 16-510 evaluates the line equation parameters to generate color corrected strobe pixel 16-512. This evaluation process is illustrated in the pseudo-code of Table 16-9.

TABLE 16-9
// evaluate line equation based on strobePixel for red, green, blue
vec3 pixSlope = (pixSlope.r, pixSlope.g, pixSlope.b);
vec3 pixOffset = (pixOffset.r, pixOffset.g, pixOffset.b);
vec3 deNormCorrectedPixel = (strobePixel * pixSlope) + pixOffset;
normalizeFactor = length(strobePixel) / length(deNormCorrectedPixel);
vec3 normCorrectedPixel = deNormCorrectedPixel * normalizeFactor;
vec3 correctedPixel = cAttractor(normCorrectedPixel);

In other embodiments, pixel level correction factors comprise a set of quadratic parameters per color channel, with color components of strobePixel comprising function inputs for each quadratic equation. In such embodiments, pixel-level correction function 16-510 evaluates the quadratic equation parameters to generate color corrected strobe pixel 16-512.

In certain embodiments chromatic attractor function (cAttractor) implements a target color vector of white (1, 1, 1), and causes very bright pixels to converge to white, providing a natural appearance to bright portions of an image. In other embodiments, a target color vector is computed based on spatial color information, such as an average color for a region of pixels surrounding the strobe pixel. In still other embodiments, a target color vector is computed based on an average frame-level color. A threshold length associated with the chromatic attractor function may be defined as a constant, or, without limitation, by a user input, a characteristic of a strobe image or an ambient image or a combination thereof. In an alternative embodiment, pixel-level correction function 16-510 does not implement the chromatic attractor function.

In one embodiment, a trust level is computed for each patch-level correction and applied to generate an adjusted patch-level correction factor comprising sampled patch-level correction factors 16-505. Generating the adjusted patch-level correction may be performed according to the techniques taught herein for generating adjusted frame-level correction factors 16-507.

Other embodiments include two or more levels of spatial color correction for a strobe image based on an ambient image, where each level of spatial color correction may contribute a non-zero weight to a color corrected strobe image comprising one or more color corrected strobe pixels. Such embodiments may include patches of varying size comprising varying shapes of pixel regions without departing the scope of the present invention.

FIG. 16-5B illustrates a chromatic attractor function 16-560, according to one embodiment of the present invention. A color vector space is shown having a red axis 16-562, a green axis 16-564, and a blue axis 16-566. A unit cube 16-570 is bounded by an origin at coordinate (0, 0, 0) and an opposite corner at coordinate (1, 1, 1). A surface 16-572 having a threshold distance from the origin is defined within the unit cube. Color vectors having a length that is shorter than the threshold distance are conserved by the chromatic attractor function 16-560. Color vectors having a length that is longer than the threshold distance are converged towards a target color. For example, an input color vector 16-580 is defined along a particular path that describes the color of the input color vector 16-580, and a length that describes the intensity of the color vector. The distance from the origin to point 16-582 along input color vector 16-580 is equal to the threshold distance. In this example, the target color is pure white (1, 1, 1), therefore any additional length associated with input color vector 16-580 beyond point 16-582 follows path 16-584 towards the target color of pure white.

One implementation of chromatic attractor function 16-560, comprising the cAttractor function of Tables 16-8 and 16-9 is illustrated in the pseudo-code of Table 16-10.

TABLE 16-10

extraLength = max(length (inputColor), distMin) ;
mixValue= (extraLength − distMin) / (distMax− distMin);
outputColor = mix (inputColor, targetColor, mixValue);

Here, a length value associated with inputColor is compared to distMin, which represents the threshold distance. If the length value is less than distMin, then the “max” operator returns distMin. The mixValue term calculates a parameterization from 0.0 to 1.0 that corresponds to a length value ranging from the threshold distance to a maximum possible length for the color vector, given by the square root of 3.0. If extraLength is equal to distMin, then mixValue is set equal to 0.0 and outputColor is set equal to the inputColor by the mix operator. Otherwise, if the length value is greater than distMin, then mixValue represents the parameterization, enabling the mix operator to appropriately converge inputColor to targetColor as the length of inputColor approaches the square root of 3.0. In one embodiment, distMax is equal to the square root of 3.0 and distMin=1.45. In other embodiments different values may be used for distMax and distMin. For example, if distMin=1.0, then chromatic attractor 16-560 begins to converge to targetColor much sooner, and at lower intensities. If distMax is set to a larger number, then an inputPixel may only partially converge on targetColor, even when inputPixel has a very high intensity. Either of these two effects may be beneficial in certain applications.

While the pseudo-code of Table 16-10 specifies a length function, in other embodiments, computations may be performed in length-squared space using constant squared values with comparable results.

In one embodiment, targetColor is equal to (1,1,1), which represents pure white and is an appropriate color to “burn” to in overexposed regions of an image rather than a color dictated solely by color correction. In another embodiment, targetColor is set to a scene average color, which may be arbitrary. In yet another embodiment, targetColor is set to a color determined to be the color of an illumination source within a given scene.

FIG. 16-6 is a flow diagram of a method 16-600 for generating an adjusted digital photograph, according to one embodiment of the present invention. Although the method steps are described in conjunction with the systems of FIGS. 3A-3D, persons skilled in the art will understand that any system configured to perform the method steps, in any order, is within the scope of the present invention.

Method 16-600 begins in step 16-610, where a digital photographic system, such as digital photographic system 16-300 of FIG. 3A, receives a trigger command to take (i.e., capture) a digital photograph. The trigger command may comprise a user input event, such as a button press, remote control command related to a button press, completion of a timer count down, an audio indication, or any other technically feasible user input event. In one embodiment, the digital photographic system implements digital camera 302 of FIG. 3C, and the trigger command is generated when shutter release button 315 is pressed. In another embodiment, the digital photographic system implements mobile device 376 of FIG. 3D, and the trigger command is generated when a UI button is pressed.

In step 16-612, the digital photographic system samples a strobe image and an ambient image. In one embodiment, the strobe image is taken before the ambient image. Alternatively, the ambient image is taken before the strobe image. In certain embodiments, a white balance operation is performed on the ambient image. Independently, a white balance operation may be performed on the strobe image. In other embodiments, such as in scenarios involving raw digital photographs, no white balance operation is applied to either the ambient image or the strobe image.

In step 16-614, the digital photographic system generates a blended image from the strobe image and the ambient image. In one embodiment, the digital photographic system generates the blended image according to data flow process 16-200 of FIG. 16-1A. In a second embodiment, the digital photographic system generates the blended image according to data flow process 16-202 of FIG. 16-1B. In a third embodiment, the digital photographic system generates the blended image according to data flow process 16-204 of FIG. 16-2A. In a fourth embodiment, the digital photographic system generates the blended image according to data flow process 16-206 of FIG. 16-2B. In each of these embodiments, the strobe image comprises strobe image 16-210, the ambient image comprises ambient image 16-220, and the blended image comprises blended image 16-280.

In step 16-616, the digital photographic system presents an adjustment tool configured to present at least the blended image, the strobe image, and the ambient image, according to a transparency blend among two or more of the images. The transparency blend may be controlled by a user interface slider. The adjustment tool may be configured to save a particular blend state of the images as an adjusted image. The adjustment tool is described in greater detail below in FIGS. 16-9 and 16-10.

The method terminates in step 16-690, where the digital photographic system saves at least the adjusted image.

FIG. 16-7A is a flow diagram of a method 16-700 for blending a strobe image with an ambient image to generate a blended image, according to a first embodiment of the present invention. Although the method steps are described in conjunction with the systems of FIGS. 3A-3D, persons skilled in the art will understand that any system configured to perform the method steps, in any order, is within the scope of the present invention. In one embodiment, method 16-700 implements data flow 16-200 of FIG. 16-1A. The strobe image and the ambient image each comprise at least one pixel and may each comprise an equal number of pixels.

The method begins in step 16-710, where a processor complex within a digital photographic system, such as processor complex 310 within digital photographic system 16-300 of FIG. 3A, receives a strobe image and an ambient image, such as strobe image 16-210 and ambient image 16-220, respectively. In step 16-712, the processor complex generates a blended image, such as blended image 16-280, by executing a blend operation 16-270 on the strobe image and the ambient image. The method terminates in step 16-790, where the processor complex saves the blended image, for example to NV memory 316, volatile memory 318, or memory system 362.

FIG. 16-7B is a flow diagram of a method 16-702 for blending a strobe image with an ambient image to generate a blended image, according to a second embodiment of the present invention. Although the method steps are described in conjunction with the systems of FIGS. 3A-3D, persons skilled in the art will understand that any system configured to perform the method steps, in any order, is within the scope of the present invention. In one embodiment, method 16-702 implements data flow 16-202 of FIG. 16-1B. The strobe image and the ambient image each comprise at least one pixel and may each comprise an equal number of pixels.

The method begins in step 16-720, where a processor complex within a digital photographic system, such as processor complex 310 within digital photographic system 16-300 of FIG. 3A, receives a strobe image and an ambient image, such as strobe image 16-210 and ambient image 16-220, respectively. In step 16-722, the processor complex generates a color corrected strobe image, such as corrected strobe image data 16-252, by executing a frame analysis operation 16-240 on the strobe image and the ambient image and executing and a color correction operation 16-250 on the strobe image. In step 16-724, the processor complex generates a blended image, such as blended image 16-280, by executing a blend operation 16-270 on the color corrected strobe image and the ambient image. The method terminates in step 16-792, where the processor complex saves the blended image, for example to NV memory 316, volatile memory 318, or memory system 362.

FIG. 16-8A is a flow diagram of a method 16-800 for blending a strobe image with an ambient image to generate a blended image, according to a third embodiment of the present invention. Although the method steps are described in conjunction with the systems of FIGS. 3A-3D, persons skilled in the art will understand that any system configured to perform the method steps, in any order, is within the scope of the present invention. In one embodiment, method 16-800 implements data flow 16-204 of FIG. 16-2A. The strobe image and the ambient image each comprise at least one pixel and may each comprise an equal number of pixels.

The method begins in step 16-810, where a processor complex within a digital photographic system, such as processor complex 310 within digital photographic system 16-300 of FIG. 3A, receives a strobe image and an ambient image, such as strobe image 16-210 and ambient image 16-220, respectively. In step 16-812, the processor complex estimates a motion transform between the strobe image and the ambient image. In step 16-814, the processor complex renders at least an aligned strobe image or an aligned ambient image based the estimated motion transform. In certain embodiments, the processor complex renders both the aligned strobe image and the aligned ambient image based on the motion transform. The aligned strobe image and the aligned ambient image may be rendered to the same resolution so that each is aligned to the other. In one embodiment, steps 16-812 and 16-814 together comprise alignment operation 16-230. In step 16-816, the processor complex generates a blended image, such as blended image 16-280, by executing a blend operation 16-270 on the aligned strobe image and the aligned ambient image. The method terminates in step 16-890, where the processor complex saves the blended image, for example to NV memory 316, volatile memory 318, or memory system 362.

FIG. 16-8B is a flow diagram of a method 16-802 for blending a strobe image with an ambient image to generate a blended image, according to a fourth embodiment of the present invention. Although the method steps are described in conjunction with the systems of FIGS. 3A-3D, persons skilled in the art will understand that any system configured to perform the method steps, in any order, is within the scope of the present invention. In one embodiment, method 16-802 implements data flow 16-206 of FIG. 16-2B. The strobe image and the ambient image each comprise at least one pixel and may each comprise an equal number of pixels.

The method begins in step 16-830, where a processor complex within a digital photographic system, such as processor complex 310 within digital photographic system 16-300 of FIG. 3A, receives a strobe image and an ambient image, such as strobe image 16-210 and ambient image 16-220, respectively. In step 16-832, the processor complex estimates a motion transform between the strobe image and the ambient image. In step 16-834, the processor complex may render at least an aligned strobe image or an aligned ambient image based the estimated motion transform. In certain embodiments, the processor complex renders both the aligned strobe image and the aligned ambient image based on the motion transform. The aligned strobe image and the aligned ambient image may be rendered to the same resolution so that each is aligned to the other. In one embodiment, steps 16-832 and 834 together comprise alignment operation 16-230.

In step 16-836, the processor complex generates a color corrected strobe image, such as corrected strobe image data 16-252, by executing a frame analysis operation 16-240 on the aligned strobe image and the aligned ambient image and executing a color correction operation 16-250 on the aligned strobe image. In step 16-838, the processor complex generates a blended image, such as blended image 16-280, by executing a blend operation 16-270 on the color corrected strobe image and the aligned ambient image. The method terminates in step 16-892, where the processor complex saves the blended image, for example to NV memory 316, volatile memory 318, or memory system 362.

While the techniques taught herein are discussed above in the context of generating a digital photograph having a natural appearance from an underlying strobe image and ambient image with potentially discordant color, these techniques may be applied in other usage models as well.

For example, when compositing individual images to form a panoramic image, color inconsistency between two adjacent images can create a visible seam, which detracts from overall image quality. Persons skilled in the art will recognize that frame analysis operation 16-240 may be used in conjunction with color correction operation 16-250 to generated panoramic images with color-consistent seams, which serve to improve overall image quality. In another example, frame analysis operation 16-240 may be used in conjunction with color correction operation 16-250 to improve color consistency within high dynamic range (HDR) images.

In yet another example, multispectral imaging may be improved by enabling the addition of a strobe illuminator, while maintaining spectral consistency. Multispectral imaging refers to imaging of multiple, arbitrary wavelength ranges, rather than just conventional red, green, and blue ranges. By applying the above techniques, a multispectral image may be generated by blending two or more multispectral images having different illumination sources, i.e., different lighting conditions.

In still other examples, the techniques taught herein may be applied in an apparatus that is separate from digital photographic system 16-300 of FIG. 3A. Here, digital photographic system 300 may be used to generate and store a strobe image and an ambient image. The strobe image and ambient image are then combined later within a computer system, disposed locally with a user, or remotely within a cloud-based computer system. In one embodiment, method 16-802 comprises a software module operable with an image processing tool to enable a user to read the strobe image and the ambient image previously stored, and to generate a blended image within a computer system that is distinct from digital photographic system 300.

Persons skilled in the art will recognize that while certain intermediate image data may be discussed in terms of a particular image or image data, these images serve as illustrative abstractions. Such buffers may be allocated in certain implementations, while in other implementations intermediate data is only stored as needed. For example, aligned strobe image 16-232 may be rendered to completion in an allocated image buffer during a certain processing step or steps, or alternatively, pixels associated with an abstraction of an aligned image may be rendered as needed without a need to allocate an image buffer to store aligned strobe image 16-232.

While the techniques described above discuss color correction operation 16-250 in conjunction with a strobe image that is being corrected based on an ambient reference image, a strobe image may serve as a reference image for correcting an ambient image. In one embodiment ambient image 16-220 is subjected to color correction operation 16-250, and blend operation 16-270 operates as previously discussed for blending an ambient image and a strobe image.

### User Interface Elements

FIG. 16-9 illustrates a user interface (UI) system 16-900 for generating a combined image 16-920, according to one embodiment of the present invention. Combined image 16-920 comprises a combination of at least two related images. In one embodiment, combined image 16-920 comprises an image rendering that combines an ambient image, a strobe image, and a blended image. The strobe image may comprise a color corrected strobe image. For example combined image 16-920 may include a rendering that combines ambient image 16-220, strobe image 16-210, and blended image 16-280 of FIGS. 16-2A-16-2D. In one configuration, combined image 16-920 comprises an image rendering that combines an ambient image and a blended image. In another configuration, combined image 16-920 comprises an image rendering that combines an ambient image and a strobe image.

In one embodiment, UI system 16-900 presents a display image 16-910 that includes, without limitation, combined image 16-920, a UI control grip 16-930 comprising a continuous linear position UI control element configured to move along track 16-932, and two or more anchor points 16-940, which may each include a visual marker displayed within display image 16-910. In alternative embodiments, UI control grip 16-930 may comprise a continuous rotational position UI control element, or any other technically feasible continuous position UI control element. In certain embodiments, UI control grip 16-930 is configured to indicated a current setting for an input parameter, whereby the input parameter may be changed by a user via a tap gesture or a touch and drag gesture. The tap gesture may be used to select a particular position of UI control grip 16-930, while a touch and drag gesture may be used to enter a sequence of positions for UI control grip 16-930.

In one embodiment, UI system 16-900 is generated by an adjustment tool executing within processor complex 310 and display image 16-910 is displayed on display unit 312. The at least two component images may reside within NV memory 316, volatile memory 318, memory subsystem 362, or any combination thereof. In another embodiment, UI system 16-900 is generated by an adjustment tool executing within a computer system, such as a laptop computer, desktop computer, server computer, or any other technically feasible computer system. The at least two component images may be transmitted to the computer system or may be generated by an attached camera device. In yet another embodiment, UI system 16-900 is generated by a cloud-based server computer system, which may download the at least two component images to a client browser, which may execute combining operations described below.

UI control grip 16-930 is configured to move between two end points, corresponding to anchor points 16-940-A and 940-B. One or more anchor points, such as anchor point 16-940-S may be positioned between the two end points. Each anchor point 16-940 should be associated with a specific image, which may be displayed as combined image 16-920 when UI control grip 16-930 is positioned directly over the anchor point.

In one embodiment, anchor point 16-940-A is associated with the ambient image, anchor point 16-940-S is associated with the strobe image, and anchor point 16-940-B is associated with the blended image. When UI control grip 16-930 is positioned at anchor point 16-940-A, the ambient image is displayed as combined image 16-920. When UI control grip 16-930 is positioned at anchor point 16-940-S, the strobe image is displayed as combined image 16-920. When UI control grip 16-930 is positioned at anchor point 16-940-B, the blended image is displayed as combined image 16-920. In general, when UI control grip 16-930 is positioned between anchor points 16-940-A and 940-S, inclusive, a first mix weight is calculated for the ambient image and the strobe image. The first mix weight may be calculated as having a value of 0.0 when the UI control grip 16-930 is at anchor point 16-940-A and a value of 1.0 when UI control grip 16-930 is at anchor point 16-940-S. A mix operation, described previously, is then applied to the ambient image and the strobe image, whereby a first mix weight of 0.0 gives complete mix weight to the ambient image and a first mix weight of 1.0 gives complete mix weight to the strobe image. In this way, a user may blend between the ambient image and the strobe image. Similarly, when UI control grip 16-930 is positioned between anchor point 16-940-S and 940-B, inclusive, a second mix weight may be calculated as having a value of 0.0 when UI control grip 16-930 is at anchor point 16-940-S and a value of 1.0 when UI control grip 16-930 is at anchor point 16-940-B. A mix operation is then applied to the strobe image and the blended image, whereby a second mix weight of 0.0 gives complete mix weight to the strobe image and a second mix weight of 1.0 gives complete mix weight to the blended image.

This system of mix weights and mix operations provide a UI tool for viewing the ambient image, strobe image, and blended image as a gradual progression from the ambient image to the blended image. In one embodiment, a user may save a combined image 16-920 corresponding to an arbitrary position of UI control grip 16-930. The adjustment tool implementing UI system 16-900 may receive a command to save the combined image 16-920 via any technically feasible gesture or technique. For example, the adjustment tool may be configured to save combined image 16-920 when a user gestures within the area occupied by combined image 16-920. Alternatively, the adjustment tool may save combined image 16-920 when a user presses, but does not otherwise move UI control grip 16-930. In another implementation, the adjustment tool may save combined image 16-920 when the user enters a gesture, such as pressing a save button 16-931, dedicated to receive a save command.

In one embodiment, save button 16-931 is displayed and tracks the position of UI control grip 16-930 while the user adjusts UI control grip 16-930. The user may click save button 16-931 at any time to save an image corresponding to the current position of UI control grip 16-930.

In another embodiment, save button 16-931 is displayed above (or in proximity to) UI control grip 16-930, when the user does not have their finger on UI control grip 16-930. If the user touches the save button 16-931, an image is saved corresponding to the position of UI control grip 16-930. If the user subsequently touches the UI control grip 16-930, then save button 16-931 disappears. In one usage case, a user adjusts the UI control grip 16-930, lifts their finger from the UI control grip, and save button 16-931 is displayed conveniently located above UI control grip 16-930. The user may then save a first adjusted image corresponding to this first position of UI control grip 16-930. The user then makes a second adjustment using UI control grip 16-930. After making the second adjustment, the user lifts their finger from UI control grip 16-930 and save button 16-931 is again displayed above the current position of UI control grip 16-930. The user may save a second adjusted image, corresponding to a second UI control grip position, by pressing save button 16-931 again.

In certain embodiments, UI control grip 16-930 may be positioned initially in a default position, or initially in a calculated position, such as calculated from current image data or previously selected position information. The user may override the initial position by moving UI control grip 16-930. The initial position may be indicated via an initial position marker 16-933 disposed along track 16-932 to assist the user in returning to the initial position after moving UI control grip 16-930 away from the initial position. In one embodiment, UI control grip 16-930 is configured to return to the initial position when a user taps in close proximity to initial position marker 16-933. In certain embodiments, the initial position marker may be configured to change color or intensity when UI control grip 16-930 is positioned in close proximity to the initial position marker.

In certain embodiments, the adjustment tool provides a continuous position UI control, such as UI control grip 16-930, for adjusting otherwise automatically generated parameter values. For example, a continuous UI control may be configured to adjust, without limitation, a frameTrust value, a bias or function applied to a plurality of individual pixelTrust values, blend surface parameters such as one or more of heights 355-358 illustrated in FIG. 16-3C, blend surface curvature as illustrated in FIG. 16-3D, or any combination thereof. In one embodiment, an initial parameter value is calculated and mapped to a corresponding initial position for UI control grip 16-930. The user may subsequently adjust the parameter value via UI control grip 16-930. Any technically feasible mapping between a position for UI control grip 16-930 and the corresponding value may be implemented without departing the scope and spirit of the present invention.

Persons skilled in the art will recognize that the above system of mix weights and mix operations may be generalized to include two or more anchor points, which may be associated with two or more related images without departing the scope and spirit of the present invention. Such related images may comprise, without limitation, an ambient image and a strobe image, two ambient images having different exposure and a strobe image, or two or more ambient images having different exposure. Furthermore, a different continuous position UI control, such as a rotating knob, may be implemented rather than UI control grip 16-930. In certain embodiments, a left-most anchor point corresponds to an ambient image, a mid-point anchor point corresponds to a blended image, and a right-most anchor point corresponds to a strobe image.

FIG. 16-10A is a flow diagram of a method 16-1000 for generating a combined image, according to one embodiment of the present invention. Although the method steps are described in conjunction with the systems of FIGS. 3A-3D, persons skilled in the art will understand that any system configured to perform the method steps, in any order, is within the scope of the present invention.

Method 16-1000 begins in step 16-1010, where an adjustment tool executing within a processor complex, such as processor complex 310, loads at least two related source images. In step 16-1012, the adjustment tool initializes a position for a UI control, such as UI control grip 16-930 of FIG. 16-9, to an initial position. In one embodiment, the initial UI control position corresponds to an anchor point, such as anchor point 16-940-A, anchor point 16-940-S, or anchor point 16-940-B. In another embodiment, the initial UI control position corresponds to a recommended UI control position. In certain embodiments, the recommended UI control position is based on previous UI control positions associated with a specific UI event that serves to indicate user acceptance of a resulting image, such as a UI event related to saving or sharing an image based on a particular UI control position. For example, the recommended UI control position may represent an historic average of previous UI control positions associated with the UI event. In another example, the recommended UI control position represents a most likely value from a histogram of previous UI control positions associated with the UI event.

In certain embodiments, the recommended UI control position is based on one or more of the at least two related source images. For example, a recommended UI control position may be computed to substantially optimize a certain cost function associated with a combined image 16-920. The cost function may assign a cost to over-exposed regions and another cost to under-exposed regions of a combined image associated with a particular UI control position. Optimizing the cost function may then comprise rendering combined images having different UI control positions to find a UI control position that substantially minimizes the cost function over each rendered combined image. The combined images may be rendered at full resolution or reduced resolution for calculating a respective cost function. The cost function may assign greater cost to over-exposed regions than under-exposed regions to prioritize reducing over-exposed areas. Alternatively, the cost function may assign greater cost to under-exposed regions than over-exposed regions to prioritize reducing under-exposed areas. One exemplary technique for calculating a recommended UI control position for UI control grip 16-930 is illustrated in greater detail below in FIG. 16-10B.

In certain alternative embodiments, the cost function is computed without rendering a combined image. Instead, the cost function for a given UI control position is computed via interpolating or otherwise combining one or more attributes for each image associated with a different anchor point. For example, a low intensity mark computed at a fifteenth percentile point for each of two different images associated with corresponding anchor points may comprise one of two attributes associated with the two different images. A second attribute may comprise a high intensity mark, computed at an eighty-fifth percentile mark. One exemplary cost function defines a combined low intensity mark as a mix of two different low intensity marks corresponding to each of two images associated with two different anchor points, and a high intensity mark as a mix of two different high intensity marks corresponding to each of the two images. The cost function value is then defined as the sum of an absolute distance from the combined low intensity mark and a half intensity value and an absolute distance from the combined high intensity mark and a half intensity value. Alternatively, each distance function may be computed from a mix of median values for each of the two images. Persons skilled in the art will recognize that other cost functions may be similarly implemented without departing the scope and spirit of the present invention.

In one embodiment, computing the recommended UI control position includes adding an offset estimate, based on previous user offset preferences expressed as a history of UI control position overrides. Here, the recommended UI control position attempts to model differences in user preference compared to a recommended UI control position otherwise computed by a selected cost function. In one implementation, the offset estimate is computed along with an offset weight. As offset samples are accumulated, the offset weight may increase, thereby increasing the influence of the offset estimate on a final recommended UI control position. Each offset sample may comprise a difference between a recommended UI control position and a selected UI control position expressed as a user override of the recommended UI control position. As the offset weight increases with accumulating samples, the recommended UI control position may gradually converge with a user preference of UI control position. The goal of the above technique is to reduce an overall amount and frequency of override intervention by the user by generating recommended UI control positions that are more consistent with a preference demonstrated by for the user.

In step 16-1014, the adjustment tool displays a combined image, such as combined image 16-920, based on a position of the UI control and the at least two related source images. Any technically feasible technique may be implemented to generate the combined image. In one embodiment, step 16-1014 includes generating the combined image, whereby generating comprises mixing the at least two related source images as described previously in FIG. 16-9. In certain embodiments, the adjustment tool displays a “save” button, when the user is not touching the UI control. In certain other embodiments, the adjustment tool displays the save button regardless of whether the user is touching the UI control.

In step 16-1016, the adjustment tool receives user input. The user input may include, without limitation, a UI gesture such as a selection gesture or click gesture within display image 16-910. If, in step 16-1020, the user input should trigger a display update, then the method proceeds back to step 16-1014. A display update may include any change to display image 16-910. As such, a display update may include, without limitation, a chance in position of the UI control, an updated rendering of combined image 16-920, or a change in visibility of a given UI element, such as save button 16-931. Otherwise, the method proceeds to step 16-1030.

If, in step 16-1030, the user input does not comprise a command to exit, then the method proceeds to step 16-1032, where the adjustment tool performs a command associated with the user input. In one embodiment, the command comprises a save command and the adjustment tool then saves the combined image, which is generated according to a current position of the UI control. The method then proceeds back to step 16-1016.

Returning to step 16-1030, if the user input comprises a command to exit, then the method terminates in step 16-1035, and the adjustment tool exits, thereby terminating execution.

In one embodiment, one of the two related images is an ambient image, while another of the two related images is a strobe image. In certain embodiments, the strobe image comprises a color corrected strobe image.

FIG. 16-10B is a flow diagram of a method 16-1002 for calculating a recommended UI control position for blending two different images, according to one embodiment of the present invention. Although the method steps are described in conjunction with the systems of FIGS. 3A-3D, persons skilled in the art will understand that any system configured to perform the method steps, in any order, is within the scope of the present invention. In one embodiment, the control position corresponds to a UI control position such as a position for UI control grip 16-930, used to generate blending weights for two or more related images.

The two different images may include regions having different exposure and lighting characteristics. For example, a strobe image may include excessively bright or saturated regions where the strobe reflected almost fully, while an ambient image may not include saturated regions, but may instead have inadequately illuminated regions.

A combined image, as described above, may include an excessively bright region as a consequence of one of the two different images having an overexposed region, or an inadequately exposed region as a consequence of one of the two different images having an inadequately exposed region. In one embodiment, a combined image is generated by mixing the two different images according to a mix weight. For certain pairs of two different images, reducing the mix weight of a first image may improve image quality by reducing the influence of overexposed regions within the first image. Similarly, reducing the mix weight of a second image may improve image quality by reducing the influence of inadequately exposed regions in the second image. In certain scenarios, a balanced mix weight between the first image and the second image may produce good image quality by reducing the influence of excessively bright regions in the first image while also reducing the influence of inadequately exposed regions in the second image. Method 16-1002 iteratively finds a mix weight that optimizes a cost function that is correlated to image quality of the combined image.

Method 16-1002 begins is step 16-1050, where a selection function selects an initial blend weight. In one embodiment, the selection function is associated with the adjustment tool of FIG. 16-10A. The initial blend weight may give complete weight to the first image and no weight to the second image, so that the combined image is equivalent to the first image. Alternatively, the initial blend weight may give complete weight to the second image, so that the combined image is equivalent to the second image. In practice, any technically feasible initial blend weight may also be implemented. In step 16-1052, the selection function renders a combined image according to a current blend weight, based on the first image and the second image. Initially, the current blend weight should be the initial blend weight.

In step 16-1054, the selection function computes a cost function value for the combined image. In one embodiment, the cost function is proportional to image area that is either overexposed or underexposed. A larger cost function value indicates more overexposed or underexposed area; such overexposed or underexposed areas are correlated to lower image quality for the combined image. In one exemplary implementation, the cost function comprises a sum where each pixel within the combined image adds a constant value to the cost function if the pixel intensity is below a low threshold (underexposed) or above a high threshold (overexposed). In another exemplary implementation, the cost function comprises a sum where each pixel adds an increasing value to the cost function in proportion to overexposure or underexposure. In other words, as the pixel increases intensity above the high threshold, the pixel adds an increasing cost to the cost function; similarly, as the pixel decreases intensity below the low threshold, the pixel adds an increasing cost to the cost function. In one embodiment, the high threshold is 90% of maximum defined intensity for the pixel and the low threshold is 10% of the maximum defined intensity for the pixel. Another exemplary cost function implements an increasing cost proportional to pixel intensity distance from a median intensity for the combined image. Yet another exemplary cost function combines two or more cost components, such as pixel intensity distance from the median intensity for the combined image and incremental cost for pixel intensity values above the high threshold or below the low threshold, where each cost component may be scaled according to a different weight.

In one embodiment, the cost function includes a repulsion cost component that increases as the control position approaches a specified anchor point. In one exemplary implementation, the repulsion cost component may be zero unless the control position is less than a threshold distance to the anchor point. When the control position is less than the threshold distance to the anchor point, the repulsion cost component increases according to any technically feasible function, such as a linear, logarithmic, or exponential function. The repulsion cost component serves to nudge the recommended UI control position away from the specified anchor point. For example, the repulsion cost component may serve to nudge the recommended UI control position away from extreme control position settings, such as away from anchor points 16-940-A and 940-B. In certain embodiments, the cost function may include an attraction cost component that decreases as the control position approaches a specified anchor point. The attraction cost component may serve to slightly favor certain anchor points.

If, in step 16-1060 searching for a recommended UI control position is not done, then the method proceeds to step 16-1062, where the selection function selects a next blend weight to be the current blend weight. Selecting a next blend weight may comprise linearly sweeping a range of possible blend weights, performing a binary search over the range of possible blend weights, or any other technically feasible search order for blend weights. In general, two different images should not have a monotonic cost function over the range of possible blend weights, however, the cost function may have one global minimum that may be discovered via a linear sweep or a binary search that identifies and refines a bounding region around the global minimum.

Returning to step 16-1060, if searching for a recommended UI control position is done, then the method proceeds to step 16-1070. Here a recommended UI control position corresponds to a blend weight that yields a rendered combined image having a minimum cost function over the range of possible blend weights. In step 16-1070, the selection function causes a UI control position to correspond to a best cost function value. For example, the selection tool may return a parameter corresponding to a recommended UI control position, thereby causing the adjustment tool to move UI control grip 16-930 to a position corresponding to the recommended UI control position. The method terminates in step 16-1090.

Method 16-1002 may be practiced over multiple images and multiple blend ranges. For example, the recommended UI control position may represent a blend weight from a set of possible blend ranges associated with the full travel range of UI control grip 16-930 over multiple anchor points, each corresponding to a different image. As shown in FIG. 16-9, three images are represented by anchor points 16-940, and two different blend ranges are available to blend two adjacent images. Persons skilled in the art will recognize that embodiments of the present invention may be practiced over an arbitrary set of images, including ambient images, strobe images, color corrected strobe images, and blended images.

FIGS. 16-11A-16-11C illustrate a user interface configured to adapt to device orientation while preserving proximity of a user interface control element to a hand grip edge, according to embodiments of the present invention. The user interface comprises a display object 16-1120, such as combined image 16-920 of FIG. 16-9, and a UI control 16-1132, which may comprise UI control grip 16-930 and track 16-932. Both display object 16-1120 and UI control 16-1132 are displayed on display screen 16-1112, which resides within mobile device 16-1110. A hand grip edge 16-1130 represents a portion of mobile device 16-1110 being held by a user. As shown, when the user rotates mobile device 16-1110, the display object responds by rotating to preserve a UI up orientation that is consistent with a user's sense of up and down; however, UI control 16-1132 remains disposed along user grip edge 16-1130, thereby preserving the user's ability to reach UI control 16-1132, such as to enter gestures. FIG. 16-11A illustrates mobile device 16-1110 in a typical up right position. As shown, hand grip edge 16-1130 is at the base of mobile device 16-1110. FIG. 16-11B illustrates mobile device 16-1110 in a typical upside down position. As shown, hand grip edge 16-1130 is at the top of mobile device 16-1110. FIG. 16-11C illustrates mobile device 16-1110 in a sideways position. As shown, hand grip edge 16-1130 is on the side of mobile device 16-1110.

In one embodiment, a UI up orientation is determined by gravitational force measurements provided by an accelerometer (force detector) integrated within mobile device 16-1110. In certain embodiments, hand grip edge 16-1130 is presumed to be the same edge of the device, whereby a user is presumed to not change their grip on mobile device 16-1110. However, in certain scenarios, a user may change their grip, which is then detected by a hand grip sensor implemented in certain embodiments, as illustrated below in FIG. 16-11D. For example, when a user grips mobile device 16-1110, hand grip sensors detect the user grip, such as via a capacitive sensor, to indicate a hand grip edge 16-1130. When the user changes their grip, a different hand grip edge 16-1130 may be detected.

FIG. 16-11D illustrates a mobile device incorporating grip sensors 16-1142, 16-1144, 16-1146, 16-1148 configured to detect a user grip, according to one embodiment of the present invention. As shown, grip sensor 16-1142 is disposed at the left of mobile device 16-1110, grip sensor 16-1144 is disposed at the bottom of the mobile device, grip sensor 16-1146 is disposed at the right of the mobile device, and grip sensor 16-1148 is disposed at the top of the mobile device. When a user grips mobile device 16-1110 from a particular edge, a corresponding grip sensor indicates to mobile device 16-1110 which edge is being gripped by the user. For example, if a user grips the bottom of mobile device 16-1110 along grip sensor 16-1144, then UI control 16-1132 is positioned along the corresponding edge, as shown. In one embodiment, grip sensors 16-1142-16-1148 each comprise an independent capacitive touch detector.

In certain scenarios, a user may grip mobile device 16-1110 using two hands rather than just one hand. In such scenarios, two or more grip sensors may simultaneously indicate a grip. Furthermore, the user may alternate which hand is gripping the mobile device, so that one or more of the grip sensors 16-1142-16-1148 alternately indicate a grip. In the above scenarios, when a grip sensor 16-1142-16-1148 indicates that the user changed their grip position to a new grip location, the new grip location may need to be held by the user for a specified time interval before the UI control is reconfigured according to the new grip position. In other words, selecting a new grip position may require overcoming a hysteresis function based on a hold time threshold. In each case, the UI up orientation may be determined independently according to one or more gravitational force measurements.

In one embodiment, two or more light-emitting diode (LED) illuminators are disposed on the back side of mobile device 16-1110. Each of the two or more LED illuminators is associated with a device enclosure region corresponding to a grip sensor. When a given grip sensor indicates a grip presence, a corresponding LED is not selected as a photographic illuminator for mobile device 16-1110. One or more different LEDs may be selected to illuminate a subject being photographed by mobile device 16-1110.

FIG. 16-11E is a flow diagram of a method 16-1100 for orienting a user interface surface with respect to a control element, according to one embodiment of the present invention. Although the method steps are described in conjunction with the systems of FIGS. 3A-3D, persons skilled in the art will understand that any system configured to perform the method steps, in any order, is within the scope of the present invention.

Method 16-1100 begins in step 16-1160, where a window manager executing within a computing device, such as mobile device 16-1110 of FIG. 16-11A, initializes a user interface (UI) comprising display object 16-1120 and UI control 16-1132. In step 16-1162, the window manager receives an update event, such as a user input event. In step 16-1164, the window manager determines a grip position where a user is likely holding the mobile device 16-1110. For example, the window manager may determine the grip position based on an assumption that the user will hold the mobile device along a consistent edge. The consistent edge may be initially determined, for example, as the edge closest to a physical button or UI button pressed by the user. Alternatively, the window manager may determine the grip position based on input data from one or more grip sensors, such as grip sensors 16-1142, 16-1144, 16-1146, and 16-1148. In step 16-1166, the window manager determines an up position. For example, the window manage may determine an up position based on a gravity force vector reported by an accelerometer. If, in step 16-1170 the window manager determines that a change to a current UI configuration in needed, then the method proceeds to step 16-1172. Otherwise the method proceeds back to step 16-1162. A change to the UI configuration may be needed, without limitation, if a new up orientation is detected or a new grip position is detected. In step 16-1172, the window manager updates the UI configuration to reflect a new grip position or a new up orientation, or a combination thereof. A new UI configuration should position UI control 16-1132 along the side of mobile device 16-1110 corresponding to a user grip. In one embodiment, of the user is gripping mobile device 16-1110 along two edges, then UI control 16-1132 may be positioned corresponding to the edge closest to being in a down orientation. Alternatively, the UI control 16-1132 may be positioned corresponding to a right hand preference or a left hand preference. A right or left hand preference may be selected by the user, for example as a control panel option.

If, in step 16-1180, the method should not terminate, then the method proceeds back to step 16-1162. Otherwise, the method terminates in step 16-1190.

In one embodiment the window manager comprises a system facility responsible for generating a window presentation paradigm. In other embodiments, the window manager comprises a set of window management functions associated with a given application or software module.

FIG. 16-12A illustrates a user interface (UI) control selector 16-1210 configured to select one active control 16-1214 from one or more available controls 16-1212, 16-1214, 16-1216, according to embodiments of the present invention. The one or more available controls 16-1212, 16-1214, 16-1216 are conceptually organized as a drum that may be rotated up or down in repose to a corresponding rotate up gesture or rotate down gesture. A control aperture 16-1218 represents a region in which active control 16-1214 may operate. As shown, active control 16-1214 is a linear slider control, which may be used to input a particular application parameter. Control 16-1216 is shown as being not active, but may be made active by rotating the drum down using a rotate down gesture to expose control 16-1216 within control aperture 16-1218. Similarly, control 16-1212 may be made active by rotating the drum up using rotate up gesture. Inactive controls 16-1212, 16-1216 may be displayed as being partially obscured or partially transparent as an indication to the user that they are available.

In one embodiment, the rotate up gesture is implemented as a two-finger touch and upward swipe gesture, illustrated herein as rotate up gesture 16-1220. Similarly, the rotate down gesture is implemented as a two-finger touch and downward swipe gesture, illustrated herein as rotate down gesture 16-1222. In an alternative embodiment, the rotate up gesture is implemented as a single touch upward swipe gesture within control selection region 16-1224 and the rotate down gesture is implemented as a single touch downward swipe gesture within control selection region 16-1224.

Motion of the drum may emulate physical motion and include properties such as rotational velocity, momentum, and frictional damping. A location affinity function may be used to snap a given control into vertically centered alignment within control aperture 16-1218. Persons skilled in the art will recognize that any motion simulation scheme may be implemented to emulate drum motion without departing the scope and spirit of the present invention.

FIG. 16-12B illustrates a user interface control selector 16-1230 configured to select one active control 16-1234 from one or more available controls 16-1232, 16-1234, 16-1236, according to embodiments of the present invention. The one or more available controls 16-1232, 16-1234, 16-1236 are conceptually organized as a flat sheet that may be slid up or slide down in repose to a corresponding slide up gesture or slide down gesture. A control aperture 16-1238 represents a region in which active control 16-1234 may operate. As shown, active control 16-1234 is a linear slider control, which may be used to input a particular application parameter. Control 16-1236 is shown as being not active, but may be made active by siding the sheet down using the slide down gesture to expose control 16-1236 within control aperture 16-1238. Similarly, control 16-1232 may be made active by sliding the sheet up using the slide up gesture. Inactive controls 16-1232, 16-1236 may be displayed as being partially obscured or partially transparent as an indication to the user that they are available.

In one embodiment, the slide up gesture is implemented as a two-finger touch and upward swipe gesture, illustrated herein as slide up gesture 16-1240. Similarly, the slide down gesture is implemented as a two-finger touch and downward swipe gesture, illustrated herein as slide down gesture 16-1242. In an alternative embodiment, the slide up gesture is implemented as a single touch upward swipe gesture within control selection region 16-1244 and the slide down gesture is implemented as a single touch downward swipe gesture within control selection region 16-1244

Motion of the sheet may emulate physical motion and include properties such as velocity, momentum, and frictional damping. A location affinity function may be used to snap a given control into vertically centered alignment within control aperture 16-1238. Persons skilled in the art will recognize that any motion simulation scheme may be implemented to emulate sheet motion without departing the scope and spirit of the present invention.

Active control 16-1214 and active control 16-1234 may each comprise any technically feasible UI control or controls, including, without limitation, any continuous control, such as a slider bar, or any type of discrete control, such as a set of one or more buttons. In one embodiment, two or more active controls are presented within control aperture 16-1218, 16-1238.

More generally, in FIGS. 16-12A and 16-12B, one or more active controls are distinguished from available controls that are not currently active. Any technically feasible technique may be implemented to distinguish the one or more active controls from available controls that are not currently active. For example, the one or more active controls may be rendered in a different color or degree of opacity; the one or more active controls may be rendered using thicker lines or bolder text, or any other visibly distinctive feature.

FIG. 16-12C is a flow diagram a method 16-1200 for selecting an active control from one or more available controls, according to one embodiment of the present invention. Although the method steps are described in conjunction with the systems of FIGS. 3A-3D, persons skilled in the art will understand that any system configured to perform the method steps, in any order, is within the scope of the present invention.

Method 16-1200 begins in step 16-1250, where an application configures a UI control selector to include at least two different UI controls. Configuration may be performed via one or more API calls associated with a window manager, for example via an object registration mechanism that registers each UI control and related settings with the UI control selector. One of the at least two different UI controls may be selected initially as an active control.

In step 16-1252, the UI control selector enables the active control, allowing the active control to receive user input. In step 16-1254, the window manager receives an input event. The input event may comprise a user input event targeting the active control, a user input event targeting the UI control selector, or any other technically feasible event, including a terminate signal. If, in step 16-1260, the input event comprises an active control input, then the method proceeds to step 16-1262, where the active control receives the input event and transmits a corresponding action based on the event to the application. In one embodiment, the application is configured to receive actions resulting from either of the at least two different UI controls. In certain embodiments, the application is configured to receive actions from any of the at least two different UI controls, although only the active control may actually generate actions in any one configuration of the UI control selector. Upon completing step 16-1262, the method proceeds back to step 16-1254.

Returning to step 16-1260, if the input event does not comprise an active control input, then the method proceeds to step 16-1270. If, in step 16-1270 the input event comprises an event to select a different control as the active control, then the method proceeds to step 16-1272, where the UI control selector changes which control is the active control. Upon completing step 16-1272, the method proceeds back to step 16-1252.

Returning to step 16-1270, if the input event does not comprise an event to select a different control, then the method proceeds to step 16-1280. If, in step 16-1280, the input event comprises a signal to exit then the method terminates in step 16-1290, otherwise, the method proceeds back to step 16-1252.

In one embodiment the window manager comprises a system facility responsible for generating a window presentation paradigm. In other embodiments, the window manager comprises a set of window management functions associated with a given application or software module.

FIG. 16-13A illustrates a data flow process 16-1300 for selecting an ambient target exposure coordinate, according to one embodiment of the present invention. An exposure coordinate is defined herein as a coordinate within a two-dimensional image that identifies a representative portion of the image for computing exposure for the image. The goal of data flow process 16-1300 is to select an exposure coordinate used to establish exposure for sampling an ambient image. The ambient image will then be combined with a related strobe image. Because the strobe image may better expose certain portions of a scene being photographed, those portions may be assigned reduced weight when computing ambient exposure. Here, the ambient target exposure coordinate conveys an exposure target to a camera subsystem, which may then adjust sensitivity, exposure time, aperture, or any combination thereof to generate mid-tone intensity values at the ambient target exposure coordinate in a subsequently sampled ambient image.

An evaluation strobe image 16-1310 is sampled based on at least a first evaluation exposure coordinate. An evaluation ambient image 16-1213 is separately sampled based on the at least a second evaluation exposure coordinate. In one embodiment, the second evaluation exposure coordinate comprises the first evaluation exposure coordinate. A strobe influence function 16-1320 scans the evaluation strobe image 16-1310 and the evaluation ambient image 16-1312 to generate ambient histogram data 16-1315. The ambient histogram data comprises, without limitation, an intensity value for each pixel within the evaluation ambient image, and state information indicating whether a given pixel should be counted by a histogram function 16-1322. In one embodiment, the strobe influence function implements an intensity discriminator function that determines whether a pixel is sufficiently illuminated by a strobe to be precluded from consideration when determining an ambient exposure coordinate. One exemplary discriminator function is true if a pixel in evaluation ambient image 16-1312 is at least as bright as a corresponding pixel in evaluation strobe image 16-1310. In another embodiment, the strobe influence function implements an intensity discriminator function that determines a degree to which a pixel is illuminated by a strobe. Here, the strobe influence function generates a weighted histogram contribution value, recorded in histogram function 16-1322. Pixels that are predominantly illuminated by the strobe are recorded as having a low weighted contribution for a corresponding ambient intensity by the histogram function, while pixels that are predominantly illuminated by ambient light are recorded as having a high weighted contribution for a corresponding ambient intensity by the histogram function.

In one embodiment, the first evaluation coordinate comprises a default coordinate. In another embodiment, the first evaluation coordinate comprises a coordinate identified by a user, such as via a tap gesture within a preview image. In yet another embodiment, the first evaluation coordinate comprises a coordinate identified via object recognition, such as via facial recognition.

Histogram function 16-1322 accumulates a histogram 16-1317 of ambient pixel intensity based on ambient histogram data 16-1315. Histogram 16-1317 reflects intensity information for regions of evaluation ambient image 16-1312 that are minimally influenced by strobe illumination. Regions minimally influenced by strobe illumination comprise representative exposure regions for ambient exposure calculations.

An image search function 16-1324 scans evaluation image 16-1312 to select the ambient target exposure coordinate, which may subsequently be used as an exposure coordinate to sample an ambient image. In one embodiment, the subsequently sampled ambient image and a subsequently sampled strobe image are combined in accordance with the techniques of FIGS. 16-1A through 16-10B.

In one embodiment, the image search function 16-1324 selects a coordinate that corresponds to a target intensity derived from, without limitation, intensity distribution information recorded within histogram 16-1317. In one embodiment, the target intensity corresponds to a median intensity recorded within histogram 16-1317. In another embodiment, the target intensity corresponds to an average intensity recorded within the histogram 16-1317. In certain embodiments, image search function 16-1324 preferentially selects a coordinate based on consistency of intensity in a defined region surrounding a given coordinate candidate. Consistency of intensity for the region may be defined according to any technically feasible definition; for example, consistency of intensity may be defined as a sum of intensity distances from the target intensity for pixels within the region.

In one embodiment, frame-level color correction factors, discussed in FIG. 16-4B above are substantially derived from regions included in ambient histogram data 16-1315.

FIG. 16-13B is a flow diagram of method 16-1302 for selecting an exposure coordinate, according to one embodiment of the present invention. Although the method steps are described in conjunction with the systems of FIGS. 3A-3D, persons skilled in the art will understand that any system configured to perform the method steps, in any technically feasible order, is within the scope of the present invention. In one embodiment, method 16-1302 implements an exposure coordinate selection function, such as data flow process 16-1300 of FIG. 16-13A.

Method 16-1302 begins in step 16-1350, where the exposure coordinate selection function receives an ambient evaluation image and a strobe evaluation image from a camera subsystem. The ambient evaluation image and the strobe evaluation image may be of arbitrary resolution, including a resolution that is lower than a native resolution for the camera subsystem. In one embodiment, the ambient evaluation image and the strobe evaluation image each comprise one intensity value per pixel.

In step 16-1352, the exposure coordinate selection function selects an image coordinate. The image coordinate corresponds to a two-dimensional location within ambient evaluation image, and a corresponding location within strobe evaluation image. Initially, the image coordinate may be one corner of the image, such as an origin coordinate. Subsequent execution of step 16-1352 may select coordinates along sequential columns in sequential rows until a last pixel is selected. In step 16-1354, the exposure coordinate selection function computes strobe influence for the selected coordinate. Strobe influence may be computed as described previously in FIG. 16-13A, or according to any technically feasible technique. In step 16-1356, the exposure coordinate selection function updates a histogram based on the strobe influence and ambient intensity. In one embodiment, strobe influence comprises a binary result and an ambient intensity is either recorded within the histogram as a count value corresponding to the ambient intensity or the ambient intensity is not recorded. In another embodiment, strobe influence comprises a value within a range of numeric values and an ambient intensity is recorded within the histogram with a weight defined by the numeric value.

If, in step 16-1360, the selected image coordinate is the last image coordinate, then the method proceeds to step 16-1362, otherwise, the method proceeds back to step 16-1352. In step 16-1362, the exposure coordinate selection function computes an exposure target intensity based on the histogram. For example, a median intensity defined by the histogram may be selected as an exposure target intensity. In step 16-1364, the exposure coordinate selection function searches the ambient evaluation image for a region having the exposure target intensity. This region may serve as an exemplary region for a camera subsystem to use for exposing a subsequent ambient image. In one embodiment, this region comprises a plurality of adjacent pixels within the ambient evaluation image having intensity values within an absolute or relative threshold of the exposure target intensity. The method terminates in step 16-1370.

FIG. 16-13C illustrates a scene 16-1380 having a strobe influence region, according to one embodiment of the present invention. The strobe influence region is illustrated as regions with no hash fill. Such regions include a foreground object 16-1384 and a surrounding region where the strobe illumination dominates. Region 16-1382, illustrated with a hash fill, depicts a region where strobe influence is minimal. In this example, pixels from region 16-1382 would be preferentially recorded within the histogram of FIG. 16-13B. In one embodiment, pixels comprising the strobe influence region would not be recorded within the histogram. In one alternative embodiment, pixels comprising the strobe influence region would be recorded within the histogram with reduced weight.

FIG. 16-13D illustrates a scene mask 16-1390 computed to preclude a strobe influence region 16-1394, according to one embodiment of the present invention. In this example, pixels within the strobe influence region 16-1394 are not recorded to the histogram of FIG. 16-13A, while pixels outside strobe influence region 16-1394 are recorded to the histogram.

FIG. 16-14 is a flow diagram of method 16-1400 for sampling an ambient image and a strobe image based on computed exposure coordinates, according to one embodiment of the present invention. Although the method steps are described in conjunction with the systems of FIGS. 3A-3D, persons skilled in the art will understand that any system configured to perform the method steps is within the scope of the present invention. The goal of method 16-1400 is to pre-compute two or more camera subsystem exposure parameters, a time consuming process, prior to actually sampling corresponding images for a photographic scene. Sampling the corresponding images is a time-sensitive process because the more time between two different images, the more likely the two corresponding images will appear. Therefore, the goal of method 16-1400 is to reduce overall inter-image time by performing time-consuming tasks related to image sampling prior to actually sampling the ambient image and strobe image. An image set comprises at least one ambient image and at least one strobe image. A camera control function is configured to execute method 16-1400. In one embodiment, the camera control function comprises a computer program product that includes computer programming instructions embedded within a non-transitory computer readable medium, such as within NV memory 316 of FIG. 3A, wherein the computer programming instructions cause a processor to perform method 16-1400.

Method 16-1400 begins in step 16-1410, where the camera control function causes a camera subsystem, such as camera unit 330, to sample an ambient evaluation image using available ambient scene illumination. The ambient evaluation image may be sampled at any technically feasible resolution, such as a lower resolution than a native resolution for the camera subsystem. In step 16-1412, the camera control function causes the camera subsystem to sample a strobe evaluation image of the photographic scene using a strobe illumination device, such as strobe unit 336. In one embodiment, a default exposure coordinate, such as an image midpoint, is used by the camera subsystem for exposing the ambient evaluation image and the strobe evaluation image. In another embodiment, an exposure coordinate selected by a user, such as via a tap selection gesture, is used by the camera subsystem for exposing the ambient evaluation image and the strobe evaluation image. In alternative embodiments steps 16-1412 and 16-1410 are executed in reverse sequence, so that the strobe evaluation image is sampled first followed by the ambient evaluation image. A given coordinate may also include an area, such as an area of pixels surrounding the coordinate.

In step 16-1414, the camera control function enumerates exposure requirements for an image set comprising two or more related images. One exemplary set of exposure requirements for an image set includes a requirement to sample two images, defined to be one ambient image and one strobe image. The ambient image exposure requirements may include an exposure target defined by a histogram median of pixel intensity values identified within the ambient evaluation image and strobe evaluation image. The exposure requirements may further include a coordinate being dominantly illuminated by ambient illumination rather than strobe illumination. The strobe image exposure requirements may include an exposure target defined by a user selected coordinate and a requirement to illuminate a scene with strobe illumination. Another exemplary set of exposure requirements may include three images, defined as two ambient images and one strobe image. One of the ambient images may require an exposure target defined by a histogram median with a positive offset applied for pixels identified within the ambient evaluation image and strobe evaluation image as being dominantly illuminated via ambient lighting. Another of the ambient images may require an exposure target defined by a histogram median with a negative offset applied. The strobe image exposure requirements may include an exposure target defined by the user selected coordinate and the requirement to illuminate the scene with strobe illumination. Upon completion of step 16-1414, a list of required images and corresponding exposure requirements is available, where each exposure requirement includes an exposure coordinate.

In step 16-1420, the camera control function selects an exposure coordinate based on a selected exposure requirement. In one embodiment, the exposure coordinate is selected by searching an ambient evaluation image for a region satisfying the exposure requirement. In step 16-1422, the camera control function causes the camera subsystem to generate camera subsystem exposure parameters for the photographic scene based on the selected exposure coordinate. In one embodiment, the camera subsystem exposure parameters comprise exposure time, exposure sensitivity (“ISO” sensitivity), aperture, or any combination thereof. The camera subsystem exposure parameters may be represented using any technically feasible encoding or representation, such as image sensor register values corresponding to exposure time and exposure sensitivity. In step 16-1424, the camera subsystem exposure parameters are saved to a data structure, such as a list, that includes image requirements and corresponding exposure parameters. The list of image requirements may include an entry for each image within the image set, and each entry may include exposure parameters. In certain embodiments, the exposure parameters may be kept in a distinct data structure. The exposure parameters for all images within the image set are determined prior to actually sampling the images. If, in step 16-1430, more camera subsystem exposure parameters need to be generated, then the method proceeds back to step 16-1420, otherwise, the method proceeds to step 16-1432.

In step 16-1432, the camera control function causes the camera to sample an image of the photographic scene based on a set of camera subsystem exposure parameters previously stored within the list of image requirements. In step 16-1434, the camera control function causes the image to be stored into the image set. The image set may be stored in any technically feasible memory system. If, in step 16-1440, more images need to be sampled, then the method proceeds back to step 16-1432, otherwise the method terminates in step 16-1490.

The list of image requirements may comprise an arbitrary set of ambient images and/or strobe images. In certain alternative embodiments, the strobe evaluation image is not sampled and method 16-1400 is practiced solely over images illuminated via available ambient light. Here, a histogram of ambient evaluation image may be used to generate exposure intensity targets in step 16-1414; the exposure intensity targets may then be used to find representative coordinates in step 16-1420; the representative coordinates may then be used to generate camera subsystem exposure parameters used to sample ambient images.

In certain embodiments, the camera subsystem is implemented as a separate system from a computing platform configured to perform methods described herein.

In one embodiment step 16-1420 of method 16-1400 comprises method 16-1302. In certain embodiments, step 16-612 of method 16-600 comprises method 16-1400. In one embodiment, step 16-612 of method 16-600 comprises method 16-1400, step 16-1420 comprises method 16-1302, and step 16-616 comprises method 16-1000. Furthermore, step 16-1012 comprises method 16-1002. In certain embodiments, step 16-1014 comprises method 16-1100.

In summary, techniques are disclosed for sampling digital images and blending the digital images based on user input. User interface (UI) elements are disclosed for blending the digital images based on user input and image characteristics. Other techniques are disclosed for selecting UI control elements that may be configured to operate on the digital images. A technique is disclosed for recommending blend weights among two or more images. Another technique is disclosed to generating a set of two or more camera subsystem exposure parameters that may be used to sample a sequence of corresponding images without introducing additional exposure computation time between each sampled image.

One advantage of the present invention is that a user is provided greater control and ease of control over images sampled and/or synthesized from two or more related images.

Embodiments of the present invention enable a digital photographic system to capture an image stack for a photographic scene. Exemplary digital photographic systems include, without limitation, digital cameras and mobile devices such as smart phones that are configured to include a digital camera module. A given photographic scene is a portion of an overall scene sampled by the digital photographic system. Two or more images are sampled by the digital photographic system to generate an image stack.

A given image stack comprises images of the photographic scene sampled with potentially different exposure, different strobe illumination, or a combination thereof. For example, each image within the image stack may be sampled according to a different exposure time, exposure sensitivity, or a combination thereof. A given image within the image stack may be sampled in conjunction with or without strobe illumination added to the photographic scene. Images comprising an image stack should be sampled over an appropriately short span of time to reduce visible differences or changes in scene content among the images. In one embodiment, images comprising a complete image stack are sampled within one second. In another embodiment, images comprising a complete image stack are sampled within a tenth of a second.

In one embodiment, two or more images are captured according to different exposure levels during overlapping time intervals, thereby reducing potential changes in scene content among the two or more images. In other embodiments, the two or more images are sampled sequentially under control of an image sensor circuit to reduce inter-image time. In certain embodiments, at least one image of the two or more images is sampled in conjunction with a strobe unit being enabled to illuminate a photographic scene. Image sampling may be controlled by the image sensor circuit to reduce inter-image time between an image sampled using only ambient illumination and an image sampled in conjunction with strobe illumination. The strobe unit may comprise a light-emitting diode (LED) configured to illuminate the photographic scene.

In one embodiment, each pixel of an image sensor comprises a set of photo-sensitive cells, each having specific color sensitivity. For example, a pixel may include a photo-sensitive cell configured to be sensitive to red light, a photo-sensitive cell configured to be sensitive to blue light, and two photo-sensitive cells configured to be sensitive to green light. Each photo-sensitive cell is configured to include two or more analog sampling circuits. A set of analog sampling circuits comprising one analog sampling circuit per photo-sensitive cell within the image sensor may be configured to sample and store a first image. Collectively, one set of analog sampling circuits forms a complete image plane and is referred to herein as an analog storage plane. A second set of substantially identically defined analog sampling circuits within the image sensor may be configured to sample and store a second image. A third set of substantially identically defined storage elements within the image sensor may be configured to sample and store a third image, and so forth. Hence an image sensor may be configured to sample and simultaneously store multiple images within analog storage planes.

Each analog sampling circuit may be independently coupled to a photodiode within the photo-sensitive cell, and independently read. In one embodiment, the first set of analog sampling circuits are coupled to corresponding photodiodes for a first time interval to sample a first image having a first corresponding exposure time. A second set of analog sampling circuits are coupled to the corresponding photodiodes for a second time interval to sample a second image having a second corresponding exposure time. In certain embodiments, the first time duration overlaps the second time duration, so that the first set of analog sampling circuits and the second set of analog sampling circuits are coupled to the photodiode concurrently during an overlap time. In one embodiment, the overlap time is within the first time duration. Current generated by the photodiode is split over the number of analog sampling circuits coupled to the photodiode at any given time. Consequently, exposure sensitivity varies as a function how many analog sampling circuits are coupled to the photodiode at any given time and how much capacitance is associated with each analog sampling circuit. Such variation needs to be accounted for in determining exposure time for each image.

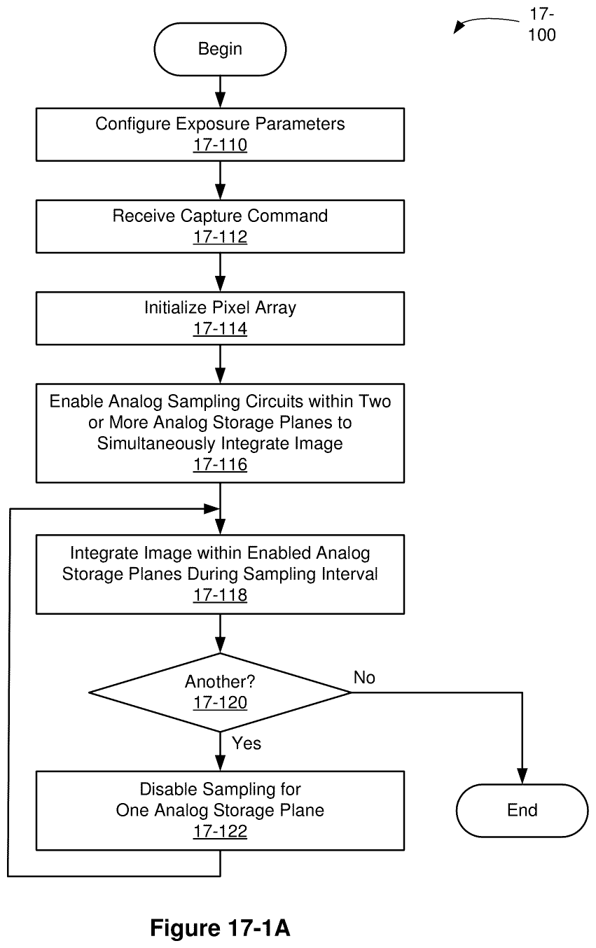

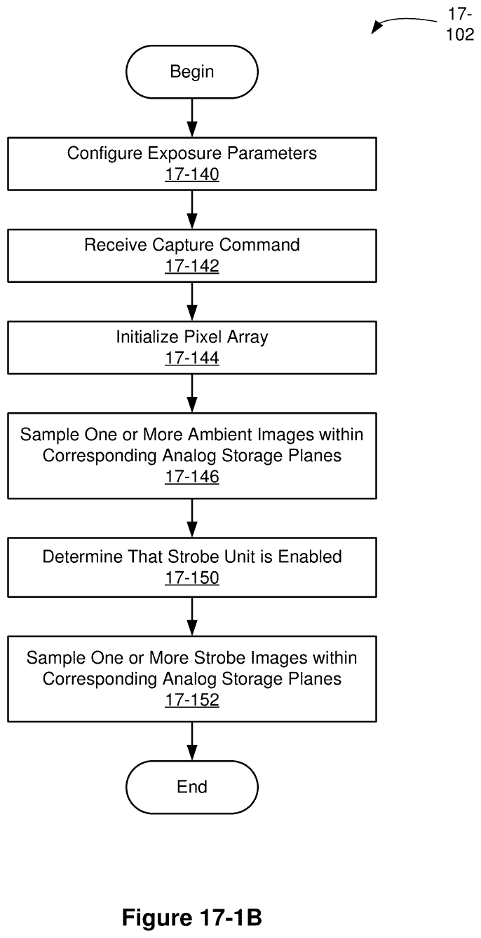

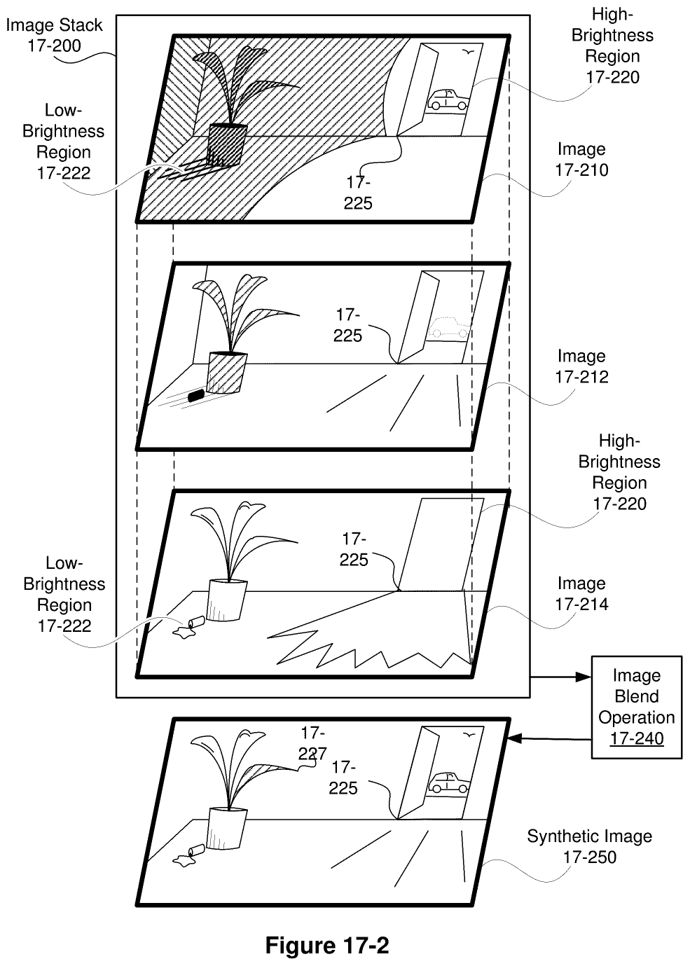

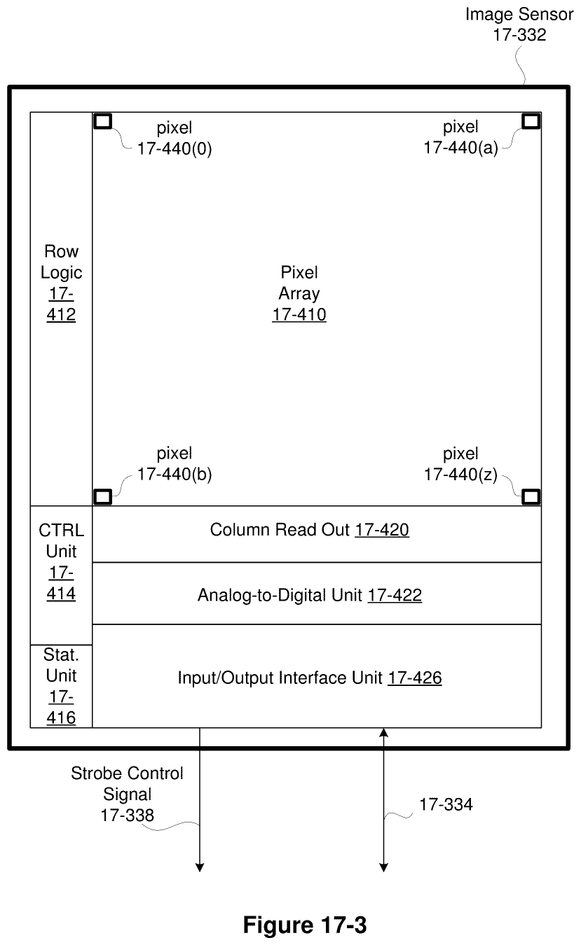

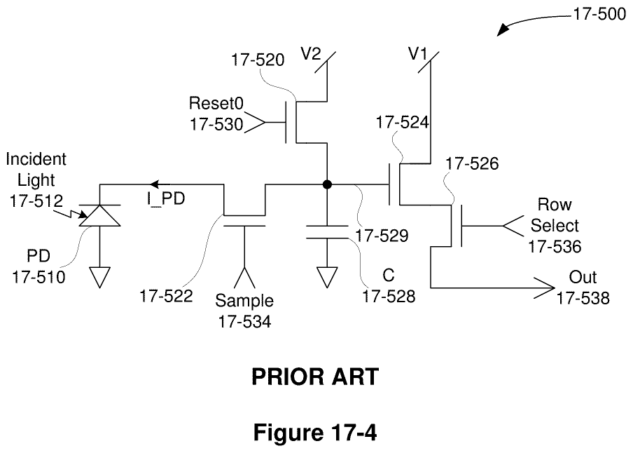

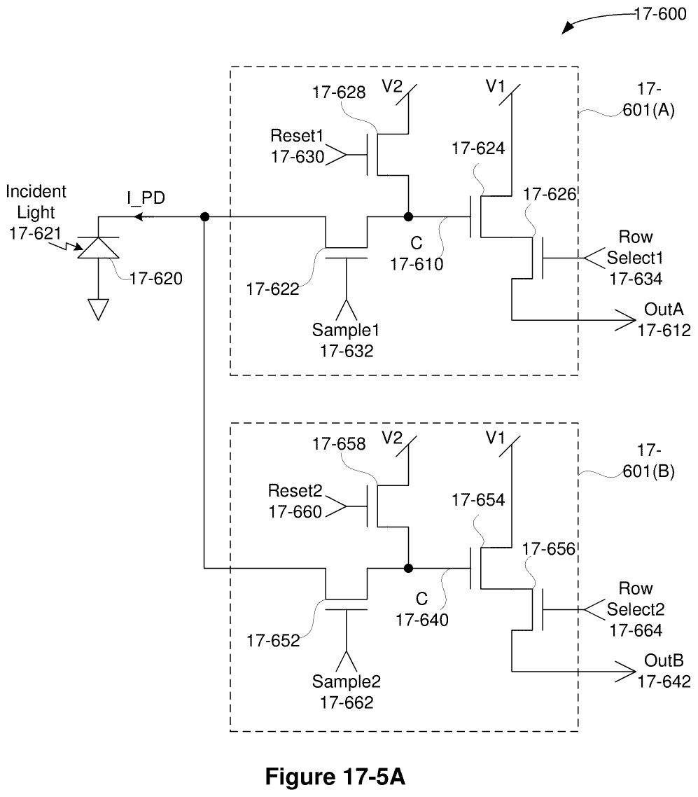

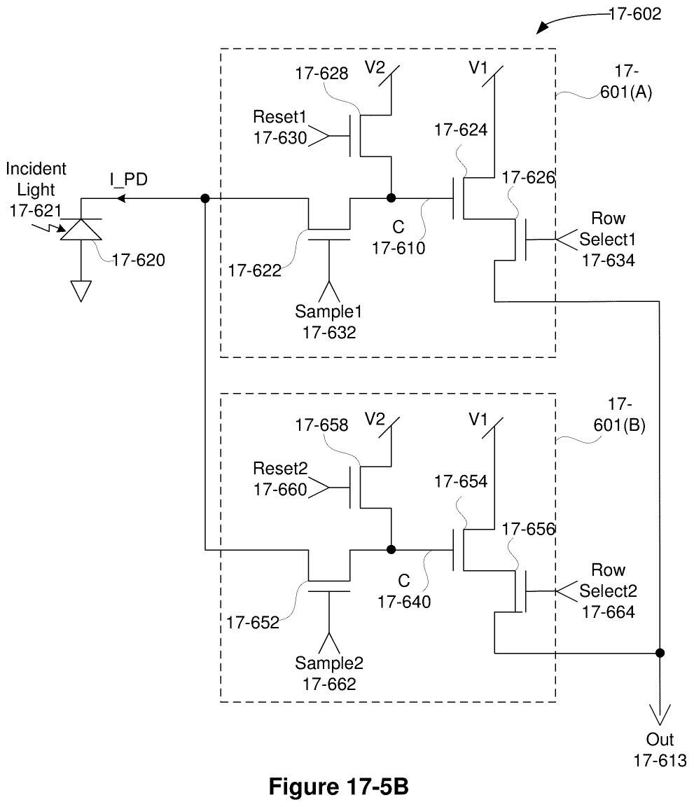

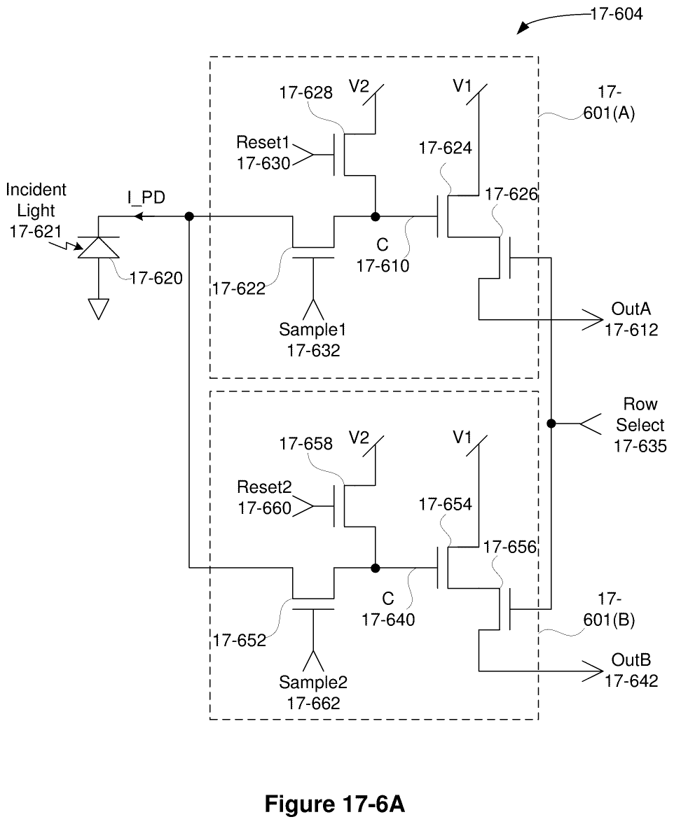

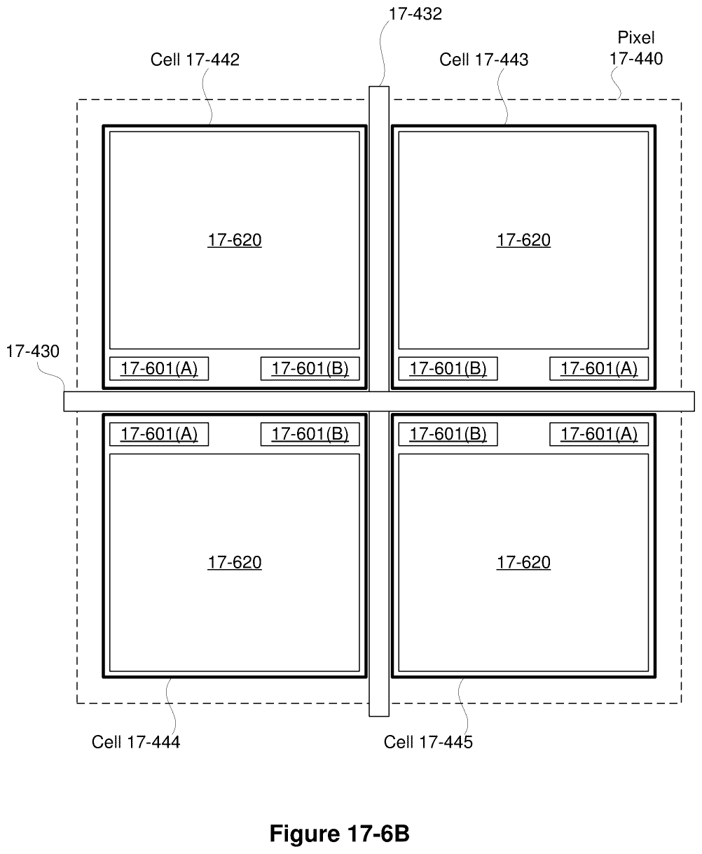

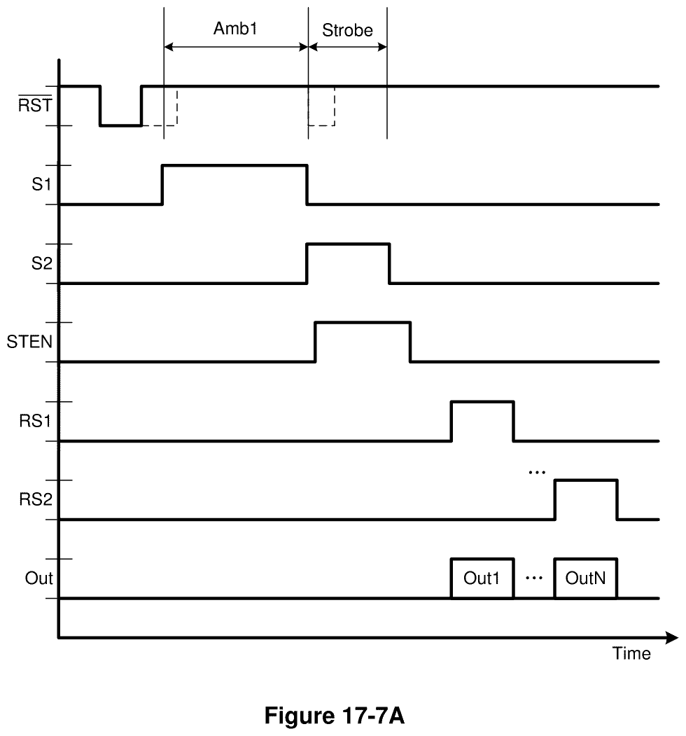

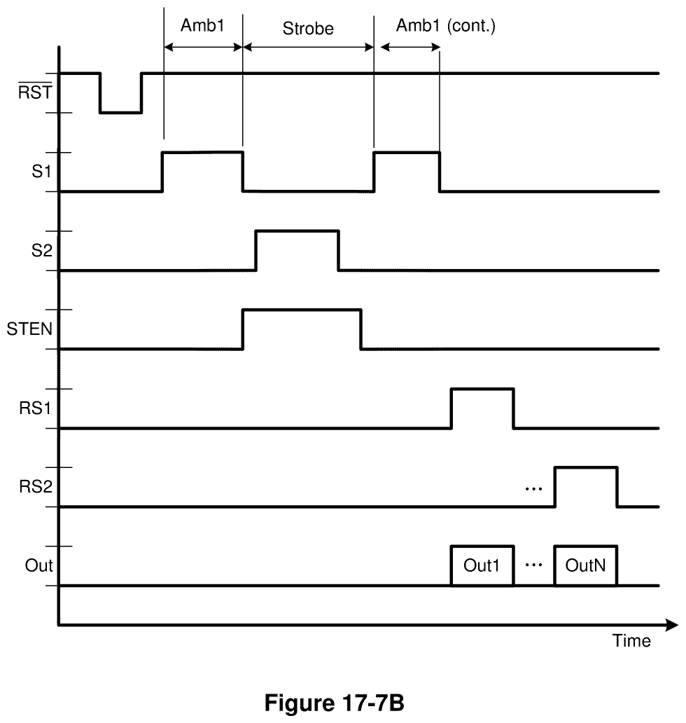

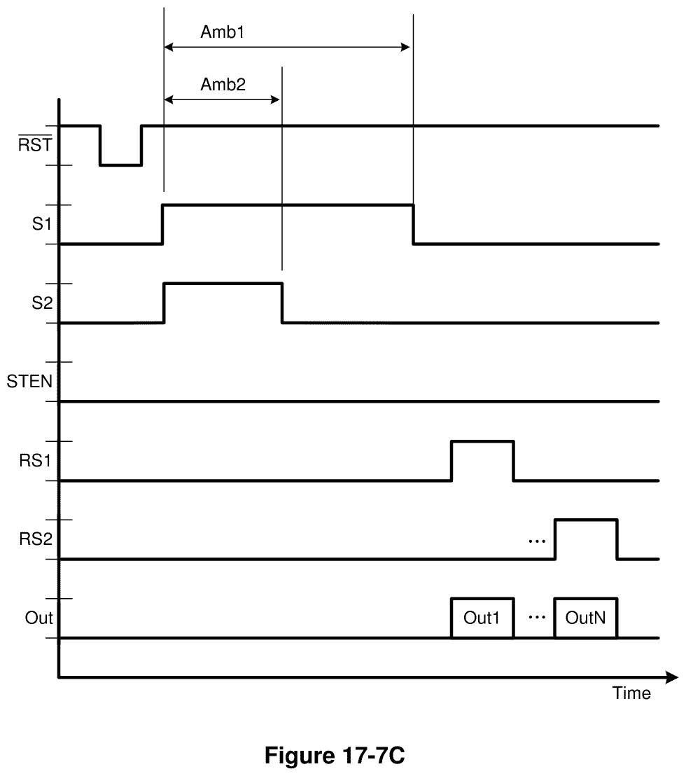

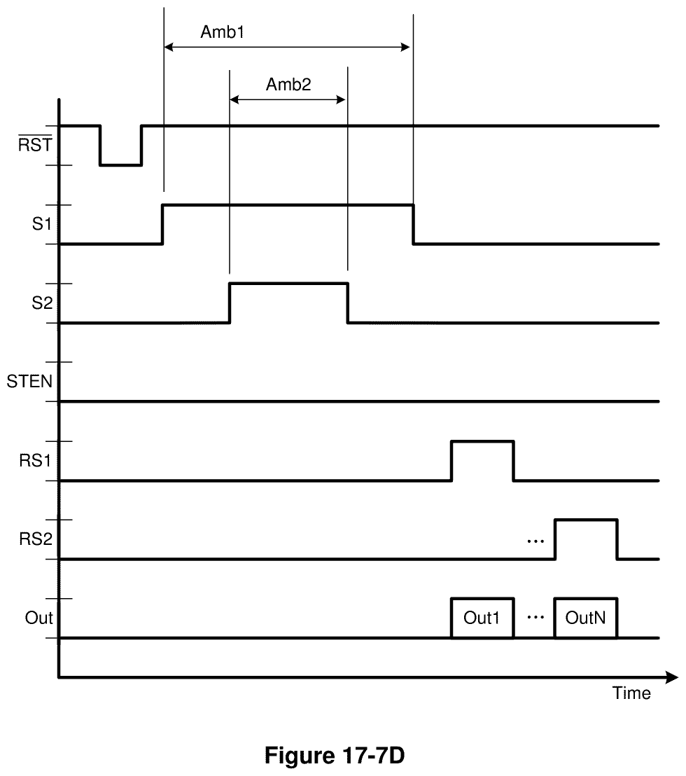

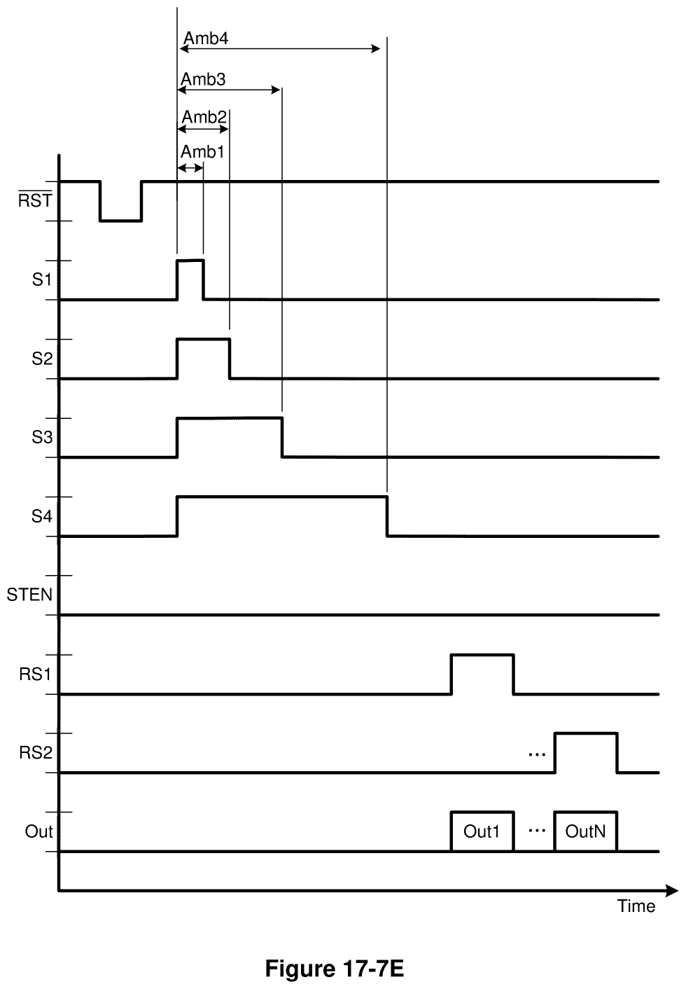

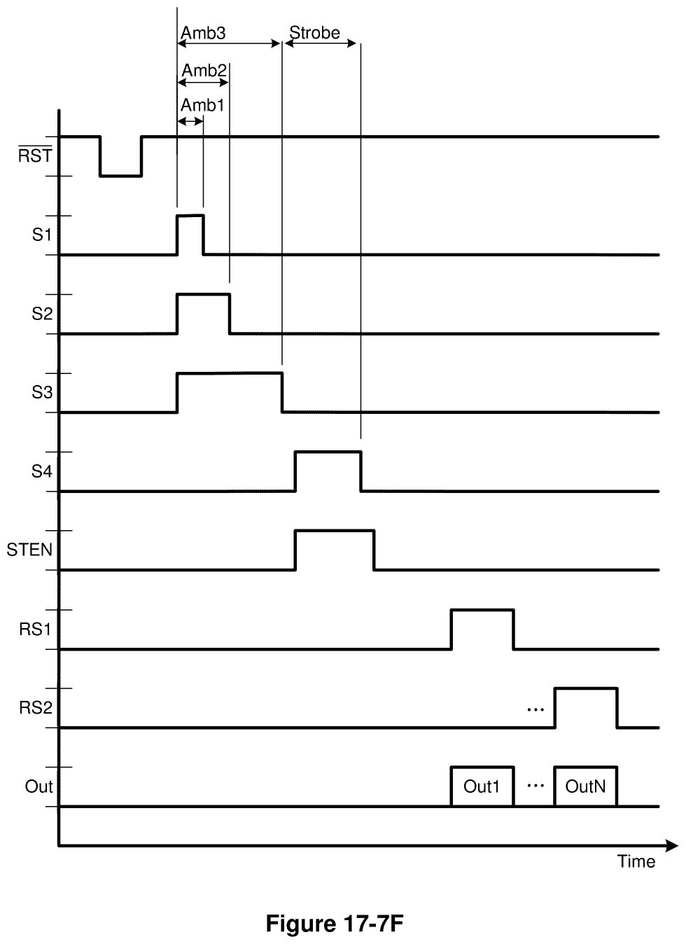

FIG. 17-1A illustrates a flow chart of a method 17-100 for generating an image stack comprising two or more images of a photographic scene, in accordance with one embodiment. Although method 17-100 is described in conjunction with the systems of FIGS. 17-2 and FIGS. 3A-3G, persons of ordinary skill in the art will understand that any system that performs method 17-100 is within the scope and spirit of embodiments of the present invention. In one embodiment, a digital photographic system, such as digital photographic system 300, is configured to perform method 17-100. The digital photographic system may be implemented within a digital camera, such as digital camera 17-202 of FIG. 17-2A, or a mobile device, such as mobile device 17-204 of FIG. 17-2B. In certain embodiments, a camera module, such as camera module 330, is configured to perform method 17-100. Method 17-100 may be performed with or without a strobe unit, such as strobe unit 336, enabled to contribute illumination to the photographic scene.

Method 17-100 begins in step 17-110, where the camera module configures exposure parameters for an image stack to be sampled by the camera module. Configuring the exposure parameters may include, without limitation, writing registers within an image sensor comprising the camera module that specify exposure time for each participating analog storage plane, exposure sensitivity for one or more analog storage planes, or a combination thereof. Exposure parameters may be determined prior to this step according to any technically feasible technique, such as well-known techniques for estimating exposure based on measuring exposure associated with a sequence of test images sampled using different exposure parameters.

In step 17-112, the camera module receives a capture command. The capture command directs the camera module to sample two or more images comprising the image stack. The capture command may result from a user pressing a shutter release button, such as a physical button or a user interface button. In step 17-114, the camera module initializes a pixel array within the image sensor. In one embodiment, initializing the pixel array comprises driving voltages on internal nodes of photo-sensitive cells within one or more analog storage planes to a reference voltage, such as a supply voltage or a bias voltage. In step 17-116, the camera module enables analog sampling circuits within two or more analog storage planes to simultaneously integrate (accumulate) an image corresponding to a photographic scene. In one embodiment, integrating an image comprises each analog sampling circuit within an analog storage plane integrating a current generated by a corresponding photodiode. In step 17-118, analog sampling circuits within enabled analog storage planes integrate a respective image during a sampling interval. Each sampling interval may comprise a different time duration.

If, in step 17-120, the camera module should sample another image, then the method proceeds to step 17-122, where the camera module disables sampling for one analog storage plane within the image sensor. Upon disabling sampling for a given analog storage plane, an image associated with the analog storage plane has been sampled completely for an appropriate exposure time.

Returning to step 17-120, if the camera module should not sample another image then the method terminates. The camera module should not sample another image after the last sampling interval has lapsed and sampling of the last image has been completed.

Reading an image from a corresponding analog storage plane may proceed using any technically feasible technique.

FIG. 17-1B illustrates a flow chart of a method 17-102 for generating an image stack comprising an ambient image and a strobe image of a photographic scene, in accordance with one embodiment. Although method 17-102 is described in conjunction with the systems of FIG. 2 and FIGS. 3A-3G, persons of ordinary skill in the art will understand that any system that performs method 17-102 is within the scope and spirit of embodiments of the present invention. In one embodiment, a digital photographic system, such as digital photographic system 300, is configured to perform method 17-102. The digital photographic system may be implemented within a digital camera, such as digital camera 17-202 of FIG. 17-2A, or a mobile device, such as mobile device 17-204 of FIG. 17-2B.

Method 17-102 begins in step 17-140, where the camera module configures exposure parameters for an image stack to be sampled by the camera module. Configuring the exposure parameters may include, without limitation, writing registers within an image sensor comprising the camera module that specify exposure time for each participating analog storage plane, exposure sensitivity for one or more analog storage planes, or a combination thereof. Exposure parameters may be determined prior to this step according to any technically feasible technique, such as well-known techniques for estimating exposure based on measuring exposure associated with a sequence of test images sampled using different exposure parameters.

In step 17-142, the camera module receives a capture command. The capture command directs the camera module to sample two or more images comprising the image stack. The capture command may result from a user pressing a shutter release button, such as a physical button or a user interface button. In step 17-144, the camera module initializes a pixel array within the image sensor. In one embodiment, initializing the pixel array comprises driving voltages on internal nodes of photo-sensitive cells within one or more analog storage planes to a reference voltage, such as a supply voltage or a bias voltage.

In step 17-146, the camera module samples one or more ambient images within corresponding analog storage planes. In one embodiment, step 17-146 implements steps 17-116 through 17-122 of method 17-100 of FIG. 17-1A.

In step 17-150, the camera module determines that a strobe unit, such as strobe unit 336, is enabled. In one embodiment, determining that the strobe unit is enabled includes the camera module directly enabling the strobe unit, such by transmitting a strobe control command through strobe control signal 338. In another embodiment, determining that the strobe unit is enabled includes the camera module detecting that the strobe unit has been enabled, such as by processor complex 310.

In step 17-152, the camera module samples one or more strobe images within corresponding analog storage planes. In one embodiment, step 17-152 implements steps 17-116 through 17-122 of method 17-100 of FIG. 17-1A. In one embodiment, the camera module directly disables the strobe unit after completing step 17-152, such as by transmitting a strobe control command through strobe control signal 338. In another embodiment, processor complex 310 disables the strobe unit after the camera module completes step 17-152.

In certain embodiments, the camera module is configured to store both ambient images and strobe images concurrently within analog storage planes. In other embodiments, the camera module offloads one or more ambient images prior to sampling a strobe image.

FIG. 17-2 illustrates generating a synthetic image 17-250 from an image stack 17-200, according to one embodiment of the present invention. As shown, image stack 17-200 includes images 17-210, 17-212, and 17-214 of a photographic scene comprising a high brightness region 17-220 and a low brightness region 17-222. In this example, image 17-212 is exposed according to overall scene brightness, thereby generally capturing scene detail. Image 17-212 may also potentially capture some detail within high brightness region 17-220 and some detail within low brightness region 17-222. Image 17-210 is exposed to capture image detail within high brightness region 17-220. For example, image 17-210 may be exposed according to an exposure offset (e.g., one or more exposure stops down) relative to image 17-212. Alternatively, image 17-210 may be exposed according to local intensity conditions for one or more of the brightest regions in the scene. For example, image 17-210 may be exposed according to high brightness region 17-220, to the exclusion of other regions in the scene having lower overall brightness. Similarly, image 17-214 is exposed to capture image detail within low brightness region 17-222. To capture low brightness detail within the scene, image 17-214 may be exposed according to an exposure offset (e.g., one or more exposure stops up) relative to image 17-212. Alternatively, image 17-214 may be exposed according to local intensity conditions for one or more of the darker regions of the scene.

An image blend operation 17-240 generates synthetic image 17-250 from image stack 17-200. As depicted here, synthetic image 17-250 includes overall image detail, as well as image detail from high brightness region 17-220 and low brightness region 17-222. Image blend operation 17-240 may implement any technically feasible operation for blending an image stack. For example, any high dynamic range (HDR) blending technique may be implemented to perform image blend operation 17-240. Exemplary blending techniques known in the art include bilateral filtering, global range compression and blending, local range compression and blending, and the like.

To properly perform a blend operation, Images 17-210, 17-212, 17-214 need to be aligned to so that visible detail in each image is positioned in the same location in each image. For example, feature 17-225 in each image should be located in the same position for the purpose of blending images 17-210, 17-212, 17-214 to generate synthetic image 17-250. Misalignment can result in blurring or ghosting in synthetic image 17-250. Various techniques are known in the art for aligning images that may have been taken from a slightly different camera position. However, if scene content changes, then alignment may fail, leading to a poor quality synthetic image 17-250. Scene content may change in a conventional camera system because inter-sample time between images 17-210, 17-212, and 17-214 is sufficiently long so as to capture discernible movement of subjects comprising scene content for images comprising an image stack. In many typical scenarios, ten milliseconds or more of inter-sample time is sufficiently long to result in discernible movement of common photographic subject matter. Furthermore, in certain scenarios, camera shake introduces discernible blur into synthetic image 17-250.

Embodiments of the present invention serve to reduce or eliminate inter-sample time for two or more images comprising an image stack. In one embodiment, an image stack is captured by a digital photographic system, described below in greater detail. A strobe unit may be enabled to provide illumination in conjunction with sampling one or more images within the image stack.

FIG. 17-3 illustrates a block diagram of image sensor 332, according to one embodiment of the present invention. As shown, image sensor 332 comprises row logic 17-412, a control (CTRL) unit 17-414, a pixel array 17-410, a column read out circuit 17-420, an analog-to-digital unit 17-422, and an input/output interface unit 17-426. The image sensor 332 may also include a statistics unit 17-416.

Pixel array 17-410 comprises a two-dimensional array of pixels 17-440 configured to sample focused optical image information and generate a corresponding electrical representation. Each pixel 17-440 samples intensity information for locally incident light and stores the intensity information within associated analog sampling circuits. In one embodiment, the intensity information comprises a color intensity value for each of a red, a green, and a blue color channel. Row logic 17-412 includes logic circuits configured to drive row signals associated with each row of pixels. The row signals may include, without limitation, a reset signal, a row select signal, and at least two independent sample control signals. One function of a row select signal is to enable switches associated with analog sampling circuits within a row of pixels to couple analog signal values (e.g., analog current values or analog voltage values) to a corresponding column output signal, which transmits the analog signal value to column read out circuit 17-420. Column read out circuit 17-420 may be configured to multiplex the column output signals to a smaller number of column sample signals, which are transmitted to analog-to-digital unit 17-422. Column read out circuit 17-420 may multiplex an arbitrary ratio of column output signals to column sample signals. Analog-to-digital unit 17-422 quantizes the column sample signals for transmission to interconnect 334 via input/output interface 17-426.

In one embodiment, the analog signal values comprise analog currents, and the analog-to-digital unit 17-422 is configured to convert an analog current to a corresponding digital value. In other embodiments, column read out circuit 17-420 is configured to convert analog current values to corresponding analog voltage values (e.g. through a transimpedance amplifier or TIA), and the analog-to-digital unit 17-422 is configured to convert the analog voltage values to corresponding digital values. In certain embodiments, column read out circuit 17-420 implements an analog gain function, which may be configured according to a digital gain value.

In one embodiment, control unit 17-414 is configured to generate detailed timing control signals for coordinating operation of row logic 17-412, column read out circuit 17-420, analog-to-digital unit 17-422, input output interface unit 17-426, and statistics unit 17-416.

In one embodiment, statistics unit 17-416 is configured to monitor pixel data generated by analog-to-digital unit 17-422 and, from the monitored pixel data, generate specified image statistics. The image statistics may include, without limitation, histogram arrays for individual pixel color channels for an image, a histogram array for intensity values derived from each pixel intensity value for an image, intensity sum values for each color channel taken over an image, a median intensity value for an image, an exposure value (EV) for an image, and the like. Image statistics may further include, without limitation, a pixel count for pixels meeting certain defined criteria, such as a pixel count for pixels brighter than a high threshold intensity, a pixel count for pixels darker than a low threshold intensity, a weighted pixel sum for pixels brighter than a high threshold intensity, a weighted pixel sum for pixels darker than a low threshold intensity, or any combination thereof. Image statistics may further include, without limitation, curve fitting parameters, such as least squares parameters, for linear fits, quadratic fits, non-quadratic polynomial fits, exponential fits, logarithmic fits, and the like.

Image statistics may further include, without limitation, one or more parameters computed from one or more specified subsets of pixel information sampled from pixel array 17-410. One exemplary parameter defines a subset of pixels to be a two-dimensional contiguous region of pixels associated with a desired exposure point. Here, an exposure parameter may be computed, for example, as a median intensity value for the region, or as a count of pixels exceeding a threshold brightness for the region. For example, a rectangular region corresponding to an exposure point may be defined within an image associated with the pixel array, and a median intensity may be generated for the rectangular region, given certain exposure parameters such as exposure time and ISO sensitivity.

Image statistics may be accumulated and computed as digital samples become available from pixel array 17-410. For example, image statistics may be accumulated as digital samples are generated by the analog-to-digital unit 17-422. In certain embodiments, the samples may be accumulated during transmission through interconnect 334. In one embodiment, the image statistics are mapped in a memory-mapped register space, which may be accessed through interconnect 334. In other embodiments, the image statistics are transmitted in conjunction with transmitting pixel data for a captured image. For example, the image statistics for a given image may be transmitted as in-line data, following transmission of pixel intensity data for the image.

In one embodiment, image statistics are computed using a fixed-function logic circuit comprising statistics unit 17-416. In other embodiments, image statistics are computed via a programmable processor comprising statistics unit 17-416. In certain embodiments, programming instructions may be transmitted to the programmable processor via interconnect 334.

In one embodiment, control unit 17-414 is configured to adjust exposure parameters for pixel array 17-410 based on images statistics for a previous image. In this way, image sensor 332 may advantageously determine proper exposure parameters per one or more specified exposure points without burdening processor resources within processor complex 310, and without incurring concomitant latencies. The proper exposure parameters may be determined by sampling sequential images and adjusting the exposure parameters for each subsequent image based on exposure parameters for a corresponding previous image. The exposure parameters for a given captured image may be read by camera interface unit 386 and stored as metadata for the image.

In one embodiment, input/output interface unit 17-426 is configured to modify pixel intensity data associated with a captured frame based on certain image statistics. In one implementation, input/output interface unit 17-426 adjusts white balance of an image during transmission of image data through interconnect 334. Red, green, and blue components of each pixel may be scaled based on previously computed image statistics. Such image statistics may include a sum of red, green, and blue components. With these sums, input/output interface unit 17-426 may be configured to perform a conventional gray world white balance correction. Alternatively, the image statistics may include quadratic curve fit parameters. With quadratic fit components, input/output interface unit 17-426 may be configured to perform a quadratic white balance mapping. Additional embodiments provide for illuminator identification via selecting for pixels above a lower threshold and below an upper threshold for consideration in determining white balance. Still further embodiments provide for color temperature identification by mapping selected samples to a color temperature snap-point. Mapping color temperature to a snap-point thereby applies an assumption that scene illumination is provided by an illuminator having a standard color temperature. In each example, image statistics may be optionally applied to adjust pixel information prior to transmission via interconnect 334.

In an alternative embodiment, statistics unit 17-416, as well as pixel modification functions discussed herein with respect to input/output interface unit 17-426 are instead implemented within sensor interface 386, residing within processor complex 310. In such an embodiment, power and heat dissipation associated with a statistics unit 17-416 and related pixel modification functions is shifted away from pixel array 17-410, which may incorporate circuitry that is sensitive to heat. In another alternative embodiment, a statistics unit 17-416, as well as pixel modification functions discussed herein with respect to input/output interface unit 17-426 are instead implemented within a separate die disposed within camera module 330. In such an embodiment, related power and heat dissipation is also shifted away from pixel array 17-410. In this embodiment, camera module 330 is configured to offer statistics and pixel modification functions in conjunction with a conventional processor complex 310, which may be configured to include a conventional sensor interface.

FIG. 17-4 is a circuit diagram for a conventional photo-sensitive cell 17-500 within a pixel, implemented using complementary-symmetry metal-oxide semiconductor (CMOS) devices. Photo-sensitive cell 17-500 may be used to implement cells comprising a conventional pixel. A photodiode (PD) 17-410 is configured to convert incident light 17-512 into a photodiode current (I_PD). Field-effect transistors (FETs) 17-520, 17-522, 17-524, 17-526, and capacitor C 17-528 are configured to integrate the photodiode current over an exposure time, to yield a resulting charge associated with capacitor C 17-528. Capacitor C 17-528 may comprise a distinct capacitor structure, as well as gate capacitance associated with FET 17-524, and diffusion to well capacitance, such as drain capacitance, associated with FETS 17-520, 17-522.

FET 17-520 is configured to provide a path to charge node 17-529 to a voltage associated with voltage supply V2 when reset0 17-530 is active (e.g., low). FET 17-522 provides a path for the photodiode current to discharge node 17-529 in proportion to an intensity of incident light 17-512, thereby integrating incident light 17-512, when sample 17-534 is active (e.g., high). The resulting charge associated with capacitor C 17-528 is an integrated electrical signal that is proportional to the intensity of incident light 17-512 during the exposure time. The resulting charge provides a voltage potential associated with node 17-529 that is also proportional to the intensity of incident light 17-512 during the exposure time.

When row select 17-536 is active (e.g., high), FET 17-526 provides a path for an output signal current from voltage source V1 through FET 17-524, to out 17-538. FET 17-524 converts a voltage on node 17-529, into a corresponding output current signal through node out 17-538. During normal operation, incident light sampled for an exposure time corresponding to an active time for sample 17-534 is represented as a charge on capacitor C 17-528. This charge may be coupled to output signal out 17-538 and read as a corresponding current value. This circuit topology facilitates non-destructive reading of charge on node 17-529.

FIG. 17-5A is a circuit diagram for a photo-sensitive cell 17-600, according to one embodiment. An instance of photo-sensitive cell 17-600 may implement one cell of cells 17-442-17-445 comprising a pixel 17-440. As shown, photo-sensitive cell 17-600 comprises two analog sampling circuits 17-601, and photodiode 17-620. Analog sampling circuit 17-601(A) comprises FETs 17-622, 624, 626, 628, and node C 17-610. Analog sampling circuit 17-601(B) comprises FETs 17-652, 17-654, 17-656, 17-658, and node C 17-640.

Node C 17-610 represents one node of a capacitor that includes gate capacitance for FET 17-624 and diffusion capacitance for FETs 17-622 and 628. Node C 17-610 may also be coupled to additional circuit elements (not shown) such as, without limitation, a distinct capacitive structure, such as a metal-oxide stack, a poly capacitor, a trench capacitor, or any other technically feasible capacitor structures. Node C 17-640 represents one node of a capacitor that includes gate capacitance for FET 17-654 and diffusion capacitance for FETs 17-652 and 17-658. Node C 17-640 may also be coupled to additional circuit elements (not shown) such as, without limitation, a distinct capacitive structure, such as a metal-oxide stack, a poly capacitor, a trench capacitor, or any other technically feasible capacitor structures.

When reset1 17-630 is active (low), FET 17-628 provides a path from voltage source V2 to node C 17-610, causing node C 17-610 to charge to the potential of V2. When sample1 17-632 is active, FET 17-622 provides a path for node C 17-610 to discharge in proportion to a photodiode current (I_PD) generated by photodiode 17-620 in response to incident light 17-621. In this way, photodiode current I_PD is integrated for a first exposure time when sample1 17-632 is active, resulting in a corresponding voltage on node C 17-610. When row select 17-634 is active, FET 17-626 provides a path for a first output current from V1 to output outA 17-612. The first output current is generated by FET 17-624 in response to the voltage on C 17-610. When row select 17-634 is active, the output current at outA 17-612 is therefore proportional to the integrated intensity of incident light 17-621 during the first exposure time.

When reset2 17-660 is active (low), FET 17-658 provides a path from voltage source V2 to node C 17-640, causing node C 17-640 to charge to the potential of V2. When sample2 17-662 is active, FET 17-652 provides a path for node C 17-640 to discharge according to a photodiode current (I_PD) generated by photodiode 17-620 in response to incident light 17-621. In this way, photodiode current I_PD is integrated for a second exposure time when sample2 17-662 is active, resulting in a corresponding voltage on node C 17-640. When row select 17-664 is active, FET 17-656 provides a path for a second output current from V1 to output outB 17-642. The second output current is generated by FET 17-654 in response to the voltage on C 17-640. When row select 17-664 is active, the output current at outB 17-642 is therefore proportional to the integrated intensity of incident light 17-621 during the second exposure time.

Photo-sensitive cell 17-600 includes independent reset signals reset1 17-630 and reset2 17-660, independent sample signals sample1 17-632 and sample2 17-662, independent row select signals row select1 17-634 and row select2 17-664, and independent output signals outA 17-612 and outB 17-642. In one embodiment, column signals 11-532 of FIG. 11-3A comprise independent signals outA 17-612 and outB 17-642 for each cell within each pixel 17-440 within a row of pixels. In one embodiment, row control signals 17-430 comprise signals for row select1 17-634 and row select2 17-664, which are shared for a given row of pixels.

A given row of instances of photo-sensitive cell 17-600 may be selected to drive respective outA 17-612 signals through one set of column signals 11-532. The w of instances of photo-sensitive cell 17-600 may also be selected to independently drive respective outB 17-642 signals through a second, parallel set of column signals 11-532. In one embodiment, reset1 17-630 is coupled to reset2 17-660, and both are asserted together.

Summarizing the operation of photo-sensitive cell 17-600, two different samples of incident light 17-621 may be captured and stored independently on node C 17-610 and node C 17-640. An output current signal corresponding to the first sample of the two different samples may be coupled to output outA 17-612 when row select1 17-634 is active. Similarly, an output current signal corresponding to the second of the two different samples may be coupled to output outB 17-642 when row select2 17-664 is active.

FIG. 17-5B is a circuit diagram for a photo-sensitive cell 17-602, according to one embodiment. An instance of photo-sensitive cell 17-602 may implement one cell of cells 17-442-17-445 comprising a pixel 17-440. Photo-sensitive cell 17-602 operates substantially identically to photo-sensitive cell 17-600 of FIG. 17-5A, with the exception of having a combined output signal out 17-613 rather than independent output signals outA 17-612, outB 17-642. During normal operation of photo-sensitive cell 17-602, only one of row select1 17-634 and row select2 17-664 should be driven active at any one time. In certain scenarios, photo-sensitive cell 17-602 may be designed to advantageously implement cells requiring less layout area devoted to column signals 11-532 than photo-sensitive cell 17-600.

FIG. 17-6A is a circuit diagram for a photo-sensitive cell 17-604, according to one embodiment. Photo-sensitive cell 17-604 operates substantially identically to sensitive cell 17-600 of FIG. 17-5A, with the exception of implementing a combined row select 635 rather than independent row select signals row select1 17-634 and row select2 17-664. Photo-sensitive cell 17-604 may be used to advantageously implement cells requiring less layout area devoted to row control signals 17-430.

Although photo-sensitive cell 17-600, photo-sensitive cell 17-602, and photo-sensitive cell 17-604 are each shown to include two analog sampling circuits 17-601, persons skilled in the art will recognize that these circuits can be configured to instead include an arbitrary number of analog sampling circuits 17-601, each able to generate an independent sample. Furthermore, layout area for a typical cell is dominated by photodiode 17-620, and therefore adding additional analog sampling circuits 17-601 to a photo-sensitive cell has a relatively modest marginal impact on layout area.

In general, sample1 17-632 and sample2 17-662 may be asserted to an active state independently. In certain embodiments, sample1 17-632 and sample2 17-662 are asserted to an active state sequentially, with only one analog sampling circuit 17-601 sourcing current to the photodiode 17-620 at a time. In other embodiments, sample1 17-632 and sample2 17-662 are asserted to an active state simultaneously to generate images that are sampled substantially concurrently, but with each having a different effective exposure time.

When both sample1 17-632 and sample2 17-662 are asserted simultaneously, photodiode current I_PD will be divided between discharging node C 17-610 and node C 17-640. For example, if sample1 17-632 and sample2 17-662 are both initially asserted, then I_PD is split initially between discharging node C 17-610 and discharging node C 17-640, each at an initial discharge rate. A short time later, if sample2 17-662 is unasserted (set to inactive), then C 17-610 is discharged at a faster rate than the initial discharge rate. In such a scenario, C 17-640 may be used to capture a color component of a pixel within a first image having a less sensitive exposure (shorter effective exposure time), while C 17-610 may be used to capture a corresponding color component of a pixel within a second image having a more sensitive exposure (longer effective exposure time). While both of the above color components were exposed according to different effective and actual exposure times, both color components were also captured substantially coincidentally in time, reducing the likelihood of any content change between the first image and the second image.

In one exemplary system, three substantially identical analog sampling circuits 17-601 are instantiated within a photo-sensitive cell. In a first sampling interval lasting one half of a unit of time, all three analog sampling currents are configured to source current (sample signal active) into the photodiode 17-620, thereby splitting photodiode current I_PD substantially equally three ways. In a second sampling interval, lasting one unit of time, a first of the three analog sampling circuits 17-601 is configured to not continue sampling and therefore not source current into the photodiode 17-620. In a third sampling interval, lasting two units of time, a second of the three analog sampling circuits 17-601 is configured to not continue sampling and therefore not source current into the photodiode 17-620.

In this example, the first analog sampling circuit 17-601 is able to integrate one quarter of the photodiode current multiplied by time as the second analog sampling circuit 17-601, which was able to integrate one quarter of the photodiode current multiplied by time as the third analog sampling circuit 17-601. The second analog sampling circuit 17-601 may be associated with a proper exposure (0 EV), while the first analog sampling circuit 17-601 is therefore associated with a two-stop under exposure (−2 EV), and the third analog sampling circuit 17-601 is therefore associated with a two-stop over exposure (+2 EV). In one embodiment, digital photographic system 300 determines exposure parameters for proper exposure for a given scene, and subsequently causes the camera module 330 to sample three images based on the exposure parameters. A first image of the three images is sampled according to half an exposure time specified by the exposure parameters (−2 EV), a second image of three images is sampled according to the exposure time specified by the exposure parameters (0 EV), while a third image of three images is sampled according to twice the exposure time specified by the exposure parameters (2 EV). The first image is sampled concurrently with the second image and third image, while the second image is sample concurrently with the third image. As a consequence of concurrent sampling, content differences among the three images are significantly reduced and advantageously bounded by differences in exposure time between images, such as images comprising an image stack. By contrast, prior art systems sample images sequentially rather than concurrently, thereby introducing greater opportunities for content differences between each image.

These three exposure levels (−2, 0, +2 EV) for images comprising an image stack are suitable candidates for HDR blending techniques, including a variety of conventional and well-known techniques. In certain embodiments, conventional techniques may be implemented to determine exposure parameters, including a mid-range exposure time, for a given scene associated with a proper exposure (0 EV). Continuing the above example, the first sampling interval would implement an exposure time of half the mid-range exposure time. The second sampling interval would implement the mid-range exposure time, and the third sampling interval would implement an exposure time of twice the mid-range exposure time.

In other embodiments, the analog sampling circuits 17-601 are not substantially identical. For example, one of the analog sampling circuits 17-601 may include twice or one half the storage capacitance (such as the capacitance associated with node C 17-610 of FIG. 17-5A) of a different analog sampling circuit 17-601 within the same pixel. Persons skilled in the art will understand that relative sample times for each different analog sampling circuit 17-601 may be computed based on relative capacitance and target exposure ratios among corresponding images.

In one embodiment, image sensor 332 comprising pixels 17-440 fabricated to include two or more instances of analog sampling circuits 17-601 is configured to sample one or more ambient image and sequentially sample one or more images with strobe illumination.

FIG. 17-6B depicts exemplary physical layout for a pixel 17-440 comprising four photo-sensitive cells 17-442, 17-443, 17-444, 17-445, according to one embodiment. As shown, each photo-sensitive cell 17-442, 17-443, 17-444, 17-445 includes a photodiode 17-620 and analog sampling circuits 17-601. Two analog sampling circuits 17-601 are shown herein, however in other embodiments, three, four, or more analog sampling circuits 17-601 are included in each photo-sensitive cell.

In one embodiment, column signals 11-532 are routed vertically between photo-sensitive cells 17-442 and 17-443, and between photo-sensitive cells 17-444 and 17-445. Row control signals 17-430 are shown herein as running between photo-sensitive cells 17-442 and 17-444, and between photo-sensitive cells 17-443 and 17-445. In one embodiment, layout for cells 17-442, 17-443, 17-444, and 17-445 is reflected substantially symmetrically about an area centroid of pixel 17-440. In other embodiments, layout for the cells 17-442, 17-443, 17-444, and 17-445 is instantiated without reflection, or with different reflection than shown here.

FIG. 17-7A illustrates exemplary timing for controlling cells within a pixel array to sequentially capture an ambient image and a strobe image illuminated by a strobe unit, according to one embodiment of the present invention. As shown, an active-low reset signal (RST) is asserted to an active low state to initialize cells within the pixel array. Each cell may implement two or more analog sampling circuits, such as analog sampling circuit 17-601 of FIGS. 17-5A, 17-5B, and 17-6A, coupled to a photodiode, such as photodiode 17-620. In one embodiment, each cell comprises an instance of photo-sensitive cell 17-600. In another embodiment, each cell comprises an instance of photo-sensitive cell 17-602. In yet another embodiment, each cell comprises an instance of photo-sensitive cell 17-604. In still yet another embodiment, each cell comprises an instance of a photo-sensitive cell that includes two or more technically feasible analog sampling circuits, each configured to integrate a signal from a photodiode, store an integrated value, and drive a representation of the integrated value to a sense wire, such as a column signal, such as a column signal 11-532.

A first sample enable signal (S1) enables a first analog sampling circuit comprising a first analog storage plane to integrate a signal from an associated photodiode. A second sample enable signal (S2) enables a second analog sampling circuit comprising a second analog storage place to integrate the signal from the photodiode. In one embodiment, both reset1 17-630 and reset2 17-660 correspond to reset signal RST, sample1 17-632 corresponds to S1, and sample2 17-662 corresponds to S2. Furthermore, row select1 17-634 corresponds to RS1 and row select 17-664 corresponds to RS2. In certain embodiments, RST is asserted briefly during each assertion of S1 and S2 to bias the photodiode prior to sampling the photodiode current. In certain other embodiments, each photodiode is coupled to a FET that is configured to provide a reset bias signal to the photodiode independent of the RST signal. Such biasing may be implemented in FIGS. 17-7B through 17-7F.

An Out signal depicts an analog signal being driven from an analog sampling circuit 17-601. The Out signal may represent outA 17-612, outB 17-642, or Out 17-613, depending on a particular selection of analog sampling circuit 17-601. For example, in an embodiment that implements photo-sensitive cell 17-602, RS1 and RS2 are asserted mutually exclusively and the Out signal corresponds to Out 17-613.

A strobe enable signal (STEN) corresponds in time to when a strobe unit is enabled. In one embodiment, camera module generates STEN to correspond in time with S1 being de-asserted at the conclusion of sampling an ambient image (Amb1).

FIG. 17-7B illustrates exemplary timing for controlling cells within a pixel array to concurrently capture an ambient image and an image illuminated by a strobe unit, according to one embodiment of the present invention. As shown, the active duration of STEN is shifted in time between two different sampling intervals for the same ambient image. This technique may result in charge sharing between each analog sampling circuit and the photodiode. In this context, charge sharing would manifest as inter-signal interference between a resulting ambient image and a resulting strobe image. Removing the inter-signal interference may attenuated in the ambient image and the strobe image using any technically feasible technique.

FIG. 17-7C illustrates exemplary timing for controlling cells within a pixel array to concurrently capture two ambient images having different exposures, according to one embodiment of the present invention. As shown, S1 and S2 are asserted active at substantially the same time. As a consequence, sampling of the two ambient images is initiated concurrently in time. In other embodiments, the strobe unit is enabled during Amb1 and at least one of the images comprises a strobe image rather than an ambient image.

FIG. 17-7D illustrates exemplary timing for controlling cells within a pixel array to concurrently capture two ambient images having different exposures, according to one embodiment of the present invention. As shown, S2 is asserted after S1, shifting the sample time of the second image to be centered with that of the first image. In certain scenarios, centering the sample time may reduce content differences between the two images.

FIG. 17-7E illustrates exemplary timing for controlling cells within a pixel array to concurrently capture four ambient images, each having different exposure times, according to one embodiment of the present invention. Each of the four ambient images corresponds to an independent analog storage plane. In certain embodiments, a strobe unit is enabled and strobe images are captured rather than ambient images.

FIG. 17-7F illustrates exemplary timing for controlling cells within a pixel array to concurrently capture three ambient images having different exposures and subsequently capture a strobe image, according to one embodiment of the present invention.

While row select signals (RS1, RS2) are shown in FIGS. 17-7A through 17-7F, different implementations may require different row selection configurations. Such configurations are within the scope and spirit of different embodiments of the present invention.

While various embodiments have been described above with respect to a digital camera 17-202 and a mobile device 17-204, any device configured to perform the method 17-100 of FIG. 17-1A or method 17-102 of FIG. 17-1B is within the scope and spirit of the present invention. In certain embodiments, two or more digital photographic systems implemented in respective devices are configured to sample corresponding image stacks in mutual time synchronization.

While the foregoing is directed to embodiments of the present invention, other and further embodiments of the invention may be devised without departing from the basic scope thereof, and the scope thereof is determined by the claims that follow.

Embodiments disclosed herein allow a photographic device to reduce noise associated with a captured image of a photographic scene. In one embodiment, two images are merged into one image (a merged image) having lower overall noise than either of the two images. In another embodiment, one image is processed to reduce noise associated with the one image. In one embodiment, the photographic device is configured to capture a first image and a second image of the same scene. The first image is captured with a flash illuminator device enabled, and the second image may be captured with the flash illuminator device either disabled completely or enabled to generate less light relative to that associated with capturing the first image. In the context of the present description, the first image may be referred to herein as a flash image and the second image may be referred to herein as an ambient image.

In certain embodiments, the first image may be captured prior to the second image in time sequence. In other embodiments, the second image may be captured prior to the first image in time sequence. In certain embodiments, the first image is captured by a first camera module and the second image is captured by a second, different camera module. In certain other embodiments, the first image is generated by combining two or more images that are captured by a first camera module, and the second image is generated by combining two or more images that are captured by a second camera module. In yet other embodiments, the first image is generated by combining two or more images, each captured by different corresponding camera modules; in related embodiments, the second image is generated by combining two or more images, each captured by the camera modules.

The first image may be captured according to a first set of exposure parameters and the second image may be captured according to a second set of exposure parameters. Each set of exposure parameters may include one or more of: exposure time, exposure sensitivity (ISO value), and lens aperture. Exposure parameters for a flash image may further include flash intensity, flash duration, flash color, or a combination thereof. The exposure parameters may also include a white balance, which may be determined according to a measured white balance for the scene, according to a known or measured white balance for the flash illuminator device, or a combination thereof. The measured white balance for the scene may be determined according to any technically feasible technique, such as estimating a gray world white balance, estimating illuminator white balance within the scene, and so forth. A capture process includes capturing the first image and the second image, and any associated images from which the first image and the second image are generated. The capture process may include a metering process to generate each set of exposure parameters. In one embodiment, the metering process is performed prior to the capture process and includes at least one ambient metering process and at least one flash metering process.

The metering process may be performed to determine one or more of the exposure parameters such that an exposure goal is satisfied. A sequential set of metering images may be captured and analyzed for comparison against the exposure goal to determine the exposure parameters, with each successive metering image in the set of metering images captured according to a refined approximation of the exposure parameters until the exposure goal is adequately satisfied. In a live view implementation, refinement of exposure may continuously accommodate changes to scene lighting prior to a user taking a picture. A first exemplary exposure goal for a captured image is for the captured image to exhibit an intensity histogram having a median intensity value that is substantially half way between intensity extremes. For example, in a system where image intensity ranges from 0.0 to 1.0, then exposure parameters that cause an image to exhibit a histogram with a median of approximately 0.50 would satisfy the exposure goal. This first exemplary exposure goal is suitable for capturing certain ambient images. A second exemplary exposure goal may be specified to bound a maximum portion or number of poorly-exposed (e.g., over-exposed or under-exposed) pixels. Satisfying the above first and second exposure goals simultaneously may require a modified first exposure goal such that the median intensity goal may specify a range (e.g., 0.45 to 0.55) rather than a fixed value (e.g. 0.50).

In one embodiment, a first metering process is performed for the first image and a second metering process is being performed for the second image. The first metering process may operate according to different constraints than the second metering process. For example, the ambient image may be metered to achieve a median intensity of approximately 0.50, while the flash image may be metered to bound the portion of over-exposed pixels to less than a specified portion of image pixels. Alternatively, the flash image may be metered to bound the portion of over-exposed pixels additional to already over-exposed pixels in the ambient image to less than a specified portion of image pixels. In other words, the flash image may be metered to avoid increasing more than a specified portion of additional over-exposed pixels compared to the ambient image. In one embodiment, the specified portion is defined herein to be one percent of pixels for a given image. In other embodiments, the specified portion may be more than one percent or less than one percent of image pixels.

Enabling the flash illuminator device may cause flash reflection, such as specular reflection, on surfaces that are nearly perpendicular to illumination generated by the flash illuminator device, leading to locally over-exposed pixels within a reflection region. To reduce over-exposure due to flash reflection, the flash illuminator device may be enabled to sweep or otherwise vary intensity over a sequence of metering images, with different metering images captured using a different flash intensity. Reflection regions can be identified in the different metering images as over-exposed regions that grow or shrink based on flash intensity, but with an over-exposed central region that remains over-exposed over the different flash intensities. Over-exposed central regions may be masked out or excluded from consideration for exposure. Furthermore, regions that remain under-exposed or consistently-exposed over different flash intensities may also be excluded from consideration for exposure. In one embodiment, an exposure histogram is generated for each metering image using pixels within the metering image that are not excluded from consideration for exposure. In certain embodiments, the exposure histogram is an intensity histogram generated from pixel intensity values. Other technically feasible exposure histograms may also be implemented without departing the scope of various embodiments. Multiple metering images are captured with varying exposure parameters and corresponding exposure histograms are generated from the metering images. Based on the exposure histograms, exposure parameters are identified or estimated to best satisfy an exposure goal. In one embodiment, the exposure goal is that the exposure histogram has a median intensity value that is substantially half way between intensity extremes. One or more pixels may be excluded from consideration in the histogram as described above. This and related embodiments allow the capture of a flash image with appropriately illuminated foreground subjects. More generally, exposure parameters for illuminated foreground subjects are determined without compromising between exposure for the foreground and exposure for the background regions, while a separately exposed ambient image may be captured to provide data for appropriately exposed background regions and other regions insignificantly hit by the flash illuminator device. In one embodiment,

In one embodiment, exposure parameters for an ambient image and exposure parameters for a flash image are determined before the ambient image is captured and before the flash image is captured. For example, to capture an ambient image and a flash image, an ambient metering process and a flash metering process are first performed to generate exposure parameters for capturing an ambient image and, exposure parameters for capturing a flash image. The ambient metering process and the flash metering process may be performed in either order, according to specific implementation requirements, if any. After the ambient metering process and the flash metering process have both completed, the ambient image and the flash image are captured. The ambient image and the flash image may be captured in any order; however, human factors generally favor capturing the flash image last because people tend to hold a pose only until they see a flash. By completing the metering process for both the ambient image and the flash image prior to capturing the ambient image and the flash image, any delay between the capture times for the ambient image and the flash image can be essentially eliminated.

In certain embodiments, a camera module used to capture a flash image incorporates an image sensor configured to generate two or more exposures of the same captured image. In one embodiment, the two or more exposures are generated by performing analog-to-digital conversion on analog pixel values within the image sensor pixel for the captured image according to two or more different analog gain values. In another embodiment, the two or more exposures are generated by performing concurrent sampling into two or more different analog storage planes within the image sensor. The two or more exposures may be generated using different sensitivities for each analog storage plane or different equivalent exposure times for each analog storage plane.

An analog storage plane comprises a two-dimensional array of analog storage elements, each configured to store an analog value, such as a voltage value. At least one analog storage element should be configured to store an analog value for each color channel of each pixel of the image sensor. Two analog storage planes can coexist within the same image sensor, wherein each of the two analog storage planes provides a different analog storage element for the same color channel of each pixel. In one embodiment, each analog storage element comprises a capacitor configured to integrate current from a corresponding electro-optical conversion structure, such as a photodiode. An image sensor with two analog storage planes can capture and concurrently store two different images in analog form. The two different images may be captured sequentially or at least partially concurrently. In one embodiment, an ambient image is captured within one analog storage plane and a flash image is captured in a different analog storage plane. Each analog storage plane is sampled by an analog-to-digital converter to generate a digital representation of an image stored as analog values within the analog storage plane.

In certain embodiments, an ambient metering process is performed to determine ambient exposure parameters for an ambient image. In addition to the ambient metering process, a flash metering process is performed to determine flash exposure parameters for a flash image. Having determined both the ambient exposure parameters and the flash exposure parameters, the photographic device captures an ambient image according to the ambient exposure parameters, and a flash image according to the flash exposure parameters. This specific sequence comprising: first metering for the ambient image and the flash image, followed by capturing the ambient image and the flash image may advantageously reduce an inter-frame time between the ambient image and the flash image by scheduling the relatively time-consuming steps associated with each metering process to be performed prior to time-critical sequential image capture steps. In one embodiment, the ambient image and the flash image are stored in different analog storage planes within a multi-capture image sensor.

In one embodiment, the ambient metering process is performed prior to the flash metering process, and the flash metering process is constrained to determining an exposure time that is less than or equal to the exposure time determined by the ambient metering process. Furthermore, the flash metering process may be constrained to determining an ISO value that is less than or equal to the ISO value determined by the ambient metering process. Together, these constraints ensure that regions of the flash image primarily lit by ambient illumination will be less intense than those lit by flash illumination, thereby generally isolating the relative effect of flash illumination in a merged image generated by combining the flash image and the ambient image. The flash metering process may vary flash duration, flash intensity, flash color, or a combination thereof, to determine flash exposure parameters that satisfy exposure goals for the flash image, such as bounding the portion or number of over-exposed pixels within the flash image.

In one embodiment, a designated image (e.g., the first image, the second image, or a combination thereof) is processed according to de-noising techniques to generate a de-noised image comprising de-noised pixels. A de-noised pixel is defined herein as a pixel selected from a designated image at a selected pixel location and processed according to a de-noising technique. The de-noised image may be stored (materialized) in a data buffer for further processing or storage within a file system. Alternatively, de-noised pixels comprising the de-noised image may be processed further before being stored in a data buffer or file system.

In one embodiment, a pixel noise estimate may be calculated and used to determine a de-noising weight for an associated pixel in a designated image to generate a corresponding de-noised pixel in a de-noised image. A given de-noising weight quantifies an amount by which a corresponding pixel is made to appear visually similar to a surrounding neighborhood of pixels, thereby reducing perceived noise associated with the pixel. A high de-noising weight indicates that a pixel should appear more like the surrounding neighborhood of pixels, while a low de-noising weight allows a pixel to remain visually distinct (e.g., in color and intensity) relative to the surrounding neighborhood of pixels. In one embodiment, de-noising weight is represented as a numeric value between 0.0 and 1.0, with higher de-noising weights indicated with values closer to 1.0 and lower de-noising weights indicated by values closer to 0.0. Other technically feasible representations of a de-noising weight may also be implemented without departing the scope of various embodiments.

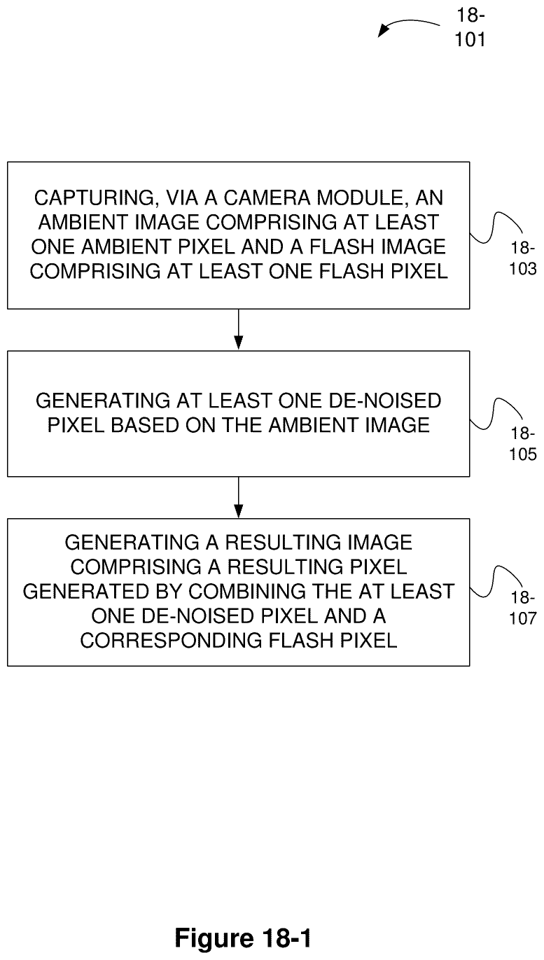

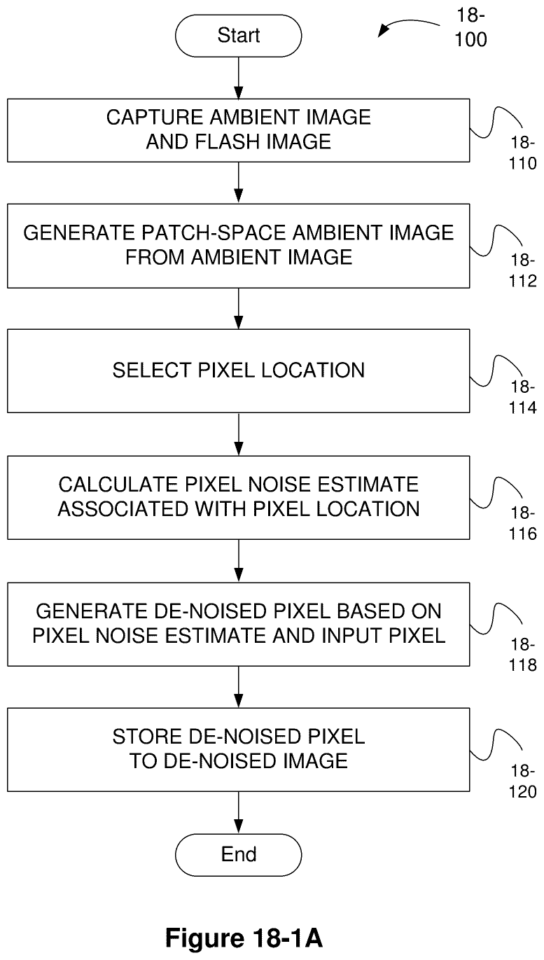

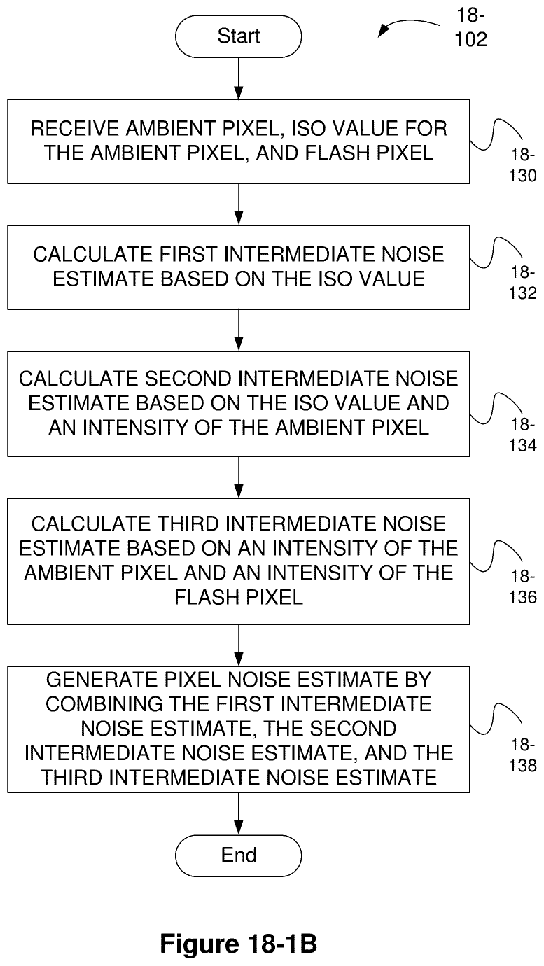

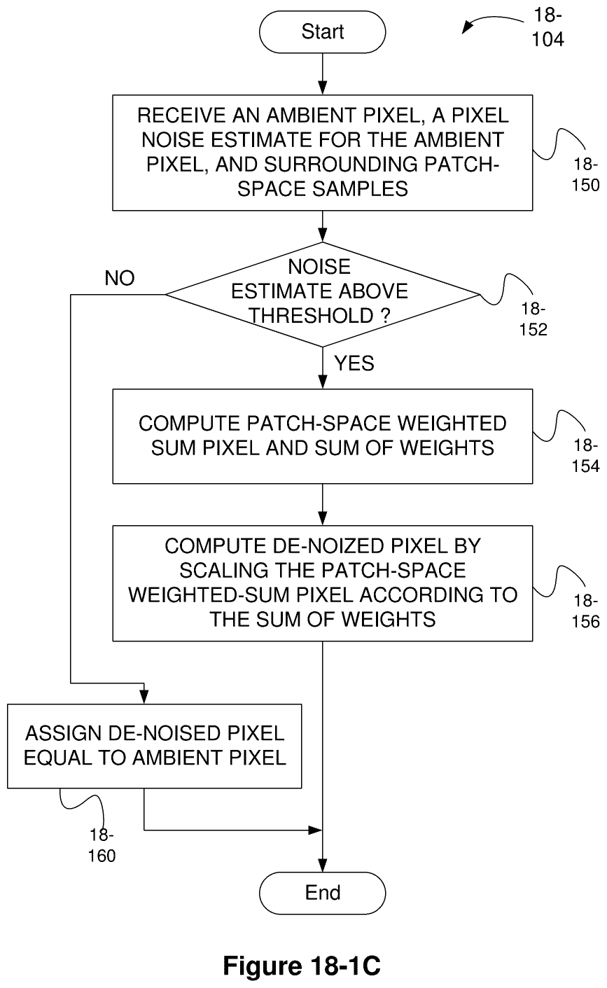

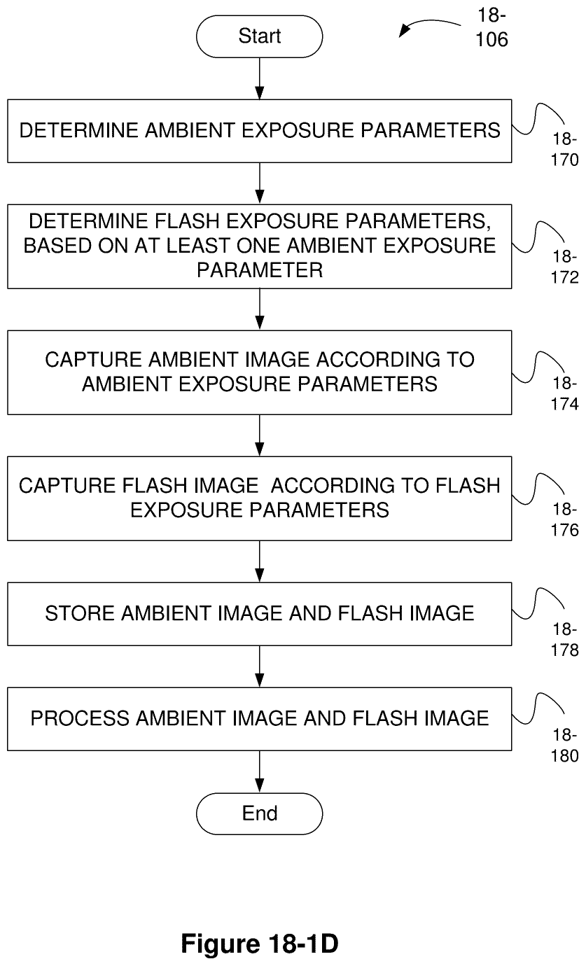

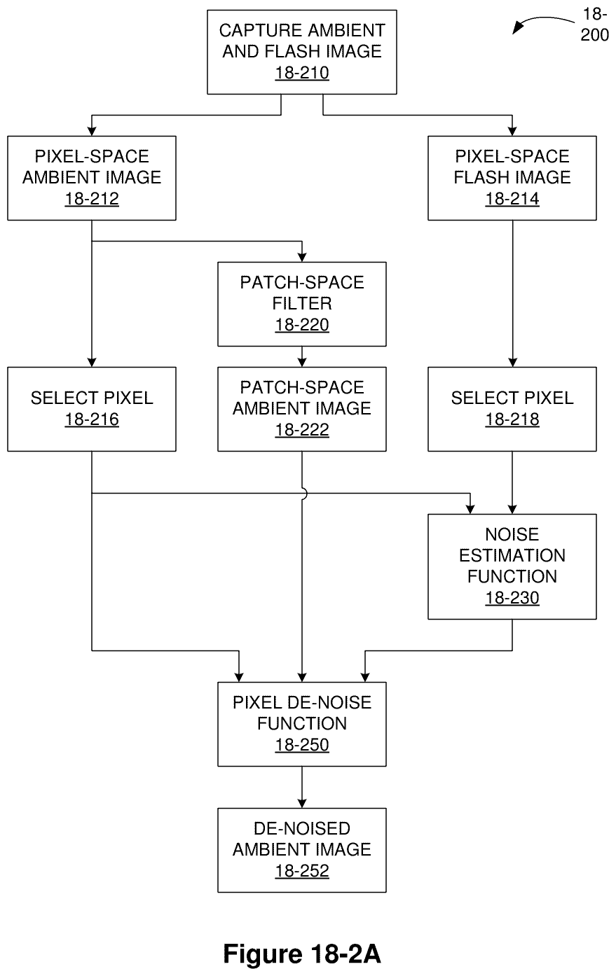

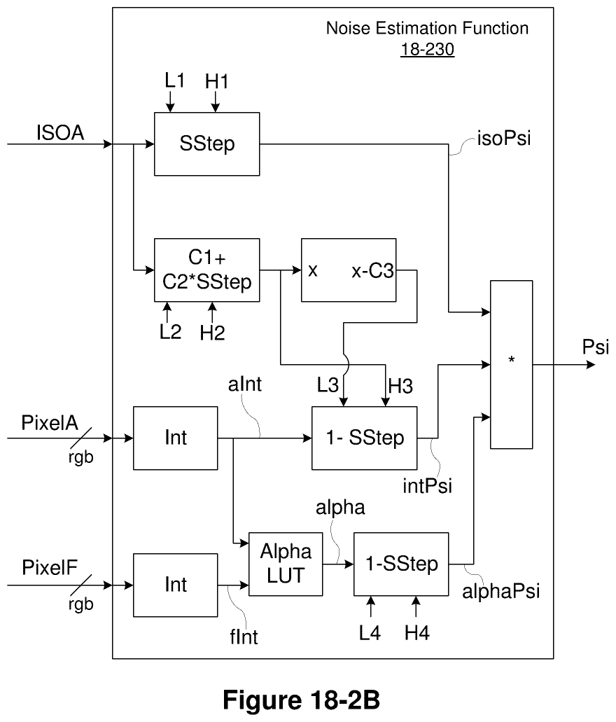

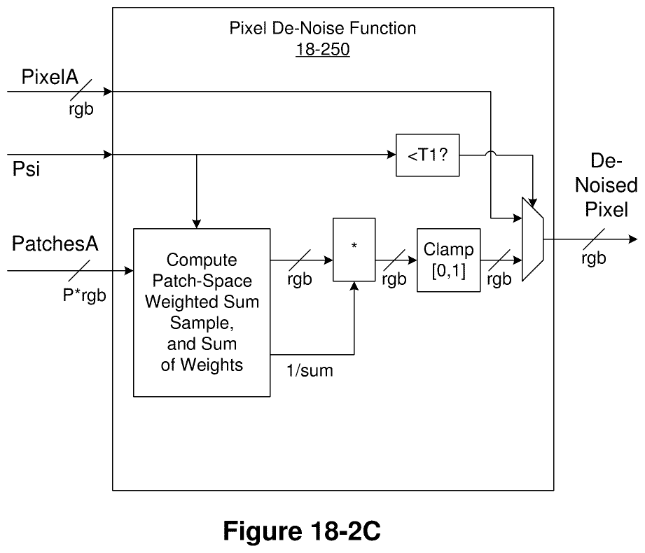

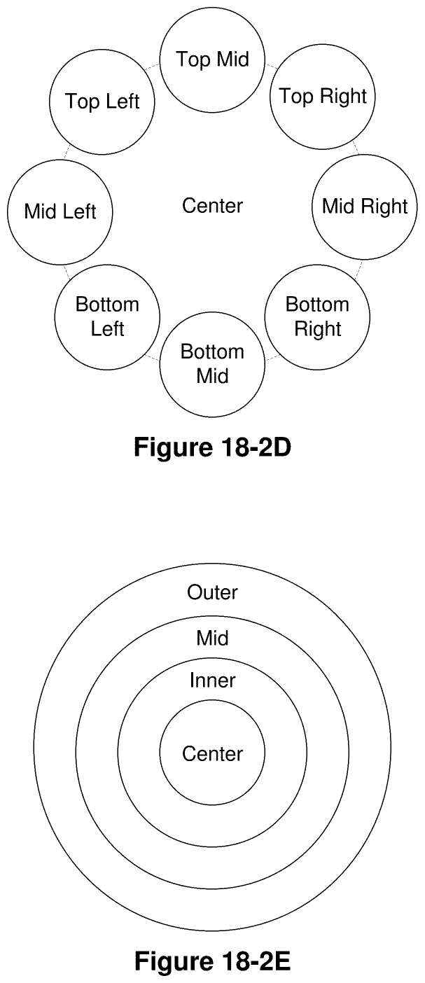

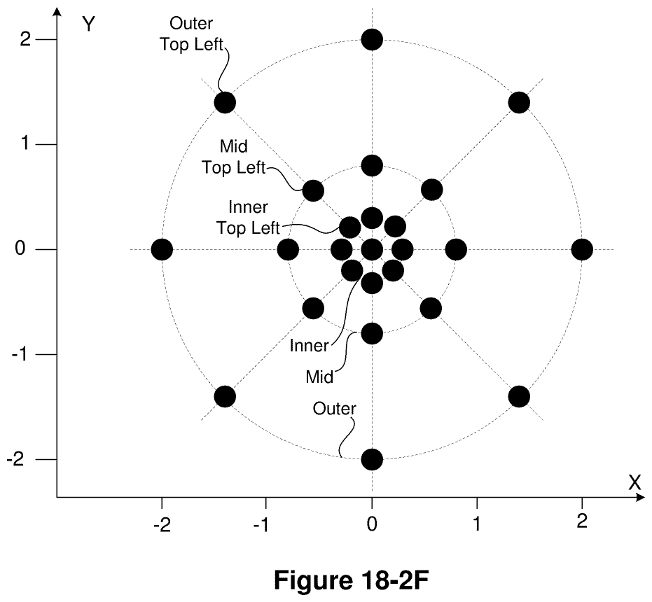

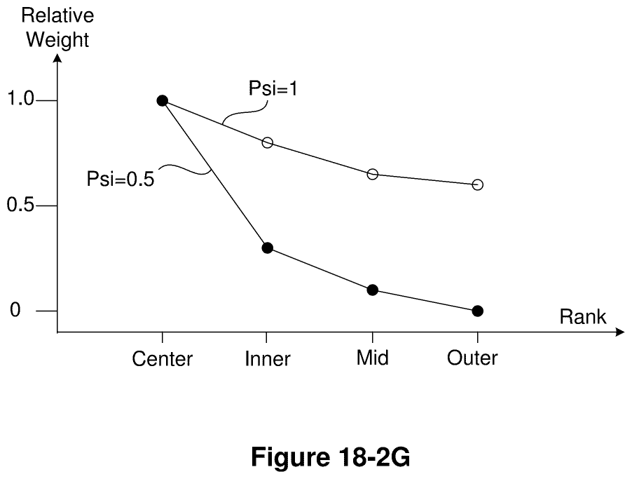

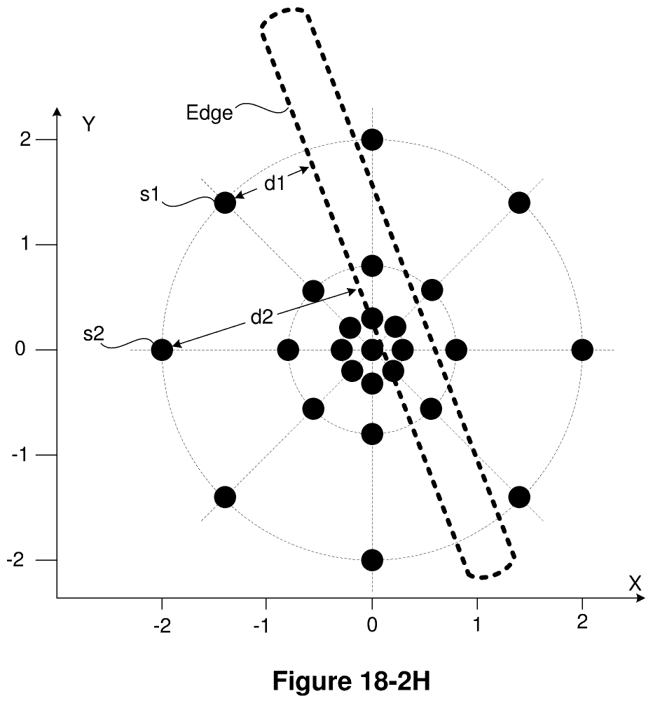

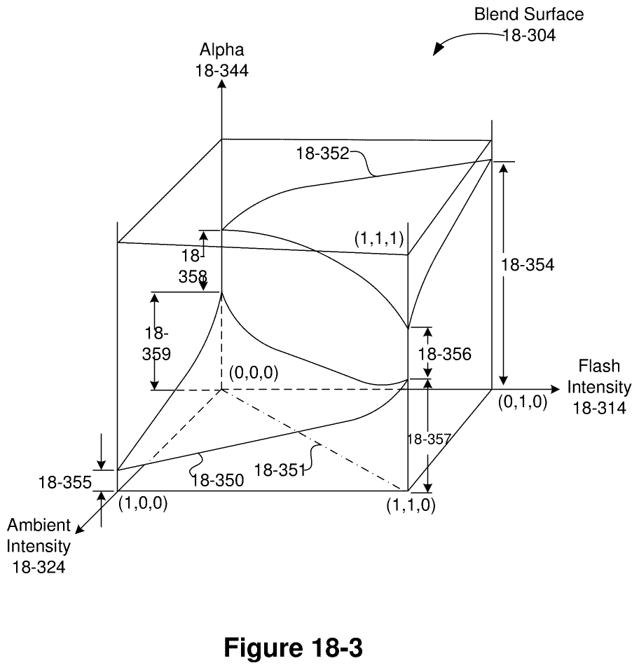

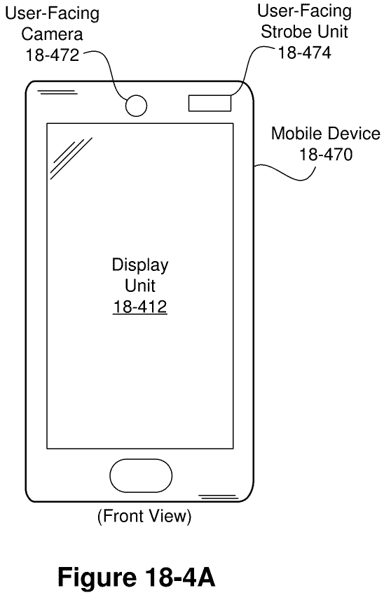

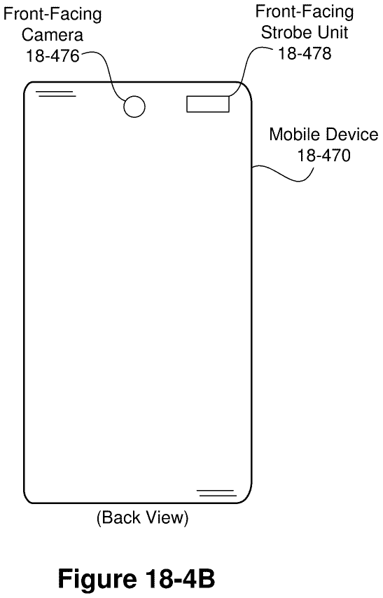

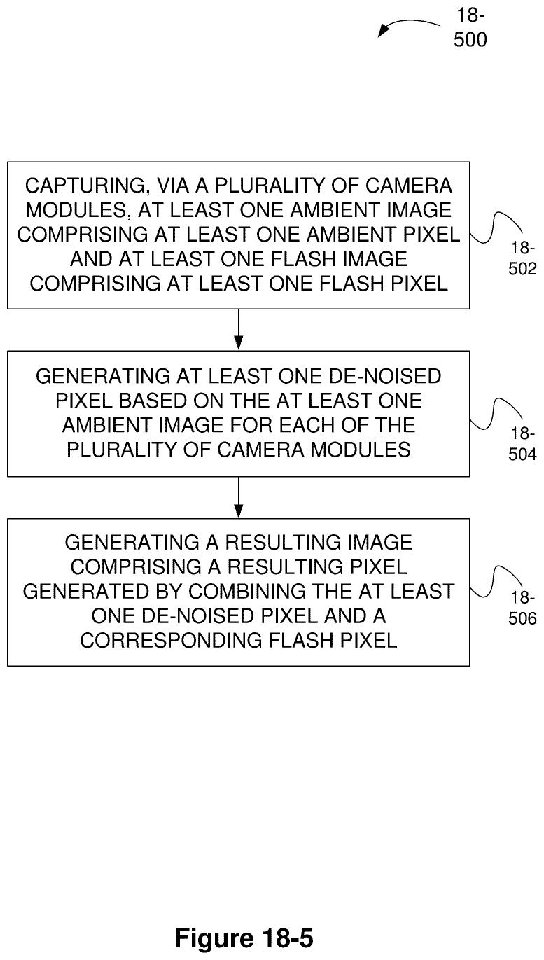

In one embodiment, the designated image is an ambient image and de-noising produces a de-noised ambient image. The captured image of the photographic scene may be generated by combining the flash image with the de-noised ambient image. The flash image may be combined with the de-noised ambient image by blending the two images. In certain embodiments, blending the two images may be performed according to a mix function having a mix function weight that is calculated according to a blend surface described below in FIG. 18-3. Alternatively, a different or similar blend surface may implement the mix function. The blend surface of FIG. 18-3 may be used in calculating an estimated noise value for a pixel (pixel noise estimate). Alternatively, a different or similar blend surface may be used in calculating an estimated noise value for a pixel.

In another embodiment, a combined image generated by combining the flash image and the ambient image is de-noised. Any technically feasible technique may be implemented to generate the combined image, such as blending according to the blend surface of FIG. 18-3.

In yet another embodiment, an input image is de-noised according to the techniques described herein. The input image may be the flash image, the ambient image, or an arbitrary image such as a previously generated or previously captured image.

Although certain aspects of the disclosed de-noising techniques are described in conjunction with de-noising a specific type or source of image, such as an ambient image, the techniques may be applied to de-noising other, arbitrary images. For example, in another embodiment, the designated image may be generated by combining the flash image with the ambient image (e.g. using a mix function between each flash pixel and each corresponding ambient pixel, and mix weights from the blend surface of FIG. 18-3). A captured image of the photographic scene may be generated by de-noising the designated image. In other embodiments, the designated image may be captured by a first camera module and de-noised in conjunction with a second image, captured by a second module (with or without flash illumination), using a sequential or substantially simultaneous capture for both camera modules. In multi-camera implementations, one or more images may be a designated image to be de-noised. In still other embodiments, the designated image may include a generated HDR image or an image within an image stack, which may be associated with an HDR image. In yet other embodiments, the designated image may comprise one or more images generated by a multi-capture image sensor configured to capture two or more analog planes (e.g., with and without flash, higher and lower ISO, or a combination thereof) of the same photographic scene. Certain embodiments implement a complete set of techniques taught herein, however other embodiments may implement a subset of these techniques. For example, certain subsets may be implemented to beneficially operate on one image rather than two images.

Each pixel in the de-noised image may be generated by performing a de-noising operation on the pixel. In one embodiment, the de-noising operation comprises blurring the pixel with neighboring pixels according to a corresponding pixel noise estimate. A pixel noise estimate threshold may be applied so that pixels with a sufficiently low estimated noise are not de-noised (not blurred). As estimated noise increases, blurring correspondingly increases according to a de-noise response function, which may be linear or non-linear. Noise in a given image may vary over the image and only those pixels with sufficiently large estimated noise are subjected to de-noising, leaving pixels with sufficiently less estimated noise untouched. In other words, only regions (e.g., pixels or groups of pixels) of the image assessed to be sufficiently noisy are subjected to a de-noising effect, while regions of the image that are not assessed to be sufficiently noisy are not subjected to de-noising and remain substantially unaltered. Determining that a pixel is sufficiently noisy may be implemented as a comparison operation of estimated noise against a quantitative noise threshold, which may be adjusted for a given implementation to correlate with a threshold for visually discernible noise. In a practical setting, a flash image provides foreground regions with low noise, while background regions tend to be out of focus and naturally blurry. Consequently, blurring out chromatic noise (commonly appears in an image as off-color speckles) in pixels with high estimated noise causes those regions to appear much more natural.

FIG. 18-1 illustrates an exemplary method 18-101 for generating a de-noised pixel, in accordance with one possible embodiment. As an option, the exemplary method 18-101 may be implemented in the context of the details of any of the Figures. Of course, however, the exemplary method 18-101 may be carried out in any desired environment.

As shown, an ambient image comprising a plurality of ambient pixels and a flash image comprising a plurality of flash pixels is captured, via a camera module. See operation 18-103. Next, at least one de-noised pixel based on the ambient image is generated. See operation 18-105. Lastly, a resulting image is generated comprising a resulting pixel generated by combining the at least one de-noised pixel and a corresponding flash pixel. See operation 18-107.

In one embodiment, a flash image may be captured while an associated strobe unit is enabled. In the context of the present description, a de-noised pixel includes a pixel selected from a designated image at a selected pixel location that is processed according to a de-noising technique. Additionally, in the context of the present description, a noise estimate value includes a calculated and estimated noise value for a pixel.

FIG. 18-1A illustrates a method 18-100 for generating a de-noised pixel comprising a digital image, according to one embodiment of the present invention. Although method 18-100 is described in conjunction with the systems of FIGS. 18-4A-18-4B, persons of ordinary skill in the art will understand that any imaging system that performs method 18-100 is within the scope and spirit of embodiments of the present invention. In one embodiment, a mobile device, such as mobile device 18-470 of FIGS. 18-4A-18-4B as well as FIGS. 3A-3G, is configured to perform method 18-100 to generate a de-noised pixel within a de-noised image. In certain implementations, a graphics processing unit (GPU) within the mobile device is configured to perform method 18-100. Alternatively, a digital signal processing (DSP) unit or digital image processing (DIP) unit may be implemented within the mobile device and configured to perform method 18-100. Steps 18-114 through 18-120 may be performed for each pixel comprising the de-noised image.

Method 18-100 begins at step 18-110, where the mobile device captures an ambient image and a flash image. In one embodiment, the ambient image comprises a two-dimensional array of ambient pixels and the flash image comprises a two-dimensional array of flash pixels. Furthermore, the de-noised image comprises a two-dimensional array of de-noised pixels. In certain embodiments, the ambient image, the flash image, and the de-noised image have substantially identical row and column dimensions (e.g. resolution). Additionally, in one embodiment, the ambient image may comprise a three-dimensional array of ambient pixels and the flash image may comprise a three-dimensional array of flash pixels.

In some embodiments, the ambient image and the flash image are aligned in an image alignment operation in step 18-110. For example, the ambient image may comprise an aligned version of an unaligned ambient image captured in conjunction with the flash image, wherein the flash image serves as an alignment reference. In another example, the flash image may comprise an aligned version of an unaligned flash image captured in conjunction with the ambient image, wherein the ambient image serves as an alignment reference. Alternatively, both the ambient image and the flash image may be co-aligned so that neither serves as the only alignment reference. Aligning the ambient image and the flash image may be performed using any technically feasible technique. In certain embodiments, the ambient image and the flash image are captured in rapid succession (e.g., with an inter-frame time of less than 50 milliseconds) within an image sensor configured to capture the two images with reduced content movement between the two images. Here, the flash image and the ambient image may still undergo alignment to fine-tune alignment, should fine-tuning be deemed necessary either by static design or by dynamic determination that alignment should be performed. In one embodiment, capturing the ambient image and the flash image may proceed according to steps 18-170-18-178 of method 18-106, described in FIG. 18-1D.

At step 18-112, the mobile device generates a patch-space ambient image from the ambient image. In one embodiment, the patch-space ambient image is a lower-resolution representation of the ambient image. For example, each pixel of the patch-space ambient image may be generated from an N×N (e.g., N=2, N=4, N=8, etc.) patch of pixels in the ambient image. In the case of N=4, each patch represents a 4-pixel by 4-pixel region, and the patch-space ambient image consequently has one fourth the resolution in each dimension of the ambient image. Any technically feasible technique may be used to generate pixels in the patch-space ambient image. For example, a simple or weighted average of corresponding 4×4 patch of ambient image pixels may be used to generate each pixel in the patch-space ambient image. The patch-space ambient image may be generated and materialized (e.g., explicitly stored in a drawing surface or texture map surface), or, alternatively, pixels comprising the patch-space ambient image may be generated when needed.

At step 18-114, the mobile device selects a pixel location corresponding to an ambient pixel within the ambient image and a flash pixel within the flash image. The pixel location may further correspond to a de-noised pixel within the de-noised image. In certain embodiments, the pixel location comprises two normalized coordinates, each ranging from 0.0 to 1.0, which specify a location within an associated image. At step 18-116, the mobile device calculates a pixel noise estimate associated with the pixel location. In one embodiment, the pixel noise estimate is calculated as a function of an intensity for the ambient pixel, an ISO value (photographic sensitivity value) associated with the ambient pixel (e.g. from ambient image metadata), and an intensity for the flash pixel. An ISO value may be selected in an exposure process for a given photographic scene and used to determine an analog gain applied to analog samples from an image sensor to generate amplified analog samples, which are then converted to corresponding digital values. In one embodiment, step 18-116 is implemented according to method 18-102, described in greater detail below in FIG. 18-1B. At step 18-118, the mobile device generates a de-noised pixel (e.g., a de-noised ambient pixel or a de-noised pixel generated by merging an ambient pixel and a flash pixel) based on the pixel noise estimate and an input pixel. In one embodiment, the input pixel is the ambient pixel. In another embodiment, the input pixel is generated by combining an ambient pixel and a flash pixel. In one embodiment, step 18-118 is implemented according to method 18-104, described in greater detail below in FIG. 18-1C.

At step 18-120, the mobile device stores the de-noised pixel to a de-noised image. In one embodiment, the de-noised pixel may be stored in a random access memory device, configured to implement an image buffer or texture map. In another embodiment, the de-noised pixel may be stored in a file system, implemented using non-volatile memory devices such as flash memory devices. In certain embodiments, the de-noised pixel is stored in a de-noised image along with a plurality of other de-noised pixels, also generated according to method 18-100. In one embodiment, the de-noised pixel is generated based on the ambient pixel and the de-noised pixel is combined with the flash pixel to generate a resulting output pixel. A plurality of output pixels generated in this way may be stored in an output image, which may be displayed to a user.

In certain embodiments, steps 18-114 through 18-120 are performed for each pixel comprising the de-noised image. The selection process for a given pixel may comprise selecting a new pixel location along a row dimension and the column dimension in a rasterization pattern until each pixel location has been selected and corresponding pixels in the de-noised image have been generated. In certain embodiments, a plurality of pixels is selected for concurrent processing and steps 18-116 through 18-120 are performed concurrently on different selected pixels. For example, in a graphics processing unit, a rasterization unit may generate a plurality of fragments (select a plurality of pixel locations) associated with different corresponding pixel locations, and steps 18-116 through 18-120 are performed concurrently on the plurality of fragments to generate associated pixels.

FIG. 18-1B illustrates a method 18-102 for estimating noise for a pixel within a digital image, according to one embodiment of the present invention. Although method 18-102 is described in conjunction with the systems of FIGS. 18-4A-18-4B as well as FIGS. 3A-3G, persons of ordinary skill in the art will understand that any image processing system that performs method 18-102 is within the scope and spirit of embodiments of the present invention. In one embodiment, a mobile device, such as mobile device 18-470 of FIGS. 18-4A-18-4B as well as FIGS. 3A-3G, is configured to perform method 18-102 to estimate noise for a pixel within a digital image. In certain implementations, a processing unit, such as a graphics processing unit (GPU) within the mobile device is configured to perform method 18-102. Alternatively, a digital signal processing (DSP) unit or digital image processing (DIP) unit may be implemented within the mobile device and configured to perform method 18-102. Method 18-102 may be performed for each pixel comprising the de-noised image of FIG. 18-1A. While embodiments discussed herein are described in conjunction with an ambient pixel, persons of ordinary skill in the art will understand that a noise estimate may be calculated for any pixel in accordance with method 18-102.

Method 18-102 begins at step 18-130, where a processing unit within the mobile device receives an ambient pixel, an ISO value for the ambient pixel, and a flash pixel. The ambient pixel may be received from a memory unit configured to store a captured (or aligned) ambient image, the ISO value may be stored in the memory unit as metadata associated with the ambient image, and the flash pixel may be from a memory unit configured to store a captured flash image.

At step 18-132, the processing unit calculates a first intermediate noise estimate (isoPsi) based on the ISO value. The first intermediate noise estimate may be calculated using the OpenGL code shown in Table 18-1. In this code, isoPsi ranges from a value of 0 (no noise) to a value of 1 (high noise). An image ISO value, given as ambientIso below, ranges within the standard range definition for photographic ISO values (100, 200, and so forth). In general, the isoPsi noise estimate increases with increasing ISO values. An ISO value floor, given at L1 in the OpenGL code of Table 18-1, may define an ISO value below which image noise is considered insignificant, indicating no de-noising should be applied. An ISO ceiling, given at H1, may define an ISO value above which image noise is considered highly significant and de-noising should be applied in accordance with other factors. In one embodiment, L1 is equal to an ISO value of 250 and H1 is equal to an ISO value of 350. In other embodiments, L1 and H1 may be assigned different ISO values, based on noise performance of an associated camera module. As is known in the art, a smoothstep function receives a “left edge” (L1), a “right edge” (H1), and input value (ambientIso). The smoothstep function generates an output value of zero (0.0) for input values below the left edge value, an output value of one (1.0) for input values above the right edge, and an smoothly interpolated output value for input values between the left edge and the right edge.

TABLE 18-1

float isoPsi = smoothstep(L1, H1, ambientIso);

At step 18-134, the processing unit calculates a second intermediate noise estimate (intPsi) based on the ISO value and an intensity of the ambient pixel. The second intermediate noise estimate may be calculated using the OpenGL code shown in Table 18-2. In this code intPsi ranges from a value of 0 (no noise) to a value of 1 (high noise). In general, the intPsi noise estimate increases with increasing ISO values and decreases with increasing ambient intensity values, given as aInt. In one embodiment, L2 is equal to an ISO value of 800, H2 is equal to an ISO value of 1600, C1 is equal to a value of 0.4, C2 is equal to a value of 0.7, and C3 is equal to a value of 0.1. In other embodiments, L2, H2, C1, C2, and C3 may be assigned different values, based on noise performance of an associated camera module. Furthermore, while a constant value of 1.0 is specified in the code, a different value may be implemented as appropriate to the camera module, numeric range of intensity values, or both.

TABLE 18-2

float H3 = C1 + (C2 * smoothstep(L2., H2., ambientIso));
float L3 = H3 − C3;
float intPsi = 1.0 − smoothstep(L3, H3, aInt);

At step 18-136, the processing unit calculates a third intermediate noise estimate (alphaPsi) based on an intensity of the ambient pixel and an intensity of the flash pixel. For example, the third intermediate noise estimate may be calculated using the OpenGL code shown in Table 18-3. In this code alphaPsi ranges from a value of 0 (no noise) to a value of 1 (high noise), and a value for alpha may be calculated according to the discussion of FIG. 18-3. In general, the value of alpha reflects a contribution of flash intensity versus ambient intensity at a selected pixel location, with a higher value of alpha indicating a higher flash contribution. In one embodiment, L4 is set to 0.4 and H4 is set to 0.5. In other embodiments, L4 and H4 may be assigned different values, based on noise performance of an associated camera module. Furthermore, while a constant value of 1.0 is specified in the code, a different value may be implemented as appropriate to the camera module, numeric range of intensity values, or both. In certain embodiments, alphaPsi is computed directly from a blend surface function configured to incorporate the smoothstep function illustrated in Table 18-3.

TABLE 18-3

float alphaPsi = 1.0 − smoothstep(L4, H4, alpha);

At step 18-138, the processing unit generates an overall pixel noise estimate (Psi) by combining the first intermediate noise estimate, the second intermediate noise estimate, and the third intermediate noise estimate. In other words, the pixel noise estimate is generated based on a pixel ISO value (e.g., for the ambient pixel), an ambient intensity value, and a flash intensity value. The first intermediate noise estimate may be calculated based on the pixel ISO value. The second intermediate noise estimate may be calculated based on the pixel ISO value and the ambient intensity value. The third intermediate noise estimate may be calculated from the ambient intensity value and the flash intensity value. In one embodiment, the combining operation may be performed as an arithmetic multiplication of the three intermediate noise estimates (Psi=isoPsi*intPsi*alphaPsi).

A final pixel noise estimate may be further defined to include additional terms. For example, a user input term received from a UI variable control element (e.g., slider, control knob, swipe gesture, etc.) may be combined (e.g. multiplied) by the pixel noise estimate for all de-noised pixels in the de-noised image to allow a user to control the strength of the de-noising effect on a given image. In another example, image features may be used to generate another noise estimation term, which may be multiplied or otherwise combined by the pixel noise estimate term. For example, if the pixel intersects a sharp edge detected in the image, the noise estimate may be reduced to reduce blurring associated with de-noising. In certain instances some noise along an edge may be preferable to a blurred edge.

FIG. 18-1C illustrates a method 18-104 for generating a de-noised pixel, according to one embodiment of the present invention. Although method 18-104 is described in conjunction with the systems of FIGS. 18-4A-18-4B as well as FIGS. 3A-3G, persons of ordinary skill in the art will understand that any image processing system that performs method 18-104 is within the scope and spirit of embodiments of the present invention. In one embodiment, a mobile device, such as mobile device 18-470 of FIGS. 18-4A-18-4B as well as FIGS. 3A-3G, is configured to perform method 18-104 to generate a de-noised pixel based on an input (e.g., ambient) pixel, a noise estimate for the input pixel (e.g., as estimated by method 18-102), and patch-space samples associated with the input pixel. The patch-space samples may comprise a region in patch-space encompassing a coordinate in patch-space that corresponds to a coordinate in pixel space for the input pixel. In certain implementations, a processing unit, such as a graphics processing unit (GPU) within the mobile device is configured to perform method 18-104. Alternatively, a digital signal processing (DSP) unit or digital image processing (DIP) unit may be implemented within the mobile device and configured to perform method 18-104. Method 18-104 may be performed for each pixel comprising the de-noised image. While embodiments discussed herein are described in conjunction with an ambient pixel and an ambient image, persons of ordinary skill in the art will understand that a de-noised pixel may be generated for any type of pixel associated with any type of image in accordance with method 18-104.

Method 18-104 begins at step 18-150, where the processing unit receives an ambient pixel, a pixel noise estimate for the ambient pixel, and a set of surrounding patch-space samples. The pixel noise estimate may be calculated according to method 18-102. The patch-space samples may be generated using any resolution re-sampling technique.

If, at step 18-152, the noise estimate is above a predefined or pre-calculated threshold, the method proceeds to step 18-154, wherein the processing unit computes a patch-space weighted-sum pixel and a sum of weights contributing to the patch-space weighted-sum pixel. At step 18-156, the processing unit computes a de-noised pixel by scaling the patch space weighted sum pixel by the sum of weights. In one embodiment, the patch-space weighted-sum pixel comprises a vec3 of red, green, and blue components, which is divided by the sum of weights (a scalar). In another embodiment, the patch-space weighted-sum pixel comprises a vec3 of red, green, and blue components, which is multiplied by a reciprocal of the sum of weights. An opacity value of 1.0 may also be assigned to the de-noised pixel to yield a vec4 de-noised pixel. One technique for generating the patch-space weighted-sum pixel is described in greater detail in FIGS. 18-2D through 18-2F.

Returning to step 18-152, if the noise estimate is not above the threshold, then the method proceeds to step 18-160, where the processing unit assigns the de-noised pixel equal to the input ambient pixel. In one embodiment, the input ambient pixel comprises a vec3 of red, green, and blue components, and assigning comprises assigning corresponding components. An opacity value of 1.0 may also be assigned to the de-noised pixel to yield a vec4 de-noised pixel.

FIG. 18-1D illustrates a method 18-106 for capturing an ambient image and a flash image, according to one embodiment of the present invention. Although method 18-106 is described in conjunction with the systems of FIGS. 18-4A-18-4B as well as FIGS. 3A-3G, persons of ordinary skill in the art will understand that any imaging system that performs method 18-106 is within the scope and spirit of embodiments of the present invention. In one embodiment, a mobile device, such as mobile device 18-470 of FIGS. 18-4A-18-4B as well as FIGS. 3A-3G, is configured to perform method 18-106 to generate an ambient image and a flash image of a photographic scene. In certain implementations, a processor complex within the mobile device controls an associated camera module and strobe unit to perform method 18-106.

Method 18-106 begins at step 18-170, where the mobile device determines ambient exposure parameters for an ambient image of the scene. The ambient exposure parameters may include at least one of: exposure time, exposure sensitivity (ISO value), and lens aperture. The ambient exposure parameters may also include white balance. In one embodiment, step 18-170 is performed by capturing a sequence of images, each captured by a camera module within the mobile device, wherein each image is captured with a successively refined estimate for the ambient exposure parameters until an ambient exposure goal is satisfied. In step 18-172, the mobile device determines flash exposure parameters for a flash image of the scene. The flash exposure parameters may include at least one of: exposure time, exposure sensitivity (ISO value), and lens aperture. The flash exposure parameters may also include white balance and flash duration. The flash exposure parameters may be constrained according to at least one ambient exposure parameter. In one embodiment, the flash ISO value is constrained to be equal to or greater than the ambient ISO value, as determined in step 18-170. In certain embodiments, the flash exposure time is constrained to be equal to or shorter than the ambient exposure time. In one embodiment, step 18-172 is performed by capturing a sequence of images, each captured by a camera module within the mobile device, with a strobe unit enabled to illuminate the scene. Each image in the sequence of images is captured with a successively refined estimate for the flash exposure parameters until an exposure goal is satisfied. In one embodiment, flash duration, flash intensity, or a combination thereof is adjusted to until a flash exposure goal is satisfied.

In step 18-174, the mobile device captures an ambient image in accordance with the ambient exposure parameters. In step 18-176, the mobile device captures a flash image in accordance with the flash exposure parameters. In one embodiment, the ambient image is captured within a first analog storage plane of a multi-capture image sensor and the flash image is captured within a second analog storage plane of the multi-capture image sensor. In step 18-178, the mobile device stores the ambient image and the flash image within a memory subsystem of the mobile device. The memory subsystem may comprise volatile memory devices (e.g., DRAM chips) or non-volatile memory devices (e.g., flash memory chips).

In step 18-180, the mobile device processes the ambient image and the flash image. In one embodiment, processing includes combining the ambient image and the flash image to generate a merged image. In another embodiment, processing includes de-noising the ambient image, the merged image, or the flash image. De-noising a given image may proceed according to FIGS. 18-1A-18-1C. In certain low-light scenarios, a relatively high ambient ISO value (e.g., ISO 1600 or higher) may be determined necessary to meet one or more ambient exposure goals. The relatively high ambient ISO value may result in increased ambient image noise. A lower flash ISO value may be determined to meet one or more flash exposure goals, which may naturally result in reduced flash image noise in regions of the image substantially lit by flash illumination. Therefore, in certain embodiments, processing may include combining the ambient image and the flash image to generate a merged image, as well as de-noising at least the ambient image or the merged image. Different de-noising techniques may be implemented as appropriate. In one embodiment generating de-noised pixels comprising a designated image (e.g., an ambient image) is performed in accordance with techniques described herein in conjunction with FIGS. 18-1A-18-1C, and 18-2A-18-3.

In certain embodiments, the ambient image is captured at a lower resolution than the flash image. For example, the ambient image may be captured at one-half the horizontal resolution and one-half the vertical resolution. In such embodiments, reducing resolution of the ambient image has the beneficial effect of reducing overall image noise in the ambient image. In low-light settings, the ambient image may be captured at or near specified sensitivity limits of an image sensor (or camera module including the image sensor), resulting in higher overall image noise than when the image sensor is operating with more available illumination.

When the flash image is combined with the ambient image to generate the merged image, pixel data from the ambient image may be interpolated to provide additional pixels for a higher effective resolution that may be equivalent to the flash image. In the context of embodiments where a lower resolution ambient image is captured, pixels from the lower resolution ambient image may be de-noised to provide further reductions in ambient image noise. Interpolating pixels from the lower resolution ambient image to generate higher resolution ambient pixels may be performed before or after a de-noising operation. In one embodiment, resulting de-noised pixels of the same resolution as the flash image are used to generate the merged image.

In one embodiment, the ambient image is captured at a lower resolution to achieve lower overall image noise at a selected ISO value for the ambient image, and the flash image is captured at a higher resolution and a higher ISO value. With more abundant illumination provided by the flash illuminator on foreground subjects, an ISO value with lower inherent noise (lower ISO value) may be selected for the flash image. In an exemplary capture process, an image sensor (e.g., within a camera module) may be directed to capture the ambient image in a low resolution mode and also capture a flash image in a high resolution mode. In the high resolution mode, the flash image is captured at a native (physical) pixel resolution for the image sensor. In the low resolution mode, intensity or color channel signals from groups of native resolution pixels (e.g. groups of 2×2, 1×2, 2×1, 3×3, 4×4, etc. native resolution pixels) are combined to generate each low resolution pixel. Combining signals from native resolution pixels may be performed at the analog level so that photodiode output current of each color channel of each native resolution pixel is combined into a corresponding analog sample for a color channel sample of a low resolution pixel.

In one embodiment, photodiode currents from photodiodes within a group of native resolution pixels are combined and integrated in capacitors associated with one or more of the photodiodes.

For example, in one mode of operation a group comprises a 2×2 pattern of native resolution pixels. Four photodiode currents are generated by four different photodiodes per color channel (one for each pixel in the 2×2 pattern) are combined and integrated in four corresponding analog storage circuits (one for each pixel in the 2×2 pattern). In one embodiment, four photodiode currents for a red color channel are combined and integrated within four corresponding analog storage circuits (e.g. including a capacitor to integrate current into a voltage). Green and blue color channels may be identically implemented. Such a mode of operation may provide lower overall image noise but lower resolution at an ISO value equivalent to native resolution operation.

In a second mode of operation using a 2×2 pattern of native resolution pixels, the four photodiode currents are combined and integrated in one analog storage circuits residing within one of the native resolution pixels. Such a mode of operation may allow image capture at a higher ISO value with comparable noise to native resolution operation. In the context of one embodiment, this second mode of operation may be selected to provide a higher ISO value that allows a faster shutter speed (shorter exposure time) in low light settings to reduce image blur associated with camera shake.

In certain embodiments, the ambient image is captured by combining and integrating photodiode currents from each color channel into a single intensity value per pixel. The photodiode currents may be combined from color channels associated with one pixel or a group of pixels. In one embodiment, photodiode currents associated with a 2×2 pattern of native resolution pixels are combined and integrated within one analog storage circuits residing within one of the native resolution pixels. These photodiode currents include current from red, green, and blue color channels from the 2×2 pattern of native resolution pixels. Such embodiments are operable in very low light and generate a gray scale ambient image, and may generate either a color flash image or a gray scale flash image. The gray scale ambient image may be generated with an effective sensitivity of almost sixteen (four photographic stops) times the sensitivity of a native resolution color image. In one embodiment, a lower resolution gray scale ambient image is combined with a full resolution color image to generate a merged image. A specific color may be applied to the gray scale ambient image so that ambient illumination appears, for example white/gray, beige, green or amber. Such embodiments may allow an ambient image to be captured using a much shorter (e.g., almost one sixteenth) overall exposure time than conventional techniques. A shorter overall exposure time advantageously reduces motion blur and other motion artifacts leading to a higher-quality ambient image. An associated flash image may then be combined with the ambient image to generate a merged image.

FIG. 18-2A illustrates a computational flow 18-200 for generating a de-noised pixel, according to one embodiment of the present invention. Computational flow 18-200 illustrates one embodiment of method 18-100 of FIG. 18-1A. A mobile device comprising a camera module, an electronic flash (e.g., one or more light-emitting diodes or a xenon strobe tube) and a processing unit may be configured to perform computational flow 18-200. At function 18-210, the mobile device captures a pixel-space ambient image 18-212 and a pixel-space flash image 18-214. In one embodiment, the mobile device captures an ambient image and a flash image according to method 18-106 of FIG. 18-1D. The ambient image is stored as pixel-space ambient image 18-212 and the flash image is stored as pixel-space flash image 18-214. A patch-space filter 18-220 generates a patch-space image 18-222 by performing any technically feasible resolution reduction operation on the pixel-space ambient image 18-212. Functions 18-216 and 18-218 select a pixel from their respective image source at the same, selected coordinate in both image sources. In one embodiment, functions 18-216 and 18-218 perform a simple raster scan to select pixels.

Noise estimation function 18-230 receives as inputs a selected ambient pixel (along with ISO metadata) and a selected flash pixel, and generates a pixel noise estimate from these these inputs. In one embodiment, the noise estimate is principally a function of the exposure conditions (e.g., ISO and intensity) for the pixels.

Pixel de-noise function 18-250 generates a de-noised pixel using the ambient pixel, patch-space ambient pixels sampled from the patch-space ambient image, and the pixel noise estimate as inputs. The de-noised pixel may be stored at the selected coordinate within a de-noised ambient image 18-252. In one embodiment, each pixel of de-noised ambient image 18-252 is generated according to computational flow 18-200. In certain embodiments, de-noised ambient image 18-252 may be combined with pixels-space flash image 18-214 to generate a merged image that may be stored and subsequently displayed.

FIG. 18-2B illustrates a noise estimation function 18-230, according to one embodiment of the present invention. One embodiment of method 18-102 of FIG. 18-1B is illustrated as noise estimation function 18-230 in the form of a computational flow diagram. As shown, three intermediate noise estimate values (isoPsi, intPsi, alphaPsi) are multiplied together to generate a pixel noise estimate (Psi). In one embodiment, the isoPsi intermediate noise estimate value may be generated according to the OpenGL code of Table 18-1, using a smoothstep function, indicated here as an “SStep” functional block. The intPsi intermediate noise estimate value may be generated according to the OpenGL code of Table 18-2. The alphaPsi intermediate noise estimate value may be generated according to the OpenGL code of Table 18-3. An intensity value (aInt) for a pixel-space ambient pixel (PixelA) is calculated and used as one input into an alpha look-up table (LUT) function. An intensity value (fInt) for a pixel-space flash pixel (PixelF) is calculated and used as a second input to the alpha LUT function. A resulting alpha value is then passed through a smoothstep function to calculate the alphaPsi value. The alpha LUT function is described in greater detail below in FIG. 18-3.

FIG. 18-2C illustrates a pixel de-noise function 18-250, according to one embodiment of the present invention. One embodiment of method 18-104 of FIG. 18-1C is illustrated as noise estimation function 18-250 in the form of a computational flow diagram. As shown, the pixel de-noise function receives a set of patch-space samples (PatchesA), a pixel noise estimate (Psi), and a pixel-space ambient pixel as input and generates a de-noised pixel as output. In one embodiment, patch-space samples comprise lower resolution samples of the image associated with the pixel-space ambient pixel. Patch-space samples may be associated with a pixel-space pixel based on relative position (e.g., normalized coordinates ranging from 0.0 to 1.0) within the image. Each patch-space sample may be similar to, and representative of a small neighborhood of pixels comprising a patch. A de-noise operation may be performed by sampling a surrounding neighborhood of patch-space samples associated with an input pixel to generate a de-noised pixel that is similar to neighboring pixels. Using patch-space samples advantageously reduces computation associated with generating a de-noised pixel by pre-computing neighboring pixel similarity in the form of a patch-space sample. However, in certain embodiments, neighboring pixel similarity may be computed as needed for each input pixel.

In one embodiment, if Psi is below a threshold, T1, then the de-noised pixel is set equal to input PixelA. Otherwise, the de-noised pixel is computed from a weighted sum of pixels scaled according to a sum of corresponding weights, with the result clamped between 0.0 and a maximum color channel intensity value (e.g. 1.0). Consequently, a resulting de-noised pixel may vary from being an exact numeric copy of PixelA if Psi is below threshold T1, and a weighted sum of neighboring pixels. The threshold T1 may be assigned value based on camera module noise performance. In one embodiment, T1 is set to 0.3. Computing the patch-space weighted sum sample and sum of weights is described in greater detail below.

FIG. 18-2D illustrates patch-space samples organized around a central region, according to one embodiment of the present invention. As shown, eight patch-space samples form a substantially circular region about a center. The center may be located according to coordinates of the pixel-space pixel (input PixelA) of FIG. 18-2B-18-2C. The patch-space samples may be generated from a patch-space image using any technically feasible technique, such as bilinear sampling, that provides for substantially arbitrary placement of sample coordinates between discrete samples in patch-space.

FIG. 18-2E illustrates patch-space regions organized around a center, according to one embodiment of the present invention. The patch-space regions may be organized in ranks as an outer rank, a mid rank, an inner rank, and a center. In one embodiment, eight samples are generated for each rank, as illustrated above in FIG. 18-2D.

FIG. 18-2F illustrates a constellation of patch-space samples around a center position, according to one embodiment of the present invention. As shown, eight sample positions for each rank are positioned in patch-space in a ring.

In one embodiment, a weight is calculated for each rank and each sample on a given rank contributes a correspondingly weighted value to the patch-space weighted sum sample of FIG. 18-2C. The sum of weights corresponds to a sum of all weights associated with samples contributing to the patch-space weighted sum sample. A center sample may be included in the patch-space weighted sum sample. The center sample may have an independent center weight. The center sample weight is added to the sum of weights. The center weight and rank weights may be calculated for each de-noised pixel. In certain implementations, the center weight is larger than an inner rank weight; the inner rank weight is larger than the mid rank weight; and, the mid rank weight is larger than the outer rank weight. The weights may be varied according to pixel noise estimate, Psi.

In one embodiment, the constellation as shown in FIG. 18-2F depicts a contribution zone around a pixel point. In one embodiment, the contribution zone may be manipulated (e.g. increased/decreased, etc.) to control the contribution of surrounding pixels, the weight of each surrounding sample in the constellation being determined as a function of estimated image noise at the pixel point, and optionally through a user input parameter (e.g., through a user interface slider control). For example, the greater an estimated noise at the pixel point, the greater the weight of mid and outer ranks. In regions of an image where estimated noise is high, the estimated noise values should vary relatively slowly over a span of many pixels (many tens of pixels), meaning the overall visual effect of de-noising scene content should remain consistent and change only slightly in response to small scene changes or camera movement. Consequently, the above technique for de-noising may generally provide stable, consistent appearance for de-noised scene content through multiple frames, such as multiple video frames.

FIG. 18-2G illustrates relative weights for different ranks in a patch-space constellation, according to one embodiment of the present invention. As shown, when pixel noise estimate Psi is smaller, the inner, mid, and outer ranks may be assigned lower weights. When Psi is larger, the inner, mid, and outer ranks may be assigned higher weights. Samples at each angular position (top mid, top right, etc.) around the constellation of FIG. 18-2F may be weighted with the same weight, or a weight that is relatively higher or lower than other samples in the same rank, as a function of image content. Each rank and angle weight may be calculated independently to contribute to an overall patch-space weighted sum sample. In certain embodiments, image content determines sample weights for each angular position within a given rank. For example, an edge running through or along the center position should be preserved, even for pixels with high estimated noise. In such an instance, weights of samples that are more similar in color to the path of the edge closest to intersecting the center may be assigned higher weights, while dissimilar samples may be assigned low weights. Such weights may follow an overall scheme that adheres to the concentric rank weights, but is further refined to preserve a distinct edge. Various techniques may be implemented to detect similarity between a center sample and other patch-space samples within the constellation. In particular, techniques that preserve larger image patterns such as edge detection may be implemented to selectively assign weights to constellation samples.

In one embodiment, an edge detection pass is performed to generate an edge-enhanced image of the ambient image. The edge-enhanced image may be a single channel (gray scale) image where higher intensity indicates a more distinct edge, while lower intensity indicates a lack of a distinct edge. In regions where a more distinct edge is present, samples along the edge should be assigned higher weights, while samples not associated with an edge should be assigned lower weights. Alternatively, samples within the constellation having similar color and intensity to a representative (e.g., average, media, or other) color associated with samples along the edge should be assigned higher weights, while dissimilar samples may be assigned lower weights. For example, higher weights could range from 0.5 to 1.0 and lower weights could range from 0.0 to 0.5.

FIG. 18-2H illustrates assigning sample weights based on detected image features, according to one embodiment. In certain embodiments, different samples in the same rank (within the same ring) are assigned different weights to better preserve detected image features. In one embodiment, if the center sample is positioned in close proximity to (e.g., intersecting or within a few pixels of intersecting) a detected edge (e.g., as indicted by higher intensity values in a corresponding edge-enhanced image) in an image being de-noised, then weights of samples that are close to the edge (e.g., s1 at distance d1) may be calculated to be higher than weights of samples that are further from the edge (e.g., s2 at distance d2). In one embodiment, weights may be calculated to be an inverse function of proximity to the edge so that sample s1 with distance d1 from the edge is assigned a higher weight than sample s2 with a larger distance d2 from the edge. Weighting samples according to similarity along an edge as discussed in FIG. 18-2G or based on proximity to an edge as discussed here in FIG. 18-2H may be implemented to preserve edges and texture of an image being de-noised by distinguishing identifiable image features from noise.

### Generating Alpha

FIG. 18-3 illustrates a blend surface 18-304 for blending two pixels, according to another embodiment of the present invention. Blend surface 18-304 comprises a flash dominant region 18-352 and an ambient dominant region 18-350 within a coordinate system defined by an axis for each of ambient intensity 18-324, flash intensity 18-314, and an alpha value 18-344.

As shown, upward curvature at the origin (0,0) and at (1,1) may be included within the ambient dominant region 18-350, and downward curvature at (0,0) and (1,1) may be included within the flash dominant region 18-352. As a consequence, a smoother transition may be observed for very bright and very dark regions, where color may be less stable and may diverge between a flash image and an ambient image. Upward curvature may be included within the ambient dominant region 18-350 along diagonal 18-351 and corresponding downward curvature may be included within the flash dominant region 18-352 along diagonal 18-351.

In certain embodiments, downward curvature may be included within ambient dominant region 18-350 at (1,0), or along a portion of the axis for ambient intensity 18-324. Such downward curvature may have the effect of shifting the weight of mix operation 10-346 to favor ambient pixel 10-322 when a corresponding flash pixel 10-312 has very low intensity.

In one embodiment, a blend surface 18-304, is pre-computed and stored as a texture map that is established as an input to a fragment shader configured to implement step 18-136 of method 18-102. A surface function that describes a blend surface having an ambient dominant region 18-350 and a flash dominant region 18-352 may be implemented to generate and store the texture map. The surface function may be implemented on a CPU core or a GPU core, or a combination thereof of cores residing within processor complex 310. The fragment shader executing on a GPU core may use the texture map as a lookup table implementation of the surface function. In alternative embodiments, the fragment shader implements the surface function and computes an alpha value 18-344 as needed for each combination of a flash intensity 18-314 and an ambient intensity 18-324. One exemplary surface function that may be used to compute an alpha value 18-344 (alphaValue) given an ambient intensity 18-324 (ambient) and a flash intensity 18-314 (flash) is illustrated below as pseudo-code in Table 18-4. A constant “e” is set to a value that is relatively small, such as a fraction of a quantization step for ambient or flash intensity, to avoid dividing by zero. Height 18-355 corresponds to constant 0.125 divided by 3.0.

TABLE 18-4

fDivA = flash/(ambient + e);
fDivB = (1.0 − ambient) / ((1.0 − flash) + (1.0 − ambient) + e)
temp = (fDivA >= 1.0) ? 1.0 : 0.125;
alphaValue = (temp + 2.0 * fDivB) / 3.0;

In certain embodiments, the blend surface is dynamically configured based on image properties associated with a given flash image and associated ambient image. Dynamic configuration of the blend surface may include, without limitation, altering one or more of heights 18-354 through 18-359, altering curvature associated with one or more of heights 18-354 through 18-359, altering curvature along diagonal 18-351 for ambient dominant region 18-350, altering curvature along diagonal 18-351 for flash dominant region 18-352, or any combination thereof.

One embodiment of dynamic configuration of a blend surface involves adjusting heights associated with the surface discontinuity along diagonal 18-351. Certain images disproportionately include gradient regions having flash pixels and ambient pixels of similar or identical intensity. Regions comprising such pixels may generally appear more natural as the surface discontinuity along diagonal 18-351 is reduced. Such images may be detected using a heat-map of ambient intensity 18-324 and flash intensity 18-314 pairs within a surface defined by ambient intensity 18-324 and flash intensity 18-314. Clustering along diagonal 18-351 within the heat-map indicates a large incidence of flash pixels and ambient pixels having similar intensity within an associated scene. In one embodiment, clustering along diagonal 18-351 within the heat-map indicates that the blend surface should be dynamically configured to reduce the height of the discontinuity along diagonal 18-351. Reducing the height of the discontinuity along diagonal 18-351 may be implemented by adding downward curvature to flash dominant region 18-352 along diagonal 18-351, adding upward curvature to ambient dominant region 18-350 along diagonal 18-351, reducing height 18-358, reducing height 18-356, or any combination thereof. Any technically feasible technique may be implemented to adjust curvature and height values without departing the scope and spirit of the present invention. Furthermore, any region of blend surface 18-304 may be dynamically adjusted in response to image characteristics without departing the scope of the present invention.

In one embodiment, dynamic configuration of the blend surface comprises mixing blend values from two or more pre-computed lookup tables implemented as texture maps. For example, a first blend surface may reflect a relatively large discontinuity and relatively large values for heights 18-356 and 18-358, while a second blend surface may reflect a relatively small discontinuity and relatively small values for height 18-356 and 18-358. Here, blend surface 18-304 may be dynamically configured as a weighted sum of blend values from the first blend surface and the second blend surface. Weighting may be determined based on certain image characteristics, such as clustering of flash intensity 18-314 and ambient intensity 18-324 pairs in certain regions within the surface defined by flash intensity 18-314 and ambient intensity 18-324, or certain histogram attributes for the flash image and the ambient image. In one embodiment, dynamic configuration of one or more aspects of the blend surface, such as discontinuity height, may be adjusted according to direct user input, such as via a UI tool.

### System Overview

FIG. 18-4A illustrates a front view of a mobile device 18-470 comprising a display unit 18-412, according to one embodiment of the present invention. Display unit 18-412 is configured to display digital photographs and user interface (UI) elements associated with software applications that may execute on mobile device 18-470. The digital photographs may include digital images captured or otherwise generated by the mobile device 18-470, digital images transmitted to the mobile device 18-470, or any combination thereof. As shown, mobile device 18-470 may include a user-facing (back-facing) camera 18-472, with a lens configured to face back towards a user; that is, the lens may face the same direction that display unit 18-412 is configured to face. User-facing camera 18-472 may also be referred to as a “selfie” camera. Mobile device 18-470 may also include a user-facing strobe unit 18-474, configured to provide illumination in the same direction as user-facing camera 18-472, thereby providing strobe illumination for taking a “selfie” picture. User facing camera 18-472 may capture images with or without strobe illumination. Furthermore, the images may be captured with a combination of both strobe illumination and no strobe illumination. In certain embodiments, display unit 18-412 may be configured to provide strobe illumination and/or augment strobe illumination from user-facing strobe unit 18-474. In certain embodiments, mobile device 18-470 may include two or more user-facing cameras that are configured to capture one or more images each; these images may be stored within an image stack and fused to generate a merged image. One or more of the images may be de-noised, such as according to the de-noising techniques of FIGS. 18-2A-18-2H. For example, in one embodiment, an ambient image is captured using one or more of the two or more user-facing cameras, and a flash image is captured using one or more of the two or more user-facing cameras. The ambient image may be de-noised using any technically feasible technique, and merged with the flash image to generate a merged image. The merged image may comprise a final image the user may view, save, share, or otherwise utilize. Alternatively, the merged image rather than the ambient image may be de-noised.

FIG. 18-4B illustrates a back view of mobile device 18-470 comprising a front-facing camera 18-476 and a front-facing strobe unit 18-478, according to one embodiment of the present invention. Front-facing camera 18-476 and front-facing strobe 18-478 may both face in a direction that is opposite to that of display unit 18-412 and/or user-facing camera 18-472. The front-facing camera 18-476 and front-facing strobe unit 18-478 may operate as described previously regarding user-facing camera 18-472 and user-facing strobe unit 18-474, respectively.

FIG. 18-5 illustrates an exemplary method 18-500 for generating a de-noised pixel based on a plurality of camera modules, in accordance with one possible embodiment. As an option, the exemplary method 18-500 may be implemented in the context of the details of any of the Figures. Of course, however, the exemplary method 18-500 may be carried out in any desired environment. For example, method 18-500 may be carried out by a mobile device such as a smartphone or a stand-alone digital camera, each configured to include the plurality of camera modules. Furthermore, the plurality of camera modules may be configured to operate with one or more flash illumination modules.

Step 18-502 shows capturing, via a plurality of camera modules, at least one ambient image comprising at least one ambient pixel and at least one flash image comprising at least one flash pixel. Next, at least one de-noised pixel is generated based on the at least one ambient image for each of the plurality of camera modules. See step 18-504. Lastly, a resulting image is generated comprising a resulting pixel generated by combining the at least one de-noised pixel and a corresponding flash pixel. See step 18-506.

In one embodiment, a plurality of camera modules may be found within one device (e.g. multiple circuits, etc.). In another embodiment, a plurality of camera modules may be found in more than one device (e.g. within a smartphone and within a tablet, etc.).

Further, in one embodiment, exposure may be harmonized between a plurality of camera modules, wherein the harmonizing includes normalizing the pixel intensity between one camera module and another, synchronizing capture time, and the like. In some embodiments, the pixel intensity may be based on a specific pixel (and corresponding pixel on other camera modules, etc.), on a grouping of pixels, on a histogram point (e.g. brightest/darkest point, etc.), exposure parameters, etc. Still yet, in another embodiment, exposure may be dependent on multi-metering. For example, spot, center, average, or partial metering may be used to determine the exposure for the captured image. Further, multiple points may be used when metering. For example, an object (e.g. face, etc.) in the foreground may be metered in addition to an object (e.g. tree, etc.) in the background. In each case, metering may be performed with any of the above described exposure goals and, optionally, implemented using any technically feasible metering techniques.

Further, multiple captures may be performed for each ambient image and each flash image. For example, in one embodiment, an ambient image may be captured at t=0 and a flash image may be captured at t=1, and multiple images may be captured between t=0 and t=1 such that as the flash is being increased/ramped up, or otherwise modulated while the multiple images are sequentially and/or concurrently captured. Again, in each case, metering may be performed with any of the above described exposure goals. In one embodiment, a de-noise operation may be performed on one or more of the ambient images captured by the plurality of camera modules. The de-noise operation generates corresponding de-noised images. One or more of the de-noised images may be combined with corresponding flash images captured by one or more camera modules of the plurality of camera modules to generate one or more merged images.

In certain embodiments, two or more ambient images are captured by a set of two or more camera modules, with each ambient image captured according to different exposure parameters. The two or more ambient images may be combined to generate an HDR ambient image. In certain embodiments, the HDR ambient image is one of a plurality of frames of HDR video, with additional frames similarly generated. In Other embodiments, two or more flash images are captured by two or more camera modules, which may comprise the set of two or more camera modules. In one embodiment, the two or more flash images are combined to generate an HDR flash image. In certain embodiments, the HDR flash image is one of a plurality of frames of an HDR video. In certain embodiments the HDR ambient image and the HDR flash image are combined to generate an HDR merged image. In one embodiment the HDR merged image is one of a plurality of frames of HDR merged video.

In certain embodiments, the camera subsystem of a mobile device is configured to take a flash photo by default in most indoors and low-light settings, unless otherwise directed to not take a flash photo. However, certain venues where a user may be inclined to take a photo (e.g., restaurants, museums, art galleries, and the like) may have no flash policies in place that direct guests to not use their camera flash. Certain embodiments address this constraint on the use of flash photography by determining whether a venue associated with a current device location has a no flash policy. For example, the mobile device may be configured to perform a geolocate operation to determine the current location of the device and a geolocation query to determine whether the venue has a no flash policy. The geolocate operation may be performed using any technique or combination of techniques, such as global positioning satellite (GPS) location, cellular tower triangulation, and the like. The geolocation query may be performed using any technically feasible technique that retrieves location-based information. In one embodiment, the location-based information includes at least a status flag for the venue that indicates whether the venue has a no flash policy. Alternatively, a wireless transmission device, such as a WiFi access point, located on or near the premises may be configured to advertise a flag that indicates whether the venue has a no flash policy. In such an embodiment, the mobile device is configured to detect the flag indicating a no flash policy. More generally, the wireless transmission device may be configured to advertise other venue-specific policies such as no outgoing cellular phone calls, no speaker phone calls, no music played through a device's speaker, etc. The wireless transmission device may be configured to advertise such policies through an administrative webpage, physical control inputs on the transmission device, and the like.

In certain embodiments, a user asserts a shutter release action (e.g., presses a virtual button on a UI interface) and the mobile device 18-470 initiates an image capture sequence to capture an ambient image and a flash image. In one embodiment, the capture sequence includes monitoring an accelerometer and/or electronic gyroscope to estimate when camera motion is at a minimum prior to capturing final ambient and flash images. In this way, the user may, in certain cases, perceive a modestly increased shutter lag, but a resulting image may be crisper overall, having had the benefit of less camera motion during at least a portion of the ambient, and/or flash exposures. In certain embodiments, camera module 330 and processor complex 310 may coordinate functions to perform exposure metering and focus operations while waiting for a time when camera motion is at a minimum.

While the techniques disclosed herein are described in conjunction with a mobile device, persons skilled in the art will recognize that any digital imaging system comprising a digital camera (camera module), digital display, and signal processing resources may be configured to implement the techniques.

While the foregoing is directed to embodiments of the present invention, other and further embodiments of the invention may be devised without departing from the basic scope thereof, and the scope thereof is determined by the claims that follow.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

While the foregoing is directed to embodiments of the present invention, other and further embodiments of the invention may be devised without departing from the basic scope thereof, and the scope thereof is determined by the claims that follow.

What is claimed is:

1. An apparatus, comprising:
an image sensor including a pixel having a plurality of cells each with at least one photodiode generating at least one analog signal;
a first amplifier in communication with the at least one photodiode, the first amplifier receiving the at least one analog signal to apply a first gain thereto for generating a first gain amplified analog signal;
a first analog-to-digital converter in communication with the first amplifier, the first analog-to-digital converter receiving the first gain amplified analog signal for conversion thereof to a first gain amplified digital signal;
a second amplifier in communication with the at least one photodiode, the second amplifier receiving the at least one analog signal to apply a second gain for generating a second gain amplified analog signal;
a second analog-to-digital converter in communication with the second amplifier, the second analog-to-digital converter receiving the second gain amplified analog signal for conversion thereof to a second gain amplified digital signal;
at least one circuitry in communication with the first analog-to-digital converter and the second analog-to-digital converter, the at least one circuitry receiving the first gain amplified digital signal and the second gain amplified digital signal, to combine at least a portion of the first gain amplified digital signal and at least a portion of the second gain amplified digital signal, resulting in high dynamic range (HDR) image generation, where a rolling shutter is utilized for generating:
at least a portion of a first HDR image representative of a portion of one frame of a plurality of frames captured by the image sensor with a first exposure time,
at least a portion of a second HDR image representative of a portion of the one frame of the plurality of frames captured by the image sensor with a second exposure time, and
at least a portion of a third HDR image representative of a portion of the one frame of the plurality of frames captured by the image sensor with a third exposure time; and
an application processor in communication with the at least one circuitry, the application processor combining the at least portion of the first HDR, the at least portion of the second HDR image, and the at least portion of the third HDR image.

2. The apparatus of claim 1, wherein the apparatus is configured such that at least a portion of the first HDR image is representative of the portion of the one frame of the plurality of frames captured by the image sensor during only the first exposure time.

3. The apparatus of claim 1, wherein the apparatus is configured such that the second HDR image is representative of the portion of the one frame of the plurality of frames captured by the image sensor during the first exposure time and the second exposure time, and the third HDR image is representative of the portion of the one frame of the plurality of frames captured by the image sensor during the first exposure time, the second exposure time, and the third exposure time.

4. The apparatus of claim 1, wherein the apparatus is configured such that the first exposure time, the second exposure time, and the third exposure time at least partially overlap.

5. The apparatus of claim 1, wherein the apparatus is configured such that the first exposure time starts first in order, the second exposure time starts second in order, and the third exposure time starts third in order.

6. A method, comprising:
at an apparatus including: an image sensor including a pixel having a plurality of cells each with at least one photodiode, a first amplifier in communication with the at least one photodiode, a first analog-to-digital converter in communication with the first amplifier, a second amplifier in communication with the at least one photodiode, a second analog-to-digital converter in communication with the second amplifier, at least one circuitry in communication with the first analog-to-digital converter and the second analog-to-digital converter, and an application processor in communication with the at least one circuitry:
generating, utilizing the at least one photodiode, at least one analog signal;
applying, utilizing the first amplifier, a first gain to the at least one analog signal for generating a first gain amplified analog signal;
converting, utilizing the first analog-to-digital converter, the first gain amplified analog signal to a first gain amplified digital signal;
applying, utilizing the second amplifier, a second gain to the at least one analog signal for generating a second gain amplified analog signal;
converting, utilizing the second analog-to-digital converter, the second gain amplified analog signal to a second gain amplified digital signal;
combining, utilizing the at least one circuitry, at least a portion of the first gain amplified digital signal and at least a portion of the second gain amplified digital signal, resulting in high dynamic range (HDR) image generation, where a rolling shutter is utilized for generating:
at least a portion of a first HDR image representative of a portion of one frame of a plurality of frames captured by the image sensor with a first exposure time,
at least a portion of a second HDR image representative of a portion of the one frame of the plurality of frames captured by the image sensor with a second exposure time, and
at least a portion of a third HDR image representative of a portion of the one frame of the plurality of frames captured by the image sensor with a third exposure time; and
combining, utilizing the application processor, the at least portion of the first HDR, the at least portion of the second HDR image, and the at least portion of the third HDR image.

7. The method of claim 6, wherein the first HDR image is representative of the portion of the one frame of the plurality of frames captured by the image sensor during only the first exposure time.

8. The method of claim 6, wherein the second HDR image is representative of the portion of the one frame of the plurality of frames captured by the image sensor during the first exposure time and the second exposure time, and the third HDR image is representative of the portion of the one frame of the plurality of frames captured by the image sensor during the first exposure time, the second exposure time, and the third exposure time.

9. The method of claim 6, wherein the first exposure time, the second exposure time, and the third exposure time at least partially overlap.

10. The method of claim 6, wherein the first exposure time starts first in order, the second exposure time starts second in order, and the third exposure time starts third in order.

11. An apparatus, comprising:
an image sensor including a pixel having a plurality of cells each with at least one photodiode generating at least one analog signal;
a first amplifier means for receiving the at least one analog signal to apply a first gain thereto for generating a first gain amplified analog signal;
a first analog-to-digital converter means for receiving the first gain amplified analog signal for conversion thereof to a first gain amplified digital signal;
a second amplifier means for receiving the at least one analog signal to apply a second gain for generating a second gain amplified analog signal;
a second analog-to-digital converter means for receiving the second gain amplified analog signal for conversion thereof to a second gain amplified digital signal;
circuitry means for receiving the first gain amplified digital signal and the second gain amplified digital signal, to combine at least a portion of the first gain amplified digital signal and at least a portion of the second gain amplified digital signal, resulting in high dynamic range (HDR) image generation, where a rolling shutter is utilized for generating:
at least a portion of a first HDR image representative of a portion of one frame of a plurality of frames captured by the image sensor with a first exposure time,
at least a portion of a second HDR image representative of a portion of the one frame of the plurality of frames captured by the image sensor with a second exposure time, and
at least a portion of a third HDR image representative of a portion of the one frame of the plurality of frames captured by the image sensor with a third exposure time; and
an application processor means for combining the at least portion of the first HDR, the at least portion of the second HDR image, and the at least portion of the third HDR image.
